(19) United States
(12) Patent Application Publication
(10) Pub. No.: US 2024/0420435 A1
(43) Pub. Date: Dec. 19, 2024

(54) METHODS FOR MOVING OBJECTS IN A THREE-DIMENSIONAL ENVIRONMENT

(71) Applicant: Apple Inc., Cupertino, CA (US)

(72) Inventors: Nathan GITTER, Cupertino, CA (US); Benjamin HYLAK, San Francisco, CA (US); Jonathan RAVASZ, Sunnyvale, CA (US); Christopher D. MCKENZIE, Burlingame, CA (US); Nahckjoon KIM, Sunnyvale, CA (US); Israel PASTRANA VICENTE, Spring, TX (US); Zoey C. TAYLOR, San Francisco, CA (US); Benjamin H. BOESEL, Jackson, WY (US)

(21) Appl. No.: 18/668,049

(22) Filed: May 17, 2024

Related U.S. Application Data
(60) Provisional application No. 63/503,149, filed on May 18, 2023.
(60) Provisional application No. 63/505,937, filed on Jun. 2, 2023.
(60) Provisional application No. 63/515,123, filed on Jul. 23, 2023.
(60) Provisional application No. 63/648,631, filed on May 16, 2024.

(51) Int. Cl. G06T 19/20; G06T 13/20; G06T 15/10

(52) U.S. Cl. CPC G06T 19/20; G06T 13/20; G06T 15/10; G06T 2219/2004

(57) ABSTRACT

In some embodiments, a computer system facilitates movement, including rotation, of a virtual object in a three-dimensional environment. In some embodiments, a computer system facilitates movement of a virtual object in a three-dimensional environment toward a movement boundary. In some embodiments, a computer system facilitates dynamic scaling of a virtual object in a three-dimensional environment based on movement of the virtual object in the three-dimensional environment. In some embodiments, a computer system facilitates inertial movement of a virtual object in a three-dimensional environment. In some embodiments, a computer system facilitates converging offsets between a portion of a user and a virtual object. In some embodiments, a computer system facilitates rotation of a volumetric virtual object in a three-dimensional environment.

### CROSS-REFERENCE TO RELATED APPLICATIONS

This application claims the benefit of U.S. Provisional Application No. 63/503,149, filed May 18, 2023, U.S. Provisional Application No. 63/505,937, filed Jun. 2, 2023, U.S. Provisional Application No. 63/515,123, filed Jul. 23, 2023, and U.S. Provisional Application No. 63/648,631, filed May 16, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted display device (HMD), a display, a projector, a touch-sensitive display (also known as a “touch screen” or “touch-screen display”), or other device or component that preserves visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with content in a three-dimensional environment. Such methods and interfaces may complement or replace conventional methods for interacting with content in a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates movement, including rotation, of a virtual object in a three-dimensional environment. In some embodiments, a computer system facilitates movement of a virtual object in a three-dimensional environment toward a movement boundary. In some embodiments, a computer system facilitates dynamic scaling of a virtual object in a three-dimensional environment based on movement of the virtual object in the three-dimensional environment. In some embodiments, a computer system facilitates moving virtual objects with inertial motion in an environment, based on movement of the virtual objects in accordance with a user input. In some embodiments, a computer system facilitates gradual updating of one or more spatial properties of a virtual object in a three-dimensional environment based on a viewpoint of a user. In some embodiments, a computer system facilitates reducing an offset between a virtual object and a portion of the user as the virtual object is moved within a three-dimensional environment. In some embodiments, a computer system facilitates rotation of a three-dimensional object relative to a viewpoint of a user based on a change in angle of elevation of the three-dimensional object within a three-dimensional environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figs.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7J illustrate examples of a computer system facilitating movement of a virtual object in a three-dimensional environment in accordance with some embodiments.

FIGS. 8A-8G is a flowchart illustrating an exemplary method of facilitating movement of a virtual object in a three-dimensional environment in accordance with some embodiments.

FIGS. 9A-9J illustrate examples of a computer system facilitating movement of a virtual object beyond a movement threshold in a three-dimensional environment in accordance with some embodiments.

FIGS. 10A-10L is a flowchart illustrating a method of facilitating movement of a virtual object beyond a movement threshold in a three-dimensional environment in accordance with some embodiments.

FIGS. 11A-11F illustrate examples of a computer system facilitating dynamic scaling of a virtual object in a three-dimensional environment in accordance with some embodiments.

FIGS. 12A-12F is a flowchart illustrating a method of facilitating dynamic scaling of a virtual object in a three-dimensional environment in accordance with some embodiments.

FIGS. 13A-13L illustrate examples of a computer system facilitating inertial movement of a virtual object in a three-dimensional environment in accordance with some embodiments.

FIG. 14 is a flowchart illustrating a method of facilitating inertial movement of a virtual object in accordance with some embodiments.

FIGS. 15A-15J illustrate examples of a computer system facilitating gradual updating of one or more spatial properties of a virtual object in a three-dimensional environment in accordance with some embodiments.

FIG. 16 is a flowchart illustrating a method of facilitating gradual updating of one or more spatial properties of a virtual object in a three-dimensional environment in accordance with some embodiments.

FIGS. 17A-17J illustrate examples of a computer system facilitating gradual reduction of offsets between a portion of a user and a virtual object in a three-dimensional environment in accordance with some embodiments.

FIG. 18 is a flowchart illustrating a method of facilitating gradual reduction of offsets between a portion of a user and a virtual object in a three-dimensional environment in accordance with some embodiments.

FIGS. 19A-19R illustrate examples of a computer system facilitating rotation of a volumetric virtual object in a three-dimensional environment in accordance with some embodiments.

FIG. 20 is a flowchart illustrating a method of facilitating rotation of a volumetric virtual object in a three-dimensional environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein provide improved ways for an electronic device to facilitate interaction with and manipulate objects in a three-dimensional environment.

In some embodiments, a computer system facilitates movement, including rotation, of a virtual object in a three-dimensional environment. In some embodiments, the computer system displays a three-dimensional environment including a virtual object. In some embodiments, in response to detecting an input corresponding to a request to move the virtual object in the three-dimensional environment, the computer system changes a position of the virtual object in the three-dimensional environment based on the input, including, in accordance with a determination that the virtual object has a first angle of elevation relative to a first portion of a user of the computer system, rotating the virtual object about a first axis in the three-dimensional environment. In some embodiments, in accordance with a determination that the virtual object has a second angle of elevation, different from the first angle of elevation, relative to the first portion of the user, the computer system rotates the virtual object about a second axis, different from the first axis, in the three-dimensional environment.

In some embodiments, a computer system In some embodiments, a computer system facilitates movement of a virtual object in a three-dimensional environment toward a movement boundary. In some embodiments, the computer system displays a three-dimensional environment including a virtual object. In some embodiments, in response to detecting an input corresponding to a request to move the virtual object in the three-dimensional environment, the computer system changes a position of the virtual object in the three-dimensional environment based on the input. In some embodiments, after detecting a termination of the request to move the virtual object, and in accordance with a determination that the virtual object is beyond a movement boundary relative to the three-dimensional environment, the computer system changes the position of the virtual object toward the movement boundary.

In some embodiments, a computer system facilitates dynamic scaling of a virtual object in a three-dimensional environment based on movement of the virtual object in the three-dimensional environment. In some embodiments, the computer system displays a three-dimensional environment that includes a virtual object. In some embodiments, in response to detecting an input corresponding to a request to move the virtual object in a first direction relative to a viewpoint of a user of the computer system, the computer system moves the virtual object in the first direction in the three-dimensional environment relative to the viewpoint of the user in accordance with the input. In some embodiments, during a first portion of the movement of the virtual object, the computer system moves the virtual object a first distance in the three-dimensional environment and scales the virtual object by a first amount in the three-dimensional environment. In some embodiments, during a second portion of the movement of the virtual object, the computer system moves the virtual object a second distance, different from the first distance, in the three-dimensional environment and scales the virtual object by a second amount, different from the first amount, in the three-dimensional environment.

In some embodiments, a computer system facilitates inertial motion of a virtual object in a three-dimensional environment based movement of the virtual object by the user. In some embodiments, while displaying a virtual object, the computer system detects a first input that includes movement. In some embodiments, in response to detecting the first input, the computer system moves the virtual object in accordance with the movement of the first input. In some embodiments, while displaying the virtual object in accordance with the movement of the first input, the computer system detects termination of the movement while the movement of the first input is in a respective direction. In some embodiments, in response to detecting the termination of the first input, the computer system continues moving the virtual object in the environment according to a respective movement model that specifies how movement of the virtual object continues after detecting termination of the input. In some embodiments, continuing the movement of the virtual object according to the respective movement model includes: in accordance with a determination that the respective direction is closer to a first reference direction than a second reference direction, the computer system moves the virtual object in a first updated direction, wherein a difference between the first updated direction and the first reference direction is smaller than a difference between the respective direction and the first reference direction.

In some embodiments, a computer system facilitates gradual updating of one or more spatial properties of a virtual object in a three-dimensional environment based on a viewpoint of a user. In some embodiments, while a virtual object is displayed with one or more first spatial properties relative to a three-dimensional environment, the computer system detects a first input corresponding to selection of the virtual object. In some embodiments, in response to detecting the first input, in accordance with a determination that the virtual object was located at a first location in the three-dimensional environment from a viewpoint of a user of the computer system when the first input is detected, the computer system updates display of the virtual object to have one or more second spatial properties, different from the one or more first spatial properties, relative to the three-dimensional environment over a first time period that is greater than zero. In some embodiments, in accordance with a determination that the virtual object was located at a second location, different from the first location, in the three-dimensional environment from the viewpoint of the user when the first input is detected, the computer system updates display of the virtual object to have one or more third spatial properties, different from the one or more second spatial properties, relative to the three-dimensional environment over a second time period that is greater than zero.

In some embodiments, while displaying a virtual object in an environment, and while there is an offset between a first vector extending from a respective pivot point towards the virtual object and a second vector extending from the respective pivot point towards a first portion of the user, a computer system detects a first input corresponding to moving the virtual object within the environment, wherein the first input corresponds to movement of the first portion of the user. In some embodiments, in response to detecting the first input: in accordance with a determination that the first input corresponds to movement of the first portion of the user in a first direction that moves the second vector that extends from the respective pivot point towards the first portion of the user, away from a location at which the virtual object was displayed prior to detecting the movement of the first portion of the user, the computer system moves the virtual object within the environment in a first manner in accordance with the first input, wherein moving the virtual object in the first manner includes gradually reducing the offset between the first vector that extends from the respective pivot point towards the virtual object, and the second vector, that extends from the respective pivot point towards the first portion of the user. In some embodiments, in response to detecting the first input: in accordance with a determination that the first input corresponds to movement of the first portion of the user in a second direction that moves the second vector towards the location at which the virtual object was displayed prior to detecting the movement of the first portion of the user, the computer system moves the virtual object within the environment in a second manner in accordance with the first input, wherein moving the virtual object in the second manner includes gradually reducing the offset between the first vector, that extends from the respective pivot point towards the virtual object, and the second vector, that extends from the respective pivot point towards the first portion of the user, at a rate that is lower than a rate of reduction of the offset associated with the first manner.

In some embodiments, a computer system facilitates rotation of a three-dimensional object relative to a viewpoint of a user based on a change in angle of elevation of the three-dimensional object within a three-dimensional environment. In some embodiments, while displaying, via a display generation component, a three-dimensional object in an environment, the computer system detects, via one or more input devices, a first input corresponding to a request to change an angle of elevation of the three-dimensional object relative to a viewpoint of a user of a computer system within the environment. In some embodiments, in response to detecting the first input, in accordance with a determination that the first input satisfies a first set of one or more criteria, the computer system changes the angle of elevation of the three-dimensional object relative to the viewpoint of the user in the environment based on the first input and rotates the three-dimensional object in the environment to tilt a first portion of the three-dimensional object toward a location of the viewpoint based on the change in the angle of elevation of the three-dimensional object relative to the viewpoint of the user. In some embodiments, in accordance with a determination that the first input does not satisfy the first set of one or more criteria, the computer system changes the angle of elevation of the three-dimensional object relative to the viewpoint of the user in the environment based on the first input, without rotating the three-dimensional object in the environment.

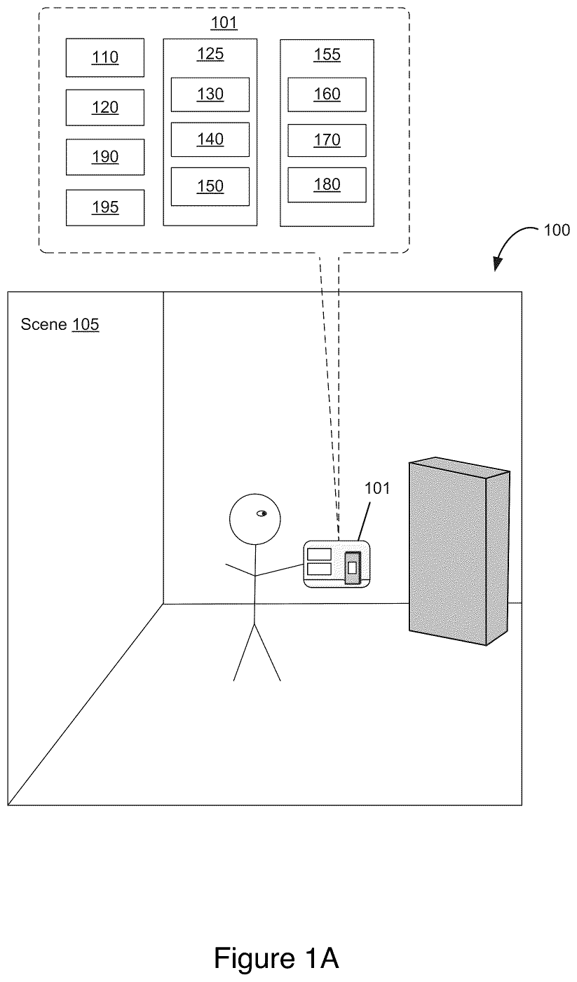

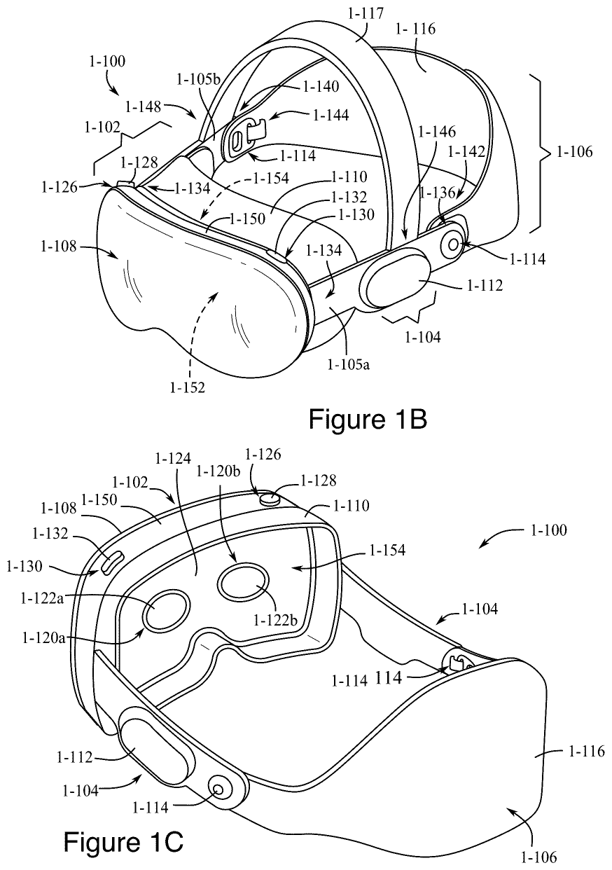

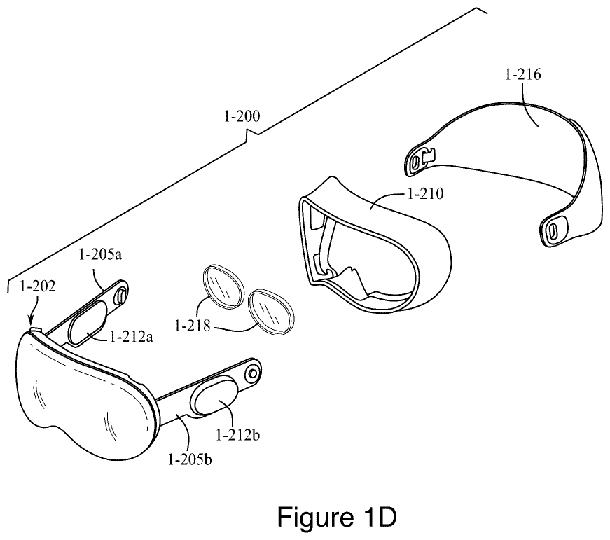

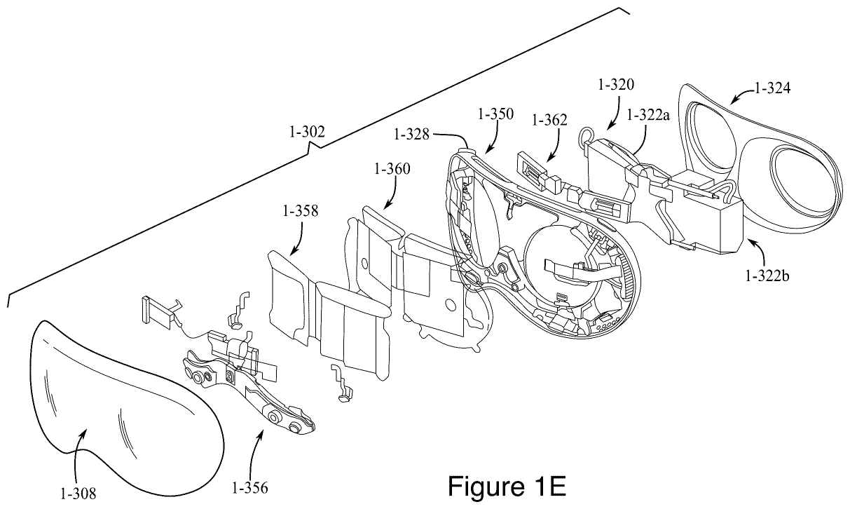

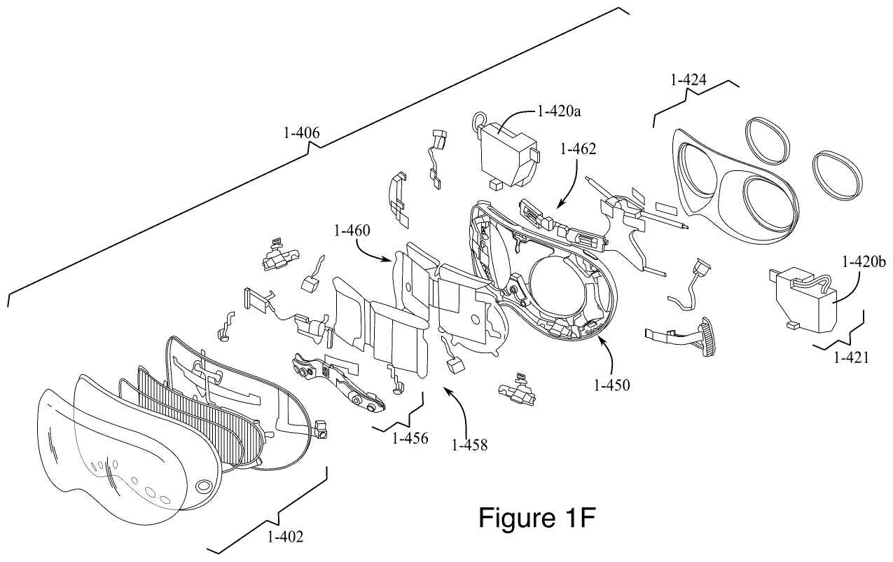

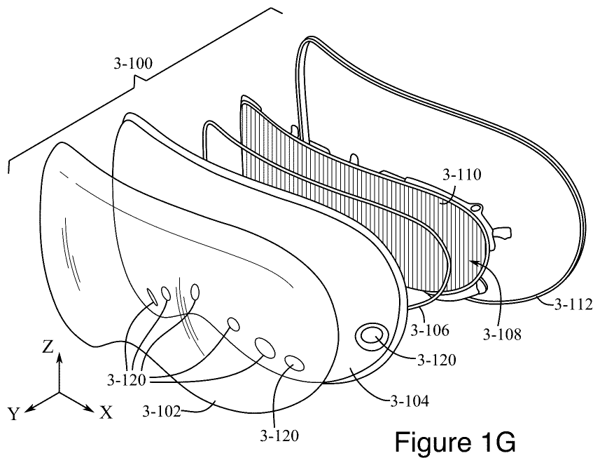

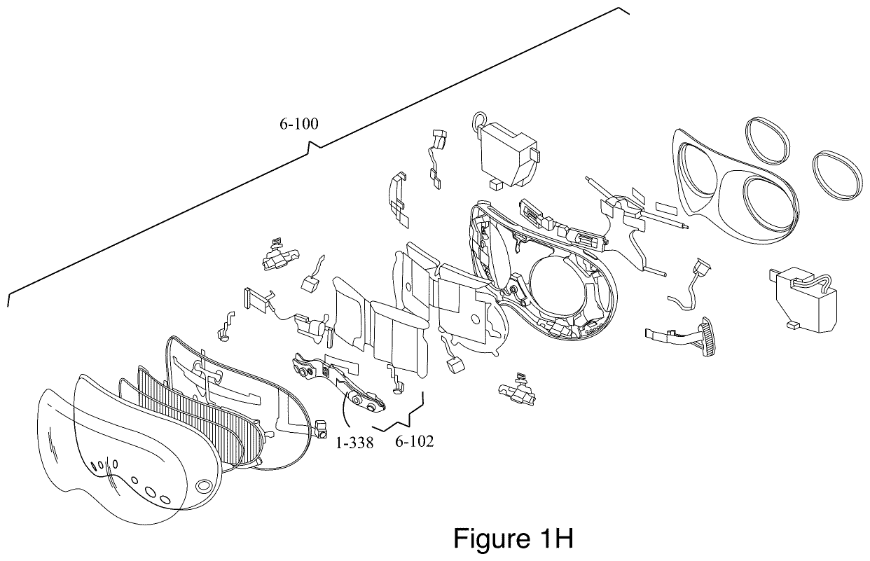

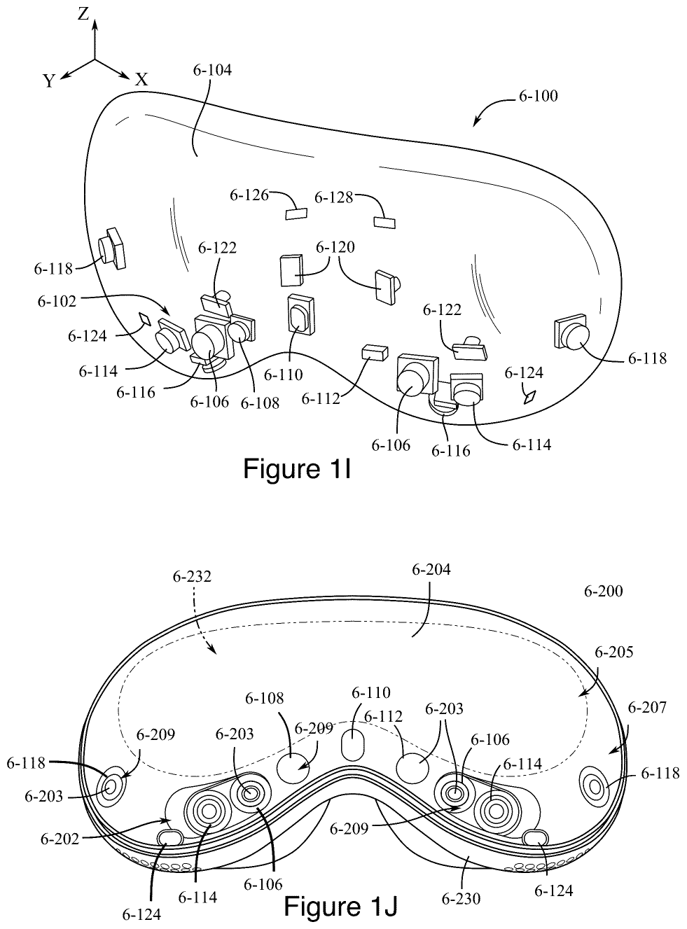

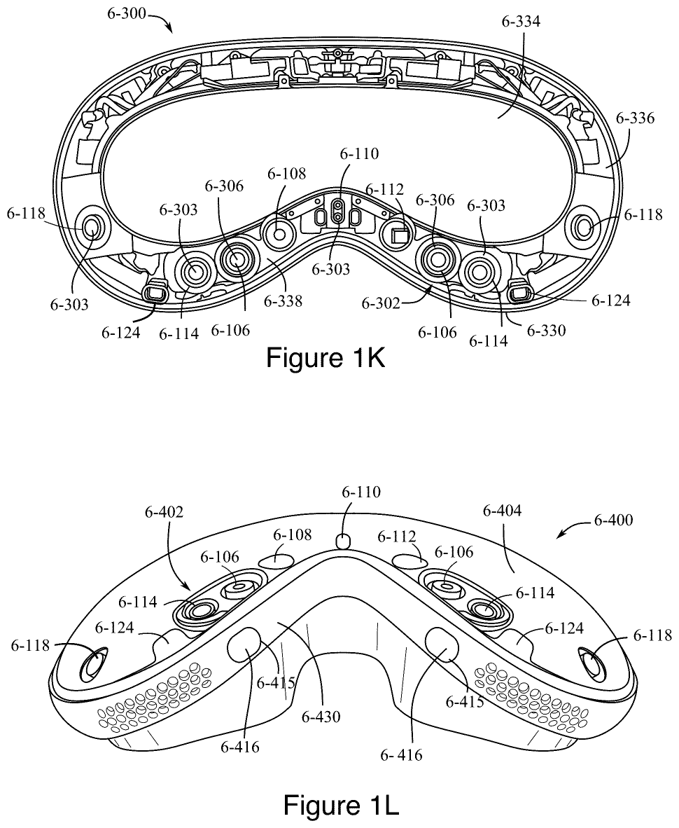

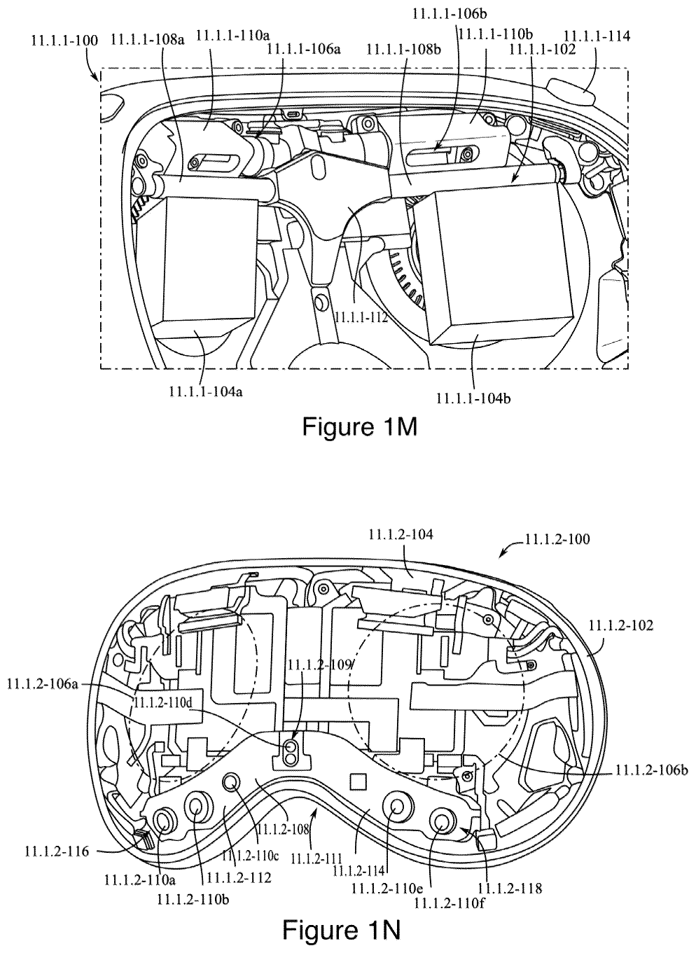

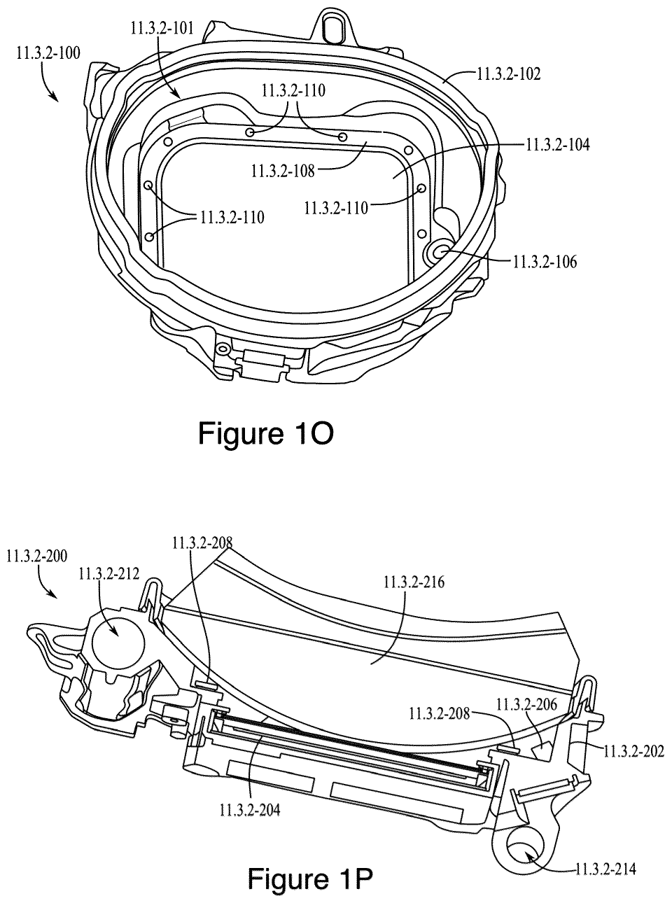

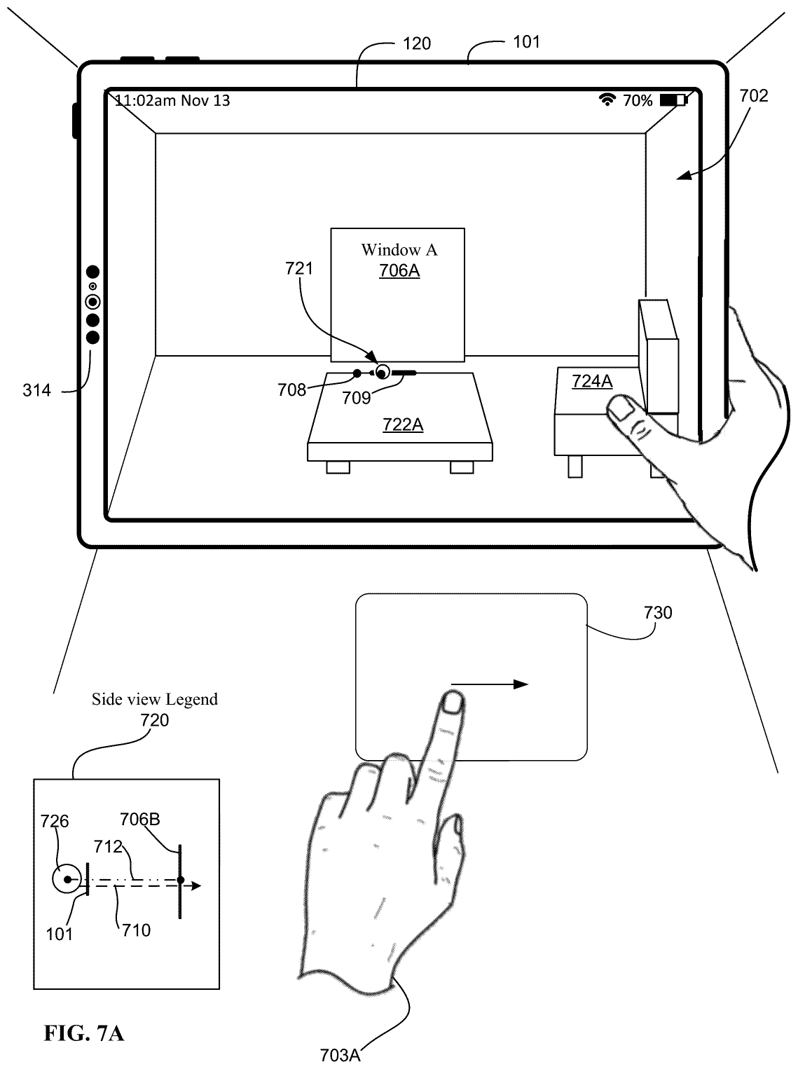

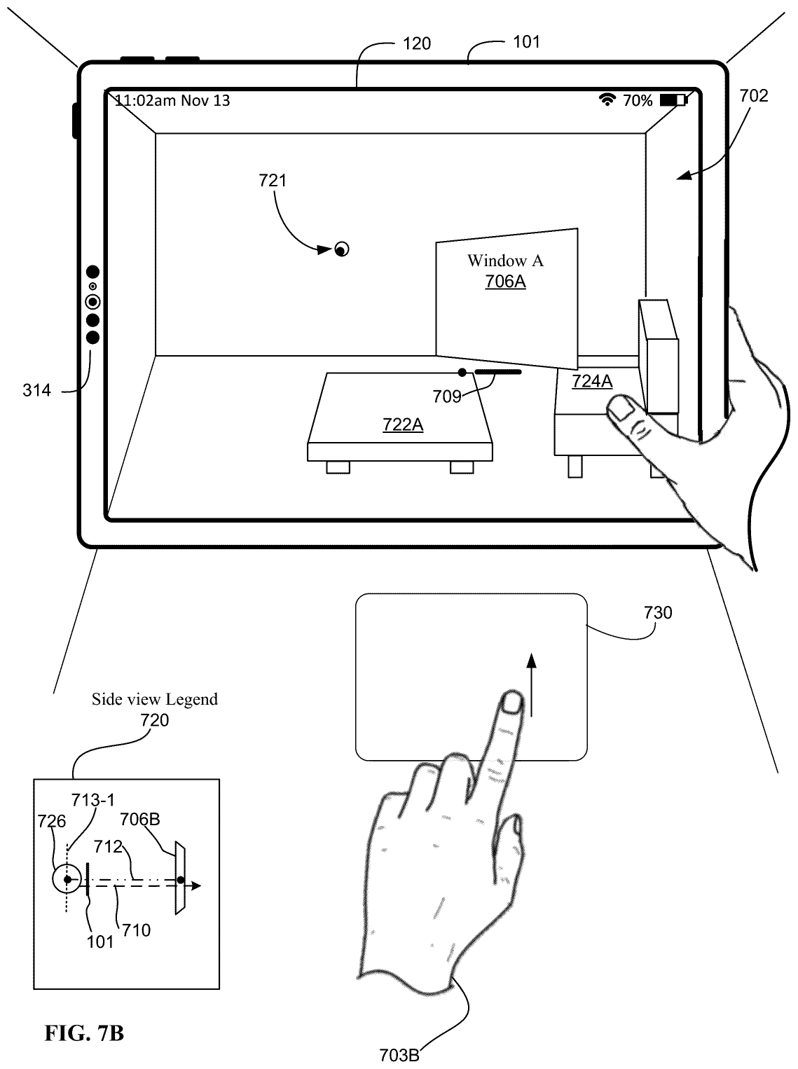

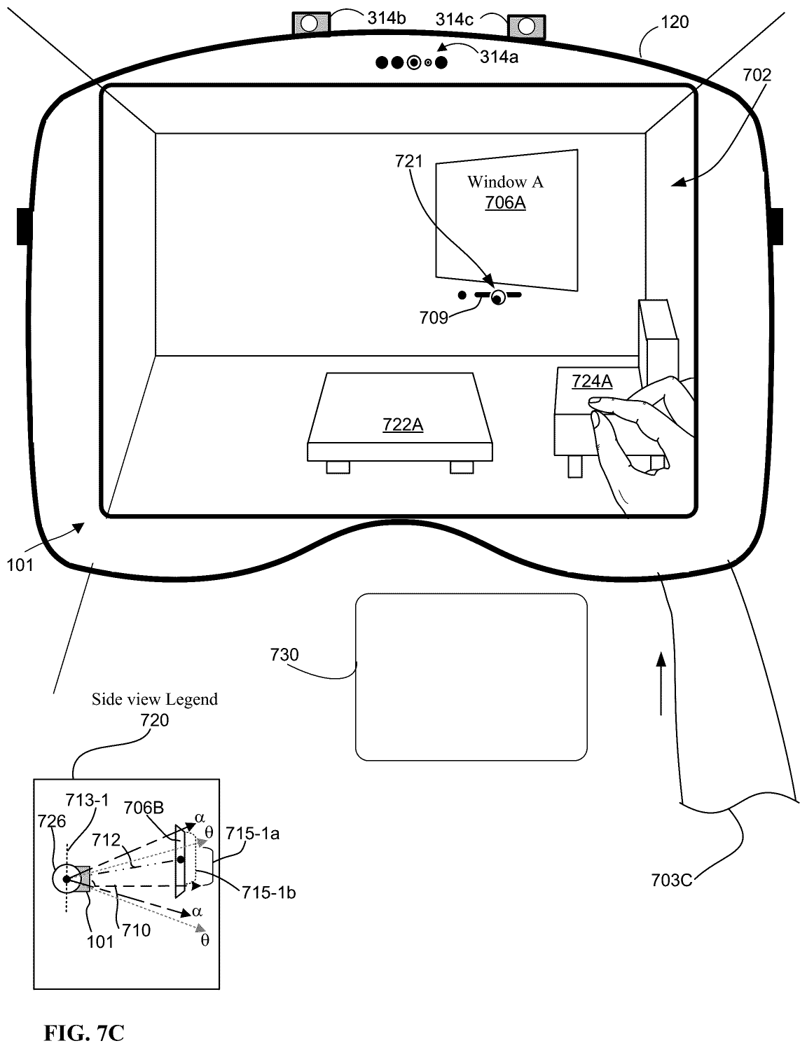

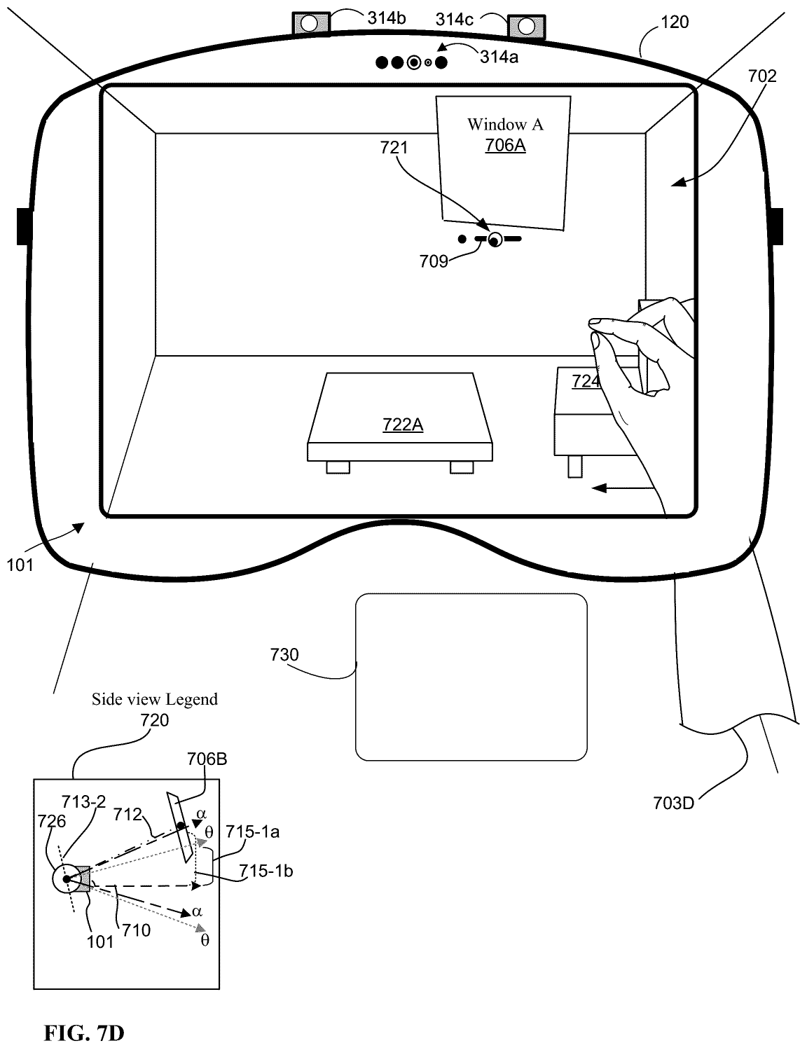

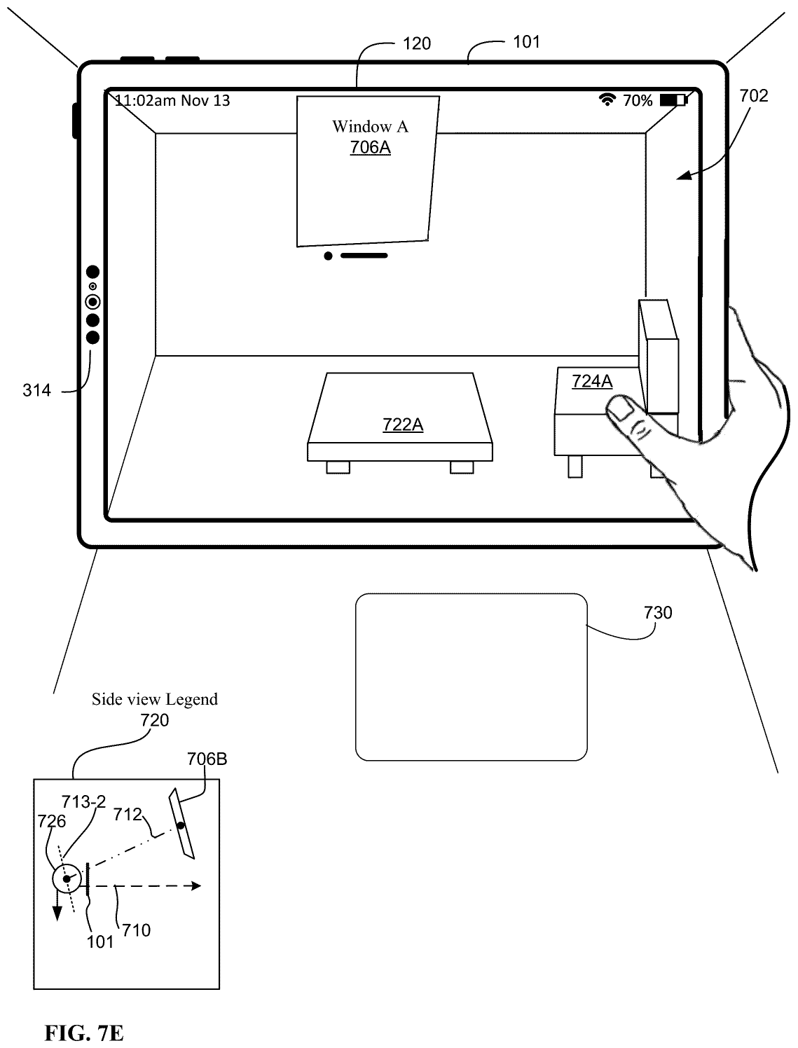

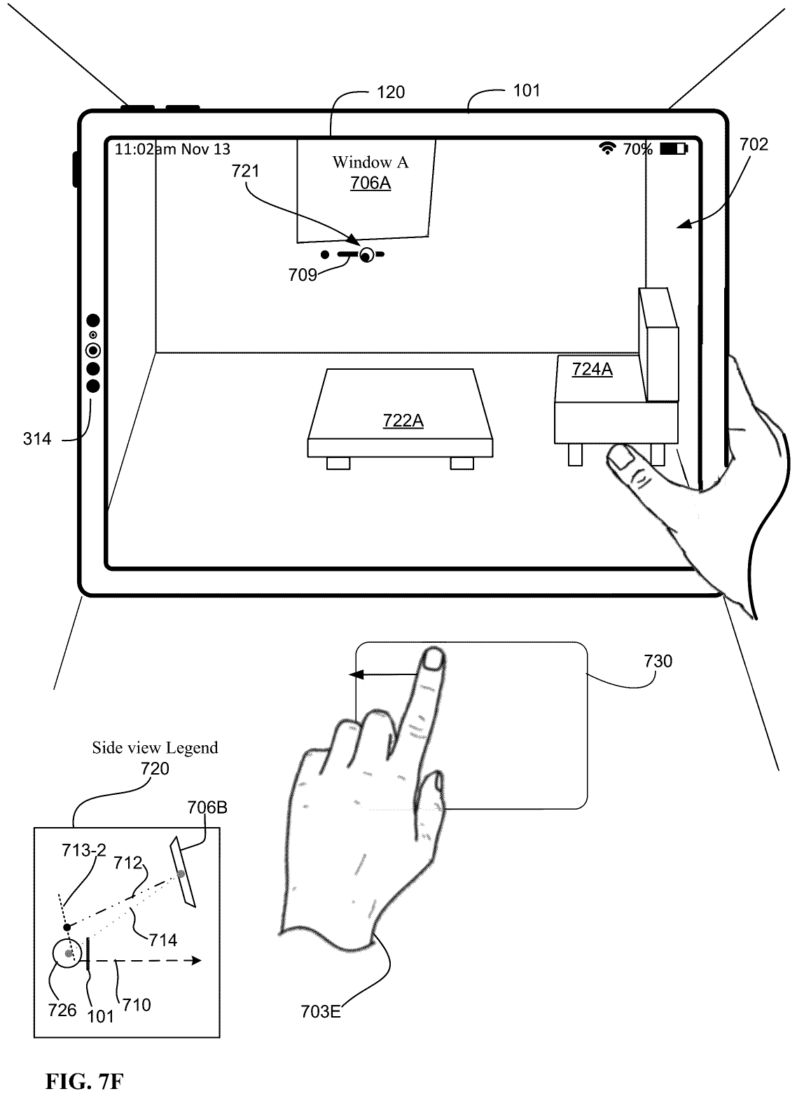

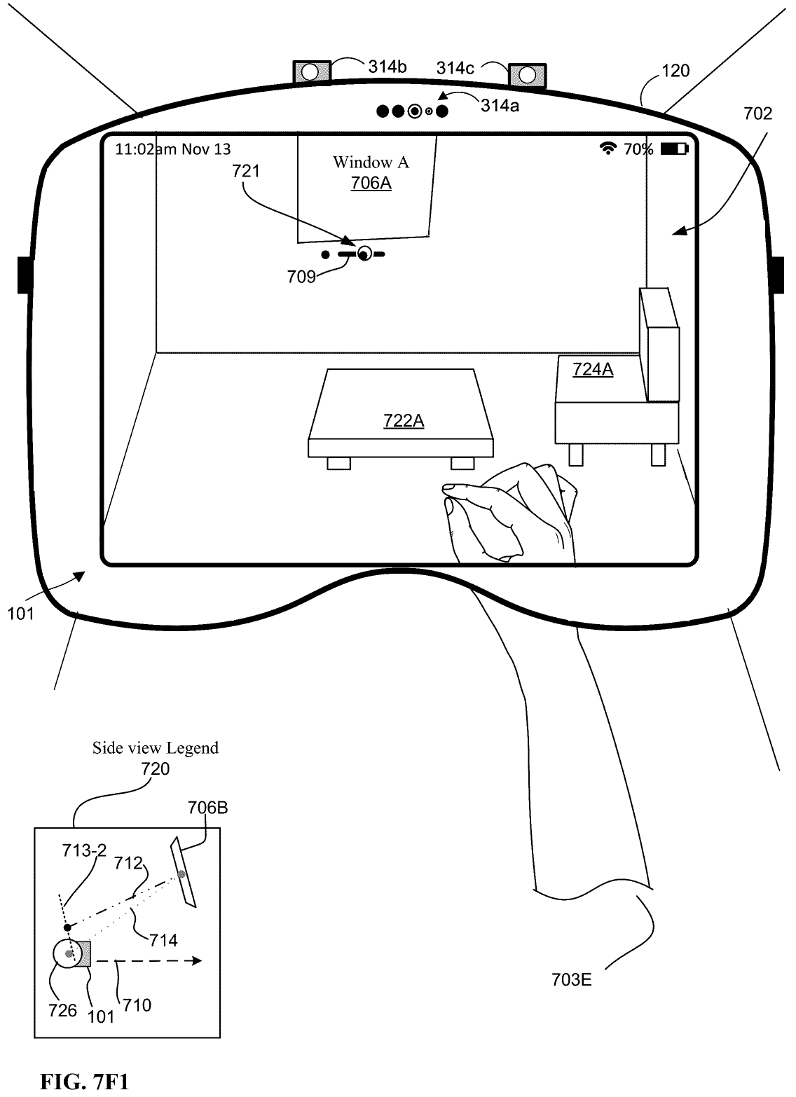

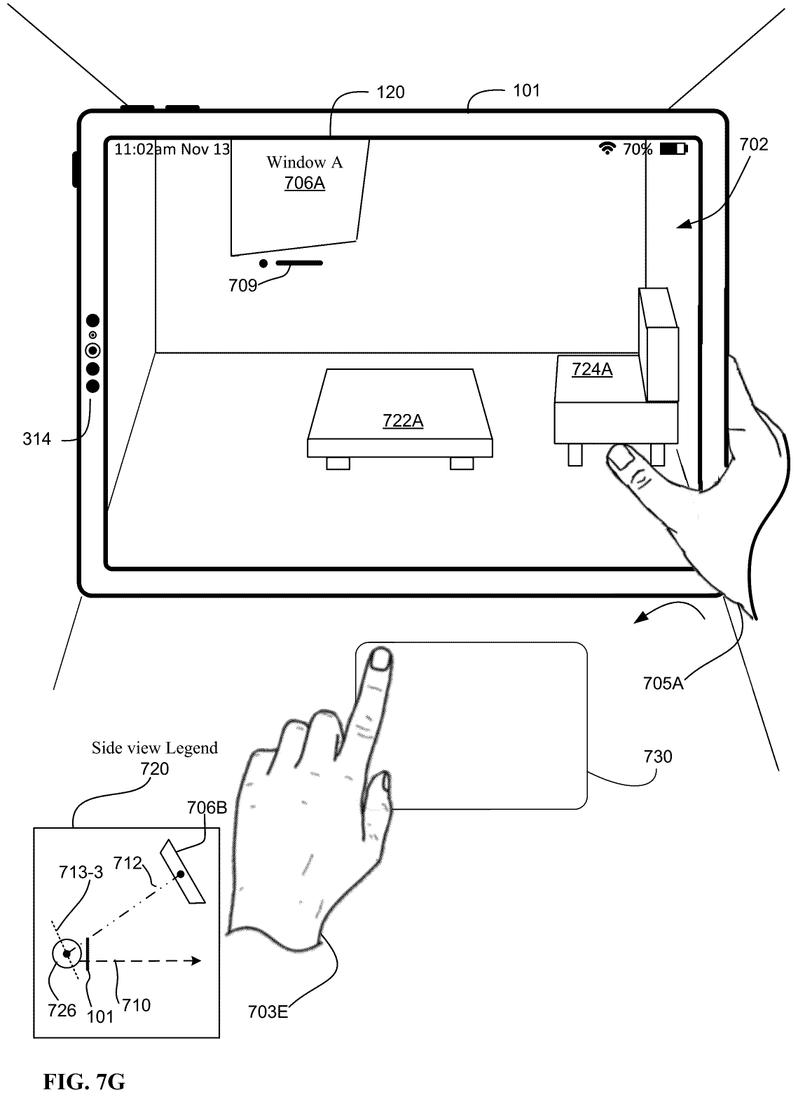

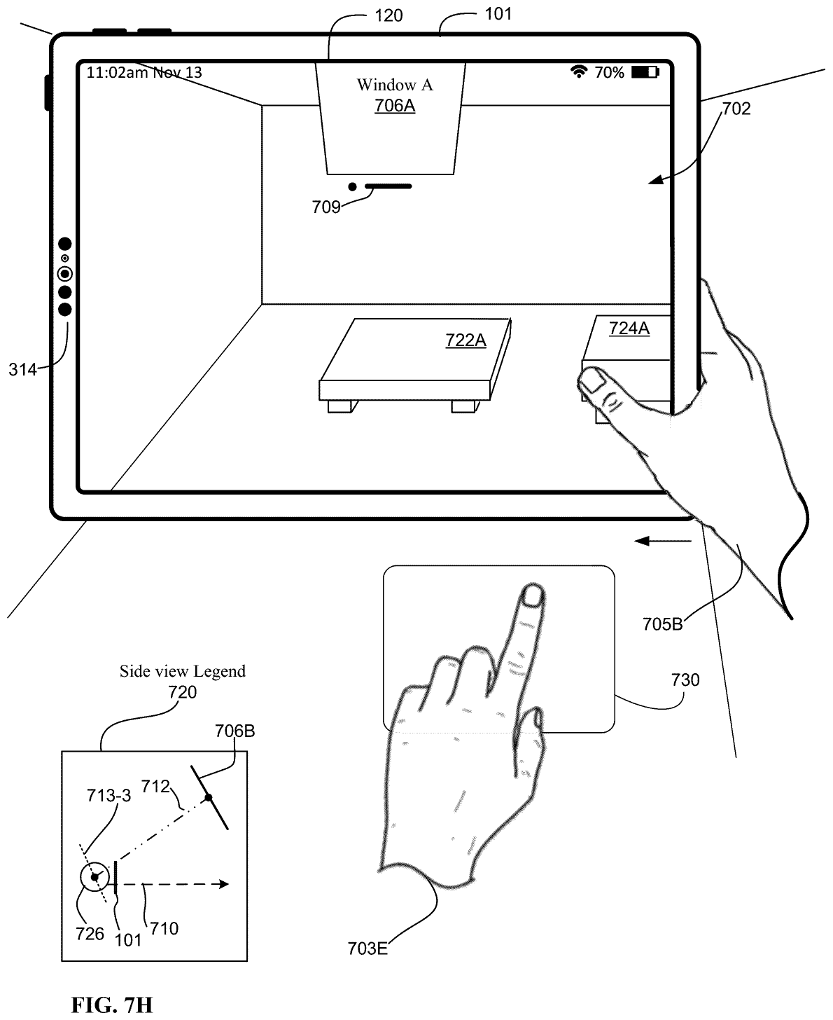

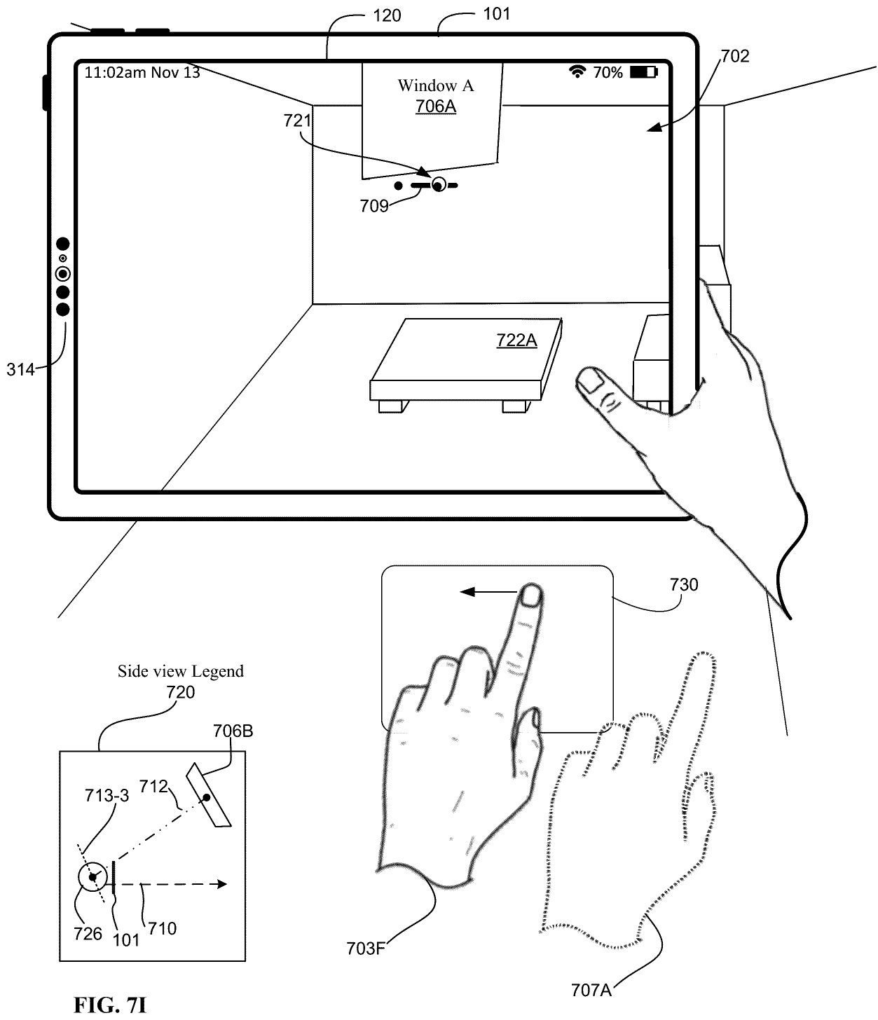

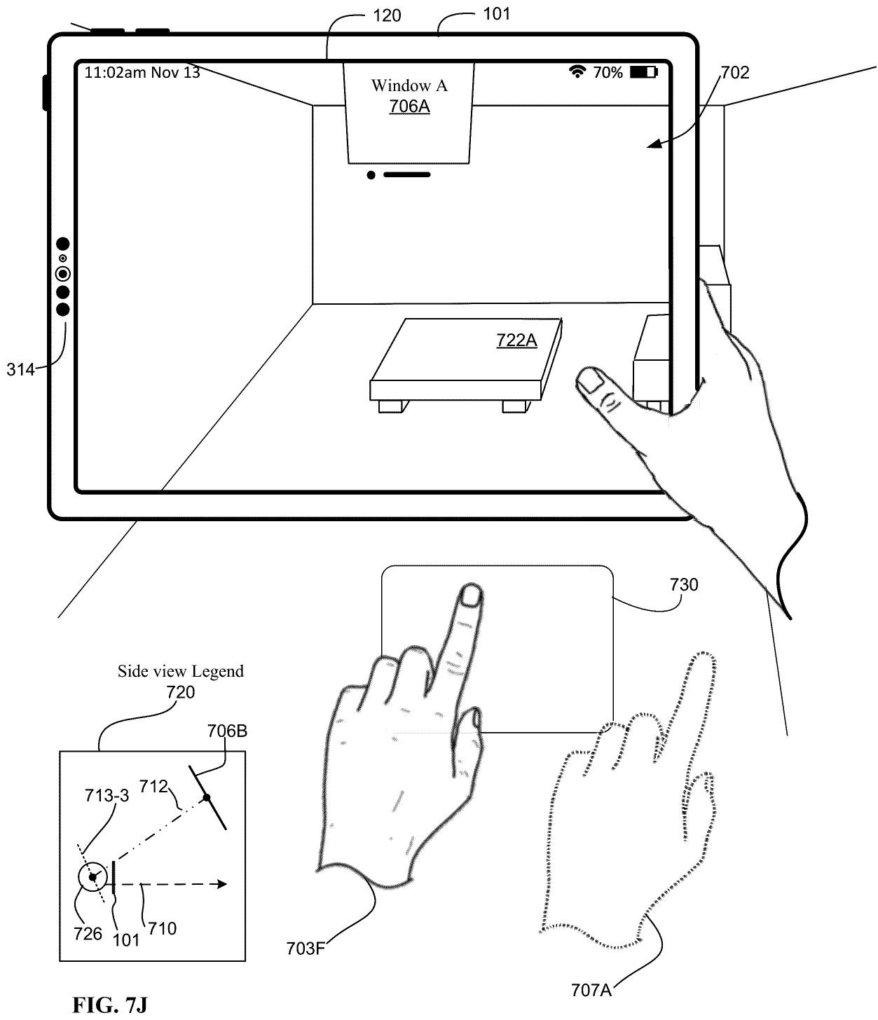

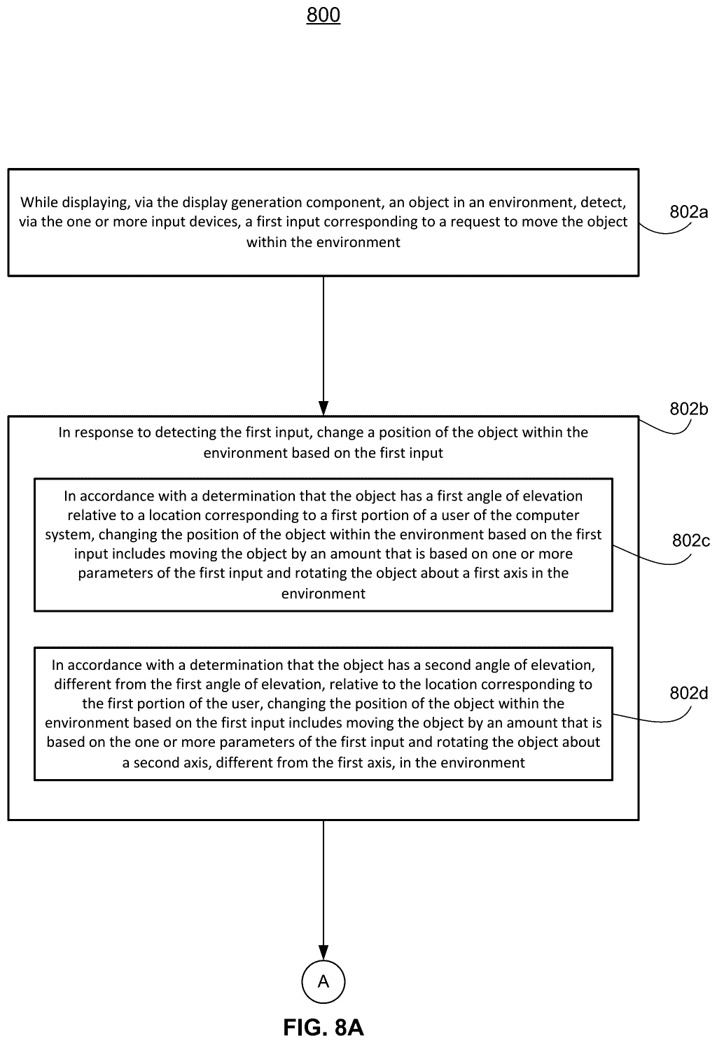

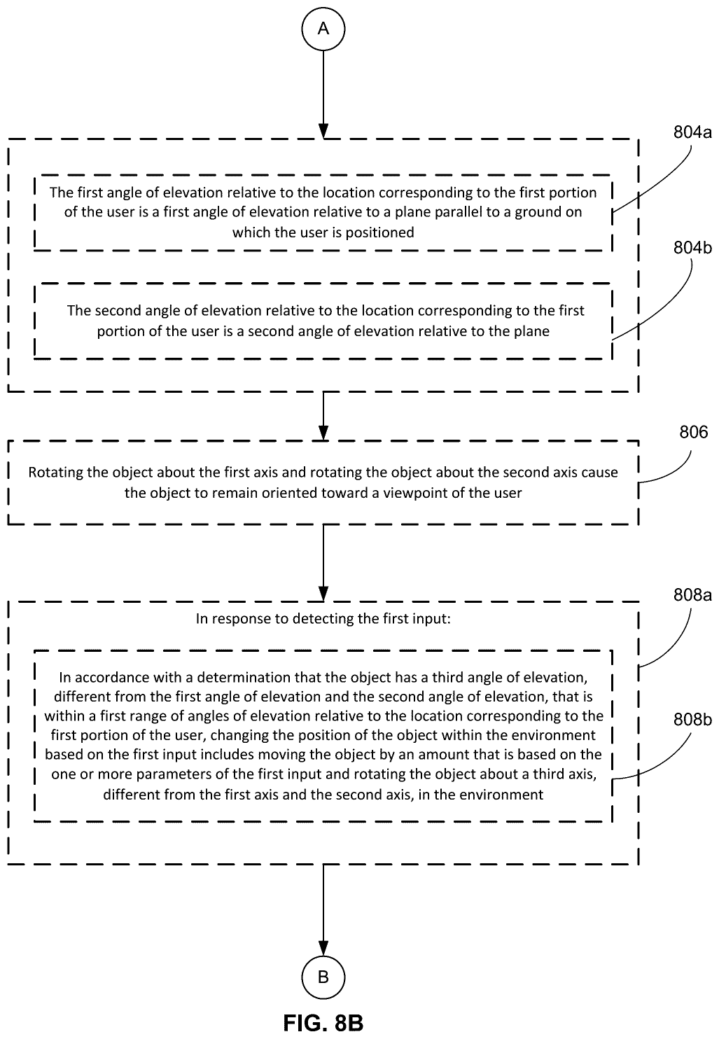

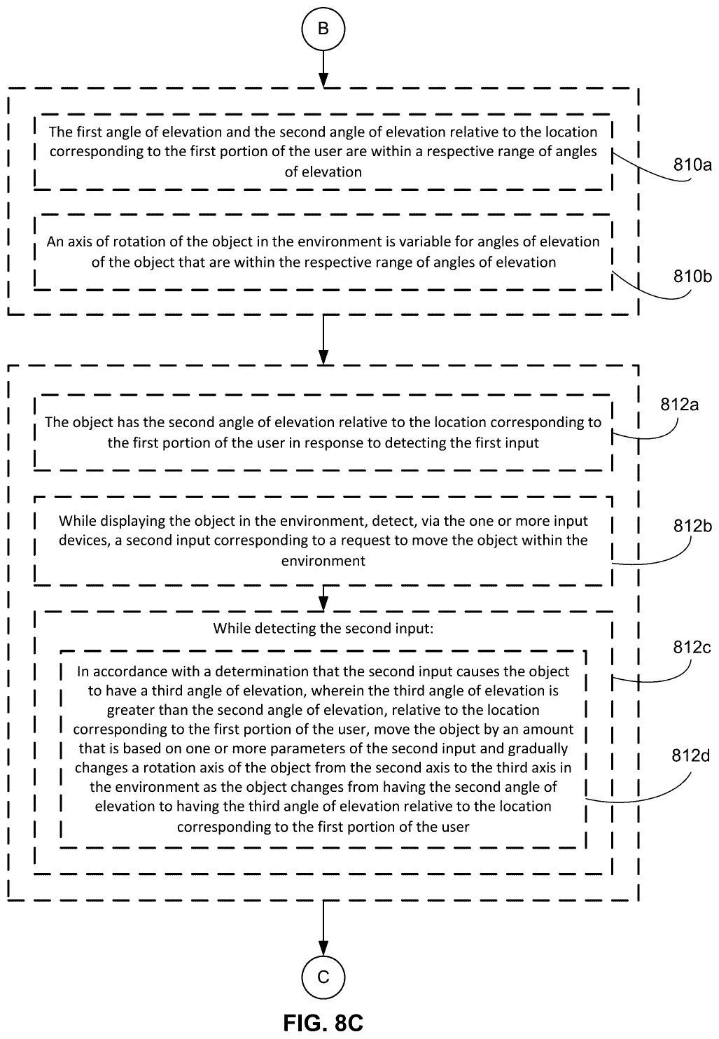

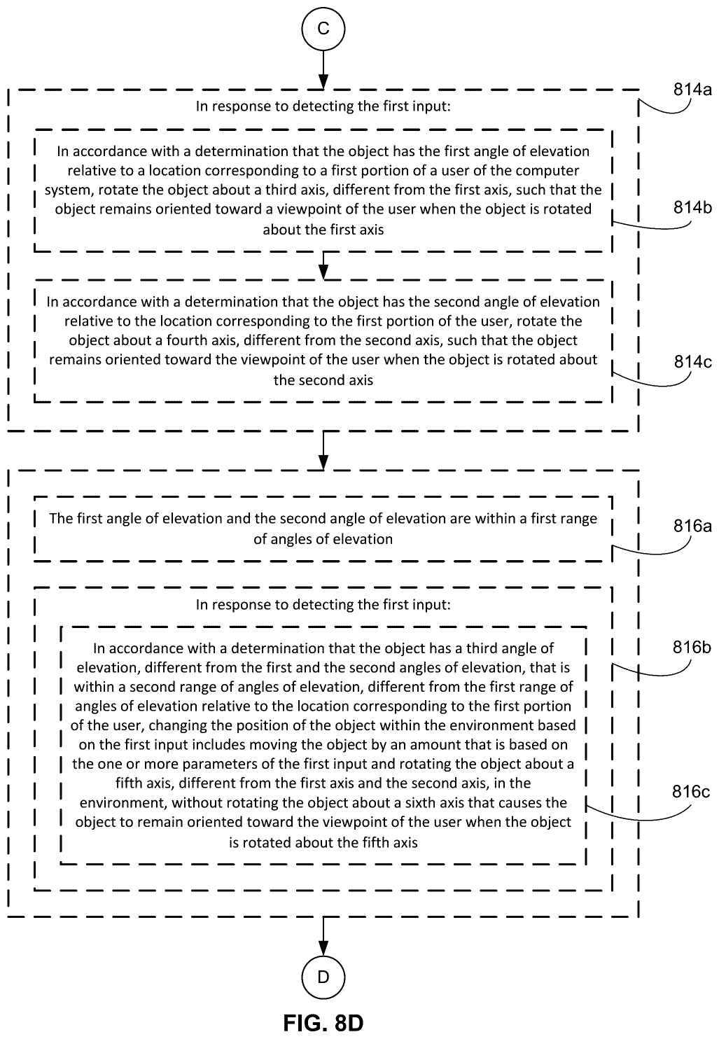

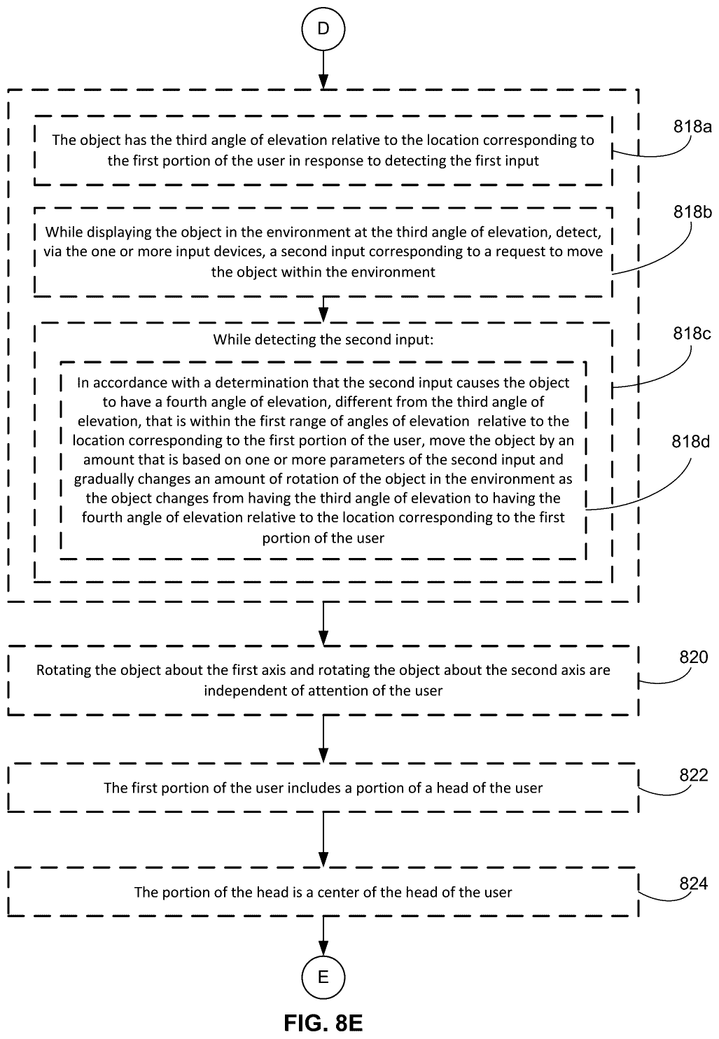

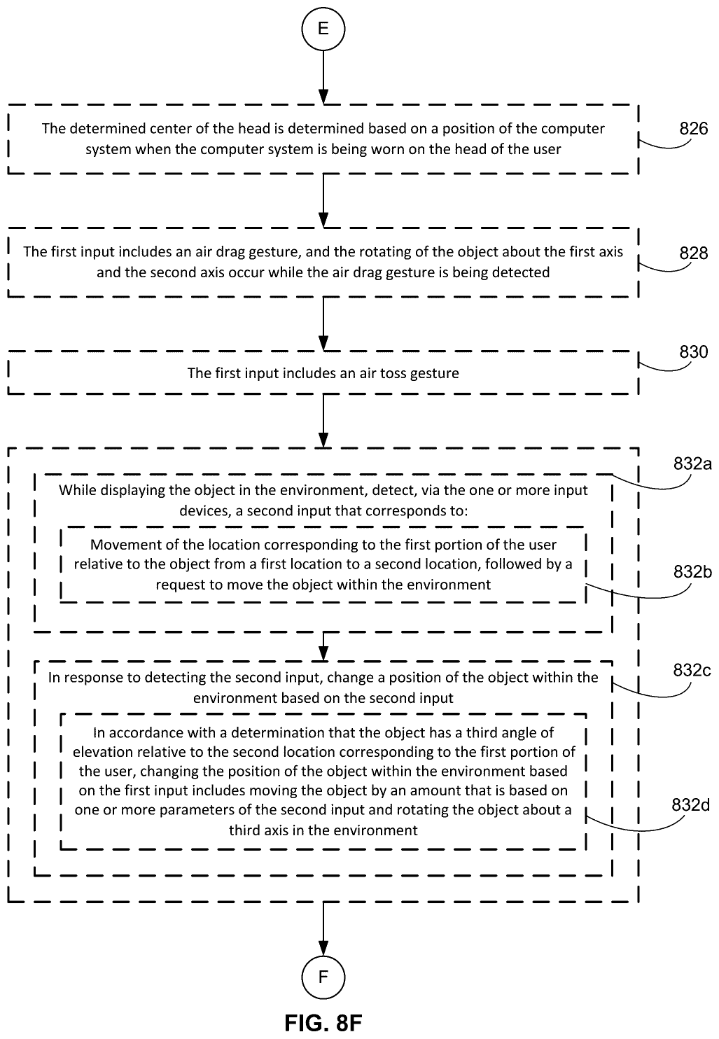

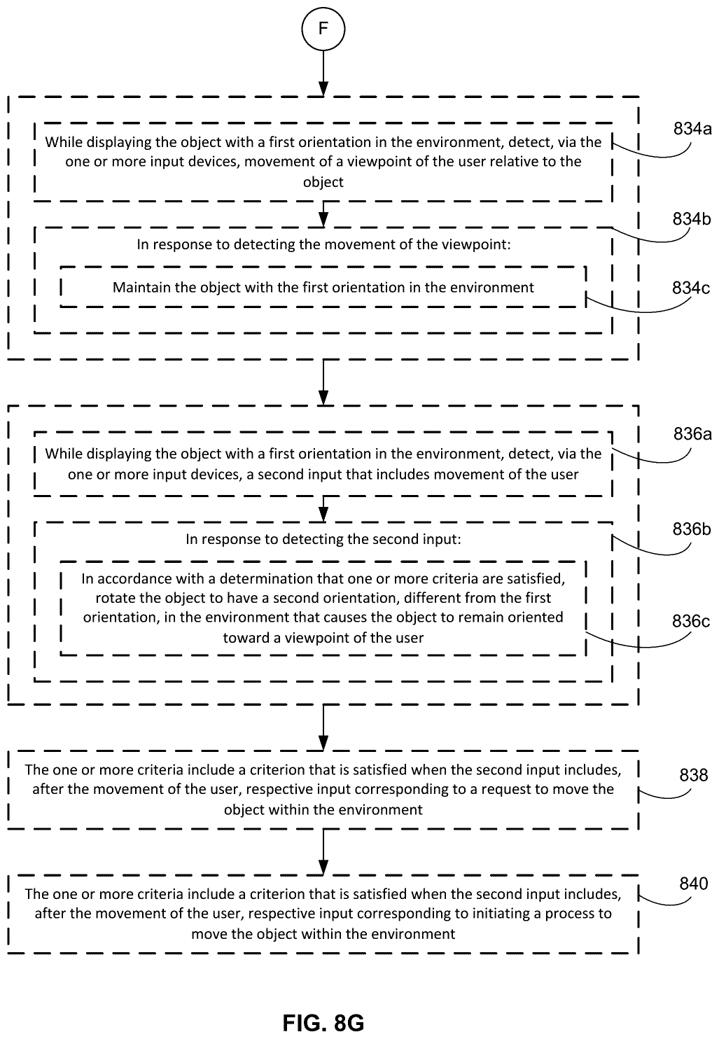

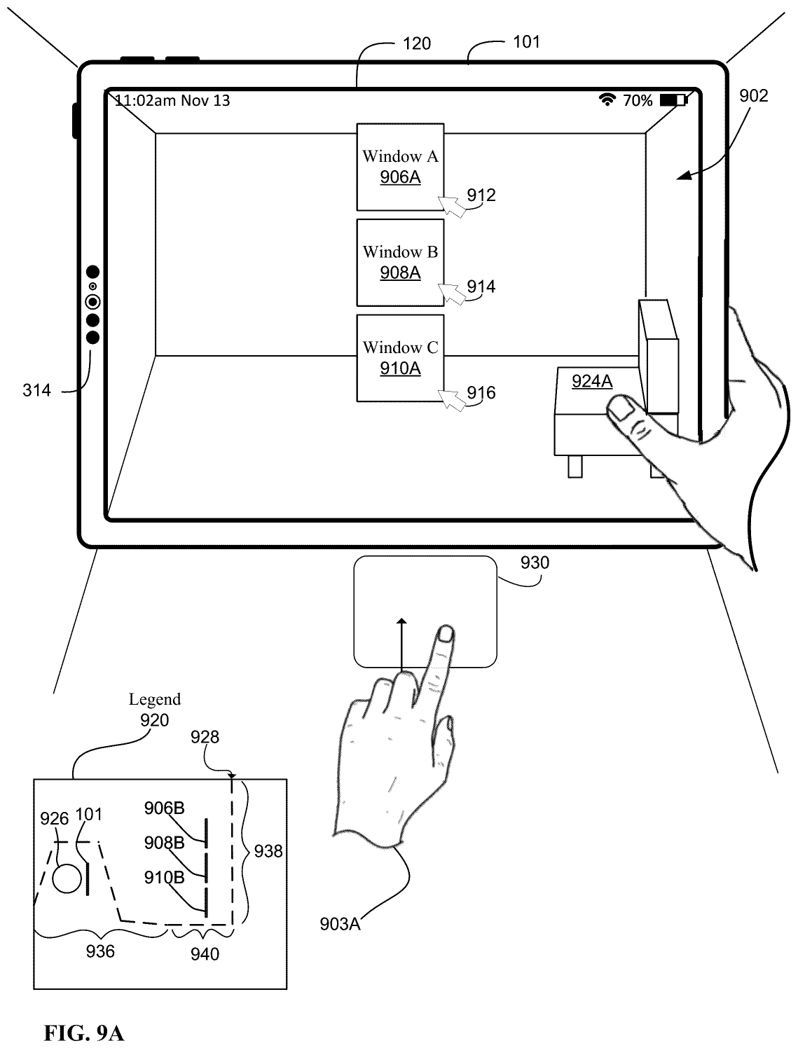

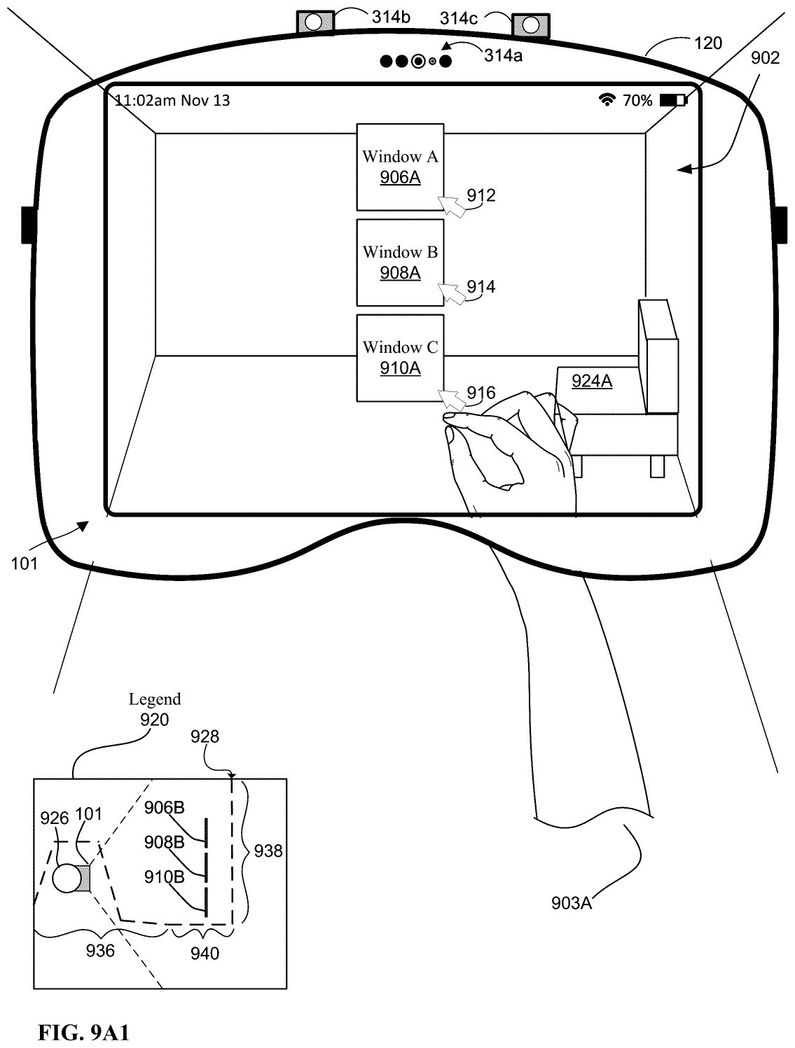

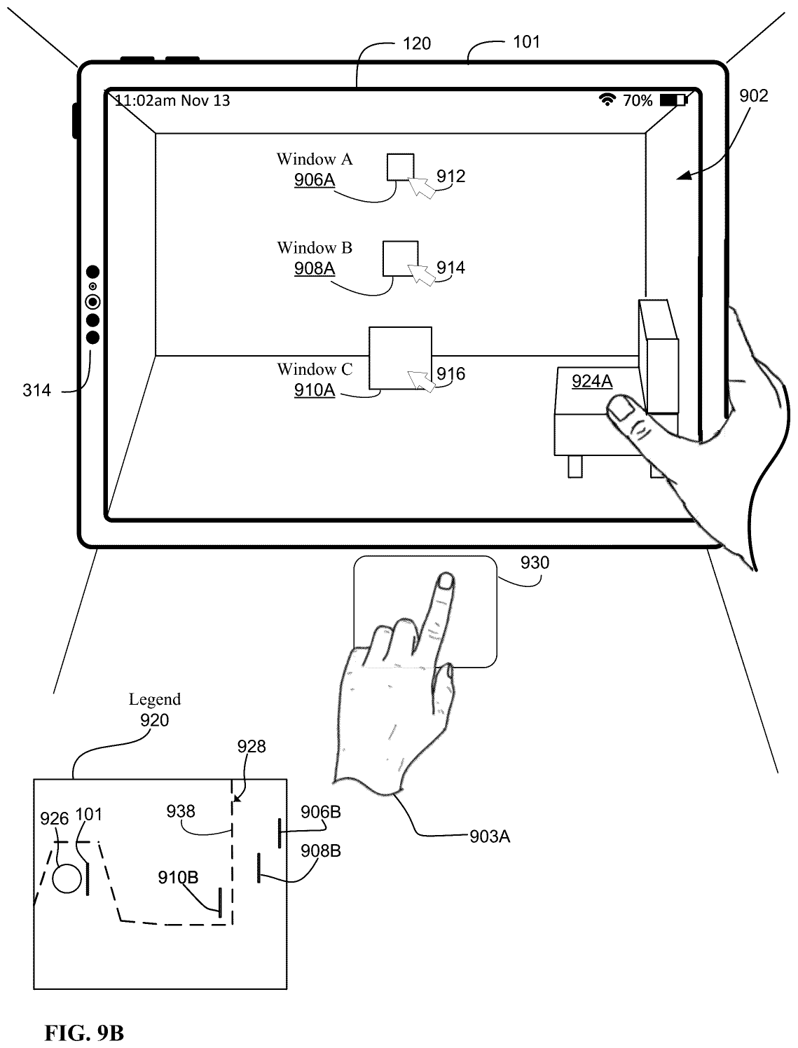

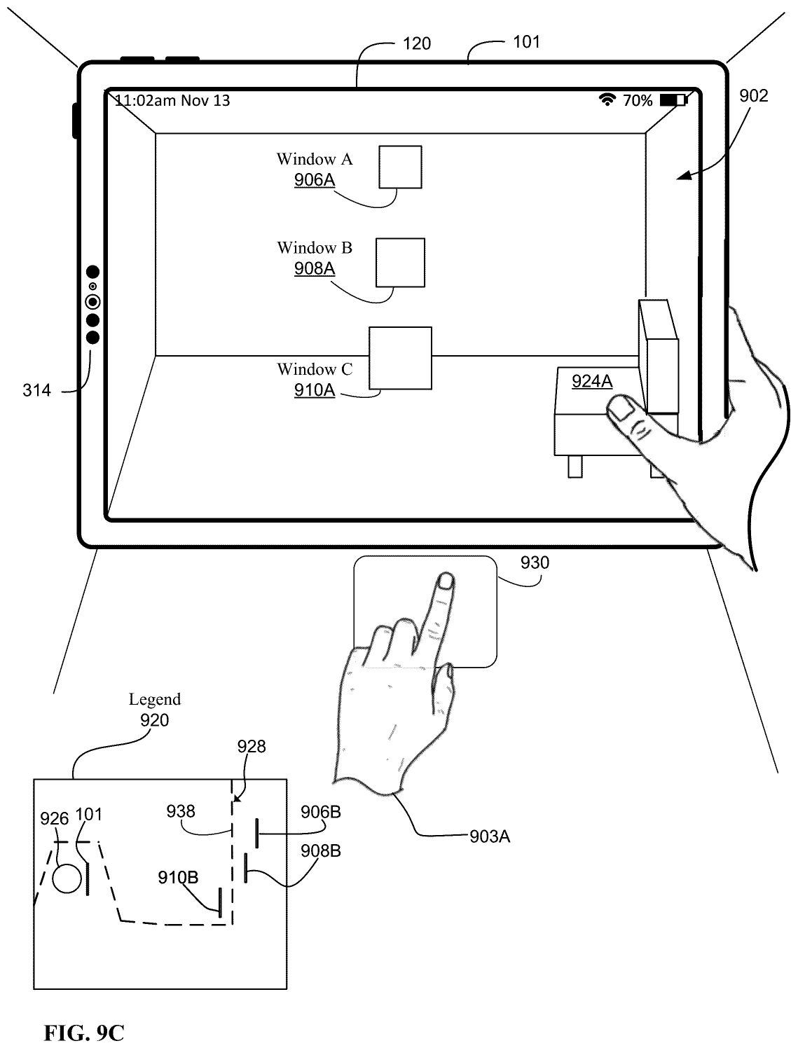

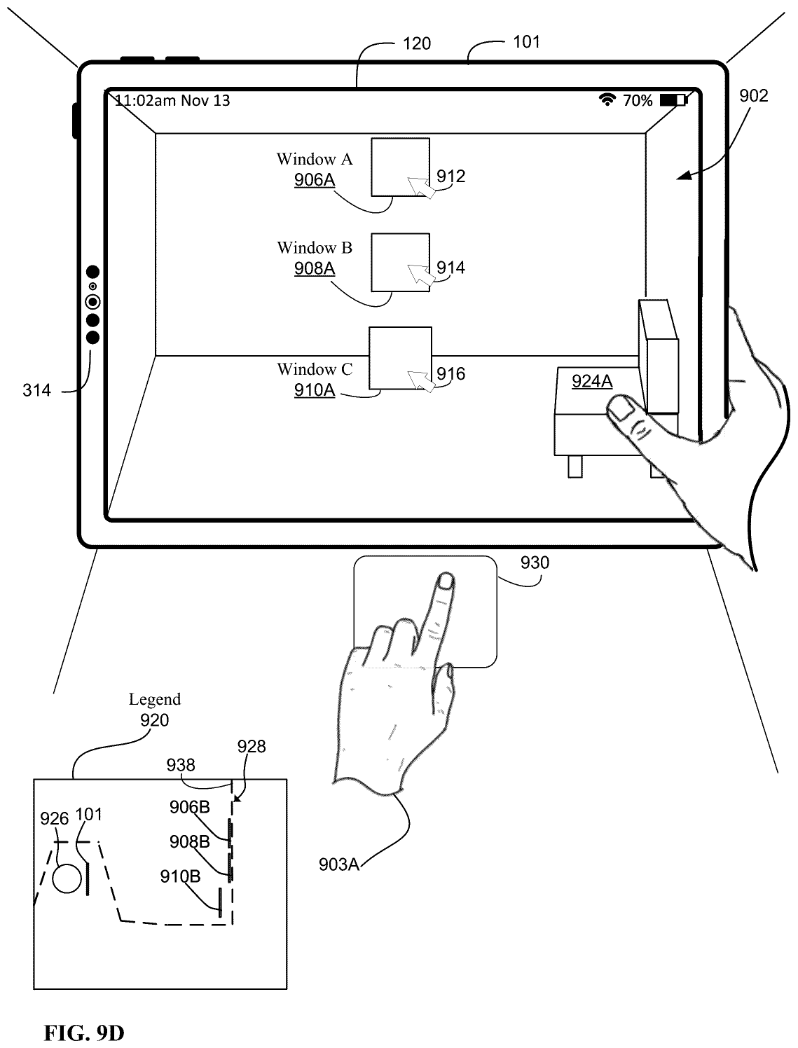

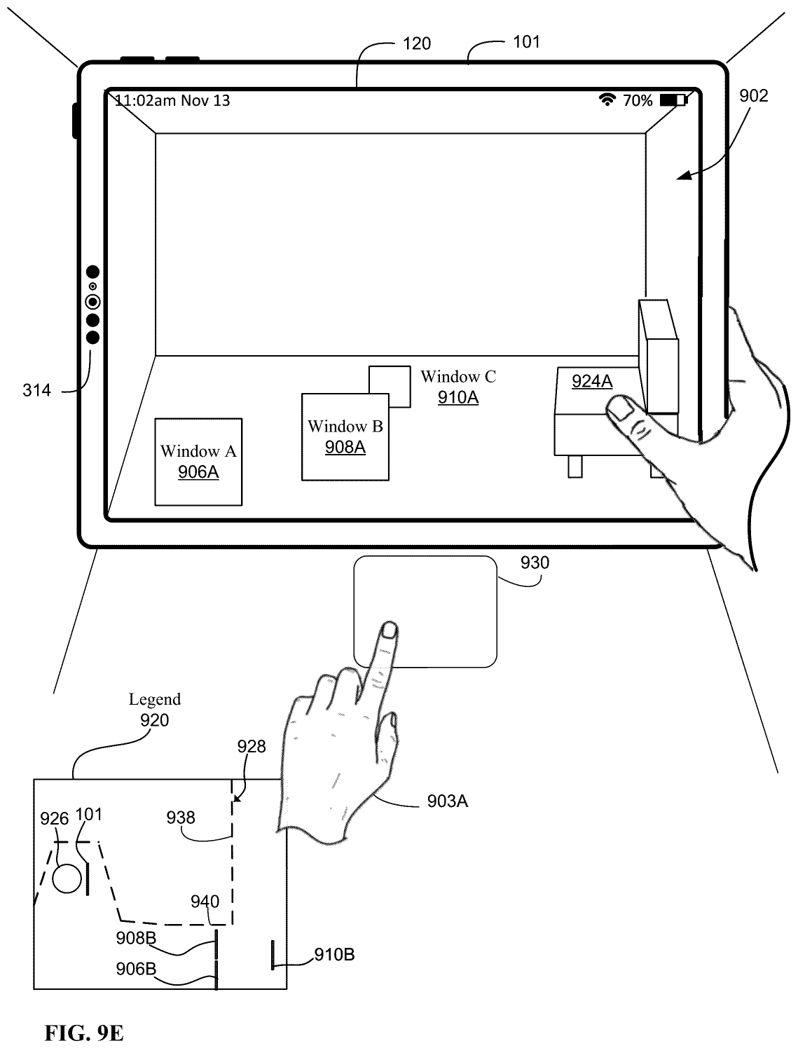

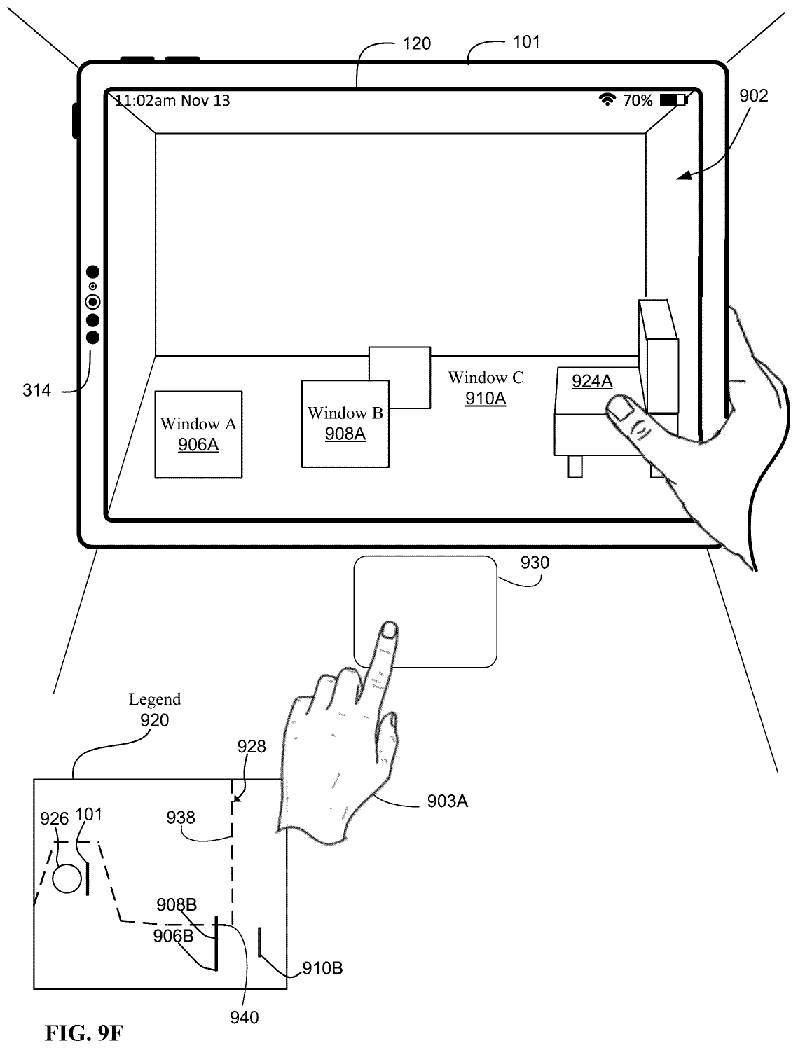

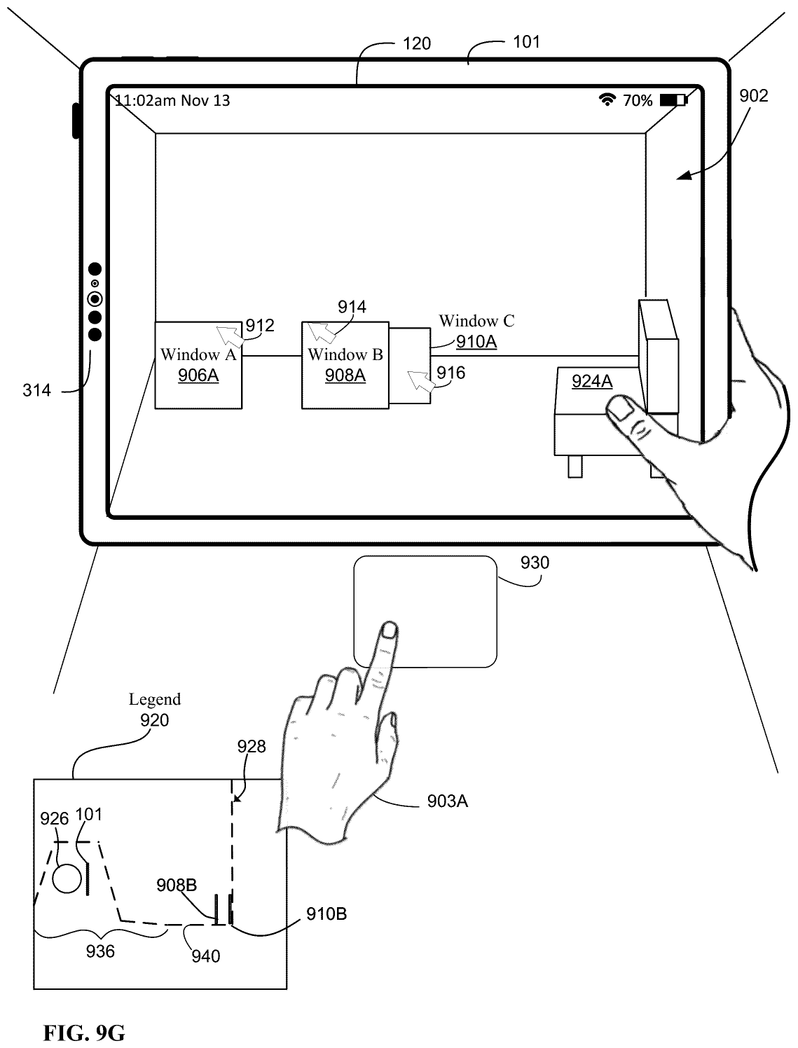

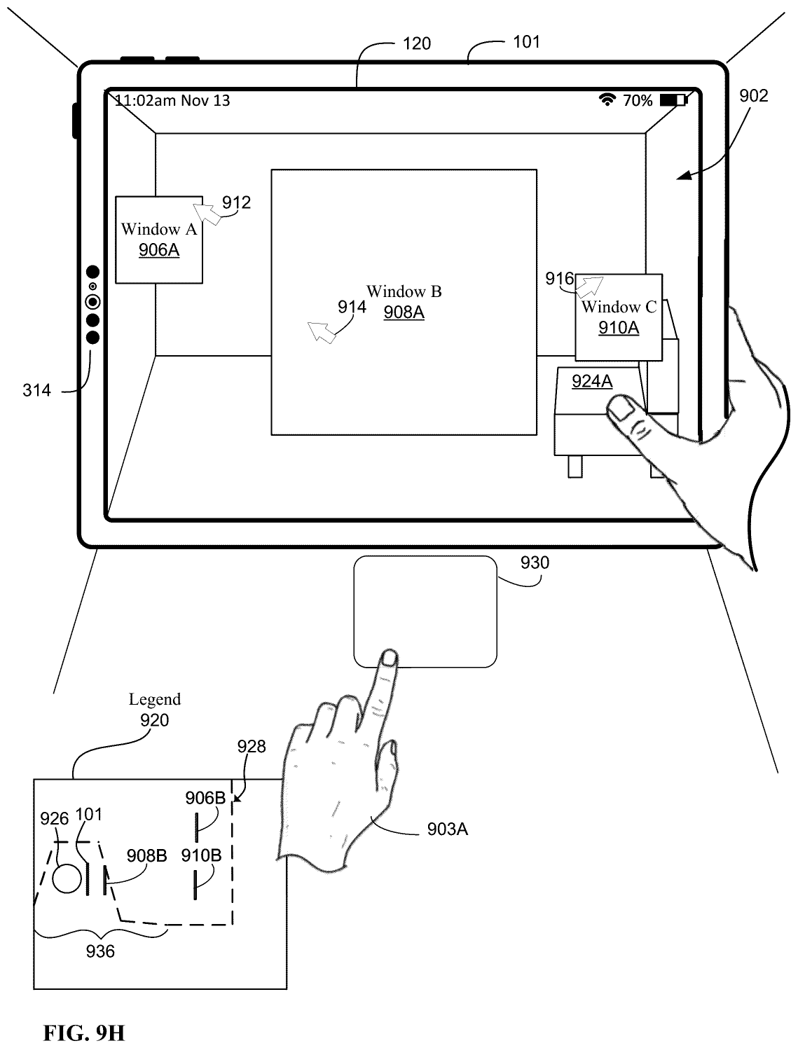

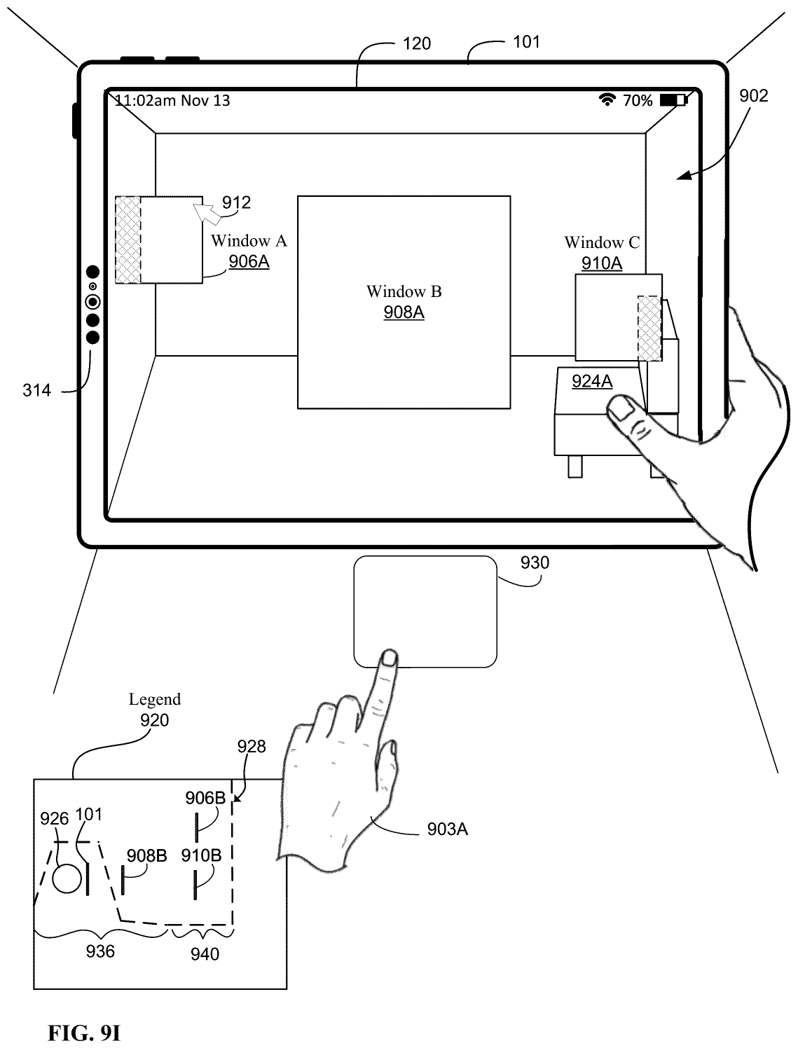

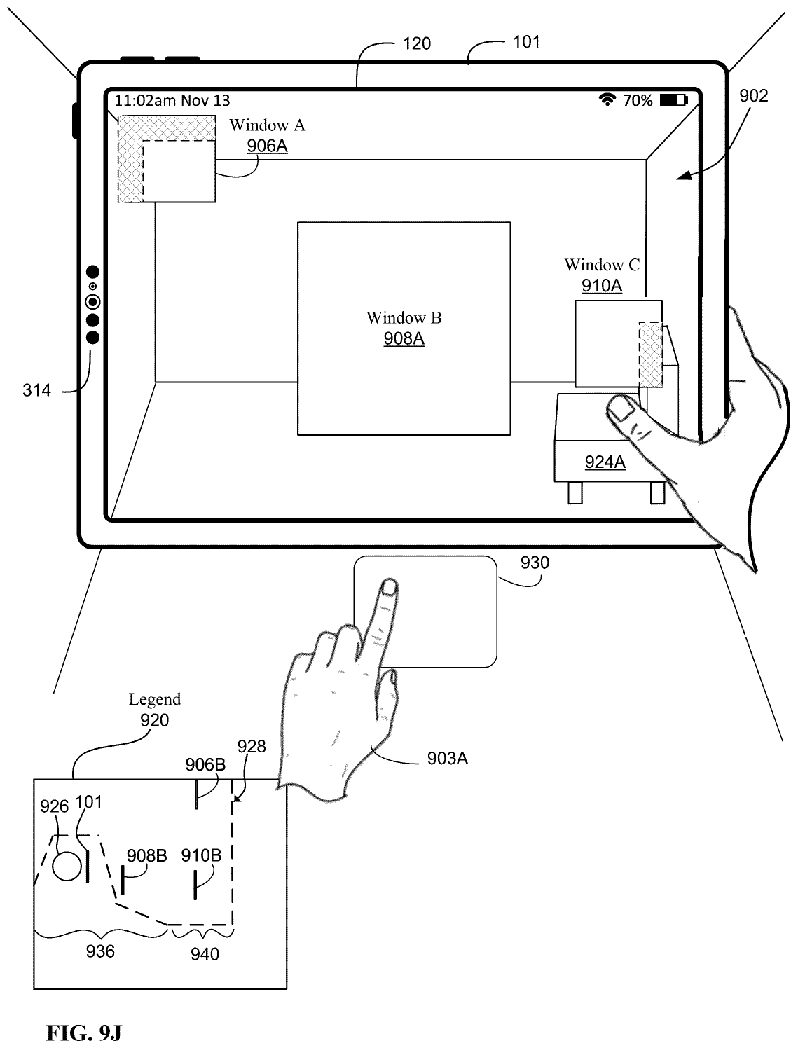

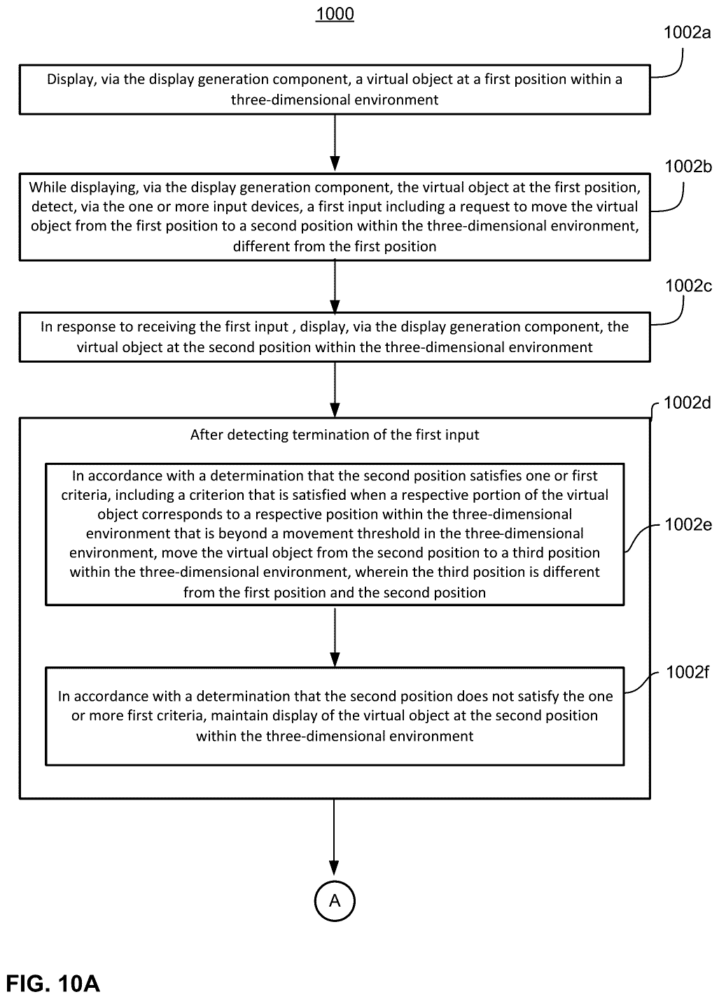

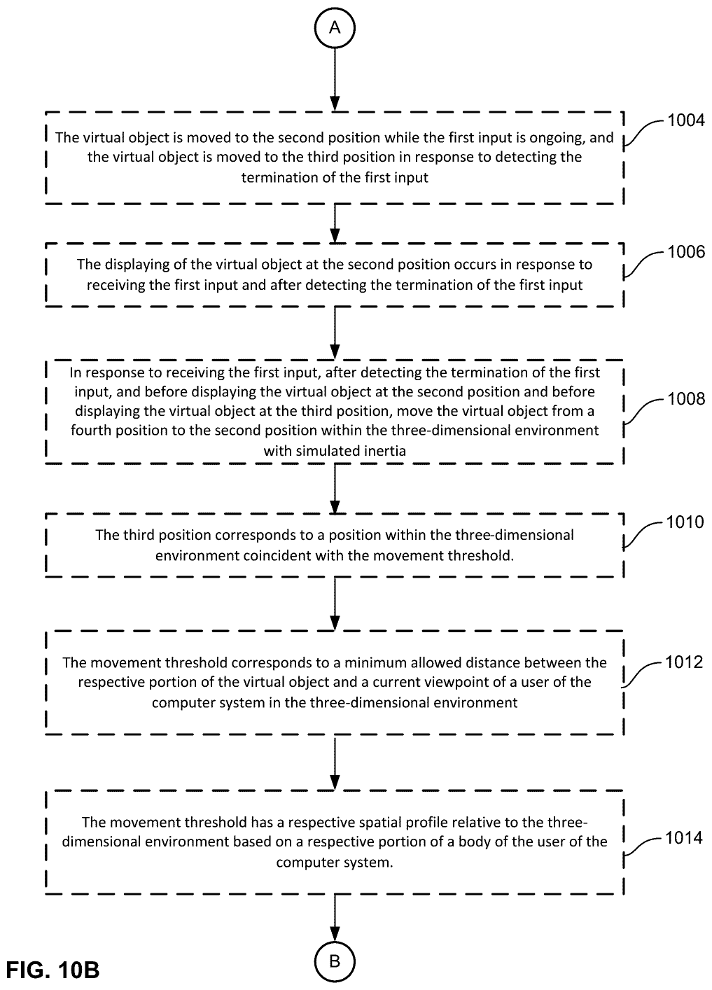

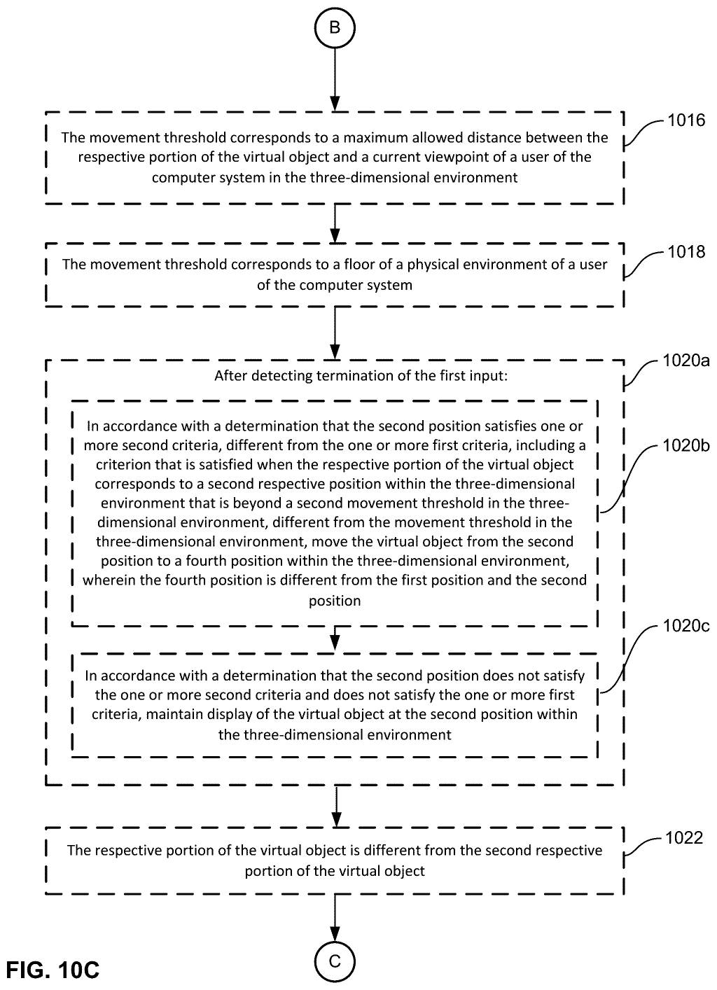

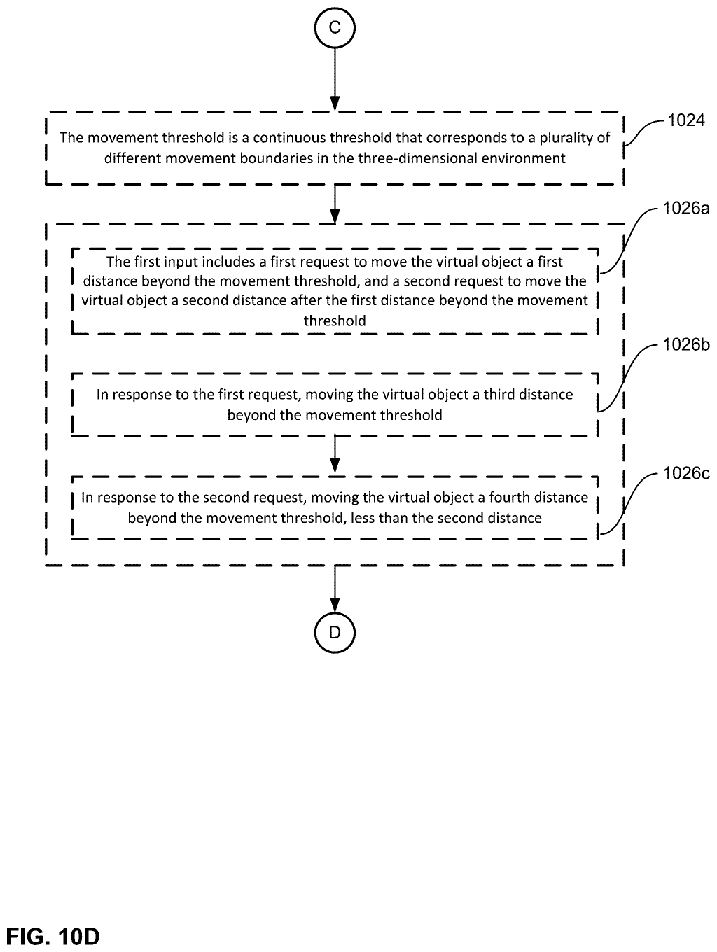

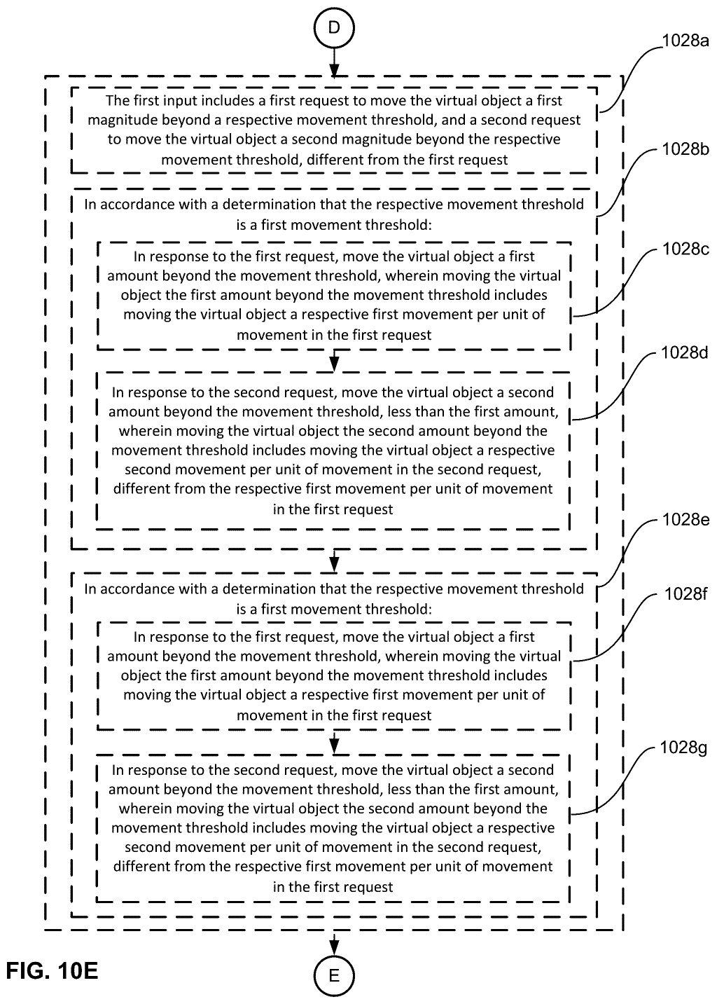

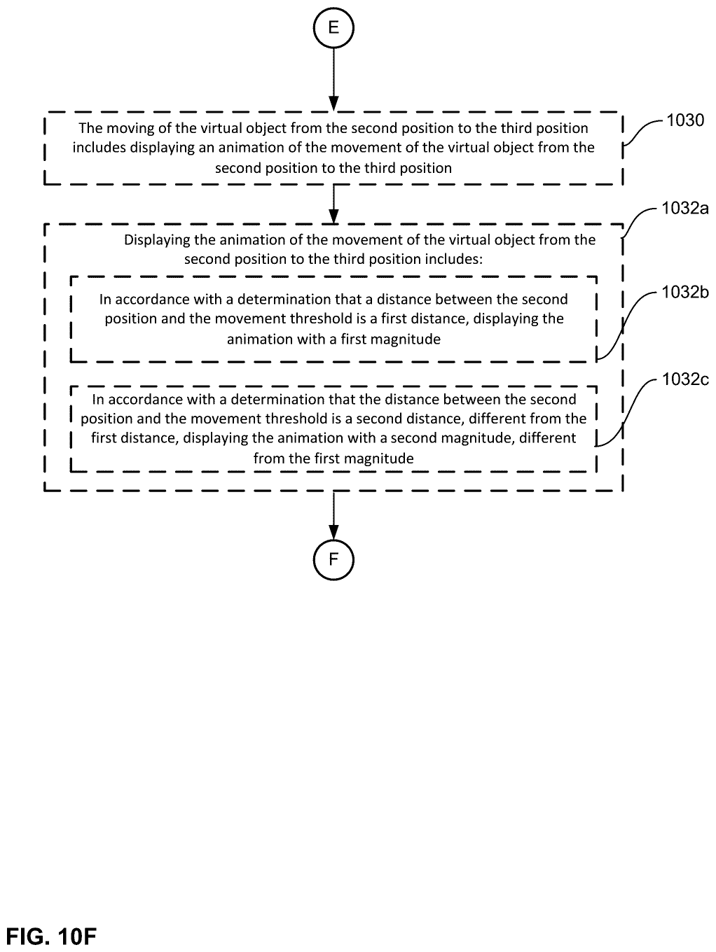

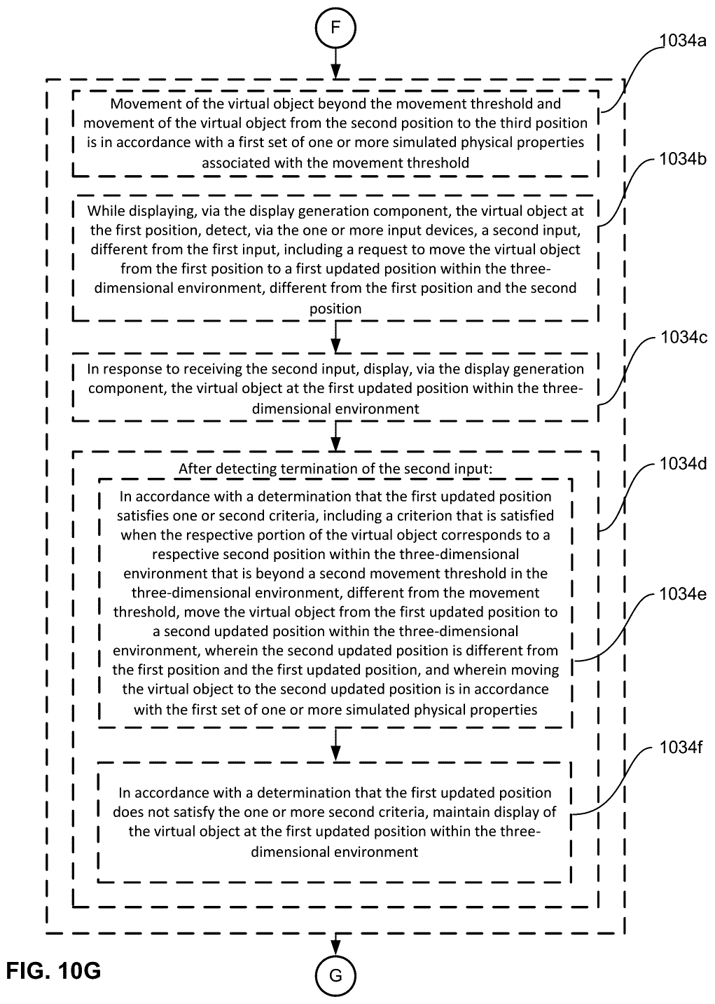

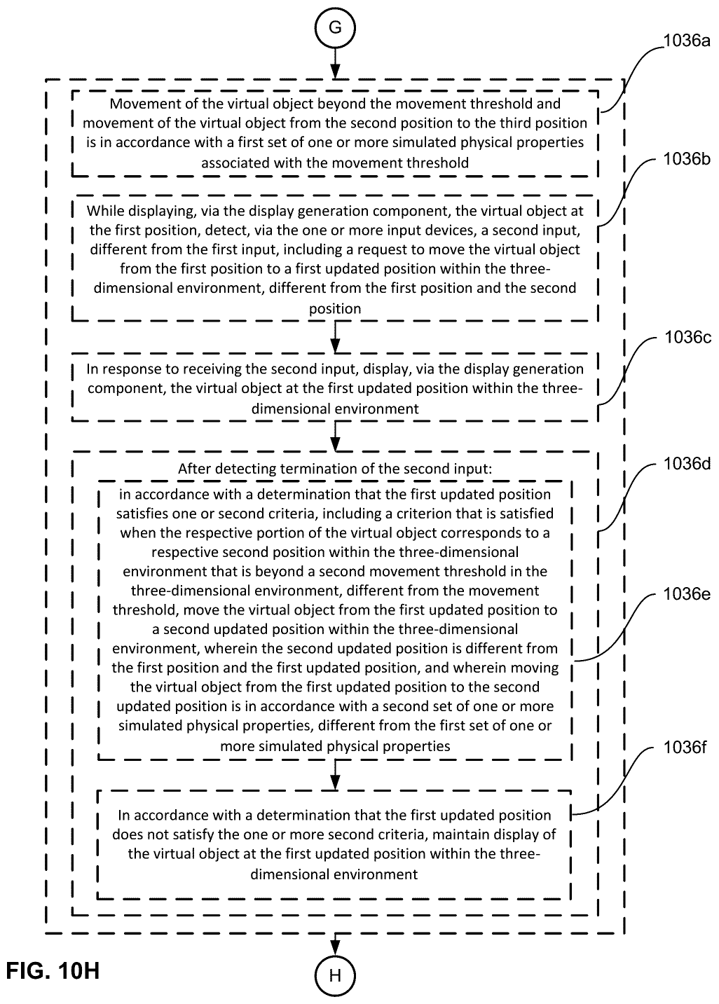

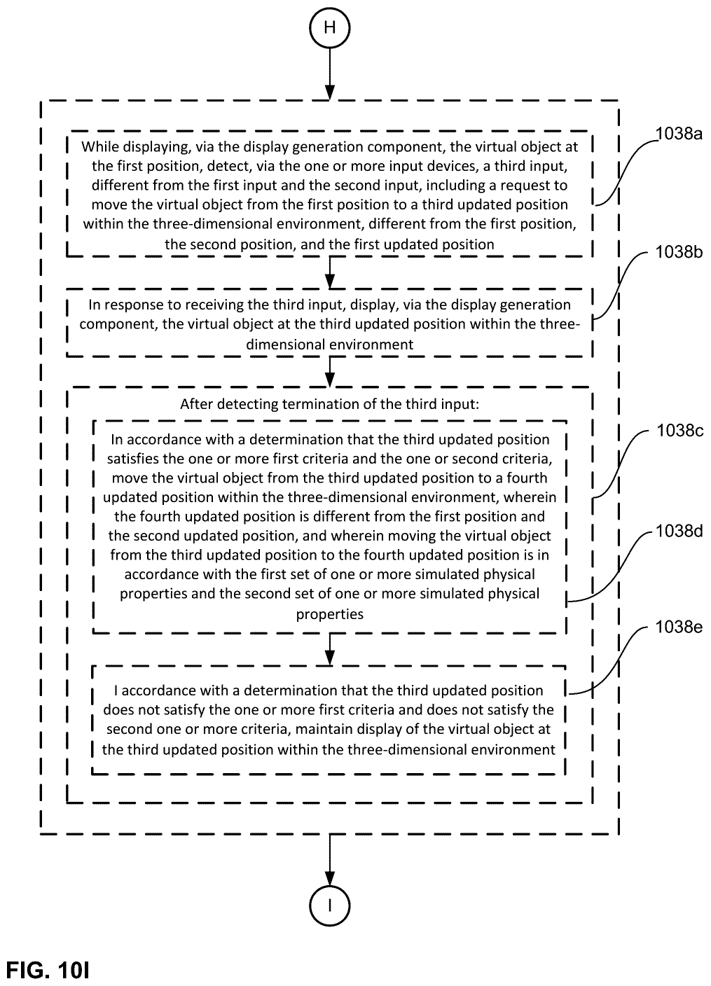

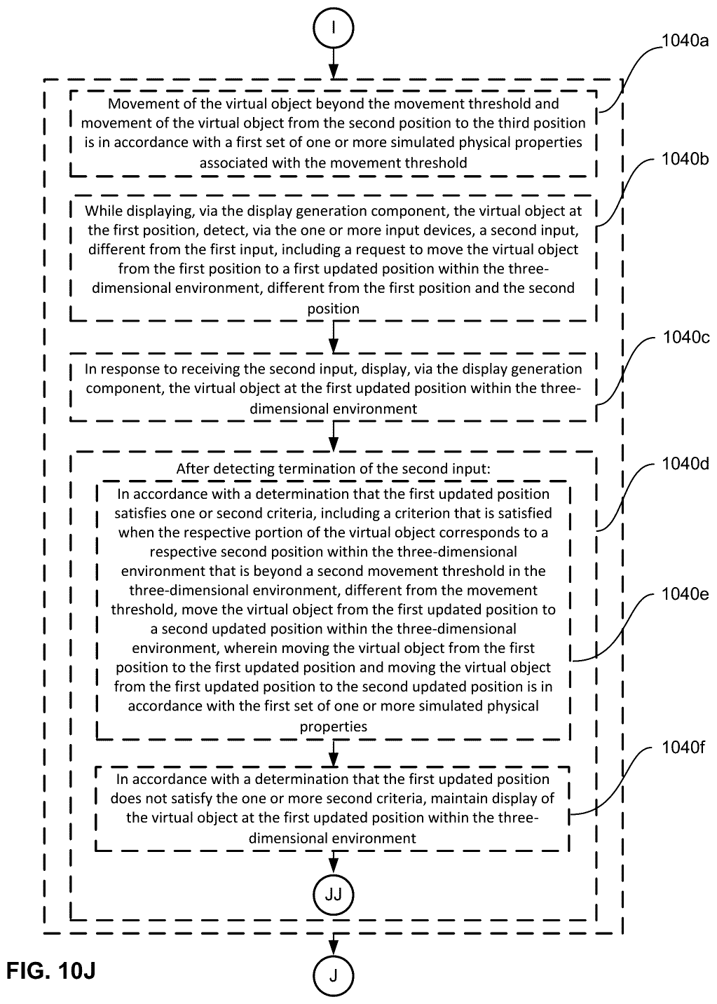

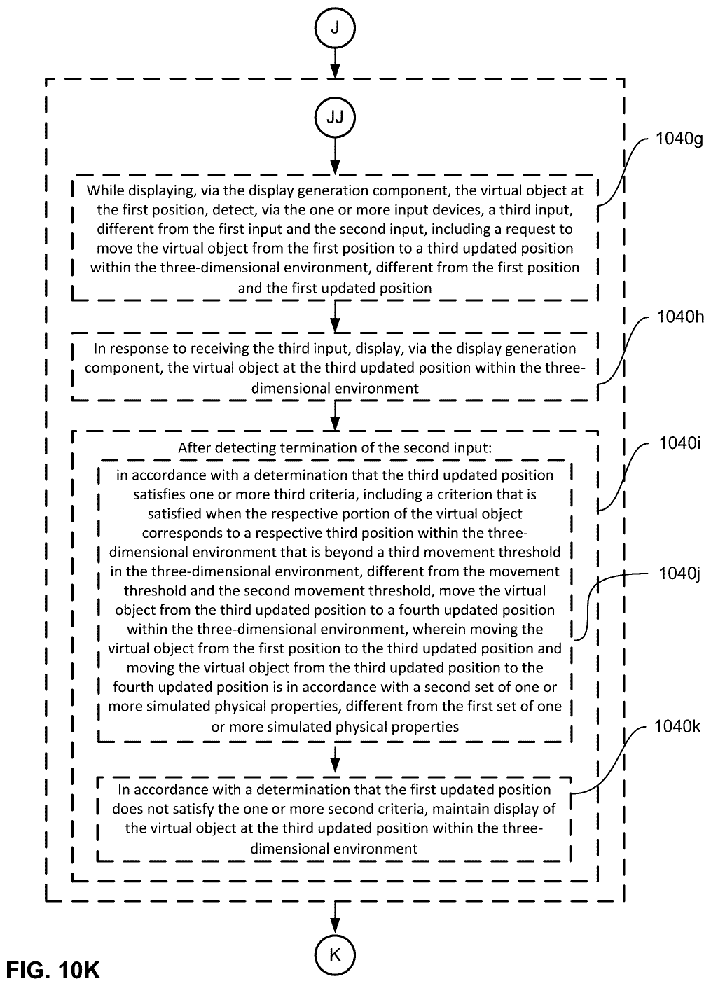

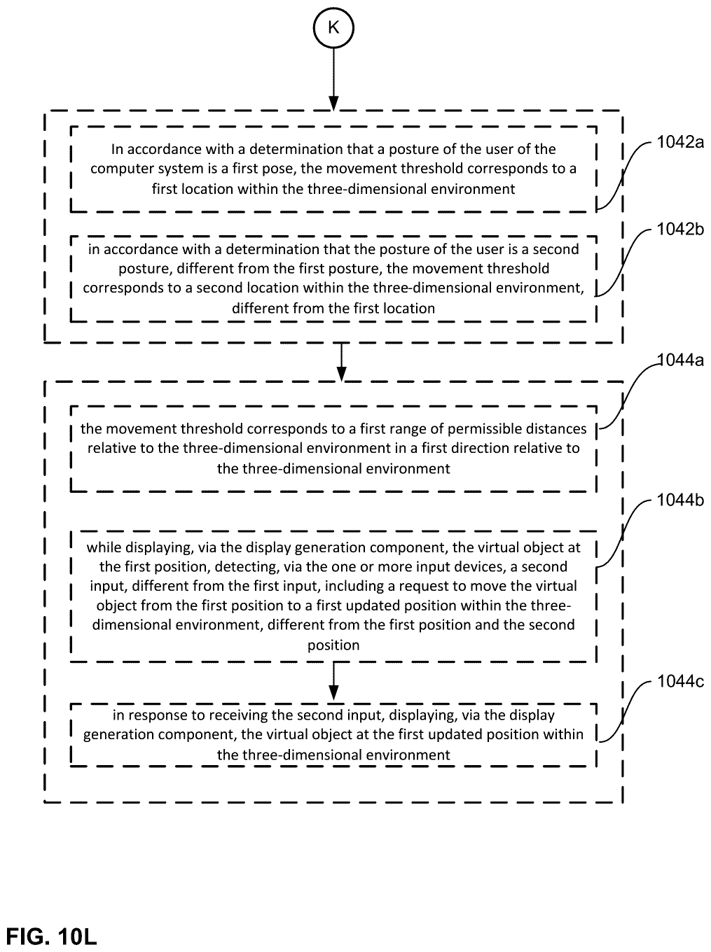

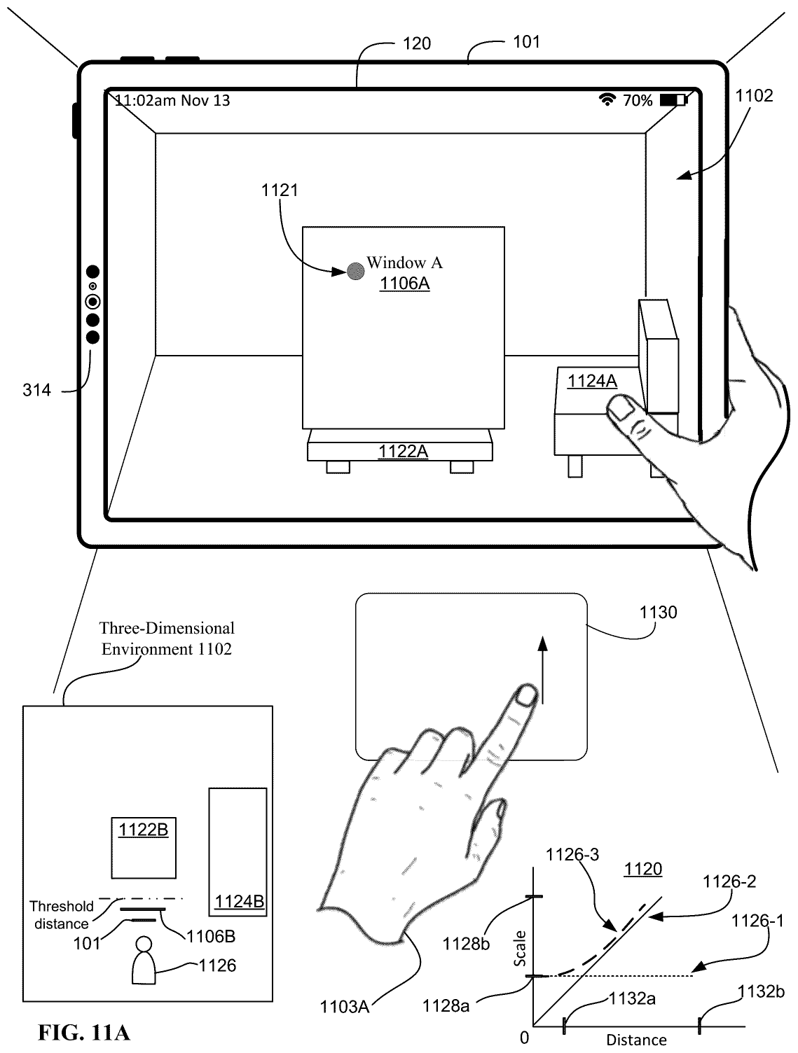

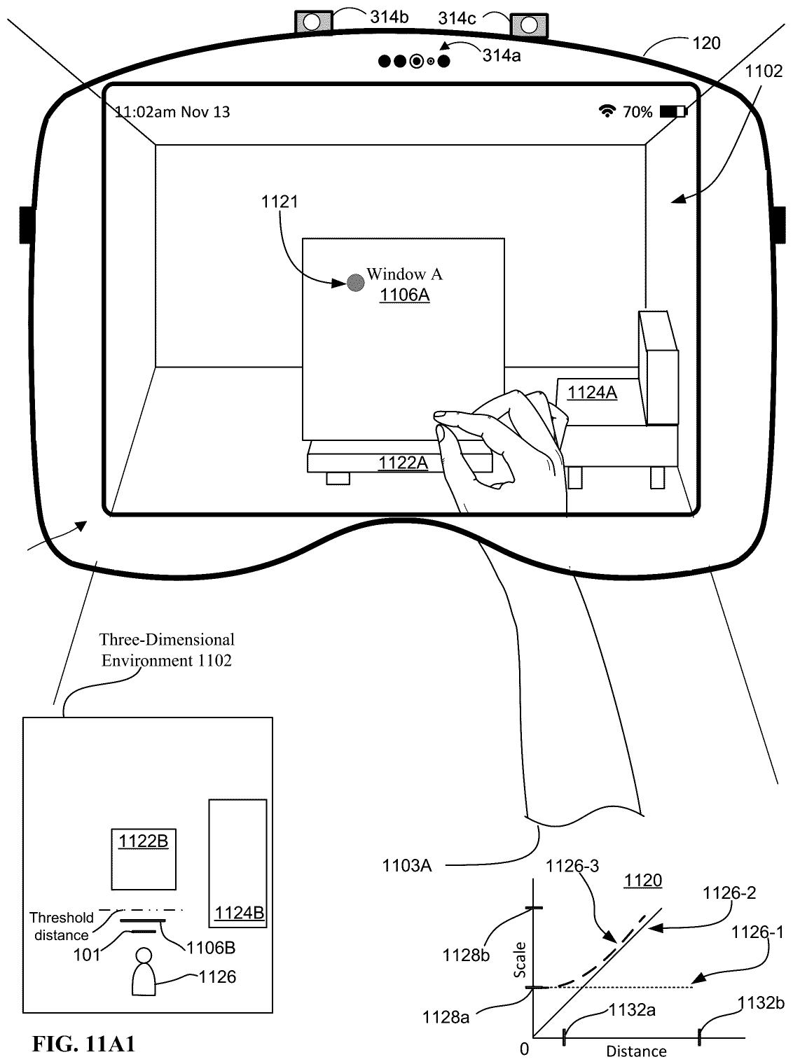

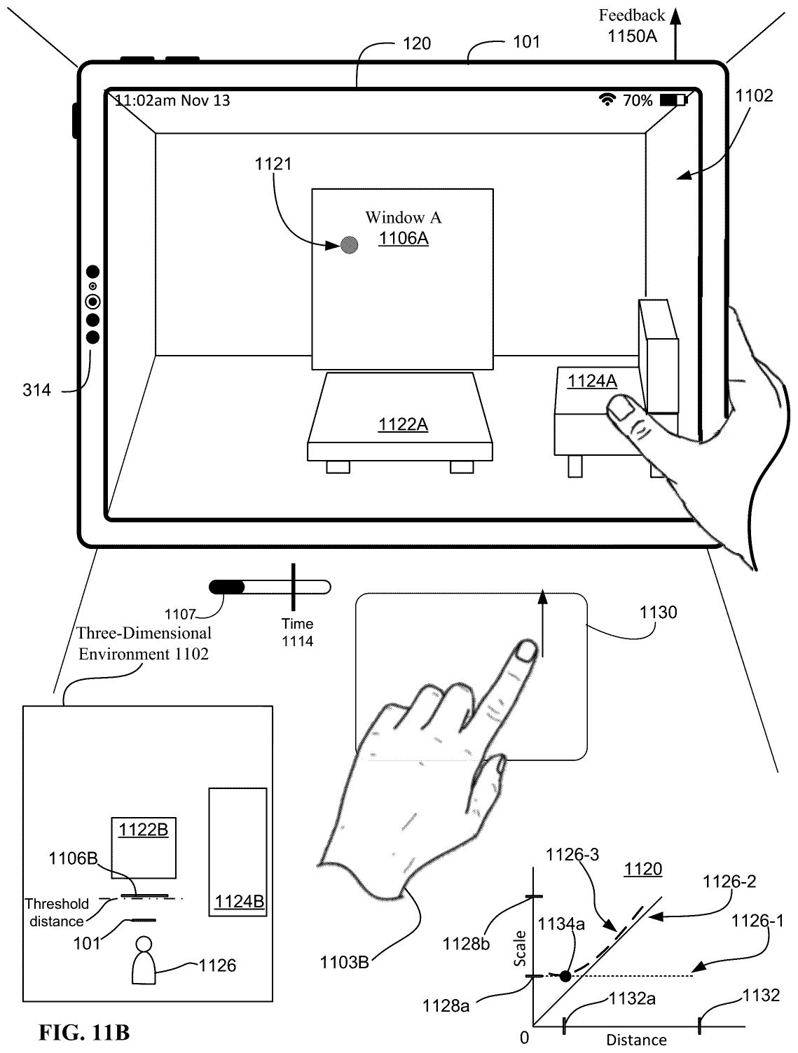

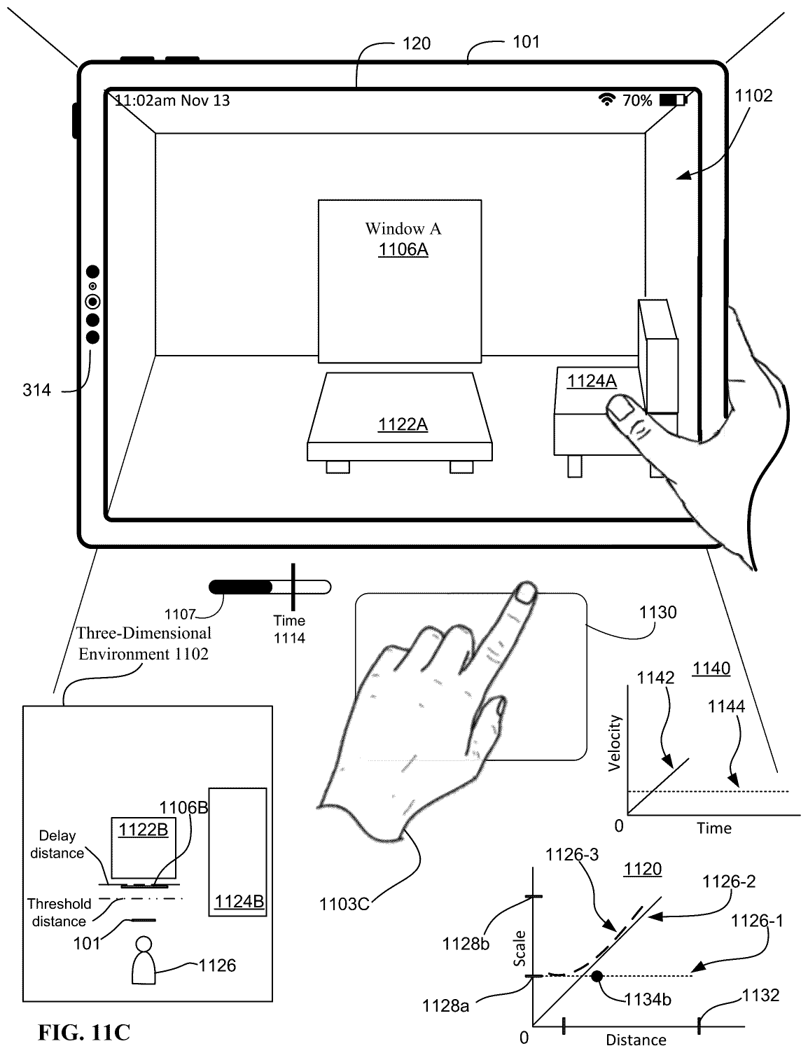

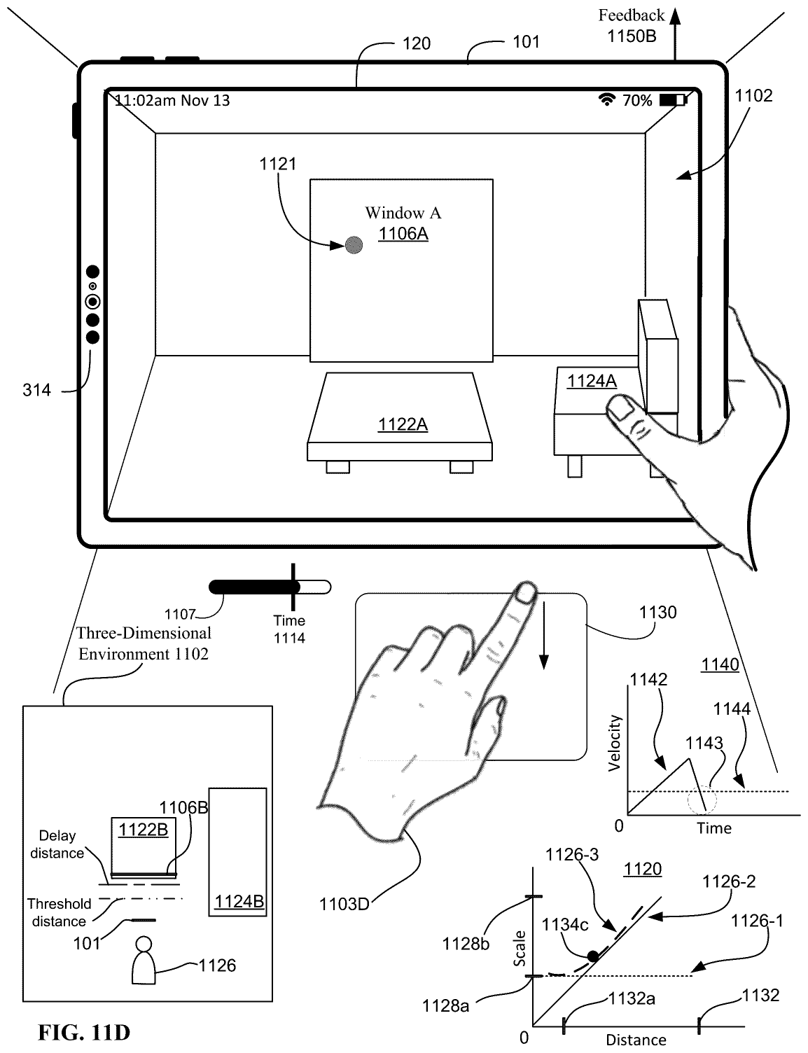

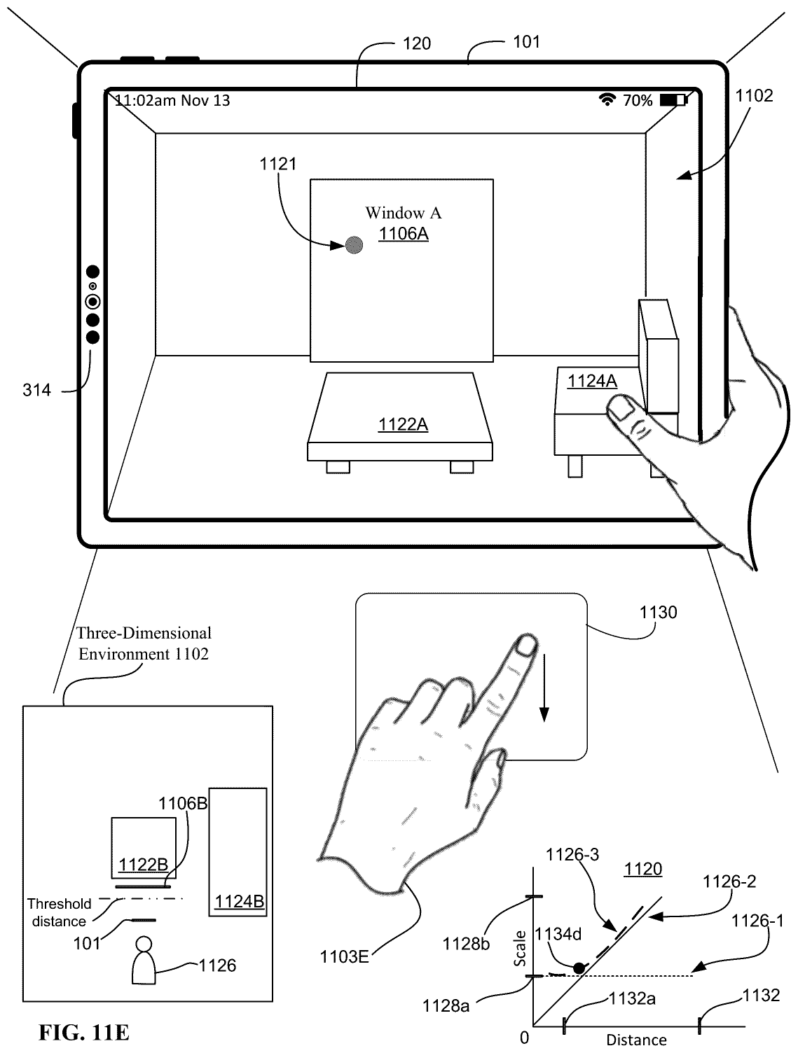

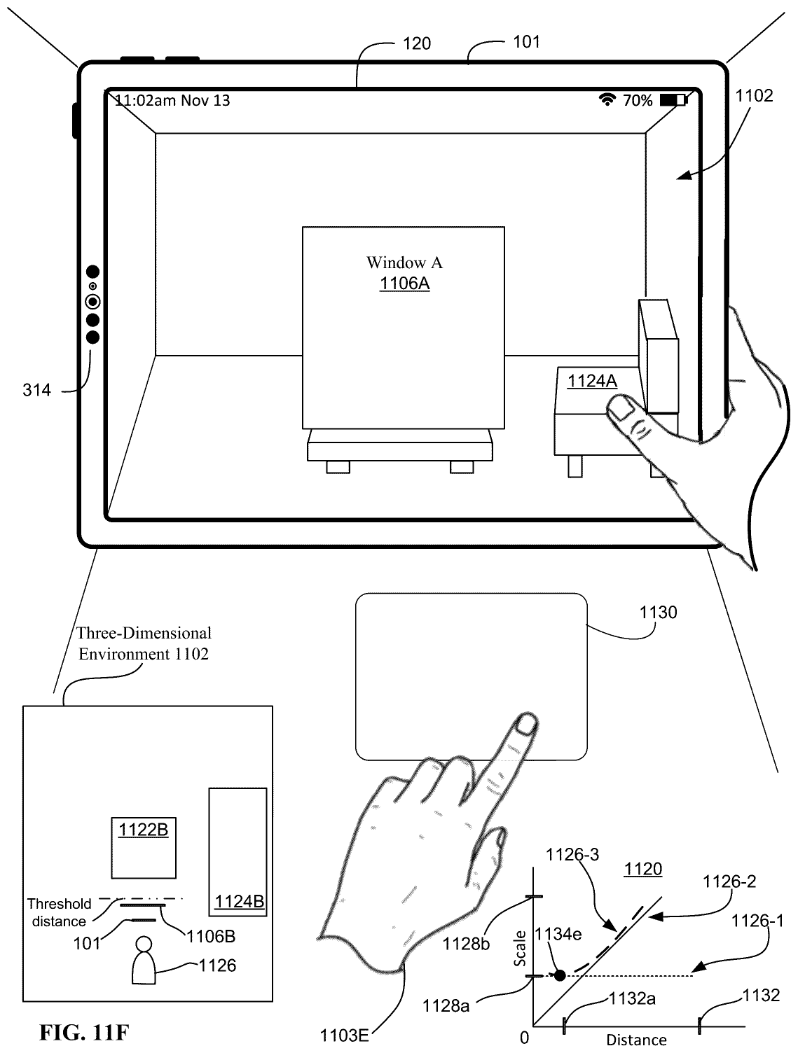

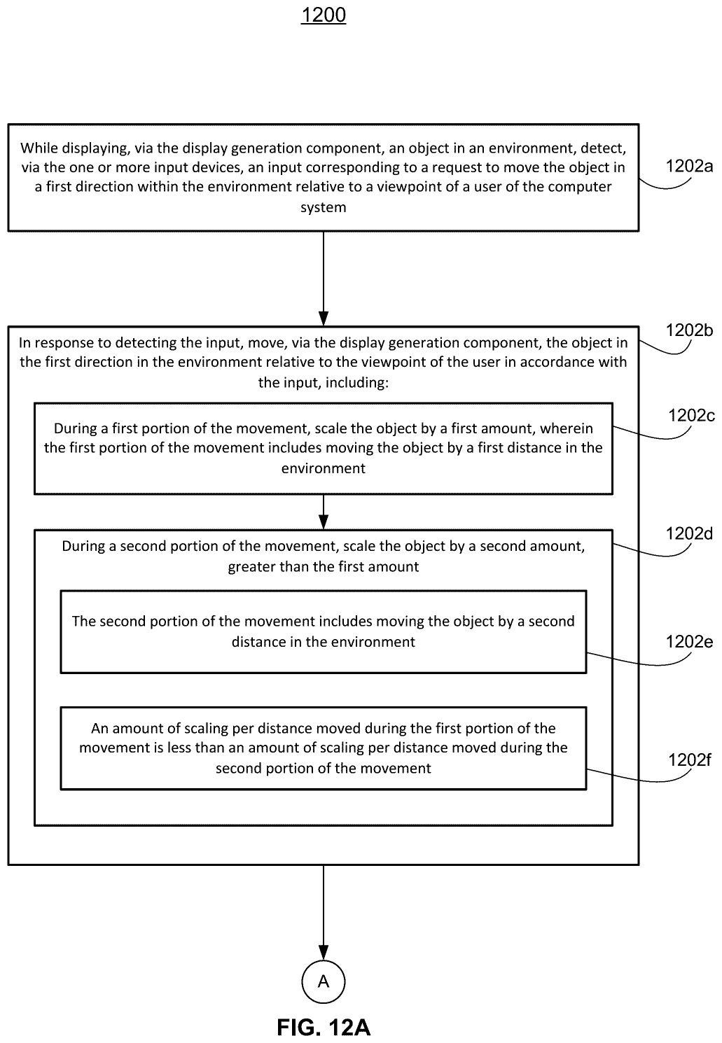

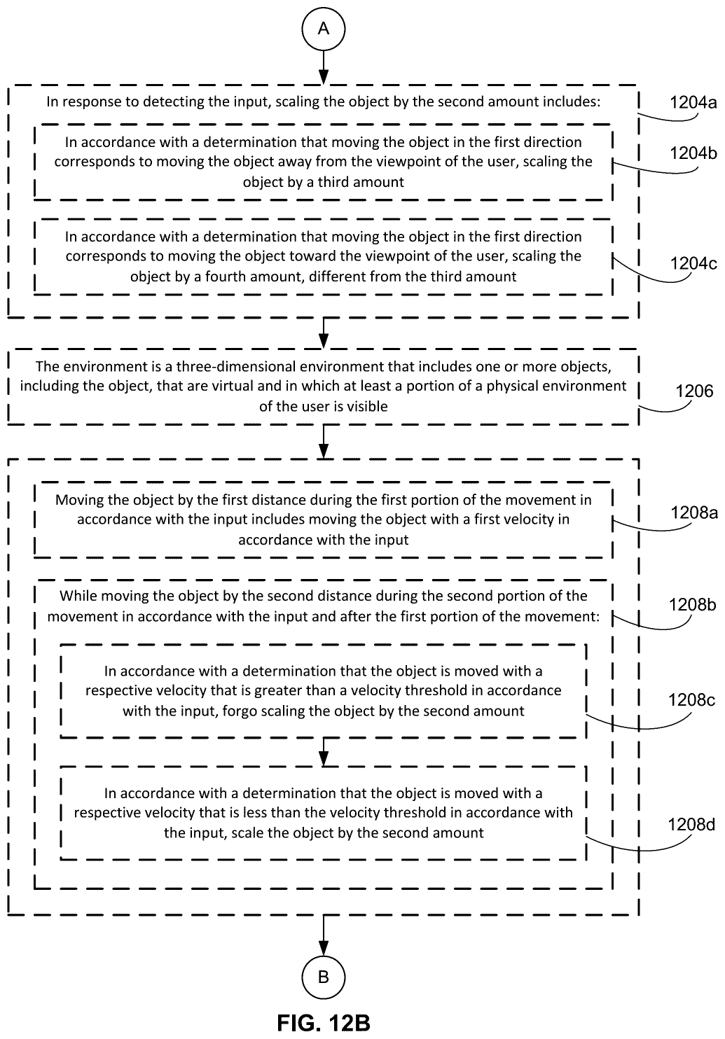

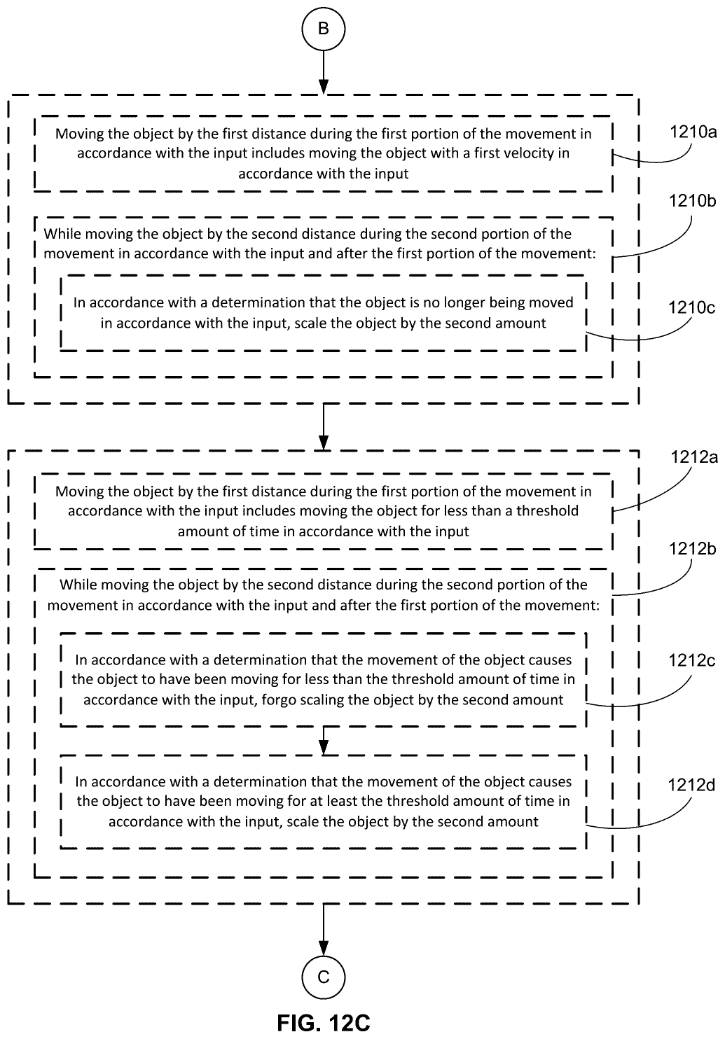

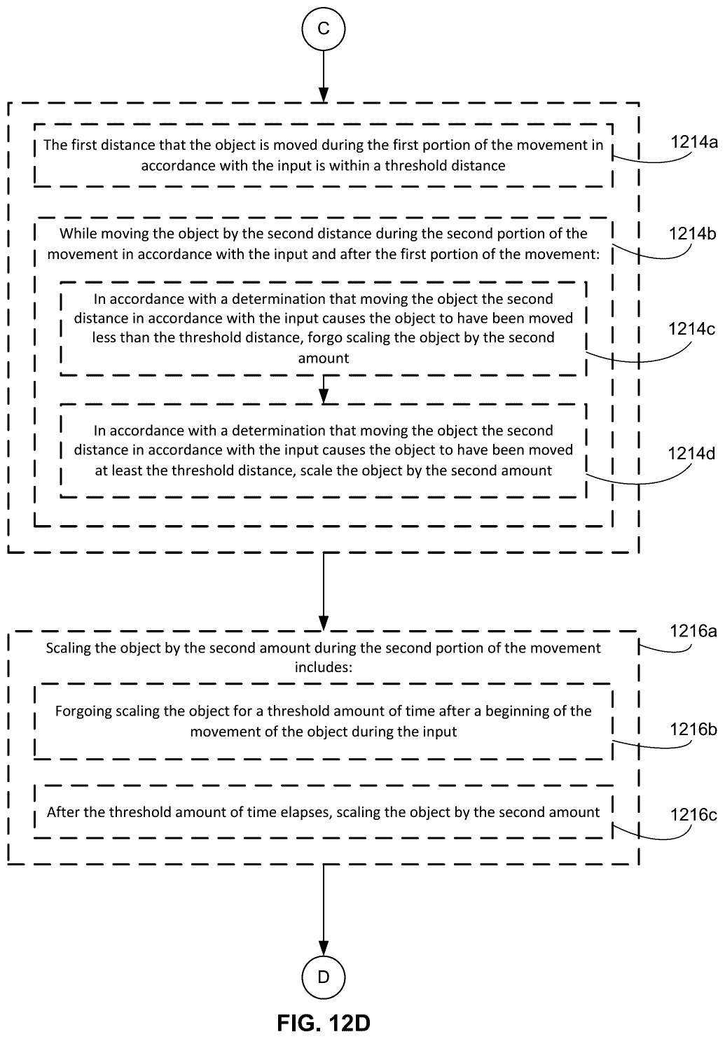

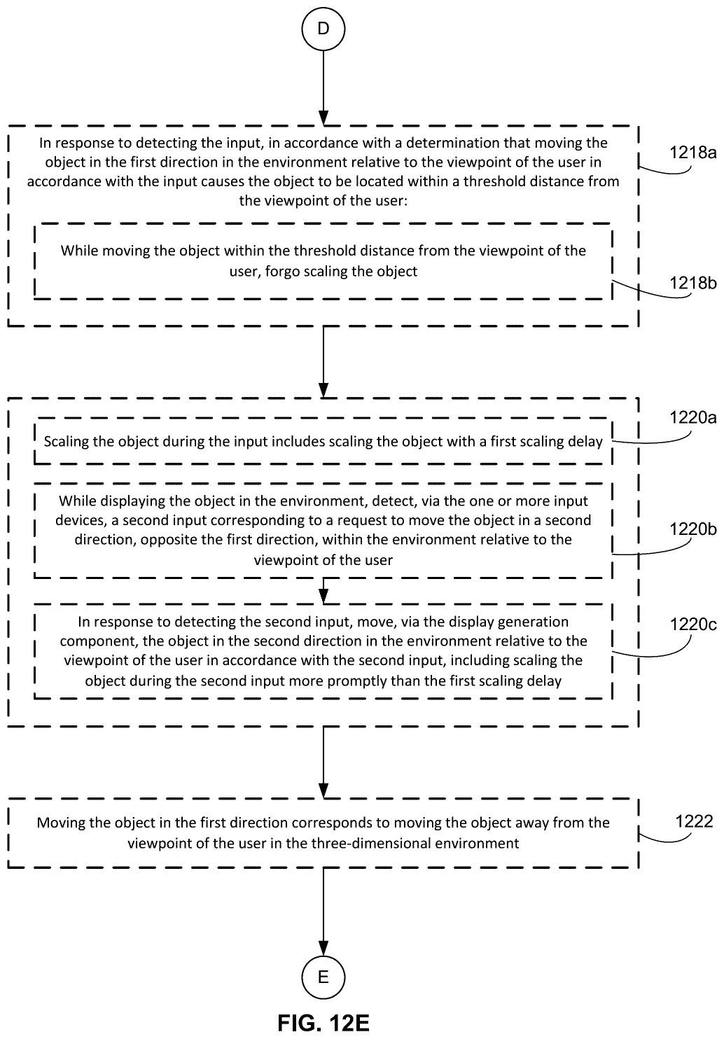

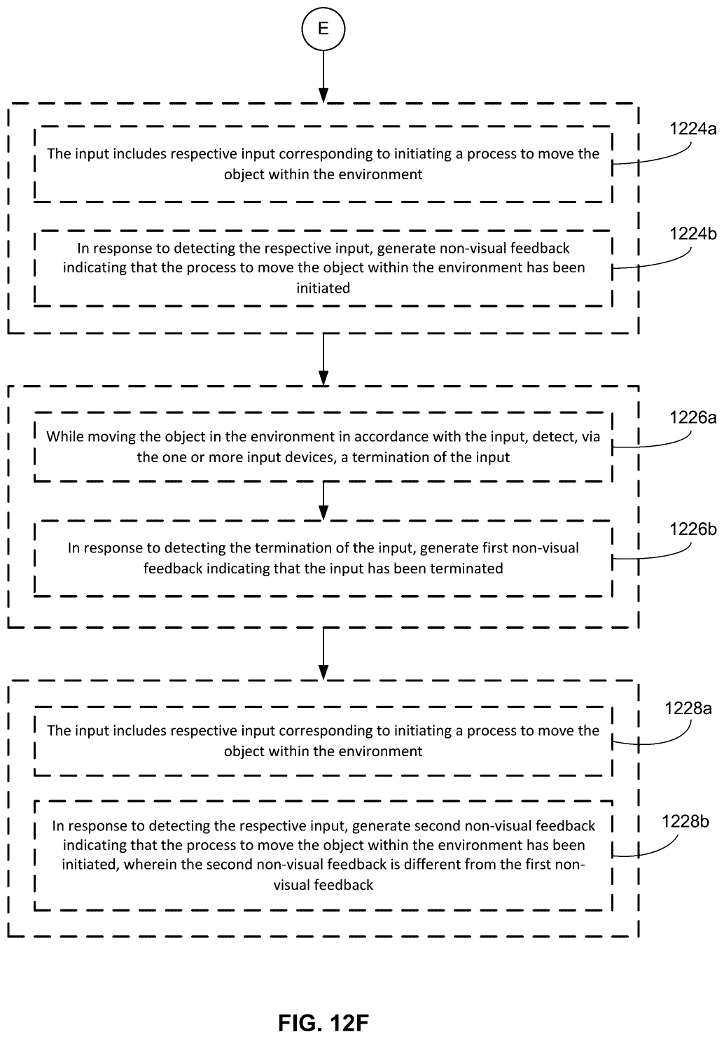

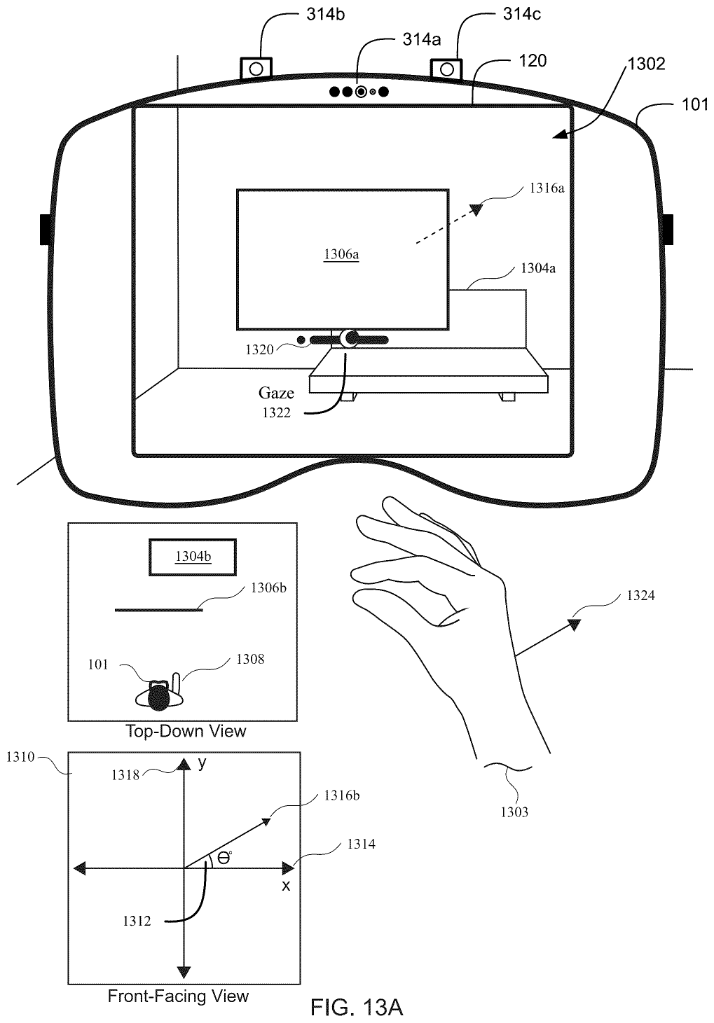

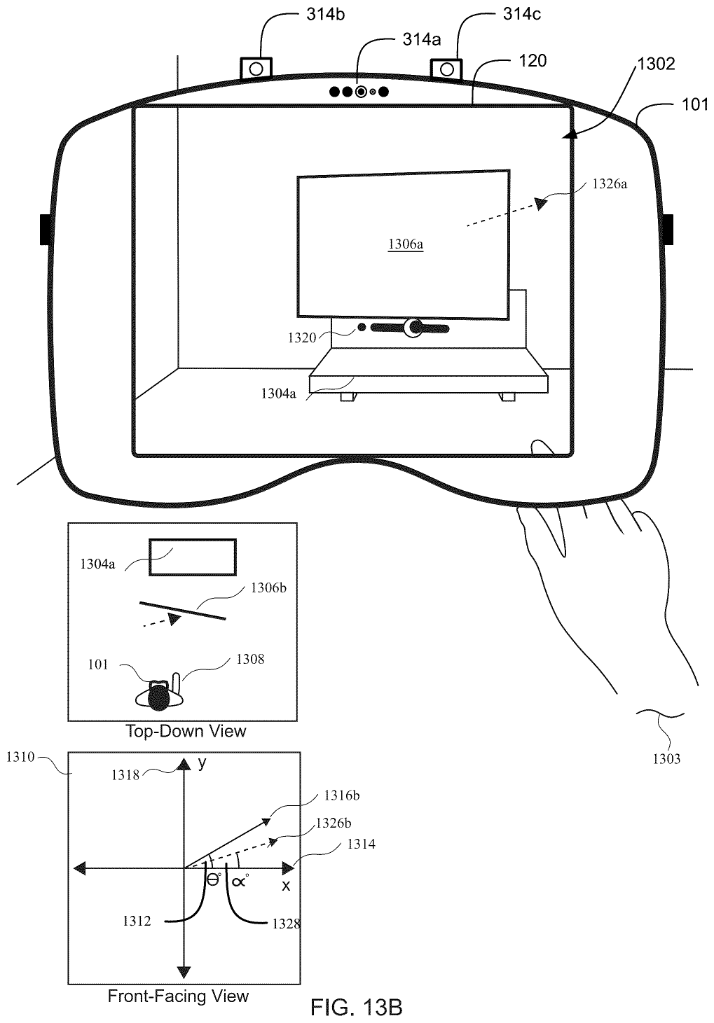

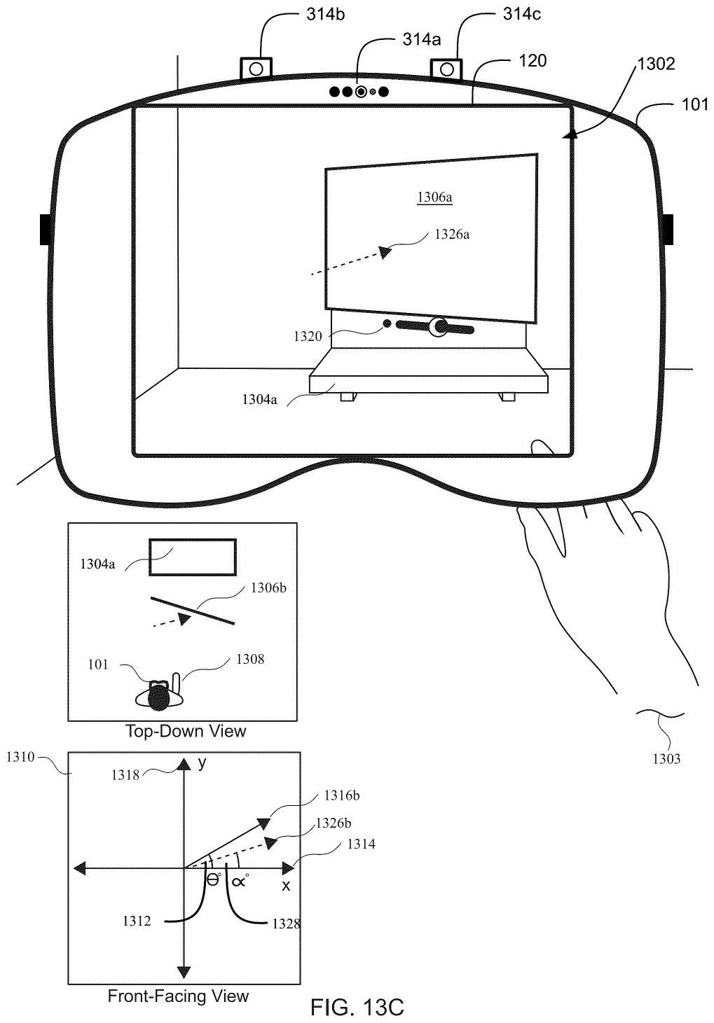

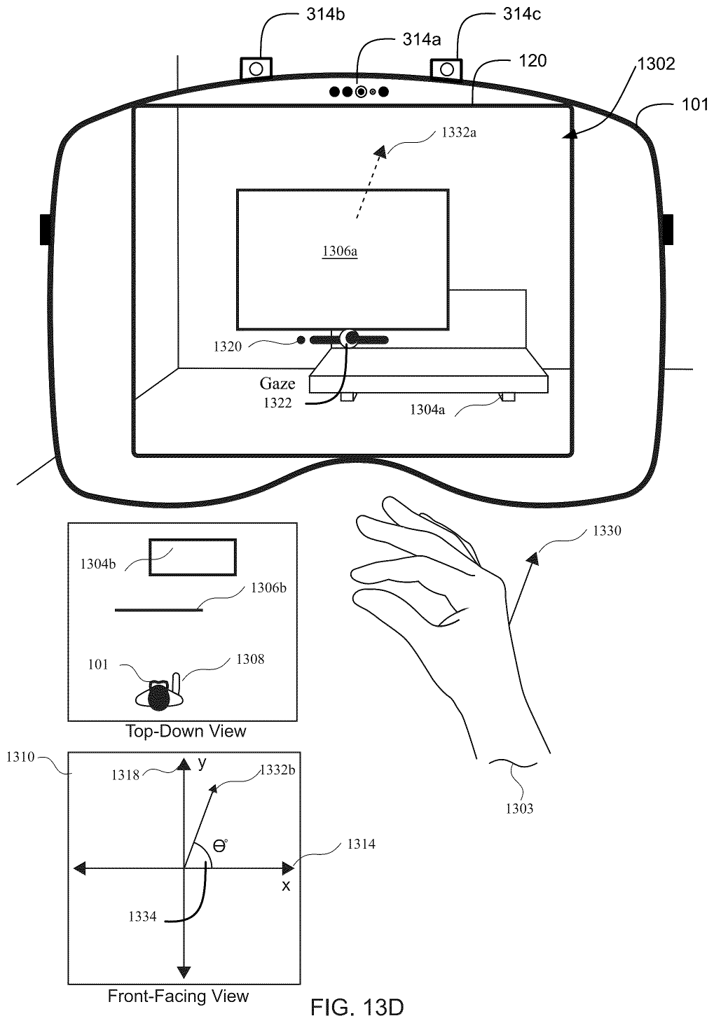

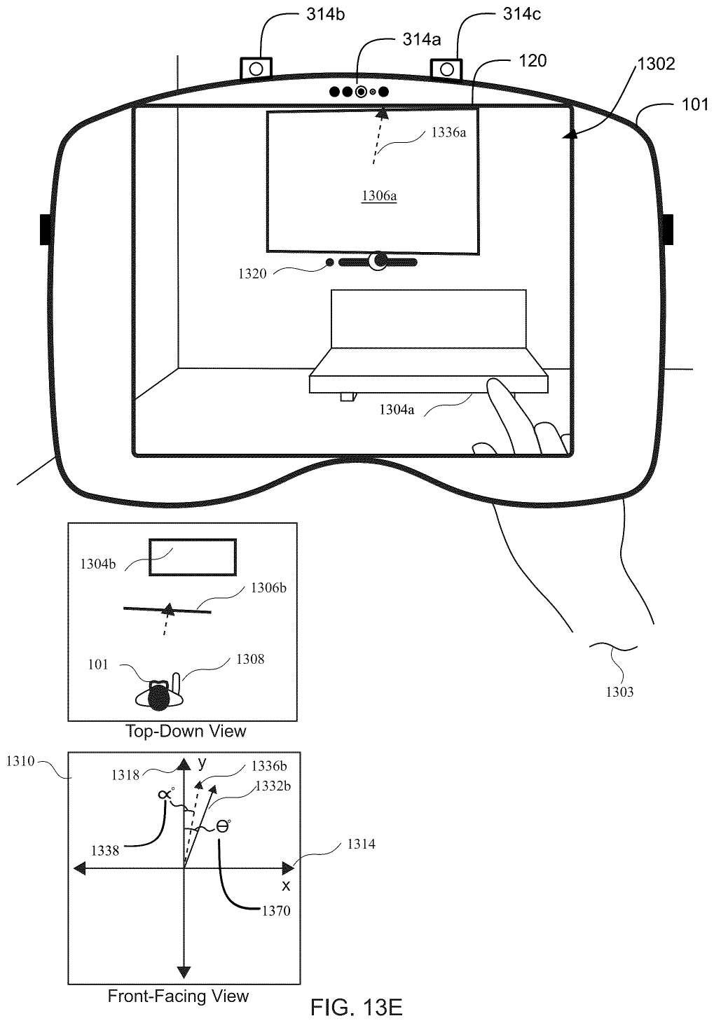

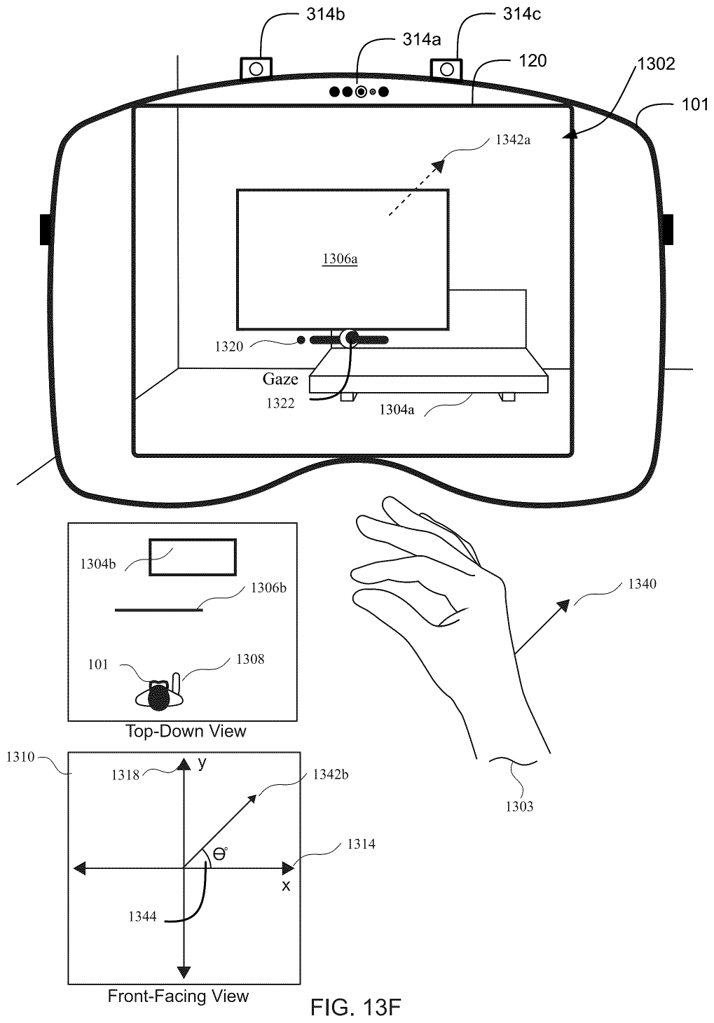

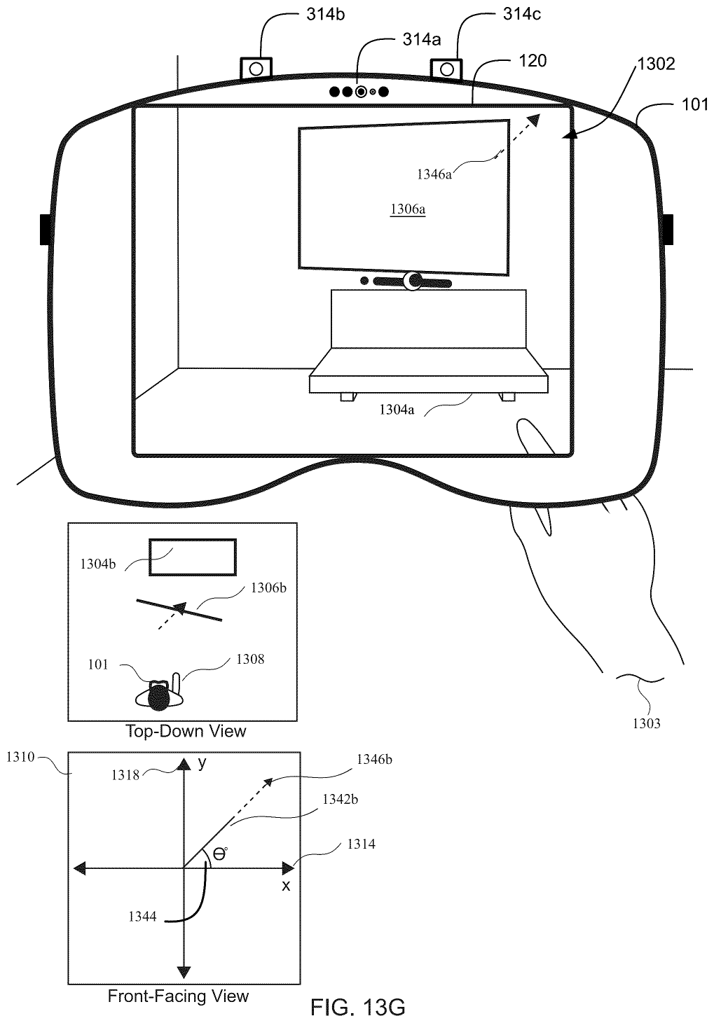

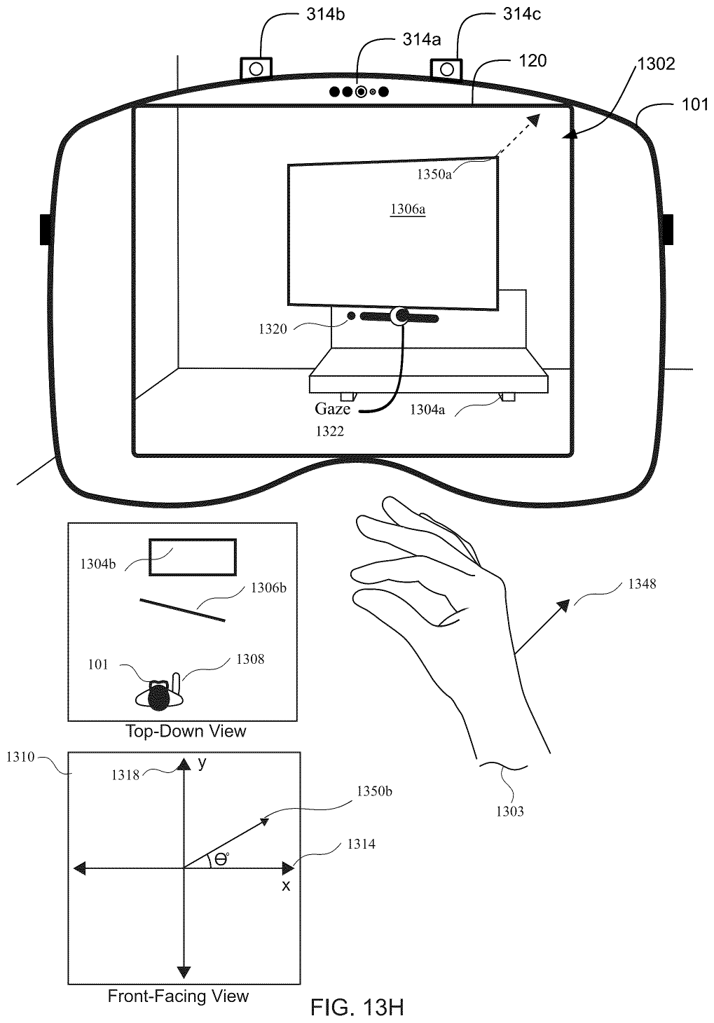

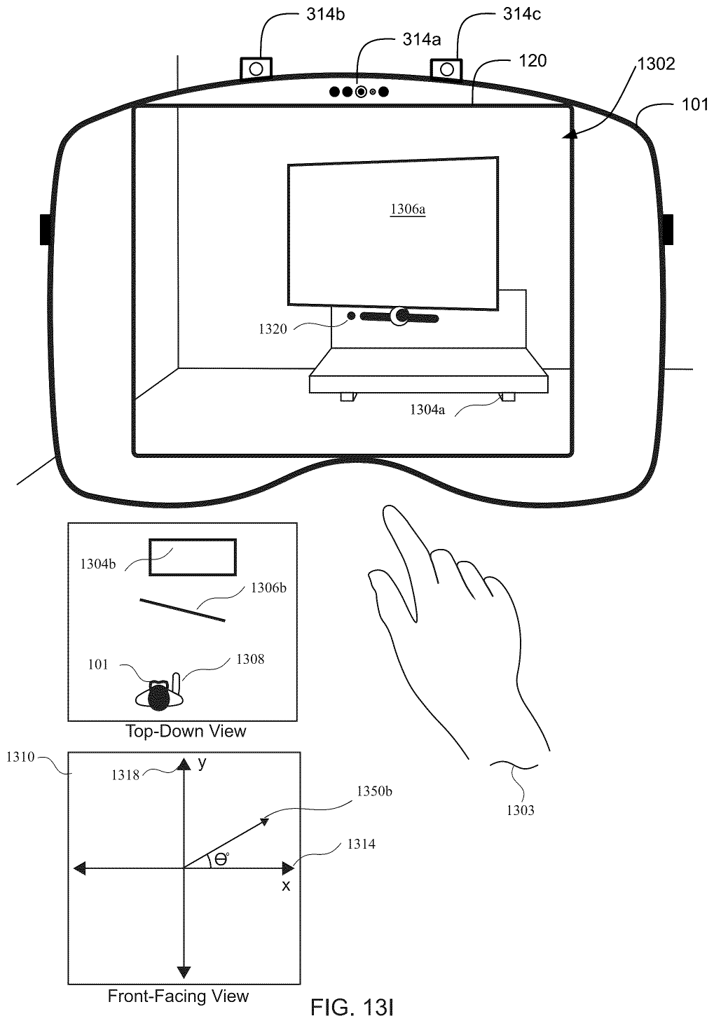

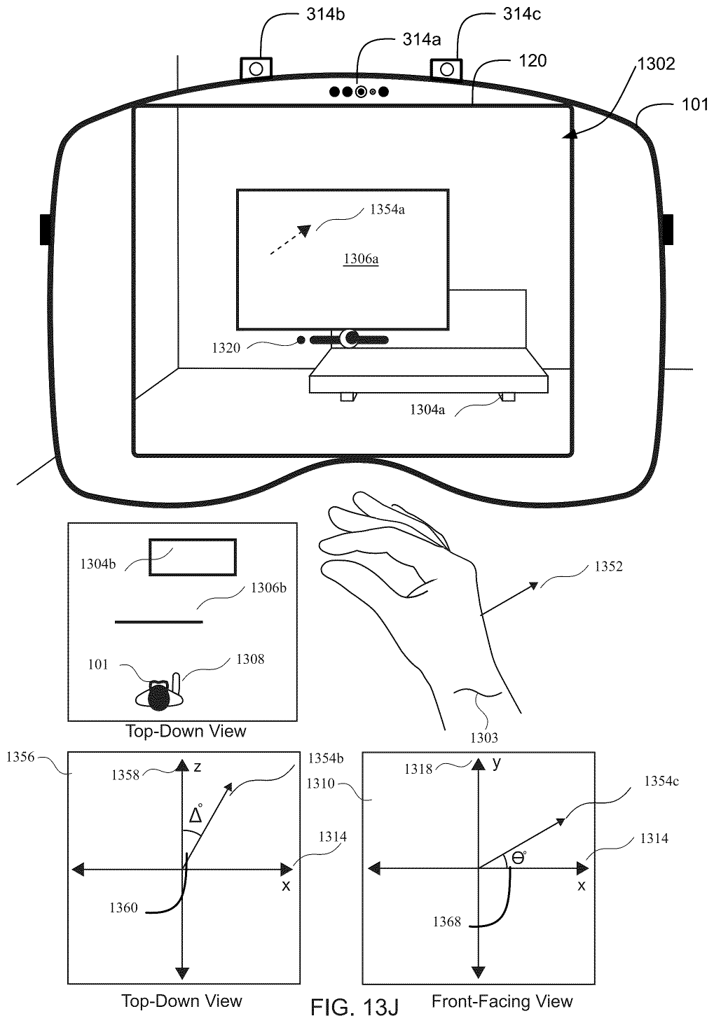

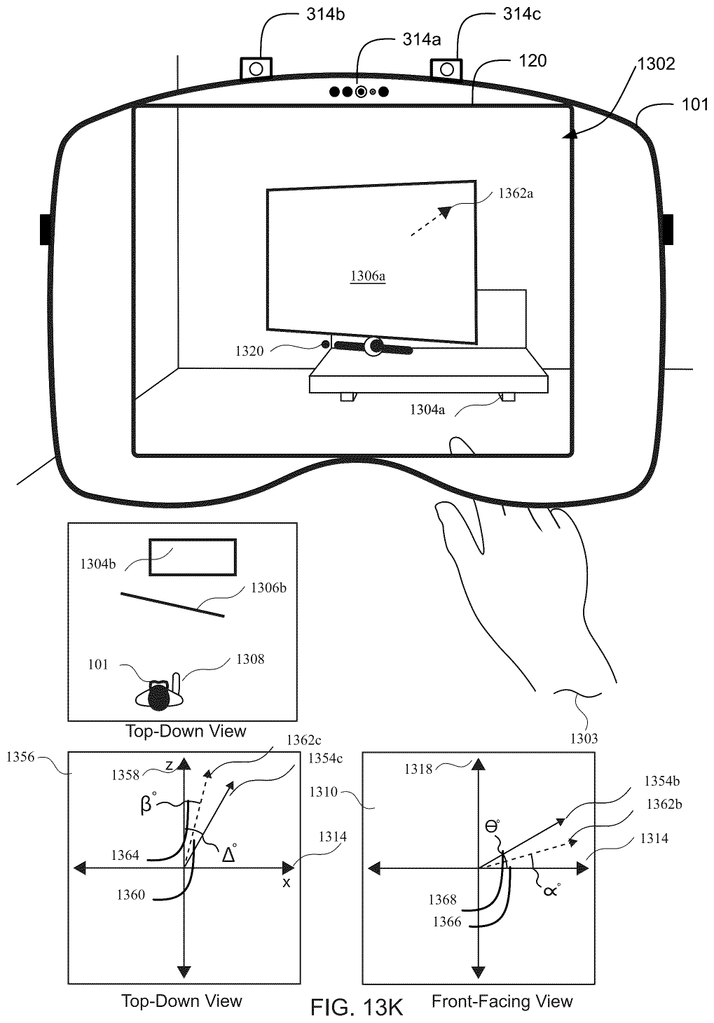

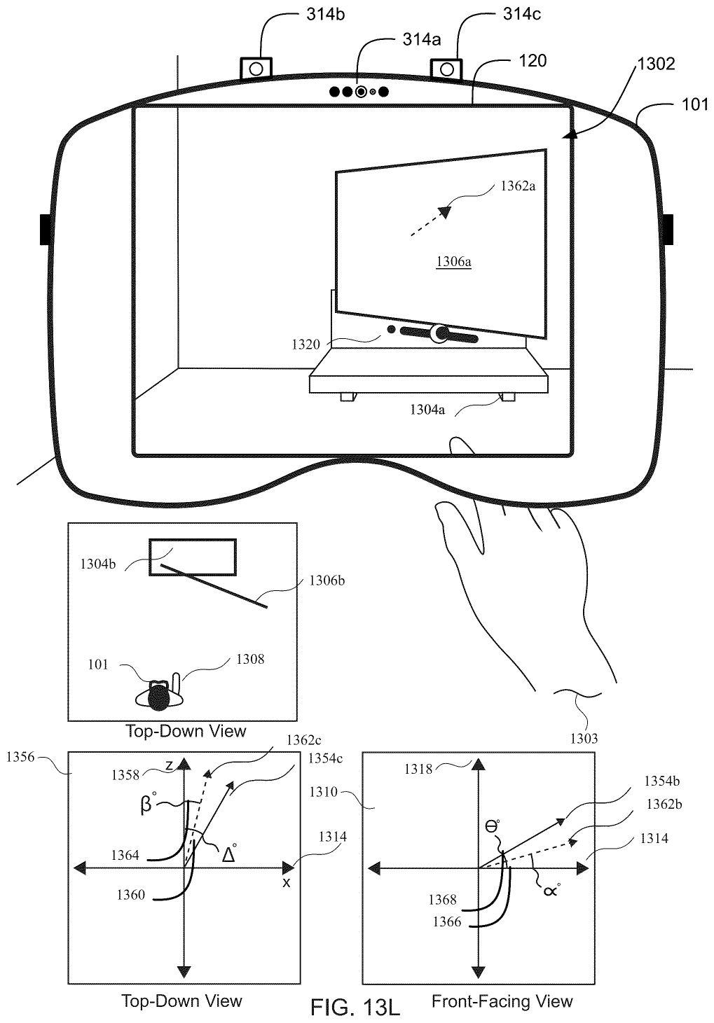

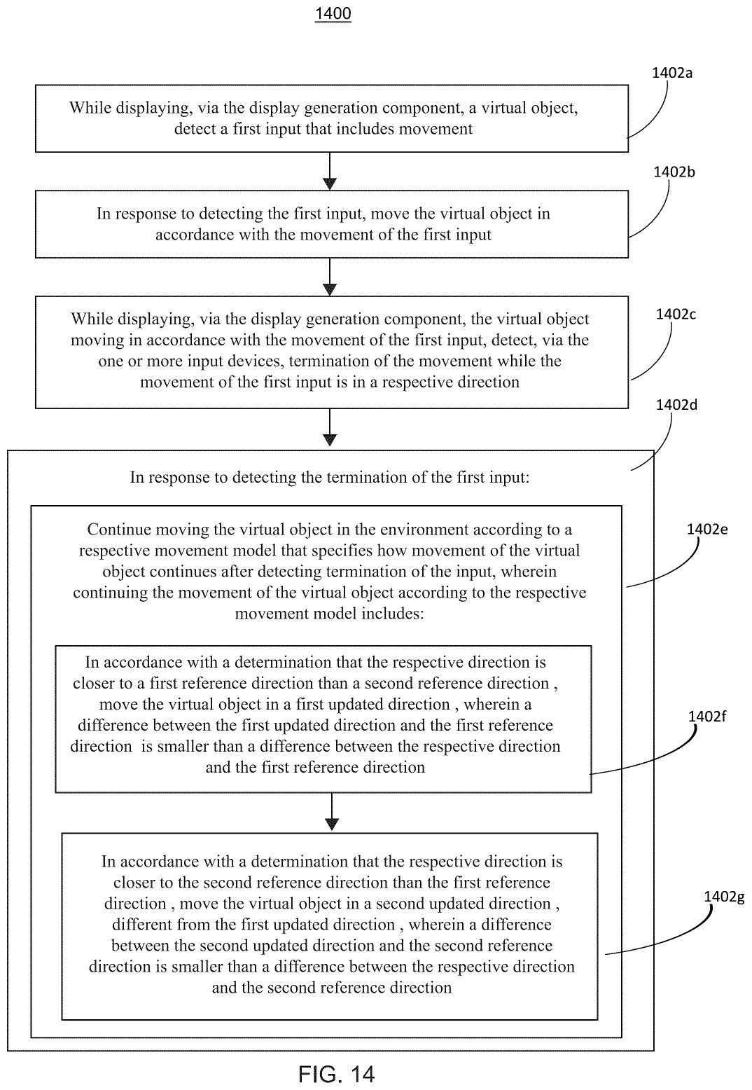

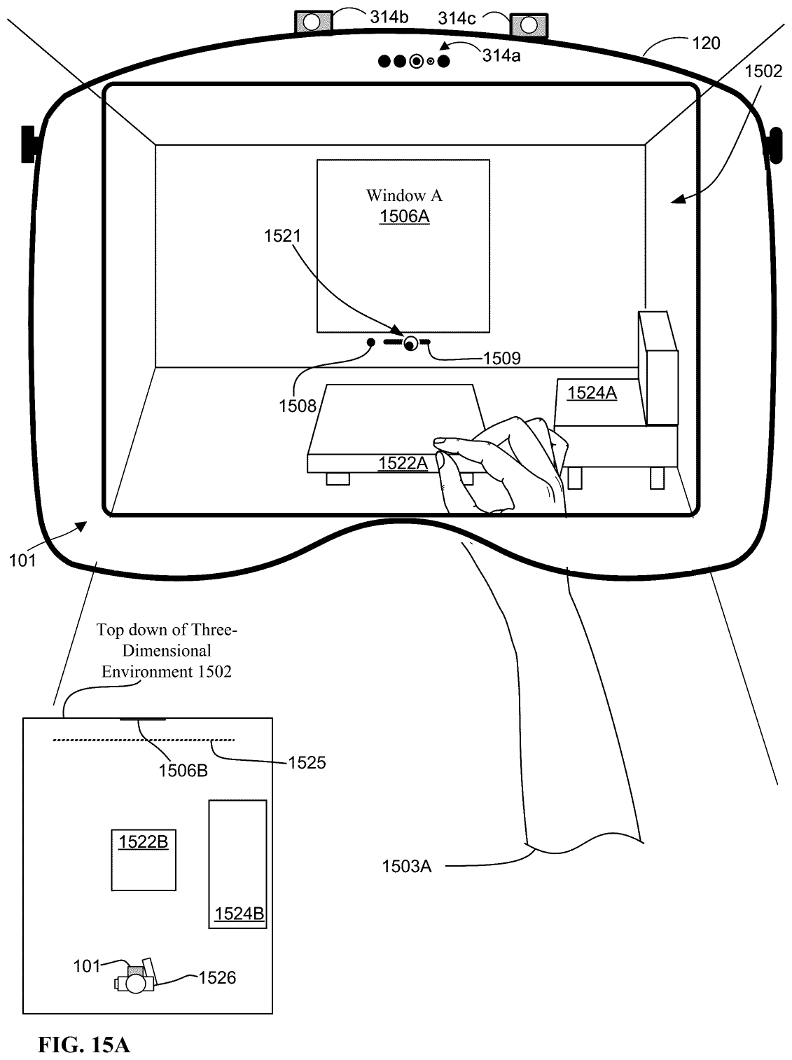

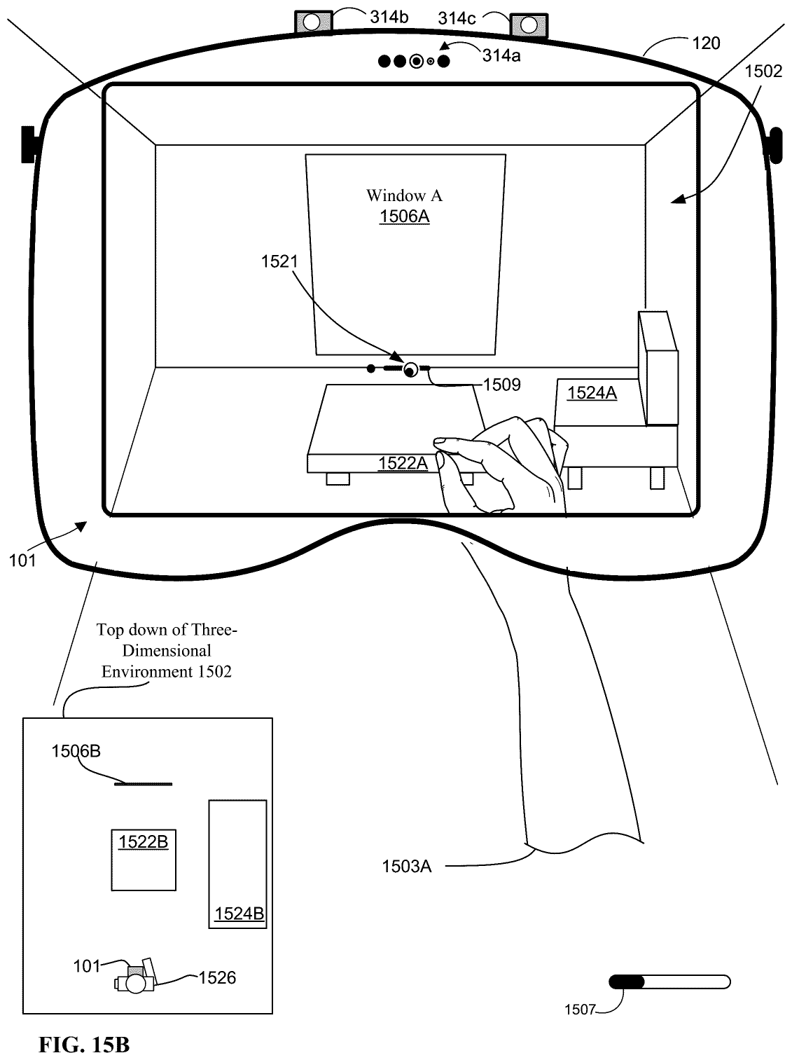

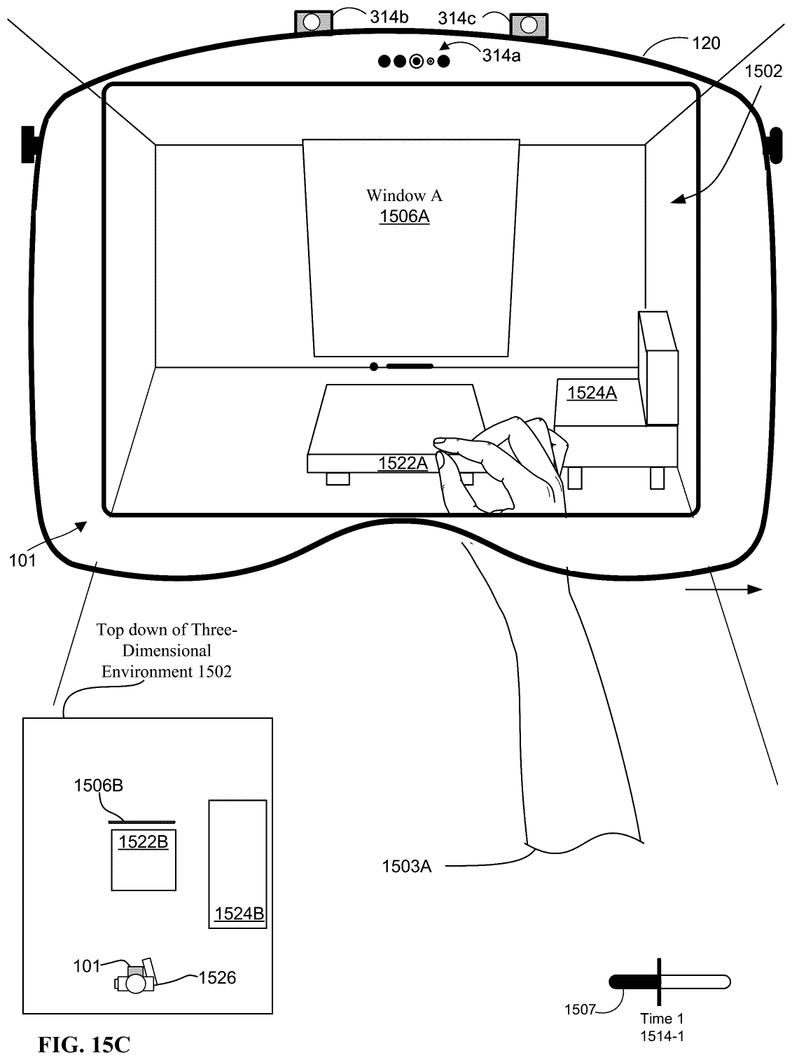

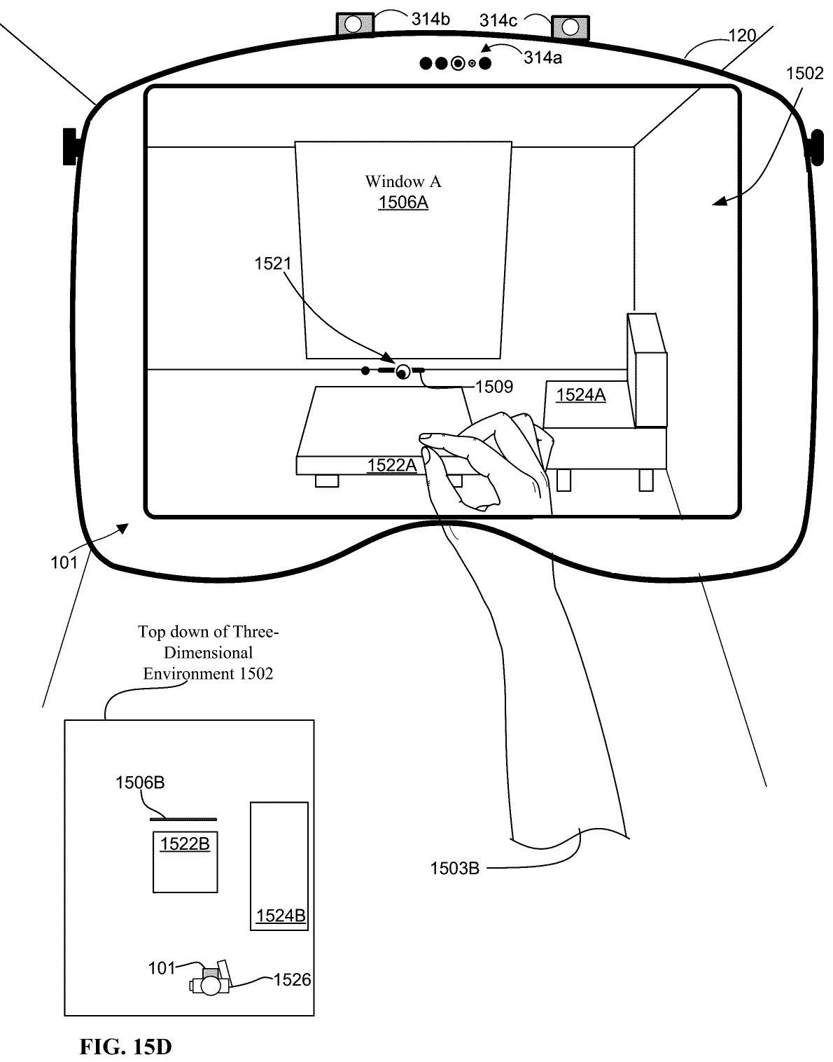

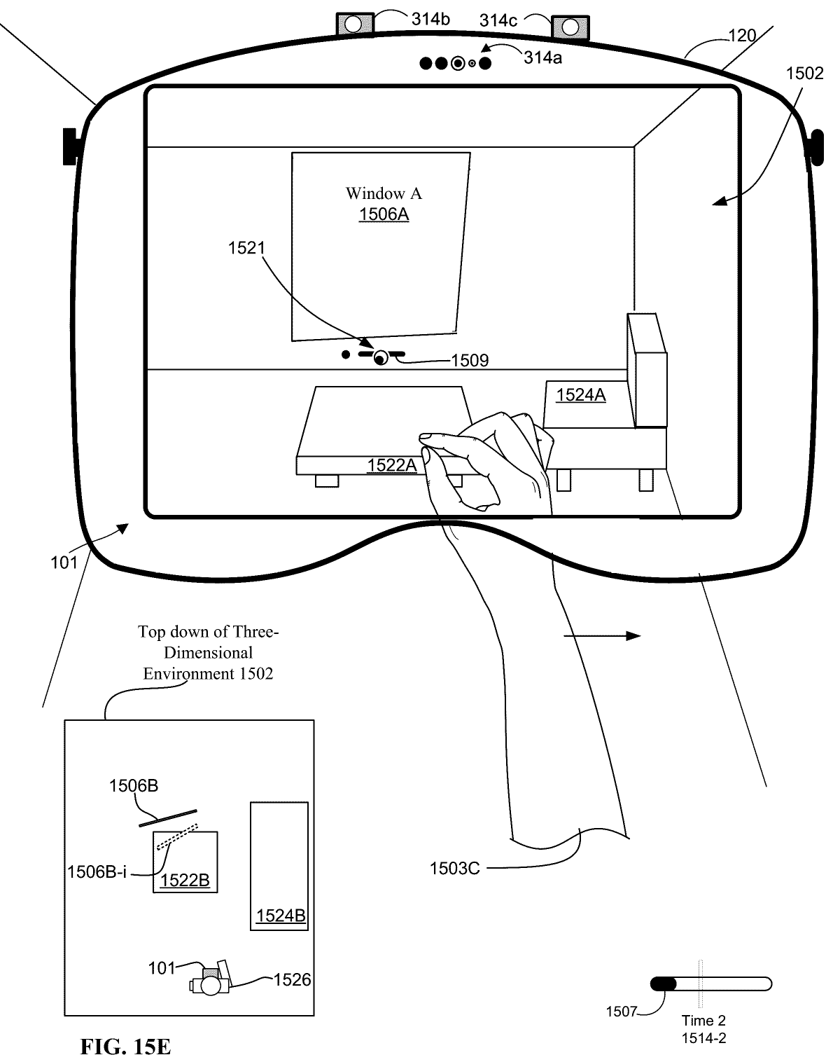

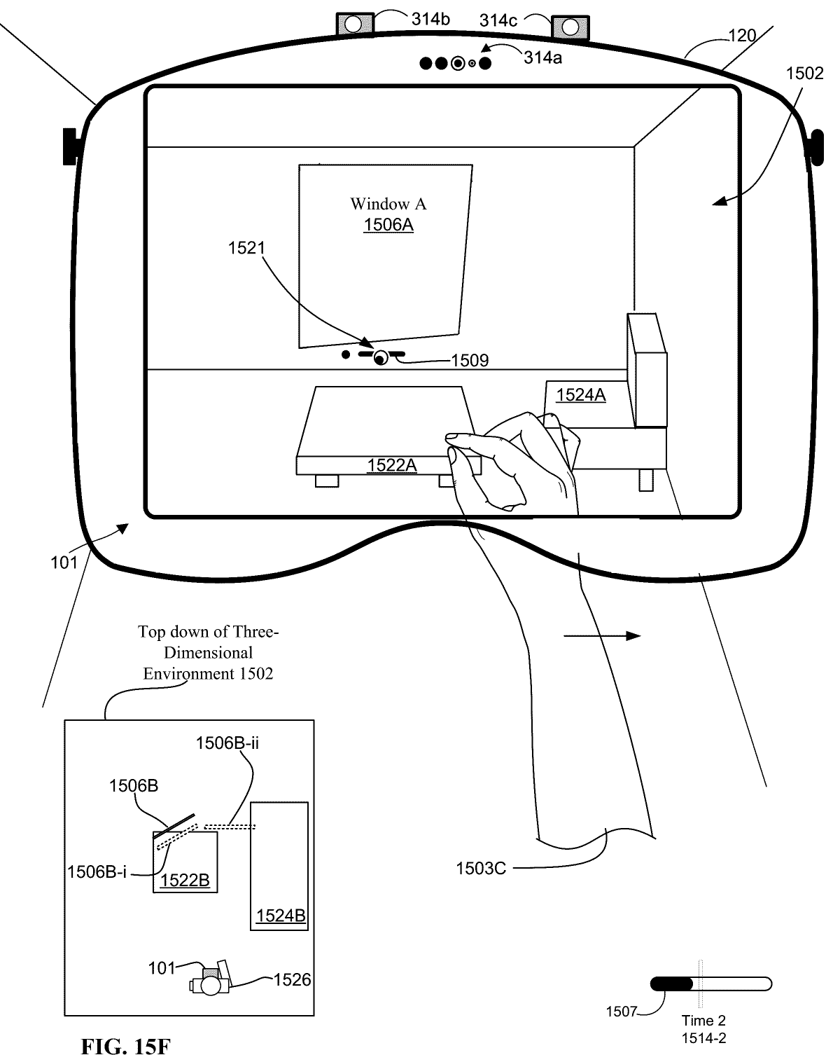

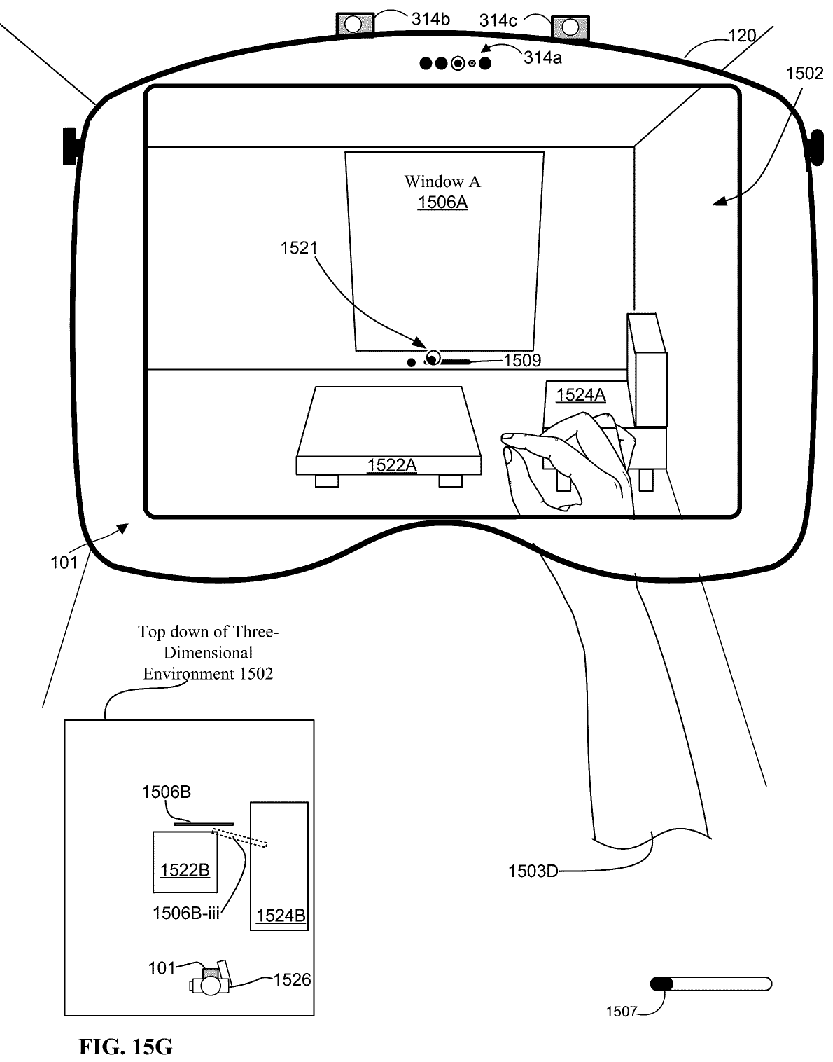

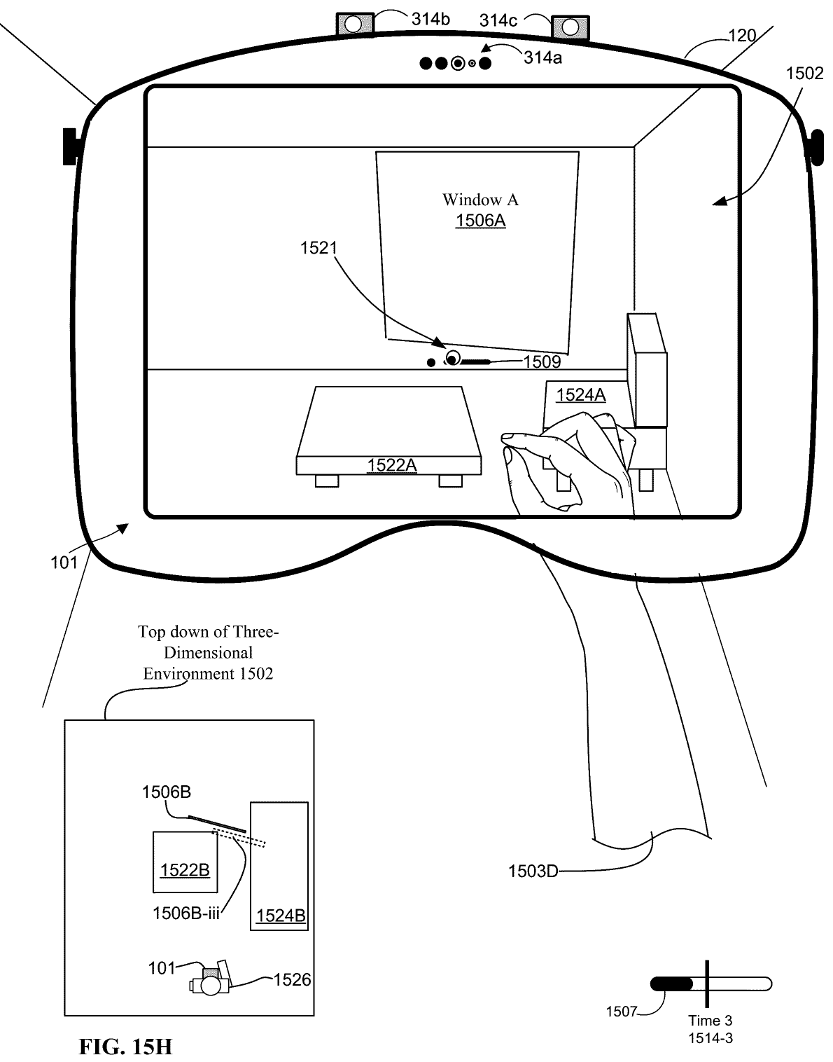

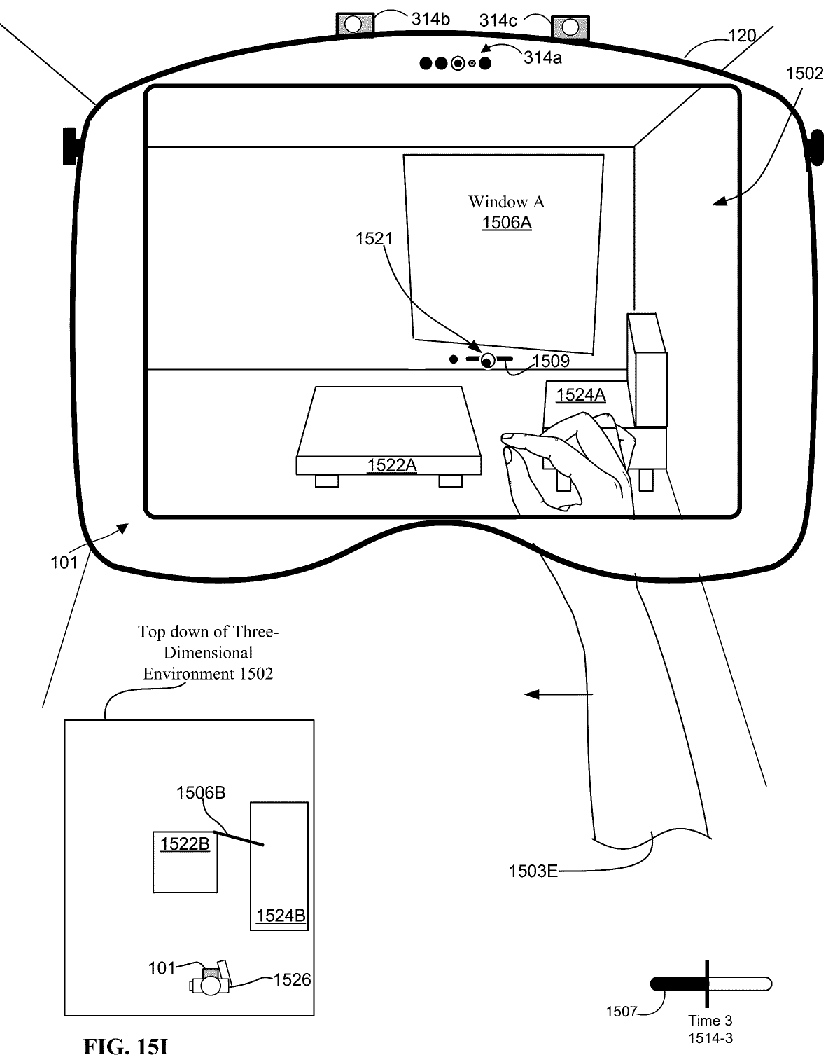

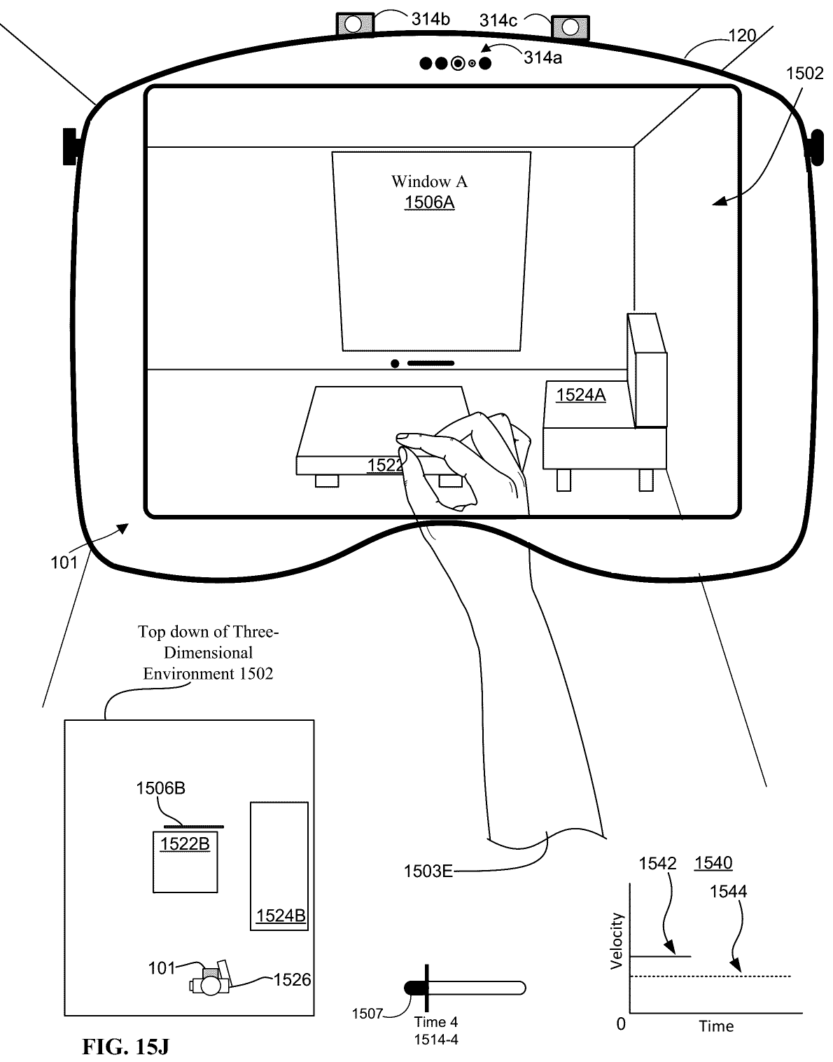

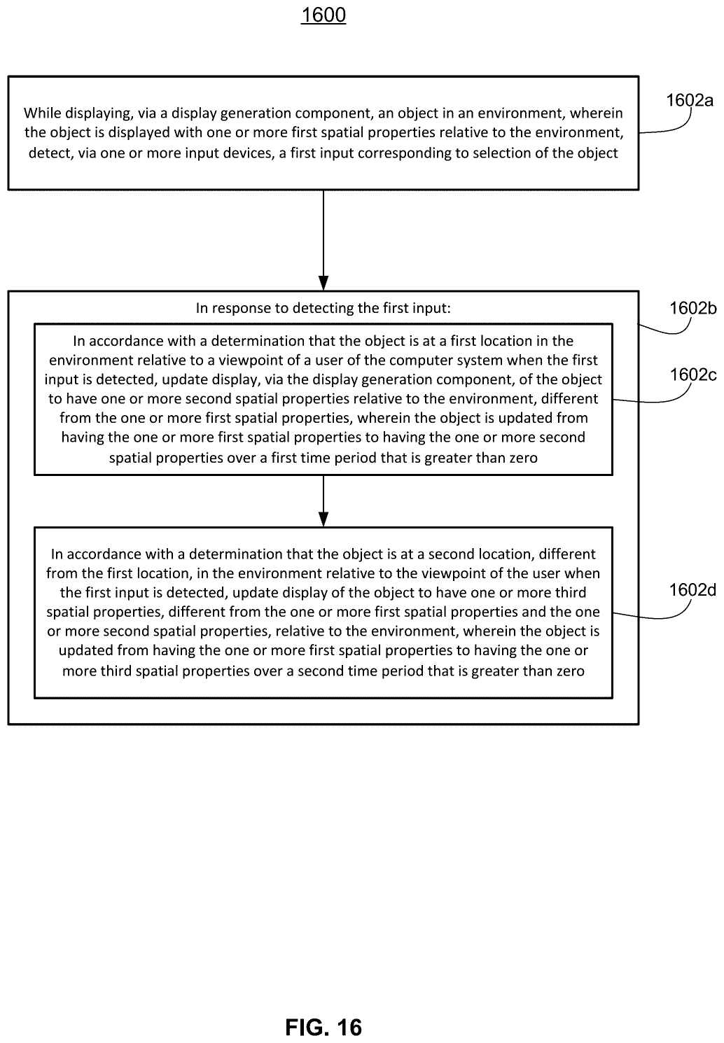

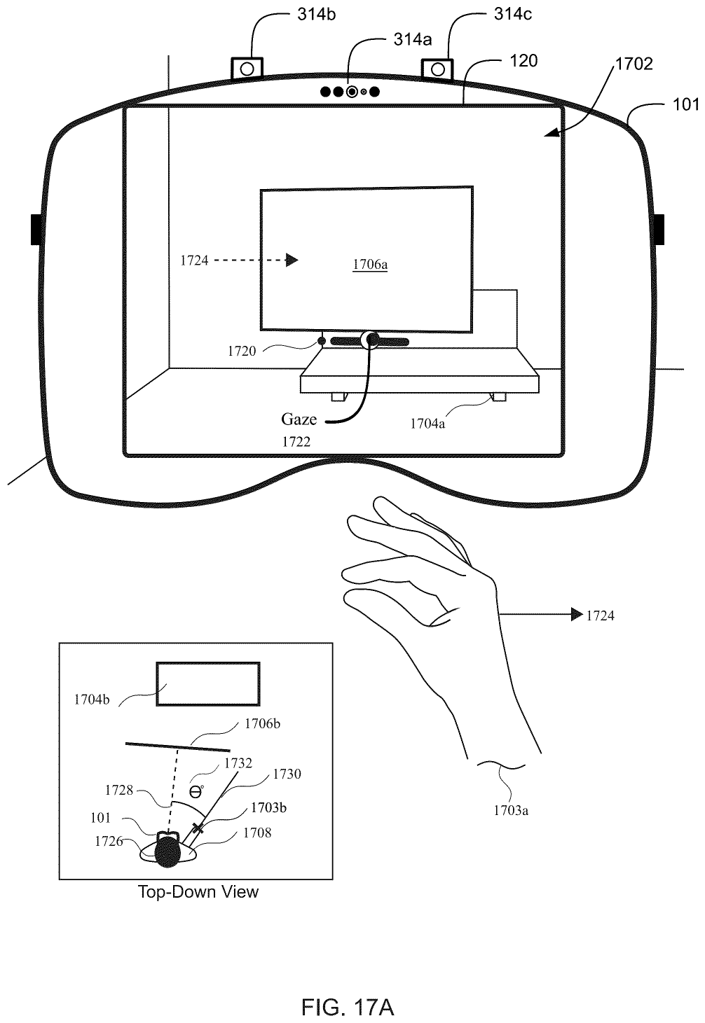

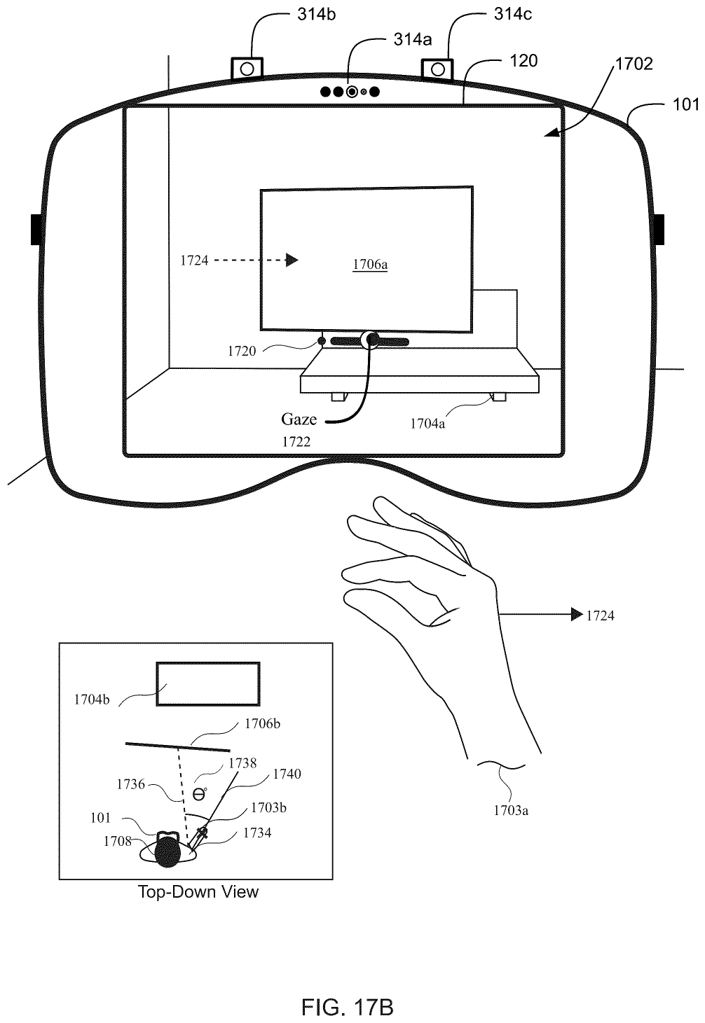

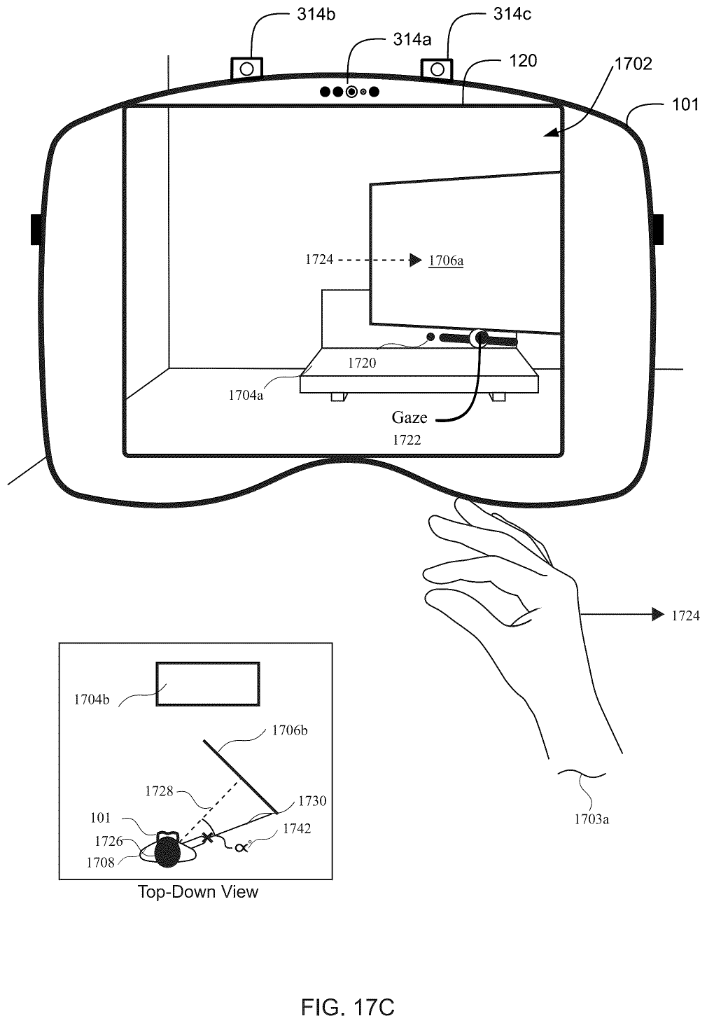

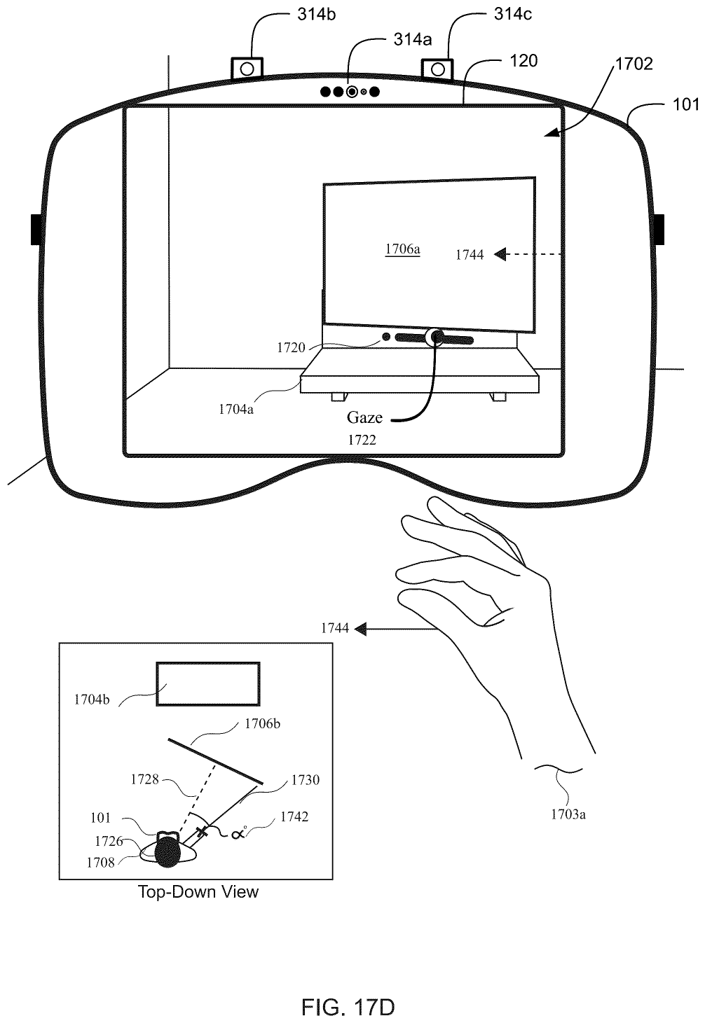

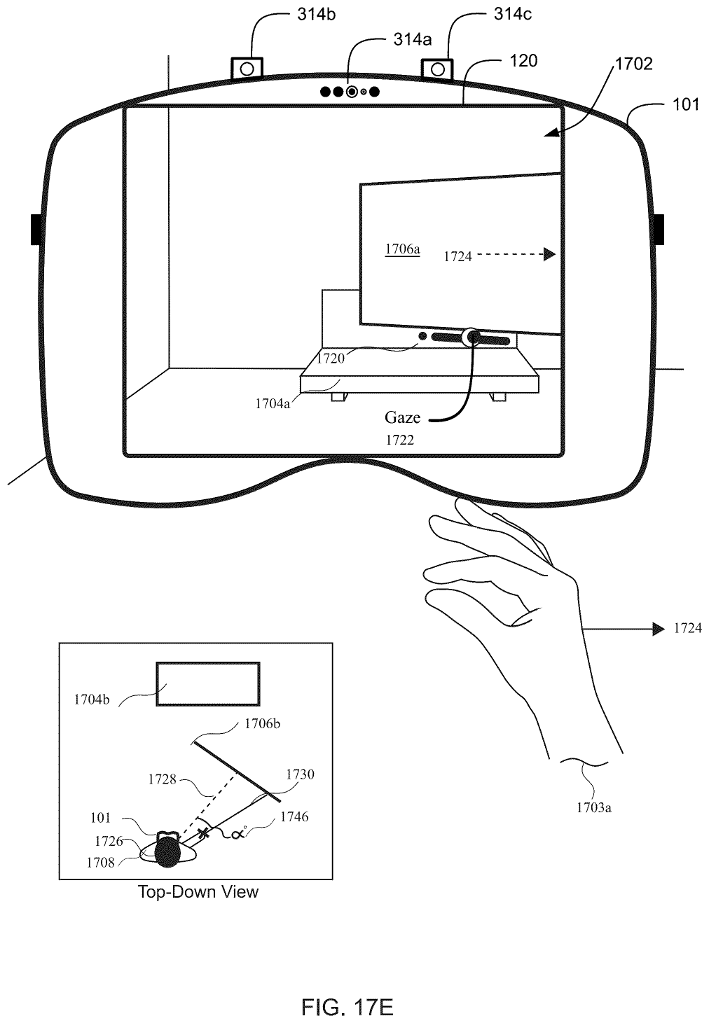

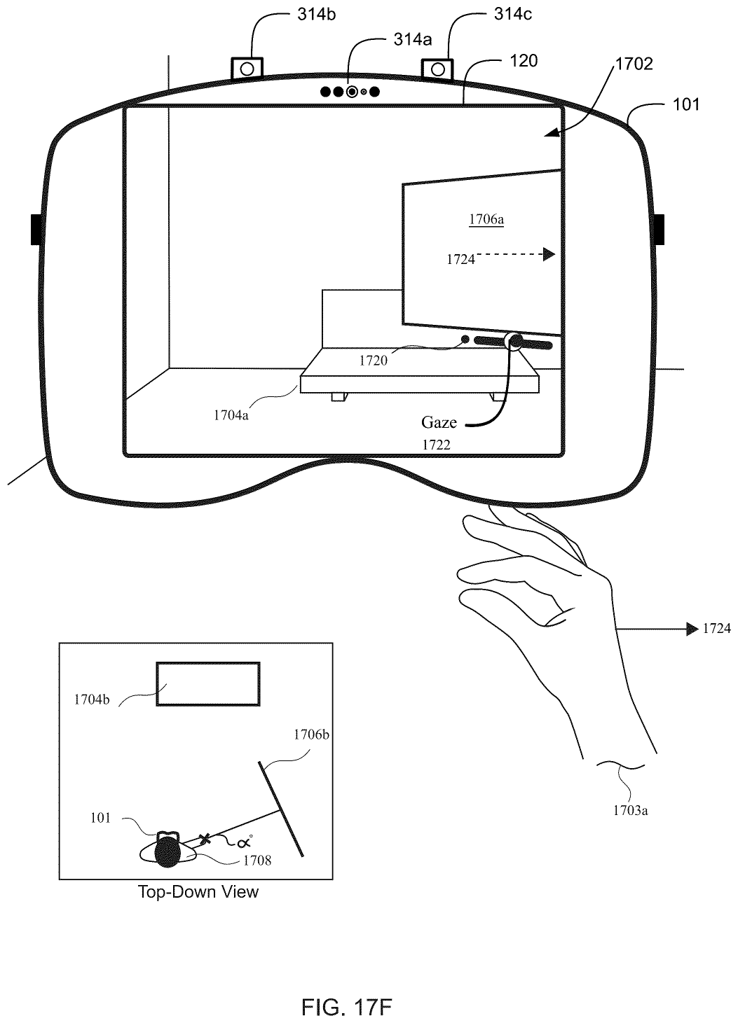

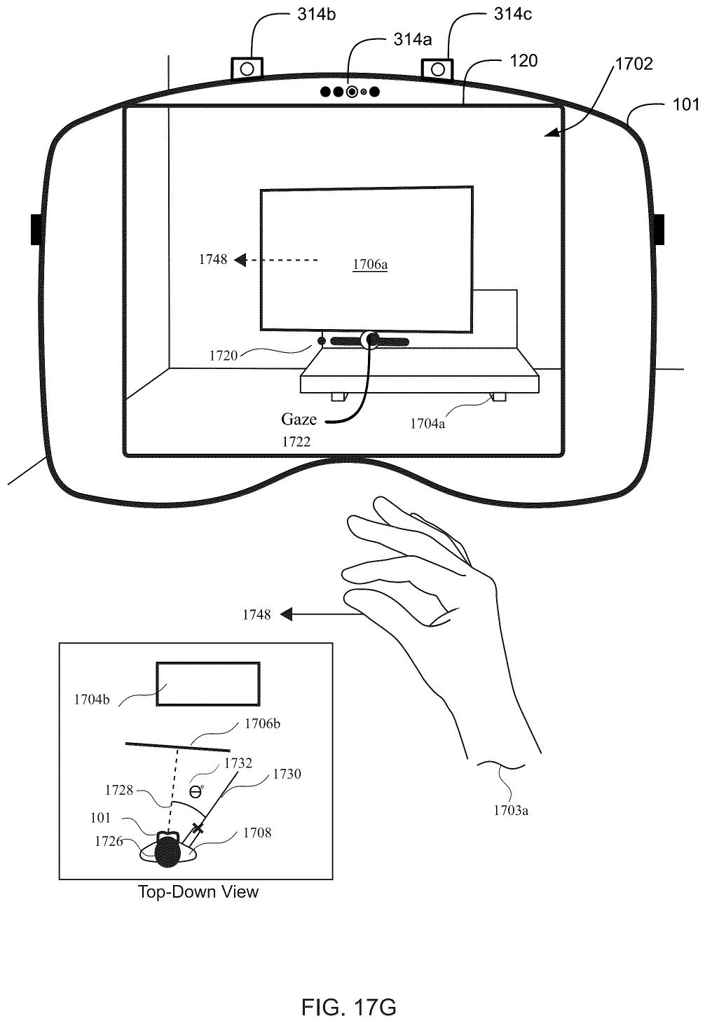

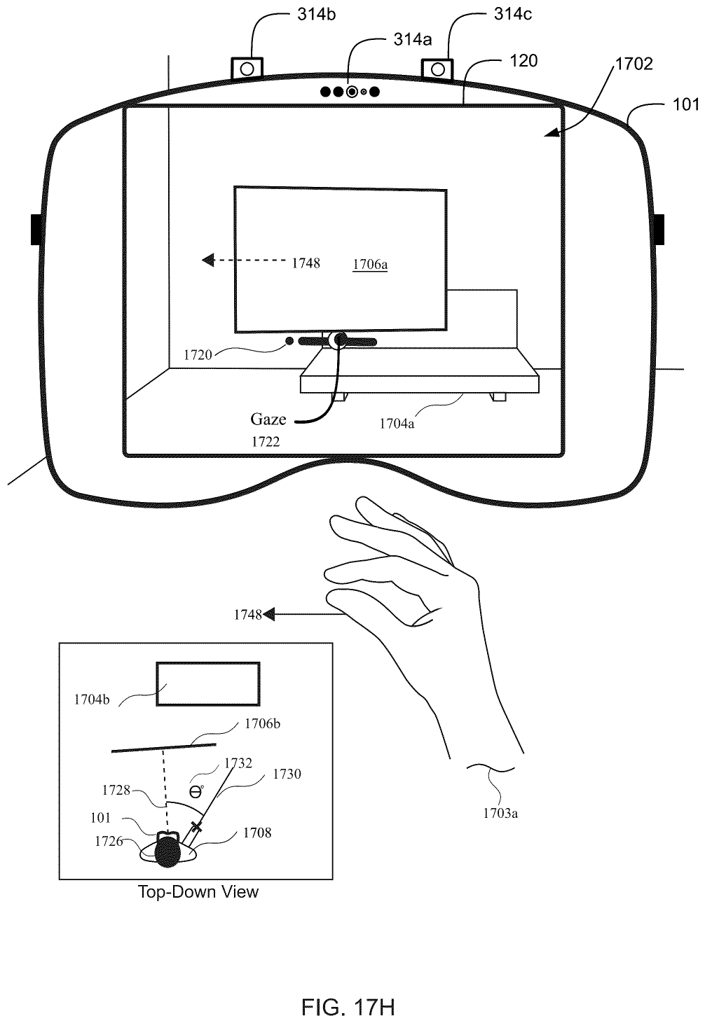

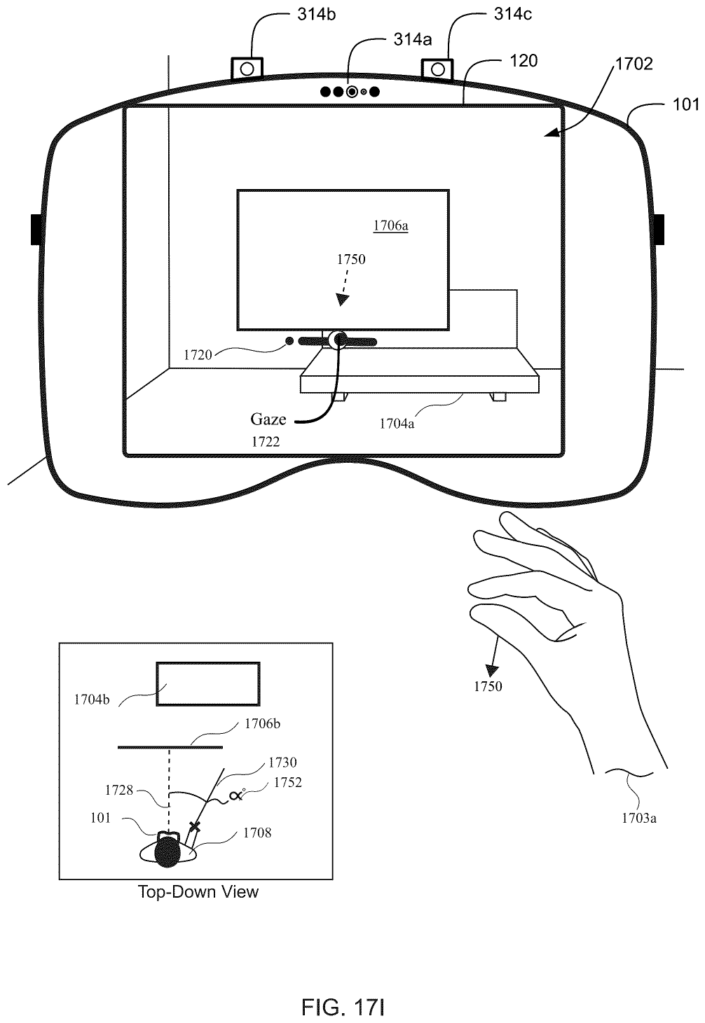

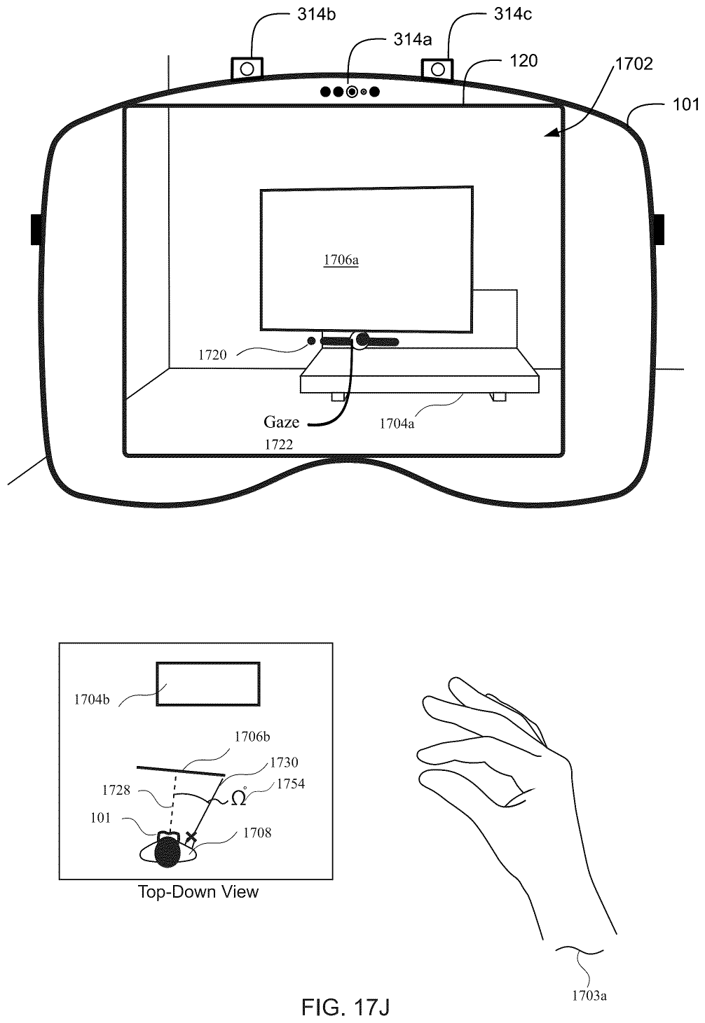

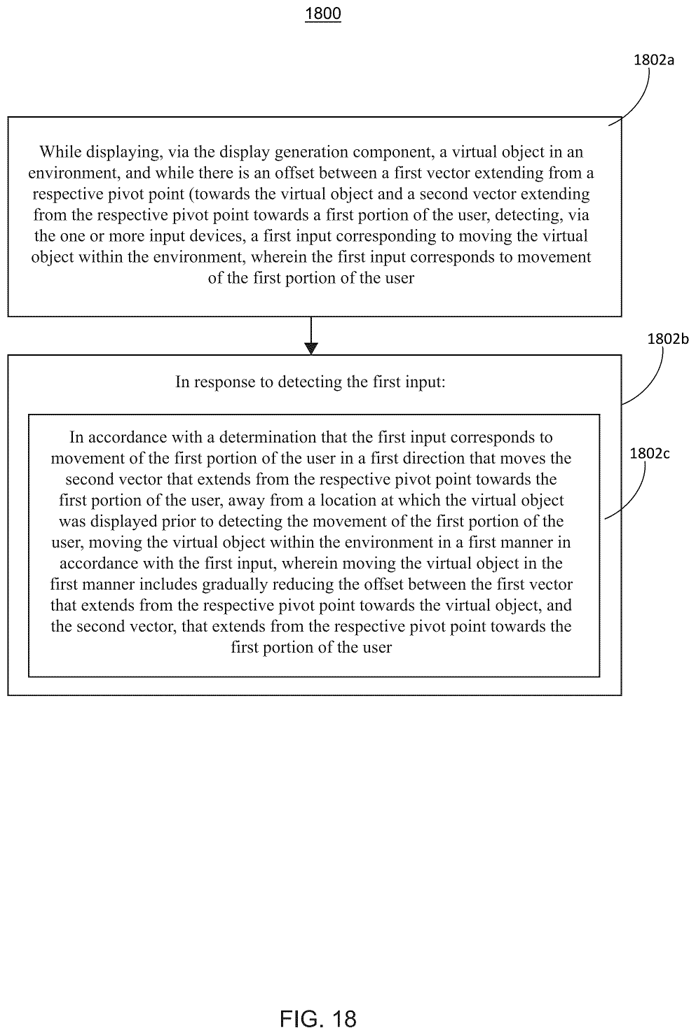

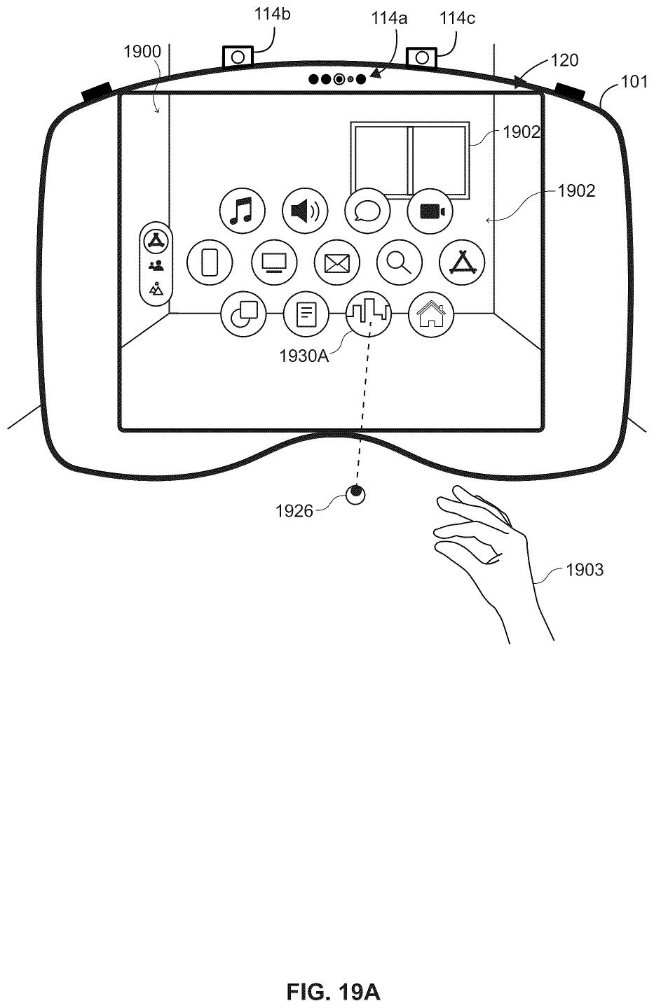

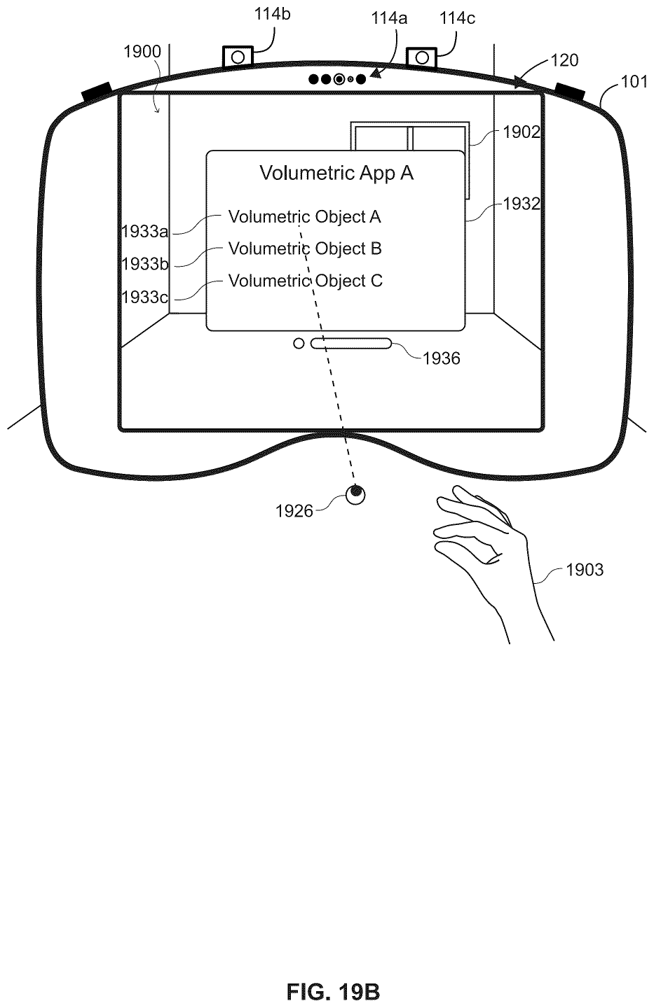

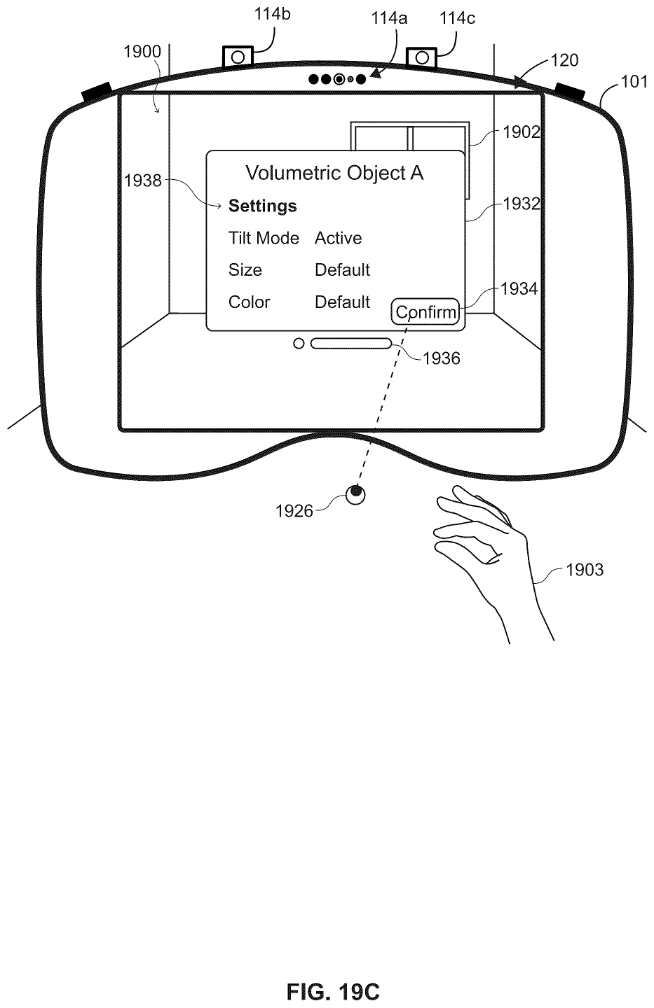

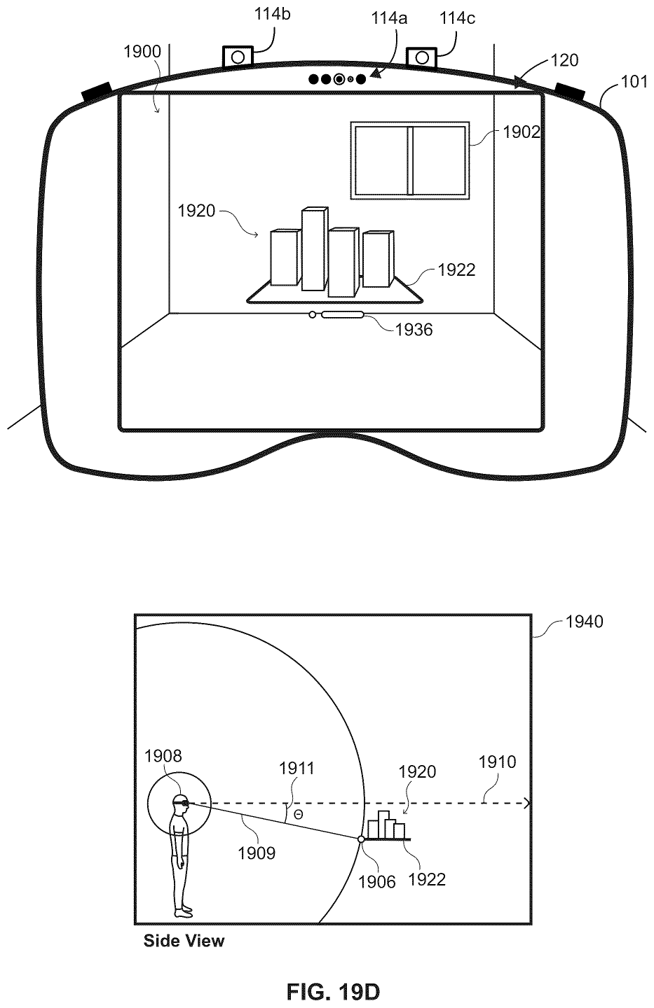

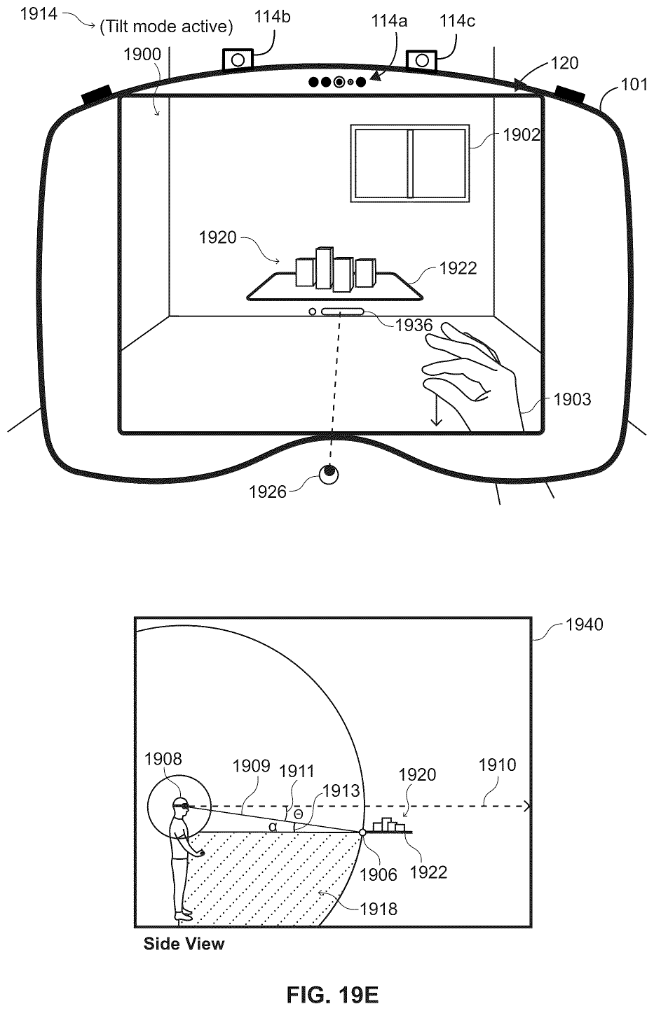

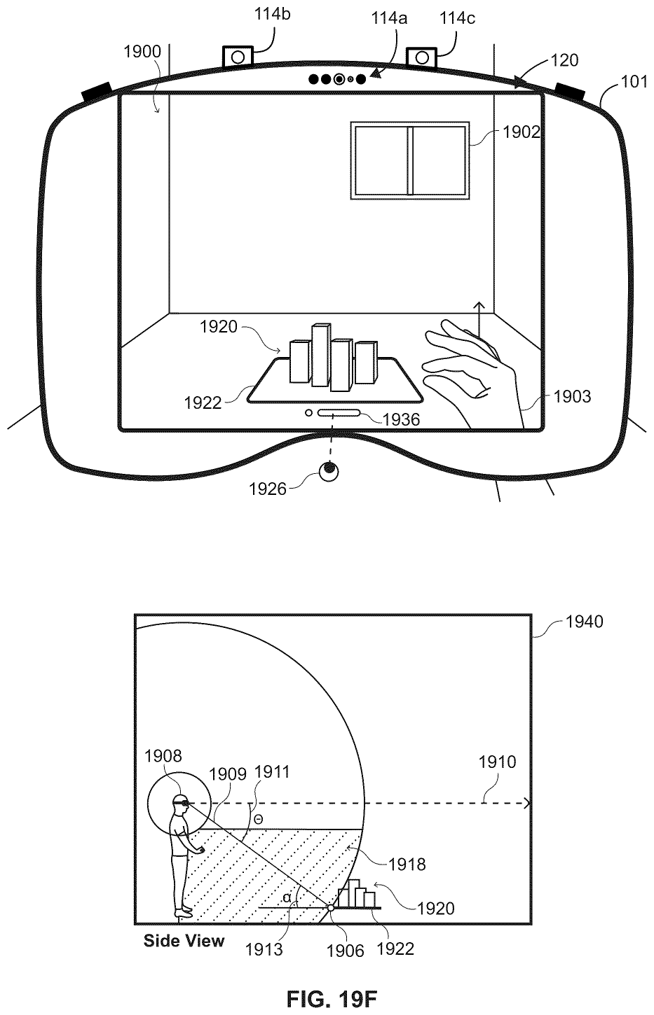

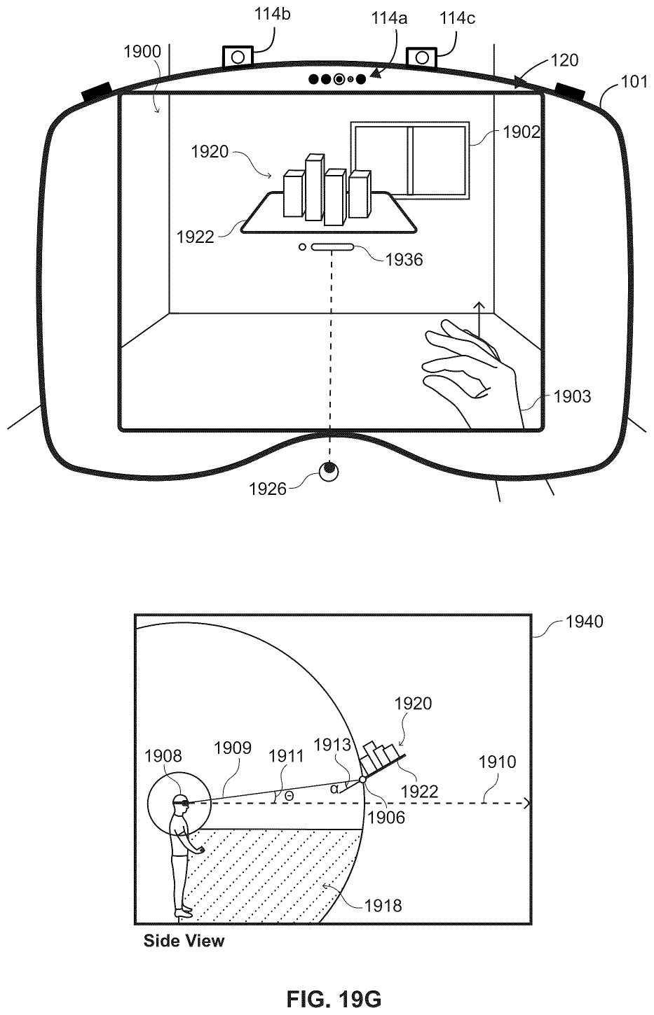

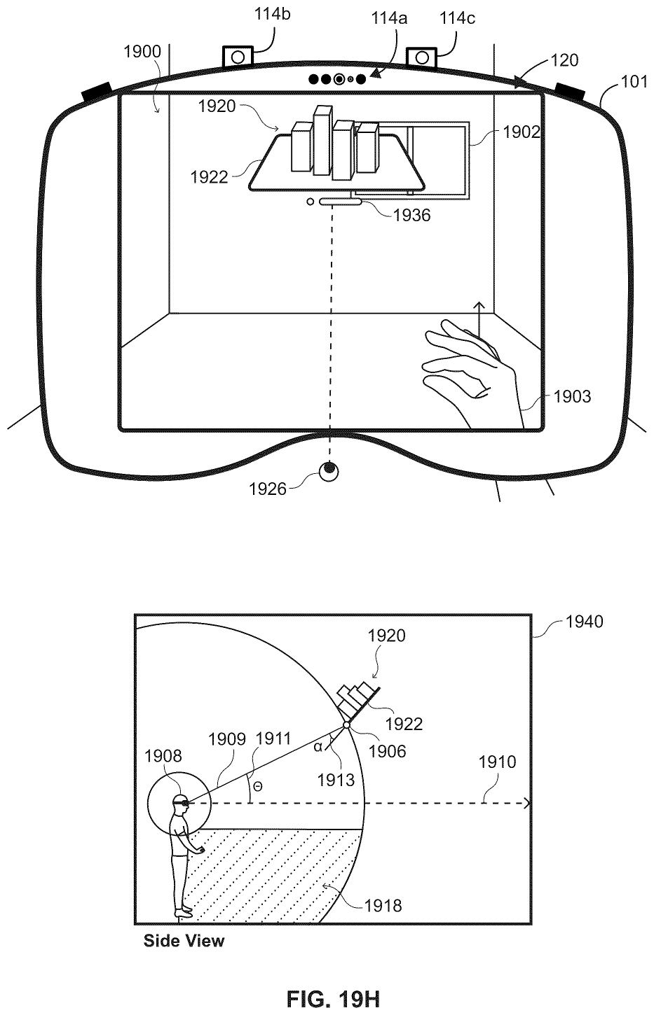

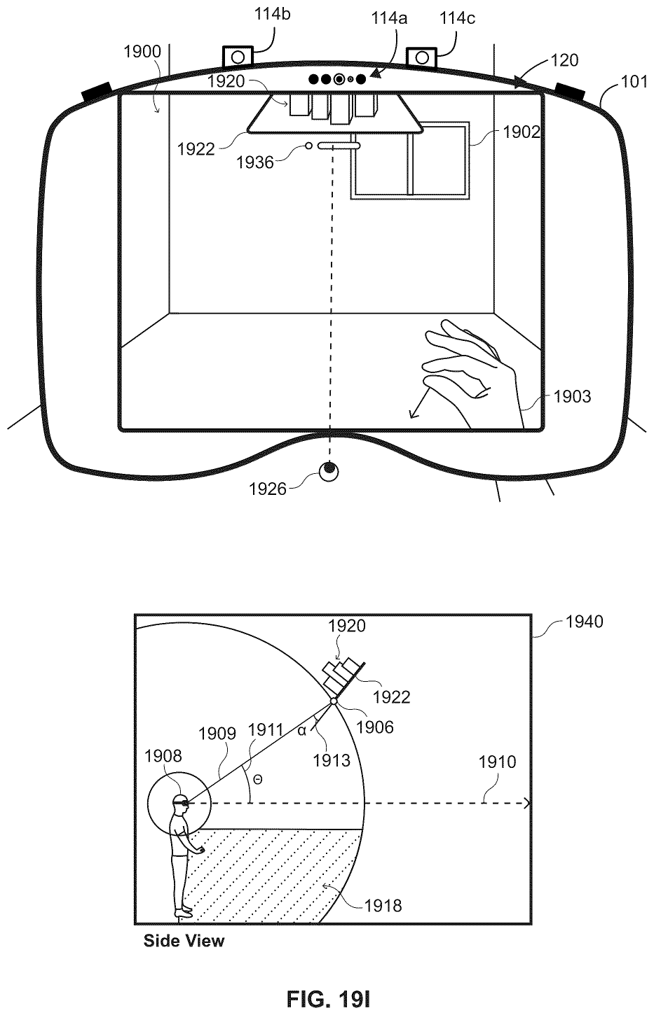

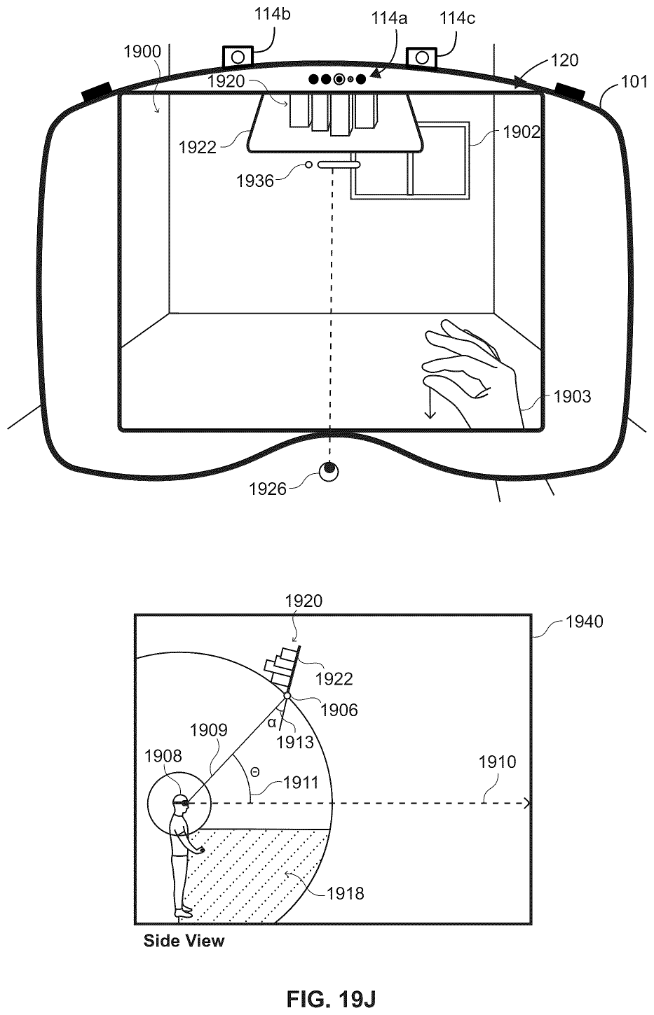

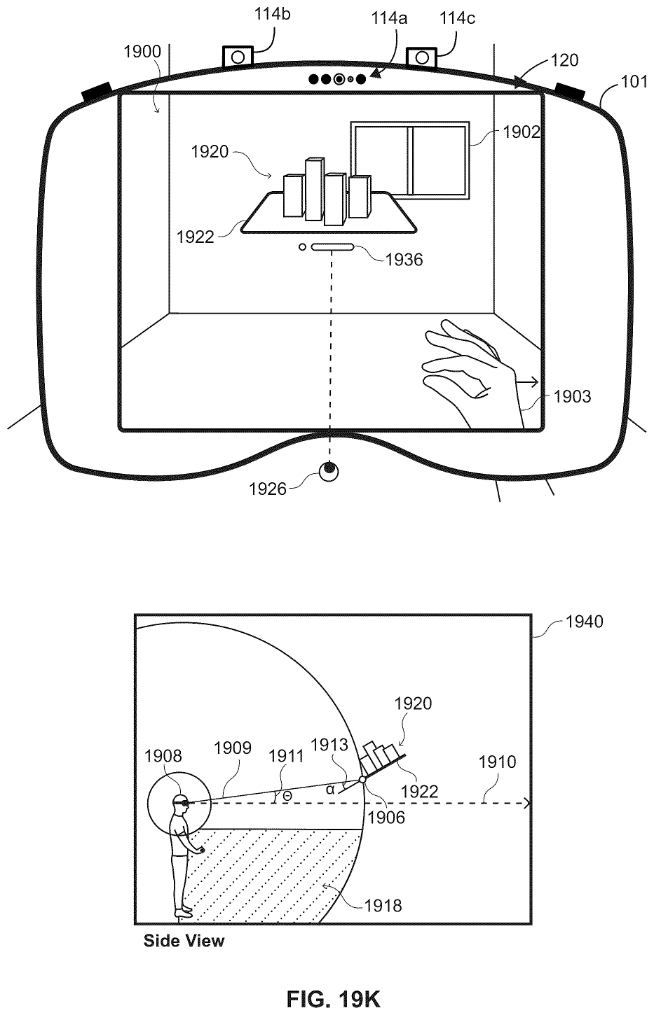

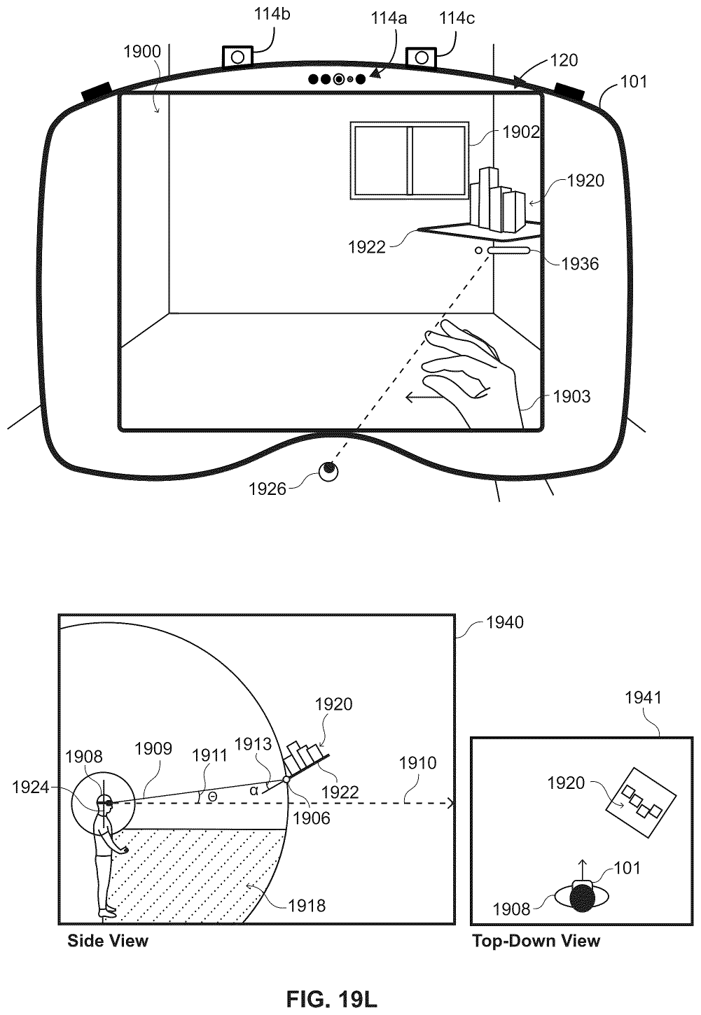

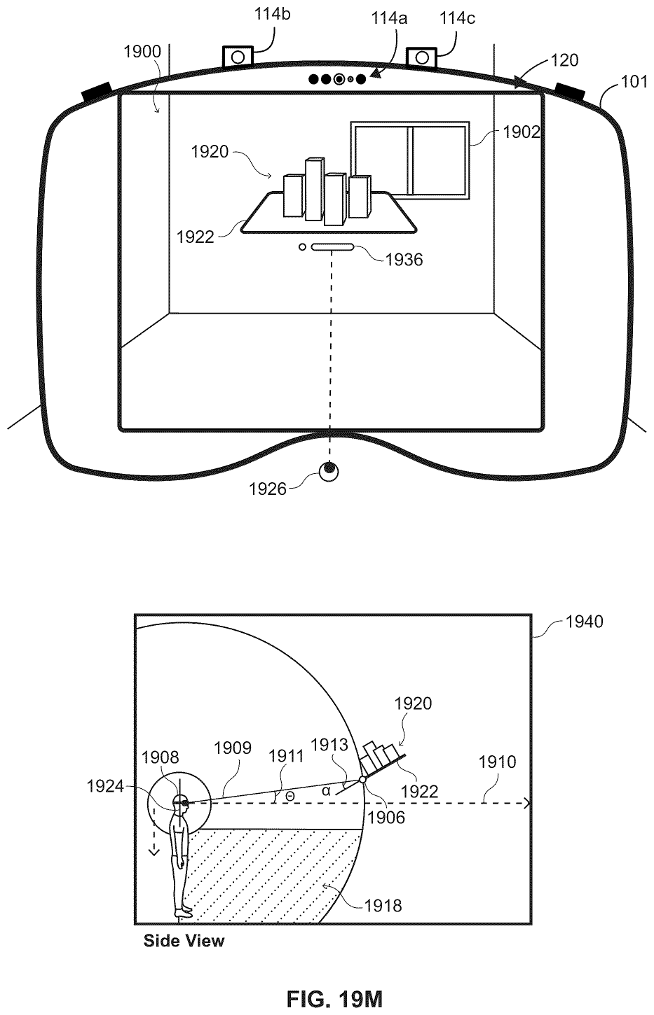

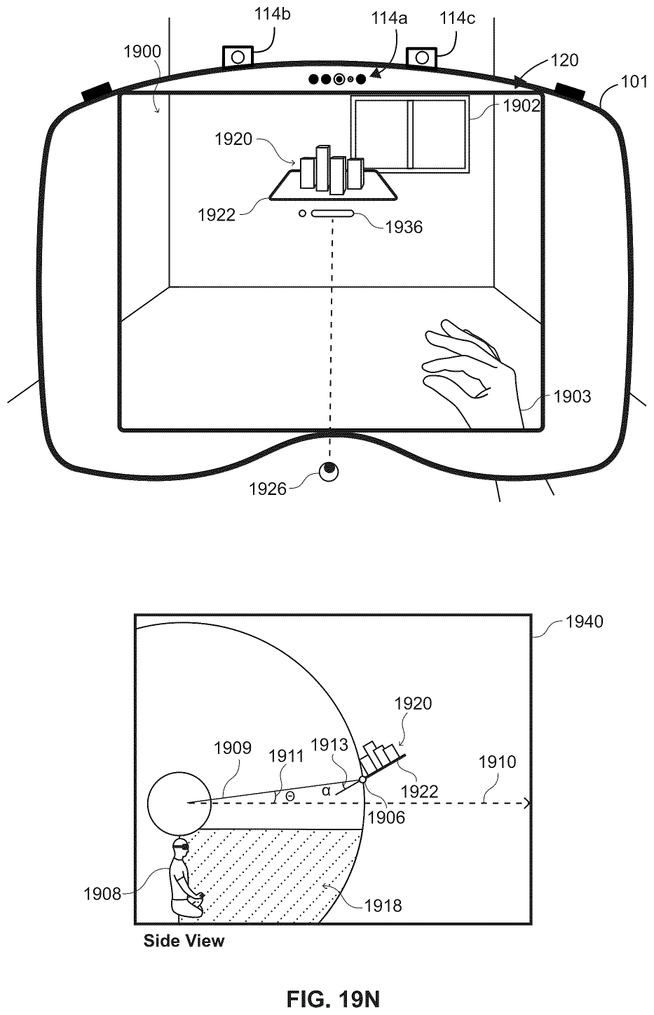

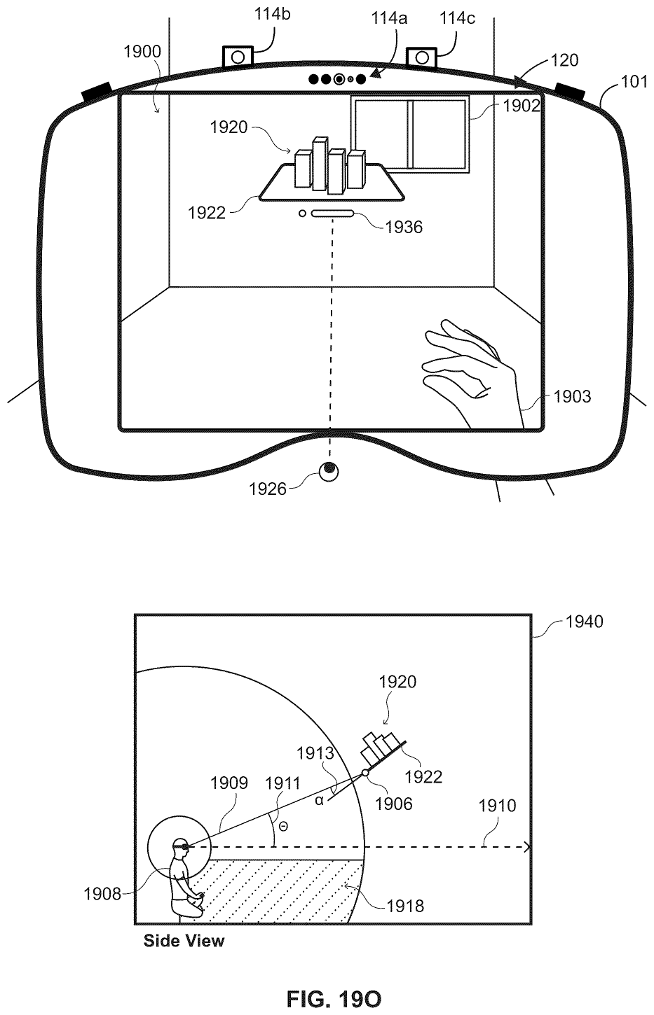

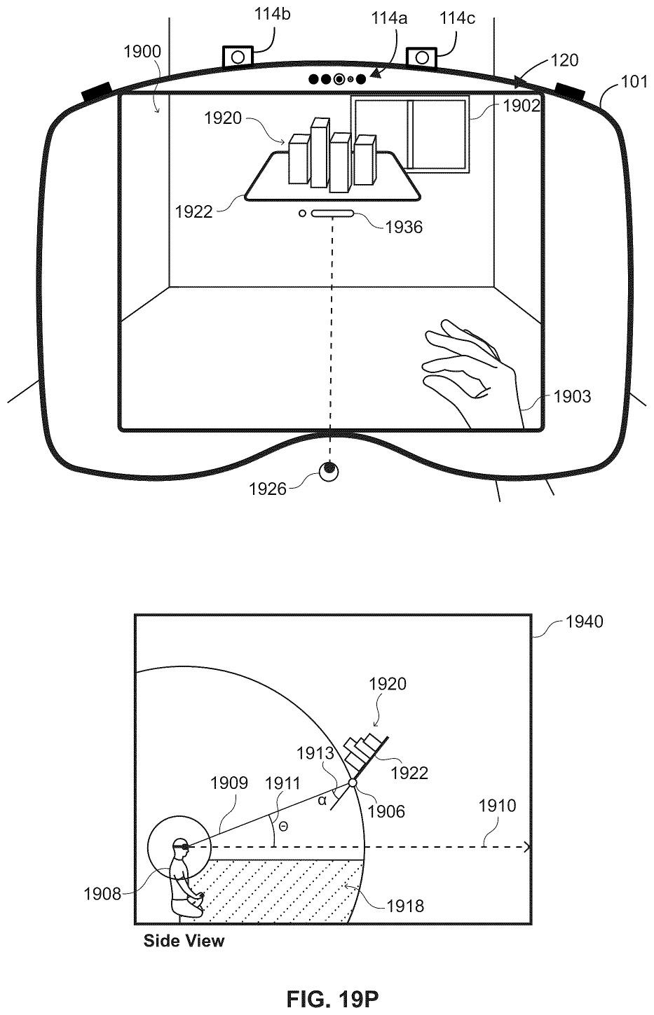

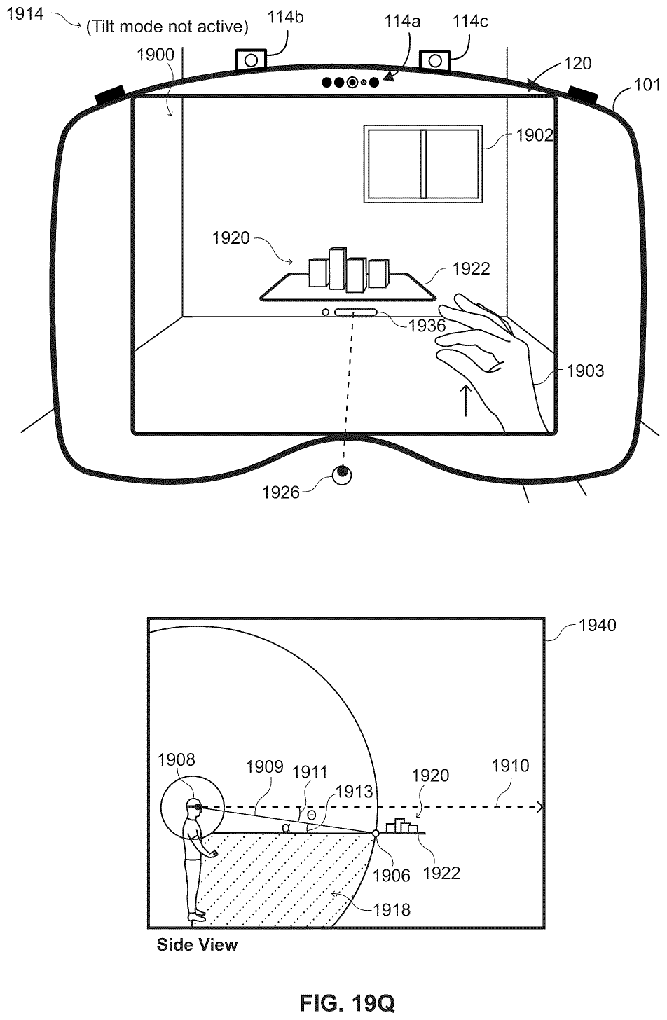

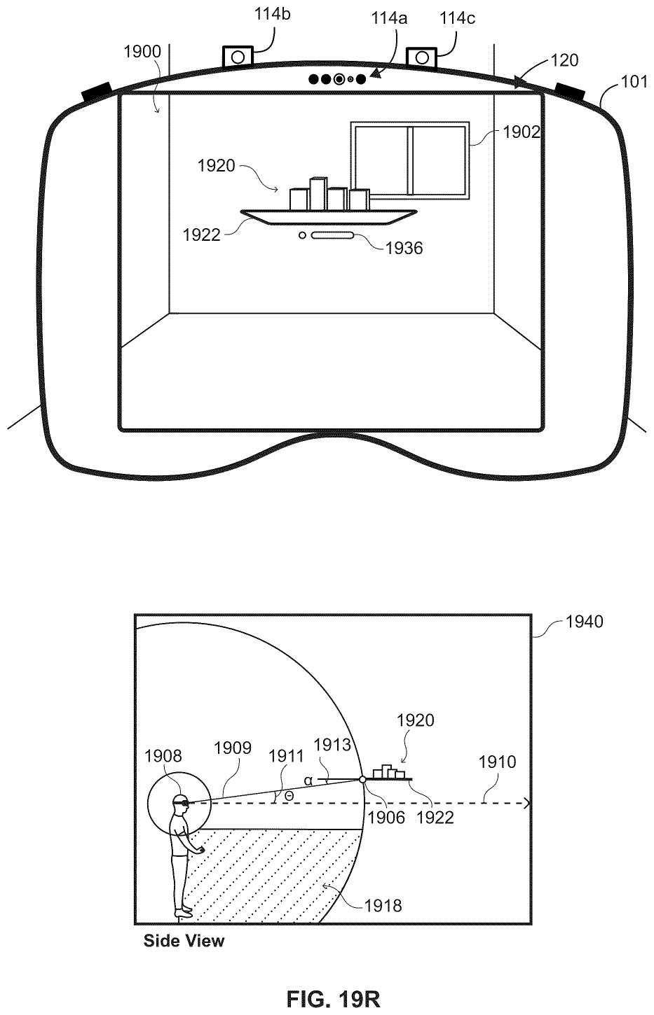

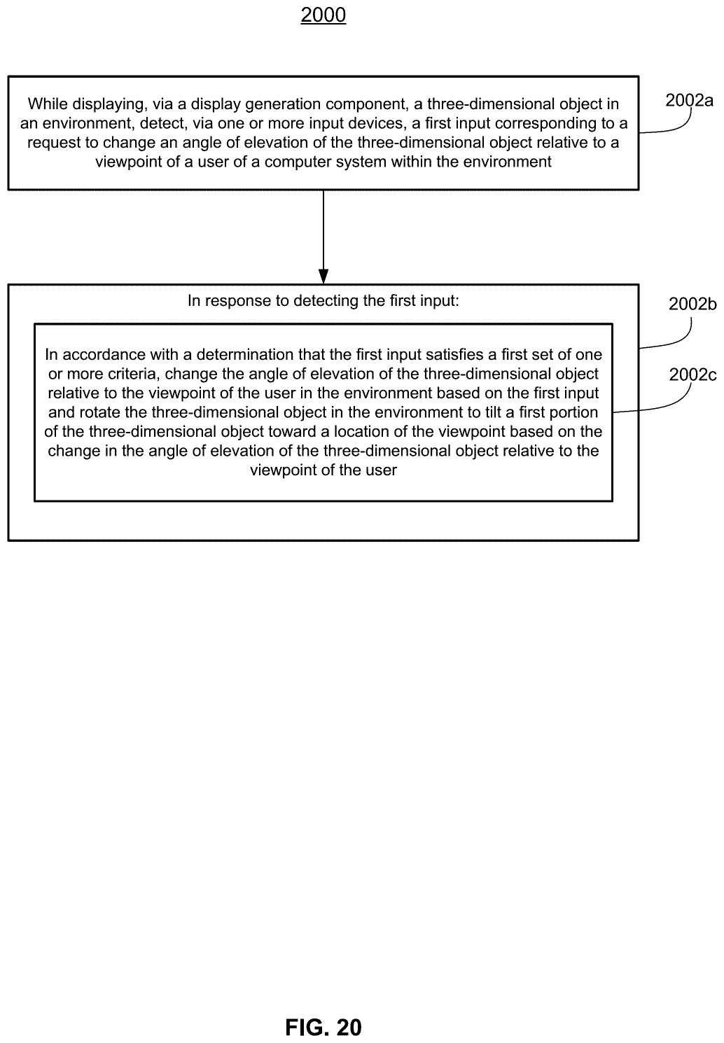

FIGS. 1A-6 provide a description of example computer systems for providing XR experiences to users (such as described below with respect to methods 800, 1000, 1200, 1400, 1600, 1800, and/or 2000). FIGS. 7A-7J illustrate example techniques for facilitating movement of a virtual object in a three-dimensional environment in accordance with some embodiments. FIGS. 8A-8G is a flow diagram of methods of facilitating movement of a virtual object in a three-dimensional environment in accordance with some embodiments. The user interfaces in FIGS. 7A-7J are used to illustrate the processes in FIGS. 8A-8G. FIGS. 9A-9J illustrate example techniques for facilitating movement of a virtual object beyond a movement threshold in a three-dimensional environment in accordance with some embodiments. FIGS. 10A-10L is a flow diagram of methods of facilitating movement of a virtual object beyond a movement threshold in a three-dimensional environment in accordance with some embodiments. The user interfaces in FIGS. 9A-9J are used to illustrate the processes in FIGS. 10A-10L. FIGS. 11A-11F illustrate example techniques for facilitating dynamic scaling of a virtual object in a three-dimensional environment in accordance with some embodiments. FIGS. 12A-12F is a flow diagram of methods of facilitating dynamic scaling of a virtual object in a three-dimensional environment in accordance with some embodiments. The user interfaces in FIGS. 11A-11F are used to illustrate the processes in FIGS. 12A-12F. FIGS. 13A-13L illustrate examples of a computer system facilitating inertial movement of a virtual object in a three-dimensional environment in accordance with some embodiments. FIG. 14 is a flow diagram of methods of facilitating inertial movement of a virtual object in accordance with some embodiments. The user interfaces in FIGS. 13A-13L are used to illustrate the processes in FIG. 14. FIGS. 15A-15J illustrate example techniques for facilitating gradual updating of one or more spatial properties of a virtual object in a three-dimensional environment in accordance with some embodiments. FIG. 16 is a flow diagram of methods of facilitating gradual updating of one or more spatial properties of a virtual object in a three-dimensional environment in accordance with some embodiments. The user interfaces in FIGS. 15A-15J are used to illustrate the processes in FIG. 16. FIGS. 17A-J illustrate examples of a computer system facilitating gradual reduction of offsets between a portion of a user and a virtual object in a three-dimensional environment in accordance with some embodiments. FIG. 18 is a flow diagram of methods of facilitating gradual reduction of offsets between a portion of a user and a virtual object in a three-dimensional environment in accordance with some embodiments. The user interfaces in FIGS. 17A-17J are used to illustrate the processes in FIG. 18. FIGS. 19A-19R illustrate examples of a computer system facilitating rotation of a volumetric virtual object in a three-dimensional environment in accordance with some embodiments. FIG. 20 is a flow diagram of methods of facilitating rotation of a volumetric virtual object in a three-dimensional environment in accordance with some embodiments. The user interfaces in FIGS. 19A-19R are used to illustrate the processes in FIG. 20.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

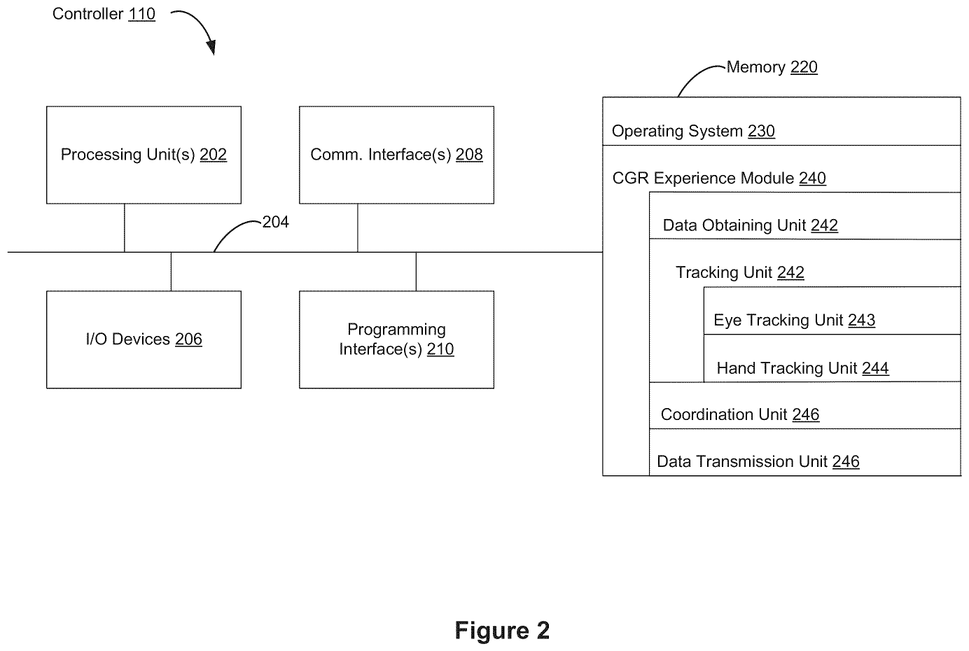

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

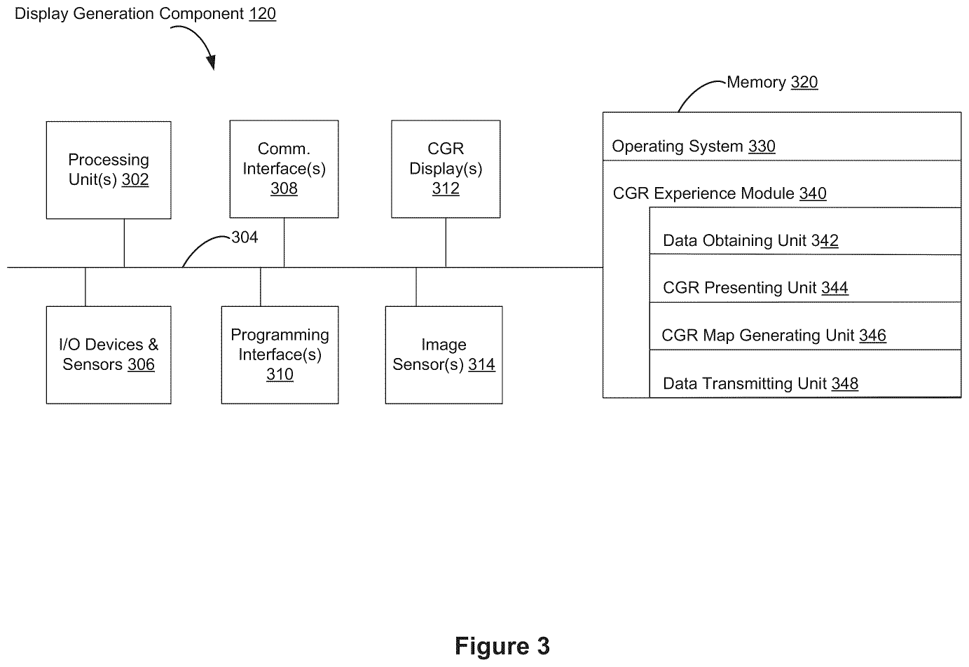

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an MID, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

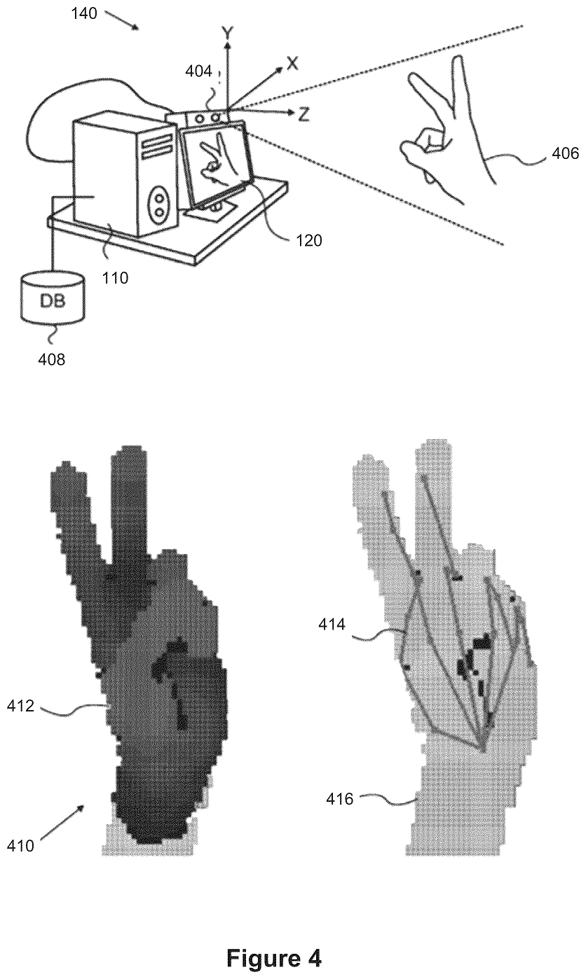

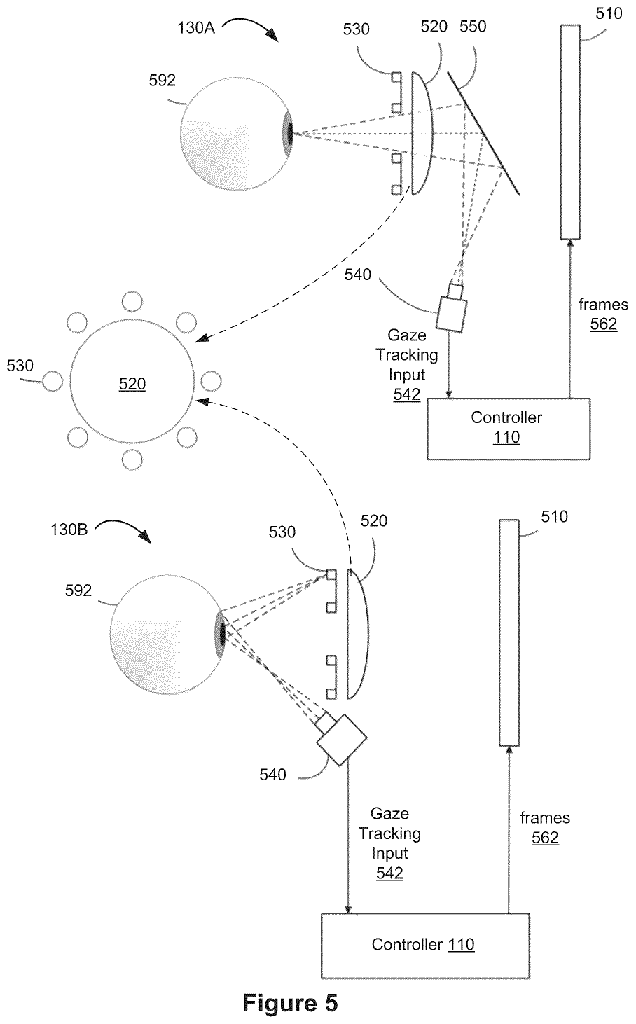

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

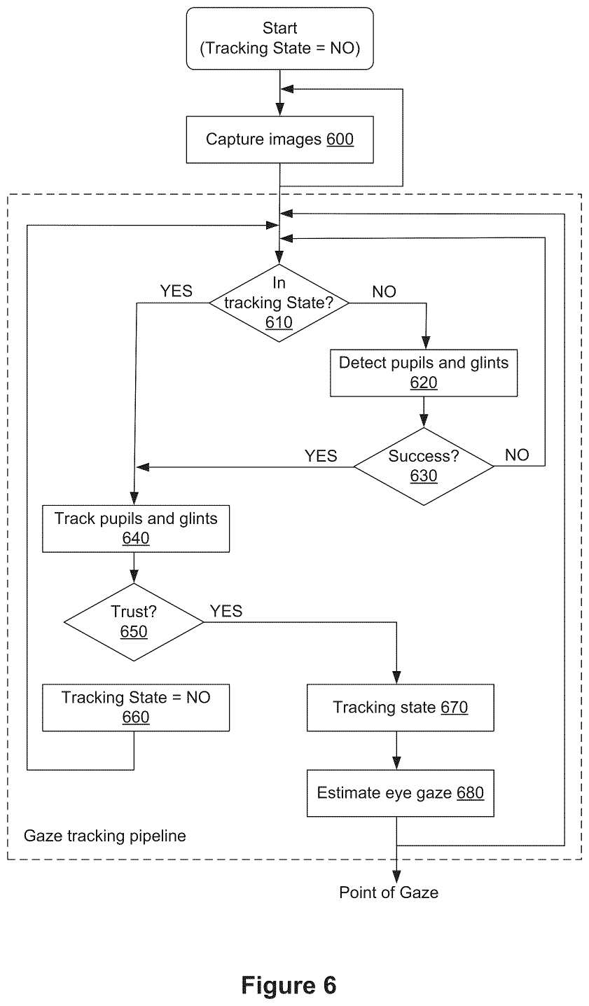

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7J illustrate examples of a computer system facilitating movement of a virtual object in a three-dimensional environment in accordance with some embodiments.

FIG. 7A illustrates a computer system 101 (e.g., an electronic device) displaying, via a display generation component (e.g., display generation component 120 of FIG. 1), a three-dimensional environment 702 from a viewpoint of a user 726 (e.g., facing the back wall of the physical environment in which computer system 101 is located, as shown in side view of legend 720). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the computer system 101 is in communication with a touchpad 730 that is configured to detect touch input (e.g., via a contact provided by a finger of a hand of the user 726). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 702. For example, three-dimensional environment 702 includes a representation 722a of a coffee table, which is optionally a representation of a physical coffee table in the physical environment, and a representation 724a of a sofa, which is optionally a representation of a physical sofa in the physical environment.

In FIG. 7A, three-dimensional environment 702 also includes a virtual object 706a (e.g., “Window 1,” corresponding to virtual object 706b in the side view of the legend 720). In some embodiments, the virtual object 706a is optionally a user interface of an application containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 7A, the virtual object 706a is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 702, such as the content described below with reference to method 800.

In some embodiments, virtual objects are displayed in three-dimensional environment 702 with respective orientations relative to a viewpoint of user 726 (e.g., prior to receiving input interacting with the virtual objects, which will be described later, in three-dimensional environment 702). As shown in FIG. 7A, the virtual object 706a optionally has a first orientation in the three-dimensional environment 702 (e.g., the front-facing surface of the virtual object 706a that faces the viewpoint of user 726 is flat relative to the viewpoint of user 726). It should be understood that the orientation of the object in FIG. 7A is merely exemplary and that other orientations are possible.

In some embodiments, the computer system 101 facilitates movement of the virtual object 706a within the three-dimensional environment 702. Particularly, in some embodiments, the computer system 101 rotates and/or tilts (e.g., changes the orientation of) the virtual object 706a in response to detecting user input based on an angle of elevation of the virtual object 706a relative to a location of a head of the user 726. For example, as shown in FIG. 7A, the virtual object 706b has a first angle of elevation 712 (e.g., measured between a center of the head of the user 726 and a center of the virtual object 706b) relative a reference ray 710 extending from the center of the head of the user 726 in the three-dimensional environment 702, as shown in the legend 720. In some embodiments, the reference ray 710 is parallel to a surface or ground of the three-dimensional environment 702, such as a floor of the physical environment in which the computer system 101 is located and on which the user 726 is positioned. In the example of FIG. 7A, while the virtual object 706a is displayed in the three-dimensional environment 702, the virtual object 706a has a starting or initial angle of elevation of zero degrees (e.g., the first angle of elevation 712 is parallel to the reference ray 710, as shown in the legend 720). Additionally, in some embodiments, the computer system 101 measures the center of the user's head based on a location of the computer system 101 in the physical environment relative to the head of the user in the physical environment. For example, the directly measures the center of the user's head (e.g., using the sensors 314) and/or calculates (e.g., estimates) the center of the user's head based on a distance between the user 726 and the computer system 101 in the physical environment. Additional details regarding the determination of the angle of elevation of the virtual object 706a relative to the head of the user 726 are provided below with reference to method 800.

In FIG. 7A, the computer system 101 detects an input provided by hand 703a corresponding to a request to move the virtual object 706a within the three-dimensional environment 702. For example, as shown in FIG. 7A, the computer system 101 detects hand 703a provide an air gesture, such as an air pinch and drag gesture in which an index finger and thumb of the hand of the user come together to make contact, while a gaze 721 of the user 726 is directed to the virtual object 706a, followed by movement of the hand 703a rightward while maintaining the pinch hand shape. Alternatively, in some embodiments, the computer system 101 detects an air toss gesture in which the hand 703a of the user mimics tossing/throwing the virtual object 706a in the three-dimensional environment 702. For example, the computer system 101 detects the index finger and the thumb of the hand 703a come together to make contact, while the gaze 721 is directed to the virtual object 706a, followed by a flicking or tossing motion while maintaining the pinch hand shape.

In some embodiments, as shown in FIG. 7B, in response to detecting the input provided by the hand 703a in FIG. 7A, the computer system 101 moves the virtual object 706a in the three-dimensional environment 702 in accordance with the movement of the hand 703a. For example, as shown in FIG. 7B, the computer system 101 moves the virtual object 706a rightward in the three-dimensional environment 702 relative to the viewpoint of the user 726. In some embodiments, moving the virtual object 706a in the three-dimensional environment 702 includes rotating the virtual object 706a relative to the viewpoint of the user 726. For example, as shown in FIG. 7B, in response to detecting the rightward movement of the hand 703b, the computer system 101 rotates the virtual object 706a clockwise in the three-dimensional environment 702 relative to the viewpoint of the user 726. In some embodiments, as shown in the legend 720 in FIG. 7B, the computer system 101 rotates the virtual object 706a about a rotation axis 713-1 (e.g., a vertical axis) that is through the center of the head of the user 726. In some embodiments, as discussed in more detail below, the computer system 101 updates the rotation axis 713-1 based on the angle of elevation 712 of the virtual object 706b relative to the head of the user 726 (e.g., relative to the ray 710).

In some embodiments, the computer system 101 changes the orientation of the virtual object 706a in the three-dimensional environment 702 when the virtual object 706a is moved horizontally in the three-dimensional environment 702. For example, as shown in FIG. 7B, when the virtual object 706a is moved rightward in the three-dimensional environment 702 in accordance with the movement of the hand 703a relative to the viewpoint of the user 726, the computer system 101 tilts the virtual object 706a, as illustrated by the tilting of the virtual object 706b in the legend 720. Particularly, in FIG. 7B, in some embodiments, the computer system 101 changes the orientation of the virtual object 706a such that the front-facing surface of the virtual object 706a continues to face toward the viewpoint of the user 726. In some embodiments, as shown in FIG. 7B, the computer system 101 tilts the virtual object 706a irrespective of a location of the gaze 721 of the user 726. For example, as shown in FIG. 7B, the computer system 101 tilts the virtual object 706a irrespective of the gaze 721 being directed away from the virtual object 706a in the three-dimensional environment 702.

In FIG. 7B, the computer system 101 detects an input provided by hand 703b corresponding to a request to move the virtual object 706a within the three-dimensional environment 702. For example, as shown in FIG. 7B, the computer system 101 detects hand 703b provide an air gesture, such as an air pinch and drag gesture, as similarly discussed above, that includes movement of the hand 703b upward. In some embodiments, as shown in FIG. 7C, in response to detecting the input provided by the hand 703b in FIG. 7B, the computer system 101 moves the virtual object 706a in the three-dimensional environment 702 in accordance with the movement of the hand 703b. For example, as shown in FIG. 7C, the computer system 101 moves the virtual object 706a upward in the three-dimensional environment 702 relative to the viewpoint of the user 726.

In some embodiments, the computer system 101 changes the orientation of the virtual object 706a in the three-dimensional environment 702 based on the angle of elevation 712 of the virtual object 706a relative to the head of the user 726. Particularly, in some embodiments, the computer system 101 changes the orientation of the virtual object 706a (e.g., rotates the virtual object 706a about a horizontal axis through (e.g., a center of) the virtual object 706a) when the virtual object 706a is moved vertically in the three-dimensional environment 702 if the angle of elevation 712 of the virtual object 706a is outside of a first range of vertical angles (e.g., represented by range 715-1 in the legend 720), such as the first range of vertical angles provided below with reference to method 800, relative to the head of the user 726. In FIG. 7C, when the virtual object 706a is moved vertically in the three-dimensional environment 702 in accordance with the movement of the hand 703b, as shown in the legend 720, the computer system 101 updates the angle of elevation 712, which lies within the first range of vertical angles 715-1 discussed above. Accordingly, as shown in FIG. 7C, in some embodiments, when the computer system 101 moves the virtual object 706a vertically in the three-dimensional environment 702 in accordance with the movement of the hand 703b, the computer system 101 forgoes changing the orientation of the virtual object 706a in the three-dimensional environment 702. For example, as shown in FIG. 7C, the front-facing surface of the virtual object 706a remains tilted/slightly angled leftward (e.g., as previously shown in FIG. 7B) relative to the viewpoint of the user but is not tilted/slightly angled downward to face toward the viewpoint of the user 726 when the virtual object 706a is moved vertically in the three-dimensional environment 702.

Additionally, as mentioned above, the computer system 101 updates the rotation axis 713-1 shown in the legend 720 about which the virtual object 706a is rotated in the three-dimensional environment 702 (e.g., in response to horizontal movement of the virtual object 706a) based on a change in the angle of elevation 712 of the virtual object 706b shown in the legend 720. In some embodiments, the computer system 101 updates the rotation axis 713-1 if the angle of elevation 712 of the virtual object 706a is outside a first range of angles of elevation, such as the angles of elevation provided below with reference to method 800, relative to the head of the user 726. In some embodiments, in FIG. 7C, a maximum value in the first range of angles of elevation is outside the first range of vertical angles 715-1 discussed above. In FIG. 7C, because the updated angle of elevation 712 is within the first range of vertical angles 715-1 after the movement of the virtual object 706a vertically in the three-dimensional environment 702, the angle of elevation 712 is thus within the first range of angles of elevation. Accordingly, as shown in FIG. 7C, the computer system 101 forgoes updating the rotation axis 713-1 when the angle of elevation 712 is updated based on the vertical movement of the virtual object 706a in the three-dimensional environment 702.

In FIG. 7C, the computer system 101 detects an input provided by hand 703c corresponding to a request to move the virtual object 706a within the three-dimensional environment 702. For example, as shown in FIG. 7C, the computer system 101 detects hand 703c provide an air gesture, such as an air pinch and drag gesture, as similarly discussed above, that includes movement of the hand 703c further upward while the gaze 721 is directed to the virtual object 706a. In some embodiments, as shown in FIG. 7D, in response to detecting the input provided by the hand 703c in FIG. 7C, the computer system 101 moves the virtual object 706a in the three-dimensional environment 702 in accordance with the movement of the hand 703c. For example, as shown in FIG. 7D, the computer system 101 moves the virtual object 706a further upward in the three-dimensional environment 702 relative to the viewpoint of the user 726.

In some embodiments, as previously discussed above, the computer system 101 changes the orientation of the virtual object 706a (e.g., rotates the virtual object 706a about a horizontal axis through the virtual object 706a) in the three-dimensional environment 702 if the angle of elevation 712 of the virtual object 706a is outside of the first range of vertical angles 715-1, in the legend 720, discussed above after the vertical movement of the virtual object 706a. As shown in FIG. 7D, when the computer system 101 moves the virtual object 706a further upward in the three-dimensional environment 702 relative to the viewpoint of the user 726, the computer system 101 updates the angle of elevation 712 of the virtual object 706a, as shown in the legend 720. In some embodiments, because the updated angle of elevation 712 of the virtual object 706a is greater than (e.g., outside of) the first range of vertical angles 715-1 as shown in the legend 720 in FIG. 7D, the computer system 101 changes the orientation of the virtual object 706a in the three-dimensional environment 702, as shown by the downward tilt of the virtual object 706b in the legend 720, in response to the upward movement of the hand 703c. For example, as shown in FIG. 7D, the front-facing surface of the virtual object 706a tilts downward in the three-dimensional environment 702 to face toward the viewpoint of the user 726, while still remaining slightly angled/tilted leftward as shown previously in FIG. 7C. In some embodiments, when the changing the orientation of the virtual object 706a in the three-dimensional environment 702, the computer system 101 gradually changes the orientation as the angle of elevation 712 of the virtual object 706b is increased past the first range of vertical angles 715-1 discussed above. For example, an amount (e.g., in degrees) that the virtual object 706a is tilted in the three-dimensional environment 702 is based on (e.g., is equal to or is proportional to) an amount (e.g., in degrees) that the angle of elevation 712 of the virtual object 706b is increased past a maximum value of the first range of vertical angles 715-1 in the legend 720.

Additionally, in some embodiments, as previously discussed above, the computer system 101 updates the rotation axis 713-1 shown in the legend 720 about which the virtual object 706a is rotated in the three-dimensional environment 702 (e.g., in response to horizontal movement of the virtual object 706a) if the angle of elevation 712 of the virtual object 706a is outside the first range of angles of elevation discussed above. In some embodiments, as shown in FIG. 7D, when the virtual object 706a is moved vertically in the three-dimensional environment 702 in accordance with the upward movement of the hand 703c, the angle of elevation 712 of the virtual object 706b shown in the legend 720 is increased past the first range of angles of elevation (e.g., which is greater than the first range of vertical angles 715-1). Accordingly, as shown in FIG. 7D, the computer system 101 updates the rotation axis to be a second rotation axis 713-2 that is based on the updated angle of elevation 712. In some embodiments, as shown in the legend 720 in FIG. 7D, the second rotation axis 713-2 is tilted/slightly angled upward due to the increase in the angle of elevation 712.

In FIG. 7D, the computer system 101 detects an input provided by hand 703d corresponding to a request to move the virtual object 706a within the three-dimensional environment 702. For example, as shown in FIG. 7D, the computer system 101 detects the hand 703d provide an air gesture, such as an air pinch and drag gesture, as similarly discussed above, that includes movement of the hand 703d leftward while the gaze 721 is directed to the virtual object 706a. In some embodiments, as shown in FIG. 7E, in response to detecting the input provided by the hand 703d in FIG. 7D, the computer system 101 moves the virtual object 706a in the three-dimensional environment 702 in accordance with the movement of the hand 703d. For example, as shown in FIG. 7E, the computer system 101 moves the virtual object 706a leftward in the three-dimensional environment 702 relative to the viewpoint of the user 726, including rotating the virtual object 706a (e.g., counterclockwise) about the second rotation axis 713-2.

In some embodiments, as shown in the legend 720 in FIG. 7E, moving the virtual object 706a in the three-dimensional environment 702 does not cause the computer system 101 to update the second rotation axis 713-2 because the angle of elevation 712 of the virtual object 706b does not change in response to the movement. Accordingly, as shown in FIG. 7E, the computer system 101 forgoes changing the orientation of the virtual object 706a (e.g., rotating the virtual object 706a about a horizontal axis through the virtual object 706a). For example, as shown in the legend 720 in FIG. 7E, when the computer system 101 rotates the virtual object 706b (e.g., counterclockwise) about the second rotation axis 713-2 in the three-dimensional environment 702, the virtual object 706b remains tilted downward toward the viewpoint of the user 726 as shown previously in FIG. 7D.

In FIG. 7E, the computer system 101 detects a change in position of the head of the user 726 in the physical environment of the computer system 101. For example, as shown in the legend 720 in FIG. 7E, the computer system 101 detects the head of the user 726 lower (e.g., in elevation) relative to the virtual object 706b in the three-dimensional environment 702. In some embodiments, as shown in FIG. 7E, the computer system 101 detects the change in the position of the head of the user 726 without detecting any input provided by the hand 703d.

In some embodiments, as shown in FIG. 7F, in response to detecting the change in the position of the head of the user 726, the computer system 101 updates the viewpoint of the user 726 based on the new position of the head of the user 726 in the physical environment. For example, the lowering of the head of the user 726 that is wearing the head-mounted display corresponds to a lowering of the viewpoint of the user 726 relative to the three-dimensional environment 702. In some embodiments, updating the viewpoint of the user 726 causes the portion of the three-dimensional environment 702, including the physical environment surrounding the display generation component 120, in the field of view of the user 726, to change in accordance with the updated viewpoint. In some embodiments, as shown in FIG. 7F, when the computer system 101 updates the viewpoint of the user 726, the representation of the coffee table 722a, the representation of the sofa 724a, and the virtual object 706a are shifted upward in the field of view of the user 726 (e.g., due to the lowering of the viewpoint of the user 726 caused by the lowering of the head of the user 726 in FIG. 7E).

In some embodiments, when the computer system 101 updates the viewpoint of the user 726 as discussed above, the computer system 101 forgoes rotating the virtual object 706a and/or changing the orientation of the virtual object 706a in the three-dimensional environment 702. Particularly, in some embodiments, as shown in the legend 720 in FIG. 7F, the computer system 101 forgoes updating the angle of elevation 712 of the virtual object 706b and/or the second rotation axis 713-2 in response to detecting the change in position of the head of the user 726. For example, as shown in the legend 720 in FIG. 7F, a “true” angle of elevation 714 of the virtual object 706b relative to the updated location of the head of the user 726 (e.g., after the computer system 101 detects the lowering of the head of the user 726) does not correspond to the current angle of elevation 712 of the virtual object 706b.

In some embodiments, as discussed below, after detecting the change in the position of the head of the user 726, the computer system 101 updates the angle of elevation 712 of the virtual object 706b and/or the second rotation axis 713-2 after detecting input corresponding to a request to move the virtual object 706b in the three-dimensional environment 702. For example, in FIG. 7F, the computer system 101 detects an input provided by hand 703e corresponding to a request to move the virtual object 706a within the three-dimensional environment 702. As shown in FIG. 7F, the computer system 101 optionally detects the hand 703e provide an air gesture, such as an air pinch and drag gesture, as similarly discussed above, that includes movement of the hand 703e leftward while the gaze 721 is directed to the virtual object 706a.

In some embodiments, as shown in FIG. 7G, in response to detecting the input provided by the hand 703e in FIG. 7F, the computer system 101 moves the virtual object 706a in the three-dimensional environment 702 in accordance with the movement of the hand 703e. For example, as shown in FIG. 7G, the computer system 101 moves the virtual object 706a leftward in the three-dimensional environment 702 relative to the viewpoint of the user 726. In some embodiments, as mentioned above, in response to detecting the input provided by the hand 703e, the computer system 101 updates the angle of elevation 712 of the virtual object 706b and/or the rotation axis based on the new position of the head of the user 726 as shown in the legend 720 in FIG. 7G. For example, as shown in FIG. 7G, when the computer system 101 moves the virtual object 706a leftward in the three-dimensional environment 702, the computer system 101 rotates the virtual object 706b (e.g., counterclockwise) about a third rotation axis 713-3 which has been updated from the second rotation axis 713-3 based on the updated angle of elevation 712 of the virtual object 706b. In some embodiments, as shown in the legend 720 in FIG. 7G, the third rotation axis 713-3 is angled upward (e.g., counterclockwise) further than the second rotation axis 713-2 in FIG. 7F based on the increase in the angle of elevation 712 of the virtual object 706b (e.g., the lowering of the head of the user 726 corresponds to an increase in the angle of elevation 712 when the input from the hand 703e is detected).

Additionally, in some embodiments, the computer system 101 changes the orientation of the virtual object 706b in the three-dimensional environment 702 based on the updated angle of elevation 712, as shown in the legend 720 in FIG. 7G. For example, as shown in FIG. 7G, the computer system 101 tilts/slightly angles the virtual object 706a downward in the three-dimensional environment 702 relative to the viewpoint of the user 726, such that the front-facing surface of the virtual object 706a is oriented toward the viewpoint of the user 726. Accordingly, as shown in the legend 720, from FIGS. 7F-7G, in response to detecting the input provided by the hand 703e in FIG. 7F, the computer system 101 optionally rotates (e.g., tilts) the virtual object 706b about a vertical axis (e.g., third rotation axis 713-3) through the center of the head of the user 726 and optionally rotates (e.g., tilts) the virtual object 706b about a horizontal axis through (e.g., a center of) the virtual object 706b based on the updated angle of elevation 712.

FIG. 7F1 illustrates similar and/or the same concepts as those shown in FIG. 7F (with many of the same reference numbers). It is understood that unless indicated below, elements shown in FIG. 7F1 that have the same reference numbers as elements shown in FIGS. 7A-7J have one or more or all of the same characteristics. FIG. 7F1 includes computer system 101, which includes (or is the same as) display generation component 120. In some embodiments, computer system 101 and display generation component 120 have one or more of the characteristics of computer system 101 shown in FIGS. 7F and 7A-7J and display generation component 120 shown in FIGS. 1 and 3, respectively, and in some embodiments, computer system 101 and display generation component 120 shown in FIGS. 7A-7J have one or more of the characteristics of computer system 101 and display generation component 120 shown in FIG. 7F1.

In FIG. 7F1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7J.

In FIG. 7F1, display generation component 120 is illustrated as displaying content that optionally corresponds to the content that is described as being displayed and/or visible via display generation component 120 with reference to FIGS. 7A-7J. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7F1.

Display generation component 120 has a field of view (e.g., a field of view captured by external image sensors 314b and 314c and/or visible to the user via display generation component 120, indicated by dashed lines in the overhead view) that corresponds to the content shown in FIG. 7F1. Because display generation component 120 is optionally a head-mounted device, the field of view of display generation component 120 is optionally the same as or similar to the field of view of the user.

In FIG. 7F1, the user is depicted as performing an air pinch gesture (e.g., with hand 703e) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 7A-7J.

In some embodiments, computer system 101 responds to user inputs as described with reference to FIGS. 7A-7J.

In the example of FIG. 7F1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7J and/or described with reference to the corresponding method(s) are optionally implemented on computer system 101 and display generation unit 120 in a manner similar or analogous to that shown in FIG. 7F1.

In FIG. 7G, the computer system 101 detects movement of the viewpoint of the user 726 without detecting input (e.g., provided by the hand 703e) directed to the virtual object 706a in the three-dimensional environment 702. For example, as shown in FIG. 7G, the computer system 101 detects hand 705a that is holding the computer system 101 move/rotate in a leftward direction (e.g., a counterclockwise direction about a body of the user 726). In some embodiments, as similarly discussed above, movement of the viewpoint of the user 726 causes the portion of the three-dimensional environment 702, including the physical environment surrounding the display generation component 120, in the field of view of the user 726, to change in accordance with the movement of the viewpoint. In some embodiments, the input for changing the viewpoint of the user 726 corresponds to a movement of the head of the user 726 in the physical environment (e.g., movement of the head-mounted display worn by the user 726 in the physical environment).

In some embodiments, as shown in FIG. 7H, in response to detecting movement of the hand 705a in FIG. 7G, the computer system 101 updates display of the three-dimensional environment 702 relative to the new viewpoint of the user 726 in accordance with the movement. For example, as shown in in FIG. 7G, the computer system 101 is moved/angled counterclockwise about the body of the user 726, such that the computer system 101 is facing the front-facing surface/portion of the virtual object 706b in the three-dimensional environment 702, as indicated in the legend 720. In some embodiments, as shown in FIG. 7H and as similarly discussed above, in response to detecting the movement of the viewpoint of the user 726, the computer system 101 forgoes rotating and/or changing the orientation of the virtual object 706a in the three-dimensional environment 702. For example, as shown in the legend 720 of FIG. 7H, the computer system 101 forgoes tilting the virtual object 706b relative to a horizontal axis through (e.g., a center of) the virtual object 706b and forgoes tilting the virtual object 706b relative to a (e.g., offset) vertical axis (e.g., the third rotation axis 713-3) through the center of the head of the user 726 in the three-dimensional environment 702. Particularly, as previously discussed above, the computer system 101 optionally forgoes rotating and/or changing the orientation of the virtual object 706a in the three-dimensional environment 702 because, in FIG. 7H, the computer system 101 does not detect input corresponding to a request to move the virtual object 706a within the three-dimensional environment 702 (e.g., such as one of the inputs discussed above).

In FIG. 7H, the computer system 101 detects movement of a position of the viewpoint of the user 726 relative to the three-dimensional environment 702 without detecting input (e.g., provided by the hand 703e) directed to the virtual object 706a in the three-dimensional environment 702. For example, as shown in FIG. 7H, the computer system 101 detects hand 705b that is holding the computer system 101 translate in a leftward direction corresponding to a change in position of the display generation component 120 in the physical environment surrounding the display generation component 120 (e.g., corresponding to a leftward movement of the body of the user 726).

In some embodiments, as shown in FIG. 7I, in response to detecting the movement of the position of the viewpoint of the user 726, the computer system 101 updates the portion of the three-dimensional environment 702 in the field of view of the user 726 based on the new position of the viewpoint. For example, as shown in FIG. 7I, the virtual object 706a, the representation of the coffee table 722a and the representation of the sofa 724a are shifted rightward in the user's field of view relative to the new viewpoint. In some embodiments, as shown in in FIG. 7I, when the display generation component 120 of the computer system 101 is shifted leftward in the physical environment, the front-facing surface of the virtual object 706b visually appears to be slightly angled/tilted to the right (e.g., while remaining tilted downward) from the new viewpoint of the user 726, as indicated in the legend 720.

In some embodiments, as similarly discussed above, in response to detecting the change in position of the viewpoint of the user 726 relative to the three-dimensional environment 702, the computer system 101 forgoes rotating and/or changing the orientation of the virtual object 706a in the three-dimensional environment 702. For example, as shown in the legend 720 of FIG. 7I, the computer system 101 forgoes tilting the virtual object 706b relative to a horizontal axis through (e.g., a center of) the virtual object 706b and forgoes tilting the virtual object 706b relative to a (e.g., offset) vertical axis (e.g., the third rotation axis 713-3) through the center of the head of the user 726 in the three-dimensional environment 702. Particularly, as previously discussed above, the computer system 101 optionally forgoes rotating and/or changing the orientation of the virtual object 706a in the three-dimensional environment 702 because, in FIG. 7I, the computer system 101 has not yet detected input corresponding to a request to move the virtual object 706a within the three-dimensional environment 702 (e.g., as discussed in more detail below).

In FIG. 7I, after detecting the change in the position of the viewpoint of the user 726, the computer system 101 detects a first input provided by the hand 703f corresponding to a request to move the virtual object 706a within the three-dimensional environment 702. For example, as shown in FIG. 7I, the computer system 101 detects the hand 703 provide an air gesture, such as an air pinch and drag gesture in which an index finger and thumb of the hand of the user come together to make contact, while the gaze 721 of the user 726 is directed to the virtual object 706a, followed by movement of the hand 703f leftward while maintaining the pinch hand shape. Additionally, in FIG. 7I, the computer system detects a second input provided by hand 707a corresponding to a selection of the virtual object 706a for movement of the virtual object 706a within the three-dimensional environment 702. For example, as shown in FIG. 7I, the computer system 101 detects the hand 707a provide an air pinch gesture while the gaze 721 of the user is directed to the virtual object 706a in the three-dimensional environment 702 (e.g., and before detecting any movement of the hand 707a for moving the virtual object 706a in the three-dimensional environment 702). It should be understood that while multiple hands and corresponding inputs are illustrated in FIG. 7I, such hands and inputs need not be detected by computer system 101 concurrently; rather, in some embodiments, computer system 101 independently responds to the hands and/or inputs illustrated and described in response to detecting such hands and/or inputs independently.

In some embodiments, as shown in FIG. 7J, in response to detecting the first input provided by the hand 703f or the second input provided by the hand 707a, the computer system 101 rotates and/or changes the orientation of the virtual object 706a in the three-dimensional environment 702 based on the updated position of the viewpoint of the user 726 in FIG. 7I. Particularly, as previously discussed above, the computer system 101 optionally rotates and/or changes the orientation of the virtual object 706a in the three-dimensional environment 702 because the computer system 101 detected (e.g., in FIG. 7I) input for moving the virtual object 706a (e.g., the first input and/or the second input discussed above). In some embodiments, as shown in the legend 720 in FIG. 7J, the computer system 101 rotates (e.g., tilts) the virtual object 706b about the third rotation axis 713-3 in the three-dimensional environment 702 based on the updated position of the viewpoint of the user 726 in FIG. 7I. For example, as shown in FIG. 7J, the computer system 101 tilts the front-facing surface of the virtual object 706a leftward relative to the viewpoint of the user 726 such that the virtual object 706a remains oriented to face toward the viewpoint in the three-dimensional environment 702, as similarly discussed herein above. Additionally, as similarly discussed above, the computer system 101 forgoes tilting the front-facing surface of the virtual object 706a upward or downward (e.g., about a horizontal axis through the virtual object 706a) relative to the viewpoint of the user 726 because the change in the position of the viewpoint of the user 726 discussed above with reference to FIG. 7I did not cause the angle of elevation (e.g., 712 in the legend 720) to change relative to the location corresponding to the head of the user 726 (e.g., referenced to the ray 710 in the legend 720).

FIGS. 7A-7J illustrate examples of a computer system facilitating movement of a virtual object in a three-dimensional environment in accordance with some embodiments.

FIG. 7A illustrates a computer system 101 (e.g., an electronic device) displaying, via a display generation component (e.g., display generation component 120 of FIG. 1), a three-dimensional environment 702 from a viewpoint of a user 726 (e.g., facing the back wall of the physical environment in which computer system 101 is located, as shown in side view of legend 720). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the computer system 101 is in communication with a touchpad 730 that is configured to detect touch input (e.g., via a contact provided by a finger of a hand of the user 726). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 702. For example, three-dimensional environment 702 includes a representation 722a of a coffee table, which is optionally a representation of a physical coffee table in the physical environment, and a representation 724a of a sofa, which is optionally a representation of a physical sofa in the physical environment.

In FIG. 7A, three-dimensional environment 702 also includes a virtual object 706a (e.g., “Window 1,” corresponding to virtual object 706b in the side view of the legend 720). In some embodiments, the virtual object 706a is optionally a user interface of an application containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 7A, the virtual object 706a is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 702, such as the content described below with reference to method 800. Additionally, in some embodiments, as shown in FIG. 7A, the virtual object 706a is displayed with an exit option 708 and a grabber bar 709. In some embodiments, the exit option 708 is selectable to initiate a process to cease displaying the virtual object 706a in the three-dimensional environment 702. For example, in response to detecting a selection of the exit option 708, the computer system 101 ceases displaying the virtual object 706a in the three-dimensional environment 702. In some embodiments, as discussed below, the grabber bar 709 is selectable to initiate a process to move the virtual object 706a within the three-dimensional environment 702.

In some embodiments, virtual objects are displayed in three-dimensional environment 702 with respective orientations relative to a viewpoint of user 726 (e.g., prior to receiving input interacting with the virtual objects, which will be described later, in three-dimensional environment 702). As shown in FIG. 7A, the virtual object 706a optionally has a first orientation in the three-dimensional environment 702 (e.g., the front-facing surface of the virtual object 706a that faces the viewpoint of user 726 is flat relative to the viewpoint of user 726). It should be understood that the orientation of the object in FIG. 7A is merely exemplary and that other orientations are possible.

In some embodiments, the computer system 101 facilitates movement of the virtual object 706a within the three-dimensional environment 702. Particularly, in some embodiments, the computer system 101 rotates and/or tilts (e.g., changes the orientation of) the virtual object 706a in response to detecting user input based on an angle of elevation of the virtual object 706a relative to a location of a head of the user 726. For example, as shown in FIG. 7A, the virtual object 706b has a first angle of elevation 712 (e.g., measured between a center of the head of the user 726 and a center of the virtual object 706b) relative a reference ray 710 extending from the center of the head of the user 726 in the three-dimensional environment 702, as shown in the legend 720. In some embodiments, the reference ray 710 is parallel to a surface or ground of the three-dimensional environment 702, such as a floor of the physical environment in which the computer system 101 is located and on which the user 726 is positioned. In the example of FIG. 7A, while the virtual object 706a is displayed in the three-dimensional environment 702, the virtual object 706a has a starting or initial angle of elevation of zero degrees (e.g., the first angle of elevation 712 is parallel to the reference ray 710, as shown in the legend 720). Additionally, in some embodiments, the computer system 101 measures the center of the user's head based on a location of the computer system 101 in the physical environment relative to the head of the user in the physical environment. For example, the directly measures the center of the user's head (e.g., using the sensors 314) and/or calculates (e.g., estimates) the center of the user's head based on a distance between the user 726 and the computer system 101 in the physical environment. Additional details regarding the determination of the angle of elevation of the virtual object 706a relative to the head of the user 726 are provided below with reference to method 800.

In FIG. 7A, the computer system 101 detects an input provided by hand 703a corresponding to a request to move the virtual object 706a within the three-dimensional environment 702. For example, as shown in FIG. 7A, the computer system 101 detects hand 703a provide an air gesture, such as an air pinch and drag gesture in which an index finger and thumb of the hand of the user come together to make contact, while a gaze 721 of the user 726 is directed to the grabber bar 709 that is displayed with the virtual object 706a, followed by movement of the hand 703a rightward while maintaining the pinch hand shape. Alternatively, in some embodiments, the computer system 101 detects an air toss gesture in which the hand 703a of the user mimics tossing/throwing the virtual object 706a in the three-dimensional environment 702. For example, the computer system 101 detects the index finger and the thumb of the hand 703a come together to make contact, while the gaze 721 is directed to the virtual object 706a, followed by a flicking or tossing motion while maintaining the pinch hand shape.

In some embodiments, as shown in FIG. 7B, in response to detecting the input provided by the hand 703a in FIG. 7A, the computer system 101 moves the virtual object 706a in the three-dimensional environment 702 in accordance with the movement of the hand 703a. For example, as shown in FIG. 7B, the computer system 101 moves the virtual object 706a rightward in the three-dimensional environment 702 relative to the viewpoint of the user 726. In some embodiments, moving the virtual object 706a in the three-dimensional environment 702 includes rotating the virtual object 706a relative to the viewpoint of the user 726. For example, as shown in FIG. 7B, in response to detecting the rightward movement of the hand 703b, the computer system 101 rotates the virtual object 706a clockwise in the three-dimensional environment 702 relative to the viewpoint of the user 726. In some embodiments, as shown in the legend 720 in FIG. 7B, the computer system 101 rotates the virtual object 706a about a rotation axis 713-1 (e.g., a vertical axis) that is through the center of the head of the user 726. In some embodiments, as discussed in more detail below, the computer system 101 updates the rotation axis 713-1 based on the angle of elevation 712 of the virtual object 706b relative to the head of the user 726 (e.g., relative to the ray 710).

In some embodiments, the computer system 101 changes the orientation of the virtual object 706a in the three-dimensional environment 702 when the virtual object 706a is moved horizontally in the three-dimensional environment 702. For example, as shown in FIG. 7B, when the virtual object 706a is moved rightward in the three-dimensional environment 702 in accordance with the movement of the hand 703a relative to the viewpoint of the user 726, the computer system 101 tilts the virtual object 706a, as illustrated by the tilting of the virtual object 706b in the legend 720. Particularly, in FIG. 7B, in some embodiments, the computer system 101 changes the orientation of the virtual object 706a such that the front-facing surface of the virtual object 706a continues to face toward the viewpoint of the user 726. In some embodiments, as shown in FIG. 7B, the computer system 101 tilts the virtual object 706a irrespective of a location of the gaze 721 of the user 726. For example, as shown in FIG. 7B, the computer system 101 tilts the virtual object 706a irrespective of the gaze 721 being directed away from the virtual object 706a in the three-dimensional environment 702.

In FIG. 7B, the computer system 101 detects an input provided by hand 703b corresponding to a request to move the virtual object 706a within the three-dimensional environment 702. For example, as shown in FIG. 7B, the computer system 101 detects hand 703b provide an air gesture, such as an air pinch and drag gesture, as similarly discussed above, that includes movement of the hand 703b upward. In some embodiments, as shown in FIG. 7C, in response to detecting the input provided by the hand 703b in FIG. 7B, the computer system 101 moves the virtual object 706a in the three-dimensional environment 702 in accordance with the movement of the hand 703b. For example, as shown in FIG. 7C, the computer system 101 moves the virtual object 706a upward in the three-dimensional environment 702 relative to the viewpoint of the user 726.

FIG. 7C includes computer system 101, which includes (or is the same as) display generation component 120. In some embodiments, computer system 101 and display generation component 120 have one or more of the characteristics of computer system 101 shown in FIGS. 7A-7B and display generation component 120 shown in FIGS. 1 and 3, respectively, and in some embodiments, computer system 101 and display generation component 120 shown in FIGS. 7A-7B have one or more of the characteristics of computer system 101 and display generation component 120 shown in FIG. 7C.

In FIG. 7C, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7B.

In FIG. 7C, display generation component 120 is illustrated as displaying content that optionally corresponds to the content that is described as being displayed and/or visible via display generation component 120 with reference to FIGS. 7A-7B. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7C.

Display generation component 120 has a field of view (e.g., a field of view captured by external image sensors 314b and 314c and/or visible to the user via display generation component 120, indicated by dashed lines in the overhead view) that corresponds to the content shown in FIG. 7C, also referred to as a viewport (e.g., defined herein). Because display generation component 120 is optionally a head-mounted device, the field of view or viewport of display generation component 120 is optionally the same as or similar to the field of view of the user.

In some embodiments, computer system 101 responds to user inputs as described with reference to FIGS. 7A-7B.

In the example of FIG. 7C, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7B and/or described with reference to the corresponding method(s) are optionally implemented on computer system 101 and display generation component 120 in a manner similar or analogous to that shown in FIG. 7C.

In some embodiments, the computer system 101 changes the orientation of the virtual object 706a in the three-dimensional environment 702 based on the angle of elevation 712 of the virtual object 706a relative to the head of the user 726. Particularly, in some embodiments, the computer system 101 changes the orientation of the virtual object 706a (e.g., rotates the virtual object 706a about a horizontal axis through (e.g., a center of) the virtual object 706a) when the virtual object 706a is moved vertically in the three-dimensional environment 702 if the angle of elevation 712 of the virtual object 706a is outside of a first range of vertical angles θ (e.g., represented by range 715-1a in the legend 720), such as the first range of vertical angles provided below with reference to method 800, relative to the head of the user 726. In FIG. 7C, when the virtual object 706a is moved vertically in the three-dimensional environment 702 in accordance with the movement of the hand 703b, as shown in the legend 720, the computer system 101 updates the angle of elevation 712, which lies within the first range of vertical angles θ, represented by the range 715-1a discussed above. Accordingly, as shown in FIG. 7C, in some embodiments, when the computer system 101 moves the virtual object 706a vertically in the three-dimensional environment 702 in accordance with the movement of the hand 703b, the computer system 101 forgoes changing the orientation of the virtual object 706a in the three-dimensional environment 702. For example, as shown in FIG. 7C, the front-facing surface of the virtual object 706a remains tilted/slightly angled leftward (e.g., as previously shown in FIG. 7B) relative to the viewpoint of the user but is not tilted/slightly angled downward to face toward the viewpoint of the user 726 when the virtual object 706a is moved vertically in the three-dimensional environment 702.

In some embodiments, the first range of vertical angles θ is alternatively asymmetrical relative to the head of the user 726 (e.g., relative to reference ray 710 in the legend 720 as discussed above). For example, as shown in the legend 720 in FIG. 7C, the first range of vertical angles θ is symmetrical about the reference ray 710 (e.g., has the same number of angles above and below the reference ray 710, such as −5 degrees to 5 degrees). In some embodiments, the computer system 101 defines first range of vertical angles α, represented by range 715-1b in the legend 720, that is asymmetrical about the reference ray 710 (e.g., has a different number of angles above and below the reference ray 710, such as −2.5 degrees to 7.5 degrees). In some embodiments, an upper bound of the first range of vertical angles α (e.g., angles greater than zero degrees) is larger than a lower bound of the first range of vertical angles α, as shown in the legend 720 in FIG. 7C. As similarly discussed above, in some embodiments, after the movement of the virtual object 706a in the three-dimensional environment 702, the angle of elevation 712 of the virtual object lies within the first range of vertical angles α (e.g., represented by the range 715-1b, which causes the computer system 101 to forgo changing the orientation of the virtual object 706a in the three-dimensional environment 702.

Additionally, as mentioned above, the computer system 101 updates the rotation axis 713-1 shown in the legend 720 about which the virtual object 706a is rotated in the three-dimensional environment 702 (e.g., in response to horizontal movement of the virtual object 706a) based on a change in the angle of elevation 712 of the virtual object 706b shown in the legend 720. In some embodiments, the computer system 101 updates the rotation axis 713-1 if the angle of elevation 712 of the virtual object 706a is outside a first range of angles of elevation, such as the angles of elevation provided below with reference to method 800, relative to the head of the user 726. In some embodiments, in FIG. 7C, a maximum value in the first range of angles of elevation is outside the first range of vertical angles, represented by the range 715-1a or 715-1b discussed above. In FIG. 7C, because the updated angle of elevation 712 is within the first range of vertical angles, represented by the range 715-1a or 715-1b, after the movement of the virtual object 706a vertically in the three-dimensional environment 702, the angle of elevation 712 is thus within the first range of angles of elevation. Accordingly, as shown in FIG. 7C, the computer system 101 forgoes updating the rotation axis 713-1 when the angle of elevation 712 is updated based on the vertical movement of the virtual object 706a in the three-dimensional environment 702.

In FIG. 7C, the computer system 101 detects an input provided by hand 703c corresponding to a request to move the virtual object 706a within the three-dimensional environment 702. For example, as shown in FIG. 7C, the computer system 101 detects hand 703c provide an air gesture, such as an air pinch and drag gesture, as similarly discussed above, that includes movement of the hand 703c further upward in space while the gaze 721 is directed to the grabber bar 709 that is displayed with the virtual object 706a. In some embodiments, as shown in FIG. 7D, in response to detecting the input provided by the hand 703c in FIG. 7C, the computer system 101 moves the virtual object 706a in the three-dimensional environment 702 in accordance with the movement of the hand 703c. For example, as shown in FIG. 7D, the computer system 101 moves the virtual object 706a further upward in the three-dimensional environment 702 relative to the viewpoint of the user 726.

In some embodiments, as previously discussed above, the computer system 101 changes the orientation of the virtual object 706a (e.g., rotates the virtual object 706a about a horizontal axis through the virtual object 706a) in the three-dimensional environment 702 if the angle of elevation 712 of the virtual object 706a is outside of the first range of vertical angles θ, represented by the range 715-1a (and/or the first range of vertical angles α, represented by the range 715-1b), in the legend 720, discussed above after the vertical movement of the virtual object 706a. As shown in FIG. 7D, when the computer system 101 moves the virtual object 706a further upward in the three-dimensional environment 702 relative to the viewpoint of the user 726, the computer system 101 updates the angle of elevation 712 of the virtual object 706a, as shown in the legend 720. In some embodiments, because the updated angle of elevation 712 of the virtual object 706a is greater than (e.g., outside of) the first range of vertical angles, represented by the range 715-1a or 715-1b as shown in the legend 720 in FIG. 7D, the computer system 101 changes the orientation of the virtual object 706a in the three-dimensional environment 702, as shown by the downward tilt of the virtual object 706b in the legend 720, in response to the upward movement of the hand 703c. For example, as shown in FIG. 7D, the front-facing surface of the virtual object 706a tilts downward in the three-dimensional environment 702 to face toward the viewpoint of the user 726, while still remaining slightly angled/tilted leftward as shown previously in FIG. 7C. In some embodiments, when the changing the orientation of the virtual object 706a in the three-dimensional environment 702, the computer system 101 gradually changes the orientation as the angle of elevation 712 of the virtual object 706b is increased past the first range of vertical angles, represented by range 715-1a or 715-1b discussed above. For example, an amount (e.g., in degrees) that the virtual object 706a is tilted in the three-dimensional environment 702 is based on (e.g., is equal to or is proportional to) an amount (e.g., in degrees) that the angle of elevation 712 of the virtual object 706b is increased past a maximum value of the first range of vertical angles θ (e.g., represented by the range 715-1a) or α (e.g., represented by the range 715-1b) in the legend 720.

Additionally, in some embodiments, as previously discussed above, the computer system 101 updates the rotation axis 713-1 shown in the legend 720 about which the virtual object 706a is rotated in the three-dimensional environment 702 (e.g., in response to horizontal movement of the virtual object 706a) if the angle of elevation 712 of the virtual object 706a is outside the first range of angles of elevation discussed above. In some embodiments, as shown in FIG. 7D, when the virtual object 706a is moved vertically in the three-dimensional environment 702 in accordance with the upward movement of the hand 703c, the angle of elevation 712 of the virtual object 706b shown in the legend 720 is increased past the first range of angles of elevation (e.g., which is greater than the first range of vertical angles represented by the range 715-1a or 715-1b). Accordingly, as shown in FIG. 7D, the computer system 101 updates the rotation axis to be a second rotation axis 713-2 that is based on the updated angle of elevation 712. In some embodiments, as shown in the legend 720 in FIG. 7D, the second rotation axis 713-2 is tilted/slightly angled upward due to the increase in the angle of elevation 712.

In FIG. 7D, the computer system 101 detects an input provided by hand 703d corresponding to a request to move the virtual object 706a within the three-dimensional environment 702. For example, as shown in FIG. 7D, the computer system 101 detects the hand 703d provide an air gesture, such as an air pinch and drag gesture, as similarly discussed above, that includes movement of the hand 703d leftward while the gaze 721 is directed to the grabber bar 709 that is displayed with the virtual object 706a. In some embodiments, as shown in FIG. 7E, in response to detecting the input provided by the hand 703d in FIG. 7D, the computer system 101 moves the virtual object 706a in the three-dimensional environment 702 in accordance with the movement of the hand 703d. For example, as shown in FIG. 7E, the computer system 101 moves the virtual object 706a leftward in the three-dimensional environment 702 relative to the viewpoint of the user 726, including rotating the virtual object 706a (e.g., counterclockwise) about the second rotation axis 713-2.

In some embodiments, as shown in the legend 720 in FIG. 7E, moving the virtual object 706a in the three-dimensional environment 702 does not cause the computer system 101 to update the second rotation axis 713-2 because the angle of elevation 712 of the virtual object 706b does not change in response to the movement. Accordingly, as shown in FIG. 7E, the computer system 101 forgoes changing the orientation of the virtual object 706a (e.g., rotating the virtual object 706a about a horizontal axis through the virtual object 706a). For example, as shown in the legend 720 in FIG. 7E, when the computer system 101 rotates the virtual object 706b (e.g., counterclockwise) about the second rotation axis 713-2 in the three-dimensional environment 702, the virtual object 706b remains tilted downward toward the viewpoint of the user 726 as shown previously in FIG. 7D.

In FIG. 7E, the computer system 101 detects a change in position of the head of the user 726 in the physical environment of the computer system 101. For example, as shown in the legend 720 in FIG. 7E, the computer system 101 detects the head of the user 726 lower (e.g., in elevation) relative to the virtual object 706b in the three-dimensional environment 702. In some embodiments, as shown in FIG. 7E, the computer system 101 detects the change in the position of the head of the user 726 without detecting any input provided by the hand 703d.

In some embodiments, as shown in FIG. 7F, in response to detecting the change in the position of the head of the user 726, the computer system 101 updates the viewpoint of the user 726 based on the new position of the head of the user 726 in the physical environment. For example, the lowering of the head of the user 726 that is wearing the head-mounted display corresponds to a lowering of the viewpoint of the user 726 relative to the three-dimensional environment 702. In some embodiments, updating the viewpoint of the user 726 causes the portion of the three-dimensional environment 702, including the physical environment surrounding the display generation component 120, in the field of view of the user 726, to change in accordance with the updated viewpoint. In some embodiments, as shown in FIG. 7F, when the computer system 101 updates the viewpoint of the user 726, the representation of the coffee table 722a, the representation of the sofa 724a, and the virtual object 706a are shifted upward in the field of view of the user 726 (e.g., due to the lowering of the viewpoint of the user 726 caused by the lowering of the head of the user 726 in FIG. 7E).

In some embodiments, when the computer system 101 updates the viewpoint of the user 726 as discussed above, the computer system 101 forgoes rotating the virtual object 706a and/or changing the orientation of the virtual object 706a in the three-dimensional environment 702. Particularly, in some embodiments, as shown in the legend 720 in FIG. 7F, the computer system 101 forgoes updating the angle of elevation 712 of the virtual object 706b and/or the second rotation axis 713-2 in response to detecting the change in position of the head of the user 726. For example, as shown in the legend 720 in FIG. 7F, a “true” angle of elevation 714 of the virtual object 706b relative to the updated location of the head of the user 726 (e.g., after the computer system 101 detects the lowering of the head of the user 726) does not correspond to the current angle of elevation 712 of the virtual object 706b.

In some embodiments, as discussed below, after detecting the change in the position of the head of the user 726, the computer system 101 updates the angle of elevation 712 of the virtual object 706b and/or the second rotation axis 713-2 after detecting input corresponding to a request to move the virtual object 706b in the three-dimensional environment 702. For example, in FIG. 7F, the computer system 101 detects an input provided by hand 703e corresponding to a request to move the virtual object 706a within the three-dimensional environment 702. As shown in FIG. 7F, the computer system 101 optionally detects the hand 703e provide an air gesture, such as an air pinch and drag gesture, as similarly discussed above, that includes movement of the hand 703e leftward while the gaze 721 is directed to the grabber bar 709 that is displayed with the virtual object 706a.

In some embodiments, as shown in FIG. 7G, in response to detecting the input provided by the hand 703e in FIG. 7F, the computer system 101 moves the virtual object 706a in the three-dimensional environment 702 in accordance with the movement of the hand 703e. For example, as shown in FIG. 7G, the computer system 101 moves the virtual object 706a leftward in the three-dimensional environment 702 relative to the viewpoint of the user 726. In some embodiments, as mentioned above, in response to detecting the input provided by the hand 703e, the computer system 101 updates the angle of elevation 712 of the virtual object 706b and/or the rotation axis based on the new position of the head of the user 726 as shown in the legend 720 in FIG. 7G. For example, as shown in FIG. 7G, when the computer system 101 moves the virtual object 706a leftward in the three-dimensional environment 702, the computer system 101 rotates the virtual object 706b (e.g., counterclockwise) about a third rotation axis 713-3 which has been updated from the second rotation axis 713-3 based on the updated angle of elevation 712 of the virtual object 706b. In some embodiments, as shown in the legend 720 in FIG. 7G, the third rotation axis 713-3 is angled upward (e.g., counterclockwise) further than the second rotation axis 713-2 in FIG. 7F based on the increase in the angle of elevation 712 of the virtual object 706b (e.g., the lowering of the head of the user 726 corresponds to an increase in the angle of elevation 712 when the input from the hand 703e is detected).

Additionally, in some embodiments, the computer system 101 changes the orientation of the virtual object 706b in the three-dimensional environment 702 based on the updated angle of elevation 712, as shown in the legend 720 in FIG. 7G. For example, as shown in FIG. 7G, the computer system 101 tilts/slightly angles the virtual object 706a downward in the three-dimensional environment 702 relative to the viewpoint of the user 726, such that the front-facing surface of the virtual object 706a is oriented toward the viewpoint of the user 726. Accordingly, as shown in the legend 720, from FIGS. 7F-7G, in response to detecting the input provided by the hand 703e in FIG. 7F, the computer system 101 optionally rotates (e.g., tilts) the virtual object 706b about a vertical axis (e.g., third rotation axis 713-3) through the center of the head of the user 726 and optionally rotates (e.g., tilts) the virtual object 706b about a horizontal axis through (e.g., a center of) the virtual object 706b based on the updated angle of elevation 712.

FIG. 7F1 illustrates similar and/or the same concepts as those shown in FIG. 7F (with many of the same reference numbers). It is understood that unless indicated below, elements shown in FIG. 7F1 that have the same reference numbers as elements shown in FIGS. 7A-7J have one or more or all of the same characteristics. FIG. 7F1 includes computer system 101, which includes (or is the same as) display generation component 120. In some embodiments, computer system 101 and display generation component 120 have one or more of the characteristics of computer system 101 shown in FIGS. 7F and 7A-7J and display generation component 120 shown in FIGS. 1 and 3, respectively, and in some embodiments, computer system 101 and display generation component 120 shown in FIGS. 7A-7J have one or more of the characteristics of computer system 101 and display generation component 120 shown in FIG. 7F1.

In FIG. 7F1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7J.

In FIG. 7F1, display generation component 120 is illustrated as displaying content that optionally corresponds to the content that is described as being displayed and/or visible via display generation component 120 with reference to FIGS. 7A-7J. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7F1.

Display generation component 120 has a field of view (e.g., a field of view captured by external image sensors 314b and 314c and/or visible to the user via display generation component 120, indicated by dashed lines in the overhead view) that corresponds to the content shown in FIG. 7F1. Because display generation component 120 is optionally a head-mounted device, the field of view of display generation component 120 is optionally the same as or similar to the field of view of the user.

In FIG. 7F1, the user is depicted as performing an air pinch gesture (e.g., with hand 703e) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 7A-7J.

In some embodiments, computer system 101 responds to user inputs as described with reference to FIGS. 7A-7J.

In the example of FIG. 7F1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7J and/or described with reference to the corresponding method(s) are optionally implemented on computer system 101 and display generation unit 120 in a manner similar or analogous to that shown in FIG. 7F1.

In FIG. 7G, the computer system 101 detects movement of the viewpoint of the user 726 without detecting input (e.g., provided by the hand 703e) directed to the virtual object 706a in the three-dimensional environment 702. For example, as shown in FIG. 7G, the computer system 101 detects hand 705a that is holding the computer system 101 move/rotate in a leftward direction (e.g., a counterclockwise direction about a body of the user 726). In some embodiments, as similarly discussed above, movement of the viewpoint of the user 726 causes the portion of the three-dimensional environment 702, including the physical environment surrounding the display generation component 120, in the field of view of the user 726, to change in accordance with the movement of the viewpoint. In some embodiments, the input for changing the viewpoint of the user 726 corresponds to a movement of the head of the user 726 in the physical environment (e.g., movement of the head-mounted display worn by the user 726 in the physical environment).

In some embodiments, as shown in FIG. 7H, in response to detecting movement of the hand 705a in FIG. 7G, the computer system 101 updates display of the three-dimensional environment 702 relative to the new viewpoint of the user 726 in accordance with the movement. For example, as shown in in FIG. 7G, the computer system 101 is moved/angled counterclockwise about the body of the user 726, such that the computer system 101 is facing the front-facing surface/portion of the virtual object 706b in the three-dimensional environment 702, as indicated in the legend 720. In some embodiments, as shown in FIG. 7H and as similarly discussed above, in response to detecting the movement of the viewpoint of the user 726, the computer system 101 forgoes rotating and/or changing the orientation of the virtual object 706a in the three-dimensional environment 702. For example, as shown in the legend 720 of FIG. 7H, the computer system 101 forgoes tilting the virtual object 706b relative to a horizontal axis through (e.g., a center of) the virtual object 706b and forgoes tilting the virtual object 706b relative to a (e.g., offset) vertical axis (e.g., the third rotation axis 713-3) through the center of the head of the user 726 in the three-dimensional environment 702. Particularly, as previously discussed above, the computer system 101 optionally forgoes rotating and/or changing the orientation of the virtual object 706a in the three-dimensional environment 702 because, in FIG. 7H, the computer system 101 does not detect input corresponding to a request to move the virtual object 706a within the three-dimensional environment 702 (e.g., such as one of the inputs discussed above).

In FIG. 7H, the computer system 101 detects movement of a position of the viewpoint of the user 726 relative to the three-dimensional environment 702 without detecting input (e.g., provided by the hand 703e) directed to the virtual object 706a in the three-dimensional environment 702. For example, as shown in FIG. 7H, the computer system 101 detects hand 705b that is holding the computer system 101 translate in a leftward direction corresponding to a change in position of the display generation component 120 in the physical environment surrounding the display generation component 120 (e.g., corresponding to a leftward movement of the body of the user 726).

In some embodiments, as shown in FIG. 7I, in response to detecting the movement of the position of the viewpoint of the user 726, the computer system 101 updates the portion of the three-dimensional environment 702 in the field of view of the user 726 based on the new position of the viewpoint. For example, as shown in FIG. 7I, the virtual object 706a, the representation of the coffee table 722a and the representation of the sofa 724a are shifted rightward in the user's field of view relative to the new viewpoint. In some embodiments, as shown in in FIG. 7I, when the display generation component 120 of the computer system 101 is shifted leftward in the physical environment, the front-facing surface of the virtual object 706b visually appears to be slightly angled/tilted to the right (e.g., while remaining tilted downward) from the new viewpoint of the user 726, as indicated in the legend 720.

In some embodiments, as similarly discussed above, in response to detecting the change in position of the viewpoint of the user 726 relative to the three-dimensional environment 702, the computer system 101 forgoes rotating and/or changing the orientation of the virtual object 706a in the three-dimensional environment 702. For example, as shown in the legend 720 of FIG. 7I, the computer system 101 forgoes tilting the virtual object 706b relative to a horizontal axis through (e.g., a center of) the virtual object 706b and forgoes tilting the virtual object 706b relative to a (e.g., offset) vertical axis (e.g., the third rotation axis 713-3) through the center of the head of the user 726 in the three-dimensional environment 702. Particularly, as previously discussed above, the computer system 101 optionally forgoes rotating and/or changing the orientation of the virtual object 706a in the three-dimensional environment 702 because, in FIG. 7I, the computer system 101 has not yet detected input corresponding to a request to move the virtual object 706a within the three-dimensional environment 702 (e.g., as discussed in more detail below).

In FIG. 7I, after detecting the change in the position of the viewpoint of the user 726, the computer system 101 detects a first input provided by the hand 703f corresponding to a request to move the virtual object 706a within the three-dimensional environment 702. For example, as shown in FIG. 7I, the computer system 101 detects the hand 703 provide an air gesture, such as an air pinch and drag gesture in which an index finger and thumb of the hand of the user come together to make contact, while the gaze 721 of the user 726 is directed to the grabber bar 709 that is displayed with the virtual object 706a, followed by movement of the hand 703f leftward while maintaining the pinch hand shape. Additionally, in FIG. 7I, the computer system detects a second input provided by hand 707a corresponding to a selection of the virtual object 706a for movement of the virtual object 706a within the three-dimensional environment 702. For example, as shown in FIG. 7I, the computer system 101 detects the hand 707a provide an air pinch gesture while the gaze 721 of the user is directed to the grabber bar 709 that is displayed with the virtual object 706a in the three-dimensional environment 702 (e.g., and before detecting any movement of the hand 707a for moving the virtual object 706a in the three-dimensional environment 702). It should be understood that while multiple hands and corresponding inputs are illustrated in FIG. 7I, such hands and inputs need not be detected by computer system 101 concurrently; rather, in some embodiments, computer system 101 independently responds to the hands and/or inputs illustrated and described in response to detecting such hands and/or inputs independently.

In some embodiments, as shown in FIG. 7J, in response to detecting the first input provided by the hand 703f or the second input provided by the hand 707a, the computer system 101 rotates and/or changes the orientation of the virtual object 706a in the three-dimensional environment 702 based on the updated position of the viewpoint of the user 726 in FIG. 7I. Particularly, as previously discussed above, the computer system 101 optionally rotates and/or changes the orientation of the virtual object 706a in the three-dimensional environment 702 because the computer system 101 detected (e.g., in FIG. 7I) input for moving the virtual object 706a (e.g., the first input and/or the second input discussed above). In some embodiments, as shown in the legend 720 in FIG. 7J, the computer system 101 rotates (e.g., tilts) the virtual object 706b about the third rotation axis 713-3 in the three-dimensional environment 702 based on the updated position of the viewpoint of the user 726 in FIG. 7I. For example, as shown in FIG. 7J, the computer system 101 tilts the front-facing surface of the virtual object 706a leftward relative to the viewpoint of the user 726 such that the virtual object 706a remains oriented to face toward the viewpoint in the three-dimensional environment 702, as similarly discussed herein above. Additionally, as similarly discussed above, the computer system 101 forgoes tilting the front-facing surface of the virtual object 706a upward or downward (e.g., about a horizontal axis through the virtual object 706a) relative to the viewpoint of the user 726 because the change in the position of the viewpoint of the user 726 discussed above with reference to FIG. 7I did not cause the angle of elevation (e.g., 712 in the legend 720) to change relative to the location corresponding to the head of the user 726 (e.g., referenced to the ray 710 in the legend 720).

FIGS. 8A-8G is a flowchart illustrating an exemplary method 800 of facilitating movement of a virtual object in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., 101) in communication with a display generation component (e.g., 120) and one or more input devices (e.g., 314), such as touchpad 730 in FIG. 7A. For example, the computer system is or includes a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, or a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, while displaying, via the display generation component, an object (e.g., a virtual object) in an environment (e.g., a three-dimensional environment), such as virtual object 706a in three-dimensional environment 702 as shown in FIG. 7A, the computer system detects (802a), via the one or more input devices, a first input corresponding to a request to move the object within the environment, such as input provided by hand 703a for moving the virtual object 706a as shown in FIG. 7A. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., true or real passthrough). For example, a representation of the physical environment is displayed in the three-dimensional environment via the display generation component (e.g., virtual or video passthrough). In some embodiments, the virtual object is generated by the computer system and/or is or includes content, such as a window of a web browsing application displaying content (e.g., text, images, or video), a window displaying a photograph or video clip, a media player window for controlling playback of content items on the computer system, a contact card in a contacts application displaying contact information (e.g., phone number email address, and/or birthday) and/or a virtual boardgame of a gaming application. In some embodiments, the virtual object is displayed at a first location in the three-dimensional environment that is in the field of view of a user of the computer system from a current viewpoint of the user in the three-dimensional environment. In some embodiments, detecting the first input includes detecting an air pinch gesture performed by a hand of the user of the computer system-such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the computer system while attention (e.g., including gaze) of the user is directed toward the virtual object. In some embodiments, the computer system detects the first input irrespective of the location of the attention of the user in the three-dimensional environment. In some embodiments, the computer system detects the air pinch gesture directed toward a selection element (e.g., a grabber or handlebar element) associated with the virtual object that is selectable to initiate movement of the virtual object in the three-dimensional environment. In some embodiments, after detecting the air pinch gesture, the computer system detects movement of a portion of the user. For example, the computer system detects movement of the hand of the user in space, such as a movement while the hand is holding the pinch hand shape (e.g., the tips of the thumb and index finger remain touching) such as an air drag gesture. In some embodiments, the movement of the hand of the user is laterally (e.g., in a horizontal direction relative to the viewpoint of the user) in space that is toward a second location in the three-dimensional environment. In some embodiments, detecting the first input includes detecting movement of a head of the user, which moves the viewpoint of the user in the three-dimensional environment. For example, the virtual object is viewpoint-locked in the three-dimensional environment, and movement of the viewpoint of the user laterally (e.g., leftward or rightward) in space causes the virtual object to move within the three-dimensional environment, as discussed below. In some embodiments, the computer system detects the first input via a hardware input device (e.g., a controller operable with six degrees of freedom of movement, or a touchpad or mouse) in communication with the computer system. For example, the computer system detects a selection input (e.g., a tap, touch, or click) via the input device provided by one or more fingers of the hand of the user. In some such embodiments, after detecting the selection input, the computer system detects movement via the hardware input device, such as movement of the controller in space, movement of a mouse across a surface (e.g., a tabletop), or movement of a finger of the hand of the user across the touchpad. In some embodiments, the lateral movement of the object relative to the three-dimensional environment is relative to gravity (e.g., a vertical vector that is parallel to the force of gravity and/or perpendicular to the physical floor of the physical environment of the user). For example, the lateral movement is horizontal relative to, and therefore normal to (e.g., or within 0.5, 1, 3, 5, 8, 10, 15, 20, 25, or 30 degrees of being normal to), the vertical vector that is parallel to the force of gravity. In some embodiments, the first input need not include exclusively lateral movement of the object. For example, the first input includes movement of the object that is vertical (or has a vertical component, such as diagonal movement) relative to gravity, followed by the lateral movement described above, or vice versa, or a combination of vertical and lateral movement occurring concurrently.

In some embodiments, in response to detecting the first input, the computer system changes (802b) a position of the object within the environment based on the first input, such as the movement of the virtual object 706a in the three-dimensional environment 702 as shown in FIG. 7B. In some embodiments, in accordance with a determination that the object has a first angle of elevation (e.g., 0, 1, 2, 3, 5, 10, 15, 18, 20, 25, or 30 degrees) relative to a location corresponding to a first portion of a user of the computer system (e.g., a location of the head of the user in space), such as angle of elevation 712 in legend 720 as shown in FIG. 7B, changing the position of the object within the environment based on the first input includes moving the object (e.g., moving the object in one, two, or three dimensions) by an amount that is based on one or more parameters of the first input (e.g., a direction, distance, and/or speed of the first input) and rotating the object about a first axis in the environment (802c) (e.g., based on the changed position of the object), such as rotation of the virtual object 706a about axis 713-1 in the legend 720 as shown in FIG. 7B. For example, the computer system moves the virtual object from the first location to the second location in the three-dimensional environment in accordance with the movement of the hand of the user, the movement of the viewpoint of the user, and/or the movement of the hardware input device (e.g., the object is moved laterally in the three-dimensional environment relative to gravity in accordance with the lateral movement of the first input or the object is moved laterally and vertically (e.g., successively, or concurrently (e.g., the object is moved diagonally)) in the three-dimensional environment relative to gravity in accordance with the vertical and lateral components of movement of the first input). In some embodiments, an angle of elevation relative to the first portion of the user corresponds to an angle of elevation relative to a horizon of the field of view of the user and/or a horizon of the physical space of the user (e.g., independent of the field of view of the user). For example, the angle of elevation relative to the first portion of the user is measured relative to a first vector or plane (e.g., parallel to a ground/surface on which the user is positioned) extending from the user's head that is normal (e.g., or within 1, 2, 3, 4, 5, 8, or 10 degrees of being normal) to a horizontal axis across (e.g., a center of) the user's field of view and/or a plane of the horizon of the physical space of the user (e.g., independent of the field of view of the user). Additionally or alternatively, in some embodiments, the first vector is parallel to a floor of the physical environment surrounding the user (e.g., the first vector extends laterally (horizontally) in the direction of the lateral orientation of the object relative to the viewpoint/head of the user and is independent of a vertical and/or lateral orientation of the viewpoint and/or head of the user). For example, the first vector is determined irrespective of the location and/or direction of the attention (e.g., including gaze) of the user in the three-dimensional environment. In some embodiments, the location corresponding to the first portion of the user includes a location of the computer system. For example, if the computer system is or includes a head-mounted display as discussed above, the angle of elevation relative to the user's head is also an angle of elevation relative to the computer system. Accordingly, in some embodiments, when determining the angle of elevation of the object in the three-dimensional environment relative to the location corresponding to the first portion of the user, the computer system evaluates the angle of elevation of the object relative to the first vector extending from the user's head (and, in some embodiments, the computer system) toward the horizon. For example, the angle of elevation of the object in the three-dimensional environment is an angle that is measured between the first vector described above and a second vector that extends from the (e.g., center of) the user's head to (e.g., a center of) of the object in the three-dimensional environment. In some embodiments, while moving the virtual object in accordance with the first input, if the computer system determines that the virtual object has the first angle of elevation relative to the location of the user's head in space (e.g., the angle that is measured between the first vector and the second vector described above is the first angle), the computer system rotates the object about a first rotation axis in the three-dimensional environment. For example, the computer system rotates the virtual object such that a front-facing surface of the virtual object (e.g., the front-facing surface when the first input is detected) continues to face toward the viewpoint of the user in the user's field of view as the virtual object is moved laterally in the three-dimensional environment by rotating the virtual object about the first axis. In some embodiments, the first axis corresponds to a vertical axis through (e.g., a center of) the first portion of the user. For example, if the virtual object has the first angle of elevation relative to the location of the user's head in space when the first input is detected, the computer system rotates the virtual object about a vertical axis through the user's head as the virtual object is moved laterally in the three-dimensional environment. In some embodiments, a direction of the rotation of the virtual object is based on the direction of lateral movement of the object in the three-dimensional environment. For example, if the first input causes the computer system to move the virtual object rightward in the user's field of view, the computer system rotates the virtual object clockwise about the first axis in the user's field of view of the three-dimensional environment (e.g., radially along a sphere centered at the user's head). Similarly, if the first input causes the computer system to move the virtual object leftward in the user's field of view, the computer system optionally rotates the virtual object counterclockwise about the first axis in the user's field of view of the three-dimensional environment. In some embodiments, an amount (e.g., an angular amount) of the rotation of the virtual object about the first axis is based on the distance of lateral movement of the virtual object in the three-dimensional environment. For example, if the first input causes the computer system to move the virtual object laterally by a first distance in the three-dimensional environment, the computer system rotates the virtual object (e.g., clockwise or counterclockwise) about the first axis by a first angular amount that is based on (e.g., equivalent to or proportional to) the first distance. Similarly, if the first input causes the computer system to move the virtual object laterally by a second distance, greater than the first distance, in the three-dimensional environment, the computer system optionally rotates the virtual object about the first axis by a second angular amount, greater than the first angular amount, that is based on the second distance.

In some embodiments, in accordance with a determination that the object has a second angle of elevation (e.g., 15, 20, 25, 30, 40, 45, 60, 75, 80, or 90 degrees), different from the first angle of elevation (e.g., greater than the first angle of elevation), relative to the location corresponding to the first portion of the user, such as angle of elevation 712 in the legend 720 as shown in FIG. 7E, changing the position of the object within the environment based on the first input includes moving the object (e.g., moving the object in one, two, or three dimensions) by an amount that is based on the one or more parameters (e.g., a direction, distance, and/or speed of the first input) of the first input, such as the movement of the virtual object 706a in the three-dimensional environment 702 as shown in FIG. 7E, and rotating the object about a second axis, different from the first axis, in the environment (802d) (e.g., based on the changed position of the object), such as rotating the virtual object 706b about axis 713-2 in the legend 720 as shown in FIG. 7E. For example, as discussed above, the computer system moves the virtual object from the first location to the second location in the three-dimensional environment in accordance with the movement of the hand of the user, the movement of the viewpoint of the user, and/or the movement of the hardware input device. In some embodiments, while moving the virtual object in accordance with the first input, if the computer system determines that the virtual object has the second angle of elevation relative to the location of the user's head in space (e.g., the angle that is measured between the first vector and the second vector described above is the second angle), the computer system rotates the object about a second rotation axis in the three-dimensional environment, as similarly discussed above. In some embodiments, the second axis corresponds to a first vertical axis that is offset from a second vertical axis that is through (e.g., a center of) the first portion of the user. For example, the first vertical axis and the second vertical axis intersect at the user's head, and the first vertical axis is offset from the second vertical axis by 1, 5, 10, 15, 20, 25, 30, 40, 45, 50, 60, 75, or 90 degrees. Accordingly, if the virtual object has the second angle of elevation relative to the location of the user's head in space when the first input is detected, the computer system rotates the virtual object about the second vertical axis through the user's head as the virtual object is moved laterally in the three-dimensional environment. In some embodiments, as described in more detail below, an amount that the second vertical axis is offset from the first vertical axis is based on the angle of elevation of the object in the three-dimensional environment. In some embodiments, as similarly discussed above, a direction of the rotation of the virtual object about the second axis is based on the direction of lateral movement of the object in the three-dimensional environment. Additionally, as similarly discussed above, in some embodiments, an amount (e.g., angular amount) of the rotation of the virtual object about the second axis is based on the distance of lateral movement of the virtual object in the three-dimensional environment. Varying an axis of rotation of an object in a three-dimensional environment in response to detecting movement of the object in the three-dimensional environment based on an angle of elevation of the object relative to a location of a portion of the user enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment, thereby improving user-device interaction.

In some embodiments, the first angle of elevation relative to the location corresponding to the first portion of the user is a first angle of elevation relative to a plane parallel to a ground (or other surface) on which the user is positioned (804a) (e.g., as similarly described above with reference to step(s) 802), such as reference plane or vector 710 in the legend 720 of FIG. 7A. In some embodiments, the computer system detects the ground (or other surface) on which the user is positioned. For example, the ground is detected using one or more cameras or depth sensors of the computer system. In some embodiments, the computer system estimates the ground (or other surface) on which the user is positioned. For example, the ground is estimated (e.g., calculated) based on gravity.

In some embodiments, the second angle of elevation relative to the location corresponding to the first portion of the user is a second angle of elevation relative to the plane (804b) (e.g., as similarly described above with reference to step(s) 802), such as the reference plane or vector 710 in the legend 720 of FIG. 7D. In some embodiments, the plane parallel to the ground is parallel to (e.g., or within a threshold amount, such as 0, 1, 2, 5, 8, 10, 15, 18, 20, or 25 degrees, of being parallel to) a horizon of the field of view of the user (e.g., a horizontal line across a center of the user's field of view). In some embodiments, the horizon of the field of view is normal to (e.g., or within a threshold amount, such as 0, 1, 2, 5, 8, 10, or 15 degrees, of being normal to) the force of gravity in the physical environment. In some embodiments, the horizon of the field of view is a horizon of a virtual environment (e.g., an immersive environment displayed in the three-dimensional environment) or of the physical environment surrounding the display generation component. Varying an axis of rotation of an object in a three-dimensional environment in response to detecting movement of the object in the three-dimensional environment based on an angle of elevation of the object relative to a plane parallel to the ground enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment, thereby improving user-device interaction.

In some embodiments, rotating the object about the first axis and rotating the object about the second axis cause the object to remain oriented toward a viewpoint of the user (806) (e.g., orienting the object toward the viewpoint of the user includes orienting the object so that a front of the object or a side of the object that is presented to a user by default when the object is initially displayed (e.g., and before detecting the first input) is oriented towards the viewpoint of the user (e.g., the front or side of the object is facing or is perpendicular or normal to the viewpoint of the user)), such as the virtual object 706a remaining oriented toward the viewpoint of the user 726 as shown in FIG. 7B and FIG. 7E. For example, when the object is moved within the three-dimensional environment, the computer system tilts the object away from the default orientation such that a front-facing surface of the object continues to face toward the viewpoint of the user. In some embodiments, the rotation of the object is based on a direction of movement of the object. For example, if the object is moved horizontally in the three-dimensional environment, the computer system tilts the object relative to a vertical axis through the object. In some embodiments, if the object is moved vertically in the three-dimensional environment, the computer system tilts the object relative to a horizontal axis through the object. In some embodiments, the object is tilted about a center of the object in the three-dimensional environment. In some embodiments, if the object is moved toward or away from the viewpoint of the user (e.g., without changing the angle of elevation of the object), the object is not rotated in the three-dimensional environment. Changing an orientation of an object in a three-dimensional environment in response to detecting movement of the object in the three-dimensional environment enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment to face towards the viewpoint of the user, thereby improving user-device interaction.

In some embodiments, in response to detecting the first input (808a), in accordance with a determination that the object has a third angle of elevation, different from the first angle of elevation and the second angle of elevation, that is within a first range of angles of elevation (e.g., between −30 and 30 degrees, −25 and 25 degrees, −20 and 20 degrees, −15 and 15 degrees, −10 and 10 degrees, or −5 and 5 degrees) relative to the location corresponding to the first portion of the user, such as range 715-1 in the legend 720 as shown in FIG. 7C, changing the position of the object within the environment based on the first input includes moving the object by an amount that is based on the one or more parameters of the first input, such as the movement of the virtual object 706a in the three-dimensional environment 702 as shown in FIG. 7B, and rotating the object about a third axis, different from the first axis and the second axis, in the environment (808b). For example, as similarly described above with reference to step(s) 802, if the angle of elevation of the object, including the third angle of elevation, is within the first range of angles of elevation above, the object is rotated about a third axis in the three-dimensional environment. In some embodiments, in response to detecting the first input, in accordance with a determination that the object has a fourth angle of elevation, different from the third angle of elevation, that is within the first range of angles of elevation relative to the location corresponding to the first portion of the user, the computer system changes the position of the object within the environment based on the first input, including moving the object by an amount that is based on the one or more parameters of the first input and rotating the object about the third axis in the environment. Accordingly, in some embodiments, the rotation axis for the object in the three-dimensional environment is the third axis if the angle of elevation of the object when the first input is detected is within the first range of angles of elevation. In some embodiments, the first angle of elevation and the second angle of elevation described above with reference to step(s) 802 are outside of the first range of angles of elevation. Maintaining an axis of rotation of an object in a three-dimensional environment in response to detecting movement of the object in the three-dimensional environment if an angle of elevation of the object relative to a location of a portion of the user is within a first range of angles limits or reduces unnecessary changes to the axis of rotation for relatively low angles of elevation, which negates and/or reduces a number of inputs that would be needed to reorient the object in the user's field of view of the three-dimensional environment, thereby improving user-device interaction.

In some embodiments, the first angle of elevation and the second angle of elevation relative to the location corresponding to the first portion of the user are within a respective range of angles of elevation (810a) (e.g., less than −30, −25, −20, −15, −10, or −5 degrees or greater than 5, 10, 15, 20, 25, or 30 degrees). For example, the respective range of angles of elevation is outside the first range of angles of elevation discussed above with reference to step(s) 808. In some embodiments, the third angle of elevation and the fourth angle of elevation described above with reference to step(s) 808 are outside of the respective range of angles of elevation.

In some embodiments, an axis of rotation of the object in the environment is variable for angles of elevation of the object that are within the respective range of angles of elevation (810b), such as the variability of the axis 713-2 in the legend 720 in FIG. 7D. For example, as similarly described above with reference to step(s) 802, if the angle of elevation of the object is the first angle of elevation, the object is rotated about the first axis in the three-dimensional environment, and if the angle of elevation of the object is the second angle of elevation, the object is rotated about the second axis in the three-dimensional environment. Accordingly, in some embodiments, the rotation axis for the object in the three-dimensional environment is varied for respective angles of elevation of the object that fall within the respective range of angles of elevation when the first input is detected. Varying an axis of rotation of an object in a three-dimensional environment in response to detecting movement of the object in the three-dimensional environment if an angle of elevation of the object relative to a location of a portion of the user is within a respective range of angles enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment, thereby improving user-device interaction.

In some embodiments, the object has the second angle of elevation relative to the location corresponding to the first portion of the user in response to detecting the first input (812a) (e.g., within the respective range of angles of elevation described above with reference to step(s) 810), such as the angle of elevation 712 in the legend 720 in FIG. 7C. In some embodiments, while displaying the object in the environment, the computer system detects (812b), via the one or more input devices, a second input corresponding to a request to move the object within the environment (e.g., an input similar to or corresponding to the first input described above with reference to step(s) 802), such as input provided by hand 703c for moving the virtual object 706a in the three-dimensional environment 702 as shown in FIG. 7C. In some embodiments, while (optionally in response to) detecting the second input (812c), in accordance with a determination that the second input causes the object to have a third angle of elevation, wherein the third angle of elevation is greater than the second angle of elevation, such as the angle of elevation 712 in the legend 720 as shown in FIG. 7D, relative to the location corresponding to the first portion of the user, the computer system moves (812d) the object (e.g., moving the object in one, two, or three dimensions) by an amount that is based on one or more parameters of the second input (e.g., a direction, distance, and/or speed of the second input, as similarly described above with reference to step(s) 802), such as the movement of the virtual object 706a upward in the three-dimensional environment 702 as shown in FIG. 7D, and gradually changes a (e.g., magnitude and/or direction of a) rotation axis of the object from the second axis to the third axis in the environment as the object changes from having the second angle of elevation to having the third angle of elevation relative to the location corresponding to the first portion of the user, such as changing the rotation axis to axis 713-2 in the legend 720 as shown in FIG. 7D. For example, while moving the object from having the second angle of elevation to having the third angle of elevation relative to the location corresponding to the first portion of the user in the three-dimensional environment in accordance with the second input, the computer system gradually increases the offset of the rotation axis from the vertical axis through (e.g., a center of) the user's head as similarly described above with reference to step(s) 810. In some embodiments, gradually changing the rotation axis of the object from the second axis to the third axis is based on a difference (e.g., in degrees) between the second angle of elevation and the third angle of elevation within the respective range of angles of elevation. For example, an amount that the rotation axis is offset from the vertical axis relative to the second axis is proportional to or equal to a difference in degrees between the second angle of elevation and the third angle of elevation and/or is proportional to or equal to a difference in degrees between a current angle of elevation and the second angle of elevation. In some embodiments, gradually changing the rotation axis of the object from the second axis to the third axis is based on a direction (e.g., relative to the location corresponding to the first portion of the user) of the change in the angle of elevation from the second angle of elevation to the third angle of elevation within the respective range of angles of elevation. For example, a direction that the rotation axis is offset from the vertical axis through (e.g., a center of) the user's head is based on whether the third angle of elevation is greater than the second angle of elevation or less than the second angle of elevation. In some embodiments, as similarly discussed above with reference to step(s) 802, if the computer system detects an input corresponding to a request to move the object (optionally laterally) in the three-dimensional environment while the object has the third angle of elevation, the computer system will rotate the object about the third axis in the three-dimensional environment. Gradually varying an axis of rotation of an object in a three-dimensional environment if an angle of elevation of the object relative to a location of a portion of the user is within a respective range of angles helps avoid or reduce eye strain for the user during the varying the axis of rotation that could be caused if the varying the axis of rotation was not gradual, thereby improving user-device interaction.

In some embodiments, in response to detecting the first input (814a), in accordance with a determination that the object has the first angle of elevation (e.g., 0, 1, 2, 3, 5, 10, 15, 18, 20, 25, or 30 degrees) relative to a location corresponding to a first portion of a user of the computer system (e.g., a location of the head of the user in space), the computer system rotates (814b) the object about a third axis, different from the first axis, such that the object remains oriented toward a viewpoint of the user when the object is rotated about the first axis, such as the rotation of the virtual object 706a in the three-dimensional environment 702 as shown in FIG. 7B. In some embodiments, in accordance with a determination that the object has the second angle of elevation (e.g., 15, 20, 25, 30, 40, 45, 60, 75, 80, or 90 degrees) relative to the location corresponding to the first portion of the user, the computer system rotates (814c) the object about a fourth axis, different from the second axis, such that the object remains oriented toward the viewpoint of the user when the object is rotated about the second axis (e.g., orienting the object toward the viewpoint of the user includes orienting the object so that a front of the object or a side of the object that is presented to a user by default when the object is initially displayed (e.g., and before detecting the first input) is oriented towards the viewpoint of the user (e.g., the front or side of the object is facing or is perpendicular or normal to the viewpoint of the user)), such as the rotation of the virtual object 706a in the three-dimensional environment 702 as shown in FIG. 7E. For example, when the object is moved within the three-dimensional environment, the computer system tilts the object such that a front-facing surface of the object continues to face toward the viewpoint of the user. In some embodiments, the computer system rotates the object about the third axis and the fourth axis above when the movement of the object relative to the environment causes the angle of elevation of the object to fall within a first range of vertical angles (e.g., greater than 15, 12, 10, 5, 3, or 1 degrees and less than −15, −12, −10, −5, −3, or −1 degrees) relative to the location corresponding to the first portion of the user. In some embodiments, the computer system forgoes rotating the object about the third axis and the fourth axis above when the movement of the object relative to the environment causes the angle of elevation of the object to fall within a second range of vertical angles (e.g., between −15, −12, −10, −5, −3, or −1 degrees and 15, 12, 10, 5, 3, or 1 degrees (e.g., respectively)), smaller than the first range of vertical angles. In some embodiments, when the object is moved in the three-dimensional environment in accordance with the second input, rotating the object about the third axis or the fourth axis in the three-dimensional environment includes tilting the object relative to a horizontal axis through (e.g., a center of) the object in the three-dimensional environment (e.g., the third axis and/or the fourth axis correspond to the horizontal axis through the object). In comparison, as previously discussed above with reference to step(s) 802, when the object is moved in the three-dimensional in accordance with the first input, rotating the object about the first axis or the second axis in the three-dimensional environment includes tilting the object relative to a vertical axis through (e.g., a center of) the head of the user in the three-dimensional environment (e.g., the first axis and/or the second axis correspond to the vertical axis through the head of the user). In some embodiments, the third axis is normal to (e.g., or within a threshold amount, such as 0, 1, 2, 4, 5, 8, 10, 15, 20, or 25 degrees, of being normal to) the first axis and the fourth axis is normal to (e.g., or within a threshold amount, such as 0, 1, 2, 4, 5, 8, 10, 15, 20, or 25 degrees, of being normal to) the second axis in the three-dimensional environment. In some embodiments, the computer system moves the object as previously discussed above with reference to step(s) 802 in response to detecting the first input without necessarily rotating the object about the third axis or the fourth axis (e.g., if the angle of elevation of the object increases or decreases to within the second range of vertical angles above). Changing an orientation of an object in a three-dimensional environment relative to a horizontal axis through the object in response to detecting movement of the object in the three-dimensional environment if one or more criteria are satisfied enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment to face towards the viewpoint of the user, thereby improving user-device interaction.

In some embodiments, the first angle of elevation and the second angle of elevation are within a first range of angles of elevation (816a) (e.g., greater than 15, 12, 10, 5, 3, or 1 degrees and less than −15, −12, −10, −5, −3, or −1 degrees), such as outside the range 715-1 in the legend 720 as shown in FIG. 7D. In some embodiments, in response to detecting the first input (816b), in accordance with a determination that the object has a third angle of elevation, different from the first and the second angles of elevation, that is within a second range of angles of elevation (e.g., between −15 and 15 degrees, −12 and 12 degrees, −10 and 10 degrees, −5 and 5 degrees, −3 and 3 degrees, or −1 and 1 degrees), different from the first range of angles of elevation (e.g., as similarly described above with reference to step(s) 814), such as outside of the range 715-1 in the legend 720 as shown in FIG. 7C, relative to the location corresponding to the first portion of the user, changing the position of the object within the environment based on the first input includes moving the object by an amount that is based on the one or more parameters of the first input and rotating the object about a fifth axis, different from the first axis and the second axis, in the environment, such as the movement of the virtual object 706a in the three-dimensional environment 702 as shown in FIG. 7C, without rotating the object about a sixth axis (e.g., normal or perpendicular to (e.g., or within a threshold amount, such as 0, 1, 2, 4, 5, 8, 10, 15, 20, or 25 degrees, of being normal to) the fifth axis) that causes the object to remain oriented toward the viewpoint of the user when the object is rotated about the fifth axis (816c) (e.g., orienting the object toward the viewpoint of the user includes orienting the object so that a front of the object or a side of the object that is presented to a user by default when the object is initially displayed (e.g., and before detecting the first input) is oriented towards the viewpoint of the user (e.g., the front or side of the object is facing or is perpendicular or normal to the viewpoint of the user)). For example, because the third angle of elevation is within the second range of angles of elevation, the computer system moves the object in the three-dimensional environment without tilting the object to face toward the viewpoint of the user. In some embodiments, as similarly described above, the computer system rotates the object about the fifth axis (e.g., a vertical axis through the center of the head of the user) without rotating the object about the sixth axis (e.g., a horizontal axis through the center of the object) in the three-dimensional environment. Changing an orientation of an object in a three-dimensional environment in response to detecting vertical movement of the object in the three-dimensional environment if the vertical movement is within a first range of vertical angles are satisfied limits or reduces unnecessary changes to the orientation of the object for relatively low angles of elevation, which negates and/or reduces a number of inputs that would be needed to reorient the object in the user's field of view of the three-dimensional environment, thereby improving user-device interaction.

In some embodiments, the second range of angles of elevation (e.g., represented by range 715-1b in FIG. 7C) extends further in a first direction from a reference angle of elevation than in a second direction from the reference angle of elevation in the environment (e.g., the second range of angles of elevation is asymmetrically distributed relative to the reference angle (e.g., zero degrees or some other reference angle) of elevation in the environment), wherein the reference angle of elevation in the environment corresponds to a horizon in the environment. In some embodiments, the horizon of the three-dimensional environment is a horizontal line that extends across a center of the field of view of the user of the computer system. In some embodiments, a reference ray extending from a center of the head of the user is normal to (e.g., intersects) the horizon at the center of the field of view of the user. In some embodiments, the second range of angles of elevation includes one or more angles that are numerically larger than the respective angle of elevation. In some embodiments, the second range of angles includes one or more angles that are numerically smaller than the respective angle of elevation. In some embodiments, the second range of angles of elevation includes a larger number of degrees in the first direction from (e.g., upward from (e.g., numerically larger than)) the respective angle than a number of degrees that are in the second direction from (e.g., downward from (e.g., numerically smaller than)) the respective angle (or vice versa). For example, an upper portion of the second range of angles of elevation includes angles between 0 and 7.5 degrees (e.g., where the respective angle of elevation is 0 degrees) and a lower portion of the second range of angles of elevation includes angles between 0 degrees and −2.5 degrees. Changing an orientation of an object in a three-dimensional environment in response to detecting vertical movement of the object in the three-dimensional environment if the vertical movement is within a first range of vertical angles are satisfied limits or reduces unnecessary changes to the orientation of the object for relatively low angles of elevation, which negates and/or reduces a number of inputs that would be needed to reorient the object in the user's field of view of the three-dimensional environment, thereby improving user-device interaction.

In some embodiments, the object has the third angle of elevation relative to the location corresponding to the first portion of the user in response to detecting the first input (818a) (e.g., within the second range of angles of elevation (e.g., between −15 and 15 degrees, −12 and 12 degrees, −10 and 10 degrees, −5 and 5 degrees, −3 and 3 degrees, or −1 and 1 degrees) described above with reference to step(s) 814), such as the angle of elevation 712 in the legend 720 as shown in FIG. 7C. In some embodiments, while displaying the object in the environment at the third angle of elevation, the computer system detects (818b), via the one or more input devices, a second input corresponding to a request to move the object within the environment (e.g., an input similar to or corresponding to the first input described above with reference to step(s) 802), such as input provided by the hand 703c as shown in FIG. 7C.

In some embodiments, while (optionally in response to) detecting the second input (818c), in accordance with a determination that the second input causes the object to have a fourth angle of elevation, different from the third angle of elevation, that is within the first range of angles of elevation (e.g., greater than 15, 12, 10, 5, 3, or 1 degrees and less than −15, −12, −10, −5, −3, or −1 degrees) relative to the location corresponding to the first portion of the user, such as the angle of elevation 712 that is outside the range 715-1 in the legend 720 as shown in FIG. 7D, the computer system moves (818d) the object (e.g., moving the object in one, two, or three dimensions) by an amount (and/or direction) that is based on one or more parameters of the second input (e.g., a direction, distance, and/or speed of the second input, as similarly described above with reference to step(s) 802) and gradually changes an amount of rotation of the object in the environment as the object changes from having the third angle of elevation to having the fourth angle of elevation relative to the location corresponding to the first portion of the user (e.g., greater than 15, 12, 10, 5, 3, or 1 degrees and less than −15, −12, −10, −5, −3, or −1 degrees), such as the rotation of the virtual object 706a in the three-dimensional environment 702 as shown in FIG. 7D. For example, when the second input is detected, the object has an angle of elevation that is within the second range of angles of elevation, and in response to detecting the second input, the object has an angle of elevation that is within the first range of angles of elevation, which causes the computer system to rotate the object about the horizontal axis through (e.g., a center of) the object, as similarly discussed above with reference to step(s) 814. In some embodiments, as the object is moved such that the angle of elevation of the object increases past the second range of angles of elevation to within the first range of angles of elevation, the computer system gradually increases an amount by which the object is tilted (e.g., about the horizontal axis through the object) in the three-dimensional environment to continue to be facing toward the viewpoint of the user. For example, an amount that the object Is tilted in the three-dimensional environment is based on (e.g., proportional or equal to) an amount (e.g., in degrees) that the angle of elevation of the object is moved past the second range of angles of elevation in the three-dimensional environment. In some embodiments, the change in the amount of rotation of the object in the environment occurs over a predetermined amount of time (e.g., after detecting an end/termination (e.g., a release) of the second input), such as over 0.25, 0.5, 0.75, 1, 1.5, 2, 3, 5, 8, 10, 12, 15, or 30 seconds. Gradually changing an orientation of an object in a three-dimensional environment in response to detecting movement of a viewpoint of the user relative to the object in the three-dimensional environment helps avoid premature reorientation of the object based on the new viewpoint of the user, which would require additional input for reorienting the object in the user's field of view of the three-dimensional environment if the viewpoint is moved back to its previous location and/or to another new location relative to the object, thereby improving user-device interaction and/or reducing or preventing eye strain for the user that can be caused by the successive reorientations of the object.

In some embodiments, rotating the object about the first axis and rotating the object about the second axis are independent of attention (e.g., including gaze) of the user (820) (or, alternatively, independent of a direction of attention of the user), such as rotation of the virtual object 706a independent of gaze 721 as shown in FIG. 7B. For example, in response to detecting the first input, in accordance with a determination that the gaze of the user is directed to a first location in the three-dimensional environment that corresponds to a location of the object when the first input is detected (e.g., and the angle of elevation of the object is within the first range of angles of elevation (e.g., greater than 15, 12, 10, 5, 3, or 1 degrees and less than −15, −12, −10, −5, −3, or −1 degrees) discussed above with reference to step(s) 814), the computer system rotates the object about the first axis or the second axis as previously discussed above with reference to step(s) 802 (e.g., and rotates the object about the third axis or the fourth axis as previously discussed above with reference to step(s) 816 that causes the object to face toward the viewpoint of the user). Additionally, in some embodiments, in accordance with a determination that the gaze of the user is directed to a second location, different from the first location, in the three-dimensional environment that does not correspond to the location of the object when the first input is detected (e.g., and the angle of elevation is within the first range of angles of elevation (e.g., greater than 15, 12, 10, 5, 3, or 1 degrees and less than −15, −12, −10, −5, −3, or −1 degrees) discussed above with reference to step(s) 814), the computer system still rotates the object about the first axis or the second axis as previously discussed above with reference to step(s) 802 (e.g., and rotates the object about the third axis or the fourth axis as previously discussed above with reference to step(s) 816 that causes the object to face toward the viewpoint of the user). Accordingly, in some embodiments, so long as the angle of elevation of the object is within the first range of angles of elevation discussed above, the front-facing surface of the object is oriented toward the viewpoint of the user when and/or if the user looks toward the object (e.g., the gaze is directed toward the front-facing surface of the object). Changing an orientation of an object in a three-dimensional environment independent of a location of attention of the user ensures the object is visibly displayed when attention is ultimately directed to the object, such that a front-facing surface of the object is oriented toward the viewpoint of the user when the user looks toward the object in the three-dimensional environment, thereby improving user-device interaction.

In some embodiments, the first portion of the user includes a portion of a head of the user (822) (e.g., as similarly described above with reference to step(s) 802), such as the head of the user 726 in the legend 720 in FIG. 7A. Varying an axis of rotation of an object in a three-dimensional environment in response to detecting movement of the object in the three-dimensional environment based on an angle of elevation of the object relative to a location of a portion of the user's head improves accuracy for determining the angle of elevation of the object in the three-dimensional environment to maintain the object oriented toward the viewpoint of the user in the user's field of view compared to determining the angle of elevation of the object relative to a different portion of the user's body, which could result in the object not remaining visibly displayed, thereby improving user-device interaction.

In some embodiments, the portion of the head is a center of the head of the user (824) (e.g., based on a detected, calibrated, and/or estimated center of the head) (e.g., as similarly described above with reference to step(s) 802), as similarly described with reference to FIG. 7A. Varying an axis of rotation of an object in a three-dimensional environment in response to detecting movement of the object in the three-dimensional environment based on an angle of elevation of the object relative to a location of a center of the user's head improves accuracy for determining the angle of elevation of the object in the three-dimensional environment to maintain the object oriented toward the viewpoint of the user in the user's field of view compared to determining the angle of elevation of the object relative to a different portion of the user's body, which could result in the object not remaining visibly displayed, thereby improving user-device interaction.

In some embodiments, the determined center of the head is determined based on a position of the computer system when the computer system is being worn on the head of the user (826) (e.g., worn on the face of the user and/or over the eyes of the user) (optionally relative to the physical environment), as similarly described with reference to FIG. 7A. For example, the computer system estimates the center of the user's head based on the position of the computer system in the physical environment in which the computer system is located. In some embodiments, the determined center of the head is determined based on a position of the display generation component in communication with the computer system. In some embodiments, the determined center of the head is determined based on a center point of the display generation component (e.g., a center point between portions of the display generation component that are located over the eyes of the user). In some embodiments, the center of the head is determined using a predetermined offset (e.g., a distance offset) that is measured from the position of the computer system (e.g., back toward the head of the user, a directionality of which is known based on one or more sensors of the computer system). In some embodiments, the computer system determines the offset previously during a configuration (e.g., a set-up) of the computer system. For example, the computer system determines the offset based on one or more characteristics of the user's head, such as a size and/or shape of the user's head, which are determined automatically (e.g., using one or more sensors) or manually (e.g., via user input specifying such characteristics). Estimating a center of the user's head based on a position of the computer system improves accuracy for determining the angle of elevation of the object in the three-dimensional environment to maintain the object oriented toward the viewpoint of the user in the user's field of view compared to determining the angle of elevation of the object relative to a different portion of the user's body, which could result in the object not remaining visibly displayed, thereby improving user-device interaction.

In some embodiments, the first input includes an air drag gesture (e.g., as similarly described above with reference to step(s) 802), and the rotating of the object about the first axis and the second axis occur while the air drag gesture is being detected (828), as similarly described with reference to the hand 703a in FIG. 7A. For example, the computer system rotates the object about the first axis in accordance with the determination that the object has the first angle of elevation in the three-dimensional environment and/or rotates the object about the second axis in accordance with the determination that the object has the second angle of elevation as previously discussed above with reference to step(s) 802 while the hand of the user is providing the air drag gesture. In some embodiments, if the computer system detects an end of the air drag gesture (e.g., a release of the air drag gesture), the computer system ceases changing the position of the object in the three-dimensional environment, including rotating the object about the first axis and/or about the second axis, even if the viewpoint of the user and/or a position of the user moves relative to the three-dimensional environment. For example, the end of the air drag gesture corresponds to a release of the air pinch (e.g., the index finger and thumb of the hand are no longer in contact) and/or movement of the hand to a resting state position (e.g., at the user's side and/or out of the user's field of view), irrespective of further movement of the viewpoint and/or the user. Varying an axis of rotation of an object in a three-dimensional environment in response to detecting movement of the object produced by an air drag gesture in the three-dimensional environment based on an angle of elevation of the object relative to a location of a portion of the user enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment, thereby improving user-device interaction.

In some embodiments, the first input includes an air toss gesture (830) (e.g., in which the movement of the hand of the user simulates a throwing motion for throwing the object toward a particular location in the three-dimensional environment), as similarly described with reference to the hand 703a in FIG. 7A. In some embodiments, the air toss gesture has one or more characteristics of the air toss gestures discussed below with reference to method 900. In some embodiments, the computer system rotates the object about the first axis or the second axis in the three-dimensional environment during a beginning portion of the air toss gesture. For example, the computer system tilts the object in the three-dimensional environment relative to the viewpoint of the user during the initial flick/throwing motion for throwing the object. In some embodiments, the computer system rotates the object about the first axis or the second axis in the three-dimensional environment during the movement of the object in the three-dimensional environment. For example, the computer system tilts the object in the three-dimensional environment relative to the viewpoint of the user while the object is moving through the three-dimensional environment (e.g., after the object has been thrown) toward the particular location. In some embodiments, the computer system rotates the object about the first axis or the second axis in the three-dimensional environment after the object arrives at the particular location in the three-dimensional environment. For example, the computer system tilts the object in the three-dimensional environment relative to the viewpoint of the user after the object lands at the particular location after being thrown. Varying an axis of rotation of an object in a three-dimensional environment in response to detecting movement of the object produced by an air toss gesture in the three-dimensional environment based on an angle of elevation of the object relative to a location of a portion of the user enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment, thereby improving user-device interaction.

In some embodiments, while displaying the object in the environment, the computer system detects (832a), via the one or more input devices, a second input that corresponds to movement of the location corresponding to the first portion of the user (e.g., the head of the user) relative to the object from a first location to a second location, such as movement of the head of the user 726 in the legend 720 as shown in FIGS. 7F and 7F1, followed by a request to move the object within the environment (832b) (e.g., such as via an input similar to or corresponding to the first input described above with reference to step(s) 802), such as input provided by hand 703e as shown in FIGS. 7F and 7F1 In some embodiments, the movement of the first portion of the user corresponds to movement (e.g., rotation or shifting) of the viewpoint of the user in the three-dimensional environment. In some embodiments, the movement of the first portion of the user is detected in response to the user moving (e.g., leftward or rightward) in the physical environment in which the computer system is located. In some embodiments, the movement of the first portion of the user corresponds to movement of the display generation component in communication with the computer system via which the three-dimensional environment is displayed. In some embodiments, the movement of the first portion of the user and/or the viewpoint of the user is independent of a direction of the gaze of the user in the three-dimensional environment.

In some embodiments, in response to detecting the second input, the computer system changes (832c) a position of the object within the environment based on the second input, such as movement of the virtual object 706a in the three-dimensional environment 702 as shown in FIG. 7G. In some embodiments, in accordance with a determination that the object has a third angle of elevation relative to the second location corresponding to the first portion of the user (e.g., different from the first angle of elevation and the second angle of elevation discussed above with reference to step(s) 802), changing the position of the object within the environment based on the first input includes moving the object (e.g., moving the object in one, two, or three dimensions) by an amount (and/or in a direction) that is based on one or more parameters of the second input (e.g., a direction, distance, and/or speed of the second input, as similarly described above with reference to step(s) 802) and rotating the object about a third axis in the environment (832d) (optionally different from the first axis and the second axis), such as rotating the virtual object 706b about axis 713-3 in the legend 720 as shown in FIG. 7G. For example, when the computer system moves the object in the three-dimensional environment in accordance with the second input, the computer system rotates the object about a rotation axis in the three-dimensional environment that is based on the updated angle of elevation of the object relative to the updated location of the first portion of the user. In some embodiments, the angle of elevation of the object is determined based on the movement of the first portion of the user. For example, because the second input corresponds to movement of the object after the first portion of the user moves, the computer system determines the angle of elevation of the object based on the updated location of the first portion of the user relative to the three-dimensional environment. In some embodiments, if the movement of the first portion of the user causes the updated location of the first portion of the user to be higher or lower relative to the object in the three-dimensional environment (e.g., because the first portion of the user moved upward or downward in the physical environment), the computer system updates the angle of elevation of the object relative to the first portion of the user. In some embodiments, if the movement of the first portion of the user causes the updated location of the first portion of the user to be at the same elevation relative to the object in the three-dimensional environment (e.g., because the first portion of the user moved forward or backward, or leftward or rightward in the physical environment), the computer system maintains the angle of elevation of the object relative to the first portion of the user at the angle of elevation prior to the second input (e.g., such as the first angle of elevation or the second angle of elevation discussed above with reference to step(s) 802). In some embodiments, if the third angle of elevation is greater than the second angle of elevation, the third axis about which the object is rotated in the three-dimensional environment has a greater offset from a vertical axis through (e.g., a center of) the user's head, as similarly discussed above with reference to step(s) 802, than the second axis. In some embodiments, if the third angle of elevation is less than the second angle of elevation, the third axis about which the object is rotated in the three-dimensional environment has a smaller offset from the vertical axis through (e.g., a center of) the user's head, as similarly discussed above with reference to step(s) 802, than the second axis. Accordingly, when the request to move the object is detected by the computer system after the movement of the location corresponding to the first portion of the user from the first location to the second location, the computer system optionally changes the rotation axis of the object in the three-dimensional environment if the second location corresponding to the first portion of the user causes the object to have a greater angle of elevation. For example, the computer system changes the rotation axis even if the request to move the object (e.g., the air pinch and drag gesture) is the same (e.g., in movement and/or magnitude and/or direction) or similar type of input as the first input discussed above with reference to step(s) 802. In some embodiments, in accordance with a determination that the object has the first angle of elevation relative to the location corresponding to the first portion of the user, the computer system rotates the object about the first axis in the environment, as similarly described above with reference to step(s) 802. In some embodiments, in accordance with a determination that the object has the second angle of elevation relative to the location corresponding to the first portion of the user, the computer system rotates the object about the second axis in the environment, as similarly described above with reference to step(s) 802. Varying an axis of rotation of an object in a three-dimensional environment in response to detecting movement of a portion of the user followed by movement of the object in the three-dimensional environment based on an updated angle of elevation of the object relative to an updated location of the portion of the user enables the object to automatically remain visibly displayed and/or oriented towards the updated viewpoint of the user in the user's field of view after the movement of the portion of the user and/or the object, which negates and/or reduces a number of inputs that would be needed to reorient the object in the user's field of view of the three-dimensional environment, thereby improving user-device interaction.

In some embodiments, while displaying the object with a first orientation in the environment, the computer system detects (834a), via the one or more input devices, movement of a viewpoint of the user relative to the object, such as movement of the viewpoint of the user 726 caused by movement of hand 705A as shown in FIG. 7G. For example, the movement of the viewpoint of the user corresponds to a rotation of the viewpoint caused by a rotation of the head of the user (e.g., about the user's neck). In some embodiments, movement of the viewpoint causes the display generation component in communication with the computer system to move (e.g., rotate) in the physical environment. For example, the movement of the viewpoint causes the display generation component to rotate clockwise or counterclockwise relative to the object in the three-dimensional environment displayed via the display generation component. In some embodiments the movement of the viewpoint causes the display generation component to rotate upward or downward relative to the object in the three-dimensional environment.

In some embodiments, in response to detecting the movement of the viewpoint (834b), the computer system maintains (834c) the object with the first orientation in the environment (and optionally maintaining display of the object with the same orientation in the environment), such as maintaining the orientation of the virtual object 706a in the three-dimensional environment 702 as shown in FIG. 7H. For example, the computer system does not tilt or move the object in the three-dimensional environment such that a front-facing surface of the object optionally no longer faces toward the new viewpoint of the user after the movement of the viewpoint discussed above. In some embodiments, the computer system maintains display of the object with the first orientation until subsequent input is provided that is directed to the object in the three-dimensional environment. For example, as similarly discussed below with reference to step(s) 836, the computer system displays the object with a second orientation that causes the object to face toward the updated viewpoint of the user in response to detecting input for moving the object in the three-dimensional environment (e.g., an air pinch gesture, optionally followed by movement of the hand, such as an air drag gesture). Forgoing changing an orientation of an object in a three-dimensional environment in response to detecting movement of a viewpoint of the user relative to the object in the three-dimensional environment helps avoid premature reorientation of the object based on the new viewpoint of the user, which would require additional input for reorienting the object in the user's field of view of the three-dimensional environment if the viewpoint is moved back to its previous location and/or to another new location relative to the object, thereby improving user-device interaction and/or reducing or preventing eye strain for the user that can be caused by the successive reorientations of the object.

In some embodiments, while displaying the object with a first orientation in the environment, the computer system detects (836a), via the one or more input devices, a second input that includes movement of the user, such as movement of the viewpoint of the user 726 caused by movement of hand 705b as shown in FIG. 7H. For example, the second input corresponds to movement or shifting of the viewpoint of the user in the three-dimensional environment. In some embodiments, the second input is provided when the user moves (e.g., leftward or rightward) in the physical environment in which the computer system is located. In some embodiments, the second input corresponds to movement of the display generation component in communication with the computer system via which the three-dimensional environment is displayed. In some embodiments, the movement of the user and/or the viewpoint of the user is independent of a direction of the gaze of the user in the three-dimensional environment.

In some embodiments, in response to (and/or after) detecting the second input (836b), in accordance with a determination that one or more criteria are satisfied, as similarly described with reference to FIG. 7J, the computer system rotates (836c) the object to have a second orientation, different from the first orientation, in the environment that causes the object to remain oriented toward a viewpoint of the user, such as the rotation of the virtual object 706a in the three-dimensional environment 702 as shown in FIG. 7J. For example, as similarly described above with reference to step(s) 806, the computer system tilts the object such that a front-facing surface of the object continues to face toward the new viewpoint of the user after the user moves in the physical environment. In some embodiments, the second orientation corresponds to or is based on the first axis that is based on the first angle of elevation of the object or the second axis that is based on the second angle of elevation of the object described previously above with reference to step(s) 802. For example, the computer system rotates the object about an axis that is or that is offset from the first axis or the second axis in the three-dimensional environment based on the angle of elevation of the object when the second input is detected. In some embodiments, the one or more criteria include a criterion that is satisfied when the second input includes, after the movement of the user, input corresponding to a request to move the object within the three-dimensional environment. For example, the one or more criteria are satisfied if, after the user moves within the physical environment, the user provides an air pinch gesture directed to the object, followed by movement of the hand of the user while maintaining a pinch hand shape. In some embodiments, the request to move the object within the three-dimensional environment has one or more characteristics of the first input described with reference to step(s) 802. In some embodiments, the one or more criteria include a criterion that is satisfied when the one or more criteria include a criterion that is satisfied when the second input includes, after the movement of the user, input corresponding to a selection of the object for movement within the three-dimensional environment. For example, the one or more criteria are satisfied if, after the user moves within the physical environment, the user provides an air pinch gesture directed to the object, and optionally maintains the air pinch gesture (e.g., maintains the hand in the pinch hand shape) for a threshold amount of time (e.g., 0.01, 0.05, 0.1, 0.2, 0.3, 0.5, 0.75, 1, 2, 3, 5, 8, 10, 15, or 20 seconds), optionally while and/or before moving the hand in space. In some embodiments, in response to detecting the second input, in accordance with a determination that the one or more criteria are not satisfied, the computer system maintains the object with the first orientation in the environment). Changing an orientation of an object in a three-dimensional environment in response to detecting movement of the user relative to the object in the three-dimensional environment if one or more criteria are satisfied enables the object to automatically remain visibly displayed and/or oriented towards the viewpoint of the user in the user's field of view after the movement of the user, which negates and/or reduces a number of inputs that would be needed to reorient the object in the user's updated field of view of the three-dimensional environment to face towards the viewpoint of the user, thereby improving user-device interaction.

In some embodiments, the one or more criteria include a criterion that is satisfied when the second input includes, after the movement of the user, respective input (e.g., an air pinch and drag gesture, as similarly described above with reference to step(s) 802) corresponding to a request to move the object within the environment (838) (e.g., as similarly described above with reference to step(s) 836), such as input provided by hand 703f as shown in FIG. 7I. In some embodiments, when the computer system displays the object with the second orientation in the three-dimensional environment, the computer system moves the object within the three-dimensional environment in accordance with the respective input. For example, the computer system tilts the object to face toward the new viewpoint of the user after the user moves laterally in the physical environment while moving the object within the three-dimensional environment in accordance with the respective input. Accordingly, in some embodiments, the one or more criteria are satisfied if, after detecting the movement of the user (e.g., as discussed above with reference to step(s) 836), the computer system detects respective input corresponding to the request to move the object within the three-dimensional environment. For example, the computer system rotates the object to have the second orientation after detecting an air pinch gesture selecting the object, followed by movement of the hand of the user, and does not move (e.g., including rotating) the object until detecting the movement of the hand. Changing an orientation of an object in a three-dimensional environment in response to detecting movement of the user relative to the object in the three-dimensional environment if the object is moved in the three-dimensional environment helps avoid premature reorientation of the object based on a new viewpoint of the user, which would require additional input for reorienting the object in the user's field of view of the three-dimensional environment if the user moves back to their previous location and/or to another new location relative to the object, thereby improving user-device interaction and/or reducing or preventing eye strain for the user that can be caused by the successive reorientations of the object.

In some embodiments, the one or more criteria include a criterion that is satisfied when the second input includes, after the movement of the user, respective input (e.g., an air pinch gesture, as similarly described above with reference to step(s) 802) corresponding to initiating a process to move the object within the environment (840) (e.g., as similarly described above with reference to step(s) 836), such as input provided by hand 707a as shown in FIG. 7I. For example, the computer system tilts the object to face toward the new viewpoint of the user after the user moves laterally in the physical environment in response to detecting the selection of the object within the three-dimensional environment for movement of the object. In some embodiments, if the object is moved in the three-dimensional environment (e.g., in response to movement of the hand of the user after providing the respective input selecting the object), the computer system tilts the object further in the three-dimensional environment based on the movement of the object, as similarly described above with reference to step(s) 806. Accordingly, in some embodiments, the one or more criteria are satisfied if, after detecting the movement of the user (e.g., as discussed above with reference to step(s) 836), the computer system detects respective input corresponding to a selection of the object to subsequently move the object within the three-dimensional environment. For example, the computer system rotates the object to have the second orientation after detecting an air pinch gesture selecting the object, including rotating the object before detecting movement of the hand that subsequently moves the object (e.g., changes the position of the object) in the three-dimensional environment. In some embodiments, the one or more criteria are satisfied if, after detecting the movement of the user, the computer system detects a first (e.g., initial) portion of the movement of the hand (e.g., which initiates movement of the object) after detecting the air pinch gesture selecting the object. Changing an orientation of an object in a three-dimensional environment in response to detecting movement of the user relative to the object in the three-dimensional environment if the object is selected for movement in the three-dimensional environment enables the object to automatically remain visibly displayed and/or oriented towards the viewpoint of the user in the user's field of view based on the movement of the user, and/or facilitates discovery that the movement of the user causes a rotation axis for the object to be updated based on the new location of the user, thereby facilitating user input for returning to their previous location if the change in orientation of the object is unintended or undesirable and improving user-device interaction.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9J illustrate examples of a computer system facilitating movement of a virtual object beyond a movement threshold in a three-dimensional environment in accordance with some embodiments.

FIG. 9A illustrates a computer system 101 (e.g., an electronic device) displaying, via a display generation component (e.g., display generation component 120 of FIG. 1), a three-dimensional environment 902 from a viewpoint of a user 926 (e.g., facing the back wall of the physical environment in which computer system 101 is located, as shown in side view of legend 920). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the computer system 101 is in communication with a touchpad 930 that is configured to detect touch input (e.g., via a contact provided by a finger of a hand 903 of the user). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user).

As described with reference to method 1000, computer system 101 optionally detects one or more requests to move virtual objects such as movement of an air gesture (e.g., an air pinch including contact between fingers of hand 903) while attention is directed to a virtual object and the air gesture is maintained, movement of an input devices such as a stylus or other pointing device while a button is selected and/or contact with a touch sensitive surface is maintained, and/or movement of a mouse peripheral device in communication with computer system 101 while a button is selected. It is understood that moving the virtual object while the first input is maintained (e.g., the air gesture is maintained, the button on the stylus and/or mouse remains selected, and/or that contact with a touch-sensitive surface is maintained) results in movement of a virtual object—at times referred to herein as “moving” and/or “pulling” of the virtual object—in directions and by magnitudes based on a corresponding direction and/or magnitude of movement of the air gestures, stylus, mouse, and/or contact with a touch-sensitive surface such as touchpad 930. Thus, computer system 101 optionally moves the virtual objects by a magnitude and/or in a direction of physical inputs that are detected via one or more input devices in communication with computer system 101, and/or included in computer system 101.

In some embodiments, virtual object(s) are moved in accordance with any suitable input(s) and/or combination of input(s), described further with reference to method 1000. For example, some embodiments of the disclosure herein are directed to movement of virtual objects in response to and/or caused by input(s) between a hand of a user and a touchpad. In some embodiments, additional or alternative inputs are detected and operative to cause similar and/or the same movements of virtual objects. For example, when embodiments are described with reference to moving a virtual object in accordance with a magnitude of movement of the hand contacting the trackpad, it is understood that computer system 101 optionally moves the virtual object in response to detecting a magnitude of an additional or alternative input, such as a magnitude of movement of an air gesture including magnitude(s) of movement of finger(s), hand(s), and/or arm(s) of the user, a magnitude of movement of a joystick, and/or a magnitude of movement of a tip of a stylus or other pointing device. Additionally, when embodiments are described with reference to moving a virtual object in a direction in accordance with a direction of a hand contacting the trackpad, it is understood computer system 101 optionally moves the virtual object in a direction corresponding to a direction of movement of an additional or alternative input, such as a direction of movement of the portion(s) of the user's body described previously, a direction of movement of a joystick, and/or a direction of movement of the tip of stylus or other pointing device. Additionally or alternatively, when embodiments are described with reference to movement and/or selection of a virtual object performed in response to and/or while a contact between the hand and the air gesture is received, it is understood that computer system 101 optionally initiates and/or continues movement and/or selection of the virtual object in response to detecting and/or while an air gesture and/or air pose are maintained, while a button is selected (e.g., on a mouse), and/or while a surface and/or button is contacted on a stylus or other pointing device. Similarly, embodiments described with reference to the hand not contacting the trackpad apply to embodiments where the computer system 101 ceases a movement of a virtual object in response to detecting a ceasing of an air gesture and/or air pose, a ceasing of movement of a joystick, a ceasing of a pressing of a button, and/or a ceasing of contact between a surface and/or button of a stylus or pointing device. In some embodiments, computer system 101 detects some combination of the various modalities of input described above, and moves the virtual object in accordance with a combination of direction(s) and/or magnitude(s) of input provided via the respective modalities of input. In some embodiments, computer system 101 preferentially moves the virtual object in accordance with a single modality of input when a plurality of modalities of input are concurrently detected, such as moving a virtual object in accordance with an air gesture and not in accordance with a concurrently detected movement of a joystick, and/or moving the virtual object in accordance with a stylus device and not in accordance with a concurrently detected movement of a contact on a trackpad.

Additionally or alternatively, some embodiments are described herein with reference to concurrent detection of attention directed to virtual objects, input(s) directed to virtual objects, and/or movement of the virtual objects in response to the attention and/or input(s). In some embodiments, the attention and/or input(s) are not detected concurrently. For example, computer system 101 optionally detects attention directed to a virtual object, and later detects the attention target something other than the virtual object. In response to detecting input(s) directed to the virtual object, such as one or more air gestures directed to the virtual object, computer system 101 optionally moves the virtual object in accordance with the one or more air gestures without detecting attention that is concurrently directed to the moving virtual object.

As shown in FIG. 9A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 902, and/or provides visibility of the physical environment (e.g., via a passive passthrough through display generation component 120). For example, three-dimensional environment 902 includes a representation 924a of a sofa, which is optionally a representation of a physical sofa in the physical environment.

In FIG. 9A, three-dimensional environment 902 also includes a virtual object 906a (e.g., “Window A,” corresponding to virtual object 906b in the side view of the legend 920), includes a virtual object 908A (e.g., “Window B,” corresponding to virtual object 908b in the side view of the legend 920), and includes a virtual object 910a (e.g., “Window C,” corresponding to virtual object 910b in the side view of the legend 920). In some embodiments, the virtual objects 906a, 908a, and/or 910a are optionally user interfaces of an application containing content (e.g., a plurality of selectable options), three-dimensional objects (e.g., virtual clocks, virtual balls, virtual cars) or any other element displayed by computer system 101 that is not included in the physical environment of display generation component 120. For example, in FIG. 9A, the virtual objects 906a, 908a, and/or 910a are optionally user interfaces of a web-browsing application containing website content, such as text, images, video, hyperlinks, and/or audio content, from the website, or user interfaces of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 902, such as the content described below with reference to method 1000.

In some embodiments, virtual objects are displayed in three-dimensional environment 902 with respective orientations relative to a viewpoint of user 926 (e.g., prior to receiving input interacting with the virtual objects, which will be described later, in three-dimensional environment 902). As shown in FIG. 9A, the virtual object 906a optionally has a first orientation in the three-dimensional environment 902 (e.g., the front-facing surface of the virtual object 906a that faces the viewpoint of user 926 is flat relative to the viewpoint of user 926). Similarly, virtual object 908a and virtual object 910a optionally have a second and third orientation in the three-dimensional environment 902, respectively, relative to the viewpoint of user 926. It should be understood that the orientation of the objects in FIG. 9A is merely exemplary and that other orientations are possible.

In some embodiments, the computer system 101 detects a target of manipulation operations performed moving virtual objects within three-dimensional environment 902. For example, cursor 912, cursor 914, and cursor 916 are optionally indicative of alternative and/or at least partially concurrent targets of virtual object manipulation. In some embodiments, as described with reference to method 1000, such targets are determined in accordance with a determination that attention of the user is directed to a particular object. Cursor 912, for example, optionally indicates that attention such as a gaze of user 926 is directed to virtual object 906a. Similarly, cursor 914 optionally indicates that attention of user 926 is directed to virtual object 908a, and cursor 916 optionally indicates that attention of user 926 is directed to virtual object 910a. In some embodiments, manipulation operations of virtual objects include one or more requests to move virtual objects within three-dimensional environment 902.

In some embodiments, computer system 101 detects one or more requests to move a virtual object. For example, while attention of user 926 is directed to a respective virtual object, computer system 101 optionally detects movement of an input object such as hand 903 contacting and moving across a surface of touchpad 930. In response to such movement, the computer system 101 optionally moves the virtual objects within the three-dimensional environment, described further with reference to method 1000 and at least FIG. 9B.

In some embodiments, computer system 101 determines and/or operates according to one or more movement thresholds relative to viewpoint of user 926 and/or relative to the three-dimensional environment 902. In some embodiments, the movement threshold 928 is a continuous threshold that defines positions within three-dimensional environment 902 that present difficulties in interacting with the virtual objects. For example, moving a virtual object beyond a respective portion of the movement threshold 928 optionally positions the virtual object such that viewing an interaction surface of the virtual object is difficult. To mitigate movement of such virtual objects to disadvantageous positions, computer system 101 optionally determines movement thresholds that are too far away, too close, and/or too low relative to viewpoint of user 926 for optimal interaction with such virtual objects. For example, near-field threshold 936 optionally circumscribes a region surrounding (e.g., centered on or including) viewpoint of user 926, within which virtual objects are relatively too close to interact with. Similarly, far-field threshold 938 optionally circumscribes a region of three-dimensional environment 902 beyond which virtual objects are relatively too far away relative to viewpoint of user 926 to interact with. Additionally, floor-based threshold 940 optionally circumscribes a region of three-dimensional environment 902 beyond which virtual objects are relatively too low relative to viewpoint of user 926 to interact with. As described further with reference to method 1000, the movement threshold 928 optionally is planar and/or a volume, including one or more portions, and/or having a spatial profile based on the physical environment included in three-dimensional environment 902, the body of user 926, and/or three-dimensional environment 902.

From FIG. 9A to FIG. 9B, computer system 101 detects a first input including one or more inputs moving the virtual objects toward far-field threshold 938. In some embodiments, the virtual objects are moved a simulated distance based on a magnitude of displacement of contact made by hand 903 with touchpad 930, and in some embodiments, the virtual objects are moved in a direction that is based on the direction of movement of the contact. For example, hand 903 slides upwards on touchpad from FIG. 9A to FIG. 9B, and in response to detecting the sliding, computer system 101 optionally moves the virtual object along a first dimension relative to the three-dimensional environment 902 (e.g., in depth, in a simulated lateral direction from a left wall to a right wall within the three-dimensional environment 902, and/or vertically relative to the floor and/or ground of three-dimensional environment 902). In some embodiments, in response to detecting movement of an input object along a second direction, different from the first direction (e.g., sliding upwards), the computer system 101 moves a corresponding target of a movement operation in a second direction, different from the first. In response to the one or more inputs moving the virtual objects, the computer system 101 optionally animates a movement of the virtual object. Object 906A is optionally moved a first distance (e.g., due to a first distance of movement of the contact) beyond far-field threshold 938 while the contact is maintained. Object 908a is optionally moved a second, relatively smaller distance beyond far-field threshold 938 in response to a second, relatively smaller movement of the contact, and object 910a is optionally moved a third distance, smaller than the first and the second distance, toward but not beyond far-field threshold 938. In some embodiments, when a virtual object is moved beyond movement threshold 928, computer system 101 offers a simulated resistance to requests to move the virtual object. For example, as described further with reference to method 1000, computer system 101 optionally moves virtual object 906a a relatively smaller distance past far-field threshold 938 in response to a first displacement of hand 903 moving across touchpad 930 as compared to a different movement of virtual object 906a before reaching far-field threshold 938 performed in response to detecting a similar or same displacement of hand 903 moving across touchpad 930. Thus, the computer system 101 optionally simulates an effect of a rubber band coupled between far-field threshold 938 and object 906a, slowing down a rate of movement of object 906a in response to further movement beyond far-field threshold 938. Similarly, while moving object 908a beyond far-field threshold 938, computer system 101 optionally slows down and/or offers simulated resistance to movement of object 908a beyond far-field threshold 938. In some embodiments, while contact with touchpad 930 is static and attention of the user continues to be directed to a respective virtual object, the respective virtual object remains static within the three-dimensional environment, even when beyond movement threshold 928.

FIG. 9A1 illustrates similar and/or the same concepts as those shown in FIG. 9A (with many of the same reference numbers). It is understood that unless indicated below, elements shown in FIG. 9A1 that have the same reference numbers as elements shown in FIGS. 9A-9J have one or more or all of the same characteristics. FIG. 9A1 includes computer system 101, which includes (or is the same as) display generation component 120. In some embodiments, computer system 101 and display generation component 120 have one or more of the characteristics of computer system 101 shown in FIGS. 9A and 9A-9J and display generation component 120 shown in FIGS. 1 and 3, respectively, and in some embodiments, computer system 101 and display generation component 120 shown in FIGS. 9A-9J have one or more of the characteristics of computer system 101 and display generation component 120 shown in FIG. 9A1.

In FIG. 9A1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 9A-9J.

In FIG. 9A1, display generation component 120 is illustrated as displaying content that optionally corresponds to the content that is described as being displayed and/or visible via display generation component 120 with reference to FIGS. 9A-9J. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 9A1.

Display generation component 120 has a field of view (e.g., a field of view captured by external image sensors 314b and 314c and/or visible to the user via display generation component 120, indicated by dashed lines in the overhead view) that corresponds to the content shown in FIG. 9A1. Because display generation component 120 is optionally a head-mounted device, the field of view of display generation component 120 is optionally the same as or similar to the field of view of the user.

In FIG. 9A1, the user is depicted as performing an air pinch gesture (e.g., with hand 903A) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 9A-9J.

In some embodiments, computer system 101 responds to user inputs as described with reference to FIGS. 9A-9J.

In the example of FIG. 9A1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 9A-9J and/or described with reference to the corresponding method(s) are optionally implemented on computer system 101 and display generation unit 120 in a manner similar or analogous to that shown in FIG. 9A1.

From FIG. 9B to FIG. 9C, computer system 101 detects a termination of the first input. For example, computer system 101 optionally detects that contact between hand 903 and touchpad 930 is released, attention is no longer directed to a respective virtual object (e.g., for an amount of time greater than a threshold amount of time (e.g., 0.001, 0.005, 0.01, 0.05, 0.1, 0.5, 1, 5, 10, 50, 100, or 500 seconds), hand 903 no longer maintains an air gesture (e.g., an air de-pinch is detected including ceasing of contact between fingers of hand 903), and/or a button is released. In response to the termination of the first input, the computer system 101 optionally begins to move virtual objects that were previously moved past far-field threshold 938 back toward viewpoint of user 926, thereby improving visibility of virtual content included in such virtual objects, simulating a contracting of the rubber band described previously pulling the virtual objects back toward a position closer to viewpoint of the user 926 and within far-field threshold 938. In some embodiments, virtual objects moved to a position that are not beyond a movement threshold maintain their position relative to three-dimensional environment 902 in response to detecting termination of the first input. For example, virtual object 910a maintains its position from FIG. 9B to FIG. 9C. In some embodiments, object 906a optionally moves back toward viewpoint of user 926 in a direction that opposes its movement when moved beyond the movement threshold, simulating a stretching of a rubber band between far-field threshold 938 and object 906a. For example, the computer system 101 optionally determines a location where the object 906a first was incident with far-field threshold 938, and optionally moves object 906a parallel to a vector extending from the location where object 906a was when the first input was terminated toward the location to where object 906a was first incident with far-field threshold 938, normal to far field threshold 938, and/or normal to a vector extending from the object 906a to a current viewpoint 926 of the user.

In some embodiments, as described with reference to method 1000, the movement is based on a set of simulated laws of physics associated with the portion of movement threshold 938. For example, computer system 101 optionally moves virtual objects 906a and 908a in FIG. 9C with respective magnitudes (e.g., of distance, velocity, and/or acceleration) in accordance with a previous movement of the virtual object. In some embodiments, in response to detecting termination of input moving the virtual object (e.g., a lifting of hand 903 from touchpad 930, terminating its previous contact that was maintained during the moving of the virtual object, and/or termination of an air gesture) such as between FIGS. 9B-9C, computer system 101 rubberbands a virtual object moved beyond a movement threshold in accordance with a distance of the virtual object beyond the movement threshold at a time when input was terminated. Rubberbanding behavior is discussed in greater detail with reference to FIGS. 10A-10L. For example, from FIG. 9B to FIG. 9C, virtual object 906a rubberbands (e.g., moves back toward far-field threshold 938), accelerating with a first magnitude of acceleration and/or with a first speed toward far-field threshold, optionally based on a first distance between far-field threshold 938 and virtual object 906a when the moving of virtual object 906a was terminated (e.g., proportionally, exponentially, and/or logarithmically based on the distance). Thus, virtual object 906a optionally moves in accordance with a simulated set of physics similar to a physical rubber band coupled between virtual object 906a and far-field 938, contracting and snapping virtual object 906a back toward far-field threshold 938 based on the distance the physical rubber band was stretched. Similarly, in response to detecting the moving of the virtual object 908a terminate when virtual object 908a is at a second distance from far-field threshold 938, relatively less than the first distance, computer system 101 optionally rubberbands virtual object 908a toward far-field threshold 938, accelerating with a second magnitude of acceleration that is relatively less than the first magnitude of acceleration and/or with a second speed that is relatively less than the first speed, because virtual object 908a was moved a relatively smaller distance beyond far-field threshold 938. In some embodiments, the velocity (e.g., magnitude and direction) of the virtual objects rubberbanding is based on a set of one or more physical properties and/or on a set of simulated physics that dictates the acceleration and/or displacement of the virtual object when moving beyond the far-field threshold 938.

From FIG. 9C to FIG. 9D, the computer system 101 rubberbands the virtual objects moved beyond the movement threshold to positions within the movement threshold along their previous trajectory. For example, virtual object 906a and virtual object 908a are optionally moved such that their dimensions are within far-field threshold 938, as seen in the side-view legend 920. In some embodiments, the movement of the virtual object 906a and 908a terminate when such objects are moved within a movement threshold, irrespective of a previous simulated velocity and/or momentum of the virtual object when rubberbanding the virtual object. In some embodiments, the virtual object rubberbanding terminates in accordance with a determination a particular portion of the virtual object moves within a movement threshold. For example, virtual objects 906a and/or 908a are optionally rubberbanded until an interactive surface of the respective virtual object is within the far-field threshold 938 (e.g., a surface including virtual content the user 926 will likely interact with and/or view). In some embodiments, the particular portion of the virtual object(s) corresponds to a center, an edge, a corner, a surface, and/or a point along a body of the virtual object.

In some embodiments, the virtual object continues to move within the movement threshold with a simulated velocity and/or simulated deceleration in accordance with the distance past far-field threshold 938 the respective virtual object was when input moving the virtual object past far-field threshold 938 was terminated. For example, when rubberbanding past the far-field threshold 938, the computer system 101 optionally moves the virtual object with a significantly reduced, but non-zero velocity (e.g., a simulated velocity that is scaled down from its previous simulated velocity before crossing back to within far-field threshold 938), and optionally terminating its movement at a position based on a simulated inertia of the corresponding virtual object (e.g., stopping its movement relatively further within far-field threshold 938 when it was moved relatively further beyond far-field threshold 938 when the moving of the virtual object was terminated).

In some embodiments, computer system 101 detects one or more inputs requesting movement of corresponding virtual objects while attention is directed to such objects. In some embodiments, requested movement corresponds to a throwing of the virtual objects, similar to a throwing of a physical object as illustrated in FIGS. 9D-9E. In some embodiments, when the throwing of the virtual objects is beyond a movement threshold, computer system 101 rubberbands the virtual objects to return to positions within the movement threshold, as illustrated in FIGS. 9D-9E. For example, the computer system optionally detects one or more inputs similar to as described with reference to moving of the virtual objects illustrated in FIGS. 9A-9B (e.g., movement of a maintained air gesture, movement of a contact with a touch-sensitive surface such as hand 903 contacting touchpad 930, movement of a mouse device and/or pointing device while a button is depressed), and moves the virtual object in accordance with a maintained one or more inputs. In some embodiments, computer system 101 detects termination of the one or more maintained inputs, and continues to move (e.g., animate movement) the virtual object in accordance with its previous movement while the one or more inputs were maintained (e.g., with a similar or the same speed and/or direction).

For example, in FIG. 9D, computer system 101 detects attention directed to object 906a, object 908a, and object 910a, as indicated by cursor 912, cursor 914, and cursor 916 respectively. Optionally concurrent with detecting attention directed to the virtual objects, computer system 101 optionally detects a throwing of the virtual objects. As described previously, in some embodiments, attention is not concurrently directed to the virtual objects when throwing input(s) are detected (e.g., attention recently targeted the virtual objects), and the computer system proceeds to move the virtual object in accordance with the throwing input(s). Such a throwing of virtual objects optionally includes one or more of the inputs described previously, and the computer system optionally detects one or more kinematic quantities (e.g., displacement, speed, direction, and/or acceleration) of movement of an input object (e.g., hand 903a), and optionally moves the virtual objects in accordance with the movement. For example, in response to detecting a relatively greater speed and/or magnitude of acceleration of an input object requesting movement of the virtual object, the computer system 101 optionally moves the virtual object at a relatively greater simulated speed and/or acceleration, and in response to detecting a relatively lesser speed and/or magnitude acceleration of the input object, optionally moves the virtual object at a relatively lesser simulated speed and/or acceleration.

In some embodiments, while attention is directed to a thrown virtual object, computer system 101 continues to move the virtual object in accordance with the movement of the input object. In some embodiments, in response to detecting a request to terminate the throwing input, the computer system 101 determines a simulated velocity (e.g., speed and/or direction) of the thrown virtual object at the time the input was terminated, and continues to move the virtual object with a similar or the same simulated velocity. Thus, when throwing virtual objects, termination of an input optionally is similar to releasing of a physical object during a throwing of the physical object. In some embodiments, after detecting movement of the virtual object and while the virtual object is moving in response to one or more throwing inputs, in response to detecting additional input (e.g., movement) of the input object that caused the throwing of the virtual object, computer system 101 forgoes additional movement (e.g., moving and/or throwing) of the virtual object in accordance with the additional input of the input object.

From FIG. 9D to FIG. 9E, virtual object 906a and virtual object 908a are thrown in a downward direction relative to the floor of three-dimensional environment 902 and leftward relative to viewpoint of user 926, and virtual object 910a is thrown in the downward direction and further away from the viewpoint of the user 926. Comparatively, virtual object 906a is thrown to a position that is closer to the floor (e.g., further downward relative to viewpoint of the user 926) due to a relatively faster movement of the input object before a throwing input was terminated, relative to virtual object 908a, which corresponds to a termination of a throwing input at a relatively slower movement of the input object at a same and/or similar time the input throwing virtual object 906a was terminated. As shown, virtual object 906a and virtual object 908a are optionally thrown beyond a floor-based threshold relative to the physical environment. Additionally, virtual object 906a and virtual object 908a are thrown in an apparent side-to-side direction relative to viewpoint of user 926. For example, virtual object 906a is optionally thrown with a first magnitude (e.g., of velocity and/or acceleration) relative to viewpoint of user 926 in a leftward direction, and virtual object 908a is optionally thrown a second, relatively lesser magnitude (e.g., of velocity and/or acceleration). Accordingly, virtual object 906a as illustrated in FIG. 9D moves further to the left relative to viewpoint of user 926 compared to virtual object 908a.

As described further with reference to method 1000, computer system 101 optionally determines a range of positions relative to the floor of three-dimensional environment 902 and/or relative to one or more portions of the user's 926 body that are optionally too low for optimal interaction with and/or viewing virtual content included in virtual objects. Accordingly, similar to as described with reference to far-field threshold 938, computer system 101 optionally rubberbands virtual objects when moved beyond such a threshold, such as floor-based threshold 940.

In some embodiments, floor-based threshold 940 corresponds to a continuous and/or contiguous range of positions, wherein portions of the floor-based threshold 940 are parallel to the floor of three-dimensional environment 902. In some embodiments, the floor-based threshold 940 is continuous, contiguous, and/or intersects with far-field threshold 938. Similar to as described with reference to far-field threshold 938, in some embodiments, computer system 101 slows down movement of the virtual objects (e.g., due to a simulated force of a simulated rubber band coupled to the far-field threshold 938 and the virtual object) when thrown beyond floor-based threshold 940 and/or far-field threshold 938. In some embodiments, computer system 101 decelerates the virtual object at a first rate before reaching the far-field threshold 938, and decelerates the virtual object moving beyond floor-based threshold 940 at a second, relatively greater rate when moving beyond floor-based threshold 940. In some embodiments, computer system 101 does not decelerate the thrown virtual object before reaching a movement threshold, such as floor-based threshold 940. In some embodiments, the computer system 101 optionally decelerates the thrown virtual object, optionally animating a stopping of the virtual object's movement, and shortly or immediately thereafter rubberbands the virtual object to a position within floor-based threshold 940. In some embodiments, while a thrown virtual object travels beyond a movement threshold, the thrown virtual object's movement is resisted along a first one or more directions, but not along second one or more directions or is less resisted along the second one or more directions. For example, movement along a first component (e.g., the leftward/horizontal component relative to viewpoint 926) of the virtual object 906a and/or virtual object 908a is optionally opposed to a first degree or not at all, and movement along a second component (e.g., the perceived downward/vertical component relative to viewpoint 926, such as further below floor-based threshold 940) is resisted to a second degree, different from (e.g., greater than) the first degree.

From FIG. 9E to FIG. 9F, the virtual objects rubberband back toward positions within respective movement thresholds. For example, virtual object 906a is optionally rubberbanded upward toward a ceiling of three-dimensional environment 902 with a first magnitude (e.g., distance, velocity, and/or acceleration) and virtual object 908a is optionally rubberbanded upward toward the ceiling with a second magnitude (e.g., distance, velocity, and/or acceleration) optionally less than the first magnitude. In some embodiments, virtual object 906a and virtual object 908a are rubberbanded rightward (e.g., in response to the leftward component of throwing of the virtual objects described previously). Similarly, virtual object 910 optionally rubberbands back toward a position within far-field threshold 938 and within floor-field threshold (e.g., relative to the viewpoint of the user 926), in several directions (e.g., upward toward the ceiling and closer to viewpoint of the user 926).

From FIG. 9F to 9G, computer system 101 optionally completes the rubberbanding of the virtual objects. For example, virtual object 906a and virtual object 908a are optionally moved upward to a same vertical position, within the floor-based threshold 940. Additionally, virtual object 910a is optionally moved upwards, within floor-based threshold 940 similar to as described to virtual object 906a and 908e from FIG. 9F to FIG. 9G, and optionally concurrently is moved closer to viewpoint 926 and within far-field threshold 938, as described with reference to virtual object 906a and virtual object 908a from FIGS. 9B-9D.

In FIG. 9G, computer system 101 detects attention directed to virtual object 906a, virtual object 908a, and virtual object 910a, as indicated by cursor 912, cursor 914, and cursor 916 respectively. Concurrent with the attention, computer system 101 optionally detects one or more inputs including contact between hand 903 and touchpad 930 corresponding to one or more inputs moving the virtual objects to updated positions within the three-dimensional environment 902.

From FIG. 9G to FIG. 9H, computer system 101 optionally detects one or more inputs moving virtual objects and in response, moves the virtual objects. Virtual object 906a, for example, is moved until one or more portions on the left side of virtual object 906a are coincident (e.g., presenting an apparent spatial conflict with) a physical and/or virtual wall of three-dimensional environment 902. Virtual object 910a is optionally moved into one or more portions of representation 924a of the sofa, such that one or more portions of the virtual object 908 are coincident with the virtual object 910a. As described herein, an apparent spatial conflict corresponds to an arrangement of virtual objects relative to representations of physical objects and/or other virtual content that would present a physical conflicting and/or contacting of physical objects occupying the same physical positions as corresponding virtual content (e.g., virtual content such as virtual objects and/or physical objects visible via display generation component 120). For example, a physical object comparable to virtual object 906a in size and position relative to a physical wall would protrude into the physical wall, and a physical object comparable to virtual object 910a in size and position relative to the sofa represented by representation 924a would protrude into the sofa.

In some embodiments, a virtual object is moved within a near-field threshold 936 that is determined relative to one or more portions of the user's 926 body and/or the three-dimensional environment 902. For example, in FIG. 9H, virtual object 908a is moved (e.g., and/or pulled, similar to as described with reference to the “moving” of a virtual object) within near-field threshold 936. In some embodiments, near-field threshold 936 corresponds to one or more positions within three-dimensional environment 902 that are relatively too close to the viewpoint of the user 926 for optimal viewing and/or interaction with the virtual content included in a respective virtual object. For example, virtual object 908a is moved within a downward-sloping portion of near-field threshold 936, corresponding to a threshold distance of user 926 (e.g., the user's head, body, limbs, appendages, and/or a respective portion of such portions of the user's body (e.g., a center, a distal portion and/or a proximal portion)).

In some embodiments, near-field threshold 936 is comprised of a plurality of movement thresholds that operate in accordance with a shared set of simulated laws of physics (e.g., moving and/or rubberbanding of virtual objects is similar or the same within the plurality of movement thresholds). For example, a first portion of near-field threshold 936 includes a first volume and/or surface (e.g., a sphere, prism, and/or an ellipsoid) at least partially surrounding a portion of the user's body (e.g., the user's head, facial features, neck, and/or torso) and a second portion includes a second volume and/or surface corresponding to and/or partially surrounding a portion of the user's body (e.g., a wedge shape expanding toward the floor, a cone, a cylinder), described further with reference to method 1000.

From FIG. 9H to FIG. 9I, the computer system 101 optionally detects termination of movement inputs moving virtual objects, and in response to detecting the termination, optionally maintains virtual objects not positioned beyond a movement threshold at their previous positions when termination of the movement inputs were detected, and rubberbands a virtual object to a position that is no longer beyond near-field threshold 936 in response to detecting termination of the movement input. For example, virtual object 906a and virtual object 910a are optionally not moved, and virtual object 908A is optionally moved away from viewpoint of the user 926 in accordance with a respective set of simulated physics. In some embodiments, the near-field threshold 936 has one or more characteristics of the floor-based threshold 938 and far field threshold 940 described previously, but as related to positions of virtual content that are relatively too close to user 926. Further description of such characteristics is omitted for brevity. In FIG. 9I, virtual object 906a presents an apparent spatial conflict with a physical wall of three-dimensional environment 902, as indicated by the cross-hatched pattern consuming a left portion of virtual object 906a. In some embodiments, computer system 101 displays such a portion of virtual object 906a with a visual appearance different from a portion of virtual object 906a not presenting an apparent spatial conflict with a physical object in the environment of the user. For example, the cross-hatched portion optionally corresponds to a modified level of opacity, saturation, brightness, a magnitude of a blurring effect, and/or a degree of modification of a border relative to other portions of virtual object 906a. Similarly, the portion of object 910a including a cross-hatched portion presents an apparent spatial conflict with couch 924a (e.g., a physical object), and is modified in visual appearance in accordance with an amount of the apparent spatial conflict, similarly to as described with reference to virtual object 906a. In FIG. 9I, computer system 101 optionally detects one or more inputs moving virtual object 906a upward toward a ceiling of three-dimensional environment 902.

From FIG. 9I to FIG. 9J, computer system 101 detects a changing of posture of user 926 and/or a movement of computer system 101. In response to the one or more inputs moving virtual object 906a to a position presenting an additional, apparent spatial conflict with the ceiling of the three-dimensional environment 902, computer system 101 optionally increases an amount of the modified visual appearance of the cross-hatched portions of virtual objects 906a and/or 906b based on the increased amount of apparent spatial conflict. For example, computer system 101 expands the cross-hatched portion of virtual object 906a due to the apparent spatial conflict with the ceiling of three-dimensional environment 902 in FIG. 9J, in addition to its previous spatial conflict with the wall of three-dimensional environment 902. In some embodiments, computer system 101 does not determine a movement threshold relative to one or more portions of the physical environment, such as the ceiling. Accordingly, the computer system 101 optionally does not rubberband virtual object 906a in response to detecting termination of one or more inputs moving virtual object 906a into the ceiling.

In some embodiments, one or more portions of movement threshold 928 are changed in response to detecting a change in posture and/or position of user 926 relative to three-dimensional environment 902. For example, in response to detecting the user move from a seated to a standing position, computer system 101 optionally raises one or more portions of movement threshold 928, such as a downward sloping portion of near-field threshold 936 and/or changing a slope and/or spatial profile of floor-based threshold 940 (not shown). Such a change optionally includes changing a shape (e.g., curvature, a number of volumetric shapes, and/or an angle) of such movement thresholds, changing an elevation of such movement thresholds, changing a height (e.g., a threshold distance) of the movement thresholds, and/or maintaining a shape relative to the user's body while changing the height and/or elevation of the movement thresholds. In some embodiments, computer system maintains one or more positions of movement threshold 928 relative to one or more portions of the user's body as, while, in response to and/or after the one or more portions of the user's body move. For example, a respective portion of movement threshold 928 is optionally offset 0.25 m from the user's head (e.g., a center of the user's head, a top of the user's head, and/or a bottom of the user's chin), such as a top of the near-field threshold 936 and/or a respective point along a sloped portion of near-field threshold 936.

FIGS. 10A-10L is a flowchart illustrating a method of facilitating movement of a virtual object beyond a movement threshold in a three-dimensional environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system in communication with a display generation component and one or more input devices. In some embodiments, the computer system, the display generation component, and the one or more input devices have one or more characteristics described with reference to method 800. In some embodiments, the computer system, displays (1002a), via the display generation component, a virtual object at a first position within a three-dimensional environment, such as objects 906A, 908A, and 910A in FIGS. 9A and 9A1. For example, the virtual object optionally is a virtual window including virtual content, such as a user interface of an application, media, two-dimensional and/or three-dimensional virtual objects, and/or a user interface to modify user settings and/or preferences of the computer system. The virtual object optionally has one or more characteristics of the virtual object described with reference to method 800. In some embodiments, the virtual object is displayed within a three-dimensional environment, such as a virtual reality (VR), mixed reality (MR), augmented reality (AR), and/or an extended reality (XR) environment. The three-dimensional environment optionally has one or more of the characteristics of the three-dimensional environment of method 800. For example, the virtual object is optionally displayed within an XR environment including a representation of the physical environment (e.g., via a physical and/or digital visual passthrough, such as one or more transparent lenses and/or one or more cameras) at a first position within the XR environment. The virtual object is optionally a world-locked object.

In some embodiments, while displaying, via the display generation component, the virtual object at the first position, the computer system detects (1002b), via the one or more input devices, a first input including a request to move the virtual object from the first position to a second position within the three-dimensional environment, different from the first position, such as hand 903A directed to touchpad 930 in FIGS. 9A and 9A1. In some embodiments, the first input has one or more of the characteristics of the input(s) described with reference to method 800. For example, the computer system optionally detects a selection input such as an air gesture (e.g., an air pinch including contacting of a thumb and an index finger, movement of one or more fingers and/or a hand including one or more swiping gestures, a splaying of one or more fingers of a hand, and/or a pointing of a finger such as an index finger) while attention is directed to the virtual object, a contacting of a surface (e.g., touch-sensitive surface) while a pointing device such as a mouse and/or a stylus is directed to the virtual object, and/or an actuation of a virtual or physical button. In some embodiments, the virtual object is selected in response to the selection input. In some embodiments, the virtual object remains selected until the selection input is repeated and/or a similar input is received to de-select the virtual object. In some embodiments, the virtual object remains selected while the selection input is ongoing. For example, while the computer system detects that a hand of the user continues to maintain an air-pinch hand shape (e.g., with the tips of the thumb and index fingers remaining in contact), the computer system optionally continues to select the target of the air pinch gesture (e.g., the virtual object). Similarly, while the computer system detects continuous—or nearly continuous—contact between a finger of the user of the computer system and the surface of the computer system and/or a second computer system in communication with the computer system (e.g., a trackpad device), the computer system maintains the selection of the virtual object. In some embodiments, the computer system displays an interactable virtual object associated with the virtual object, that is selectable to initiate a move operation of the virtual object. The interactable virtual object—at times referred to herein as a “grabber”—is optionally displayed near the virtual object (e.g., immediately below the virtual object relative to a floor of the physical environment), and while selected, functions to move the virtual object within the three-dimensional environment. For example, while the grabber is selected, the computer system optionally detects one or more inputs including one or more movements of a finger, a hand (e.g., while maintaining the air pinch hand shape), and/or an arm of the user, and in response to the one or more movements, translates the virtual object within the three-dimensional object to an updated, second position within the three-dimensional environment. In some embodiments, the grabber is not displayed, and while the virtual object is selected, the computer system detects one or more inputs such as the one or more movements described previously with reference to the grabber and translates (e.g., moves) the virtual object based on the one or more movements. Thus, in some embodiments, the computer system detects a first input—such as a selection and/or movement of the virtual object—including a request to move the virtual object from a first position to a second position within the three-dimensional environment. In some embodiments, a magnitude and/or a direction of translation of the virtual object is based on a corresponding magnitude and/or direction of movement of a respective portion of a user (e.g., the user's hand) and/or a movement of a contact (e.g., between the respective portion of the user and a surface such as a touch-sensitive surface) included in the first input.

In some embodiments, in response to receiving the first input (optionally while receiving the first input and before detecting a termination of the first input, such as described below with reference to step(s) 1004), the computer system displays (1002c), via the display generation component, the virtual object at the second position within the three-dimensional environment, such as the updated positions of objects 906A, 908A, and 910A in FIG. 9B. For example, while the virtual object is selected and/or is being moved, the first input is optionally ongoing (e.g., the computer system has not detected termination of the first input). In response to the one or more inputs moving the virtual object from the first position to the second position, the computer system optionally displays at a least a portion or the entirety of the virtual object at the second position (e.g., after having displayed the virtual object moving from the first position to the second position in accordance with the first input).

In some embodiments, after detecting termination of the first input (1002d) (e.g., in response to detecting the termination of the first input), in accordance with a determination that the second position satisfies one or first criteria, including a criterion that is satisfied when a respective portion of the virtual object corresponds to a respective position within the three-dimensional environment that is beyond a movement threshold in the three-dimensional environment, such as one or more portions of objects 906A and 908A in FIG. 9B beyond far-field threshold 938, (automatically, without user input for doing so) the computer system moves (1002e) the virtual object from the second position to a third position within the three-dimensional environment, wherein the third position is different from the first position and the second position (e.g., and is within the movement threshold in the three-dimensional environment), such as the updated positions of objects 906A and 908A in FIG. 9C. For example, the computer system optionally determines that if the virtual object is displayed in its entirety at the second position, the respective portion of the virtual object while displayed at the second position extends beyond a boundary corresponding to an impermissible location of the virtual object. As an example, the computer system optionally defines one or more regions of the environment that are beyond a boundary allowed for virtual content relative to a current viewpoint of the user, such that viewing and/or interacting with respective virtual content (e.g., photos, video, text, and/or interactable virtual elements like pushbuttons) displayed beyond the boundary is optionally suboptimal due to a reduced size of the virtual object. In response to a first input including a request moving the virtual object from a first position to a second position, such that at least a portion of the virtual object (e.g., a corner, a point corresponding to the virtual object, and/or a three-dimensional shape bounding the virtual object such as a mesh surrounding the virtual object that optionally is not displayed) extends into a far-field region that is beyond the boundary relative to the current viewpoint of the user of the computer system, the computer system optionally moves (e.g., displays) the virtual object at the second position until the first input is terminated. In response to determining the first input is terminated (e.g., an air pinch gesture is released), the computer system optionally moves the virtual object to a third position, relatively closer to the current viewpoint of the user, such that the portion of the virtual object no longer protrudes into the far-field region at the second position. Thus, in some embodiments, the computer system proactively moves the virtual object to a position that improves viewing of the virtual object if a destination of a movement operation satisfies the one or more criteria. The one or more criteria optionally include a criterion that is satisfied when the respective portion of the virtual object extends into a respective region of one or more regions of the three-dimensional environment. Additionally or alternatively, the computer system optionally defines one or more near-field regions. For example, if a portion of the virtual object extends into a region of the three-dimensional environment that is within a boundary surrounding at least a portion of a head of a user of the computer system when the computer system detects termination of the first input, the computer system optionally moves the virtual object to an updated position, further away from the viewpoint of the user, such that the portion of the virtual object no longer is extending into the boundary surrounding to the portion of the head of the user. In some embodiments, the computer system defines one or more movement thresholds based on a physical environment of the user. For example, the computer system optionally detects a floor of the physical environment, and in response to detecting termination of a movement of the virtual object to a position that extends into the floor, the computer system optionally moves the virtual object away from the virtual floor. In some embodiments, the computer system defines one or more boundaries based on additional or alternative aspects of the physical environment, such as the physical floor of the environment, one or more boundaries relative to one or more portions of the user's body, and/or virtual boundaries such as virtual walls and/or floors of an immersive virtual environment.

In some embodiments, the computer system detects termination of the first input while displaying the virtual object at the second position within the three-dimensional environment, such as the terminated input shown in FIG. 9B. For example, the computer system, optionally detects a second selection input that has one or more characteristics of the selection input described previously, and in response, terminates the selection and/or the movement operation(s) of the virtual object. Additionally or alternatively, the computer system optionally detects the termination of the first input in response to detecting an air gesture and/or an updated posture of a portion (e.g., finger(s), hand(s), and/or (arms)) of the user. For example, the computer system optionally determines the first input is ongoing while an air pinch gesture is maintained, and in response to detecting the hand of the user that formed the air pinch has assumed a pose that does not correspond to the air pinch (e.g., the tips of the index finger and the thumb of the user are no longer in contact), determines that the air pinch (e.g., the first input) has terminated. In some embodiments, the first input is terminated in response to detecting a target of selection and/or movement has shifted from the virtual object to a second, different virtual object. For example, in response to detecting attention of the user shift from the virtual object to a second virtual object, the computer system optionally determines that the first input (e.g., selecting and/or moving the virtual objected) has terminated.

In some embodiments, in accordance with a determination that the second position does not satisfy the one or more first criteria, the computer system maintains (1002f) display of the virtual object at the second position within the three-dimensional environment, such as the maintaining the position of object 910A from FIG. 9B to FIG. 9C. For example, if the respective portion of the virtual object does not extend into one or more regions beyond the one or more movement thresholds when the first input is terminated, the computer system optionally maintains display of the virtual object at the second position without moving the virtual object to the third position. Moving the virtual object to a third position if the one or more criteria are satisfied improves visibility of the virtual object and reduces visual conflict with certain portions of the three-dimensional environment (e.g., beyond the above-described boundaries), thereby reducing input required to manually improve the visibility and reducing input erroneously directed to the virtual object due to suboptimal visibility of the virtual object.

In some embodiments, the virtual object is moved to the second position while the first input is ongoing, such as the moving of object 906A in FIG. 9B, and the virtual object is moved to the third position in response to detecting the termination of the first input (1004), such as moving of object 906A in FIG. 9C. For example, as described with reference to step(s) 1002, the computer system detects a selection input that is ongoing, and updates the position of the virtual object based on a magnitude and/or degree of movement of the selection input (e.g., movement of a maintained air gesture, movement of an object contacting a touch-sensitive surface of a hardware input device in communication with the computer system, movement of a mouse device while a mouse button remains depressed, movement of a stylus and/or pointing device while a button is depressed, and/or similar movement of similar objects before an express input terminating the selection is received), referred to herein as a “pushing” of the virtual object. In some embodiments, the computer system detects termination of the input, and moves the virtual object in accordance with one or more laws of simulated physics, described with reference to step(s) 1034-1040. In some embodiments, the termination of the input includes a release of contact with a touch-sensitive surface, a release of a button, a change in a posture of a portion of the body (e.g., a hand) of the user to an air gesture or pose that is different from the selection air gesture, and/or a second selection input is received corresponding to an express request to terminate the selection. In some embodiments, the computer system moves the virtual object back toward a movement threshold until at least a portion (e.g., a front-facing surface, corner, and/or body) of the virtual object is no longer extending beyond the movement threshold, referred to herein as a “rubberbanding” of the virtual object. In some embodiments, the computer system moves the virtual object in accordance with one or more simulated physical properties and/or in accordance with a set of simulated laws of physics, such as a simulated Hooke's law. It is understood that description herein of movement of virtual objects in accordance with one or more simulated physical properties includes movement based on the previously described set of simulated laws of physics (e.g., the set of simulated laws of physics being applied to the simulated physical properties to result in one or more simulated responses of the virtual object(s)). For example, the computer system detects an amount of displacement measured between the second position and the movement threshold and animates a translation of the virtual object with a magnitude of acceleration based on the displacement, such that the greater the displacement, the greater the acceleration of the virtual object when the first input is terminated. In some embodiments, the relationship between the displacement and the simulated acceleration of the virtual object moving back toward the movement threshold is linear, exponential, logarithmic, and/or some other non-linear relationship between the displacement and the simulated acceleration. Moving the virtual object from the second position to the third position in response to detecting termination of the first input provides opportunity to interact with the virtual object at a consistent distance relative to the current viewpoint, and when the user opts to terminate the first input, moves the virtual object toward a movement threshold, thereby avoiding premature moving of the virtual object before the first input is terminated and reducing user input moving to correct for such erroneous movement.

In some embodiments, the displaying of the virtual object at the second position occurs in response to receiving the first input and after detecting the termination of the first input (1006), such as a termination of input causing moving of objects 906A, 908A, and 910A in FIG. 9E. In some embodiments, the first input includes movement of an input object (e.g., a hand of the user, one or more fingers of the user, a stylus and/or pointing device in communication with the computer system, and/or movement of a finger contacting a trackpad) detected by the computer system, and after detecting termination of the input as described with reference to step(s) 1004, the virtual object continues to move—without detecting express user input requesting such movement—with a simulated momentum based on the movement of the input object before the first input was terminated. Such movement after termination of the first input, and in response to the first input is referred to herein as a “throwing” of the virtual object, and the virtual object is optionally referred to as a “thrown” object and/or a “flying” object for brevity. For example, similar to throwing a physical object, when a speed of the virtual object due to the movement of the input object is relatively fast (e.g., a ball is thrown with a large amount of force), the virtual object continues to move relatively fast and/or far after the first input is terminated as compared to the speed of the virtual object due to a relatively slow movement of the input object (e.g., when the ball is thrown with less force). In some embodiments, the simulated velocity (e.g., speed and direction) of the virtual object is based on, continues in a similar velocity and/or continues as the same velocity as the simulated velocity of the virtual object before and/or at a time when the first input is terminated, and when the virtual object moves beyond the movement threshold, continues in a similar or same direction at a gradually reduced velocity, as described further with reference to step(s) 1008. Displaying the virtual object at the second position in response to receiving the first input and after the first input terminates reduces user input required to move virtual objects to updated positions in the three-dimensional environment, thereby improving interaction efficiency with the three-dimensional environment and/or reducing processing required to continuously detect changes in the first input.

In some embodiments, in response to receiving the first input, after detecting the termination of the first input, and before displaying the virtual object at the second position and before displaying the virtual object at the third position, the computer system moves (1008) the virtual object from a fourth position to the second position within the three-dimensional environment with simulated inertia (e.g., the movement of the virtual object from the fourth position to the second position is based on one or more characteristics of the first input), such as with a simulated inertia of virtual object 906A moving in FIG. 9B and/or FIG. 9C. In some embodiments, the virtual object slows down (e.g., due to a simulated inertia of the virtual object) when the virtual object reaches or is beyond the movement threshold. In some embodiments, to simulate physical inertia of a physical object that is similar to the virtual object, the computer system slows down the movement of the virtual object by a magnitude of deceleration based on a simulated velocity of the virtual object in response to detected throwing of the virtual object. For example, when the virtual object moves with a first velocity before reaching the movement threshold, when reaching the movement threshold, the virtual object moves with a second, decreased velocity, optionally without detecting input requesting such decreases in velocity. In some embodiments, the velocity of the virtual object progressively (e.g., gradually) decreases (e.g., due to the simulated inertia) until the movement of the virtual object ceases at a position that is beyond the movement threshold. In some embodiments, the decrease in velocity is based on a speed and/or a direction of movement of the virtual object before reaching the movement threshold, following a behavior that is similar to a stretching or compressing of an invisible rubber band that is coupled between the virtual object and the movement threshold. For example, the virtual object when moving past the movement threshold slows down in a plurality of directions relative to the three-dimensional environment corresponding to a plurality of directions of movement prior to reaching the movement threshold. Additionally or alternatively, the speed of the virtual object along the plurality of directions is optionally decreased beyond the movement threshold, decelerating at a rate based on (e.g., proportional to) the simulated speed of the virtual object at the time the virtual object reaches the movement threshold. In some embodiments, the movement of the virtual object is opposed based on a first degree of simulated inertia before reaching the movement threshold, and is opposed based on a second, relatively greater degree of simulated inertia after reaching the movement threshold. In some embodiments, the movement of the virtual object is not opposed before reaching the movement threshold. In some embodiments, the simulated velocity (e.g., speed and direction) of the virtual object is based on, continues at a similar velocity, and/or continues at a same velocity as the simulated velocity of the virtual object before and/or at a time when the first input is terminated, and when the virtual object moves beyond the movement threshold, continues in a similar or same direction at a gradually reduced velocity. Moving the virtual object with a simulated inertia beyond the movement threshold decreases the likelihood that the user moves the virtual object beyond a distance suitable for interaction with the virtual object, thus reducing user input required to move the virtual object closer back toward a current viewpoint of the user, and/or helping avoid or reduce errors in interaction with the virtual object.

In some embodiments, the third position corresponds to a position within the three-dimensional environment coincident with the movement threshold (1010), such as the position of objects 906A and/or 908A in FIG. 9D. For example, the computer system moves the virtual object to an updated position (e.g., the third position) such that the virtual object does not extend beyond the movement threshold, optionally without detecting express input for moving the virtual object to the updated position. For example, as described with reference to step(s) 1004, the computer system moves the virtual object in accordance with a simulated Hooke's law while the virtual object is located beyond the movement threshold. In some embodiments, the third position is based on a previous movement of the virtual object relative to the movement threshold. For example, when the virtual object is moved past the movement threshold in a first direction, the computer system moves the virtual object back to a position within the movement threshold that is in the first direction, thereby terminating the movement of the virtual object at the third position that is coincident with movement threshold. Moving the virtual object to a position coincident with the movement threshold reduces the likelihood the virtual object is placed such that the virtual object is difficult to interact with, thereby reducing user input required to manually move the virtual object to a relatively improved position for interaction and/or helping avoid or reduce errors in interaction with the virtual object.

In some embodiments, the movement threshold corresponds to a minimum allowed distance between the respective portion of the virtual object and a current viewpoint of a user of the computer system (e.g., including a respective portion of the user's body) in the three-dimensional environment (1012), such as near-field threshold 936 in FIG. 9G. In some embodiments, the computer system determines a near-field threshold relative to the current viewpoint of the user to reduce the likelihood virtual objects are moved too close to the current viewpoint of the user for viewing and/or interacting with virtual content included in the virtual objects. For example, the computer system optionally determines a range of positions within a threshold distance (e.g., 0.0001, 0.001, 0.01, 0.1, 1 m) of the current viewpoint of user, such that when a virtual object is moved within the threshold distance, the computer system moves the virtual object to a position that is outside of the threshold distance (e.g., and away) from the current viewpoint after termination of the first input. In some embodiments, the threshold distance is measured relative to a respective portion of the user's body (e.g., a center of a head of the user, one or more facial features of the user, a center of a torso of the user, eyes of the user, a back of the head of the user, a neck of the user, and/or shoulders of the user). In some embodiments, the threshold distance is measured relative to one or more portions of the computer system (e.g., from the display generation component, from a passive lens included in the computer system, from a center of a housing of the computer system, from a band included in the computer system configured to couple the computer system to the user's body, and/or from a position determined based on the previously described potions of the computer system such as a center between the band and the lens of the computer system). In some embodiments, a spatial profile of the near-field movement threshold is measured uniformly relative to the one or more portions of the user's body and/or the computer system (e.g., similar to a not-displayed sphere surrounding the head of the user). In some embodiments, determining a reference at the respective portion of the user's body has one or more characteristics of determining a reference at a portion of the user's body as described in method 800. Determining a movement threshold that restricts movement of virtual objects to positions that are relatively close to the current viewpoint helps improve visibility of the totality of the virtual objects and/or improves visibility of virtual content included in the virtual objects, thereby reducing the likelihood the user moves one or more of the virtual objects to a position that is suboptimal for interacting with the virtual object, which also helps reduce eye strain for the user.

In some embodiments, the movement threshold has a respective spatial profile relative to the three-dimensional environment based on a respective portion of a body of the user of the computer system (1014), such as a spatial profile based on a head of a user in FIG. 9G, including near-field threshold 936 in FIG. 9G. For example, the movement threshold is optionally a continuous threshold measured relative to one or more portions of the user's body, optionally having a spatial profile (e.g., one or more shapes) relative to the three-dimensional environment surrounding the user of the computer system. In some embodiments, the spatial profile includes a first shape (e.g., having a first volume) surrounding first one or more portions of the user's body (e.g., a sphere, an ellipsoid, a geometric prism, and/or an asymmetric volumetric shape, surrounding (e.g., centered at) a head of the user) and a second shape (e.g., having a second volume) surrounding second one or more portions of the user's body (e.g., similar shapes as described previously, centered on the torso and/or legs of the user). In some embodiments, the spatial profile includes a first shape surrounding the user of the computer system. In some embodiments, the spatial profile includes one or more shapes of the movement threshold that are continuous and/or contiguous with other portions of the movement threshold corresponding to other portions of the three-dimensional environment (e.g., the floor or ground of the three-dimensional environment). In some embodiments, the spatial profile of one or more portions of the movement threshold is maintained, but a location of the movement threshold is updated in response to detecting movement of the user's body. For example, one or more movement thresholds are raised relative to a floor of the physical environment in response to detecting the user stand up, described further with reference to step(s) 1042, while a wedge-shaped near field threshold volume—expanding downward from the user's head toward the floor—is translated upwards by a distance corresponding to a displacement of the user's head from a seated to the standing posture. Thus, a spatial profile of the movement threshold defined relative to the user's viewpoint (e.g., body) is maintained in response to detecting movement of the user's body, and a second spatial profile of the movement threshold defined relative to the three-dimensional environment is changed in response to the detecting of movement. Defining a movement threshold spatial profile based on the portion of the user's body reduces the likelihood the virtual object is moved to a position that is too close to the user's body and/or viewpoint for interaction, thereby reducing the need for inputs to correct for such unwanted movement of the virtual object and/or helping reduce or avoid errors in interaction with the virtual object.

In some embodiments, the movement threshold corresponds to a maximum allowed distance between the respective portion of the virtual object and a current viewpoint of a user of the computer system in the three-dimensional environment (1016), such as far-field threshold 938 in FIG. 9C. For example, the movement threshold includes a far-field threshold, including a range of positions determined relative to the current viewpoint of the user at which interaction with the virtual object is suboptimal. For example, the computer system optionally determines a range of positions within a threshold distance (e.g., 0.5, 1, 10, 100, or 1000 m) of the current viewpoint of user, such that when a virtual object is moved beyond the threshold distance, the computer system moves the virtual object back toward the current viewpoint to a position that is within the threshold distance after termination of the first input. In some embodiments, the movement has a spatial profile relative to the user's body (e.g., similar or the same shapes described with reference to step(s) 1014). In some embodiments, the far-field threshold is a plane perpendicular to a floor or surface of the three-dimensional environment at the threshold distance away from the current viewpoint. Determining a movement threshold relative to the current viewpoint of the user, and beyond which the virtual object is moved back toward the current viewpoint of the user, reduces user input required to correct for movement of the virtual object to positions within the three-dimensional environment suboptimal for interaction with the virtual object and/or helps reduce or avoid errors in interaction with the virtual object.

In some embodiments, the movement threshold corresponds to a floor of a physical environment of a user of the computer system (1018) (e.g., a surface included in (e.g., visible in) the three-dimensional environment on which a user of the computer system is positioned), such as corresponding to a floor of environment 902 illustrated in the legend 920. For example, the movement threshold is coincident with and/or parallel to the floor of the physical environment of the user, and the computer system moves the virtual object back within the movement threshold after (e.g., in response to) detecting termination of the first input. In some embodiments, the movement threshold prevents movement of the virtual object within a threshold distance (e.g., 0.0001, 0.001, 0.01, 0.1, 1 m) of the floor. In some embodiments, the movement threshold is at least partially curved relative to the physical floor. In some embodiments, the movement threshold corresponding to the floor is parallel to the floor outside a first threshold distance from the current viewpoint (e.g., 0.0001, 0.001, 0.01, 0.1, 1 m), and is non-parallel (e.g., sloped, or curved) to the floor outside a second threshold distance (e.g., 0.0001, 0.001, 0.01, 0.1, 1 m) from the current viewpoint (e.g., between the far-field movement threshold and a near-field threshold described with reference to step(s) 1012 based on a portion of the user's body). In some embodiments, the spatial profile and/or location of the movement threshold is independent of physical objects within the physical environment, for example, not offset relative to a physical object and/or passing through a physical object. Determining a movement threshold corresponding to a floor of the physical environment reduces the likelihood that the computer system displays virtual objects at positions presenting apparent spatial conflicts with the floor, which helps reduce eye strain caused by such spatial conflicts, thereby improving visibility of virtual content included in the virtual object and reducing user input required to resolve such apparent spatial conflicts.

In some embodiments, after detecting termination of the first input (e.g., in response to detecting the termination of the first input) (1020a), such as termination of input in FIG. 9E, in accordance with a determination that the second position satisfies one or more second criteria, different from the one or more first criteria, including a criterion that is satisfied when the respective portion of the virtual object corresponds to a second respective position within the three-dimensional environment that is beyond a second movement threshold in the three-dimensional environment, such as far-field threshold 938 in FIG. 9D, different from the movement threshold in the three-dimensional environment, such as near-field threshold 936 in FIG. 9G, (automatically, without user input for doing so) the computer system moves (1020b) the virtual object from the second position to a fourth position within the three-dimensional environment, wherein the fourth position is different from the first position and the second position, such as termination of input causing the movement of the object 906A in FIG. 9C to its position in FIG. 9D. For example, the computer system rubberbands the virtual object when moved past the movement threshold described with reference to step(s) 1002, and optionally rubberbands the virtual object when moved past a second, different movement threshold (e.g., 0.0001, 0.001, 0.01, 0.1, 1, 10, or 100 m from a current viewpoint of the user). In some embodiments, the second criteria are similar or the same as the criteria described with reference to step(s) 1002, however, are based on the second movement threshold (e.g., a near-field threshold described with reference to step(s) 1012) instead of the movement threshold (e.g., a far-field threshold described with reference to step(s) 1016).

In some embodiments, the virtual objects are rubberbanded back to within respective thresholds to updated positions coincident with the respective thresholds in accordance with a determination that at least a portion of the virtual object extends beyond the respective thresholds. For example, the computer system detects a first corner of a virtual object extend beyond the far-field movement threshold while a second corner of the virtual object is within the far-field movement threshold, and rubberbands the virtual object to an updated position such that the first corner is within the far-field movement threshold. When the computer system optionally detects the second corner—but not the first corner—move within the near-field threshold of the current viewpoint of the user, the computer system optionally rubberbands the virtual object back outside of the near-field threshold. Thus, it is understood that according to embodiments herein described with reference to a “respective portion” of a virtual object satisfying one or more first or second criteria, that different portions of the same virtual object can respectively satisfy the one or more first or the second criteria.

In some embodiments, after detecting termination of the first input (e.g., in response to detecting the termination of the first input) (1020a) in accordance with a determination that the second position does not satisfy the one or more second criteria and does not satisfy the one or more first criteria (e.g., and does not satisfy other criteria satisfied when the respective portion of the virtual object is beyond any other movement threshold), the computer system maintains (1020c) display of the virtual object at the second position within the three-dimensional environment, such as maintaining the position of object 910A in FIG. 9C. For example, as similarly described with reference to the one or more first criteria, but relative to the second one or more criteria, the computer system maintains display of the virtual object when moved to an updated position (e.g., the second position) that is not beyond the second movement threshold. Rubberbanding the virtual object within a first or a second threshold in accordance with a determination that the virtual object extends beyond a respective threshold reduces the likelihood that the virtual object is moved to a variety of positions that are suboptimal for interacting with the virtual object, thereby further improving user interaction efficiency by reducing user input required to correct for suboptimal placement of the virtual object and/or helping avoid or reduce errors in interaction with the virtual object.

In some embodiments, the respective portion of the virtual object is different from the second respective portion of the virtual object (1022), such as a different respective portions object 906A in FIG. 9C. In some embodiments, the computer system rubberbands the virtual object within a first movement threshold when a first portion (e.g., a center, an edge, or a corner) of the virtual object is moved beyond the first movement threshold, does not rubberband the virtual object when the first portion is moved beyond a second, different movement threshold, and rubberbands the virtual object when a second, different portion of the virtual object (e.g., a bottom side or edge or bottom extension of the virtual object) is moved beyond the second movement threshold. For example, when a center of the virtual object is moved beyond the far-field threshold, the computer system rubberbands the virtual object independent of a position of a bottom edge of the virtual object relative to the far-field threshold, and when the bottom edge of the virtual object is moved beyond the far-field threshold, the computer system forgoes rubberbanding the virtual object, independent of where the center of the virtual object is relative to the far-field threshold. In some embodiments, when moving the virtual object beyond a first or a second movement threshold, the computer system determines a respective first portion of the virtual object or a respective second portion are respectively beyond the first or second movement threshold and in response, initiates rubberbanding of the virtual object. In some embodiments, such a respective first portion is the same as the respective second portion for different thresholds. For example, the computer system optionally initiates rubberbanding when the center and/or a bottom edge of the virtual object is moved beyond the first and/or beyond the first and second movement thresholds. Defining violation of movement thresholds based on different portions of the virtual object extending beyond such movement thresholds reduces the likelihood the computer system needlessly rubberbands the virtual object when a portion of the virtual object is already suitably presented for interaction, thereby reducing computing required to affect such rubberbanding and/or helping avoid or reduce errors in interaction with the virtual object.

In some embodiments the movement threshold is a continuous threshold that corresponds to a plurality of different movement boundaries in the three-dimensional environment (1024), such as movement threshold 928 in FIGS. 9A and 9A1. For example, the movement threshold is continuous and/or contiguous with a plurality of portions of the movement threshold (e.g., the near-field threshold, the far-field threshold, and/or the floor related threshold described with reference to step(s) 1012, step(s) 1016, and/or step(s) 1018, respectively, optionally contiguous and/or continuous with one another). In some embodiments, the plurality of portions of the movement thresholds that are contiguous and/or continuous (e.g., corresponding to the combined continuous threshold) are mathematically continuous (e.g., for one or more derivatives of the combined continuous threshold) where respective portions of the movement threshold intersect and/or come together. In some embodiments, after detecting termination of input moving the virtual object beyond a respective portion of the movement threshold that corresponds to the plurality of different movement boundaries, the computer system rubberbands the virtual object back toward the respective portion of the movement threshold in accordance with a simulated inertia associated with the respective portion of the movement threshold (e.g., the near-field threshold, the far-field threshold, and/or the floor related threshold described with reference to step(s) 1012, step(s) 1016, and/or step(s) 1018, respectively). Determining a continuous threshold including a plurality of different movement boundaries improves consistency of movement of a virtual object and rubberbanding regime, thus decreasing the likelihood that the user moves virtual objects to suboptimal positions that are intermediate and/or straddling a plurality of thresholds, thereby reducing user input required to move virtual objects away from such suboptimal positions, helping avoid unexpected or sudden changes in behavior of the virtual object, and/or helping avoid or reduce errors in interaction with the virtual object.

In some embodiments, the first input includes a first request to move the virtual object by a first magnitude (e.g., of distance) beyond the movement threshold, such as a first request moving object 906A from as shown in FIGS. 9A and 9A1 to as shown in FIG. 9B, and a second request to move the virtual object a second magnitude (e.g., of distance) after moving the first magnitude beyond the movement threshold (1026a), such as a second request moving object 906A from as shown in FIGS. 9A and 9A1 to as shown in FIG. 9B. For example, the first input includes a first movement of an input object (e.g., described with reference to step(s) 1006, such as a hand of the user and/or an input device) a first distance, followed by a second movement of the input object a second distance, optionally in a same direction as the first movement, and optionally while attention is directed to the virtual object. In some embodiments, in response to detecting movement of the virtual object past a movement threshold, the computer system offers a gradually increasing, simulated resistance to progressive movement. Accordingly, in some embodiments, the virtual object is moved a progressively lesser amount in response to detecting a same request (e.g., same movement of an input object) to move the virtual object, due to the simulated resistance. In some embodiments, the simulated resistance Increases proportionally, exponentially, and/or some other combination based on a distance the virtual object is moved beyond the movement threshold.

In some embodiments, in response to the first request, the computer system moves (1026b) the virtual object a first amount beyond the movement threshold, wherein moving the virtual object the first amount beyond the movement threshold includes moving the virtual object a respective first movement per unit of movement (e.g., per cm, per pixel, or per degree) in the first request such as a first amount of movement of object 906A from as shown in FIGS. 9A and 9A1 to as shown in FIG. 9B. For example, the virtual object is moved proportionally to or otherwise based on the first distance of the first movement of the input object. In some embodiments, the direction of the first movement is based on (e.g., is the same as) a direction of the pushing and/or throwing of the virtual object beyond the movement threshold. In some embodiments, in response to detecting the first request, the computer system moves the virtual object by a first distance (e.g., 0.0001, 0.001, 0.01, 0.1, or 1 m) per unit of movement in the first request (e.g., relative to a first magnitude of input object movement (e.g., 0.0001, 0.001, 0.01, 0.1, or 1 m)).

In some embodiments, in response to the second request, the computer system moves (1026c) the virtual object a second amount beyond the movement threshold, less than the first amount, wherein moving the virtual object the second amount beyond the movement threshold includes moving the virtual object a respective second movement per unit of movement (e.g., per cm, per pixel, or per degree) in the second request, different from (e.g., less than or greater than) than the respective first movement per unit of movement such as a second amount of movement of object 906A from as shown in FIGS. 9A and 9A1 to as shown in FIG. 9B. For example, the virtual object is optionally moved proportionally to or otherwise based on the second distance (e.g., the same as the first distance and/or the third distance). In some embodiments, the second movement of the virtual object is relatively less than the first movement of the virtual object, despite the respective movements being caused by detection of a same magnitude of displacement of the input object. In some embodiments, the direction of the second movement is based on (e.g., is the same as) a direction of the pushing and/or throwing of the virtual object beyond the movement threshold. In some embodiments, in response to detecting the second request, the computer system moves the virtual object by a different (e.g., lesser) distance (e.g., 0.00001, 0.0001, 0.001, 0.01, 0.1, or 1 m) per unit of movement in the first request. Moving the virtual object a relatively smaller distance beyond the movement threshold in response to the second request provides visual feedback that requested movement is beyond a movement threshold and reduces the distance the virtual object is moved beyond the movement threshold, thereby reducing user input erroneously moving the virtual object beyond the movement threshold.

In some embodiments, the first input includes a first request to move the virtual object a first magnitude (e.g., of distance) beyond a respective movement threshold, and a second request to move the virtual object a second magnitude (e.g., of distance) beyond the respective movement threshold, different from the first request (1028a), such as a first and a second request moving object 906A beyond floor-based threshold 940 in FIGS. 9D-9E. For example, as similarly described with reference to step(s) 1026.

In some embodiments, in accordance with a determination that the respective movement threshold is a first movement threshold (1028b) (e.g., the near-field threshold, the far-field threshold, and/or the floor related threshold described with reference to step(s) 1012, step(s) 1014, step(s) 1016, and/or step(s) 1018), such as floor-based threshold 940 in FIGS. 9D-9E in response to the first request, the computer system moves (1028c) the virtual object a first amount beyond the movement threshold, wherein moving the virtual object the first amount beyond the movement threshold includes moving the virtual object a respective first movement per unit of movement (e.g., per cm, per pixel, or per degree) in the first request, such as a first amount of movement of object 906A from FIG. 9D to FIG. 9E. For example, as described with reference to step(s) 1026, in response to the first request, the computer system moves the virtual object by a first distance per unit of input object movement.

In some embodiments, in accordance with a determination that the respective movement threshold is a first movement threshold (1028b) in response to the second request, the computer system moves (1028d) the virtual object a second amount beyond the movement threshold, less than the first amount, wherein moving the virtual object the second amount beyond the movement threshold includes moving the virtual object a respective second movement per unit of movement in the second request, different from (e.g., less than or greater than) the respective first movement per unit of movement (e.g., per cm, per pixel, or per degree) in the first request, such as a second amount of movement of object 906A from FIG. 9D to FIG. 9E. For example, as similarly described with reference to step(s) 1026. For example, as described with reference to step(s) 1026, in response to the second request, the computer system moves the virtual object by a second, different distance per unit of input object movement (e.g., a relatively smaller distance).

In some embodiments, in accordance with a determination that the respective movement threshold is a second movement threshold, different from the first movement threshold (1028e), such as far-field threshold 938 in FIG. 9C, in response to the first request, the computer system moves (1028f) the virtual object a third amount beyond the movement threshold wherein moving the virtual object the third amount beyond the movement threshold includes moving the virtual object a respective third movement per unit of movement (e.g., per cm, per pixel, or per degree) in the first request such as a first amount of movement of object 906A from FIGS. 9A and 9A1 to FIG. 9B. For example, as described with reference to step(s) 1026, in response to the first request, the computer system moves the virtual object by a first distance per unit of input object movement, different (e.g., greater or lesser) than similar movement performed in response to a similar request moving the virtual object beyond the first movement threshold described previously.

In some embodiments, in accordance with a determination that the respective movement threshold is the second movement threshold (1028e), in response to the second request, the computer system moves (1028g) the virtual object a fourth amount beyond the movement threshold, less than the third amount, wherein moving the virtual object the fourth amount beyond the movement threshold includes moving the virtual object a respective fourth movement per unit of movement (e.g., per cm, per pixel, or per degree) in the second request different from (e.g., less than or greater than) the respective third movement per unit of movement in the first request such as a second amount of movement of object 906A from FIGS. 9A and 9A1 to FIG. 9B. For example, as similarly described with reference to step(s) 1026. For example, as described with reference to step(s) 1026, in response to the second request, the computer system moves the virtual object by a second distance per unit of input object movement, different (e.g., greater or lesser) than similar movement performed in response to the first request, and/or different from a similar request moving the virtual object beyond the first movement threshold described previously. In some embodiments, a degree of simulated resistance is different for different respective movement thresholds. For example, the computer system offers a higher degree of simulated resistance when moving a virtual object and/or throwing a virtual object beyond the far-field threshold as compared to similar movement of the virtual object beyond the floor related threshold. In some embodiments, the degree of simulated resistance of a first and a second movement thresholds is similar or the same. For example, the far-field threshold and the near-field threshold offer a similar or same simulated resistance in response to a request to move the virtual object a same distance beyond the movement thresholds. Utilizing different simulated resistances for different movement thresholds provides visual feedback indicating the presence of the movement thresholds relative to the three-dimensional environment, thereby reducing erroneous movement of the virtual object and user input to correct such erroneous movement.

In some embodiments, the moving of the virtual object from the second position to the third position includes displaying an animation of the movement of the virtual object from the second position to the third position (1030), such as an animated movement of object 906a from FIG. 9B to FIG. 9C. For example, as described with reference to step(s) 1012, the computer system offers a simulated resistance similar to as if a rubber band is attached between the movement threshold and the virtual object when moving the virtual object past the movement threshold. In response to pushing and/or throwing the virtual object, the computer system optionally animates a snapping back of the virtual object toward the movement threshold, similar to as if the stretched rubber band was released. In some embodiments, the second position corresponds to where the virtual object stops moving (e.g., the termination of the first input pushing virtual object, wherein the virtual object stops moving after throwing the virtual object due to simulated inertia). In some embodiments, the acceleration and/or velocity of the virtual object snapping back from the second position toward the movement threshold is determined based on the distance the virtual object is displaced relative to the movement threshold when the virtual object stops moving. In some embodiments, the direction of animated movement from the second position toward the third position is based on (e.g., directly opposes) a same direction of movement relative to the direction of a pushing and/or throwing of the virtual object beyond the movement threshold, and includes maintaining display of the virtual object. Animating the virtual object moving from the second position to the third position provides visual feedback about the automatic movement of the virtual object, thereby providing visual feedback about the movement and/or destination of the virtual object and visually indicating where future inputs directed to the virtual object should be directed towards, and/or provides a visual indication of an allowed degree of movement within the three-dimensional environment, which helps reduce or avoid errors in interaction directed to the virtual object.

In some embodiments, displaying the animation of the movement of the virtual object from the second position to the third position includes (1032a), in accordance with a determination that a distance between the second position and the movement threshold is a first distance, displaying the animation with a first magnitude (1032b), such as a first magnitude of an animation of movement of object 906a from FIG. 9B to FIG. 9C. For example, the magnitude of the animation corresponds to a simulated distance, velocity and/or acceleration with which the virtual object travels when snapping back toward the movement threshold as described with reference to step(s)1030. In some embodiments, the virtual object accelerates and decelerates based on a simulated inertia of the virtual object, as described with reference to step(s) 1008.

In some embodiments, displaying the animation of the movement of the virtual object from the second position to the third position includes (1032a) in accordance with a determination that the distance between the second position and the movement threshold is a second distance, different from the first distance, displaying the animation with a second magnitude, different from the first magnitude (1032c) such as a second magnitude of an animation of movement of object 906a from FIG. 9B to FIG. 9C. For example, the second magnitude of the animation corresponds to a relatively greater or lesser simulated distance, velocity and/or acceleration compared to the first magnitude describe previously. In some embodiments, the greater the displacement of the virtual object past the movement threshold (e.g., when throwing or pushing the virtual object), the greater the magnitude of maximum simulated acceleration and/or velocity when the virtual object is moved back toward the movement threshold. Moving the virtual object from the second position toward the movement threshold with a magnitude of an animation based on the distance between the second position and the movement threshold provides visual feedback about the location of the movement threshold, thereby reducing the likelihood the user erroneously moves a virtual object beyond the movement threshold in the future and/or helping avoid or reduce errors in interaction directed to the virtual object.

In some embodiments, movement of the virtual object beyond the movement threshold and movement of the virtual object from the second position to the third position is in accordance with a first set of one or more simulated physical properties associated with the movement threshold (1034a), such as a first set of one or more simulated physical properties associated with movement of object 906a from FIG. 9B to FIG. 9C beyond far-field threshold 938. For example, the first one or more simulated physical properties associated with a respective movement threshold optionally is determined in accordance with a set of simulated laws of physics, and includes a first magnitude of simulated inertia, accordingly affecting the simulated resistance to throwing and/or pushing virtual objects beyond the movement thresholds and/or the acceleration and/or velocity when moving the virtual object from a position (e.g., the second position described with reference to step(s) 1002 and step(s) 1030) toward the movement threshold. Additionally or alternatively, the first one or more simulated physical properties optionally include and/or correspond to a first magnitude of simulated elasticity associated with the rubberbanding of virtual object described with reference to step(s) 1010.

In some embodiments, while displaying, via the display generation component, the virtual object at the first position, the computer system detects (1034b), via the one or more input devices, a second input, different from the first input, including a request to move the virtual object from the first position to a first updated position within the three-dimensional environment, different from the first position and the second position such as a second set of one or more simulated physical properties associated with movement of object 906a from FIG. 9B to FIG. 9C beyond floor-based threshold 940. For example, from the first position, the computer system optionally detects a second input similar to the first input, including movement of the virtual object to the first updated position. In some embodiments, the movement performed in response to the second input is opposed (e.g., due to the simulated inertia and/or simulated elasticity of rubberbanding) due to the first set of one or more simulated physical properties.

In some embodiments, in response to receiving the second input, the computer system displays (1034c), via the display generation component, the virtual object at the first updated position within the three-dimensional environment, such as the updated position of object 906a in FIG. 9B.

In some embodiments, after detecting termination of the second input (1034d), in accordance with a determination that the first updated position satisfies one or second criteria, including a criterion that is satisfied when the respective portion of the virtual object corresponds to a respective second position within the three-dimensional environment that is beyond a second movement threshold in the three-dimensional environment, such as the position of object 906 in FIG. 9E beyond floor-based threshold 940, different from the movement threshold, the computer system moves (1034e) the virtual object from the first updated position to a second updated position within the three-dimensional environment, such as the movement of object 906a from as shown in FIG. 9F to FIG. 9G wherein the second updated position is different from the first position and the first updated position, and wherein moving the virtual object to the second updated position is in accordance with the first set of one or more simulated physical properties. For example, if the respective portion is beyond the second movement threshold, the computer system rubberbands the virtual object back to an updated, second position within the three-dimensional environment based on the first set of one or more simulated physical properties. Such rubberbanding is optionally performed in accordance with the first magnitude of simulated inertia and/or the first magnitude of elasticity associated with the rubberbanding of the virtual object when moved beyond the movement threshold described with reference to step(s) 1002. Thus, moving the virtual object a same distance beyond the first movement threshold and/or the second movement threshold optionally results in a similar or same one or more characteristics of the movement toward a respective threshold (e.g., a similar or same speed and/or acceleration).

In some embodiments, after detecting termination of the second input (1034d), in accordance with a determination that the first updated position does not satisfy the one or more second criteria, the computer system maintains (1034f) display of the virtual object at the first updated position within the three-dimensional environment, such as the maintained position of object 910a in FIG. 9C. For example, the first virtual object remains at the first updated position if the virtual object is not moved beyond the second movement threshold, and/or not moved beyond any other movement threshold. Rubberbanding the virtual object in accordance with the first one or more simulated physical properties when moved beyond the first or a second threshold improves consistency of a degree of rubberbanding toward the threshold in response to a same amount of displacement from a respective threshold, thereby improving user interaction efficiency by rubberbanding virtual objects to predictable positions and reducing user inputs erroneously directed to mistaken positions not corresponding to the virtual objects due to unpredictable rubberbanding.

In some embodiments, movement of the virtual object beyond the movement threshold and movement of the virtual object from the second position to the third position is in accordance with a first set of one or more simulated physical properties associated with the movement threshold (1036a), such as a first set of one or more simulated physical properties associated with movement of object 906a from FIG. 9B to FIG. 9C. For example, as described with reference to step(s) 1034, and/or in accordance with a set of simulated laws of physics. In some embodiments, while displaying, via the display generation component, the virtual object at the first position, the computer system detects (1036b), via the one or more input devices, a second input, different from the first input, including a request to move the virtual object from the first position to a first updated position within the three-dimensional environment, different from the first position and the second position, such as an input requesting movement of object 906a as shown from FIG. 9D to FIG. 9E. For example, as described with reference to step(s) 1034.

In some embodiments, in response to receiving the second input, the computer system displays (1036c), via the display generation component, the virtual object at the first updated position within the three-dimensional environment, such as the updated position of object 906a in FIG. 9E. In some embodiments, after detecting termination of the second input (1036d), in accordance with a determination that the first updated position satisfies one or second criteria, including a criterion that is satisfied when the respective portion of the virtual object corresponds to a respective second position within the three-dimensional environment that is beyond a second movement threshold in the three-dimensional environment, different from the movement threshold, such as the position of object 906a in FIG. 9E, the computer system moves (1036e) the virtual object from the first updated position to a second updated position within the three-dimensional environment, such as the updated position of object 906a in FIG. 9F, wherein the second updated position is different from the first position and the first updated position, and wherein moving the virtual object from the first updated position to the second updated position is in accordance with a second set of one or more simulated physical properties, different from the first set of one or more simulated physical properties, such as in accordance with the simulated set of physical properties associated with floor-based threshold 940 in FIG. 9F. For example, the second set of one or more simulated physical properties are associated with a different magnitude of simulated inertia and/or a different simulated magnitude of elasticity compared to the first set of one or more simulated physical properties. For example, movement of the virtual object beyond different movement thresholds optionally is resisted to a greater degree based on a relatively greater magnitude of elasticity included in a respective set of one or more simulated physical properties (e.g., a simulated force applied to a virtual object is based on a simulated Hooke's law beyond the different movement thresholds, optionally such that the virtual object is subject to the same simulated Hooke's law using different spring constants when moved beyond different movement thresholds) and corresponding to a respective threshold. Alternatively, movement is relatively less resisted based on a relatively lesser magnitude of elasticity included in a second respective set of one or more simulated physical properties corresponding to a different, second movement threshold. Similarly, rubberbanding of the virtual object optionally is relatively quicker or slower, in accordance with the one or more simulated physical properties associated with a threshold being violated by the virtual object movement past an associated movement threshold.

In some embodiments, after detecting termination of the second input (1036d) in accordance with a determination that the first updated position does not satisfy the one or more second criteria, the computer system maintains (1036f) display of the virtual object at the first updated position within the three-dimensional environment, such as the maintained position of object 910a in FIG. 9C. For example, the first virtual object remains at the first updated position if the virtual object is not moved beyond the second movement threshold, and/or not moved beyond any other movement threshold. Utilizing different positions where the virtual object rubberbands towards when movement input is terminated while the virtual object is beyond different movement thresholds provides visual feedback indicating the presence of the movement thresholds relative to the three-dimensional environment, thereby reducing erroneous movement of the virtual object and user input to correct such erroneous movement.

In some embodiments, while displaying, via the display generation component, the virtual object at the first position, the computer system detects (1038a), via the one or more input devices, a third input, different from the first input and the second input, including a request to move the virtual object from the first position to a third updated position within the three-dimensional environment, different from the first position, the second position, and the first updated position, such as request to move object 910a as shown from FIG. 9D to FIG. 9E. For example, having one or more characteristics of the inputs described with reference to step(s) 1002 and step(s) 1034, and/or in accordance with a set of simulated laws of physics.

In some embodiments, in response to receiving the third input, the computer system displays (1038b), via the display generation component, the virtual object at the third updated position within the three-dimensional environment, such as updated position of object 910a in FIG. 9E. For example, the third updated position has one or more characteristics of the first updated position and/or the second position described respectively with reference to step(s) 1034 and step(s) 1002.

In some embodiments, after detecting termination of the third input (1038c), in accordance with a determination that the third updated position satisfies the one or more first criteria and the one or second criteria, the computer system moves (1038d) the virtual object from the third updated position to a fourth updated position within the three-dimensional environment, such as the movement of object 910a from FIG. 9D to FIG. 9E, wherein the fourth updated position is different from the first position and the second updated position, and wherein moving the virtual object from the third updated position to the fourth updated position is in accordance with the first set of one or more simulated physical properties and the second set of one or more simulated physical properties, such as a set of simulated properties associated with moving object 910a beyond floor-based threshold 940 and far-field threshold 938 from FIG. 9D to FIG. 9E. For example, the second set of one or more simulated physical properties are associated with a different magnitude of simulated inertia and/or a different simulated magnitude of elasticity (e.g., different spring constants use to apply a simulated force in accordance with a simulated Hooke's law are associated with different movement thresholds) described with reference to step(s) 1036, as related to the first set of one or more simulated physical properties. In some embodiments the third updated position correspond to movement beyond a plurality of movement thresholds, and the movement past the movement thresholds and/or rubberbanding back toward the movement thresholds are performed in some combination (e.g., a sum and/or some other combination greater or lesser than the sum) of the rubberbanding caused by individual movement thresholds. For example, the direction of the rubberbanding is optionally based on movement of the virtual object beyond a first and a second threshold, back to the third updated position within the first and second thresholds, and the simulated velocity and/or acceleration of the rubberbanding is similarly based on the distance that the virtual object respectively moves past the first and the second threshold.

In some embodiments, after detecting termination of the third input (1038c), in accordance with a determination that the third updated position does not satisfy the one or more first criteria and does not satisfy the second one or more criteria, the computer system maintains (1038e) display of the virtual object at the third updated position within the three-dimensional environment, such as the maintained position of object 910a from FIG. 9B to FIG. 9C. For example, the first virtual object remains at the third updated position if the virtual object is not moved beyond the first and the second movement thresholds, and/or not moved beyond any other movement thresholds. Rubberbanding the virtual object based on the first and the second one or more simulated physical properties improves the likelihood that the virtual object is ultimately positioned relative to the current viewpoint of the user to facilitate interaction with the virtual object and provides visual feedback that the virtual object was moved beyond multiple movement thresholds, thereby reducing the need for manual inputs to perform similar discrete movements relative to associated movement thresholds.

In some embodiments, movement of the virtual object beyond the movement threshold and movement of the virtual object from the second position to the third position is in accordance with a first set of one or more simulated physical properties associated with the movement threshold (1040a), such as a set of simulated physics associated with moving object 906a beyond far-field threshold 938 from FIG. 9B to FIG. 9C. In some embodiments, one or more movement thresholds are associated with a first set of one or more simulated physical properties (e.g., described with reference to step(s) 1034) and/or in accordance with a set of simulated laws of physics, one or more second movement thresholds are associated with a second set of one or more simulated physical properties, different form the first set of one or more simulated physical properties (e.g., described with reference to step(s) 1036), and movement of the virtual object beyond a combination of such thresholds and rubberbanding back towards such thresholds are performed in accordance with a combination of the relevant thresholds beyond the virtual object is moved.

In some embodiments, while displaying, via the display generation component, the virtual object at the first position, the computer system detects (1040b), via the one or more input devices, a second input, different from the first input, including a request to move the virtual object from the first position to a first updated position within the three-dimensional environment, different from the first position and the second position, such as input moving object 906a beyond floor-based threshold 940 from FIG. 9D to FIG. 9E. For example, as described with reference to step(s) 1034.

In some embodiments, in response to receiving the second input, the computer system displays (1040c), via the display generation component, the virtual object at the first updated position within the three-dimensional environment, such as the position of object 906a in FIG. 9E. In some embodiments, after detecting termination of the second input (1040d), in accordance with a determination that the first updated position satisfies one or second criteria, including a criterion that is satisfied when the respective portion of the virtual object corresponds to a respective second position within the three-dimensional environment that is beyond a second movement threshold in the three-dimensional environment, different from the movement threshold, the computer system moves (1040e) the virtual object from the first updated position to a second updated position within the three-dimensional environment, such as moving object 906a from as shown in FIG. 9D to as shown in FIG. 9E, wherein moving the virtual object from the first position to the first updated position and moving the virtual object from the first updated position to the second updated position is in accordance with the first set of one or more simulated physical properties, such as described previously. For example, as described with reference to step(s) 1034 and/or step(s) 1036.

In some embodiments, after detecting termination of the second input (1040d), in accordance with a determination that the first updated position does not satisfy the one or more second criteria, the computer system maintains (1040f) display of the virtual object at the first updated position within the three-dimensional environment, such as the maintained position of object 906a from FIG. 9B to FIG. 9C. For example, as described with reference to step(s) 1034, when the virtual object is not moved beyond any movement threshold.

In some embodiments, while displaying, via the display generation component, the virtual object at the first position, the computer system detects (1040g), via the one or more input devices, a third input (e.g., as similarly described above with reference to step(s) 1038), different from the first input and the second input, including a request to move the virtual object from the first position to a third updated position within the three-dimensional environment, different from the first position and the first updated position, such as input and corresponding movement of object 908a from as shown in FIG. 9G to as shown in FIG. 9H.

In some embodiments, in response to receiving the third input, the computer system displays (1040h), via the display generation component, the virtual object at the third updated position within the three-dimensional environment, such as the updated position of object 908a in FIG. 9H. For example, as described with reference to step(s) 1036.

In some embodiments, after detecting termination of the third input (1040i), in accordance with a determination that the third updated position satisfies one or more third criteria, including a criterion that is satisfied when the respective portion of the virtual object corresponds to a respective third position within the three-dimensional environment that is beyond a third movement threshold in the three-dimensional environment, different from the movement threshold and the second movement threshold, the computer system moves (1040j) the virtual object from the third updated position to a fourth updated position within the three-dimensional environment, such as the position of object 908a in FIG. 9H beyond near-field threshold 936 in FIG. 9H, wherein moving the virtual object from the first position to the third updated position and moving the virtual object from the third updated position to the fourth updated position is in accordance with a second set of one or more simulated physical properties, different from the first set of one or more simulated physical properties, such as a set of simulated one or more physical properties associated with near-field threshold 936. For example, as described with reference to step(s) 1036.

In some embodiments, after detecting termination of the third input (1040i), in accordance with a determination that the third updated position does not satisfy the one or more third criteria, the computer system maintains (1040k) display of the virtual object at the third updated position within the three-dimensional environment, such as the maintained position of object 908a in FIG. 9H if object 908a is not moved beyond near-field threshold 936. For example, as described with reference to step(s) 1036, when the virtual object is not moved beyond any movement threshold. Rubberbanding the virtual object in accordance with the first or second one or more simulated physical properties when moved beyond the respective threshold provides visual feedback about which movement threshold has been crossed.

In some embodiments, in accordance with a determination that a posture of the user of the computer system is a first pose, the movement threshold corresponds to a first location within the three-dimensional environment (1042a), for example, the pose of the user in FIG. 9H and the position of near-field threshold 936 in FIG. 9H. For example, the computer system determines that the user is crouching, sitting, standing, laying down, doubled over, leaning backward and/or forwards, is hunched, and/or assumes some combination of such postures, and optionally changes a movement threshold (e.g., a near-field movement threshold described with reference to step(s) 1012 and/or a physical floor-based threshold described with reference to step(s) 1018) based on the determined posture. For example, the computer system raises and/or lowers one or more portions of a floor-based movement threshold (e.g., relative to the floor and/or gravity of the physical environment of the user) based on whether the user's posture is standing or seated, respectively. It is understood that the computer system optionally raises the one or more portions of the floor-based movement threshold in response to detecting intermediate postures between a standing and/or seated posture (e.g., while the user is standing up), gradually raising the one or more portions of the floor-based movement threshold in response to postures that are approaching a standing posture. Conversely, in response to detecting the posture of the user lower (e.g., from a standing toward a seated posture) relative to the floor, the computer system optionally lowers the one or more portions of the floor-based movement threshold. In some embodiments, the computer system raises and/or lowers the one or more portions of the floor-based movement threshold in response to detecting a change in pose of the user while a posture of the user is maintained (e.g., raising the floor-based threshold in response to detecting the user remains in a seated posture and elevates (e.g., on an office chair), and/or lowers the floor-based threshold in response to detecting the user descend (e.g., on the office chair)).

In some embodiments, in accordance with a determination that the posture of the user is a second pose, different from the first pose, the movement threshold corresponds to a second location within the three-dimensional environment, different from the first location (1042b), such as the pose of the user and location of near-field threshold 936 in FIG. 9J. Determining a location of the movement threshold based on a determination of user posture improves the likelihood that virtual content is not prematurely or belatedly rubberbanded back within the movement threshold, thereby reducing the likelihood the virtual content is moved to locations that are suboptimal for interaction with the virtual object, and/or accounts for a relative position and/or elevation of the user, which helps reduce or avoid errors in interaction with the virtual object.

In some embodiments, the movement threshold corresponds to a first range of permissible distances relative to the three-dimensional environment in a first direction relative to the three-dimensional environment (1044a), such movement of object 906a beyond a portion of movement threshold 928 in FIG. 9B. For example, the first range of permissible distance corresponds to a range of distances from the floor of the user's physical environment, as described with reference to step(s) 21, extending upwards (e.g., opposing physical gravity) away from the floor. Additionally or alternatively, the range of distances optionally correspond to a range of distance from a back-wall of the user's physical environment extending away from (e.g., normal to) the surface of the back wall and/or towards the viewpoint of the user.

In some embodiments, while displaying, via the display generation component, the virtual object at the first position, the computer system detects (1044b), via the one or more input devices, a second input, different from the first input, including a request to move the virtual object from the first position to a first updated position within the three-dimensional environment, different from the first position and the second position (e.g., the second input has one or more characteristics of the first input discussed above with reference to step(s) 1002, but a magnitude and/or direction of movement of the second input are different from the first input), such as request to move object 906a as shown from FIG. 9H to FIG. 9I, wherein the movement of the virtual object is in a second direction relative to the three-dimensional environment, different from the first direction, and the first updated position corresponds to a position within the three-dimensional environment that corresponds to a location beyond a physical boundary within a physical environment of the user of the computer system, such as the position of object 906a in FIG. 9I and/or FIG. 9J. For example, the first updated position is optionally near or presents an apparent spatial conflict with a wall (e.g., to the left or the right of the current viewpoint) and/or with a ceiling of the physical environment. For example, the second direction is optionally different from the first direction (e.g., is leftward and/or rightward relative to the current viewpoint of the user, upward relative to the current viewpoint of the user, and/or toward a lateral wall or ceiling within a physical environment of the user).

In some embodiments, in response to receiving the second input, the computer system displays (1044c), via the display generation component, the virtual object at the first updated position within the three-dimensional environment, such as the displayed object 906a in FIG. 9J. In some embodiments, one or more portions of the three-dimensional environment are not bounded by a movement threshold; thus, movement of the virtual object to or within such one or more portions is not subject to the rubberbanding described with reference to step(s) 1010. For example, in response to detecting throwing and/or pushing of a virtual object toward a ceiling above and/or toward a wall to the left or right of the current viewpoint of the user, the computer system moves the virtual object in accordance with a set of simulated physics (e.g., lacking a simulated inertia, and/or having a relatively reduced magnitude of simulated inertia relative to movement beyond movement thresholds). Thus, the virtual object optionally continues to travel in a direction of movement of the virtual object, until a simulated inertia gradually slows down the virtual object until it reaches the first updated position, regardless of whether the virtual object has moved beyond a boundary of the physical ceiling or side wall(s) in the physical environment of the user. Moving virtual objects toward physical boundaries without rubberbanding the virtual objects allows the user to move virtual objects to more distal positions relative to their current viewpoint, thereby allowing visibility of other aspects of the three-dimensional environment, while maintaining interaction with the virtual object at the distal positions, thereby improving user-device interaction.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIGS. 11A-11F illustrate examples of a computer system facilitating dynamic scaling of a virtual object in a three-dimensional environment in accordance with some embodiments.

FIG. 11A illustrates a computer system 101 (e.g., an electronic device) displaying, via a display generation component (e.g., display generation component 120 of FIG. 1), a three-dimensional environment 1102 from a viewpoint of a user 1126 (e.g., facing the back wall of the physical environment in which computer system 101 is located, as shown in the overhead view of the three-dimensional environment 1102). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the computer system 101 is in communication with a touchpad 1130 that is configured to detect touch input (e.g., via a contact provided by a finger of a hand of the user 1126). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user).

As shown in FIG. 11A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1102. For example, three-dimensional environment 1102 includes a representation 1122a of a coffee table, which is optionally a representation of a physical coffee table in the physical environment, and a representation 1124a of a sofa, which is optionally a representation of a physical sofa in the physical environment.

In FIG. 11A, three-dimensional environment 702 also includes a virtual object 1106a (e.g., “Window 1,” corresponding to virtual object 1106b in the overhead view). In some embodiments, the virtual object 1106a is optionally a user interface of an application containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 11A, the virtual object 1106a is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 1102, such as the content described below with reference to method 1200.

In some embodiments, virtual objects are displayed in three-dimensional environment 1102 with respective sizes relative to a viewpoint of user 1126 (e.g., prior to receiving input interacting with the virtual objects, which will be described later, in three-dimensional environment 1102). As shown in FIG. 11A, the virtual object 1106a optionally has a first size in the three-dimensional environment 1102 (e.g., determined by a width and/or height (e.g., an area) of the two-dimensional front-facing surface of the virtual object 1106a that faces the viewpoint of user 1126). It should be understood that the initial size of the virtual object 1106a in FIG. 11A is merely exemplary and that other sizes are possible (e.g., based on object type, a distance to the virtual object from the viewpoint of the user 1126, and/or a dimensionality of the virtual object).

In some embodiments, the computer system 101 facilitates dynamic scaling of the virtual object 1106a within the three-dimensional environment 1102. Particularly, in some embodiments, the computer system 101 selectively changes the size of the virtual object 1106a relative to the viewpoint of the user 1126 in response to detecting user input causing movement of the virtual object 1106a within the three-dimensional environment 1102 at least partially based on a distance between the virtual object 1106a and the current viewpoint of the user 1126, as discussed below. In some embodiments, the computer system 101 selectively scales the virtual object 1106a to enable continuous interaction with (e.g., such as selection of content included in) the virtual object 1106a when the virtual object 1106a is displayed at varying distances from the viewpoint of the user 1126. In the examples of FIGS. 1IA-11F, the dynamic scaling of the virtual object 1106a per distance travelled in the three-dimensional environment 1102 is represented in plot 1120, which is discussed below.

As discussed herein, in some embodiments, the computer system 101 selectively scales the virtual object 1106a relative to the viewpoint of the user 1126 based on the distance between the virtual object 1106a and the current viewpoint of the user 1126, as indicated in the plot 1120. For example, in the plot 1120, the “Distance” metric (e.g., expressed in terms of cm, m, km, inches, feet, and/or miles) on the x-axis corresponds to a distance between the viewpoint of the user 1126 and a location of the virtual object 1106a in the three-dimensional environment 1102 for a given movement of the virtual object 1106a within the three-dimensional environment 1102. Accordingly, in the plot 1120, movement of the virtual object 1106a away from the viewpoint of the user 1126 corresponds to an increase in the Distance and movement of the virtual object 1106a toward the viewpoint corresponds to a decrease in the Distance. As shown in FIG. 11A, the Distance optionally has a minimum value 1132a (e.g., corresponding to a minimum distance (e.g., allowed/determined by the computer system 101) between the location of the virtual object 1106a and the viewpoint of the user, which is optionally a non-zero value) and a maximum value 1132b (e.g., corresponding to a maximum distance (e.g., allowed/determined by the computer system 101) between the location of the virtual object 1106a and the viewpoint of the user) for which scaling of the virtual object 1106a occurs in the three-dimensional environment 1102. For example, the minimum value 1132a of the Distance corresponds to a threshold distance (e.g., “Threshold distance,” exemplary values of which are provided below with reference to method 1200) as shown in the overhead view. In some embodiments, while the virtual object 1106b is located within the threshold distance of the viewpoint of the user 1126 (e.g., while the value of the Distance in the plot 1120 is between 0 and the minimum value 1132a), as illustrated in the overhead view, the computer system 101 forgoes scaling the virtual object 1106b in response to movement of the virtual object 1106b, as discussed in more detail below.

Additionally, in FIG. 11A, the “Scale” metric on the y-axis in the plot 1120 (e.g., expressed in terms of magnitude/amount of increase in size, such as 1×, 1.15×, 1.25×, 1.5×, 1.75×, 2×, 3×, 4×, 5×, and/or 10×) corresponds to an amount of scaling for the virtual object 1106a in the three-dimensional environment 1102 per unit distance. Accordingly, in the plot 1120, movement of the virtual object 1106a away from the viewpoint of the user 1126 corresponds to an increase in the Scale amount and movement of the virtual object 1106a toward the viewpoint corresponds to a decrease in the Scale amount. As shown in FIG. 11A, the Scale metric optionally has a minimum value 1128a (e.g., corresponding to a minimum amount of scaling (e.g., allowed/determined by the computer system 101), which is optionally a non-zero value, for the minimum distance (e.g., at 1132a) between the location of the virtual object 1106a and the viewpoint of the user) and a maximum value 1132b (e.g., corresponding to a maximum amount of scaling (e.g., allowed/determined by the computer system 101) for the maximum distance (e.g., at 1132b) between the location of the virtual object 1106a and the viewpoint of the user) for the virtual object 1106a in the three-dimensional environment 1102. For example, the minimum value 1128a of the Scale metric indicates that the computer system 101 begins scaling the virtual object 1106a in the three-dimensional environment 1102 when the distance between the virtual object 1106a and the viewpoint of the user 1126 is at least the minimum distance value 1132a (e.g., the location of the virtual object 1106b is at or outside of the threshold distance, (e.g., “Threshold distance” as shown in the overhead view)). In some embodiments, while the virtual object 1106b is located within the threshold distance of the viewpoint of the user 1126 (e.g., while the value of the Distance in the plot 1120 is between 0 and the minimum value 1132a), as illustrated in the overhead view, the computer system 101 clamps the scaling amount to be the minimum scaling value 1128a, as represented by line 1126-1 in the plot 1120 (e.g., forgoes scaling the virtual object 1106b in response to movement of the virtual object 1106b). Additionally, beyond (e.g., after) the minimum distance value 1132a, the scaling of the virtual object 1106a follows a non-linear curve, such as quadratic, logarithmic, and/or exponential, as represented by curve 1126-3. Particularly, as discussed herein, the computer system 101 forgoes scaling the virtual object 1106a when the location of the virtual object 1106a is below the minimum value 1132a from the viewpoint of the user 1126, and when the location of the virtual object 1106a is above the minimum value 1132a, the computer system 101 scales the virtual object 1106a according to the curve 1126-3 such that the scaling of the virtual object 1106a catches up (e.g., corresponds) to a linear scaling, as represented by line 1126-2. Additional details regarding dynamic scaling of the virtual object 1106a in response to movement of the virtual object 1106a are provided below with reference to method 1200.

In FIG. 11A, the computer system 101 detects an input provided by hand 1103a corresponding to a request to move the virtual object 1106a within the three-dimensional environment 1102. For example, as shown in FIG. 11A, the computer system 101 detects hand 1103a provide an air gesture, such as an air pinch and drag gesture in which an index finger and thumb of the hand of the user come together to make contact, while a gaze 1121 of the user 1126 is directed to the virtual object 1106a, followed by movement of the hand 1103a forward (e.g., away from a body of the user 1126) while maintaining the pinch hand shape. In some embodiments, the movement of the virtual object 1106a corresponds to movement of the virtual object 1106a away from the viewpoint of the user 1126 in the three-dimensional environment 1102.

In some embodiments, as shown in FIG. 11B, in response to detecting an initiation of the movement of the virtual object 1106a (e.g., a selection of the virtual object 1106a prior to the movement of the virtual object 1106a), the computer system 101 generates non-visual feedback 1150a indicating that the virtual object 1106a has been selected for movement in the three-dimensional environment 1102. For example, the computer system 101 outputs the non-visual feedback 1150a in response to detecting the hand 1103a provide the air pinch gesture discussed above and/or initially contact the touchpad 1130, and optionally prior to detecting the movement of the hand 1103a in FIG. 11A. In some embodiments, the non-visual feedback 1150a includes audio output (e.g., a ring, chime, tune, or other sound), tactile feedback and/or haptic feedback (e.g., a sequence of one or more vibrations of the computer system 101) indicating that movement of the hand 1103a of the user 1126 in FIG. 11A will cause the computer system to move the virtual object 1106a accordingly in the three-dimensional environment 1102, as further discussed below.

Additionally in some embodiments, as shown in FIG. 11B, in response to detecting the movement input provided by the hand 1103a in FIG. 11A, the computer system 101 moves the virtual object 1106a in the three-dimensional environment 1102 in accordance with the movement of the hand 1103a. For example, as shown in FIG. 11B, the computer system 101 moves the virtual object 1106a forward in the three-dimensional environment 1102 and away from the viewpoint of the user 1126. In some embodiments, when the computer system 101 moves the virtual object 1106a away from the viewpoint of the user 1126 in the three-dimensional environment 1102, as shown in the overhead view, a location of the virtual object 1106b relative to the viewpoint of the user 1126 remains within (e.g., at) the threshold distance from the viewpoint in the three-dimensional environment 1102. Accordingly, as indicated in the plot 1120 in FIG. 11B, the computer system 101 forgoes scaling the virtual object 1106a in the three-dimensional environment 1102 when the virtual object 1106a is moved away from the viewpoint of the user. For example, in the plot 1120, marker 1134a indicates that an amount that the virtual object 1106a is scaled in the three-dimensional environment 1102 for the distance travelled (e.g., moved) in the three-dimensional environment 1102 is fixed at the minimum scaling value 1128a. Accordingly, the virtual object 1106a optionally remains displayed at the same size (e.g., the first size discussed above) in the three-dimensional environment 1102 as before the input is detected, which optionally causes the virtual object 1106a to appear smaller relative to the viewpoint of the user 1126 (e.g., because the virtual object 1106a is located farther away from the viewpoint than in FIG. 11A), as shown in FIG. 11B.

FIG. 11A1 illustrates similar and/or the same concepts as those shown in FIG. 11A (with many of the same reference numbers). It is understood that unless indicated below, elements shown in FIG. 11A1 that have the same reference numbers as elements shown in FIGS. 11A-11F have one or more or all of the same characteristics. FIG. 11A1 includes computer system 101, which includes (or is the same as) display generation component 120. In some embodiments, computer system 101 and display generation component 120 have one or more of the characteristics of computer system 101 shown in FIGS. 11A and 11A-11F and display generation component 120 shown in FIGS. 1 and 3, respectively, and in some embodiments, computer system 101 and display generation component 120 shown in FIGS. 11A-11F have one or more of the characteristics of computer system 101 and display generation component 120 shown in FIG. 11A1.

In FIG. 11A1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 11A-11F.

In FIG. 11A1, display generation component 120 is illustrated as displaying content that optionally corresponds to the content that is described as being displayed and/or visible via display generation component 120 with reference to FIGS. 11A-11F. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 11A1.

Display generation component 120 has a field of view (e.g., a field of view captured by external image sensors 314b and 314c and/or visible to the user via display generation component 120, indicated by dashed lines in the overhead view) that corresponds to the content shown in FIG. 11A1. Because display generation component 120 is optionally a head-mounted device, the field of view of display generation component 120 is optionally the same as or similar to the field of view of the user.

In FIG. 11A1, the user is depicted as performing an air pinch gesture (e.g., with hand 1103A) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 11A-11F.

In some embodiments, computer system 101 responds to user inputs as described with reference to FIGS. 11A-11F.

In the example of FIG. 11A1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 11A-11F and/or described with reference to the corresponding method(s) are optionally implemented on computer system 101 and display generation unit 120 in a manner similar or analogous to that shown in FIG. 11A1.

In FIG. 11B, the computer system 101 detects an input provided by hand 1103b corresponding to a request to move the virtual object 1106a within the three-dimensional environment 1102. For example, as shown in FIG. 11A, the computer system 101 detects hand 1103b provide an air gesture, such as an air pinch and drag gesture, while the gaze 1121 of the user 1126 is directed to the virtual object 1106a, followed by movement of the hand 1103b forward (e.g., away from a body of the user 1126) while maintaining the pinch hand shape. In some embodiments, the movement of the virtual object 1106a corresponds to movement of the virtual object 1106a further away from the viewpoint of the user 1126 in the three-dimensional environment 1102.

In some embodiments, as shown in FIG. 11C, in response to detecting the input provided by the hand 1103b in FIG. 11B, the computer system 101 moves the virtual object 1106a in the three-dimensional environment 1102 in accordance with the movement of the hand 1103b. For example, as shown in FIG. 11C, the computer system 101 moves the virtual object 1106b further forward in the three-dimensional environment 1102 and away from the viewpoint of the user 1126, as shown in the overhead view. Further, in some embodiments, as shown in the overhead view in FIG. 11C, the movement of the virtual object 1106b causes the location of the virtual object 1106b to go beyond the threshold distance of the viewpoint of the user 1126 (e.g., “Threshold distance” in the overhead view). In some embodiments, as discussed below, even though the distance travelled (e.g., moved) is beyond the minimum distance value 1132a in the plot 1120, marker 1134b indicates that the amount that the virtual object 1106a is scaled in the three-dimensional environment 1102 for the distance travelled in the three-dimensional environment 1102 remains fixed at the minimum scaling value 1128a. Particularly, as discussed below, the computer system 101 optionally delays scaling the virtual object 1106a by an amount that is based on the distance travelled after the virtual object 1106a is moved beyond the threshold distance for which there is no scaling. Accordingly, the virtual object 1106a optionally remains displayed at the same size (e.g., the first size discussed above) in the three-dimensional environment 1102 as before the input is detected, which optionally causes the virtual object 1106a to appear smaller relative to the viewpoint of the user 1126 (e.g., because the virtual object 1106a is located farther away from the viewpoint than in FIG. 11B), as shown in FIG. 11C.

In some embodiments, the computer system 101 employs a time-based delay for delaying the scaling of the virtual object 1106a by an amount that is based on the distance that the virtual object 1106a has been moved in the three-dimensional environment 1102. For example, as shown in FIG. 11C, the computer system 101 delays scaling the virtual object 1106a in the three-dimensional environment 1102 for a threshold amount of time 1114, such as 0.25, 0.5, 1, 1.5, 2, 3, 4, 5, 10, 15, 30, 45, or 60 seconds, indicated in time bar 1107. In some embodiments, the threshold amount of time 1114 corresponds to a predetermined (e.g., fixed) time delay. For example, the threshold amount of time 1114 is measured from a point in time in which the virtual object 1106a is moved beyond the threshold distance (e.g., “Threshold distance” in the overhead view) relative to the viewpoint of the user 1126 (e.g., corresponding to the minimum distance value 1132a in the plot 1120). Alternatively, in some embodiments, the threshold amount of time 1114 corresponds to an overall (e.g., total) duration of the movement of the virtual object 1106a in the three-dimensional environment 1102 (e.g., for which the movement is continuous (e.g., in which contact is continuously detected on the touchpad 1130)). For example, the threshold amount of time 1114 is measured from a point in time in which the virtual object 1106a begins to be moved within the three-dimensional environment 1102 (e.g., in response to user input), such as from FIGS. 11A-11B. In some embodiments, the threshold amount of time elapses irrespective of further movement of the virtual object 1106a within the three-dimensional environment 1102 (e.g., excluding movement of the virtual object 1106a back to within the threshold distance (e.g., “Threshold distance” in the overhead view)). As shown in FIG. 11C, the time bar 1107 has optionally not reached the threshold amount of time 1114, so the computer system 101 continues to forgo scaling the virtual object 1106a by an amount that is based on the distance that the virtual object 1106a has been moved in the three-dimensional environment 1102.

In some embodiments, the computer system 101 employs a distance-based delay for delaying the scaling of the virtual object 1106a by an amount that is based on the distance that the virtual object 1106a has been moved in the three-dimensional environment 1102. For example, as shown in the overhead view in FIG. 11C, the computer system 101 forgoes scaling the virtual object 1106a until the virtual object 1106a has been moved more than a delay distance (e.g., “Delay distance”) in the three-dimensional environment 1102, such as 1, 2, 5, 8, 10, 15, 25, 30, 40, or 50 m. In some embodiments, the Delay distance corresponds to an overall (e.g., a net total) distance that the virtual object 1106a has been moved in the three-dimensional environment 1102, optionally irrespective of a direction in which the virtual object 1106a has been moved relative to the viewpoint of the user 1126. As shown in FIG. 11C, the location of the virtual object 1106a corresponds to a distance travelled that has optionally just reached/crossed the Delay distance, so the computer system 101 continues to forgo scaling the virtual object 1106a by an amount that is based on the distance that the virtual object 1106a has been moved in the three-dimensional environment 1102.

In some embodiments, the computer system 101 employs a velocity-based (e.g., speed-based) delay for delaying the scaling of the virtual object 1106a by an amount that is based on the distance that the virtual object 1106a has been moved in the three-dimensional environment 1102. For example, the computer system 101 delays scaling the virtual object 1106a until a velocity of movement of the virtual object 1106a, represented by curve 1142 in plot 1140, falls below a threshold velocity of movement, represented by line 1144, such as below 0.01, 0.05, 0.1, 0.25, 0.5, 1, 2, 3, 5, or 8 m/s. As shown in the plot 1120 of FIG. 11C, the velocity of the movement of the virtual object 1106a (e.g., which is based on the movement of the virtual object 1106a starting from FIG. 11A), represented by the curve 1142, is greater than the threshold velocity of movement, represented by the line 1144. In other words, at the instant in time represented in FIG. 11C, the movement of the virtual object 1106a has not slowed to below the threshold velocity. In some embodiments, the threshold velocity of movement corresponds to zero velocity. For example, the velocity-based delay for delaying the scaling of the virtual object 1106a is maintained while the virtual object 1106a continues to move (e.g., is moved with a velocity that is greater than zero velocity). Accordingly, as similarly discussed above, the computer system 101 continues to forgo scaling the virtual object 1106a by an amount that is based on the distance that the virtual object 1106a has been moved in the three-dimensional environment 1102.

In FIG. 11C, the computer system 101 detects termination (e.g., a release) of the input moving the virtual object 1106a in the three-dimensional environment 1102 provided by the hand 1103c. For example, the computer system 101 detects a release of the pinch hand shape by the hand 1103c (e.g., such that the index finger and thumb of the hand are no longer touching). In some embodiments, the computer system 101 detects the hand 1103c move into a relaxed state. For example, the computer system 101 detects a release of a contact of the hand 1103c on the touchpad 1130.

In some embodiments, as shown in FIG. 11D, in response to detecting the termination of the input causing movement of the virtual object 1106a (e.g., a deselection of the virtual object 1106a after the movement of the virtual object 1106a), the computer system 101 generates non-visual feedback 1150b indicating that the virtual object 1106a is no longer selected for movement in the three-dimensional environment 1102. For example, the computer system 101 outputs the non-visual feedback 1150b in response to detecting the hand 1103a release the air pinch gesture discussed above (e.g., such that the index finger and thumb of the hand are no longer touching), and optionally after detecting the movement of the hand 1103c in FIG. 11C. In some embodiments, the non-visual feedback 1150b includes audio output (e.g., a ring, chime, tune, or other sound), tactile feedback and/or haptic feedback (e.g., a sequence of one or more vibrations of the computer system 101 or a controller for interacting with the computer system 101 such as a handheld controller, keyboard, or trackpad) indicating that input provided by the hand 1103c in FIG. 11C has been terminated. In some embodiments, the non-visual feedback 1150b outputted by the computer system 101 in FIG. 11D is different form the non-visual feedback 1150a outputted by the computer system 101 in FIG. 11B. For example, one or more characteristics of the non-visual feedback 1150b (e.g., duration, tone, frequency, waveform, and/or volume) are different from one or more characteristics of the non-visual feedback 1150a. As another example, a type of the non-visual feedback 1150a is different of the type of the non-visual feedback 1150b. For example, the non-visual feedback 1150a corresponds to audio feedback and the non-visual feedback 1150b corresponds to haptic feedback.

Additionally, in some embodiments, as shown in FIG. 11D, the computer system 101 scales the virtual object 1106a by an amount that is based on the location of the virtual object 1106a relative to the viewpoint of the user 1126 (e.g., based on the distance between the location of the virtual object 1106a and the viewpoint of the user 1126 after the movement of the virtual object 1106a in FIG. 11C). For example, as discussed below, the computer system 101 concludes application of the scaling delays described above with reference to FIG. 11C. As shown in the overhead view of FIG. 11D, scaling the virtual object 1106b includes changing the size of the virtual object 1106b based on the distance between the location of the virtual object 1106b and the viewpoint of the user 1126. As shown in the plot 1120 of FIG. 11D, the computer system 101 optionally scales the virtual object 1106a according to the scale curve 1126-3, as indicated by the marker 1134c. Particularly, as shown in FIG. 11D, the computer system 101 optionally increases the size of the virtual object 1106a in the three-dimensional environment 1102 after the scaling delay, which causes the virtual object 1106a to appear larger in the three-dimensional environment 1102 relative to the viewpoint of the user 1126 (e.g., larger than the size of the virtual object 1106a in FIG. 11C).

In some embodiments, the computer system 101 ceases application of the time-based delay discussed above for delaying scaling the virtual object 1106a in the three-dimensional environment 1102 when the threshold amount of time discussed above elapses. For example, as shown in FIG. 11D, the computer system 101 determines that the threshold amount of time 1114 has elapsed since detecting movement of the virtual object 1106a beyond the threshold distance (e.g., “Threshold distance” in the overhead view) (e.g., corresponding to the minimum distance value 1132a in the plot 1120). Alternatively, in FIG. 11D, the computer system 101 determines that the threshold amount of time 1114 has elapsed since detecting the initial movement of the virtual object 1106a in FIGS. 11A-11B. Accordingly, as shown in FIG. 11D, the computer system 101 optionally scales the virtual object 1106a to catch up the scaling of the virtual object 1106a to the predetermined scaling factor (e.g., amount) based on the location of the virtual object 1106a in the three-dimensional environment 1102 (e.g., based on the scaling curve 1126-3).

In some embodiments, the computer system 101 ceases application of the distance-based delay discussed above for delaying scaling the virtual object 1106a in the three-dimensional environment 1102 when the virtual object 1106a is moved more than the Delay distance discussed above (e.g., indicated in the overhead view in FIG. 11D). For example, as shown in FIG. 11D, the computer system 101 determines that a total distance that the virtual object 1106a is moved in the three-dimensional environment 1102 since detecting the initial movement of the virtual object 1106a in FIGS. 11A-11B is greater than the Delay distance indicated in the overhead view of FIG. 11D. Accordingly, as shown in FIG. 11D, the computer system 101 optionally scales the virtual object 1106a to catch up the scaling of the virtual object 1106a to the predetermined scaling factor (e.g., amount) based on the location of the virtual object 1106a in the three-dimensional environment 1102 (e.g., based on the scaling curve 1126-3).

In some embodiments, the computer system 101 ceases application of the velocity-based delay discussed above for delaying the scaling of the virtual object 1106a in the three-dimensional environment 1102 when movement of the virtual object 1106a slows to below the threshold velocity of movement discussed above (e.g., represented by line 1144 in the plot 1140). For example, as shown in FIG. 11D, the computer system 101 determines that movement of the virtual object 1106a, represented by the curve 1142 in the plot 1140, is less than the threshold velocity of movement represented by the line 1144 (e.g., portion 1143 of the curve 1142). Alternatively, in response to detecting the termination of the input for moving the virtual object 1106a provided by the hand 1103c in FIG. 11C, the computer system 101 optionally determines that the velocity of the movement of the virtual object 1106a slows to zero velocity. Accordingly, as shown in FIG. 11D, the computer system 101 optionally scales the virtual object 1106a to catch up the scaling of the virtual object 1106a to the predetermined scaling factor (e.g., amount) based on the location of the virtual object 1106a in the three-dimensional environment 1102 (e.g., based on the scaling curve 1126-3).

In FIG. 11D, after scaling the virtual object 1106a in the three-dimensional environment 1102 relative to the viewpoint of the user 1126, the computer system 101 detects an input provided by hand 1103d corresponding to a request to move the virtual object 1106a within the three-dimensional environment 1102. For example, as shown in FIG. 11D, the computer system 101 detects the hand 1103d provide an air pinch gesture, as similarly discussed above, while the gaze 1121 of the user is directed to the virtual object 1106a, followed by movement of the hand 1103d toward the body of the user 1126. In some embodiments, the input corresponds to movement of the virtual object 1106a toward the viewpoint of the user 1126.

In some embodiments, as shown in FIG. 11E, in response to detecting the input provided by the hand 1103e, the computer system 101 moves the virtual object 1106a in the three-dimensional environment 1102 in accordance with the input. For example, as shown in the overhead view in FIG. 11D, the computer system 101 moves the virtual object 1106b backward in the three-dimensional environment 1102 and toward the viewpoint of the user 1126. Additionally, as shown in FIG. 11D, when the computer system 101 moves the virtual object 1106a within the three-dimensional environment 1102, the computer system 101 optionally scales the virtual object 1106a relative to the viewpoint of the user 1126 based on the distance that the virtual object 1106a is moved in accordance with the input. For example, as shown in the overhead view in FIG. 11E, the computer system 101 decreases the size of the virtual object 1106b when the virtual object 1106b is moved closer to the viewpoint of the user 1126. Accordingly, in some embodiments, as shown in FIG. 11E, even though the virtual object 1106a is located closer to the viewpoint of the user 1126 after the movement of the virtual object 1106a in the three-dimensional environment 1102, because the computer system 101 scales the virtual object 1106a, the virtual object 1106a appears to be the same size in the three-dimensional environment 1102 relative to the viewpoint of the user 1126 (e.g., the same size as in FIG. 11D).

In FIG. 11E, the computer system 101 detects an input provided by hand 1103b corresponding to a request to move the virtual object 1106a within the three-dimensional environment 1102. For example, as shown in FIG. 11E, the computer system 101 detects hand 1103e provide an air gesture, such as an air pinch and drag gesture, while the gaze 1121 of the user 1126 is directed to the virtual object 1106a, followed by movement of the hand 1103b backward (e.g., toward the body of the user 1126) while maintaining the pinch hand shape. In some embodiments, the movement of the virtual object 1106a corresponds to movement of the virtual object 1106a further toward the viewpoint of the user 1126 in the three-dimensional environment 1102.

In some embodiments, as shown in FIG. 11F, in response to detecting the input provided by the hand 1103e in FIG. 11F, the computer system 101 moves the virtual object 1106a in the three-dimensional environment 1102 in accordance with the movement of the hand 1103e. For example, as shown in FIG. 11F, the computer system 101 moves the virtual object 1106a further backward in the three-dimensional environment 1102 and toward the viewpoint of the user 1126. In some embodiments, when the computer system 101 moves the virtual object 1106a toward the viewpoint of the user 1126 in the three-dimensional environment 1102, as shown in the overhead view, a location of the virtual object 1106b relative to the viewpoint of the user 1126 moves to within the threshold distance (e.g., “Threshold distance” in the overhead view) from the viewpoint in the three-dimensional environment 1102. Accordingly, as indicated in the plot 1120 in FIG. 11F, the computer system 101 ceases scaling the virtual object 1106a in the three-dimensional environment 1102 when the virtual object 1106a is moved further toward the viewpoint of the user. For example, in the plot 1120, marker 1134e indicates that an amount that the virtual object 1106a is scaled in the three-dimensional environment 1102 for the distance travelled (e.g., moved) in the three-dimensional environment 1102 is fixed at the minimum scaling value 1128a discussed previously above. Accordingly, the size of the virtual object 1106a optionally remains unchanged after crossing the threshold distance (e.g., “Threshold distance” in the overhead view) in the three-dimensional environment 1102, which causes the virtual object 1106a to appear larger relative to the viewpoint of the user 1126 (e.g., because the virtual object 1106a is located closer to the viewpoint than in FIG. 11E), as shown in FIG. 11F.

In some embodiments, when moving the virtual object 1106a further toward the viewpoint of the user 1126 in the three-dimensional environment 1102 to within the threshold distance of the viewpoint of the user 1126 (e.g., “Threshold distance” in the overhead view), the computer system 101 forgoes applying a scaling delay (e.g., described previously above) to the virtual object 1106a in the three-dimensional environment 1102. For example, as shown in the plot 1120 in FIG. 11F, when the virtual object 1106a is moved further toward the viewpoint of the user 1126 (e.g., when the distance between the location of the virtual object 1106a and the viewpoint of the user 1126 decreases along the x axis), the computer system 101 continues to scale the virtual object 1106a according to the scaling curve 1126-3, as indicated by marker 1134d, until the scaling flatlines according to the line 1126-1. Thus, in some embodiments, as described above, when the virtual object 1106b is moved from within the threshold distance of the viewpoint of the user 1126 (e.g., “Threshold distance” in the overhead view) to outside of the threshold distance (e.g., in response to movement away from the viewpoint), the computer system 101 transitions from applying no scaling to applying a scaling factor using a scaling delay (e.g., one of the delays discussed above), and when the virtual object 1106b is moved from outside of the threshold distance to within the threshold distance of the viewpoint of the user 1126, (e.g., “Threshold distance” as shown in the overhead view) in FIG. 11F, the computer system 101 ceases scaling the virtual object 1106a in the three-dimensional environment 1102 without using a scaling delay (e.g., or using a smaller scaling delay).

FIGS. 12A-12F is a flowchart illustrating a method 1200 of facilitating dynamic scaling of a virtual object in a three-dimensional environment in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed at a computer system (e.g., 101) in communication with a display generation component (e.g., 120) and one or more input devices (e.g., 314), such as touchpad 1130 in FIGS. 11A and 11A1. For example, the computer system is or includes a mobile device (e.g., a tablet, a smartphone, a media player, or a wearable device), or a computer. In some embodiments, the computer system has one or more characteristics of the computer system in methods 800 and/or 1000. In some embodiments, the display generation component has one or more characteristics of the display generation component in methods 800 and/or 1000. In some embodiments, the one or more input devices have one or more characteristics of the one or more input devices in methods 800 and/or 1000.

In some embodiments, while displaying, via the display generation component, an object (e.g., a virtual object) in an environment (e.g., a three-dimensional environment), such as virtual object 1106a in three-dimensional environment 1102 as shown in FIGS. 11A and 11A1, the computer system detects (1202a), via the one or more input devices, an input corresponding to a request to move the object in a first direction within the environment relative to a viewpoint of a user of the computer system, such as input provided by hand 1103a as shown in FIGS. 11A and 11A1. For example, the three-dimensional environment is generated, displayed, or otherwise caused to be viewable by the computer system (e.g., an extended reality (XR) environment such as a virtual reality (VR) environment, a mixed reality (MR) environment, and/or an augmented reality (AR) environment). In some embodiments, the environment has one or more characteristics of the environments in methods 800 and/or 1000. In some embodiments, the object is generated by the computer system and/or is or includes content. In some embodiments, the object has one or more characteristics of the objects in methods 800 and/or 1000. In some embodiments, detecting the first input includes detecting an air pinch gesture performed by a hand of the user of the computer system-such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the computer system while attention (e.g., including gaze) of the user is directed toward the virtual object. In some embodiments, after detecting the air pinch gesture, the computer system detects movement of a portion of the user (e.g., the hand of the user while maintaining a pinch hand shape). In some embodiments, the movement of the hand of the user is away from a body of the user (e.g., in a forward direction) in space that corresponds to movement of the object away from a viewpoint of the user in the three-dimensional environment. Alternatively, in some embodiments, the movement of the hand of the user is toward the body of the user (e.g., in a backward direction) in space that corresponds to movement of the object toward the viewpoint of the user in the three-dimensional environment. In some embodiments, the computer system detects the input via a hardware input device (e.g., a controller operable with six degrees of freedom of movement, or a touchpad or mouse) in communication with the computer system. In some such embodiments, after detecting the selection input, the computer system detects movement via the hardware input device, such as movement of the controller in space, movement of a mouse across a surface (e.g., a tabletop), or movement of a finger of the hand of the user across the touchpad. In some embodiments, the input has one or more characteristics of the inputs in methods 800 and/or 1000.

In some embodiments, in response to detecting the input, the computer system moves (1202b), via the display generation component, the object in the first direction in the environment relative to the viewpoint of the user in accordance with the input, such as movement of the virtual object 1106a in the three-dimensional environment 1102 as shown in FIG. 11B. For example, the computer system moves the virtual object away from the viewpoint of the user in the three-dimensional environment in accordance with the movement of the hand of the user and/or the movement of the hardware input device. In some embodiments, the computer system moves the object by the first distance in the three-dimensional environment in accordance with a first portion of the input and moves the object by the second distance, after the first distance, in accordance with a second portion of the input, after the first portion of the input. For example, the computer system moves the virtual object in the first direction (e.g., away from the viewpoint of the user) by the first distance in the three-dimensional environment based on (e.g., equivalently or proportionally to) a first magnitude (e.g., of speed and/or distance) of movement of the hand of the user in space and then by the second distance in the first direction in the three-dimensional environment based on a second magnitude (e.g., of speed and/or distance) of movement of the hand of the user in space. Accordingly, if the computer system detects that the movement of the virtual object ceases in the three-dimensional environment, the computer system optionally ceases scaling the virtual object in the three-dimensional environment, as described in more detail later. In some embodiments, the first distance is equal to the second distance. In some embodiments, the first distance is different from the second distance (e.g., because the first magnitude of movement of the hand of the user is different from the second magnitude of the movement of the hand of the user). For example, the speed and/or distance at which the hand of the user moves in space during the second portion of the input (e.g., corresponding to the request to move the object the second distance) is greater than the speed and/or distance at which the hand of the user moves in space during the first portion of the input (e.g., corresponding to the request to move the object the second distance), which causes the computer system to move the object different distance in response to detecting the input.

In some embodiments, during a first portion of the movement, the computer system scales (1202c) the object (e.g., changing a size of the virtual object in the three-dimensional environment) by a first amount, such as scaling the virtual object 1106a according to scaling curve 1126-1 in plot 1120 as shown in FIG. 11B, wherein the first portion of the movement includes moving the object by a first distance (e.g., 1, 5, 10, 15, 20, 25, 35, 40, 45, 50, or 60 cm) in the environment, such as a distance the virtual object 1106b is moved in the three-dimensional environment 1102 as shown in the overhead view in FIG. 11B. For example, while the computer system moves the virtual object away from the viewpoint of the user by the first distance in the three-dimensional environment, the computer system scales the virtual object relative to the three-dimensional environment. In some embodiments, scaling the object in the three-dimensional environment includes increasing or decreasing a size of the object in the three-dimensional environment. In some embodiments, scaling the object in the three-dimensional environment includes scaling content included in the object in the three-dimensional environment. For example, as the computer system moves the virtual object in the first direction by the first distance, the computer system increases a size of one or more selectable options, one or more text-entry fields, one or more images, text, and/or other user interface elements/content included in the virtual object in the three-dimensional environment. In some embodiments, the first amount of scaling is based on the first distance (e.g., the computer system scales the virtual object per unit length (e.g., per cm, per 2 cm, per 5 cm, or per 10 cm) of distance from the viewpoint of the user). For example, the computer system increases the size of the virtual object while the virtual object is moved the first distance (e.g., further away from the viewpoint of the user) in the three-dimensional environment according to a linear relationship. In some embodiments, the computer forgoes scaling the object (e.g., by any amount, including the first amount) in the three-dimensional environment during the first portion of the movement.

In some embodiments, during a second portion of the movement (e.g., after or before the first portion of the movement discussed above), the computer system scales (1202d) the object by a second amount, greater than the first amount, such as the scaling of the virtual object 1106a according to scaling curve 1126-3 in the plot 1120 as shown in FIG. 11D. In some embodiments, the second portion of the movement includes moving the object by a second distance in the environment (1202e) (e.g., where the second distance is less than or equal to the first distance above), such as the movement of the virtual object 1106b as shown in the overhead view of the three-dimensional environment 1102 as shown in FIG. 11C, and an amount of scaling per distance moved during the first portion of the movement (e.g., the first amount of scaling relative to, as compared to, or as a ratio of, the first distance) is less than an amount of scaling per distance moved during the second portion of the movement (1202f) (e.g., the second amount of scaling relative to, as compared to, or as a ratio of, the second distance). In some embodiments, while the computer system moves the virtual object away from the viewpoint of the user by the second distance, after moving the virtual object by the first distance, in the first direction in the three-dimensional environment, the computer system continues scaling the virtual object relative to the three-dimensional environment, but scales the virtual object by a greater amount than during the movement by the first distance, per unit length or distance from the viewpoint of the user. For example, while moving the virtual object the second distance, the computer system increases the size of the virtual object more per unit length than the scaling of the virtual object during the movement of the virtual object by the first distance relative to the viewpoint of the user. In some embodiments, if the distance that the object is moved during the first portion of the movement is the same as the distance that the object is moved during the second portion of the movement, the first amount of scaling is smaller than the second amount of scaling. In some embodiments, the computer system transitions to scaling the object by the second amount in the three-dimensional environment after the object has been moved the first distance using a distance-based delay. For example, the second distance is separated from the first distance relative to the viewpoint of the user by a predetermined distance clamp (e.g., a threshold distance of 30, 35, 40, 45, 55, 60, 65, 70, 75, or 80 cm) that follows the first distance during which the computer system forgoes scaling the object in the three-dimensional environment (e.g., the computer system does not scale the object in the three-dimensional environment until the virtual object has been moved the threshold distance after the first distance). In some embodiments, the computer system transitions to scaling the object by the second amount in the three-dimensional environment after the virtual object has been moved the first distance using a time-based delay. For example, the computer system employs a predetermined delay (e.g., 0.01, 0.05, 0.1, 0.15, 0.25, 0.5, 0.75, 1, 1.5, or 2 seconds) between scaling the virtual object by the first amount and scaling the virtual object by the second amount in the three-dimensional environment. In some embodiments, employing a delay (e.g., distance-based delay or time-based delay) between scaling the virtual object by the first amount and the second amount while the virtual object is being moved in the three-dimensional environment enables user interface elements, such as selectable options, buttons, text, and/or images, to remain targetable based on the attention (e.g., including gaze) of the user and/or selectable (e.g., via hand-based user input, such as an air pinch gesture). In some embodiments, the computer system ceases scaling the object in the three-dimensional environment when the movement of the virtual object reaches a predefined distal limit (e.g., 10, 50, 100, 300, 350, 400, 450, 475, 500, 525, 550, 600, or 700 cm) from the viewpoint of the user. For example, if the virtual object is moved beyond the predefined distal limit in the three-dimensional environment, the computer system moves the virtual object without changing the size of the virtual object. In some embodiments, as described in more detail below, the computer system imposes a predefined near end limit (e.g., 1, 5, 8, 10, 12, 15, 20, 30, 40, 50, 75, 90, or 100 cm) relative to the viewpoint of the user for scaling the object in the three-dimensional environment (e.g., for movement of the virtual object toward the viewpoint of the user), such that when the virtual object moves closer than that near end limit to the viewpoint of the user, the computer system ceases to scale the virtual object based on changes in distance between the virtual object and the viewpoint of the user. Scaling an object by a variable amount based on a distance that the object is moved in a three-dimensional environment relative to a viewpoint of the user in response to detecting movement of the object away from or towards the viewpoint of the user enables the object to automatically remain visibly displayed in the user's field of view during the movement of the object, which allows the user to continue to interact with the object and/or content included in the object, thereby improving user-device interaction.

In some embodiments, in response to detecting the input, scaling the object by the second amount includes (1204a), in accordance with a determination that moving the object in the first direction corresponds to moving the object away from the viewpoint of the user, scaling the object by a third amount (1204b), such as the scaling of the virtual object 1106a according to the scaling curve 1126-1 as shown in the plot 1120 in FIG. 11B. In some embodiments, in accordance with a determination that moving the object in the first direction corresponds to moving the object toward the viewpoint of the user, the computer system scales the object by a fourth amount, different from the third amount (1204c) (e.g., greater than the third amount), such as the scaling of the virtual object 1106a according to the scaling curve 1126-3 in the plot 1120 as shown in FIG. 11E. For example, the computer system scales the object by different amounts relative to, as compared to, or as a ratio of, the distance that the object is moved based on whether the object is moved away from the viewpoint of the user or toward the viewpoint of the user in the three-dimensional environment. In some embodiments, during the second portion of the movement discussed above with reference to step(s) 1202, if the object is moved the second distance away from the viewpoint of the user, the computer system scales the object by the third amount, which is greater than the first amount. In some embodiments, during the second portion of the movement, if the object is moved the second distance toward the viewpoint of the user, the computer system scales the object by the fourth amount, which is greater than the first amount and the third amount. Scaling an object by a variable amount based on a distance that the object is moved and a direction of movement of the object in a three-dimensional environment relative to a viewpoint of the user in response to detecting movement of the object away from or towards the viewpoint of the user enables content associated with the object to continue to remain visibly displayed in the user's field of view during the movement of the object, which allows the user to continue to interact with the content, and/or accounts for changes in eye focus as the object is moved away form or toward the viewpoint of the user, which helps reduce eye strain for the user, thereby improving user-device interaction.

In some embodiments, the environment is a three-dimensional environment that includes one or more objects, including the object, that are virtual, such as the virtual object 1106a in the three-dimensional environment 1102 as shown in FIGS. 11A and 11A1, and in which at least a portion of a physical environment of the user is visible (1206) (e.g., the three-dimensional environment is an augmented reality environment or a virtual environment including one or more virtual objects, as similarly described above with reference to step(s) 1202), such as representation 1122a of a coffee table and representation 1124a of a sofa as shown in FIGS. 11A and 11A1. Scaling a virtual object by a variable amount based on a distance that the virtual object is moved in a three-dimensional environment relative to a viewpoint of the user in response to detecting movement of the virtual object away from or towards the viewpoint of the user enables the virtual object to automatically remain visibly displayed in the user's field of view during the movement of the virtual object, which allows the user to continue to interact with the virtual object and/or content included in the virtual object, thereby improving user-device interaction.

In some embodiments, moving the object by the first distance during the first portion of the movement in accordance with the input includes moving the object with a first velocity in accordance with the input (1208a) (e.g., based on a velocity/speed of the movement of the hand of the user providing the input, as similarly described above with reference to step(s) 1202), as similarly represented by velocity curve 1142 in plot 1140 as shown in FIG. 11C. In some embodiments, while moving the object by the second distance during the second portion of the movement in accordance with the input and after the first portion of the movement (1208b), in accordance with a determination that the object is moved with a respective velocity that is greater than a velocity threshold (e.g., 0.1, 0.25, 0.5, 0.75, 1, 2, 5, 8, 10, 15, 20, 25, or 30 m/s) in accordance with the input, such as velocity threshold 1144 in the plot 1140 in FIG. 11C, the computer system forgoes (1208c) scaling the object by the second amount (e.g., scaling the object by an amount that is less than the second amount or forgoing scaling the object by any amount) (e.g., including the first amount and the second amount discussed above with reference to step(s) 1202), such as scaling the virtual object 1106a according to the scaling curve 1126-1 in the plot 1120 as shown in FIG. 11C. For example, while the object is moved the second distance or a part of the second distance during the second portion of the movement, if the movement of the hand of the user causes the object to be moved with a respective velocity that is greater than the velocity threshold (e.g., and equal to or different from the first velocity above), the computer system does not scale the object in the three-dimensional environment. In some embodiments, the computer system scales the object by a third amount, less than the second amount, in accordance with the determination that the object is moved with the respective velocity that is greater than the velocity threshold in accordance with the input. In some embodiments, as the object continues to be moved in accordance with the input during the second portion of the movement, if the velocity at which the object is moved remains above the velocity threshold, the computer system continues to forgo scaling the object by any amount in the three-dimensional environment (e.g., or continues to scale the object by the third amount discussed above).

In some embodiments, in accordance with a determination that the object is moved with a respective velocity that is less than the velocity threshold in accordance with the input, as similarly represented by portion 1143 of the velocity curve 1142 in the plot 1140 as shown in FIG. 11D, the computer system scales (1208d) the object by the second amount, such as scaling the virtual object 1106a according to the scaling curve 1126-3 as shown in FIG. 11D. For example, while the object is moved the second distance or a part of the second distance during the second portion of the movement, if the movement of the hand of the user causes the object to be moved with a respective velocity that is less than the velocity threshold (e.g., and less than the first velocity above), the computer system scales the object by the second amount in the three-dimensional environment in the manner previously described above with reference to step(s) 1202. Accordingly, as similarly described above with reference to step(s) 1202, in some embodiments, when moving the object in the first direction in response to detecting the first input, the computer system transitions to scaling the object by the second amount, after scaling the object by the first amount (e.g., which is optionally no amount of scaling, as previously discussed above with reference to step(s) 1202), in the three-dimensional environment after the object has been moved the first distance using a velocity-based delay. In some embodiments, the computer system transitions to scaling the object by the second amount, after scaling the object by the first amount, in the three-dimensional environment in response to any one or a combination of the scaling criteria described above (e.g., the velocity-based delay) and/or described below with reference to step(s)s 1210, 1212, 1214, 1216, and/or 1218 being satisfied. Delaying scaling an object by a variable amount based on a distance that the object is moved in a three-dimensional environment relative to a viewpoint of the user in response to detecting movement of the object away from or towards the viewpoint of the user until a velocity of the movement of the object slows provides visual feedback regarding the distance of the object from the viewpoint of the user, which helps avoid or reduce errors in interaction with content associated with the object, which allows the user to continue to interact with the content, and/or accounts for changes in eye focus as the object is moved away form or toward the viewpoint of the user, which helps reduce eye strain for the user, thereby improving user-device interaction.

In some embodiments, moving the object by the first distance during the first portion of the movement in accordance with the input includes moving the object with a first velocity (e.g., a velocity that is greater than zero (e.g., a threshold velocity (e.g., 0.1, 0.25, 0.5, 0.75, 0.9, 1, 2, 3, 5, or 10 m/s) of being zero (e.g., 0 m/s)) in accordance with the input (1210a) (e.g., based on a velocity/speed of the movement of the hand of the user providing the input, as similarly described above with reference to step(s) 1202), such as the movement of the virtual object 1106a according to the velocity curve 1142 in the plot 1140 as shown in FIG. 11C. In some embodiments, while moving the object by the second distance during the second portion of the movement in accordance with the input and after the first portion of the movement (1210b), in accordance with a determination that the object is no longer being moved (e.g., the object is being moved with a respective velocity that is within or less than the threshold velocity of being zero) in accordance with the input, such as in response to detecting termination of the input by hand 1103c as shown in FIG. 11C, the computer system scales (1210c) the object by the second amount. For example, while the object is moved the second distance or a part of the second distance during the second portion of the movement, if the movement of the hand of the user causes the object to be moved with a respective velocity that is zero velocity (e.g., and less than the first velocity above), the computer system scales the object by the second amount in the three-dimensional environment in the manner previously described above with reference to step(s) 1202. Accordingly, as similarly described above with reference to step(s) 1202, in some embodiments, when moving the object in the first direction in response to detecting the first input, the computer system transitions to scaling the object by the second amount, after scaling the object by the first amount (e.g., which is optionally no amount of scaling, as previously discussed above with reference to step(s) 1202), in the three-dimensional environment after the object has been moved the first distance using a velocity-based delay. In some embodiments, in accordance with a determination that the object is being moved (e.g., with a respective velocity that is greater than the threshold velocity of being zero) in accordance with the input, the computer system forgoes scaling the object by the second amount (e.g., scaling the object by an amount that is less than the second amount or forgoing scaling the object by any amount (e.g., including the first amount and the second amount discussed above with reference to step(s) 1202)). For example, while the object is moved the second distance or a part of the second distance during the second portion of the movement, if the movement of the hand of the user causes the object to be moved with a respective velocity that is greater than zero velocity (e.g., and equal to or different from the first velocity above), the computer system does not scale the object in the three-dimensional environment. In some embodiments, the computer system scales the object by a third amount, less than the second amount, in accordance with the determination that the object is moved with a respective velocity that is greater zero velocity in accordance with the input. In some embodiments, as the object continues to be moved in accordance with the input during the second portion of the movement, if the velocity at which the object is moved remains greater than the threshold velocity of being zero, the computer system continues to forgo scaling the object by any amount in the three-dimensional environment (e.g., or continues to scale the object by the third amount discussed above). In some embodiments, the computer system transitions to scaling the object by the second amount, after scaling the object by the first amount, in the three-dimensional environment in response to any one or a combination of the scaling criteria described above (e.g., the velocity-based delay) and described with reference to step(s)s 1208, 1212, 1214, 1216, and/or 1218. Delaying scaling an object by a variable amount based on a distance that the object is moved in a three-dimensional environment relative to a viewpoint of the user in response to detecting movement of the object away from or towards the viewpoint of the user until a velocity of the movement of the object reaches zero provides visual feedback regarding the distance of the object from the viewpoint of the user, which helps avoid or reduce errors in interaction with content associated with the object, and/or accounts for changes in eye focus as the object is moved away form or toward the viewpoint of the user, which helps reduce eye strain for the user, thereby improving user-device interaction.

In some embodiments, moving the object by the first distance during the first portion of the movement in accordance with the input includes moving the object for less than a threshold amount of time (e.g., 0.5, 1, 2, 3, 5, 10, 15, 30, 60, 90, 120, 150, 180, or 200 seconds) in accordance with the input (1212a) (e.g., based on a duration of the movement of the hand of the user providing the input, as similarly described above with reference to step(s) 1202), such as threshold amount of time 1114 as shown in FIG. 11B. In some embodiments, while moving the object by the second distance during the second portion of the movement in accordance with the input and after the first portion of the movement (1212b), in accordance with a determination that the movement of the object causes the object to have been moving for less than the threshold amount of time in accordance with (and/or during) the input, such as time bar 1107 being less than the threshold amount of time 1114 as shown in FIG. 11C, the computer system forgoes (1212c) scaling the object by the second amount (e.g., scaling the object by an amount that is less than the second amount or forgoing scaling the object by any amount (e.g., including the first amount and the second amount discussed above with reference to step(s) 1202)). For example, while the object is moved the second distance during the second portion of the movement, if the movement of the hand of the user causes the object to be moved for less than the threshold amount of time since the movement of the object began during the first portion of the movement, the computer system does not scale the object in the three-dimensional environment. In some embodiments, the computer system scales the object by a third amount, less than the second amount, in accordance with the determination that the object has been moving for less than the threshold amount of time in accordance with the input. In some embodiments, as the object continues to be moved in accordance with the input during the second portion of the movement, if the overall duration of the movement of the object remains below the threshold amount of time discussed above, the computer system continues to forgo scaling the object by any amount in the three-dimensional environment (e.g., or continues to scale the object by the third amount discussed above). In some embodiments, the threshold amount of time above corresponds to a length of time during which the input is detected (e.g., a duration of the input).

In some embodiments, in accordance with a determination that the movement of the object causes the object to have been moving for at least the threshold amount of time in accordance with (and/or during) the input, such as the time bar 1107 progressing past the threshold amount of time 1114 as shown in FIG. 11D, the computer system scales (1212d) the object by the second amount. For example, while the object is moved the second distance or a part of the second distance during the second portion of the movement, if the movement of the hand of the user causes the object to be moved for at least the threshold amount of time since the movement of the object began during the first portion of the movement, the computer system scales the object by the second amount in the three-dimensional environment in the manner previously described above with reference to step(s) 1202. Accordingly, as similarly described above with reference to step(s) 1202, in some embodiments, when moving the object in the first direction in response to detecting the first input, the computer system transitions to scaling the object by the second amount, after scaling the object by the first amount (e.g., which is optionally no amount of scaling, as previously discussed above with reference to step(s) 1202), in the three-dimensional environment after the object has been moved the first distance using a time-based delay. In some embodiments, the computer system transitions to scaling the object by the second amount, after scaling the object by the first amount, in the three-dimensional environment in response to any one or a combination of the scaling criteria described above (e.g., the time-based delay) and described with reference to step(s)s 1208, 1210, 1214, 1216, and/or 1218. For example, the computer system scales the object by the second amount in the three-dimensional environment as discussed above if the movement of the object causes the object to have been moving for at least the threshold amount of time in accordance with the input even if the object is still being moved with a respective velocity that is greater than the velocity threshold discussed above with reference to step(s) 1208. Delaying scaling an object by a variable amount based on a distance that the object is moved in a three-dimensional environment relative to a viewpoint of the user in response to detecting movement of the object away from or towards the viewpoint of the user until the movement of the object reaches a threshold duration provides visual feedback regarding the distance of the object from the viewpoint of the user, which helps avoid or reduce errors in interaction with content associated with the object, and/or accounts for changes in eye focus as the object is moved away form or toward the viewpoint of the user, which helps reduce eye strain for the user, thereby improving user-device interaction.

In some embodiments, the first distance that the object is moved during the first portion of the movement in accordance with the input is within a threshold distance (1214a) (e.g., a total distance the object has been moved in the three-dimensional environment during the input, such as, 1, 5, 8, 10, 12, 15, 20, 30, 40, 50, 75, 90, or 100 cm), such as Delay distance indicated in the overhead view of the three-dimensional environment 1102 as shown in FIG. 11C. In some embodiments, while moving the object by the second distance during the second portion of the movement in accordance with the input and after the first portion of the movement (1214b), in accordance with a determination that moving the object the second distance in accordance with the input causes the object to have been moved (optionally during the input) less than the threshold distance, such as the virtual object 1106b being moved less than the Delay distance in the overhead view as shown in FIG. 11C, the computer system forgoes (1214c) scaling the object by the second amount (e.g., scaling the object by an amount that is less than the second amount or forgoing scaling the object by any amount (e.g., including the first amount and the second amount discussed above with reference to step(s) 1202)). For example, while the object is moved the second distance or a part of the second distance during the second portion of the movement, if the movement of the hand of the user causes the object to subsequently be moved a total distance that is still within the threshold distance from the viewpoint of the user since the movement of the object began during the first portion of the movement, the computer system does not scale the object in the three-dimensional environment. In some embodiments, the computer system scales the object by a third amount, less than the second amount, in accordance with the determination that the object has been moved less than the threshold distance in accordance with the input. In some embodiments, as the object continues to be moved in accordance with the input during the second portion of the movement, if the overall distance of the movement of the object remains within the threshold distance from the viewpoint of the user, the computer system continues to forgo scaling the object by any amount in the three-dimensional environment (e.g., or continues to scale the object by the third amount discussed above).

In some embodiments, in accordance with a determination that moving the object the second distance in accordance with the input causes the object to have been moved (optionally during the input) at least the threshold distance, such as the virtual object 1106b being moved beyond the Delay distance in the overhead view as shown in FIG. 11D, the computer system scales (1214d) the object by the second amount. For example, while the object is moved the second distance or a part of the second distance during the second portion of the movement, if the movement of the hand of the user causes the object to be an overall distance from the viewpoint of the user that is at least the threshold distance from the viewpoint of the user since the movement of the object began during the first portion of the movement, the computer system scales the object by the second amount in the three-dimensional environment in the manner previously described above with reference to step(s) 1202. Accordingly, as similarly described above with reference to step(s) 1202, in some embodiments, when moving the object in the first direction in response to detecting the first input, the computer system transitions to scaling the object by the second amount, after scaling the object by the first amount (e.g., which is optionally no amount of scaling, as previously discussed above with reference to step(s) 1202), in the three-dimensional environment after the object has been moved the first distance using a distance-based delay. In some embodiments, the computer system transitions to scaling the object by the second amount, after scaling the object by the first amount, in the three-dimensional environment in response to any one or a combination of the scaling criteria described above (e.g., the distance-based delay) and described with reference to step(s)s 1208, 1210, 1212, 1216, and/or 1218. For example, the computer system scales the object by the second amount in the three-dimensional environment as discussed above if moving the object the second distance in accordance with the input causes the object to have been moved at least the threshold distance even if the object has been moving for less than the threshold amount of time discussed above with reference to step(s) 1212 and/or even if the object is still being moved with a respective velocity that is greater than the velocity threshold discussed above with reference to step(s) 1208. Delaying scaling an object by a variable amount based on a distance that the object is moved in a three-dimensional environment relative to a viewpoint of the user in response to detecting movement of the object away from or towards the viewpoint of the user until the distance that the object is moved reaches a threshold distance enables the object to automatically remain visibly displayed in the user's field of view during the movement of the object, which allows the user to continue to interact with the object and/or content included in the object, thereby improving user-device interaction.

In some embodiments, scaling the object by the second amount during the second portion of the movement includes (1216a) forgoing scaling the object (optionally by any amount (e.g., including the first amount and the second amount discussed above with reference to step(s) 1202)) for a threshold amount of time (e.g., 0.01, 0.05, 0.1, 0.15, 0.25, 0.5, 0.75, 1, 1.5, 2, 5, 10, 15, or 30 seconds) after a beginning of the movement of the object during the input (1216b) (e.g., after a beginning of the first portion of the movement), such as the threshold amount of time 1114 as shown in FIG. 11B. For example, while the object is moved the first distance during the first portion of the movement and/or while the object is being moved the second distance during the second portion of the movement in accordance with the movement of the hand of the user, while the threshold amount of time is elapsing, the computer system does not scale the object in the three-dimensional environment.

In some embodiments, after the threshold amount of time elapses (e.g., since the beginning of the second portion of the movement), such as after the time bar 1107 progresses past the threshold amount of time 1114 as shown in FIG. 11D, the computer system scales the object by the second amount (1216c) (e.g., in the manner previously described above with reference to step(s) 1202). Accordingly, as similarly described above with reference to step(s) 1202, in some embodiments, when moving the object in the first direction in response to detecting the first input, the computer system transitions to scaling the object by the second amount, after scaling the object by the first amount (e.g., which is optionally no amount of scaling), in the three-dimensional environment while the object is being moved during the second portion of the movement using a time-based delay. In some embodiments, the computer system transitions to scaling the object by the second amount, after scaling the object by the first amount, in the three-dimensional environment in response to any one or a combination of the scaling criteria described above (e.g., the time-based delay) and described with reference to step(s)s 1208, 1210, 1212, 1214, and/or 1218. Delaying scaling an object by a variable amount based on a distance that the object is moved in a three-dimensional environment relative to a viewpoint of the user for a threshold amount of time provides visual feedback regarding the distance of the object from the viewpoint of the user, which helps avoid or reduce errors in interaction with content associated with the object, and/or accounts for changes in eye focus as the object is moved away form or toward the viewpoint of the user, which helps reduce eye strain for the user, thereby improving user-device interaction.

In some embodiments, in response to detecting the input, in accordance with a determination that moving the object in the first direction in the environment relative to the viewpoint of the user (e.g., either during the first portion of the movement or the second portion of the movement discussed above with reference to step(s) 1202) in accordance with the input causes the object to be located within a threshold distance (e.g., the predefined near end limit discussed above with reference to step(s) 1202, such as, 1, 5, 8, 10, 12, 15, 20, 30, 40, 50, 75, 90, or 100 cm) from the viewpoint of the user (1218a), such as threshold distance (e.g., “Threshold distance in the overhead view) of the three-dimensional environment 1102 as shown in FIGS. 11A and 11A1, while moving the object within the threshold distance from the viewpoint of the user, the computer system forgoes (1218b) scaling the object (optionally by any amount (e.g., including the first amount and the second amount discussed above with reference to step(s) 1202)). For example, in response to detecting the input, if the movement of the hand of the user causes the object to be moved a distance from the viewpoint of the user that is within the threshold distance from the viewpoint of the user, while the object is located within the threshold distance from the viewpoint of the user, the computer system does not scale the object in the three-dimensional environment. In some embodiments, in response to detecting the input, in accordance with a determination that moving the object in the first direction in the environment relative to the viewpoint of the user in accordance with the input causes the object to be moved to a location that is outside the threshold distance from the viewpoint of the user, the computer system scales the object in the manner described previously with reference to step(s) 1202 (e.g., scales the object by the first amount during the first portion of the movement and/or by the second amount during the second portion of the movement). Forgoing scaling an object by a variable amount based on a distance that the object is moved in a three-dimensional environment relative to a viewpoint of the user while the object is within a threshold distance enables the object to automatically remain visibly displayed in the user's field of view during the movement of the object, without increasing a size of the object to an unnaturally large degree, which allows the user to continue to interact with the object and/or content included in the object, thereby improving user-device interaction.

In some embodiments, scaling the object during the input includes scaling the object with a first scaling delay (1220a) (e.g., one or more of the scaling delays described with reference to step(s)s 1208-1216), such as scaling the virtual object 1106a according to the scaling curve 1126-1 in the plot 1120 as shown in FIG. 11C. In some embodiments, while displaying the object in the environment, the computer system detects (1220b), via the one or more input devices, a second input corresponding to a request to move the object in a second direction (e.g., toward the viewpoint of the user), opposite the first direction, within the environment relative to the viewpoint of the user, such as input provided by hand 1103d as shown in FIG. 11D. For example, the computer system detects the hand of the user perform an air gesture, such as an air pinch and drag gesture, or interaction with a hardware input device, such as a controller. In some embodiments, the second input has one or more characteristics of the first input described above with reference to step(s) 1202.

In some embodiments, in response to detecting the second input, the computer system moves (1220c), via the display generation component, the object in the second direction in the environment relative to the viewpoint of the user in accordance with the second input, such as the movement of the virtual object 1106b in the overhead view as shown in FIG. 11E, including scaling the object during the second input more promptly than the first scaling delay, such as scaling the virtual object 1106a according to the scaling curve 1126-3 in the plot 1120 as shown in FIG. 11E. For example, the computer system scales the object by different amounts relative to, as compared to, or as a ratio of, the distance that the object is moved based on whether the object is moved toward the viewpoint of the user or away from the viewpoint of the user in the three-dimensional environment. In some embodiments, as similarly described above with reference to step(s) 1202, when moving the object in the first direction in response to detecting the first input, the computer system transitions to scaling the object by the second amount, after scaling the object by the first amount (e.g., which is no amount of scaling), in the three-dimensional environment after the object has been moved the first distance using a first time-based delay. For example, the computer system employs a first predetermined delay (e.g., 0.01, 0.05, 0.1, 0.15, 0.25, 0.5, 0.75, 1, 1.5, or 2 seconds) between scaling the virtual object by the first amount and scaling the object by the second amount in the three-dimensional environment. In some embodiments, when moving the object in the second direction in response to detecting the second input, the computer system transitions to scaling the object with a second scaling delay that is smaller than (e.g., quicker than) the first scaling delay (e.g., using a second time-based delay, smaller than the first time-based delay). In some embodiments, the computer system does not employ a time-based delay when moving the object in the second direction in the three-dimensional environment. Scaling an object by a variable amount based on a distance that the object is moved and a direction of movement of the object in a three-dimensional environment relative to a viewpoint of the user in response to detecting movement of the object away from or towards the viewpoint of the user enables the object to automatically remain visibly displayed in the user's field of view during the movement of the object, which allows the user to continue to interact with the object and/or content included in the object, thereby improving user-device interaction.

In some embodiments, moving the object in the first direction corresponds to moving the object away from the viewpoint of the user in the three-dimensional environment (1222) (or away from a location corresponding to the user in the three-dimensional environment) (e.g., as similarly described above with reference to step(s) 1202), such as the movement of the virtual object 1106b away from the viewpoint of the user 1126 as shown in the overhead view in FIG. 11B. Scaling an object by a variable amount based on a distance that the object is moved in a three-dimensional environment relative to a viewpoint of the user in response to detecting movement of the object away from the viewpoint of the user enables the object to automatically remain visibly displayed in the user's field of view during the movement of the object, which allows the user to continue to interact with the object and/or content included in the object, thereby improving user-device interaction.

In some embodiments, the input includes respective input corresponding to initiating a process to move the object within the environment (1224a) (e.g., as similarly described above with reference to method 800, such as detecting selection (e.g., an air pinch gesture or tap or touch gesture directed to) the object in the three-dimensional environment before detecting an input to move the object), such as contact of hand 1103a on touchpad 1130 as shown in FIGS. 11A and 11A1. In some embodiments, in response to detecting the respective input, the computer system generates (1224b) non-visual feedback indicating that the process to move the object within the environment has been initiated (e.g., before moving the object in the three-dimensional environment in accordance with the input as discussed above with reference to step(s) 1202), such as feedback 1150a as shown in FIG. 11B. In some embodiments, in conjunction with initiating the process to move the object within the three-dimensional environment (e.g., and in response to detecting selection (e.g., an air pinch gesture or tap or touch gesture directed to) the object in the three-dimensional environment), the computer system generates a non-visual feedback (e.g., an audio, tactile and/or haptic output) indicating that the object has been selected for movement within the three-dimensional environment. For example, the non-visual feedback is generated via one or more speakers in communication with the computer system (e.g., the non-visual feedback is a sound (e.g., a chime, tone, ring, bell, and/or other sound) produced by the one or more speakers) and/or is generated via one or more motors in communication with the computer system (e.g., the non-visual feedback is a vibration or sequence of vibrations produced by the one or more motors), among other possibilities. In some embodiments, the non-visual feedback is the same as non-visual feedback generated by the computer system in response to other inputs corresponding to interaction with the object (e.g., an input for changing the size of the object in the environment, an input for initially displaying the object in the environment, and/or an input interacting with (e.g., selecting) a user interface object (e.g., an image or selectable option) included in the object). Alternatively, in some embodiments in which the non-visual feedback is generated in response to an input selecting the object for movement in the three-dimensional environment, the non-visual feedback is different from (e.g., in duration, amplitude, tone, frequency, and/or waveform) a non-visual feedback generated by the computer system in response to other inputs corresponding to interaction with the object (e.g., such as the inputs discussed above). Generating non-visual feedback in response to detecting an input for initiating a process to move an object in a three-dimensional environment relative to a viewpoint of the user facilitates discovery, via the non-visual feedback, that movement input directed to the object will cause the object to be moved within the three-dimensional environment and/or provides confirmation to the user that the input directed to the object has been detected as intended by the user, thereby improving user-device interaction.

In some embodiments, while (and/or after) moving the object in the environment in accordance with the input, the computer system detects (1226a), via the one or more input devices, a termination of the input, such as an end of contact of hand 1103c on the touchpad 1130 in FIG. 11C. For example, the computer system detects a release of the input discussed above with reference to step(s) 1202. In some embodiments, if the input includes a hand gesture, such as an air pinch gesture, detecting the termination of the input includes detecting a release or deconfiguration of the pinch hand shape (e.g., such that the index finger and thumb of the hand of the user are no longer in contact). In some embodiments, detecting the termination of the input includes detecting the hand of the user move to a relaxed state relative to the environment (e.g., such that the hand of the user is rested at the user's side and/or positioned outside of the field of view of the three-dimensional environment from the viewpoint of the user). In some embodiments, if the input includes interaction with a hardware input device (e.g., a remote controller in communication with the computer system), detecting the termination of the input includes detecting a release of a physical button or switch on the hardware input device.

In some embodiments, in response to detecting the termination of the input, the computer system generates (1226b) first non-visual feedback indicating that the input has been terminated (e.g., after moving the object in accordance with the input in the environment as discussed above with reference to step(s) 1202), such as feedback 1150b as shown in FIG. 11D. Additionally, in some embodiments, in response to detecting the termination of the input, the computer system ceases moving the object in the three-dimensional environment (e.g., additional movement of the hand that is detected after the termination of the input has been detected will optionally not cause further movement of the object in the three-dimensional environment). In some embodiments, in conjunction with terminating the movement of the object within the three-dimensional environment, the computer system generates a non-visual feedback (e.g., an audio, tactile and/or haptic output) indicating that the object is no longer selected for movement within the three-dimensional environment. In some embodiments, the first non-visual feedback has one or more characteristics of the non-visual feedback discussed above with reference to step(s) 1224. Generating non-visual feedback in response to detecting an end of input for moving an object in a three-dimensional environment relative to a viewpoint of the user facilitates discovery, via the non-visual feedback, that further movement input directed to the object will not cause the object to be moved within the three-dimensional environment and/or provides confirmation to the user that the end of the input directed to the object has been detected as intended by the user, thereby improving user-device interaction.

In some embodiments, the input includes respective input corresponding to initiating a process to move the object within the environment (1228a) (e.g., as similarly described above with reference to step(s) 1224), such as contact of hand 1103a on touchpad 1130 as shown in FIGS. 11A and 11A1. In some embodiments, in response to detecting the respective input, the computer system generates (1228b) second non-visual feedback indicating that the process to move the object within the environment has been initiated (e.g., feedback 1150a in FIG. 11B), wherein the second non-visual feedback is different from the first non-visual feedback, as similarly described with reference to FIG. 11D. For example, the computer system generates the second non-visual feedback when the movement of the object within the three-dimensional environment is initiated, as similarly discussed above with reference to step(s) 1224, and generates the first non-visual feedback when the movement of the object within the three-dimensional environment is terminated. In some embodiments, a duration, amplitude, tone, frequency, and/or waveform of the first non-visual feedback is different from that/those of the second non-visual feedback. In some embodiments, a type of the first non-visual feedback is different from the type of the second non-visual feedback. For example, generating the first non-visual feedback includes providing haptic and/or tactile feedback (e.g., producing one or more vibrations, as similarly discussed above with reference to step(s) 1224) and generating the second non-visual feedback includes providing audio feedback (e.g., outputting sound, as similarly discussed above with reference to step(s) 1224). Generating non-visual feedback in response to detecting an input initiating movement of an object in a three-dimensional environment that is different from non-visual feedback that is generated in response to detecting an end of input for moving the object in a three-dimensional environment helps the user distinguish between whether the movement of the object has been initiated or terminated and/or provides feedback about whether the input for initiating or terminating the movement of the object has been detected as intended by the user, thereby improving user-device interaction.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

FIGS. 13A-13L illustrate examples of a computer system facilitating inertial movement of virtual objects in a three-dimensional environment in accordance with some embodiments.

FIG. 13A illustrates a computer system 101 (e.g., an electronic device) displaying, via a display generation component (e.g., display generation component 120 of FIGS. 1 and 3), a three-dimensional environment 1302 from a viewpoint of a user 1308 (e.g., facing the back wall of the physical environment in which computer system 101 is located, as shown in the overhead/top down view of the three-dimensional environment 1302).

In some embodiments, computer system 101 includes a display generation component 120. In FIG. 13A, the display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to the FIGS. 7, 9, and 11 series.

As shown in FIG. 13A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1302 or the physical environment is visible via display generation component 120. For example, three-dimensional environment 1302 includes a representation 1304a of a sofa (e.g., corresponding to representation 1304b in the overhead view), which is optionally a representation of a physical sofa in the physical environment.

As discussed in more detail below, in FIG. 13A, display generation component 120 is illustrated as displaying content in the three-dimensional environment 1302. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 13A-13L.

Display generation component 120 has a field of view (e.g., a field of view captured by external image sensors 314b and 314c and/or visible to the user via display generation component 120) that corresponds to the content shown in FIG. 13A. Because display generation component 120 is optionally a head-mounted device, the field of view of display generation component 120 is optionally the same as or similar to the field of view of the user.

As discussed herein, the user 1308 performs one or more air pinch gestures (e.g., with hand 1303) to provide one or more inputs to computer system 101 to provide one or more user inputs directed to content displayed by computer system 101. Such depiction is intended to be exemplary rather than limiting; the user optionally provides user inputs using different air gestures and/or using other forms of input as described with reference to the FIGS. 7, 9, and 11 series.

As mentioned above, the computer system 101 is configured to display content in the three-dimensional environment 1302 using the display generation component 120. In FIG. 13A, three-dimensional environment 1302 also includes a virtual object 1306a (corresponding to virtual object 1306b in the overhead view). In some embodiments, virtual object 1306a is a “content window” that displays graphical and/or textual content on a three-dimensional (or two-dimensional service) that is oriented to the user 1308 so that the user can view the content provided on the window. In some embodiments, the virtual object 1306a is optionally a user interface of an application containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 13A, the virtual object 1306a is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 1302, such as the content described below with reference to method 1400. Additionally, in some embodiments, as shown in FIG. 13A, the virtual object 1306a is displayed with a grabber bar 1320. In some embodiments, as discussed below, the grabber bar 1320 is selectable to initiate a process to move the virtual object 1306a within the three-dimensional environment 1302. In some embodiments, as discussed below, the virtual object 1306a is moveable within the three-dimensional environment in response to detected user input as well as in accordance with an inertial model.

In some embodiments, virtual objects are displayed in three-dimensional environment 1302 with respective orientations relative to a viewpoint of user 1308. For instance, as shown in FIG. 13A, the virtual object 1306a optionally has a first orientation in the three-dimensional environment 1302 (e.g., the front-facing surface of the virtual object 1306a that faces the viewpoint of user 1308 is perpendicular to a vector extending from the location of the viewpoint to the center of object 1306a). In some embodiments, the orientation of the virtual object 1306a is based on the location of the virtual object within the three-dimensional environment 1302 with respect to the viewpoint of the user 1308. As described in further detail below, the orientation of the virtual object 1306a optionally varies as the virtual object 1306a is moved through the three-dimensional environment 1302 by the computer system 101.

In some embodiments, virtual objects are displayed in three-dimensional environment 1302 with respective sizes relative to a viewpoint of user 1308 (e.g., prior to receiving input interacting with the virtual objects, which will be described later, in three-dimensional environment 1302). As shown in FIG. 13A, the virtual object 1306a optionally has a first size in the three-dimensional environment 1302 (e.g., determined by a width and/or height (e.g., an area) of the two-dimensional front-facing surface of the virtual object 1306a that faces the viewpoint of user 1308). In some embodiments, and as described in further detail below, the size of the virtual object within the three-dimensional environment 1302 is based on object type, a distance to the virtual object from the viewpoint of the user 1308, and/or a dimensionality of the virtual object.

In some embodiments, computer system 101 detects an input provided by hand 1303 (such as an air pinch gesture) corresponding to a request to select the virtual object 1306a in the three-dimensional environment 1302. For example, as shown in FIG. 13A, the computer system 101 detects hand 1303 providing an air gesture, such as an air pinch gesture in which an index finger and thumb of the hand of the user come together to make contact, while a gaze 1322 of the user 1308 is directed to the grabber bar 1320 that is displayed with the virtual object 1306a. In some embodiments, the computer system 101 detects the hand 1303 providing the air pinch gesture without detecting movement of the hand 1303 in space.

In some embodiments, the computer system 101 detects movement of hand 1303 while the hand is providing the air gesture (such as an air pinch gesture) and while the gaze 1322 of the user 1308 is directed to the grabber bar 1320 of virtual object 1306a. In some embodiments, and in response to detecting movement of hand 1303 (while the user is engaged in the air gesture), the computer system moves virtual object 1306a in accordance with direction and/or velocity of the movement of hand 1303. For instance, when the computer system detects that hand 1303 is moving in direction 1324 through space (while engaging in the air gesture), the computer system moves virtual object 1306a within the three-dimensional environment in the same direction 1316a (corresponding to the direction 1324 of the movement of hand 1303 through space) as the movement of hand 1303. In some embodiments, the direction 1324 of the movement of hand 1303 includes one or more components in the horizontal direction (x-direction), the vertical direction (y-direction), and away from/towards the user (z-direction). Optionally, in response to detecting the hand 1303 moving in direction 1324 (while engaged in the air gesture), the computer system moves the virtual object 1306a within the three-dimensional environment such that the direction 1316a includes the same X, Y, and Z components of motion as the movement of hand 1303. Optionally, the computer system 101 also changes the orientation of the virtual object 1306 based on the horizontal and vertical location of the virtual object 1306a and changes the size of the virtual object based on the distance of the virtual object from the viewpoint of the user as described above.

In some embodiments, the motion of the virtual object 1306a within the three-dimensional environment, and specifically the direction of the motion, is characterized using one or more reference directions as shown in the front-facing view motion graph 1310 of FIG. 13A. In some embodiments, front-facing view motion graph 1310 is used to characterize the motion of virtual object 1306a along the X-Y plane of motion (e.g., horizontally and vertically, respectively, relative to the viewpoint of the user). As described above, as direction 1324 of the motion of the hand 1303, and subsequently the direction 1316a of the motion of the virtual object 1306a, includes motion in both the X and Y directions (e.g., horizontal and vertical respectively), the direction of motion is represented in the front-facing view motion graph 1310 as 1316b (which corresponds to the direction of motion 1316a). In some embodiments, the direction of motion 1316b is a vector with a component in the X direction and a component in the Y direction. The vector representing the direction of motion 1316b, thus can be represented using a magnitude and a phasor (e.g., an angle) that describes the distance the direction of motion is away from a particular reference direction. For instance, the direction of motion 1316b can be characterized by an angle 1312 between the direction 1316b of motion and the X reference direction 1314 (e.g., the horizontal direction). In some embodiments, the larger the angle between the X reference direction 1314 and the direction of motion 1316b (e.g., the further away from the X reference direction), the less the magnitude of the component of motion in the X direction, and the larger the magnitude of the component of motion in the Y direction. Thus, in some embodiments, if the angle 1312 is between 0° and 45°, the direction of motion 1316b is characterized as being closer to the X reference direction 1314 (e.g., the direction of motion 1316b has a larger component of motion in the X direction than the Y direction). Additionally, if the angle 1312 is between 45° and 90°, the direction of motion 1316b is characterized as being closer to the Y reference direction 1318. Additionally, or alternatively, the direction of motion 1316b is optionally characterized by its angle with respect to the Y reference direction (e.g., the vertical direction).

In some embodiments, upon detecting termination of the air gesture performed by hand 1303 (e.g., releasing the pinch of the hand such that a distance between the thumb of the hand 1303 and one or more fingers of the hand increases), the computer system 101 continues to move the virtual object 1306a in accordance with an inertial movement model as illustrated in FIG. 13B. In some embodiments, the inertial movement model is configured to simulate the inertia an object would have if it were being moved in response to a force in a real-world physical environment. Thus, in one or more examples, the movement of the hand 1303 when engaged in the air pinch as described in FIG. 13A imparts an inertia on the virtual object 1306a that continues moving the virtual object even when the air gesture (e.g., air pinch is terminated). In some embodiments, the velocity of the object 1306a according to the inertial movement model decelerates over time until the virtual object 1306a comes to a rest within the three-dimensional environment 1302 (so as to simulate friction in the environment).

In some embodiments, the direction of motion 1326a of the inertial movement model (corresponding to direction 1326b in the top down view) is based on the direction of motion 1316a that the virtual object was moved in while the user was moving the virtual object with hand 1303. However, optionally, the direction of motion 1326a (e.g., the updated direction of motion) is “biased” towards a reference direction based on which reference direction the motion 1316a of the input was closest to. In the example of FIG. 13A, the direction of motion 1316b (referring to the front-facing graph view 1310) is shown as being closer to reference direction 1314 with an angle 1312 between the direction of the motion 1316b and the X reference direction 1314. In some embodiments, since the direction of motion 1316b is closer to the X reference direction 1314, the direction of motion 1326b of the inertial movement model used to continue the motion of the virtual object 1306a after the input has been terminated is biased towards the X reference direction 1314 such that the angle 1328 is smaller than angle 1312 with respect to the X reference direction 1314. In some embodiments, since angle 1328 is smaller than angle 1312, the virtual object's motion according to the inertial movement model will have a larger component in the X reference direction than the object's motion while the user was moving the object.

In some embodiments, the computer system 101 continues to move the virtual object according to the inertial movement model as illustrated in FIG. 13C. In FIG. 13C, computer system 101, optionally continues to move virtual object 1306a within environment 1302 in direction 1326a, which has a larger component of motion in the X direction (e.g., it is closer/biased to the X direction) than direction of motion 1316a of virtual object 1306a when it was moved by hand 1303 as described above. In some embodiments, while the virtual object is moving in the X direction, the orientation of the virtual object changes in accordance with the motion as described above.

In some embodiments, if the motion of the hand when moving the virtual object 1306a is closer to the Y reference direction 1318, then the direction of motion of the inertial movement model, according to which the virtual object 1306a will continue to move, will be biased (e.g., closer) to the Y reference direction 1318 as compared to the direction of the motion of the virtual object 1306a when being moved by the user's hand 1303, as illustrated in FIG. 13D. In the example of FIG. 13D, the computer system 101 detects movement of the user's hand 1303, while the user performs an air gesture (e.g., an air pinch), and while the user's gaze 1322 is directed at grabber bar 1320, like the example of FIG. 13A. In some embodiments, the computer system in response to the motion of the user's hand in direction 1330 moves virtual object 1306a in direction 1332a (corresponding to the direction 1330 of the movement of hand 1303 through space). In contrast to direction 1316b of FIG. 13A, direction 1332b (as illustrated in front facing view motion graph 1310) is closer to the Y reference direction 1318 than X direction 1314, thus meaning that direction 1332b has a larger component in the Y reference direction 1318 compared to the X reference direction 1314 (e.g., the vertical component of the motion is greater than the horizontal component). Thus, angle 1334 as illustrated in the front facing graph view 1310 will be larger than 45° indicating that direction of motion 1332b of the virtual object in response to the motion of user's hand 1303 has a larger component of motion in the Y reference direction 1318 as compared to the X reference direction 1314.

In some embodiments, since direction 1332b is closer to the Y reference direction 1318, the inertial movement model will be biased to the Y-direction, and the computer system 101 will continue to move virtual object 1306a in an updated direction that is biased to the Y reference direction (e.g., vertical direction) when the computer system detects that user 1308 has terminated the air gesture, as illustrated in FIG. 13E.

In FIG. 13E, the user's hand 1303 is shown as terminating the air gesture by releasing the air pinch (e.g., by separating one or more fingers from the thumb of the hand). In some embodiments, and in response to detecting termination of the input from the user's hand, the computer system 101 continues to move the virtual object 1306a according to the inertial movement model, similar to the examples described above. In the example of FIG. 13E, since direction 1332a (e.g., the direction the computer system 101 moves the virtual object 1306a in response to the input from hand 1303 while the air pinch gesture is engaged) is closer to the Y reference direction 1318 (as described above with respect to FIG. 13D), the updated direction of movement 1336a (e.g., the motion according to the inertial movement model) will be biased in the Y reference direction 1318 as compared to direction 1332a, meaning the direction of movement of 1336a will have a larger Y component of motion than direction 1332a. As illustrated in the front facing motion graph 1310, angle 1338 is closer to the Y reference direction 1318 than angle 1370 thus indicating that direction 1336b has a larger Y component of motion than direction 1332b.

In some embodiments, the direction of motion of the virtual object 1306a in response to movement of the user's hand 1303 (e.g., while the air pinch gesture is engaged) can be equidistant from both the X reference direction and the Y reference direction as illustrated in FIG. 13F. In the example of FIG. 13F, the direction 1340 of the motion of the user's hand 1303 (while gaze 1322 is directed to grabber bar 1320 and while the user is performing an air gesture such as an air pinch) has equal components in the X direction and the Y direction, thus causing computer system 101 to move virtual object 1306a in direction 1342a (corresponding to the direction 1340 of the movement of hand 1303 through space). In some embodiments, as shown in front facing view graph 1310, direction 1342a includes equal X and Y components, and thus angle 1344 is 45° with respect to both the X direction 1314 and the Y reference direction 1318).

In some embodiments, as direction 1342a (corresponding to direction 1342b in the front facing view) has equal components in both the X reference direction and the Y reference direction, when computer system 101 detects termination of the user input (e.g., by terminating the air pinch), the computer system 101 moves virtual object 1306a according to the inertial movement model illustrated in FIG. 13G. In the example of FIG. 13G, in response to detecting termination of the user input, the computer system 101 continues to move virtual object in direction 1346a. As indicated in front view motion graph 1310, direction 1346b is not biased in either the X reference direction 1314 or Y reference direction 1318, thus making direction 1346b the same as direction 1342b. In some embodiments both directions 1342b and 1346b have the same angle 1344 with respect to both the X reference direction 1314 and Y reference direction 1318 (e.g., 45°) thus indicating that both directions 1342b and 1346b have equal components (with respect to magnitude) in both the X reference direction and the Y reference direction (e.g., both directions are equidistant with respect to the reference directions).

In some embodiments, computer system 101 does not continue moving the virtual object 1306a after detecting termination of the user's input according to an inertial movement model if the detected motion of the user's hand 1303 is below a pre-determined velocity threshold (e.g., when the air pinch input is terminated). For instance, in the example of FIG. 13H, computer system moves virtual object 1306a in direction 1350a in response to the movement of the user's hand 1303 (while the user's gaze 1322 is directed to grabber bar 1320 in FIG. 13A, and while performing an air gesture such as an air pinch) in direction 1348, and in response moves virtual object 1306a in direction 1350a (corresponding to the direction 1348 of the movement of hand 1303 through space). In some embodiments, the movement of the user's hand is below a pre-determined velocity threshold (e.g., when the air pinch input is terminated). In some embodiments, the pre-determined velocity threshold is selected from one or more of the following values, 0.5, 1, 2, 5, 10, 25, 50, 75, or 100 cm/s. In some embodiments, and to simulate a real-world physical environment in which an object that is not moved with sufficient force (e.g., moved at a slow velocity) does not exhibit inertial motion when the force the object is moved with is not sufficient to overcome the friction of the physical real-world environment, the computer system 101 terminates movement of the virtual object 1306a rather than continuing the movement of the virtual object 1306a in response to detecting termination of the input, as illustrated in FIG. 13I.

In some embodiments, the motion of the user's hand includes motion in three-dimensions as illustrated in FIG. 13J. In the example of FIG. 13J, the computer system 101 detects motion of the user's hand 1303 (while the gaze 1322 of the user is directed to grabber bar 1320, and while the user is performing an air gesture such as an air pinch). Optionally, the user's hand 1303 is moving in direction 1352 which includes motion in three dimensions (e.g., horizontally, vertically, and away from/towards the viewpoint of the user). In some embodiments, in response to detecting the input from the user's hand 1303 in direction 1352 (e.g., while the air pinch gesture remains engaged), computer system 101 moves virtual object 1306a in direction 1354a (corresponding to the direction 1352 of the movement of hand 1303 through space). In some embodiments, and in response to detecting that direction 1352 includes motion in three-dimensions, direction 1354a includes motion in three-dimensions as well. For instance, and as illustrated in front facing view motion graph 1310, direction 1354c (corresponding to direction 1354a) includes motion in both the X reference direction 1314 and Y reference direction 1318 (e.g., in the X-Y plane). Additionally, in some embodiments, and as shown in top down view motion graph 1356, direction 1354b includes motion in the Z reference direction 1358 (which is orthogonal to both X reference direction 1314 and Y reference direction 1318) and motion in the X reference direction 1314.

In some embodiments, direction 1354b (corresponding to direction 1354a) is characterized in the top down view motion graph 1356 (e.g., the X-Z plane) using angle 1360. In some embodiments, and similar to the examples described above, if angle 1360 is between 0° and 450 with respect to the Z reference direction 1358, then the direction 1354b is closer to the Z reference direction 1358 meaning that direction 1354b has a larger component of motion in the Z reference direction than the X reference direction. In the example of FIG. 13J, direction 1354b is illustrated as being closer to the Z reference direction 1358 in comparison to the X reference direction 1314. In some embodiments, direction 1354c is characterized in front facing motion graph 1310 (e.g., the X-Y) plane using angle 1368. In some embodiments, and similar to the examples described above, if angle 1368 is between 0° and 45° with respect to the X reference direction 1314, then the direction 1354c is closer to the X reference direction 1314 indicating that direction 1354c has a larger component of motion in in the X reference direction than the Y reference direction. In the example of FIG. 13J, direction 1354c is illustrated as being closer to X reference direction 1314.

In some embodiments, computer system 101 continues to move virtual object 1306a according to an inertial movement model in response to detecting termination of the air gesture performed by hand 1303 (e.g., by detecting that the user has terminated the air pinch by separating one or more fingers of the hand from thumb), as illustrated in FIG. 13K. In some embodiments, and as illustrated in FIG. 13K, computer system 101 moves virtual object 1306a in updated direction 1362a (which corresponds to direction 1362b in the front facing view, and direction 1362c in the top down view. In some embodiments, updated direction 1362a is biased towards one or more reference directions in comparison to direction 1354a. For instance, as direction 1354c was closer to the Z reference direction (as described above), updated direction 1362c is biased towards the Z reference direction 1358 such that angle 1364 is smaller with respect to the Z reference direction as compared to angle 1360. Thus, updated direction 1362a will have a larger Z component of motion as compared to the X component of motion.

In some embodiments, updated direction 1362a is independently biased in the X-Y plane toward the X reference direction as illustrated in front facing view motion graph 1310. Since direction 1354c is closer to the X reference direction 1314 (as described above with respect to FIG. 13J), updated direction 1362b is biased toward the X reference direction 1314 such that angle 1366 is smaller with respect to the X reference direction 1314 than angle 1368. In some embodiments, computer system 101 continues to move virtual object 1306a in accordance with the inertial model described above until the computer system 101 terminates the motion (in order to simulate real-world friction) as illustrated in FIG. 13L.

FIG. 14 is a flowchart illustrating an exemplary method of moving a virtual object with inertial motion in an environment in accordance with some embodiments. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, method 1400 is performed at a computer system in communication with a display generation component and one or more input devices: For example, the computer system is or includes a mobile device (e.g., a tablet, a smartphone, a media player, or a wearable device), or a computer. In some embodiments, the computer system has one or more characteristics of the computer system in methods 800, 1000, 1200, 1600, and/or 1800. In some embodiments, the display generation component has one or more characteristics of the display generation component in methods 800, 1000, 1200, 1600, and/or 1800. In some embodiments, the one or more input devices have one or more characteristics of the one or more input devices in methods 800, 1000, 1200, 1600, and/or 1800.

In some embodiments, while displaying, via the display generation component, a virtual object (such as virtual object 1406a in FIGS. 13A-L) (e.g., in a user interface or in an environment such as a three-dimensional environment), the computer system detects (1402a) a first input that includes movement such as in FIG. 13A. In some embodiments, in response to detecting the first input, the computer system moves (1402b) the virtual object in accordance with the movement of the first input (such as in FIG. 13A) (e.g., moving the virtual object based on a direction, magnitude, and/or speed of the movement of the first input).

In some embodiments, while displaying, via the display generation component, the virtual object moving in accordance with the movement of the first input, the computer system detects (1402c), via the one or more input devices, termination of the movement while the movement of the first input is in a respective direction (such as in FIG. 13B). In some embodiments, the environment is a three-dimensional environment that at least partially incorporates a representation of the real-world physical environment of the user while using the computer system (e.g., via active or passive passthrough). In some embodiments, the environment has one or more characteristics of the environments in methods 800, 1000, 1200, 1600, and/or 1800. In some embodiments, a virtual object refers to an object that is displayed by the computer system in the environment that is generated by the computer system and is not part of the physical real-world physical environment. In some embodiments, the object has one or more characteristics of the objects in methods 800, 1000, 1200, 1600, and/or 1800. As an example of a virtual object, the computer system displays a window in the environment that displays content (e.g., visual content and/or text). In some embodiments, the window is moveable within the environment by the user. For example, the computer system moves the virtual object in response to detected movement of an input from the user. In some embodiments, detecting the movement of an input includes detecting that the user is performing an air pinch while gazing at the window to select the window and moving the hand of the user (while maintaining the air pinch) in a respective direction. In some embodiments, the computer system detects the direction the user's hand (that is performing the input) is moving, and accordingly moves the window (e.g., virtual object) in the same direction within the environment. In some embodiments, the direction of movement can be up, down, left, right, away and/or towards the viewpoint of the user. In some embodiments, the computer system will continue to move the virtual object so long as it detects that the input is still being performed by the user. In some embodiments, the computer system detects termination of the input upon detecting that the air pinch has been released (e.g., that the fingers of the user are no longer pinched together). In some embodiments the input by user can be detected on a trackpad or other touch surface. For example, the user selects the window using the track pad (for instance by tapping on the trackpad) and then keeps their finger engaged on the trackpad while moving their finger to move the object. In the example of a trackpad, the termination of the input is detected when the user lifts their finger off of the trackpad surface after having moved the object within the environment.

In some embodiments, in response to detecting the termination of the first input (1402d) (e.g., and in accordance with a determination that one or more first criteria are satisfied (e.g., as described in further detail below)), the computer system continues moving (1402e) the virtual object in the environment according to a respective movement model (e.g., an inertial movement model) that specifies how movement of the virtual object continues after detecting termination of the input (such as in FIG. 14C). In some embodiments, continuing the movement of the virtual object according to the respective movement model includes: in accordance with a determination that the respective direction is closer to a first reference direction (e.g., such as direction 1316b being closer to reference direction 1314 in FIG. 13C) (e.g., in the user interface or in the environment) than a second reference direction (such as reference direction 1318 in FIG. 13C) (e.g., in the user interface or in the environment), the computer system moves (1402f) the virtual object in a first updated direction such as direction 1326b in FIG. 13C (e.g., in the user interface or in the environment), wherein a difference between the first updated direction and the first reference direction is smaller than a difference between the respective direction and the first reference direction such as direction 1326b having a smaller angular distance 1328 when compared to angular distance 1312 of direction 1316b. In some embodiments, once the computer system determines that the input has been terminated, the computer system continues to move the virtual object for a period of time and eventually stops moving the virtual object to simulate inertial movement of the object (e.g., as if the object has a simulated mass), as well as to simulate friction that a moving object would encounter in a real-world environment to cause the object's velocity to decrease, optionally ultimately to zero. In some embodiments, the computer system continues to move the object after detecting termination of the input based on the detected movement, velocity and/or acceleration and direction of the user's hand while performing the input and/or when the input was terminated. To simulate inertial movement of the object, in some embodiments, the computer system continues to move the virtual object, after detecting termination of the input, according to an inertial movement model. In some embodiments, the inertial movement model specifies, amongst other things, the velocity, the direction of movement, as well as the distance that the virtual object will move once the computer system has detected termination of the input. In some embodiments, the computer system continues to move the object at the termination of the input only if the one or more first criteria are satisfied, such as described in further detail below. If the one or more first criteria are not satisfied, then the computer system will optionally terminate movement of the object when termination of the input is detected (e.g., without continuing to move the object in accordance with the inertial movement model). In some embodiments, the inertial movement model is based on the detected velocity of the input (e.g., the detected speed at which the user's hand is moving during the input movement). The detected velocity can be determined at a time at or slightly before termination of the input is detected thereby making the inertial movement model based on the final velocity of the user's hand before the input is terminated. The direction of movement of the inertial movement model, in some examples, is based on the direction of movement of the input. The direction of the input can be characterized using one or more reference directions. For instance, as the input occurs in three-dimensions (as described above), the direction of the movement of the input can be characterized using three orthogonal reference directions (e.g., X, Y, and Z-directions) in the environment. For instance, a particular direction of movement of the input will have a component along the X reference direction, a component of movement along the Y reference direction, and/or a component of movement along the Z reference. In some embodiments, the computer system determines the direction of movement of the inertial movement model by determining the components of the direction of movement of the input in each of the reference directions. Additionally or alternatively, the computer system characterizes the direction of movement of the input using angles. For example, if the movement of the input is along the X-Y plane (e.g., there is no component of movement in the Z direction) then the direction of movement can be characterized as an angle with respect to the X reference direction. If the direction of movement in the X reference direction is greater than the direction of movement in the Y reference direction, then the angle of the direction of movement of the input will be between 0° (e.g., no movement in the Y reference direction) and 45°. If the direction of movement in the X reference direction is less than the Y reference direction, then the direction of input will be between 450 and 900 (e.g., no movement in the X reference direction). If the movement in the X reference direction and the Y reference direction are equal, then the direction of the movement of the input will be 45°. Using the above example, if the direction of the input is between 0° and 45°, then the direction of movement of the input is characterized as being “closer” to the X reference direction (since graphically, a vector between 0° and 45° is closer to the X-axis than the Y-axis). In the example when the direction of the input is between 45° and 90°, the direction of movement of the input is characterized as being closer to the Y-reference direction. In some embodiments, continuing the movement of the virtual objection according to the inertial model includes moving the virtual object in a first updated direction in the environment, wherein the first updated direction is based on the determined direction of movement of the input. For instance, using the example above, if the direction of movement of the input is closer to the X reference direction (e.g., the direction of movement of the input has a larger X component than Y component) than the first updated direction will also be closer to the X reference direction and will be closer to the X reference direction than the direction of movement of the input (e.g., the difference between the X component and the Y component of movement of the first updated direction will be larger than the difference between the components of the direction of movement of the input, with the component in the X direction of the first updated direction being larger than the component in the Y direction). Thus in some embodiments, the computer system biases the resulting movement of the object in the environment towards the reference direction(s) to which the movement of the input is closer (e.g., offsets the resulting movement of the object along those reference direction(s) from the component(s) of the input along those reference direction(s)). In some embodiments, the closer the movement of the input is to a given reference direction, the more the resulting movement of the object along that reference direction is biased towards that given reference direction. The above is optionally performed concurrently with respect to one or more or all of the reference directions along which the input has movement components.

In some embodiments, in accordance with a determination that the respective direction is closer to the second reference direction (e.g., in the user interface or in the environment) than the first reference direction such as direction 1332b being closer to the Y reference direction 1318 than the X reference direction 1314 in FIG. 13D (e.g., in the user interface or in the environment), the computer system moves (1402g) the virtual object in a second updated direction (e.g., direction 1336b in FIG. 13E (e.g., in the user interface or in the environment), different from the first updated direction (e.g., in the user interface or in the environment), wherein a difference between the second updated direction and the second reference direction is smaller than a difference between the respective direction and the second reference direction, such as direction 1336b having a smaller angular distance 1338 from the Y-reference direction 1318 when compared to the angular distance 1334 of direction 1332b with respect to Y-reference direction 1318. For instance, using the example above, if the direction of movement of the input is closer to the Y reference direction (e.g., the direction of movement of the input has a larger Y component than X component) then the second updated direction will also be closer to the Y reference direction and will be closer to the Y reference direction than the direction of movement of the input (e.g., the difference between the X component and the Y component of movement of the first updated direction will be larger than the difference between the components of the direction of movement of the input, with the component in the Y direction of the second updated direction being larger than the component in the X direction.) Moving the virtual object in updated directions that are biased towards reference directions in response to detecting termination of the input reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, the first reference direction and the second reference direction are orthogonal with respect to each other (such as X reference direction 1314 being orthogonal to Y reference direction 1318) and continuing moving the virtual object according to the respective movement model includes moving the virtual object in both the first reference direction and the second reference direction concurrently (such as direction 1336b illustrated in FIG. 13E). In some embodiments, the movement of the virtual object according to the inertial movement model is two-dimensional with the first dimension corresponding to the first reference direction, and the second dimension corresponding to the second dimension. In some embodiments, the two-dimensional inertial movement of the virtual object described above is in response to the device detecting two-dimensional motion of the portion of the user during the first input. In some embodiments, the first reference direction and the second direction are orthogonal to one another and thus the movement of the virtual object according to the inertial model is characterized by a component in the first reference direction and a component in the second reference direction, wherein the components are mutually exclusive (due to the orthogonality of the first and second reference directions.) In a two-dimensional space, the continued movement of the object according to the inertial model can move simultaneously in both the first reference direction and the second reference direction (e.g., in any direction along a two-dimensional plane). Moving the virtual object in two orthogonal dimensions in response to detecting termination of the input reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, the first reference direction is a horizontal direction (e.g., X reference direction 1314) with respect to a reference location relative to a user (e.g., a viewpoint of a user or a location of a body or a line between the shoulders of the user) of the computer system associated with the input. In some embodiments, the second reference direction is a vertical direction with respect to the reference location relative to the user (such as Y reference direction 1318 illustrated in FIG. 13E). In some embodiments, a difference between the first updated direction and the horizontal direction is smaller than a difference between the respective direction and the vertical direction (such as updated direction 1326b in FIG. 13C), and wherein a difference between the second updated direction and the vertical direction is smaller than a difference between the respective direction and the horizontal direction (such as updated direction 1336 in FIG. 13E). In some embodiments, the first dimension (e.g., the first reference direction) corresponds to horizontal movement (e.g., left and right relative to the viewpoint of the user) and the second dimension (e.g., the second reference direction) corresponds to vertical movement (e.g., up and down movement relative to the viewpoint of the user). In some embodiments, in accordance with the determination that the respective direction is closer to the first reference direction (e.g., the horizontal direction), the first updated direction is biased towards the horizontal direction such that a difference between the respective direction and the horizontal direction is smaller than a difference between the respective direction and the vertical direction. Optionally, the first updated direction includes a component of motion in the vertical direction. In some embodiments, in accordance with the determination that the respective direction is closer to the second reference direction (e.g., the vertical direction), the second updated direction is biased towards the vertical direction such that a difference between the respective direction and the vertical direction is smaller than a difference between the respective direction and horizontal direction. Optionally, the second updated direction includes a component of motion in the horizontal direction. Moving the virtual object both horizontally and vertically in response to detecting termination of the input reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments the first updated direction includes a component in the second reference direction (such as updated direction 1326b in FIG. 13C). Optionally, the component in the second reference direction of the first updated direction is based on the respective direction of the first input (such as direction 1324 in FIG. 13A). In some embodiments, the second updated direction includes a component in the first reference direction such as updated direction 1336b including a component of motion in the X reference direction 1314, and the component in the first reference direction of the second updated direction is based on the respective direction of the first input such as direction 1330 of hand 1303 in FIG. 13D. In some embodiments, even though the first updated direction is biased towards the first reference direction, the first updated direction can include a component of motion in the second reference direction to reflect that the respective direction of the input included a component in the second reference direction. Optionally, if the respective direction of the input only included a component of motion in the first reference direction and did not include any component of motion in the second reference direction, then the first updated direction will not include a component of motion in the second reference direction. Similarly, in some embodiments, even though the second updated direction is biased towards the second reference direction, the second updated direction can include a component of motion in the first reference direction to reflect that the respective direction of the input included a component in the first reference direction. Optionally, if the respective direction of the input included only included a component of motion in the second reference direction and did not include any component of motion in the first reference direction, then the second updated direction will not include a component of motion in the first reference direction. In some embodiments, in accordance with the respective direction of the input having a first component in the second reference direction, the first updated direction has a first updated component in the second reference direction. Similarly, in some embodiments, in accordance with the respective direction of the input having a second component (optionally greater than the first component) in the second reference direction, the first updated direction has a second updated component (optionally greater than the first updated component) in the second reference direction, different from the first updated component. Moving the virtual object to have some motion in the non-biased reference direction, thus reflecting that the input had some motion in the non-biased reference direction in response to detecting termination of the input reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, in response to detecting the termination of the first input, the computer system in accordance with a determination that the respective direction is equidistant to the first reference direction and the second reference direction such as direction 1340 of hand 1303 in FIG. 13F, moves the virtual object in a third updated direction in the environment, wherein the third updated direction is the same as the respective direction, such as updated direction 1346b in FIG. 13G. In some embodiments, when the respective direction of the input includes both a horizontal motion component (e.g., motion in the first reference direction) and a vertical motion component (e.g., motion in the second reference direction) and the magnitudes of the horizontal and vertical components are equal (e.g., the respective direction is 450° from the horizontal reference direction and the vertical reference direction), the computer system continues moving the virtual object (upon detection of the termination of the first input), in accordance with the respective movement model, without biasing the inertial movement towards any one of the first or second reference directions, thus maintaining the respective direction of the input. Moving the virtual object to not be biased in a reference direction upon detection of the termination of the input, when the input has equal components of motion in the first and second reference directions reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, continuing moving the virtual object in the environment according to the respective movement model includes: in accordance with the determination that the respective direction is closer to the first reference direction than the second reference direction and that the respective direction is a first angular distance away from the first reference direction, the computer system moves the virtual object in the first updated direction in the environment such that the first updated direction is a second angular distance away from the first reference direction, wherein the first angular distance and second angular distance are different such as direction 1316b having a different angular distance 1312 than the angular distance 1328 of updated reference direction 1326b in FIG. 13C. In some embodiments, the second angular distance is smaller than the first angular distance, so as to bias the first updated direction in the first reference direction (in accordance with the determination the respective direction of the input is closer to the first reference direction than the second reference direction).

In some embodiments, in accordance with a determination that the respective direction is closer to the first reference direction than the second reference direction and that the respective direction is a third angular distance away from the first reference direction (as if virtual object 1306a were moved in a different direction than direction 1316b), wherein the third angular distance is different from the first angular distance (due to biasing the direction to the X reference direct 1314 as illustrated in FIG. 13C), the computer system moves the virtual object in the in the first updated direction in the environment such that the first updated direction is a fourth angular distance away from the first reference direction, wherein the third angular distance and the first angular distance are different; and In some embodiments, the fourth angular distance is smaller than the thirds angular distance, so as to bias the first updated direction in the first reference direction (in accordance with the determination the respective direction of the input is closer to the first reference direction than the second reference direction).

In some embodiments, a first ratio between the first angular distance and the second angular distance is different than a second ratio between the third angular distance and the fourth angular distance. In some embodiments, the relationship between the respective directions of inputs has a non-linear relationship with the corresponding updated directions of movement occurring after termination of the input is detected. For instance, if the direction of the input is 40° degrees from the first reference direction, then the first updated direction is 30° from the first reference direction. However, if the input is 20° degrees from the first reference direction, the resultant motion in the first updated direction, instead of being 15° from the first reference direction (e.g., a linear relationship) will instead be larger or smaller than 15°. Similarly, if the respective direction was closer to the second reference direction, then the updated direction would be biased towards the second reference direction. As illustrated in the example above, the closer the respective direction is to a reference direction, the more (or less) the updated direction is optionally biased towards the reference direction, and the further the respective direction is to the reference direction, the less (or more) the updated direction is biased toward the reference direction. In some embodiments, the non-linear relationships between the movement input and the updated input also apply if the direction of the input is closer to the second reference direction. Moving the virtual object upon detection of the termination of the input to be closer to the first reference direction in a non-linear manner reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, continuing moving the virtual object according to the movement model includes moving the virtual object in the first reference direction, the second reference direction, and a third reference direction concurrently, wherein the first, second, and third reference directions are orthogonal with respect to one another such as direction 1352 having components in the X reference direction 1314, the Y reference direction 1318, and the Z reference direction 1358 in FIG. 13J. In some embodiments, the virtual object is displayed in a three-dimensional environment. In some embodiments, continuing to move the virtual object according to the respective movement model (e.g., the inertial movement model) includes moving the virtual object in each of the three-dimensions of the environment, with each dimension (e.g., reference direction) being orthogonal to one another. Thus, optionally, the movement model (based on the respective direction of the input) includes a component in the first reference direction (e.g., the X-direction), the second reference direction (e.g., the Y-direction), and the third reference direction (e.g., the Z-direction) thus causing the virtual object to move in three dimensions. In some embodiments, continuing to move the virtual object according to the movement model (e.g., the inertial movement model) is applied to different pairs of reference directions that make up the three-dimensions, independently. For instance, the updated direction of the inertial movement is based on biasing the movement in each of the X-Y, X-Z, and Y-Z planes. Moving the virtual object upon detection of the termination of the input in three dimensions within a three-dimensional environment reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, in accordance with the determination that the respective direction is closer to the first reference direction in the environment, and while continuing the movement of the virtual object according to the respective movement model (e.g., inertial movement model), the computer system gradually modifies one or more characteristics of the virtual object other than a location of the virtual object based on the first updated direction such as the orientation of virtual object 1306b changing in response horizontal motion as shown by the orientation of virtual object 1306b in FIG. 13B when comparted to the orientation of virtual object 1306 in FIG. 13A.

In some embodiments, in accordance with the determination that the respective direction is closer to the second reference direction in the environment, and while continuing the movement of the virtual object according to the respective movement model (e.g., inertial movement model), the computer system gradually modifies the one or more characteristics of the virtual object other than the location of the virtual object based on the second updated direction, such as virtual object 1306a being tilted toward the user in FIG. 13E, when compared to the orientation of virtual object 1306a in FIG. 13D. In some embodiments, movement of the virtual object in an environment includes updating one or more visual characteristics of the virtual object based on its location with respect to the viewpoint of the user within the environment. The visual characteristics (described in further detail below) are configured to provide the user of the computer system with a consistent visual representation of the virtual object even if the location of the virtual object is changed. In some embodiments, in order to maintain visual consistency of virtual objects in an environment, the change in visual characteristics based on location is uniform regardless of whether the virtual object is moving according to the inertial movement model or in response to detected user input. In this way, the computer system consistently alters the visual characteristics of the virtual object no matter the source that drives the change in location of the virtual object (e.g., user movement or inertial movement.) In some embodiments, the one or more visual characteristics are gradually modified as the object moves within the environment, with the amount of modification at any given movement based on the current location of the object in the environment at any given instant of time. Changing one or more characteristics of a virtual object based on the location of the virtual object within a three-dimensional environment maintains visibility of the virtual object to the user and/or interactability of the virtual object while it is moving within the environment, thus minimizing the occurrence of erroneous user input and thereby conserving computing resources associated with correcting erroneous input.

In some embodiments, the one or more characteristics of the virtual object include a size of the virtual object such as the size of virtual object 1306b increasing in response to being moved away from user 1308 in FIG. 13K when compared to the size of virtual object 1306b in FIG. 13J. (e.g., relative to the environment in which the virtual object is displayed). In some embodiments, when moving the virtual object towards or away from the viewpoint of the user, the computer system increases or decreases the size of the virtual object based on the direction of movement of the virtual object, as well the magnitude (e.g., amount) of movement of the virtual object away from or towards the viewpoint of the user of the computer system. For instance, if the virtual object is moved away from the viewpoint of user (e.g., the virtual object is moved further back in the environment), then optionally the size of the virtual object is increased. By increasing the size of the object when it is being pushed back in the environment (e.g., away from the viewpoint of the user), even though the object would naturally appear smaller to the user of the computer system since it is moving farther away from the user, the smaller appearance is counteracted by increasing the size of the virtual object as it moves away from the viewpoint of the user thus creating a consistent appearance (in terms of size) even if the object is moved away from the viewpoint of the user. Similarly, as the virtual object is moved closer or towards the viewpoint of the user, the computer system optionally decreases the size of the virtual object to counteract the appearance of the size of the virtual object increasing because it is being moved closer to the viewpoint of the user. Changing the size of the virtual object based on the location of the virtual object within a three-dimensional environment maintains visibility of the virtual object to the user and/or interactability of the virtual object while it is moving within the environment, thus minimizing the occurrence of erroneous user input and thereby conserving computing resources associated with correcting erroneous input.

In some embodiments, the one or more characteristics of the virtual object include an orientation of the virtual object (such as the orientation of virtual object 1306a in FIG. 13J when compared to the orientation of the virtual object in FIG. 13K) (e.g., relative to the viewpoint of the user and/or the environment in which the virtual object is displayed). In some embodiments, when moving the virtual object horizontally (e.g., to the left or right) with respect to the viewpoint of the user, the computer system modifies the orientation of the virtual object (e.g., the direction that the virtual object is facing) to keep the virtual object oriented to the viewpoint of the user. For example, when the computer system moves the virtual object (based on user input or the inertial movement model) to the right, the orientation of the virtual window (e.g., virtual object) is optionally tilted in a first direction towards the viewpoint of the user to keep the orientation of the virtual window directed at the viewpoint of the user, and when the computer system moves the virtual object (based on user input or the inertial movement model) to the left, the orientation of the virtual window (e.g., virtual object) is optionally tilted in a second direction towards the viewpoint of the user to keep the orientation of the virtual window directed at the viewpoint of the user. Changing the size of the virtual object based on the location of the virtual object within a three-dimensional environment maintains visibility of the virtual object to the user and/or interactability of the virtual object while it is moving within the environment, thus minimizing the occurrence of erroneous user input and thereby conserving computing resources associated with correcting erroneous input.

In some embodiments, gradually modifying the one or more characteristics of the virtual object other than the location of the virtual object based on the first updated direction includes: in accordance with a determination that a current location of the virtual object has a first spatial arrangement (e.g., position and/or orientation) relative to a viewpoint of a user of the computer system, the computer system modifies the one or more characteristics of the virtual object in a first manner such as computer system 101 increasing the size of virtual object 1306A in response the user pushing away the virtual object as illustrated in FIG. 13K.

In some embodiments, in accordance with a determination that the current location of the virtual object has a second spatial arrangement (e.g., position and/or orientation), different from the first spatial arrangement, relative to the viewpoint of the user of the computer system, the computer system modifies the one or more characteristics of the virtual object in a second manner, different from the first manner (e.g., the size of virtual object 1306A in FIG. 13K would be larger if the user pushed the virtual object 1306a further back in the environment with respect to the viewpoint of the user). In some embodiments, the amount of modification of the one or more visual characteristics of the virtual object is based on the spatial arrangement of the virtual object relative to the viewpoint of the user of the computer at any given time. For instance, when the computer system moves the virtual object (in response to direct user input or in accordance with the inertial movement model), the computer system also modifies the one or more characteristics such that the change in the visual characteristic is commensurate with the location of the virtual object with respect to the viewpoint of the user. For instance, the size of the virtual object is changed gradually by the computer system when the computer system is moving the virtual object, with an amount of change being based on the amount and/or direction of change in the angular distance of the virtual object between the user's viewpoint and the virtual object. In some embodiments, the amount of tilt (e.g., orientation) is based on the location of the virtual object with respect to the viewpoint of the user at any given time. Thus, when the virtual object is moving horizontally, the orientation of the virtual object is gradually modified to match the location of the virtual object at a given moment with respect to the viewpoint of the user. The above optionally applies as well even if the continued motion of the virtual object is in the second updated direction. Basing changes to one or more characteristics of the virtual object on the location of the virtual object in an environment maintains visibility of the virtual object to the user and/or interactability of the virtual object while it is moving within the environment, thus minimizing the occurrence of erroneous user input and thereby conserving computing resources associated with correcting erroneous input.

In some embodiments, the viewpoint of the user is determined when the termination of the movement while the movement of the first input is in the respective direction is detected (for instance at the time when hand 1303 releases an air pinch gesture such as illustrated in FIG. 13K). In some embodiments, the modification to the one or more characteristics described above are made with respect to the viewpoint of the user at the time that the termination of the movement of the first input is detected. In this way, even if the user changes their viewpoint with respect to the virtual environment after termination of the first input is detected, and while the virtual object is moving according to the inertial movement model, the one or more characteristics will optionally change based on changes to the location of the virtual object with respect to the viewpoint of the user at the time that the movement was terminated, and not the current, changed viewpoint of the user. Basing changes to one or more characteristics of the virtual object on the location of the virtual object in an environment with respect to the viewpoint of the user at the time termination of movement of the virtual object is detected reduces unpredictable changes to the characteristics of the object caused by the user moving their viewpoint within the environment after terminating the input, thus minimizing the occurrence of erroneous user input and thereby conserving computing resources associated with correcting erroneous input.

In some embodiments, the first input is an air gesture (such as an air pinch gesture performed by hand 1303 in FIG. 13A) (e.g., a direct air gesture or an indirect air gesture). In some embodiments, the first input is an air gesture that is detected by the computer system. As described above, an air gesture is a gesture that is detected without the user touching (or independently of) an input element that is part of a device (e.g., computer system 101, one or more input devices 125, and/or hand tracking device 140.) As an example, and as described above, the computer system detects user selection of a virtual object by detecting the user gazing at the virtual object (e.g., by directing their attention to the virtual object) and performing a pinch with their hand. The computer system then detects the movement of the user hand and moves the virtual object in accordance with the movement of the user's hand. In some embodiments, the movement of the user's hand to move the virtual object (after selecting the virtual object) constitutes an air gesture. Enabling the user of the computer system to move virtual objects with air gestures reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

In some embodiments, the virtual object is a window such as window 1306a shown in FIG. 13A. In some embodiments, the virtual object is a content window (e.g., of an application on the computer system) that includes text, graphics, and other content presented on a two-dimensional or three-dimensional surface, optionally oriented toward the viewpoint of the user of the computer system. In some embodiments, the window is displayed in a three-dimensional environment. Presenting content on a content window that can be moved, resized, and otherwise manipulated by a user of the computer system minimizes user error associated with interpreting content, the minimizing the occurrence of erroneous user input and thereby conserving computing resources associated with correcting erroneous input.

In some embodiments, while displaying, via the display generation component, the virtual object, the computer system detects a second input that includes movement. In some embodiments, the second input has one or more characteristics of the first input described above.

In some embodiments, while (and/or in response to) detecting the second input, the computer system moves the virtual object in accordance with the movement of the second input. For example, moving the virtual object in a direction and/or an amount in a three-dimensional environment corresponding to a direction and/or amount of the movement of the second input. In some embodiments, the direction of the movement of the virtual object is the same as the direction of the movement of the second input. In some embodiments, while displaying, via the display generation component, the virtual object moving in accordance with the movement of the second input, the computer system detects, via the one or more input devices, termination of the movement associated with the second input while the movement of the second input is in a respective direction. In some embodiments, the termination of the movement associated with the second input has one or more characteristics of the termination of the movement associated with first input described above. In some embodiments, detecting termination of the movement associated with the first input has one more or characteristics of detecting termination of the movement associated with the first input described above.

In some embodiments, in response to detecting the termination of the second input, and in accordance with a determination that a velocity of the second input is below a velocity threshold, the computer system terminates movement of the virtual object such as in FIG. 13G. In some embodiments, moving the virtual object in accordance with a respective movement model (e.g., inertial movement model) after termination of the input has been detected requires that the input satisfy a velocity criterion associated with the input. For instance, in order to continue moving the virtual object after detecting termination of the input, the computer system determines the velocity of the input (e.g., the rate at which the virtual object was moved by the input) and compares the determined velocity to velocity threshold. In some embodiments, the velocity of the input is determined at the time at (or within some time threshold of) termination of the input. If the determined velocity is below the velocity threshold, then the computer system terminates movement of the virtual object upon detecting termination of the input (e.g., without moving the virtual object according to the respective movement model). In some embodiments, the velocity threshold is configured to simulate the physics of a real-world physical environment. An object in a real-world physical environment moves with inertial motion (e.g., movement after a force causing the movement of object is removed) if the velocity of the movement (e.g., the force) is large enough to overcome the friction of the environment. If the velocity of the input is below the threshold, then in a physical environment, the object will not have enough momentum to sustain the movement after the force (e.g., the input) is terminated. In some embodiments, the velocity threshold is selected from one or more of the following values, 0.5, 1, 2, 5, 10, 25, 50, 75, or 100 cm/s. In some embodiments, the velocity threshold is a value that is at or between the exemplary values provided above. Moving the virtual object with inertial motion only if the input motion exceeds a pre-determined threshold velocity reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

It should be understood that the particular order in which the operations in method 1400 have been described is merely exemplary and is not intended to indicate that the described order is the only order in which the operations could be performed. One of ordinary skill in the art would recognize various ways to reorder the operations described herein.

FIGS. 15A-15J illustrate examples of a computer system facilitating gradual updating of one or more spatial properties of a virtual object in a three-dimensional environment in accordance with some embodiments.

FIG. 15A illustrates a computer system 101 (e.g., an electronic device) displaying, via a display generation component (e.g., display generation component 120 of FIGS. 1 and 3), a three-dimensional environment 1502 from a viewpoint of a user 1526 (e.g., facing the back wall of the physical environment in which computer system 101 is located, as shown in the overhead/top-down view of the three-dimensional environment 1502).

In some embodiments, computer system 101 includes a display generation component 120. In FIG. 15A, the display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to the FIGS. 7, 9, and 11 series.

As shown in FIG. 15A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1502. For example, three-dimensional environment 1502 includes a representation 1522a of a coffee table (e.g., corresponding to representation 1522b in the overhead view), which is optionally a representation of a physical coffee table in the physical environment, and a representation 1124a of a sofa (e.g., corresponding to representation 1524b in the overhead view), which is optionally a representation of a physical sofa in the physical environment.

As discussed in more detail below, in FIG. 15A, display generation component 120 is illustrated as displaying content in the three-dimensional environment 1502. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 15A-15J.

Display generation component 120 has a field of view (e.g., a field of view captured by external image sensors 314b and 314c and/or visible to the user via display generation component 120) that corresponds to the content shown in FIG. 15A. Because display generation component 120 is optionally a head-mounted device, the field of view of display generation component 120 is optionally the same as or similar to the field of view of the user.

As discussed herein, the user 1526 performs one or more air pinch gestures (e.g., with hand 1503A) to provide one or more inputs to computer system 101 to provide one or more user inputs directed to content displayed by computer system 101. Such depiction is intended to be exemplary rather than limiting; the user optionally provides user inputs using different air gestures and/or using other forms of input as described with reference to the FIGS. 7, 9, and 11 series.

In the example of FIG. 15A, because the user's hand is within the field of view of display generation component 120, it is visible within the three-dimensional environment 1502. That is, the user can optionally see, in the three-dimensional environment, any portion of their own body that is within the field of view of display generation component 120.

As mentioned above, the computer system 101 is configured to display content in the three-dimensional environment 1502 using the display generation component 120. In FIG. 15A, three-dimensional environment 1502 also includes a virtual object 1506a (e.g., “Window A,” corresponding to virtual object 1506b in the overhead view). In some embodiments, the virtual object 1506a is optionally a user interface of an application containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 15A, the virtual object 1506a is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 1502, such as the content described below with reference to method 1600. Additionally, in some embodiments, as shown in FIG. 15A, the virtual object 1506a is displayed with an exit option 1508 and a grabber bar 1509. In some embodiments, the exit option 1508 is selectable to initiate a process to cease displaying the virtual object 1506a in the three-dimensional environment 1502. In some embodiments, as discussed below, the grabber bar 1509 is selectable to initiate a process to move the virtual object 1506a within the three-dimensional environment 1502. In some embodiments, as discussed below, the virtual object 1506a is displayed with one or more spatial properties relative to the three-dimensional environment 1502 from a viewpoint of the user 1526.

In some embodiments, virtual objects are displayed in three-dimensional environment 1502 with respective orientations relative to a viewpoint of user 1526 (e.g., prior to receiving input interacting with the virtual objects, which will be described later, in three-dimensional environment 1502). As shown in FIG. 15A, the virtual object 1506a optionally has a first orientation in the three-dimensional environment 1502 (e.g., the front-facing surface of the virtual object 1506a that faces the viewpoint of user 1526 is flat relative to the viewpoint of user 1526). It should be understood that the orientation of the object in FIG. 15A is merely exemplary and that other orientations are possible.

In some embodiments, virtual objects are displayed in three-dimensional environment 1502 with respective sizes relative to a viewpoint of user 1526 (e.g., prior to receiving input interacting with the virtual objects, which will be described later, in three-dimensional environment 1502). As shown in FIG. 15A, the virtual object 1506a optionally has a first size in the three-dimensional environment 1502 (e.g., determined by a width and/or height (e.g., an area) of the two-dimensional front-facing surface of the virtual object 1506a that faces the viewpoint of user 1526). It should be understood that the initial size of the virtual object 1506a in FIG. 15A is merely exemplary and that other sizes are possible (e.g., based on object type, a distance to the virtual object from the viewpoint of the user 1526, and/or a dimensionality of the virtual object).

In some embodiments, virtual objects are displayed in three-dimensional environment 1502 at respective locations relative to the viewpoint of the user 1526 (e.g., prior to receiving input interacting with the virtual objects, which will be described later, in three-dimensional environment 1502). As shown in FIG. 15A, the virtual object 1506a is optionally displayed at a first location in the three-dimensional environment 1502 (e.g., at a rear wall of the physical environment that is visible in the three-dimensional environment 1502, as indicated in the overhead view in FIG. 15A). In some embodiments, the first location of the virtual object 1506a in FIG. 15A is beyond a far-field threshold 1525 (e.g., boundary) from the viewpoint of the user 1526, as indicated in the overhead view. It should be understood that the initial location of the virtual object 1506a in FIG. 15A is merely exemplary and that other locations are possible (e.g., based on object type, prior input directed to the virtual object provided by the user 1526, and/or the application with which the virtual object is associated).

In some embodiments, the computer system 101 facilitates gradual updating of one or more of the spatial properties of the virtual object 1506a discussed above within the three-dimensional environment 1502 based on the viewpoint of the user 1526. Particularly, in some embodiments, the computer system 101 gradually changes the size of the virtual object 1506a, the orientation of the virtual object 1506a, and/or the location of the virtual object 1506a relative to the three-dimensional environment 1502 in response to detecting user input corresponding to selection of the virtual object 1506a within the three-dimensional environment 1502 at least partially based on the current viewpoint of the user 1526, as discussed below. In some embodiments, the computer system 101 gradually updates one or more spatial properties of the virtual object 1506a to enable continuous interaction with (e.g., such as selection of content included in) the virtual object 1506a when the virtual object 1506a is displayed at varying locations from the viewpoint of the user 1526.

In FIG. 15A, the computer system 101 detects an input provided by hand 1503a corresponding to a request to select the virtual object 1506a in the three-dimensional environment 1502. For example, as shown in FIG. 15A, the computer system 101 detects hand 1503a provide an air gesture, such as an air pinch gesture in which an index finger and thumb of the hand of the user come together to make contact, while a gaze 1521 of the user 1526 is directed to the grabber bar 1509 that is displayed with the virtual object 1506a. In some embodiments, as shown in FIG. 15A, the computer system 101 detects the hand 1503a provide the air pinch gesture without detecting movement of the hand 1503a in space. In some embodiments, as mentioned above, the computer system 101 detects the hand 1503a provide the air pinch gesture while the virtual object 1506a is located beyond the far-field threshold 1525 from the viewpoint of the user 1526, as shown in the overhead view in FIG. 15A.

In some embodiments, as shown in FIG. 15B, in response to detecting the selection of the virtual object 1506a, the computer system 101 updates one or more spatial properties of the virtual object 1506a relative to the three-dimensional environment 1502 based on the current viewpoint of the user 1526. For example, as discussed above, when the computer system 101 detects the input provided by the hand 1503a corresponding to selection of the virtual object 1506a, the virtual object 1506a is located beyond the far-field threshold 1525 shown in the overhead view in FIG. 15A. In some embodiments, because the virtual object 1506a is located beyond the far-field threshold 1525, the computer system 101 updates a location of the virtual object 1506a in the three-dimensional environment 1502 in response to detecting the selection of the virtual object 1506a. For example, as shown in the overhead view in FIG. 15B, the computer system 101 shifts the virtual object 1506b forward in the three-dimensional environment 1502, such that the virtual object 1506b is located closer to the viewpoint of the user and within the far-field threshold 1525 shown in FIG. 15A. In some embodiments, the far-field threshold 1525 of FIG. 15A has one or more characteristics of far-field thresholds described with reference to method 1000.

Additionally, in some embodiments, as shown in FIG. 15B, updating the one or more spatial properties of the virtual object 1506a includes updating an orientation of the virtual object 1506a within the three-dimensional environment 1502. For example, as shown in FIG. 15B, in response to detecting the selection of the virtual object 1506a, the computer system 101 tilts and/or rotates the virtual object 1506a (e.g., the front-facing surface of the virtual object 1506a) about a horizontal axis through (e.g., a center of) the virtual object 1506a, such that the front-facing surface of the virtual object 1506a is angled downward and facing toward the viewpoint of the user 1526. In some embodiments, the computer system 101 updates the virtual object 1506a to face toward the viewpoint of the user 1526 based on an angle of elevation of the virtual object 1506a relative to a portion of the user 1526 (e.g., a head of the user 1526), as discussed in detail with reference to method 800.

In some embodiments, as shown in FIG. 15B, updating the one or more spatial properties of the virtual object 1506a includes updating a size of the virtual object 1506a in the three-dimensional environment 1502. For example, as shown in FIG. 15B, in response to detecting the selection of the virtual object 1506a, the computer system 101 scales (e.g., increases or decreases the area of the front-facing surface of) the virtual object 1506a from the viewpoint of the user 1526. In some embodiments, the computer system 101 dynamically scales the virtual object 1506a in the three-dimensional environment 1502 based on a distance between the virtual object 1506a and the viewpoint of the user 1526, as described in detail with reference to method 1200.

In some embodiments, the computer system 101 gradually updates the one or more spatial properties of the virtual object 1506a described above relative to the three-dimensional environment 1502. For example, as indicated in time bar 1507 in FIG. 15B, the computer system 101 updates the location of the virtual object 1506a, the orientation of the virtual object 1506a, and/or the size of the virtual object 1506a based on the viewpoint of the user 1526 over a first time period. In some embodiments, the computer system 101 gradually updates the one or more spatial properties of the virtual object 1506a in the manner(s) discussed above by simulating one or more physical laws of attraction. For example, in response to detecting the selection of the virtual object 1506a in FIG. 15A, the computer system 101 applies a simulated gravitational force, a simulated magnetic force, and/or a simulated spring force (e.g., according to Hooke's law) that causes the virtual object 1506a to gradually move toward the viewpoint of the user 1526, gradually tilt/rotate from the viewpoint of the user 1526, and/or gradually scale from the viewpoint of the user 1526 in the three-dimensional environment 1502. In some embodiments, the one or more simulated physical laws of attraction are based on a simulated mass of the virtual object 1506a, a distance between the virtual object 1506a and the viewpoint of the user 1526 when the input provided by the hand 1503a is detected, and/or a duration of the input provided by the hand 1503a. Additional details regarding the simulation of the one or more physical laws of attraction for causing the one or more spatial properties of the virtual object 1506a to be gradually updated relative to the three-dimensional environment 1502 are provided with reference to method 1600.

In FIG. 15B, the computer system 101 continues detecting the input provided by the hand 1503a discussed above. For example, as shown in FIG. 15B, the computer system 101 continues to detect the hand 1503a provide the air pinch gesture, optionally while the gaze 1521 of the user remains directed toward the grabber bar 1509 in the three-dimensional environment 1502.

In some embodiments, from FIGS. 15B-15C, the computer system 101 completes the updating of the one or more spatial properties of the virtual object 1506a relative to the three-dimensional environment 1502 based on the viewpoint of the user 1526. For example, as indicated in the time bar 1507, the updating of the one or more spatial properties of the virtual object 1506a concludes at time 1514-1 (e.g., “Time 1”). In some embodiments, as similarly discussed above and as shown in FIG. 15C, when the computer system 101 completes the updating of the one or more spatial properties of the virtual object 1506a relative to the three-dimensional environment 1502, the virtual object 1506b is located at an updated location in the three-dimensional environment compared to the previous location in FIG. 15B in the overhead view, the virtual object 1506a is displayed with an updated orientation in the three-dimensional environment compared to the previous orientation illustrated in FIG. 15B, and/or the virtual object 1506a is displayed at an updated size in the three-dimensional environment 1502 from the viewpoint of the user 1526 compared to the previous orientation illustrated in FIG. 15B. For example, as shown in FIG. 15C, the virtual object 1506a is shifted closer toward the viewpoint of the user 1526, as indicated by the placement of the virtual object 1506b in the overhead view, the front-facing surface of the virtual object 1506a is angled downward more to face toward the viewpoint of the user 1526, and/or the virtual object 1506a has a larger size in the three-dimensional environment 1502 from the viewpoint of the user 1526 compared to those shown in FIG. 15B.

In FIG. 15C, the computer system 101 detects movement of the viewpoint of the user 1526 without detecting input (e.g., provided by the hand 1503a) directed to the virtual object 1506a in the three-dimensional environment 1502. For example, as shown in FIG. 15C, the computer system 101 detects the head of the user 1526 on which the computer system 101 is worn shift in a rightward direction. In some embodiments, as similarly discussed above, movement of the viewpoint of the user 1526 causes the portion of the three-dimensional environment 1502, including the physical environment surrounding the display generation component 120, in the field of view of the user 1526, to change in accordance with the movement of the viewpoint.

In some embodiments, as shown in FIG. 15D, in response to detecting the movement of the viewpoint of the user 1526, the computer system 101 updates the portion of the three-dimensional environment 1502 that is in the field of view of the user 1526. For example, as shown in FIG. 15D, because the computer system 101, including the display generation component 120, is shifted rightward in the physical environment relative to the three-dimensional environment 1502, the virtual object 1506a, the representation 1522a of the coffee table and the representation 1524a of the sofa are shifted leftward in the field of view of the user 1526 in accordance with the movement of the viewpoint. In some embodiments, in response to detecting the movement of the viewpoint of the user 1526, the computer system 101 forgoes updating one or more of the spatial properties of the virtual object 1506a relative to the three-dimensional environment 1502 based on the updated viewpoint of the user 1526. For example, as shown in FIG. 15D, the computer system 101 forgoes gradually updating the location, size, and/or orientation of the virtual object 1506a based on the updated viewpoint of the user 1526 in the manner(s) discussed above.

In FIG. 15D, after the viewpoint of the user 1526 is updated, the computer system 101 detects an input provided by hand 1503b corresponding to selection of the virtual object 1506a. For example, the computer system 101 detects the hand 1503b provide an air pinch gesture while the gaze 1521 is directed to the grabber bar 1509 that is displayed with the virtual object 1506a.

In some embodiments, as shown in FIG. 15E, in response to detecting the input provided by the hand 1503b directed to the virtual object 1506a, the computer system 101 gradually updates one or more spatial properties of the virtual object 1506a relative to the three-dimensional environment 1502 based on the updated viewpoint of the user 1526. For example, as shown in FIG. 15E, the computer system 101 gradually shifts the virtual object 1506a upward in the three-dimensional environment 1502 toward the updated viewpoint of the user 1526, as represented by the updated location of the virtual object 1506b in the overhead view, rotates/tilts the virtual object 1506a (e.g., about a vertical axis through (e.g., a center of) the virtual object 1506a) in the three-dimensional environment 1502, and/or updates the size of the virtual object 1506a (e.g., decreases the size of the virtual object 1506a), as represented by the tilting of the virtual object 1506b in the overhead view. In some embodiments, as discussed previously above, the computer system 101 gradually updates the one or more spatial properties of the virtual object 1506a by applying one or more simulated physical laws of attraction to the virtual object 1506a. Based on the simulated physical laws of attraction, a “target” location, a target orientation, and/or a target size of the virtual object 1506a are determined, which are collectively represented by first target 1506B-i in the overhead view in FIG. 15E. For example, the virtual object 1506a will be displayed at the location, at the size, and/or with the orientation indicated by the first target 1506B-i in the overhead view when a time period corresponding to time 1514-2 (e.g., “Time 2”) in the time bar 1507 elapses.

In FIG. 15E, before the one or more spatial properties discussed above are completely updated (e.g., before the time 1514-2 elapses and before the virtual object 1506a reaches the first target 1506B-i indicated in the overhead view), the computer system 101 detects an input provided by hand 1503c corresponding to a request to move the virtual object 1506a within the three-dimensional environment 1502. For example, the computer system 101 detects an air pinch and drag gesture in which, while the hand is in the pinch hand shape, the hand 1503c moves rightward in space, optionally while the gaze 1521 of the user is directed to the grabber bar 1509 that is displayed with the virtual object 1506a in the three-dimensional environment 1502.

In some embodiments, as shown in FIG. 15F, in response to detecting the movement input provided by the hand 1503c before the one or more spatial properties are fully updated based on the updated viewpoint of the user 1526 in FIG. 15E, the computer system 101 determines an updated target for the one or more spatial properties of the virtual object 1506a that are based on the movement of the hand 1503c. For example, as shown in FIG. 15F, the computer system 101 determines second target 1506B-ii (e.g., corresponding to a second target location, a second target orientation, and/or a second target size) for the virtual object 1506a that is based on the movement of the hand 1503c (e.g., and is no longer based solely on the current viewpoint of the user 1526). As shown in the overhead view in FIG. 15F, the second target 1506B-ii is optionally different from the first target 1506B-i discussed above.

In some embodiments, when the computer system 101 detects the input provided by the hand 1503c for moving the virtual object 1506a within the three-dimensional environment 1502, the computer system 101 continues to, temporarily, as indicated by time bar 1507, progress the updating of the one or more spatial properties of the virtual object 1506a toward the first target 1506B-i in the overhead view. For example, as shown in FIG. 15F, the computer system 101 updates the location at which the virtual object 1506a is displayed in the three-dimensional environment 1502, the size at which the virtual object 1506a is displayed, and/or the orientation with which the virtual object 1506a is displayed based on a simulation of one or more physical laws of attraction produced by the movement of the hand 1503c (e.g., a gravitational force, a magnetic force, and/or a spring force exerted (e.g., pulling) on the virtual object 1506a), as similarly discussed above.

In some embodiments, the computer system 101 alternatively applies a simulated inertial movement model to the virtual object 1506a, rather than a physical law of attraction as described above, to gradually update the one or more spatial properties of the virtual object 1506a relative to the three-dimensional environment 1502. In some embodiments, the inertial movement model is based on a magnitude of the movement of the hand 1703c (e.g., a velocity, acceleration, and/or distance of the movement of the hand 1703c), a direction of the movement of the hand (e.g., the rightward movement of the hand 1703c as shown), and/or a simulated mass of the virtual object 1506a. Accordingly, in some embodiments, in response to detecting the initial movement of the hand 1503c from FIGS. 15E-15F while the hand 1503c maintains the pinch hand shape, the virtual object 1506a continues to move (e.g., with simulated inertia) toward the target location specified by the first target 1506B-i (e.g., as well as continues to rotate and/or continues to scale as defined by the first target 1506B-i) in the overhead view. Additional details regarding the simulated inertial movement model are provided below with reference to method 1400.

In FIG. 15F, the computer system 101 detects continued movement of the hand 1503c in space (e.g., while the hand maintains the pinch hand shape and while the gaze 1521 remains directed to the grabber bar 1509 that is displayed with the virtual object 1506a). In some embodiments, the continuation of the movement of the hand 1503c in FIG. 15F is detected without detecting a release of the pinch hand shape detected in FIG. 15E. As similarly discussed above with reference to FIG. 15E, the computer system 101 detects the continued movement of the hand 1503c before the one or more spatial properties discussed above are completely updated (e.g., before the virtual object 1506a reaches the first target 1506B-i indicated in the overhead view).

In some embodiments, as shown in FIG. 15G, in response to detecting the continuation of the movement input provided by the hand 1503c (e.g., and before the one or more spatial properties are fully updated based on the updated viewpoint of the user 1526 in FIG. 15F), the computer system 101 determines an updated target for the one or more spatial properties of the virtual object 1506a that are based on the subsequent movement of the hand 1503c. For example, as shown in FIG. 15G, the computer system 101 determines third target 1506B-iii (e.g., corresponding to a third target location, a third target orientation, and/or a third target size) for the virtual object 1506a that is based on the continued movement of the hand 1503c (e.g., and is not based solely on the current viewpoint of the user 1526). As shown in the overhead view in FIG. 15G, the third target 1506B-iii is optionally different from the second target 1506B-ii and the first target 1506B-i discussed above.

Accordingly, in some embodiments, as shown in FIG. 15G, as the computer system 101 continues to detect the movement of the hand 1503c in space while maintaining the pinch hand shape, the computer system 101 continues to gradually update the one or more spatial properties of the virtual object 1506a relative to the three-dimensional environment 1502, as indicated by the time bar 1507. As indicated in the overhead view in FIG. 15G, the one or more spatial properties of the virtual object 1506b are “catching up” to those defined by the second target 1506B-ii in the overhead view in FIG. 15F. As similarly described above, in some embodiments, the computer system 101 continues to gradually update the one or more spatial properties (e.g., location, size, and/or orientation) of the virtual object 1506a by simulating one or more physical laws of attraction and/or by simulating inertia.

In FIG. 15G, the computer system 101 detects a termination of the input provided by the hand 1503d. For example, the computer system 101 detects the hand 1503d release the air pinch gesture (e.g., such that the index finger and thumb are no longer in contact) and/or detects that the hand 1503d is no longer moving in space (e.g., and/or is rested beside the user's torso outside of the field of view of the user 1526). In some embodiments, the computer system 101 detects the termination of the input while the virtual object 1506b is catching up to the one or more target spatial properties defined by the second target 1506B-ii discussed above.

In some embodiments, when the computer system 101 detects the termination of the input provided by the hand 1503d, the computer system 101 forgoes defining any new target spatial properties for the virtual object 1506a. For example, when the computer system 101 detects the termination of the input in FIG. 15G, the computer system 101 establishes the third target 1506B-iii in the overhead view as the final target for the one or more spatial properties of the virtual object 1506b. Accordingly, in some embodiments, as shown in FIG. 15H, the computer system 101 continues to update the one or more spatial properties of the virtual object 1506a relative to the three-dimensional environment 1502 until the virtual object 1506a possesses the target spatial properties defined by the third target 1506B-iii in the overhead view, as indicated by the progression of the time bar 1507 toward time 1514-3 (e.g., “Time 3”) corresponding to a time period over which the virtual object 1506a is updated to have the one or more spatial properties defined by the third target 1506B-iii. For example, as shown in the overhead view in FIG. 15H, the virtual object 1506b progresses toward being located at a location in the three-dimensional environment 1502, having an orientation in the three-dimensional environment 1502, and/or having a size in the three-dimensional environment 1502 that corresponds to those defined by the third target 1506B-iii in the overhead view. As similarly described above, in some embodiments, the computer system 101 continues to gradually update the one or more spatial properties (e.g., location, size, and/or orientation) of the virtual object 1506a by simulating one or more physical laws of attraction and/or by simulating inertia.

From FIGS. 15H-15I, the computer system 101 continues to gradually update the one or more spatial properties of the virtual object 1506a relative to the three-dimensional environment 1502, as indicated by the progression of the time bar 1507. As shown in FIG. 15I, when the time period indicated by the time 1514-3 elapses, the virtual object 1506a possesses the one or more spatial properties defined by the third target 1506B-iii shown in the overhead view in FIG. 15H. Particularly, as shown in FIG. 15I, the virtual object 1506a is displayed at a location in the three-dimensional environment 1502, with an orientation, and/or with a size in the three-dimensional environment 1502 in accordance with the input provided by the hand 1503c above and based on the current viewpoint of the user 1526.

In FIG. 15I, the computer system 101 detects the hand 1503e provide an input directed to the virtual object 1506a corresponding to a request to move the virtual object 1506a within the three-dimensional environment 1502. For example, as shown in FIG. 15I, the computer system 101 detects the hand 1503e provide an air pinch and drag gesture, as similarly discussed above, while the gaze 1521 of the user is directed toward the grabber bar 1509 that is displayed with the virtual object 1506a in the three-dimensional environment 1502.

In some embodiments, in accordance with a determination that the movement of the virtual object 1506a includes movement (e.g., of the hand 1503e) with a respective velocity that is greater than a movement threshold (e.g., greater than 10 m/s and/or other values provided below in method 1600), the computer system 101 moves the virtual object 1506a in accordance with the movement of the hand (e.g., based on a direction and/or magnitude of the movement of the hand 1503e), optionally without applying simulated physical laws of attraction or simulated inertia. In some embodiments, in accordance with the determination that the movement of the virtual object 1506a includes movement with a respective velocity that is greater than the movement threshold, the computer system 101 still applies simulated physical laws of attraction or the simulated inertia, but does so with reduced application (e.g., over a shortened time period).

From FIGS. 15I-15J, the computer system 101 determines that the movement of the hand 1503e corresponds to movement of the virtual object 1506a with a respective velocity (e.g., velocity 1542 in plot 1540) that is greater than the movement threshold discussed above, which is represented by threshold 1544 in the plot 1540. Accordingly, as shown in FIG. 15J, in some embodiments, in response to detecting the input provided by the hand 1503e that includes movement with a respective velocity that is greater than the movement threshold, the computer system 101 moves the virtual object 1506a in the three-dimensional environment 1502 in accordance with the movement of the hand 1503e. For example, as shown in FIG. 15J, the computer system 101 moves the virtual object 1506a leftward relative to the viewpoint of the user 1526 with a respective magnitude that is based on the magnitude (e.g., speed, distance, and/or duration) of the movement of the hand 1503e. In some embodiments, as mentioned above, the computer system 101 moves the virtual object 1506a without applying one or more simulated physical laws of attraction or simulated inertia to cause the movement of the virtual object 1506a to be more gradual, rather than instantaneous (e.g., 1:1 movement of the virtual object 1506a to the movement of the hand 1503e). Alternatively, in some embodiments, as mentioned above, the computer system 101 moves the virtual object 1506a in the three-dimensional environment 1502 and applies one or more simulated laws of attraction or simulated inertia to cause the movement of the virtual object 1506a to be gradual, but with a reduced application, such that the time period over which the virtual object 1506a is moved is shorter than compared to other movements with lower velocities, as indicated by time 1514-4 (e.g., “Time 4”).

FIG. 16 is a flowchart illustrating a method of facilitating gradual updating of one or more spatial properties of a virtual object in a three-dimensional environment in accordance with some embodiments. In some embodiments, the method 1600 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments, the method 1600 is performed at a computer system in communication with a display generation component and one or more input devices. For example, the computer system is or includes a mobile device (e.g., a tablet, a smartphone, a media player, or a wearable device), or a computer. In some embodiments, the computer system has one or more characteristics of the computer system in methods 800, 1000, 1200, 1400, and/or 1800. In some embodiments, the display generation component has one or more characteristics of the display generation component in methods 800, 1000, 1200, 1400, and/or 1800. In some embodiments, the one or more input devices have one or more characteristics of the one or more input devices in methods 800, 1000, 1200, 1400, and/or 1800.

In some embodiments, while displaying, via the display generation component, an object (e.g., a virtual object) in an environment (e.g., a three-dimensional environment), such as virtual object 1506a in three-dimensional environment 1502 in FIG. 15A, wherein the object is displayed with one or more first spatial properties (e.g., position, orientation, and/or size) relative to the environment, the computer system detects (1602a), via the one or more input devices, a first input corresponding to selection of the object, such as an air gesture performed by hand 1503a in FIG. 15A. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment, etc.). In some embodiments, the environment has one or more characteristics of the environments in methods 800, 1000, 1200, 1400, and/or 1800. In some embodiments, the object is generated by the computer system and/or is or includes content. In some embodiments, the object has one or more characteristics of the objects in methods 800, 1000, 1200, 1400, and/or 1800. In some embodiments, displaying the object with the one or more first spatial properties relative to the environment includes displaying the object at a first location in the three-dimensional environment (e.g., relative to a viewpoint of a user of the computer system). In some embodiments, displaying the object with the one or more first spatial properties relative to the environment includes displaying the object with a first orientation in the three-dimensional environment. For example, if the object corresponds to a virtual application window, the computer system displays the front-facing surface of the virtual application window with a first angle, a first amount of curvature, and/or a first amount of tilt relative to the viewpoint of the user. In some embodiments, displaying the object with the one or more first spatial properties relative to the environment includes displaying the object at a first size (e.g., width, length, radius, volume, and/or surface area) in the three-dimensional environment. In some embodiments, detecting the first input includes detecting an air pinch gesture performed by a hand of the user of the computer system-such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the computer system while attention (e.g., including gaze) of the user is directed toward the virtual object. In some embodiments, the computer system detects the input via a hardware input device (e.g., a controller operable with six degrees of freedom of movement, or a touchpad or mouse) in communication with the computer system. In some embodiments, the first input includes and/or is followed by movement of the hand of the user that corresponds to a request to move the virtual object in the three-dimensional environment, as discussed in more detail below. For example, the computer system detects a press or touch of a physical button of the hardware input device provided by a finger of the hand of the user. In some embodiments, the first input has one or more characteristics of the inputs in methods 800, 1000, 1200, 1400, and/or 1800.

In some embodiments, in response to detecting the first input (1602b), in accordance with a determination that the object is at a first location (e.g., at a first distance from a viewpoint of the user, where the first location is optionally at a first orientation relative to the viewpoint of the user) in the environment relative to a viewpoint of a user of the computer system when the first input is detected (e.g., and irrespective of a location of the gaze of the user in the three-dimensional environment), such as the location of the virtual object 1506b in the overhead view in FIG. 15A, the computer system updates (1602c) display, via the display generation component, of the object to have one or more second spatial properties relative to the environment, different from the one or more first spatial properties, such as moving the virtual object 1506b and/or changing an orientation of the virtual object 1506b from FIGS. 15A-15C, wherein the object is updated from having the one or more first spatial properties to having the one or more second spatial properties over a first time period (e.g., time 1514-1 in time bar 1507 in FIG. 15C) that is greater than zero (e.g., a predetermined time period, a time period that is based on a duration of the first input (e.g., equal to or proportional to the duration of the first input), a time period that is based on one or more simulated laws of physics, and/or a time period that is based on a simulated physical property of the movement of the virtual object (e.g., an inertia of the movement)). For example, the computer system gradually updates the virtual object to have the one or more second spatial properties in the three-dimensional environment in response to detecting the first input (which optionally corresponds to movement of the virtual object to an updated location that is different from the first location in the three-dimensional environment). In some embodiments, updating the virtual object to have the one or more second spatial properties relative to the environment includes displaying the virtual object at a second location (optionally different from the first location) in the three-dimensional environment relative to the viewpoint of the user, with a second orientation (optionally different from the first orientation) relative to the viewpoint of the user, and/or at a second size (optionally different from the first size) relative to the viewpoint of the user. In some embodiments, as described in more detail below, if the first input causes the virtual object to be positioned at a subsequent new position in the three-dimensional environment relative to the viewpoint of the user, the computer system updates display of the virtual object to have one or more third spatial properties, different from the one or more second spatial properties, relative to the three-dimensional environment.

In some embodiments, in accordance with a determination that the object is at a second location (e.g., at a second distance from the viewpoint of the user, where the second location is optionally at a second orientation relative to the viewpoint of the user), different from the first location, in the environment relative to the viewpoint of the user when the first input is detected, such as the location of the virtual object 1506b in the overhead view in FIG. 15D, the computer system updates (1602d) display of the object to have one or more third spatial properties, different from the one or more first spatial properties and the one or more second spatial properties, relative to the environment, such as moving the virtual object 1506a and/or changing an orientation of the virtual object 1506a as shown in FIG. 15E, wherein the object is updated from having the one or more first spatial properties to having the one or more third spatial properties over a second time period (e.g., time 1514-2 in the time bar 1507 in FIG. 15E) that is greater than zero (e.g., a time period that is the same as the first time period or a time period that is different from the first time period). In some embodiments, the computer system gradually updates the virtual object to have the one or more third spatial properties in the three-dimensional environment in response to detecting the first input. In some embodiments, displaying the virtual object with the one or more third spatial properties is performed in a similar fashion as displaying the virtual object with the one or more second spatial properties described above. Thus, as discussed above, the computer system optionally updates one or more spatial properties of the virtual object relative to the three-dimensional environment based on a location of the virtual object relative to the viewpoint of the user in response to detecting an input that includes selection of the virtual object. Gradually updating one or more spatial properties of an object in a three-dimensional environment based on a location of the object relative to a viewpoint of the user in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, updating the object from having the one or more first spatial properties to having the one or more third spatial properties over the first time period is based on one or more first simulated physical properties, as similarly described with reference to FIG. 15C. In some embodiments, the one or more first simulated physical properties include a first simulated inertia of the object and/or a first simulated law of attraction, as described in more detail below. In some embodiments, the one or more first simulated physical properties are based on the location of the object in the three-dimensional environment when the first input is detected. For example, the first time period discussed above corresponds to an amount of time that elapses for the object to be displayed with the one or more second spatial properties according to the one or more first simulated physical properties.

In some embodiments, updating the object from having the one or more first spatial properties to having the one or more third spatial properties over the second time period is based on one or more second simulated physical properties (e.g., as similarly described above with reference to the one or more first simulated physical properties but specific to the one or more second simulated physical properties), as similarly described with reference to FIG. 15G. In some embodiments, the one or more first simulated physical properties are the same as or similar to the one or more second simulated physical properties but specific to the relationship between the viewpoint of the user and the second location in the three-dimensional environment. Gradually updating one or more spatial properties of an object in a three-dimensional environment based on a location of the object relative to a viewpoint of the user according to one or more simulated physical properties in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the one or more first simulated physical properties include a first simulated inertial characteristic, as similarly described with reference to FIG. 15C. As described above with reference to step(s) 1602, displaying the object with the one or more first spatial properties includes updating a location at which the object is displayed (e.g., moving the object within the three-dimensional environment), updating a size at which the object is displayed, and/or updating an orientation with which the object is displayed relative to the viewpoint of the user. In some embodiments, if the computer system is at the first location (and/or is displayed at the first size and/or with the first orientation as discussed above) in the environment when the first input is detected, the computer system displays the object at (e.g., moves the object to) a first updated location (and/or displays the object at a first updated size and/or with a first updated orientation) in the environment gradually according to the first simulated inertial characteristic (e.g., rather than instantaneously updating display of the object). For example, the first simulated inertial characteristic simulates friction that a moving object would encounter in a real-world environment (e.g., as if the object has a simulated mass) that causes the one or more simulated physical properties of the object to be gradually updated. In some embodiments, different objects have different simulated masses (e.g., based on a size of the objects). For example, a first object that has a first size in the three-dimensional environment (e.g., a relatively small size) has a first simulated mass and a second object that has a second size, larger than the first size, in the three-dimensional environment (e.g., a relatively large size) has a second simulated mass, greater than the first simulated mass. Alternatively, in some embodiments, different objects have the same simulated mass. In some embodiments, the first simulated inertial characteristic is determined based on a distance between the object (e.g., at the first location in the three-dimensional environment) and the viewpoint of the user when the first input is detected, a direction of the viewpoint of the user relative to the object in the three-dimensional environment when the first input is detected, and/or if the first input includes movement of the object, a velocity, direction, and/or distance of the movement of the object. Accordingly, the first simulated inertial characteristic causes the transition from displaying the object with the one or more first spatial characteristics relative to the environment to displaying the object with the one or more second spatial characteristics to occur over the first time period discussed above. In some embodiments, the first simulated inertial characteristic has one or more characteristics of the inertial movement model described in method 1400.

In some embodiments, the one or more second simulated physical properties include a second simulated inertial characteristic (e.g., as similarly described above with reference to the first simulated inertial characteristic but specific to the second simulated inertial characteristic), as similarly described with reference to FIG. 15G In some embodiments, the second simulated inertia has a different value from or the same value as the first simulated inertia based on a difference in distance between the first location and the viewpoint of the user and distance between the second location and the viewpoint of the user. Gradually updating one or more spatial properties of an object in a three-dimensional environment based on a location of the object relative to a viewpoint of the user according to simulated inertia in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the one or more first simulated physical properties include a first simulated law of attraction (e.g., non-linear physical attraction), as similarly described with reference to FIG. 15C. For example, the first simulated law of attraction corresponds to simulated gravity, simulated magnetism, and/or simulated spring physics (e.g., Hooke's Law). As described above with reference to step(s) 1602, displaying the object with the one or more first spatial properties includes updating a location at which the object is displayed (e.g., moving the object within the three-dimensional environment), updating a size at which the object is displayed, and/or updating an orientation with which the object is displayed relative to the viewpoint of the user. In some embodiments, if the computer system is at the first location (and/or is displayed at the first size and/or with the first orientation as discussed above) in the environment when the first input is detected, the computer system displays the object at (e.g., moves the object to) a first updated location (and/or displays the object at a first updated size and/or with a first updated orientation) in the environment gradually according to the first simulated law of attraction (e.g., rather than instantaneously updating display of the object). In some embodiments, the first simulated law of attraction is determined based on a simulated mass of the object (e.g., based on the size of the object in the three-dimensional environment), a distance between the object (e.g., at the first location in the three-dimensional environment) and the viewpoint of the user when the first input is detected, a direction of the viewpoint of the user relative to the object in the three-dimensional environment when the first input is detected, and/or if the first input includes movement of the object, an acceleration, direction, and/or distance of the movement of the object. For example, objects having different simulated masses experience the first simulated law of attraction differently. As an example, a first object having a higher simulated mass than a second object will experience a greater gravitational force than the second object. Accordingly, the first simulated law of attraction causes the transition from displaying the object with the one or more first spatial characteristics relative to the environment to displaying the object with the one or more second spatial characteristics to occur over the first time period discussed above.

In some embodiments, the one or more second simulated physical properties include a second simulated law of attraction (e.g., as similarly described above with reference to the first simulated law of attraction but specific to the second simulated law of attraction), as similarly described with reference to FIG. 15E. In some embodiments, the second simulated law of attraction is different from or the same as the first simulated law of attraction. Gradually updating one or more spatial properties of an object in a three-dimensional environment based on a location of the object relative to a viewpoint of the user according to simulated a simulated law of attraction in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the computer system detects, via the one or more input devices, a second input corresponding to a request to move the object to a third location, different from the first location and the second location, in the environment relative to the viewpoint of the user, such as input provided by hand 1503c as shown in FIG. 15F. For example, the computer system detects an input that has one or more characteristics of the first input discussed above. In some embodiments, the second input includes movement of the hand of the user corresponding to a request to move the object to the third location in the three-dimensional environment. In some embodiments, the computer system detects the movement of the hand of the user while the hand is engaged in an air pinch gesture or is engaging a hardware input device (e.g., a controller or trackpad).

In some embodiments, in response to detecting the second input, in accordance with a determination that the second input is detected after detecting the first input and before the display of the object is updated to have the one or more second spatial properties or the one or more third spatial properties (e.g., the second input is detected before termination of the first input, optionally as a continuation of the first input and/or during the first input), such as before the virtual object 1506b catches up to first target 1506B-i in the overhead view in FIG. 15F, the computer system updates display of the object to have one or more fourth spatial properties, different from the one or more second spatial properties and the one or more third spatial properties, relative to the third location in the environment using a first spatial property translation in accordance with the second input, such as movement of the virtual object 1506a as shown in FIG. 15G. For example, the computer system changes the one or more spatial properties of the object using a first spatial property translation that is based on one or more simulated physical properties, as discussed in more detail below. Accordingly, the computer system updates display of the object to have the one or more fourth spatial properties and does not update display of the object to have the one or more second spatial properties or the one or more third spatial properties discussed above.

In some embodiments, in accordance with a determination that the second input is detected after detecting the first input and after the display of the object is updated to have the one or more second spatial properties or the one or more third spatial properties (e.g., the second input is detected after termination of the first input or while the first input is ongoing but after the display of the object is updated to have the one or more second spatial properties or the one or more third spatial properties), such as input provided by hand 1503e as shown in FIG. 15I, the computer system updates display of the object to have one or more fifth spatial properties, different form the one or more fourth spatial properties, relative to the third location in the environment using a second spatial property translation (e.g., different from the first spatial property translation) in accordance with the second input, such as movement of the virtual object 1506a as shown in FIG. 15J. For example, the computer system changes the one or more spatial properties of the object using a second spatial property translation that is not based on the one or more simulated physical properties. Rather, as discussed in more detail below, the second spatial property translation is based on one or more aspects of the second input itself. Accordingly, a time period over which the object is updated to having the one or more fourth spatial properties above is different from a time period over which the object is updated to having the one or more fifth spatial properties. Updating one or more spatial properties of an object in a three-dimensional environment in response to detecting input moving the object according to a particular spatial property translation that is selected based on whether the input is detected during or after prior input directed to the object enables the object to automatically remain visibly displayed in the user's field of view during the subsequent movement of the object, which allows the user to continue to interact with the object, and/or helps avoid or reduce delays in the updating of the one or more spatial properties of the object based on the movement of the object, thereby improving user-device interaction.

In some embodiments, the first spatial property translation is based on one or more simulated physical properties (e.g., having one or more characteristics of the first simulated physical properties and/or the second simulated physical properties discussed above), as similarly described with reference to FIGS. 15F-15H. For example, the computer system gradually updates the one or more spatial properties of the object relative to the third location using simulated inertia or simulated laws of physics (e.g., gravity, magnetism, Hooke's Law, and the like), as similarly discussed above. In some embodiments, the computer system updates the one or more simulated physical properties that were previously being applied in response to detecting the first input when the computer system detects the second input. For example, the one or more simulated physical properties are redetermined to be relative to the third location in the three-dimensional environment rather than relative to the first location or the second location discussed above.

In some embodiments, the second spatial property translation is not based on the one or more simulated physical properties, as similarly described with reference to FIG. 15J. For example, if the computer system detects the second input after the first input has terminated (e.g., the user has released the air pinch gesture or is no longer engaging the hardware input device), the computer system forgoes gradually updating the one or more spatial properties of the object (e.g., based on simulated inertia or simulated physics laws as discussed above). Rather, in some embodiments, the computer system updates the one or more spatial properties of the object (e.g., the location of the object in the three-dimensional environment, the size of the object in the three-dimensional environment, and/or the orientation of the object in the three-dimensional environment) based on the movement input. For example, the computer system updates the object to have the one or more fifth spatial properties over a time period that is determined based on one or more aspects of the second input, such as the duration of the movement of the hand of the user, a velocity of the movement of the hand of the user, and/or a direction of the movement of the hand of the user in space. Accordingly, a delay in displaying the object with the one or more second spatial properties, if any, is based on the one or more aspects of the input itself rather than the one or more simulated physical properties discussed above. Updating one or more spatial properties of an object in a three-dimensional environment in response to detecting input moving the object according to a particular spatial property translation that is selected based on whether the input is detected during or after prior input directed to the object enables the object to automatically remain visibly displayed in the user's field of view during the subsequent movement of the object, which allows the user to continue to interact with the object, and/or helps avoid or reduce delays in the updating of the one or more spatial properties of the object based on the movement of the object, thereby improving user-device interaction.

In some embodiments, the one or more first spatial properties relative to the environment include a respective location of the object in the environment relative to the viewpoint of the user (e.g., before detecting the first input described above), such as the location of the virtual object 1506a in FIG. 15A, Accordingly, as similarly discussed above, in response to detecting the first input, updating the one or more spatial properties of the object relative to the environment includes displaying the object at an updated location in the three-dimensional environment (e.g., moving the object from the respective location to the updated location in the three-dimensional environment relative to the viewpoint of the user). In some embodiments, the movement of the object gradually occurs as previously discussed above. Gradually updating a location of an object in a three-dimensional environment based on a location of the object relative to a viewpoint of the user in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the one or more first spatial properties relative to the environment include a respective size of the object in the environment relative to the viewpoint of the user (e.g., before detecting the first input described above), such as the size of the virtual object 1506a in FIG. 15A. Accordingly, as similarly discussed above, in response to detecting the first input, updating the one or more spatial properties of the object relative to the environment includes displaying the object at an updated size in the three-dimensional environment (e.g., increasing the size and/or volume of the object or decreasing the size and/or volume of the object relative to the viewpoint of the user). In some embodiments, the scaling of the object gradually occurs as previously discussed above. Gradually updating a size of an object in a three-dimensional environment based on a location of the object relative to a viewpoint of the user in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the one or more first spatial properties relative to the environment include a respective orientation of the object in the environment relative to the viewpoint of the user (e.g., before detecting the first input described above), such as the orientation of the virtual object 1506a in FIG. 15A. Accordingly, as similarly discussed above, in response to detecting the first input, updating the one or more spatial properties of the object relative to the environment includes displaying the object with an updated orientation in the three-dimensional environment (e.g., tilting and/or rotating the object about a horizontal axis through the (e.g., center of the) object and/or about a vertical axis through the (e.g., center of the) object) in the three-dimensional environment relative to the viewpoint of the user). In some embodiments, the reorientation of the object gradually occurs as previously discussed above. Gradually updating an orientation of an object in a three-dimensional environment based on a location of the object relative to a viewpoint of the user in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, after updating display of the object to have the one or more second spatial properties or the one or more third spatial properties relative to the environment in response to detecting the first input (e.g., and before detecting termination of the first input), the computer system detects, via the one or more input devices, a second input corresponding to movement of the object relative to the viewpoint of the user, such as the input provided by the hand 1503e directed to the virtual object 1506a as shown in FIG. 15I. In some embodiments, the second input corresponds to a continuation of the first input described above. In some embodiments, the second input has one or more characteristics of the first input.

In some embodiments, in response to detecting the second input, the computer system updates display of the object to have one or more fourth spatial properties, different from the one or more second spatial properties and the one or more third spatial properties, relative to the environment, such as moving the virtual object 1506a as shown in FIG. 15J, wherein the object is updated from having the one or more second spatial properties or the one or more third spatial properties to having the one or more fourth spatial properties over a third time period (e.g., time 1514-4 in time bar 1507 in FIG. 15J) that is greater than zero (e.g., different from or the same as the first time period and/or the second time period). For example, because the second input causes the location of the object to change relative to the viewpoint of the user, the computer system gradually updates the one or more spatial properties of the object relative to the updated location of the object in the three-dimensional environment. In some embodiments, as similarly discussed above, the third time period is based on updating the one or more spatial properties of the object using simulated inertia or simulated physics laws. Gradually updating one or more spatial properties of an object in a three-dimensional environment based on a location of the object relative to a viewpoint of the user in response to detecting an input that includes selection of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the second input corresponds to movement of the object within the environment, as similarly described with reference to FIG. 15I. For example, after detecting the first input discussed above, and optionally without detecting termination of the first input, the computer system detects movement of the hand of the user in space. In some embodiments, the computer system detects the movement of the hand of the user while the hand remains engaged in the air pinch gesture (e.g., the index finger and thumb of the hand remain in contact) and/or while the hand of the user remains in contact with a physical input device (e.g., a controller or trackpad). In some embodiments, the second input causes the computer system to move the object within the three-dimensional environment, which causes the location of the object relative to the viewpoint of the user to change accordingly. Gradually updating one or more spatial properties of an object in a three-dimensional environment based on a location of the object relative to a viewpoint of the user in response to detecting an input corresponding to movement of the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the second input includes movement of the viewpoint of the user relative to the environment (and/or the location of the object within the environment), such as movement of the viewpoint as shown in FIG. 15C. For example, after detecting the first input discussed above, and optionally without detecting termination of the first input, the computer system detects movement of the hand or head of the user that causes the display generation component to move in a physical environment of the computer system. In some embodiments, the computer system detects the movement of the viewpoint of the user while the hand remains engaged in the air pinch gesture (e.g., the index finger and thumb of the hand remain in contact) and/or while the hand of the user remains in contact with a physical input device (e.g., a controller or trackpad). In some embodiments, the second input causes the viewpoint of the user move (e.g., shift and/or rotate) relative to the object in the three-dimensional environment, which causes the location of the object relative to the updated viewpoint of the user to change accordingly. Gradually updating one or more spatial properties of an object in a three-dimensional environment based on a location of the object relative to a viewpoint of the user in response to detecting an input that includes movement of the viewpoint of the user enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, while the first input is not being detected (e.g., before the first input is detected or after an end/conclusion of the first input), the computer system detects, via the one or more input devices, a second input corresponding to movement of the viewpoint of the user relative to the environment (e.g., a change in position of the viewpoint relative to the object in the three-dimensional environment), such as movement of the viewpoint as shown in FIG. 15C. For example, the computer system detects movement of a portion of the user (e.g., a hand of the user or the head of the user) that causes the display generation component to be moved in a physical environment of the computer system. In some embodiments, the movement of the viewpoint of the user includes translation of the viewpoint and/or rotation of the viewpoint relative to the object in the three-dimensional environment. In some embodiments, the computer system detects the movement of the viewpoint without detecting user input selecting or otherwise interacting with the object in the three-dimensional environment, such as an air pinch gesture.

In some embodiments, in response to detecting the first input, the computer system forgoes updating display of one or more spatial properties of the object relative to the environment, such as forgoing moving the virtual object 1506a and/or changing the orientation of the virtual object 1506a as shown in FIG. 15D. For example, if the second input is detected before the first input is detected, the computer system maintains display of the object with the one or more first spatial properties relative to the three-dimensional environment. In some embodiments, if the second input is detected after the first input is detected, the computer system maintains display of the object with the one or more second spatial properties or the one or more third spatial properties (e.g., as discussed above with reference to step(s) 1602) relative to the three-dimensional environment. Accordingly, because the second input does not include input selecting the object, the computer system optionally does not update display of the one or more spatial properties of the object based on the updated viewpoint of the user. In some embodiments, in response to detecting the first input, the computer system updates display of the object from the updated viewpoint, which causes the one or more spatial properties of the object to change relative to the viewpoint (but do not change relative to the environment as discussed above). Forgoing updating one or more spatial properties of an object in a three-dimensional environment based on a location of the object relative to a viewpoint of the user in response to detecting an input that includes movement of the viewpoint of the user helps reduce or avoid unintentional updating of the one or more spatial properties of the object in the three-dimensional environment, thus minimizing the occurrence of erroneous user input and improving user-device interaction.

In some embodiments, after updating display of the object to have the one or more second spatial properties or the one or more third spatial properties relative to the environment in response to detecting the first input (e.g., after detecting termination of the first input), the computer system detects, via the one or more input devices, a second input corresponding to movement of the object within the environment, such as the input provided by the hand 1503e as shown in FIG. 15I. In some embodiments, the second input has one or more characteristics of the first input described above. In some embodiments, the movement of the object is in a respective direction and/or with a respective magnitude (e.g., of speed, distance, and/or time). For example, the second input includes movement of the hand of the user and/or movement of a hardware input device (e.g., a controller) in communication with the computer system that are in a respective direction and/or with a respective magnitude.

In some embodiments, in response to detecting the second input, in accordance with a determination that the object is moved with a respective velocity (e.g., velocity curve 1542 in plot 1540 in FIG. 15J) that is greater than a velocity threshold (e.g., 0.5, 1, 2, 5, 8, 10, 15, 20, 25, or 30 m/s) based on the second input, such as velocity threshold 1544 in plot 1540 in FIG. 15J, the computer system updates display of the object to have one or more fourth spatial properties, different from the one or more second spatial properties and the one or more third spatial properties, relative to the environment, such as moving the virtual object 1506a in accordance with the movement of the hand 1503e as shown in FIG. 15J, wherein the object is updated from having the one or more second spatial properties or the one or more third spatial properties to having the one or more fourth spatial properties over a third time period (e.g., time 1514-4 in the time bar 1507 in FIG. 15J), smaller than the first time period and the second time period, based on (e.g., a duration of) the second input. For example, if the computer system detects movement of the hand of the user that causes the object to be moved with a respective velocity that is greater than the velocity threshold, the computer system forgoes gradually updating the one or more spatial properties of the object (e.g., based on simulated inertia or simulated physics laws as discussed above). Rather, in some embodiments, the computer system updates the one or more spatial properties of the object (e.g., the location of the object in the three-dimensional environment, the size of the object in the three-dimensional environment, and/or the orientation of the object in the three-dimensional environment) based on the movement input. For example, the third time period above is shorter than the first time period and the second time period (and is optionally zero) and is determined based on one or more aspects of the second input, such as the duration of the movement of the hand of the user, a velocity of the movement of the hand of the user, and/or a direction of the movement of the hand of the user in space. Alternatively, in some embodiments, the computer system still gradually updates the one or more spatial characteristics of the object to be the one or more third spatial characteristics based on simulated inertia or simulated physics laws, but does so by applying such simulated physical properties more quickly (e.g., than the first time period and the second time period). In some embodiments, in accordance with a determination that the object is moved with a respective velocity that is smaller than the velocity threshold in accordance with the second input, the computer system updates display of the object to have spatial properties in the manner described above with reference to step(s) 1602 (e.g., based on the location of the object relative to the viewpoint of the user, rather than based on the velocity of the movement of the object). Updating one or more spatial properties of an object in a three-dimensional environment differently in response to detecting an input that causes the object to be moved with more than a threshold velocity enables the one or more spatial properties to be updated more quickly as intended by the user, which allows the user to more quickly continue interacting with the object and/or content included in the object following the input, thereby improving user-device interaction.

In some embodiments, detecting the first input includes detecting an air gesture (e.g., an air pinch gesture or an air tap gesture) performed by a first portion (e.g., a hand) of the user (e.g., as previously described above with reference to step(s) 1602). Gradually updating one or more spatial properties of an object in a three-dimensional environment based on a location of the object relative to a viewpoint of the user in response to detecting an air gesture selecting the object enables the object to automatically remain visibly displayed in the user's field of view during a movement of the object, which allows the user to continue to interact with the object and/or content included in the object, and/or helps avoid or reduce instantaneous updating of the one or more spatial properties of the object, which could cause eye strain or discomfort for the user, thereby improving user-device interaction.

In some embodiments, the computer system detects, via the one or more input devices, a termination of the first input, such as termination of the input provided by hand 1503d as shown in FIG. 15H. In some embodiments, the computer system detects termination of the first input upon detecting that the air pinch gesture discussed above has been released (e.g., that the fingers of the user are no longer pinched together). Alternatively, in some embodiments, the termination of the first input is detected when the user is no longer engaging and/or interacting with a physical input device in communication with the computer system. For example, the computer system detects lifts their finger off of the trackpad surface after having moved the object within the environment.

In some embodiments, in response to detecting the end of the first input, the computer system continues to update display of one or more spatial properties of the object relative to the environment (e.g., including a location of the object within the environment) according to a respective movement model (e.g., an inertial movement model) that specifies how movement of the object within the environment continues after detecting termination of the first input, such as continuing to move the virtual object 1506a based on inertia as shown in FIG. 15I. In some embodiments, once the computer system determines that the first input has been terminated, the computer system continues to update the one or more spatial properties of the virtual object, including moving the virtual object, for a period of time and eventually stops updating the one or more spatial properties of the virtual object to simulate inertial movement of the object (e.g., as if the object has a simulated mass), as well as to simulate friction that a moving object would encounter in a real-world environment to cause the object's velocity to decrease, optionally ultimately to zero. In some embodiments, the computer system continues to move the object after detecting termination of the first input based on the detected movement, velocity and/or acceleration and direction of the user's hand while performing the first input and/or when the first input was terminated. To simulate inertial movement of the object, in some embodiments, the computer system continues to move the virtual object, after detecting termination of the first input, according to an inertial movement model, as described with reference to method 1400. In some embodiments, the inertial movement model specifies, amongst other things, the velocity, the direction of movement, as well as the distance that the virtual object will move once the computer system has detected termination of the first input. Additionally, in some embodiments, the inertial movement model specifies a size and/or an orientation that the virtual object will be displayed with once the computer system has detected the termination of the first input. For example, the movement of the object within the environment includes rotation of the object, such that the object spins about a vertical axis through the object (e.g., similar to a spinning top) in accordance with the first input, and after the computer system detects the termination of the first input, the object continues to rotate (e.g., spin) for a period of time with inertia. As another example, as the virtual object is moved in the environment with inertia after the computer system detects the termination of the first input, a size of the virtual object is updated (e.g., is increased or decreased) based on the location of the virtual object (e.g., if a location of the object that is close to the viewpoint of the user, the object has a size that is smaller than the size of the object when the object is located farther from the viewpoint of the user). Additional details regarding the movement of the object in the three-dimensional environment according to the respective movement model are provided with reference to method 1400. Moving a virtual object in updated directions that are biased towards reference directions in response to detecting termination of the movement input reduces unpredictable movements of the object in the three-dimensional environment and minimizes the amount of input required to move a virtual object to a specific location within the environment, thus minimizing the occurrence of erroneous user input and thereby conserving computing resources associated with correcting erroneous input.

It should be understood that the particular order in which the operations in method 1600 have been described is merely exemplary and is not intended to indicate that the described order is the only order in which the operations could be performed. One of ordinary skill in the art would recognize various ways to reorder the operations described herein.

FIGS. 17A-17J illustrate examples of a computer system facilitating converging of offsets associated with moving an object in a three-dimensional environment in accordance with some embodiments.

FIG. 17A illustrates a computer system 101 (e.g., an electronic device) displaying, via a display generation component (e.g., display generation component 120 of FIGS. 1 and 3), a three-dimensional environment 1702 from a viewpoint of a user 1708 (e.g., facing the back wall of the physical environment in which computer system 101 is located, as shown in the overhead/top down view of the three-dimensional environment 1702).

In some embodiments, computer system 101 includes a display generation component 120. In FIG. 17A, the display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to the FIGS. 7, 9, 11, and 13 series.

As shown in FIG. 17A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1702 or the physical environment is visible via display generation component 120. For example, three-dimensional environment 1702 includes a representation 1704a of a sofa (e.g., corresponding to representation 1704b in the overhead view), which is optionally a representation of a physical sofa in the physical environment.

As discussed in more detail below, in FIG. 17A, display generation component 120 is illustrated as displaying content in the three-dimensional environment 1702. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 17A-17J.

Display generation component 120 has a field of view (e.g., a field of view captured by external image sensors 314b and 314c and/or visible to the user via display generation component 120) that corresponds to the content shown in FIG. 17A. Because display generation component 120 is optionally a head-mounted device, the field of view of display generation component 120 is optionally the same as or similar to the field of view of the user.

As discussed herein, the user 1708 performs one or more air pinch gestures (e.g., with hand 1703a) to provide one or more inputs to computer system 101 to provide one or more user inputs directed to content displayed by computer system 101. Such depiction is intended to be exemplary rather than limiting; the user optionally provides user inputs using different air gestures and/or using other forms of input as described with reference to the FIGS. 7, 9, 11, and 13 series.

As mentioned above, the computer system 101 is configured to display content in the three-dimensional environment 1702 using the display generation component 120. In FIG. 17A, three-dimensional environment 1702 also includes a virtual object 1706a (e.g, corresponding to virtual object 1706b in the overhead view). In some embodiments, virtual object 1706a is a “content window” that displays graphical and/or textual content on a three-dimensional (or two-dimensional service) that is oriented to the user 1708 so that the user can view the content provided on the window. In some embodiments, the virtual object 1706a is optionally a user interface of an application containing content (e.g., a plurality of selectable options), three-dimensional objects (e.g., virtual clocks, virtual balls, virtual cars, or other virtual objects) or any other element displayed by computer system 101 that is not included in the physical environment of display generation component 120. For example, in FIG. 17A, the virtual object 1706a is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 1702, such as the content described below with reference to method 1800. Additionally, in some embodiments, as shown in FIG. 17A, the virtual object 1706a is displayed with a grabber bar 1720. In some embodiments, as discussed below, the grabber bar 1720 is selectable to initiate a process to move the virtual object 1706a within the three-dimensional environment 1702. In some embodiments, as discussed below, the virtual object 1706a is moveable within the three-dimensional environment in response to user input.

In some embodiments, virtual objects are displayed in three-dimensional environment 1702 with respective orientations relative to a viewpoint of user 1708. For instance, as shown in FIG. 17A, the virtual object 1706a optionally has a first orientation in the three-dimensional environment 1702 (e.g., the front-facing surface of the virtual object 1706a that faces the viewpoint of user 1708 is flat relative to the viewpoint of user 1708). In some embodiments, the orientation of the virtual object 1706a is based on the location of the virtual object within the three-dimensional environment 1702 with respect to the viewpoint of the user 1708. As described in further detail below, the orientation of the virtual object 1706a varies as the virtual object 1706a is moved through the three-dimensional environment 1702 by the computer system 101 similar to the examples described above with FIGS. 13A-L and method 1400.

In some embodiments, virtual objects are displayed in three-dimensional environment 1702 with respective sizes relative to a viewpoint of user 1708 (e.g., prior to receiving input interacting with the virtual objects, which will be described later, in three-dimensional environment 1702). As shown in FIG. 17A, the virtual object 1706a optionally has a first size in the three-dimensional environment 1702 (e.g., determined by a width and/or height (e.g., an area) of the two-dimensional front-facing surface of the virtual object 1706a that faces the viewpoint of user 1708). In some embodiments, and as described in further detail below, the size of the virtual object within the three-dimensional environment 1702 is based on object type, a distance to the virtual object from the viewpoint of the user 1708, and/or a dimensionality of the virtual object.

In some embodiments, computer system 101 detects an input provided by hand 1703a corresponding to a request to select the virtual object 1706a in the three-dimensional environment 1702. For example, as shown in FIG. 17A, the computer system 101 detects hand 1703a providing an air gesture, such as an air pinch gesture in which an index finger and thumb of the hand of the user come together to make contact, while a gaze 1722 of the user 1708 is directed to the grabber bar 1720 that is displayed with the virtual object 1706a. In some embodiments, the computer system 101 detects the hand 1703a providing the air pinch gesture without detecting movement of the hand 1703a in space.

In some embodiments, the computer system 101 detects movement of hand 1703a while the hand is providing the air gesture (such as an air pinch gesture) and while the gaze 1722 of the user 1708 is directed to the grabber bar 1720 of virtual object 1706a. In some embodiments, and in response to detecting movement of hand 1703a (e.g., while the user is engaged in the air gesture), the computer system moves virtual object 1706a in accordance with direction and velocity of the movement of hand 1703a. For instance, when the computer system detects that hand 1703a is moving in direction 1724, the computer system moves virtual object 1706a within the three-dimensional environment in the same (or corresponding) direction 1724 as the movement of hand 1703a.

In some embodiments, virtual object 1706a and the portion of the user (e.g., hand 1703a) that the computer system 101 detects motion from to move the virtual object 1706a are misaligned. For instance, as illustrated in FIG. 17A, while virtual object 1706a is centered on the user 1708, such that the center of virtual object 1706a is in front of the user and centered on the user's head, the user's hand 1703a (which is used to move the virtual object 1706a) is to the side of the user. In some embodiments, the misalignment between the virtual object 1706a and the portion of the user that is being used to move the object leads to visual perception abnormalities when the user moves the virtual object 1706a in the virtual environment 1702.

In some embodiments, the misalignment between the location of the virtual object 1706a and the user's hand 1703a can be characterized using two vectors that originate from a “pivot point” of the user. In some embodiments, a pivot point refers to a point of reference on the user's body that can be detected by the computer system (e.g., that is captured by one or more of the cameras that are part of the computer system). For instance, as illustrated in the top-down view of FIG. 17A, the head of user 1708 acts as a pivot point 1726. In some embodiments, the pivot point 1726 of the user 1708 is used to characterize the misalignment between the virtual object 1706a and the hand 1703a of the user (corresponding to hand 1703b in the top-down view of FIG. 17A) that is being used to move virtual object 1706a. In order to characterize the misalignment between the virtual object 1706a and the user's hand 1703a, the computer system determines a first vector 1728 that extends from the pivot point 1726 of the user through the center of the virtual object 1706 as shown in the top-down view of FIG. 17A. Additionally, the computer system determines a second vector 1730 that extends from the pivot point 1726 of the user through the user's hand 1703a. As illustrated in the top-down view of FIG. 17A, the first vector 1728 and the second vector 1730, optionally, originate at pivot point 1726. In some embodiments, when the first vector 1728 and the second vector 1730 are misaligned as they are in FIG. 17A, they form an angle 1732 between them that originates at pivot point 1726.

Additionally or alternatively, the pivot point 1726 of the user's body can be located at a different location on the user's body other than the user's head as illustrated in FIG. 17B. In the example of FIG. 17B, as illustrated in the top down view, pivot point 1734 is located at the user's shoulder (instead of the user's head). In some embodiments, pivot point 1734 is located on the shoulder of the user that is part of the arm that corresponds to the user's hand 1703a that is being used to move the virtual object 1706b in the three-dimensional 1702. First vector 1736 (e.g., the vector that extends from the pivot point to the center of virtual object 1706b) originates at pivot point 1734, while the second vector (e.g., the vector that extends from the pivot point through the hand 1703b of the user) also originates from pivot point 1734. In some embodiments, the misalignment between the first vector and the second vector is characterized by angle 1738 as illustrated in FIG. 17B.

Returning to the example of FIG. 17A, in response to detecting the motion of the user's hand 1703a in direction 1724 (e.g., to the right in the figure), computer system 101 moves virtual object 1706 in the same (or corresponding) direction 1724 as illustrated in FIG. 17C. In some embodiments, and as illustrated in FIG. 17C, in addition to moving virtual object 1706a to the right in three-dimensional environment 1702, the computer system also changes an orientation of the virtual object with respect to the viewpoint of the user so that the virtual object faces the viewpoint of the user as described above.

In some embodiments, the computer system 101 moves virtual object 1706a in direction 1324 in a manner so as to gradually reduce the offset between the first vector 1728 and the second vector 1730. For instance, the computer system 101 optionally moves virtual object 1706a at an angular velocity that is greater than the angular velocity of the user's hand 1703a while the user is moving the virtual object 1706a within the environment 1702. By moving the virtual object 1706a at a higher angular velocity than the angular velocity of the user's hand 1703a, the offset between the first vector 1728 and the second vector 1730 gradually reduces over time. For instance, the angle 1742 between first vector 1728 and second vector 1730 in FIG. 17C is smaller than angle 1732 illustrated in FIG. 17A. In some embodiments, the user 1708 effectively moves second vector 1730 through the motion of the hand, and in response, the computer system 101 moves the virtual object 1706a (e.g., thus moving first vector 1728) at a higher angular velocity (e.g., than the user's hand) thereby effectively causing the first vector 1728 to gradually catch up to (e.g., align) with second vector 1730 over time.

In the example of FIG. 17C, direction 1724 is in the same direction (e.g., the hand is moving in the direction of (or in a direction away from) the original location of the object) as the misalignment between the user's hand 1703a and the virtual object 1706a (e.g., the user's hand 1703a is misaligned to the right of the virtual object and direction 1724 is also to the right). In some embodiments, if the direction of motion of the user's hand is in the opposite direction (e.g., the hand is moving in the direction away from (or in a direction of) the original location of the object) with respect to the misalignment, then the computer system 101 does not move the virtual object 1706a in a manner that corrects the misalignment between first vector 1728 and second vector 1730 as illustrated in FIG. 17D. In the example of FIG. 17D, user 1708 changes the direction of the motion of their hand 1703a to move in direction 1744 which is in the opposite direction with respect to direction 1724. In response to detecting the change in direction of the user's hand 1703a, computer system 101 moves virtual object 1706a within the three-dimensional environment 1702 in direction 1744. However, since direction 1744 is in the opposite direction of the misalignment (e.g., direction 1744 is to the left, while hand 1703a is misaligned with the virtual object to the right), in some embodiments, computer system 101 does not move virtual object 1706a is a manner that reduces the offset between first vector 1728 and second vector 1730. Thus, as illustrated in FIG. 17D, while the first vector and the second vector move in accordance with motion of the virtual object 1706a and hand 1703a respectively, angle 1742 remains constant despite motion of both vectors.

In some embodiments, when user 1708 resumes moving hand 1703a in the direction of the misalignment, computer system 101 resumes moving virtual object 1706a in a manner that reduces the offset between the first vector and second vector (and therefore reduces the misalignment between the virtual object 1706a and the user's hand 1703a) as illustrated in FIG. 17E. In the example of FIG. 17E, user 1708 changes direction of the movement of hand 1703a to the right, thus resuming moving virtual object 1706a in the same direction as the misalignment between virtual object 1706a and hand 1703a. In some embodiments, in response to detecting that hand 1703a has resumed moving in direction 1742 (e.g., to the right), computer system 101 resumes moving virtual object 1706a in a manner that gradually reduces the offset between the first vector 1728 and second vector 1730 as shown in the top down view. As described above, optionally, computer system 101 moves virtual object 1706b at a higher angular velocity than the hand 1703a of user 1708 moves, thereby reducing the offset between the first vector 1728 and second vector 1730, as reflected by angle 1746 which is smaller in comparison to angle 17 42 of FIG. 17D. In some embodiments, as the user's hand 1703a continues to move in direction 1724, first vector 1728 and second vector 1730 will become aligned (e.g., the angle between them will be reduced to 0°) as illustrated in FIG. 17F. In some embodiments, the rate at which the offset reduces can be based on a magnitude of the movement of the user's hand, a duration of movement, and/or the velocity of the movement as described in method 1800.

The examples of FIGS. 17A-F illustrate that computer system 101 reduces the offset between the first vector and the second vector when the user's hand is moving in the same direction as the misalignment, however the computer system will optionally pause reducing the offset if the direction of the motion changes to the opposite direction, and will resume reducing the offset once the direction of the motion resumes in the direction of the misalignment. In some embodiments, if the user initially moves virtual object 1706a in the opposite direction of the misalignment, then in response, computer system 101 moves the virtual object 1706a in a manner that forgoes reducing (e.g., maintains) the offset between the first vector and the second vector as illustrated in FIG. 17G. In some embodiments, the example of FIG. 17G is substantially similar to the example of FIG. 17A except that the user initially moves virtual object 1706a in direction 1748 which is in the opposite direction of the misalignment (and is in the opposite of direction 1724).

In some embodiments, and in response to detecting motion of the user's hand 1703a (e.g., while performing an air gesture such as an air pinch and while the gaze of the user is directed to grabber bar 1720) in direction 1748, computer system 101 moves virtual object 1706a in direction 1748 as illustrated in FIG. 17H. In the example of FIG. 17H, while computer system 101 has moved virtual object 1706a in direction 1748 in response to movement of hand 1703a in direction 1748, the computer system moves virtual object 1706a in a manner that maintains the offset between first vector 1728 and second vector 1730. Thus, even though first vector 1728 and second vector 1730 have both moved in response to movement of virtual object 1706a and hand 1703a, respectively, in direction 1748, the angle 1732 between first vector 1728 and second vector 1730 is the same as in the example of FIG. 17G.

In some embodiments, user 1708 can move virtual object 1706a towards or away from the viewpoint of the user in addition to moving virtual object 1706a left to right as illustrated in FIG. 17I. In the example of FIG. 17I, user 1708 moves their hand 1703a in direction 1750 which includes a component of motion that is towards the viewpoint of the user. In response to detecting movement of hand 1703a in direction 1750 (and while computer system 101 detects that the user is performing an air gesture such as an air pinch while the gaze 1722 of the user is directed toward grabber bar 1720), computer system 101 moves virtual object 1706a in direction 1750 towards the viewpoint of the user as in illustrated in FIG. 17J. As illustrated in the top down view of FIG. 17I, first vector 1728 and second vector 1730 are offset with respect to one another, as previously described. In some embodiments, the offset is characterized by angle 1752 in FIG. 17I.

In some embodiments, in response to the input in FIG. 17I, and as illustrated in FIG. 17J, computer system 101 moves virtual object 1706a in direction 1750 in a manner that reduces the offset between first vector 1728 and second vector 1730. For instance, in addition to moving virtual object 1706b towards the viewpoint of the user, computer system 101 also moves the virtual object to the right (e.g., towards vector 1730) so as to reduce the offset between first vector 1728 and second vector 1730. In some embodiments, computer system 101 can independently reduce an offset between first vector 1728 and second vector 1730 in one or more or all planes defined by two or more reference directions in the environment (e.g., x, y and/or z reference directions), according to the examples described above with respect to FIGS. 17A-G.

FIG. 18 is a flowchart illustrating an exemplary method for converging offsets when moving a virtual object in a three-dimensional environment in accordance with some embodiments. In some embodiments, the method 1800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

In some embodiments, method 1800 is performed at a computer system in communication with a display generation component and one or more input devices: For example, the computer system is or includes a mobile device (e.g., a tablet, a smartphone, a media player, or a wearable device), or a computer. In some embodiments, the computer system has one or more characteristics of the computer system in methods 800, 1000, 1200, 1400, and/or 1600. In some embodiments, the display generation component has one or more characteristics of the display generation component in methods 800, 1000, 1200, and/or 1600. In some embodiments, the one or more input devices have one or more characteristics of the one or more input devices in methods 800, 1000, 1200, 1400, and/or 1600.

In some embodiments, while displaying, via the display generation component, a virtual object in an environment, and while there is an offset between a first vector extending from a respective pivot point (e.g., a detected location or estimated location of a body part of the user that has been selected as a pivot point for inputs of a user of the computer system or another point that has been selected as a pivot point for inputs that moves as the body of the user moves) towards the virtual object and a second vector extending from the respective pivot point towards a first portion of the user (such as the offset shown between first vector 1728 and second vector 1730 in FIG. 17A), the computer system detects (1802a), via the one or more input devices, a first input corresponding to moving the virtual object within the environment, wherein the first input corresponds to movement of the first portion of the user (e.g., hand 1703a performing an air pinch gesture in FIG. 17A) (e.g., through a physical environment, relative to other portions of the body of the user, and/or relative to the respective pivot point). In some embodiments, the environment is a three-dimensional environment that at least partially incorporates a representation of the real-world physical environment of the user while using the computer system (e.g., via active or passive passthrough). In some embodiments, the environment has one or more characteristics of the environments in methods 800, 1000, 1200, 1400, and/or 1600. In some embodiments, a virtual object refers to an object that is displayed by the computer system in the environment, that is generated by the computer system and is not part of the physical real-world environment. In some embodiments, the object has one or more characteristics of the objects in methods 800, 1000, 1200, 1400, and/or 1600. As an example of a virtual object, the computer system displays a window in the environment that displays content (e.g., visual content and/or text). In some embodiments, the window is moveable within the environment by the user. For example, the computer system moves the virtual object in response to detected “movement input” (e.g., the first input) from the user. In some embodiments, the movement input has one or more characteristics of the inputs for moving objects described with respect to methods 800, 1000, 1200, 1400, and/or 1600. In some embodiments, detecting the first input includes detecting that the user is performing an air pinch while gazing at the window (e.g., the virtual object) or gazing at a portion of the window or a movement control or affordance associated with the window, to select the window and moving the hand of the user (while maintaining the air pinch) in a respective direction. In some embodiments, the computer system detects the direction the user's hand (that is performing the movement input) is moving in, and accordingly moves the window (e.g., virtual object) in the same direction within the environment. In some embodiments, the direction of movement can be up, down, left, right, away and/or towards the viewpoint of the user. In some embodiments, the position of the virtual object (e.g., the window) within the environment is characterized by a first vector that extends from the respective pivot point to the center of the window. The respective pivot point optionally refers to a point of reference on the user's body that can be detected by the computer system (e.g., that is captured by one or more of the cameras that are part of the computer system). In some embodiments, the respective pivot point is calculated by the computer system and not able to be captured by cameras of the computer system (e.g., is outside of fields-of-view of the one or more cameras of the computer system). In some embodiments, the respective pivot point is misaligned with respect to the portion of the user that is used to move the object (e.g., the user's hand as described above). For instance, if the user's hand (that is used to select the object and move it within the environment) is to the side of the user then the center of the window (e.g., the object being moved) will be misaligned with the portion of the user (e.g., the user's hand) that is being used to move the window—for example, the first and second vectors described above will be offset from each other by one or more angular distances. In some examples, this misalignment causes perception errors for the user in the environment. In some embodiments, the misalignment between the user's hand and the center of the window can be characterized using the second vector extending from the respective pivot point towards the portion of the user used to move the window in conjunction with the first vector described above. For instance, an offset between the first vector and the second vector optionally indicates that there is a misalignment between the first vector and the second vector. As both the first vector and the second vector originate from the body pivot of the user, in some embodiments, the misalignment between the first vector and the second vector is characterized by an angle (with each vector forming the sides of the angle). For instance, if the first vector and second vector are aligned with one another (e.g., the hand of the user is between the respective pivot point and the center of the window) then the offset between the first vector and the second vector is 0°. If the offset is above zero, then there is a misalignment between the first vector and the second vector.

In some embodiments, in response to detecting the first input (1802b): in accordance with a determination that the first input corresponds to movement of the first portion of the user in a first direction that moves the second vector that extends from the respective pivot point towards the first portion of the user, away from a location at which the virtual object was displayed prior to detecting the movement of the first portion of the user, the computer system moves (1802c) the virtual object within the environment in a first manner in accordance with the first input (e.g., with a speed and/or direction corresponding to the speed and/or direction of the movement of the first portion of the user), wherein moving the virtual object in the first manner includes gradually reducing the offset between the first vector that extends from the respective pivot point towards the virtual object, and the second vector, that extends from the respective pivot point towards the first portion of the user such as in FIG. 17B. In some embodiments, the misalignment between the first vector and the second vector is corrected when the object (e.g., window) is being moved by the user in the environment. Correcting the misalignment optionally refers to moving the window faster and/or further than the movement of the user's hand would otherwise cause (e.g., the first manner), if misalignment correction were not being applied, to reduce the offset (e.g., angle) between the first vector and the second vector. In some embodiments, the correction is applied when the movement of the user's hand is in a first direction that is away from the first vector. In some embodiments, since the movement of the window is being used to correct the offset (e.g., by making the window move faster and/or further relative to the motion of the hand), applying the correction when the hand is moving away from the first vector allows for the direction of correction to be the same as the direction of movement of the hand. In some embodiments, the window is moved faster and/or further relative to the hand movement in a manner (e.g., the first manner) that reduces the offset between the first vector and the second vector gradually (e.g., the offset is reduced over time) instead of instantaneously. In some embodiments, the reduction in the offset between the first vector and the second vectors occurs while both vectors are moving. For instance, in response to the movement of the first input in the first direction (e.g., in a direction that moves the second vector way from the location at which the virtual object was displayed prior to detecting the movement of the first portion of the user), the computer system moves the virtual object in accordance with the motion, and at a velocity that is faster than the velocity at which the first input is moving. Modifying movement of the virtual object to gradually reduce the offset between the first vector and the second vector reduces unpredictable movements of the object in the three-dimensional environment, thus minimizing the occurrence of erroneous user input and thereby conserving computing resources associated with correcting erroneous input.

In some embodiments, in response to detecting the first input: in accordance with a determination that the first input corresponds to movement of the first portion of the user in a second direction that moves the second vector towards the location at which the virtual object was displayed prior to detecting the movement of the first portion of the user, the computer system moves the virtual object within the environment in a second manner in accordance with the first input, wherein moving the virtual object in the second manner includes gradually reducing the offset between the first vector, that extends from the respective pivot point towards the virtual object, and the second vector, that extends from the respective pivot point towards the first portion of the user, at a rate that is lower than a rate of reduction of the offset associated with the first manner such as if a reduction in offset occurred in response to motion of the hand in direction 1744 in FIG. 17D. In some embodiments, if the movement of the first portion of the user is towards the first vector, the computer system reduces the offset between the first vector and second vector at a rate that is lower than the rate of reduction of the offset when the movement of the first portion of the user is away from the first vector. In some embodiments, in order to reduce the offset by a lower rate when the movement of the virtual object in the second manner in contrast to the first manner, the computer system moves the virtual object at a slower velocity than it moves the first object when moving the virtual object in the first manner. In some embodiments, the computer system reduces the offset between the first vector and the second vector at a slower rate when the first portion of the user is moved towards the first vector versus when the virtual object is moved in the opposite direction in order to minimize any visual abnormalities associated with correcting the offset in a direction that is opposite to the direction of motion of the virtual object. Reducing the offset between the first vector and the second vector less when the portion of the user is moved towards the first vector versus when the portion of the user is moved away from the first vector reduces unpredictable movements of the object in the three-dimensional environment, thus minimizing the occurrence of erroneous user input and thereby conserving computing resources associated with correcting erroneous input.

In some embodiments, in response to detecting the first input: in accordance with a determination that the first input corresponds to movement of the first portion of the user in a second direction that moves the second vector towards the location at which the virtual object was displayed prior to detecting the movement of the first portion of the user, the computer system moves the virtual object within the environment in a second manner in accordance with the first input, wherein moving the virtual object in the second manner includes forgoing reducing the offset (e.g., maintaining the offset) between the first vector, that extends from the respective pivot point towards the virtual object, and the second vector, that extends from the respective pivot point towards the first portion of the user such as in FIG. 17D. In some embodiments, if the movement of the first portion of the user is toward the first vector, then the offset between the first vector and second vector is not modified and is kept at the offset that was present when the first input started. In some embodiments, forgoing reducing the offset between the first vector and the second vector when the portion of the user is moving in the second manner (e.g., towards the first vector) ensures that the direction of correction and the direction of the movement of the virtual object are the same. Reducing the offset between the first vector and the second vector such that the direction of correction and the direction of motion are opposite to one another, optionally leads to visual abnormalities that can interfere with the user's perception of the environment. Forgoing reduction of the offset between the first vector and the second vector when the virtual object is moved towards the first vector reduces unpredictable movements of the object in the three-dimensional environment, thus minimizing the occurrence of erroneous user input and thereby conserving computing resources associated with correcting erroneous input.

In some embodiments, in response to detecting the first input: in accordance with a determination that the first input corresponds to movement of the first portion of the user in a third direction that is towards the viewpoint of the user (optionally independent of whether the movement includes movement in the first direction), the computer system moves the virtual object within the environment in a second manner in accordance with the first input, wherein moving the virtual object in the second manner includes gradually reducing the offset between the first vector, that extends from the respective pivot point towards the virtual object, and the second vector, that extends from the respective pivot point towards the first portion of the user such as the movement of virtual object 1706b illustrated in FIG. 17J. In some embodiments, if the movement of the virtual object is towards the viewpoint of the user (e.g., the user is moving the virtual object closer with respect to their viewpoint), the computer system gradually reduces the offset between the first vector and the second vector. In some embodiments, as the user moves their hand to pull the virtual object towards their viewpoint, the user's hand moves away from the first vector as the hand moves to the side of the user's body (e.g., away from the user's head and/or shoulder.) In response to detecting that the user's hand is moving away from the first vector (as their hand is also moving towards the user), the computer system optionally continues to reduce the offset between the first vector and the second vector. Optionally, the offset between the first vector and the second vector is reduced in response to movement of the virtual object towards the viewpoint of the user, even if there is no horizontal motion of the hand while the hand is pulling the virtual object towards the viewpoint of the user. Reducing an offset between the first vector and the second vector when the computer system detects that the user is moving the virtual object towards the respective viewpoint of the user reduces unpredictable movements of the object in the three-dimensional environment, thus minimizing the occurrence of erroneous user input and thereby conserving computing resources associated with correcting erroneous input.

In some embodiments, the respective pivot point corresponds to a shoulder of the user such as shown in FIG. 17A (e.g., at a detected shoulder location, an estimated shoulder location, or an approximated shoulder location). In some embodiments, the first vector and the second vector originate from a shoulder of the user (e.g., at the pivot point). In some embodiments, the pivot point is located at the edge of the shoulder. Additionally or alternatively, the pivot point is located at a point at a center of the shoulder (e.g., corresponding to a center of the should joint). In some embodiments, when the computer system moves the virtual object in accordance with movement of the user's hand, the first vector and the second vector also move in accordance with movement of the virtual object and the user's hand respectively, however the first vector and the second vector continue to originate from the shoulder of the user, and the offset between the vector and the second vector is determined based on an angle formed between the first vector and the second vector with both vectors originating from the user's shoulder. In some embodiments, the computer system determines the location of the shoulder of the user using one more cameras that are communicatively coupled to the computer system (e.g., mounted on the head mounted display). In some embodiments, the location of the shoulder of the user is estimated based a determined separation and/or angle from the head mounted display. For instance, if the head is determined to be at a certain location, the computer system can estimate the location of the shoulder as being some distance away from the head, and some angle from the head. For instance, the distance can be in the range of 10-500 cm, with and angle from 20-90 degrees from the center of the head. Originating the first vector and the second vector at the shoulder of the user, provides a common origin point for both vectors that ensures accuracy in the measurement of the offset between the first vector and second vector, thus reducing unpredictable movement of the object in the three-dimensional environment, thus minimizing the occurrence of erroneous user input and thereby conserving computing resources associated with correcting erroneous input.

In some embodiments, the first portion of the user includes a hand of the user, and wherein the shoulder of the user corresponding to the respective pivot point and the hand of the user corresponding to the first portion of the user providing the first input are from a same arm of the user such as shown in FIG. 17B. In some embodiments, the shoulder of the user from which both the first vector and the second vector originate, and the hand of the user that moves the virtual object are from the same arm of the user in order to simplify measurement of the offset between the first vector and second vector and/or reduce the likelihood of any visual abnormalities experienced by the user when the computer system reduces the offset between the first vector and the second vector and/or to ensure connectedness between the movements of the hand and the resulting movement of the virtual object. In some embodiments, if the input is provided from a different hand, the location of the pivot point will be different (e.g., on the opposite shoulder). Originating the first vector and the second vector at the shoulder of the user that is from the same arm as the hand of the user that is providing the input, provides a common origin point for both vectors that ensures accuracy in the measurement of the offset between the first vector and second vector, thus reducing unpredictable movement of the object in the three-dimensional environment, thus minimizing the occurrence of erroneous user input and thereby conserving computing resources associated with correcting erroneous input.

In some embodiments, the respective pivot point corresponds to a head of the user such as shown in FIG. 17A (e.g., at a detected head location, an estimated head location, or an approximated head location). In some embodiments, the first vector and the second vector originate from the head of the user. In some embodiments, when the virtual object is moved in accordance with movement of the user's hand, the first vector and the second vector also move in accordance with movement of the virtual object and the user's hand respectively, however the first vector and the second vector continue to originate from the head of the user, and the offset between the first vector and the second vector is determined based on an angle formed between the first vector and the second vector with both vectors originating from the user's head. In some embodiments, when the pivot point is located at the user's head, the pivot point does not change locations based on which hand of the user is providing the movement. In some embodiments, the computer system determines the location of the user's head using one more cameras that are communicatively coupled to the computer system (e.g., mounted on the head mounted display). For instance, optionally, the computer system estimates the location of the head by setting the location of the user's head to be some pre-determined distance and/or orientation relative to the display generation component (e.g., the headset). As an example, the center of the head can be estimated to be 0-50 cm from the headset (e.g., behind the front of the headset), and 0 to 90 degrees from a normal to the display(s) of the headset. Originating the first vector and the second vector at the head of the user, provides a common origin point for both vectors that ensures accuracy in the measurement of the offset between the first vector and second vector, thus reducing unpredictable movement of the object in the three-dimensional environment, thus minimizing the occurrence of erroneous user input and thereby conserving computing resources associated with correcting erroneous input.

In some embodiments, in accordance with the virtual object being a window (e.g., an application window), the computer system determines a location of the respective pivot point of the user as corresponding to a second portion of the user such as the should of the user in FIG. 17A, and in accordance with the virtual object not being a window (e.g., a virtual object other than an application window, such as a representation of content (e.g., photo, video or song), or a three-dimensional model of an object (e.g., a tent, a ball or a car)), the computer system determines the location of the respective pivot point of the user as corresponding to a third portion of the user that is different from the second portion of the user such as the head in FIG. 17B and if virtual object 1706a were not a window. In some embodiments, the pivot point of the user used to determine the first vector and second vector and the offset between both vectors is based on the action that the computer system is performing using the movement of the first portion of the user as an input. For instance, optionally, when the movement of the first portion of the user is being used to move a window, the computer system uses a different pivot point than if the movement of the first portion of the user is being used to perform a drag and drop operation (e.g., the object being moved is not a window). In some embodiments, selection of the pivot point to use with a certain action is based on such factors including but not limited to: the user's viewpoint within the environment, comfort of the user when engaged in the environment, simplicity in determining the offset between the first vector and the second vector, the user's visual perception of the environment, and/or the computer system's ability to determine the location of the pivot point. Enabling the computer system to select the pivot point based on the action being performed by the computing system reduces unpredictable movement of the object in the three-dimensional environment, thus minimizing the occurrence of erroneous user input and thereby conserving computing resources associated with correcting erroneous input.

In some embodiments, the second portion of the user corresponds to a shoulder of the user as shown in FIG. 17A, and wherein the third portion of the user corresponds to a head of the user as shown in FIG. 17B. In some embodiments, the computer system optionally uses the shoulder of the user as the pivot point to originate both the first and second vectors when the computer system is moving a window in response to movement of the first portion user. Additionally, the computer system uses the user's head as a pivot point when performing other actions in response to the movement of the first portion of the user. For instance, the computer system optionally uses the head of the user as the pivot point when performing a drag and drop operation. In some embodiments, the computer system uses the shoulder as the pivot when moving content windows in the environment to simplify the process of reducing the offset between the first vector and the second vector. In some embodiments, since the shoulder of the user is closer in proximity to the hand of the user, and is closer in alignment with the hand, the computer system can more accurately determine an offset between the first vector and the second vector, and more accurately controls the rate of reduction of offset between the first vector and the second vector. Using the shoulder of the user as a pivot point during movement of a window, provides the computer system with greater control of the offset between the first and second vectors, thus reducing unpredictable movement of the object in the three-dimensional environment, thus minimizing the occurrence of erroneous user input and thereby conserving computing resources associated with correcting erroneous input.

In some embodiments, in accordance with a determination that the detected first input includes input corresponding to moving the virtual object vertically relative to the viewpoint of the user, the computer system reduces a vertical offset between the first vector and the second vector in accordance with the first input as if the motion of hand 1703 was in the vertical direction instead of the horizontal direction in FIG. 17B, and if angle 1738 represented the vertical offset between the first vector 1728 and second vector 1730. In some embodiments, in accordance with a determination that the detected first input includes input corresponding to moving the virtual object horizontally relative to the viewpoint of the user, the computer system reduces a horizontal offset between the first vector and the second vector in accordance with the first input. In some embodiments, the offset between the first vector and the second vector includes a vertical component (e.g., the first vector and the second vector are displaced from one another in the Y-axis). Optionally, as part of reducing the offset between the first vector and second vector, the computer system reduces the vertical offset between the first vector and second vector such that the first vector and the second vector become closer aligned in height (e.g., the vertical direction). In some embodiments, each component of offset reduction (e.g., horizontal and or vertical) is independently performed/determined based on the direction of motion of the user's hand. Thus, in some embodiments, the reduction in offset in the vertical direction and the reduction in offset in the horizontal direction are independently determined and are based on the vertical and horizontal motion of the hand, respectively. Reducing the vertical offset between the first vector and second vector, reduces unpredictable movement of the object in the three-dimensional environment, thus minimizing the occurrence of erroneous user input and thereby conserving computing resources associated with correcting erroneous input.

In some embodiments, the virtual object is a first distance from the respective pivot point, and moving the virtual object in the first manner comprises moving the virtual object at a first velocity in the environment, greater than a velocity at which a respective location along the second vector that is the first distance from the respective pivot point moves during the first input as shown in FIG. 17B. In some embodiments, since the second vector is moving in response to the movement of the user's hand, the computer system reduces the offset between the first vector and the second vector by moving the virtual object such that the angular velocity of the first vector is faster than the angular velocity of the second vector. In order to “move” the first vector with a faster angular velocity than the angular velocity of the second vector (caused by movement of the users hand), the computer system optionally moves the virtual object (e.g., the window) at a rotational velocity that is faster than the rotational velocity of the user's hand thereby gradually reducing the offset between the first vector and the second vector. In some embodiments, the angular velocity at which the virtual object is moved by the computer system is based on the amount of the angular offset between the first vector and the second vector and is based on a determined velocity of the portion of the user (e.g., the user's hand) that is used to move the virtual object. Moving the first vector at a faster angular velocity than the angular velocity of the second vector to reduce the offset between the first vector and the second vector, reduces unpredictable movement of the object in the three-dimensional environment, thus minimizing the occurrence of erroneous user input and thereby conserving computing resources associated with correcting erroneous input.

In some embodiments, reducing the offset includes: in accordance with a determination that a magnitude of the movement of the first portion of the user is a first magnitude, the computer system moves the virtual object so as to reduce the offset between the first vector that extends from the respective pivot point towards the virtual object, and the second vector, that extends from the respective pivot point towards the first portion of the user, by a first amount as shown in FIG. 17B. In some embodiments, in accordance with a determination that the magnitude of the movement of the first portion of the user is a second magnitude, different from the first magnitude, moving the virtual object so as to reduce the offset between the first vector that extends from the respective pivot point towards the virtual object, and the second vector, that extends from the respective pivot point towards the first portion of the user, by a second amount, different from the first amount, as would be shown in FIG. 17E. In some embodiments, the amount of reduction of offset between the first vector and the second vector is based on the detected distance the hand moves when moving the virtual object. In some embodiments, the velocity of the user's hand while performing the movement and the duration that the hand moves yield a magnitude of movement (since velocity multiplied by the time of motion yields the amount/magnitude of movement.) In some embodiments, since the reduction in offset between the first vector and the second vector occurs over the duration of the movement of the hand, and since the computer system moves the virtual object based on the velocity at which the hand is moving (e.g., at a velocity faster than the than the velocity of the hand (as described above)), the amount of reduction of the offset will optionally be based on the magnitude of the movement of hand. In some embodiments, the amount of reduction of the offset is proportional to the magnitude of the movement of the hand such that a larger magnitude of the movement of the hand yields a larger offset reduction. Basing the amount of reduction of the offset between the first vector and the second vector on the magnitude of the movement of the first portion of the user, reduces unpredictable movement of the object in the three-dimensional environment, thus minimizing the occurrence of erroneous user input and thereby conserving computing resources associated with correcting erroneous input.

In some embodiments, in accordance with a determination that a duration of the movement of the first portion of the user is a first duration, the computer system moves the virtual object so as to reduce the offset between the first vector that extends from the respective pivot point towards the virtual object, and the second vector, that extends from the respective pivot point towards the first portion of the user, by a first amount as shown in FIG. 17B. In some embodiments, in accordance with a determination that the duration of the movement of the first portion of the user is a second duration, different from the first duration, the computer system moves the virtual object so as to reduce the offset between the first vector that extends from the respective pivot point towards the virtual object, and the second vector, that extends from the respective pivot point towards the first portion of the user, by a second amount, different from the first amount as shown in FIG. 17E. In some embodiments, and as described above, the magnitude of the movement of the second vector is based on the velocity at which the hand moves as well as the duration of movement. In some embodiments, when the amount of reduction of the offset is based on the magnitude of the movement of the first input it will also be based on the duration of the movement, since the magnitude of movement is based on the duration of the movement. In some embodiments, the computer system determines the duration of movement of the hand and bases the amount of reduction of offset between the first vector and the second vector on the determined duration. In some embodiments, the amount of reduction of the offset is proportional to the duration of the movement of the hand such that a larger duration of the movement of the hand yields a larger offset reduction. Basing the amount of reduction of the offset between the first vector and the second vector on the duration of the movement of the portion of the user, reduces unpredictable movement of the object in the three-dimensional environment, thus minimizing the occurrence of erroneous user input and thereby conserving computing resources associated with correcting erroneous input.

In some embodiments, reducing the offset includes: in accordance with a determination that a rate of the movement of the first portion of the user is a first rate, moving the virtual object so as to reduce the offset between the first vector that extends from the respective pivot point towards the virtual object, and the second vector, that extends from the respective pivot point towards the first portion of the user, by a first amount as shown in FIG. 17B. In some embodiments, in accordance with a determination that the rate of the movement of the first portion of the user is a second rate, different from the first rate, the computer system moves the virtual object so as to reduce the offset between the first vector that extends from the respective pivot point towards the virtual object, and the second vector, that extends from the respective pivot point towards the first portion of the user, by a second amount, different from the first amount as would be shown if the movement of hand 1703a in FIG. 17b was quicker. In some embodiments, and as described above, the magnitude of the movement of the second vector is based on the velocity at which the hand moves as well as the duration of movement. In some embodiments, when the amount of reduction of the offset is based on the magnitude of the movement of the first input it will also be based on the rate of the movement of the first portion of the user (e.g., the velocity of the first portion), since the magnitude of movement is based on the rate of the movement. In some embodiments, the computer system determines the rate of movement of the hand, and bases the amount of reduction of offset between the first vector and the second vector on the determined rate. In some embodiments, the amount of reduction of the offset is proportional to the rate of the movement of the hand such that a larger rate of the movement of the hand yields a larger offset reduction. Basing the amount of reduction of the offset between the first vector and the second vector on the rate of movement of the portion of the user, reduces unpredictable movement of the object in the three-dimensional environment, thus minimizing the occurrence of erroneous user input and thereby conserving computing resources associated with correcting erroneous input.

It should be understood that the particular order in which the operations in method 1800 have been described is merely exemplary and is not intended to indicate that the described order is the only order in which the operations could be performed. One of ordinary skill in the art would recognize various ways to reorder the operations described herein.

FIGS. 19A-19R illustrate examples of a computer system facilitating rotation of a volumetric virtual object in a three-dimensional environment in accordance with some embodiments.

FIG. 19A illustrates a computer system 101 (e.g., an electronic device) displaying, via a display generation component (e.g., display generation component 120 of FIGS. 1 and 3), a three-dimensional environment 1900 from a viewpoint of a user (e.g., facing the back wall of the physical environment in which computer system 101 is located).

In some embodiments, computer system 101 includes a display generation component 120. In FIG. 19A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands. In some embodiments, image sensors 114a, 114b, and 114c have one or more of the characteristics of image sensors 314 described with reference to the FIGS. 7, 9, 11, 13, 15, and 17 series.

As shown in FIG. 19A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1900. For example, three-dimensional environment 1900 includes a representation of a window 1902, which is optionally a representation of a physical window in the physical environment.

As discussed in more detail below, in FIG. 19A, display generation component 120 is illustrated as displaying content in the three-dimensional environment 1900. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 19A-19R.

Display generation component 120 has a field of view (e.g., a field of view captured by external image sensors 114b and 114c and/or visible to the user via display generation component 120) that corresponds to the content shown in FIG. 19A. Because display generation component 120 is optionally a head-mounted device, the field of view of display generation component 120 is optionally the same as or similar to the field of view of the user.

As discussed herein, one or more air pinch gestures performed by a user (e.g., with hand 1903) are detected by one or more input devices of computer system 101 and interpreted as one or more user inputs directed to content displayed by computer system 101. Additionally or alternatively, in some embodiments, the one or more user inputs interpreted by computer system 101 as being directed to content displayed by computer system 101 are detected via one or more hardware input devices (e.g., controllers) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input as described with reference to the FIGS. 7, 9, 11, 13, 15, and 17 series.

As mentioned above, the computer system 101 is configured to display content in the three-dimensional environment 1900 using the display generation component 120. In FIG. 19A, three-dimensional environment 1900 includes a home user interface 1904. In some embodiments, the home user interface 1904 corresponds to a home user interface of the computer system 101 that includes a plurality of selectable icons associated with respective applications configured to be run on the computer system 101, as shown in FIG. 19A. In some embodiments, as shown in FIG. 19A, the home user interface 1904 is displayed at a center of the field of view of the display generation component 120.

In FIG. 19A, the computer system 101 detects an input provided by hand 1903 corresponding to a selection of a first icon 1930a of the plurality of icons of the home user interface 1904 in the three-dimensional environment 1900. For example, as shown in FIG. 19A, the computer system 101 detects an air pinch gesture performed by the hand 1903 (e.g., in which an index finger and thumb of the hand 1903 come together to make contact), optionally while attention (e.g., including gaze 1926) is directed to the first icon 1930a in the three-dimensional environment 1900.

In some embodiments, the first icon 1930a is associated with a first application that is configured to be run on the computer system 101. Particularly, in some embodiments, the first icon 1930a is associated with an application corresponding to and/or including volumetric (e.g., three-dimensional) content that is able to be displayed in the three-dimensional environment 1900. In some embodiments, in response to detecting the selection of the first icon 1930a, the computer system 101 launches the first application that is associated with the first icon 1930a. In some embodiments, as shown in FIG. 19B, launching the first application includes displaying user interface 1932 in the three-dimensional environment 1900 that corresponds to the first application. For example, as illustrated in FIG. 19B, the computer system 101 displays a user interface of an application for displaying volumetric content in the three-dimensional environment 1900. In some embodiments, as shown in FIG. 19B, the user interface 1932 includes a plurality of selectable options corresponding to volumetric content items displayable in the three-dimensional environment 1900. For example, as shown in FIG. 19B, the user interface 1932 includes selectable option 1933a associated with a first volumetric object, selectable option 1933b associated with a second volumetric object, and selectable option 1933c associated with a third volumetric object. In some embodiments, as similarly discussed below, the user interface 1932 is displayed with movement element 1936 (e.g., a grabber bar) that is selectable (e.g., via an air pinch gesture) to initiate movement of the user interface 1932 within the three-dimensional environment 1900.

In FIG. 19B, while displaying the user interface 1932, the computer system 101 detects a selection of the selectable option 1933a. For example, as shown in FIG. 19B, the computer system 101 detects an air pinch gesture, optionally while the attention (e.g., including the gaze 1926) of the user is directed toward the selectable option 1933a in the three-dimensional environment 1900.

In some embodiments, as shown in FIG. 19C, in response to detecting the selection of the selectable option 1933a in the user interface 1932, the computer system 101 designates a first volumetric object for display in the three-dimensional environment 1900. In some embodiments, as shown in FIG. 19C, designating the first volumetric object for display in the three-dimensional environment 1900 includes configuring and/or displaying one or more settings associated with the first volumetric object. For example, as shown in FIG. 19C, the computer system 101 updates the user interface 1932 to include settings 1938, including a tilt mode setting, a size setting, and/or a color setting. In some embodiments, as shown in FIG. 19C, the settings 1938 associated with the first volumetric object are set to default values in the user interface 1932. For example, in FIG. 19C, the tilt mode setting, which controls rotation of the first volumetric object in the three-dimensional environment 1900, as discussed herein below, is set to be active by default, the size setting, which controls a size of the first volumetric object in the three-dimensional environment 1900, is set to a default size, and the color setting, which controls one or more colors of the first volumetric object (e.g., and/or content associated with the first volumetric object), is set to default one or more colors.

In FIG. 19C, the computer system 101 detects a selection of confirm option 1934 in the user interface 1932 in the three-dimensional environment 1900. In some embodiments, the confirm option 1934 is selectable to confirm selection of the settings 1938 associated with the first volumetric object discussed above, thereby initiating display of the first volumetric object in the three-dimensional environment 1900. As shown in FIG. 19C, the computer system 101 optionally detects an air pinch gesture performed by the hand 1903, optionally while the attention (e.g., including the gaze 1926) of the user is directed to the confirm option 1934 in the three-dimensional environment.

In some embodiments, as shown in FIG. 19D, in response to detecting the selection of the confirm option 1934 in the user interface 1932, the computer system 101 displays three-dimensional virtual object 1920 (e.g., corresponding to the first volumetric object discussed above) in the three-dimensional environment 1900. In some embodiments, as illustrated in FIG. 19D, the three-dimensional virtual object 1920 includes base 1922 (e.g., a bottom (e.g., two-dimensional or three-dimensional) surface) and content disposed on the base 1922. For example, the three-dimensional virtual object 1920 corresponds to a three-dimensional model (e.g., model of a city including buildings) having a respective height (e.g., as measured from the base 1922 to a top/peak of the content (e.g., a tallest point on the tallest building)). It should be understood that the content discussed above is exemplary and that, in some embodiments, additional and/or alternative content and/or user interfaces are provided in the three-dimensional environment 1900, such as the content described below with reference to method 2000. Additionally, in some embodiments, as shown in FIG. 19D, the computer system 101 is displayed with movement element 1936 (e.g., a grabber bar or handle) that is selectable to initiate movement of the three-dimensional object 1920 within the three-dimensional environment 1900 relative to the viewpoint of the user. In some embodiments, the movement element 1936 is displayed below the three-dimensional object 1920 (e.g., below the base 1922) relative to the viewpoint of the user in the three-dimensional environment 1900. In some embodiments, the movement element 1936 is displayed overlaid on and/or in front of the base 1922 of the three-dimensional object 1920 relative to the viewpoint of the user in the three-dimensional environment 1900.

It should be understood that, in some embodiments, the computer system 101 displays the three-dimensional object 1920 in the three-dimensional environment 1900 without necessarily first displaying the user interface 1932 of FIGS. 19B and 19C. For example, the computer system 101 displays the three-dimensional object 1920 in the three-dimensional environment 1900 directly in response to detecting the selection of the first icon 1930a in FIG. 19A.

In some embodiments, as indicated in side view 1940 in FIG. 19D, when the computer system 101 displays the three-dimensional object 1920 in the three-dimensional environment 1900, the three-dimensional object 1920 is displayed at an initial angle of elevation 1911 relative to the viewpoint of the user. As illustrated in the side view 1940 in FIG. 19D, the angle of elevation 1911 is measured between a vector 1909 that extends between a head 1908 (e.g., a center of the head 1908) of the user and a first portion 1906 of the three-dimensional object 1920 and a horizon plane 1910 of the field of view of the user. Details regarding the vector 1909 and the horizon plane 1910 are provided below with reference to method 2000. In some embodiments, the first portion 1906 of the three-dimensional object 1920 corresponds to a portion of the base 1922 of the three-dimensional object 1920, such as a front of the base 1922 or a center of the base 1922. In some embodiments, the first portion 1906 of the three-dimensional object 1920 corresponds to a location of the movement element 1936 in the three-dimensional environment 1900.

In some embodiments, the initial angle of elevation 1911 is determined based on a height of the three-dimensional object 1920 in the three-dimensional environment 1900. For example, as similarly discussed above, the initial angle of elevation 1911 is determined based on the vertical distance between the base 1922 of the three-dimensional object 1920 and a top/peak of the content of the three-dimensional object 1920. In some embodiments, a smaller height of the three-dimensional object 1920 results in a lower initial angle of elevation 1911 of the three-dimensional object 1920 relative to the viewpoint of the user. For example, as shown in FIG. 19E, if the three-dimensional object 1920 has a height that is smaller than the height of the three-dimensional object 1920 in FIG. 19D, the computer system 101 displays the three-dimensional object 1920 at an initial angle of elevation 1911 that is lower (e.g., in degrees) than the initial angle of elevation 1911 in FIG. 19D, as illustrated in the side view 1940.

In some embodiments, as shown in the side view 1940 in FIG. 19E, the three-dimensional object 1920 includes and/or is associated with a reference angle 1913 measured between a plane of the three-dimensional object 1920 and the vector 1909 extending between the head 1908 of the user and the first portion 1906 of the three-dimensional object 1920. In some embodiments, the plane of the three-dimensional object 1920 corresponds to a plane that is parallel to and/or extends along the base 1922 of the three-dimensional object 1920. In some embodiments, when the three-dimensional object 1920 is initially displayed in the three-dimensional environment 1900, the angle of elevation 1911 is equal to (e.g., in degrees) the base angle 1913. In some embodiments, as described herein, changes in the angle of elevation 1911 of the three-dimensional object 1920 selectively causes the reference angle 1913 to change based on a given angle of elevation 1911 and/or a direction of the change of the angle of elevation 1911 of the three-dimensional object 1920.

In some embodiments, virtual objects are displayed in three-dimensional environment 1900 with respective orientations relative to the viewpoint of user (e.g., prior to receiving input interacting with the virtual objects, which will be described later, in three-dimensional environment 1900). As shown in FIG. 19E, the three-dimensional object 1920 optionally has a first orientation in the three-dimensional environment 1900 (e.g., the front-facing surface of the three-dimensional object 1920 that faces forward is flat relative to the viewpoint of user). It should be understood that the orientation of the object in FIG. 19E is merely exemplary and that other orientations are possible.

In some embodiments, virtual objects are displayed in three-dimensional environment 1900 with respective sizes relative to the viewpoint of user (e.g., prior to receiving input interacting with the virtual objects, which will be described later, in three-dimensional environment 1900). As shown in FIG. 19E, the three-dimensional object 1920 optionally has a first size in the three-dimensional environment 1900 (e.g., determined by a volume of the content and/or base 1922 of the three-dimensional object 1920). It should be understood that the initial size of the three-dimensional object 1920 in FIG. 19E is merely exemplary and that other sizes are possible (e.g., based on object type, a distance to the virtual object from the viewpoint of the user, and/or a dimensionality of the virtual object).

In some embodiments, virtual objects are displayed in three-dimensional environment 1900 at respective locations relative to the viewpoint of the user (e.g., prior to receiving input interacting with the virtual objects, which will be described later, in three-dimensional environment 1900). As shown in FIG. 19E, the three-dimensional object 1920 is optionally displayed at a first location in the three-dimensional environment 1900 (e.g., a default location and/or a user-selected location, as indicated in the side view 1940 in FIG. 19E). It should be understood that the initial location of the three-dimensional object 1920 in FIG. 19E is merely exemplary and that other locations are possible (e.g., based on object type, prior input directed to the virtual object provided by the user, and/or the application with which the virtual object is associated).

In some embodiments, the computer system 101 facilitates rotation (e.g., tilting) of the three-dimensional object 1920 discussed above within the three-dimensional environment 1900 based on changes in the angle of elevation 1911 of the three-dimensional object 1920 relative to the viewpoint of the user. Particularly, in some embodiments, the computer system 101 rotates the three-dimensional object 1920 to tilt the first portion 1906 to face toward the location of the viewpoint of the user in the three-dimensional environment 1900 in response to detecting user input corresponding to a request to change the angle of elevation 1911 of the three-dimensional object 1920 relative to the viewpoint of the user within the three-dimensional environment 1900, as discussed below. In some embodiments, the rotation of the three-dimensional object 1920 is based on the magnitude and/or direction of the change in the angle of elevation 1911 of the three-dimensional object 1920 relative to the viewpoint of the user in the three-dimensional environment 1900.

In FIG. 19E, the computer system 101 detects an input provided by hand 1903 corresponding to a request to change the angle of elevation 1911 of the three-dimensional object 1920 in the three-dimensional environment 1900. For example, as shown in FIG. 19E, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 in a downward direction relative to the viewpoint of the user. Additionally, in some embodiments, as indicated by indication 1914 in FIG. 19E, the computer system 101 detects the input provided by the hand 1903 while the tilt mode is active for the three-dimensional object 1920 in the three-dimensional environment 1900. It should be understood that the indication 1914 is exemplary and is not necessarily displayed in the three-dimensional environment 1900.

In some embodiments, as illustrated in the side view 1940 in FIG. 19E, rotation of the three-dimensional object 1920 in the three-dimensional environment 1900 is based on a range 1918 of angles of elevation in the three-dimensional environment 1900. In some embodiments, as shown in the side view 1940 in FIG. 19E, the range 1918 of angles of elevation extend below the horizon plane 1910 in the three-dimensional environment 1900. As shown in the side view 1940 in FIG. 19E, when the computer system 101 detects the input provided by the hand 1903 corresponding to the request to change the angle of elevation 1911 relative to the viewpoint of the user, the three-dimensional object 1920 is at a threshold of the range 1918 of angles of elevation in the three-dimensional environment 1900. For example, the base 1922 is located at a highest value (e.g., in degrees) of the range 1918 of angle of elevation in the three-dimensional environment 1900.

In some embodiments, as shown in FIG. 19F, in response to detecting the input provided by the hand 1903, the computer system 101 changes the angle of elevation 1911 of the three-dimensional object 1920 relative to the viewpoint of the user in accordance with the input. For example, as shown in the side view 1940 in FIG. 19F, in response to detecting the downward movement of the hand 1903 of the user, the computer system 101 decreases the angle of elevation 1911 of the three-dimensional object relative to the viewpoint of the user, such that the three-dimensional object 1920 is displayed and/or located lower in the field of view of the user in the three-dimensional environment 1900. In some embodiments, as illustrated in the side view 1940 in FIG. 19F, when the computer system 101 decreases the angle of elevation 1911 of the three-dimensional object 1920, the angle of elevation 1911 remains within the range 1918 of angles of elevation in the three-dimensional environment 1900. In some embodiments, while the angle of elevation 1911 is within the range 1918 of angles of elevation, the computer system 101 forgoes rotating the three-dimensional object 1920 in the three-dimensional environment 1900 based on changes in the angle of elevation 1911 (optionally despite the tilt setting of the three-dimensional object 1920 being active as discussed above).

Accordingly, in some embodiments, as shown in FIG. 19F, when the computer system 101 decreases the angle of elevation 1911 of the three-dimensional object 1920 relative to the viewpoint of the user, the computer system 101 forgoes rotating the three-dimensional object 1920 in the three-dimensional environment 1900. For example, as shown in the side view 1940 in FIG. 19F, the computer system 101 forgoes tilting the first portion 1906 of the three-dimensional object 1920 to face toward the location of the viewpoint of the user in the three-dimensional environment 1900. Additionally, because the three-dimensional object 1920 is not rotated when changing the angle of elevation 1911 of the three-dimensional object 1920 relative to the viewpoint of the user, the computer system 101 changes the reference angle 1913 of the three-dimensional object 1920. For example, as shown in the side view 1940 in FIG. 19F, the computer system 101 increases the reference angle 1913 to maintain the three-dimensional object 1920 at the first orientation (e.g., at or near level (e.g., non-tilted)) in the three-dimensional environment 1900 relative to the viewpoint of the user. In some embodiments, as shown in FIG. 19F, when the angle of elevation 1911 of the three-dimensional object 1920 is updated in accordance with the input provided by the hand 1903, a larger portion of the top of the content of the three-dimensional object 1920 is visible in the three-dimensional environment 1900 from the viewpoint of the user.

In FIG. 19F, the computer system 101 detects an input provided by hand 1903 corresponding to a request to change the angle of elevation 1911 of the three-dimensional object 1920 in the three-dimensional environment 1900. For example, as shown in FIG. 19F, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 in an upward direction relative to the viewpoint of the user.

In some embodiments, as shown in FIG. 19G, in response to detecting the input provided by the hand 1903, the computer system 101 changes the angle of elevation 1911 of the three-dimensional object 1920 relative to the viewpoint of the user in accordance with the movement of the hand 1903. For example, as illustrated in the side view 1940 in FIG. 19G, because the movement of the hand 1903 is upward in space relative to the viewpoint of the user, the computer system 101 increases the angle of elevation 1911 of the three-dimensional object 1920 relative to the viewpoint of the user, such that the three-dimensional object 1920 is spatially located higher in the field of view of the user in the three-dimensional environment 1900. Additionally, as shown in the side view 1940 in FIG. 19G, because the change in the angle of elevation 1911 causes the three-dimensional object 1920 to be greater than (e.g., outside of) the range 1918 of angles of elevation in the three-dimensional environment 1900, the computer system 101 rotates the three-dimensional object 1920 in the three-dimensional environment 1900. For example, as shown in FIG. 19G, the computer system 101 tilts the first portion 1906 of the three-dimensional object 1920 to face toward the location of the viewpoint of the user in the three-dimensional environment 1900 based on the change in the angle of elevation 1911 of the three-dimensional object 1920 relative to the viewpoint of the user. Additionally, as shown in the side view 1940 in FIG. 19G, when the computer system 101 rotates the three-dimensional object 1920 in the manner discussed above, the reference angle 1913 is reset to the initial reference angle 1913 in FIG. 19E (e.g., the reference angle 1913 of the three-dimensional object 1920 when the three-dimensional object 1920 is initially displayed in the three-dimensional environment 1900). As illustrated in the side view 1940 in FIG. 19G, in some embodiments, the rotation (e.g., tilt) of the three-dimensional object 1920 in the three-dimensional environment 1900 is based on (e.g., matches and/or corresponds to) the reference angle 1913.

In FIG. 19G, the computer system 101 detects an input provided by hand 1903 corresponding to a request to change the angle of elevation 1911 of the three-dimensional object 1920 in the three-dimensional environment 1900. For example, as shown in FIG. 19G, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 in an upward direction relative to the viewpoint of the user.

In some embodiments, as shown in FIG. 19H, in response to detecting the input provided by the hand 1903, the computer system 101 updates the angle of elevation 1911 of the three-dimensional object 1920 relative to the viewpoint of the user in the three-dimensional environment 1900. For example, as illustrated in the side view 1940 in FIG. 19H, the computer system 101 further increases the angle of elevation 1911 relative to the viewpoint of the user, such that the three-dimensional object 1920 is spatially located higher in the field of view of the user in the three-dimensional environment 1900. Additionally, as shown in FIG. 19H, because the change in the angle of elevation 1911 of the three-dimensional object 1920 relative to the viewpoint of the user causes the angle of elevation 1911 to remain above (e.g., outside of) the range 1918 of the angles of elevation discussed above, the computer system 101 further rotates the three-dimensional object 1920 in the three-dimensional environment 1900. For example, as illustrated in the side view 1940 in FIG. 19H, the computer system 101 further tilts the first portion 1906 of the three-dimensional object 1920 to face toward the location of the viewpoint of the user in the three-dimensional environment 1900 based on the further change in the angle of elevation 1911 of the three-dimensional object 1920 relative to the viewpoint of the user. As illustrated in the side view 1940, in some embodiments, in FIG. 19H, when the three-dimensional object 1920 is rotated in the three-dimensional environment 1900, the reference angle 1913 is maintained. For example, while the angle of elevation 1911 of the three-dimensional object relative to the viewpoint of the user is greater than the range 1918 of angles of elevation, the reference angle 1913 is fixed.

In FIG. 19H, the computer system 101 detects an input provided by hand 1903 corresponding to a request to change the angle of elevation 1911 of the three-dimensional object 1920 in the three-dimensional environment 1900. For example, as shown in FIG. 19H, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 in an upward direction relative to the viewpoint of the user.

In some embodiments, as shown in FIG. 19I, in response to detecting the input provided by the hand 1903, the computer system 101 updates the angle of elevation 1911 of the three-dimensional object 1920 relative to the viewpoint of the user in the three-dimensional environment 1900. For example, as illustrated in the side view 1940 in FIG. 19I, the computer system 101 further increases the angle of elevation 1911 relative to the viewpoint of the user, such that the three-dimensional object 1920 is spatially located higher in the field of view of the user in the three-dimensional environment 1900. Additionally, as shown in FIG. 19I, because the change in the angle of elevation 1911 of the three-dimensional object 1920 relative to the viewpoint of the user causes the angle of elevation 1911 to remain above (e.g., outside of) the range 1918 of the angles of elevation discussed above, the computer system 101 further rotates the three-dimensional object 1920 in the three-dimensional environment 1900. For example, as illustrated in the side view 1940 in FIG. 19I, the computer system 101 further tilts the first portion 1906 of the three-dimensional object 1920 to face toward the location of the viewpoint of the user in the three-dimensional environment 1900 based on the further change in the angle of elevation 1911 of the three-dimensional object 1920 relative to the viewpoint of the user. As illustrated in the side view 1940 in FIG. 19I, in some embodiments, when the three-dimensional object 1920 is rotated in the three-dimensional environment 1900, the reference angle 1913 is maintained. For example, while the angle of elevation 1911 of the three-dimensional object relative to the viewpoint of the user is greater than the range 1918 of angles of elevation, the reference angle 1913 is fixed.

In FIG. 19I, the computer system 101 detects an input provided by hand 1903 corresponding to a request to move the three-dimensional object 1920 relative to the viewpoint of the user in the three-dimensional environment 1900. For example, as shown in FIG. 19I, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 toward the viewpoint of the user.

In some embodiments, as shown in FIG. 19J, in response to the input provided by the hand 1903, the computer system 101 moves the three-dimensional object 1920 relative to the viewpoint of the user in accordance with the movement of the hand 1903. For example, as shown in FIG. 19J, the computer system 101 moves the three-dimensional object 1920 toward the viewpoint of the user in the three-dimensional environment 1900. In some embodiments, when the computer system 101 moves the three-dimensional object 1920 toward the viewpoint of the user, the distance between the viewpoint of the user and the three-dimensional object 1920 changes in the three-dimensional environment 1900 (e.g., decreases in the three-dimensional environment 1900). In some embodiments, the change in the distance between the viewpoint of the user and the three-dimensional object 1920 causes the reference angle 1913 to change based on the updated distance. For example, as illustrated in the side view 1940 in FIG. 19J, the computer system 101 increases the reference angle 1913 of the three-dimensional object 1920, which further causes the three-dimensional object 1920 to be further rotated (e.g., tilted) in the three-dimensional environment 1900 relative to the viewpoint of the user.

In FIG. 19J, the computer system 101 detects an input provided by hand 1903 corresponding to a request to change the angle of elevation 1911 of the three-dimensional object 1920 in the three-dimensional environment 1900. For example, as shown in FIG. 19J, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 in a downward direction relative to the viewpoint of the user.

In some embodiments, as shown in FIG. 19K, in response to detecting the input provided by the hand 1903, the computer system 101 updates the angle of elevation 1911 of the three-dimensional object 1920 relative to the viewpoint of the user in the three-dimensional environment 1900. For example, as illustrated in the side view 1940 in FIG. 19K, the computer system 101 decreases the angle of elevation 1911 relative to the viewpoint of the user, such that the three-dimensional object 1920 is spatially located lower in the field of view of the user in the three-dimensional environment 1900. Additionally, as shown in FIG. 19K, because the change in the angle of elevation 1911 of the three-dimensional object 1920 relative to the viewpoint of the user causes the angle of elevation 1911 to remain above (e.g., outside of) the range 1918 of the angles of elevation discussed above, the computer system 101 rotates the three-dimensional object 1920 in the three-dimensional environment 1900. For example, as illustrated in the side view 1940 in FIG. 19K, the computer system 101 tilts the first portion 1906 of the three-dimensional object 1920 to face toward the location of the viewpoint of the user in the three-dimensional environment 1900 based on the change in the angle of elevation 1911 of the three-dimensional object 1920 relative to the viewpoint of the user. Additionally, as illustrated in the side view 1940 in FIG. 19K, in some embodiments, when the three-dimensional object 1920 is rotated in the three-dimensional environment 1900, the reference angle 1913 is maintained, as similarly discussed above.

In FIG. 19K, the computer system 101 detects an input provided by hand 1903 corresponding to a request to move the three-dimensional object 1920 relative to the viewpoint of the user in the three-dimensional environment 1900. For example, as shown in FIG. 19K, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 rightward relative to the viewpoint of the user.

In some embodiments, as shown in FIG. 19L, in response to the input provided by the hand 1903, the computer system 101 moves the three-dimensional object 1920 relative to the viewpoint of the user in accordance with the movement of the hand 1903. For example, as shown in FIG. 19L, the computer system 101 moves the three-dimensional object 1920 rightward relative to the viewpoint of the user in the three-dimensional environment 1900.

In some embodiments, when the computer system 101 moves the three-dimensional object 1920 laterally (e.g., rightward) relative the viewpoint of the user, the computer system 101 rotates the three-dimensional object 1920 based on the angle of elevation 1911 of the three-dimensional object 1920 relative to the viewpoint of the user. Particularly, as illustrated in the side view 1940 in FIG. 19L, the computer system 101 rotates the three-dimensional object 1920 about an axis 1924 through (e.g., a center of) the head 1908 of the user in response to detecting the input corresponding to the request to move the three-dimensional object 1920 laterally in the three-dimensional environment 1900. In some embodiments, as illustrated in top-down view 1941 in FIG. 19L, when the three-dimensional object 1920 is rotated about the axis 1924 in the three-dimensional environment, the front-facing surface of the three-dimensional object 1920 continues to face toward the location of the viewpoint of the user in the three-dimensional environment 1900. Additional details regarding the rotation of the three-dimensional object 1920 about the axis 1924 in the three-dimensional environment 1900 are provided with reference to methods 800 and/or 2000.

In some embodiments, because the lateral movement of the three-dimensional object 1920 does not cause the angle of elevation 1911 of the three-dimensional object 1920 to change relative to the viewpoint of the user, the computer system 101 forgoes rotating the three-dimensional object to tilt the first portion 1906 of the three-dimensional object 1920 to face toward the location of the viewpoint of the user in the three-dimensional environment. Additionally, as illustrated in the side view 1940 in FIG. 19L, the reference angle 1913 of the three-dimensional object 1920 is also maintained in the three-dimensional environment 1900.

In FIG. 19L, the computer system 101 detects an input provided by hand 1903 corresponding to a request to move the three-dimensional object 1920 relative to the viewpoint of the user in the three-dimensional environment 1900. For example, as shown in FIG. 19L, the computer system 101 detects hand 1903 provide an air drag gesture, such as an air pinch gesture followed by movement of the hand 1903 in space, while the attention (e.g., including the gaze 1926) of the user is directed to the movement element 1936 that is displayed with the three-dimensional object 1920. In some embodiments, the computer system 101 detects the movement of the hand 1903 leftward relative to the viewpoint of the user.

In some embodiments, as shown in FIG. 19M, in response to the input provided by the hand 1903, the computer system 101 moves the three-dimensional object 1920 relative to the viewpoint of the user in accordance with the movement of the hand 1903. For example, as shown in FIG. 19M, the computer system 101 moves the three-dimensional object 1920 leftward relative to the viewpoint of the user in the three-dimensional environment 1900. Additionally, in some embodiments, as similarly discussed above, when the computer system 101 moves the three-dimensional object 1920 laterally (e.g., leftward) relative the viewpoint of the user, the computer system 101 rotates the three-dimensional object 1920 based on the angle of elevation 1911 of the three-dimensional object 1920 relative to the viewpoint of the user. Particularly, as illustrated in the side view 1940 in FIG. 19M, the computer system 101 rotates the three-dimensional object 1920 about the axis 1924 through (e.g., a center of) the head 1908 of the user in response to detecting the input corresponding to the request to move the three-dimensional object 1920 laterally in the three-dimensional environment 1900.

In FIG. 19M, the computer system 101 detects movement of the viewpoint of the user relative to the three-dimensional environment 1900. For example, as illustrated in the side view 1940 in FIG. 19M, the computer system 101 detects downward movement of the viewpoint of the user, such that a height of the head 1908 of the user relative to a ground of the physical environment of the computer system 101 decreases, as illustrated in the side view 1940 in FIG. 19N (e.g., the user sitting on the ground).

In some embodiments, as shown in FIG. 19N, when the viewpoint of the user is updated according to the downward movement discussed above, the three-dimensional object 1920 is located higher in the field of view of the user in the three-dimensional environment 1900 from the updated viewpoint of the user. Additionally, as illustrated in FIG. 19N, the downward movement of the viewpoint causes the three-dimensional object 1920 to be located at a distance in the three-dimensional environment 1900 that is farther from the viewpoint of the user than the distance in FIG. 19M, which optionally causes the three-dimensional object 1920 to appear smaller (e.g., have a smaller apparent size) in the three-dimensional environment 1900 from the updated viewpoint of the user. In some embodiments, as shown in the side view 1940 in FIG. 19N, the computer system 101 forgoes updating the angle of elevation 1911 of the three-dimensional object 1920 based on the movement of the viewpoint of the user, and therefore forgoes rotating (e.g., tilting) the three-dimensional object 1920 such that the first portion 1906 faces toward the location of the updated viewpoint of the user in the three-dimensional environment 1900. For example, as shown in the side view 1940, the computer system 101 forgoes updating the vector 1909 based on the updated viewpoint of the user and/or the horizon plane 1910. Similarly, because the horizon plane 1910 is not updated in the three-dimensional environment 1900, the range 1918 of angles of elevation is not updated in the three-dimensional environment 1900.

In FIG. 19N, the computer system 101 detects interaction with the three-dimensional object 1920 after and/or during the downward movement of the viewpoint of the user discussed above. For example, as shown in FIG. 19N, the computer system 101 detects an air pinch gesture, optionally while the attention (e.g., including gaze 1926) of the user is directed toward the movement element 1936 that is displayed with the three-dimensional object 1920 in the three-dimensional environment 1900. In some embodiments, the input corresponds to a selection of the movement element 1936 in the three-dimensional environment 1900. In some embodiments, the computer system 101 detects the air pinch gesture without detecting movement of the hand 1903 of the user.

In some embodiments, as shown in FIG. 19O, in response to detecting the interaction with the three-dimensional object 1920 in the three-dimensional environment 1900, the computer system 101 updates the angle of elevation 1911 of the three-dimensional object 1920 based on the updated viewpoint of the user. For example, as illustrated in the side view 1940 in FIG. 19O, the computer system 101 updates the vector 1909 to be based on the updated location of the head 1908 and updates the horizon plane 1910 based on the updated viewpoint of the user in the three-dimensional environment 1900. In some embodiments, updating the horizon plane 1910 causes the range 1918 of the angles of elevation to be updated (e.g., shifted downward) as well in the three-dimensional environment 1900, as illustrated in the side view 1940 in FIG. 19O. In some embodiments, updating the angle of elevation 1911 of the three-dimensional object 1920 to be relative to the updated viewpoint of the user causes the orientation of the three-dimensional object 1920 to (e.g., gradually) be updated in the three-dimensional environment 1900 relative to the viewpoint of the user. For example, in FIG. 19O, the computer system 101 initiates rotation of the three-dimensional object 1920 in the three-dimensional environment 1900, such that the first portion 1906 is gradually tilted to face toward the location of the updated viewpoint of the user in the three-dimensional environment 1900.

Additionally, in some embodiments, updating the angle of elevation 1911 of the three-dimensional object 1920 to be relative to the updated viewpoint of the user causes the location of the three-dimensional object 1920 to (e.g., gradually) be updated in the three-dimensional environment 1900 relative to the viewpoint of the user. For example, in FIG. 19O, the computer system 101 initiates movement of the three-dimensional object 1920 in the three-dimensional environment 1900, such that the three-dimensional object 1920 is gradually moved toward the location of the updated viewpoint of the user in the three-dimensional environment 1900. In some embodiments, moving the three-dimensional object 1920 causes the (e.g., apparent) size of the three-dimensional object 1920 to change from the updated viewpoint of the user in the three-dimensional environment 1900. For example, the movement of the three-dimensional object 1920 toward the location of the updated viewpoint of the user causes the size of the three-dimensional object 1920 to gradually increase in the field of view of the user from the updated viewpoint of the user in the three-dimensional environment 1900.

FIG. 19P illustrates a completion of the (e.g., gradual) rotation of the three-dimensional object 1920 in the three-dimensional environment 1900 to face toward the location of the updated viewpoint of the user, including a completion of the (e.g., gradual) movement of the three-dimensional object 1920 toward the location of the updated viewpoint in the three-dimensional environment 1900 and/or a completion of the (e.g., gradual) increase in (e.g., apparent) size of the three-dimensional object 1920 in the three-dimensional environment 1900 relative to the updated viewpoint of the user. As illustrated in the side view 1940 in FIG. 19P, upon the completion of the rotation of the three-dimensional object 1920 to be based on the updated viewpoint of the user in the three-dimensional environment 1900, the reference angle 1913 is returned to the fixed value discussed previously herein, such as the reference angle 1913 in FIG. 19M.

FIGS. 19Q-19R illustrate an example of changing the angle of elevation 1911 of the three-dimensional object 1920 while the tilt mode setting for the three-dimensional object 1920 is not active. For example, in FIG. 19Q, while displaying the three-dimensional object 1920 in the three-dimensional environment 1900, the computer system 101 detects an input corresponding to a request to change the angle of elevation 1911 of the three-dimensional object 1920 while the tilt mode setting for the three-dimensional object 1920 is not active, as illustrated via indication 1914. In some embodiments, as similarly discussed above, the tilt mode setting for the three-dimensional object 1920 is deactivated via settings 1938 in the user interface 1932 in FIG. 19C (e.g., in response to detecting input directed to the “Tilt Mode” setting corresponding to a request to deactivate/reconfigure tilting of the three-dimensional object 1920). In some embodiments, as shown in FIG. 19Q, the input corresponds to an air pinch and drag gesture provided by the hand 1903 of the user, optionally while the attention (e.g., including gaze 1926) of the user is directed to the movement element 1936 that is displayed with the three-dimensional object 1920 in the three-dimensional environment 1900. In some embodiments, as shown in FIG. 19Q, the movement of the hand 1903 corresponds to movement of the three-dimensional object 1920 in an upward direction relative to the viewpoint of the user.

In some embodiments, as shown in FIG. 19R, in response to detecting the input provided by the hand 1903, the computer system 101 changes the angle of elevation 1911 of the three-dimensional object 1920 in the three-dimensional environment 1900 relative to the viewpoint of the user. For example, as illustrated in FIG. 19R, the computer system 101 moves the three-dimensional object 1920 upward in the three-dimensional environment 1900 relative to the viewpoint of the user in accordance with the movement of the hand 1903, such that the three-dimensional object 1920 is located higher in the field of view of the user from the viewpoint of the user in the three-dimensional environment 1900.

In some embodiments, as shown in FIG. 19R, when the computer system 101 changes the angle of elevation 1911 of the three-dimensional object 1920, the computer system 101 forgoes rotating the three-dimensional object 1920 in the three-dimensional environment 1900 based on the change in the angle of elevation 1911. For example, as illustrated in the side view 1940 in FIG. 19R, the computer system 101 forgoes tilting the first portion 1906 of the three-dimensional object 1920 toward the location of the viewpoint of the user in the three-dimensional environment 1900. In some embodiments, as alluded to above, the computer system 101 forgoes rotating the three-dimensional object 1920 based on the change in the angle of elevation 1911 due to the deactivation of the tilt mode setting of the three-dimensional object 1920. Particularly, because the tilt mode setting is not active in FIG. 19Q when the computer system 101 detects the input provided by the hand 1903, the computer system 101 forgoes rotating/tilting the three-dimensional object 1920 when the angle of elevation 1911 is increased in response to detecting the input, as illustrated in the side view 1940 in FIG. 19R. Further, as illustrated in the side view 1940 in FIG. 19R, because the tilt mode setting for the three-dimensional object 1920 is not active when the input is detected in FIG. 19Q, the three-dimensional object 1920 is not rotated/tilted despite the angle of elevation 1911 being outside of (e.g., greater than) the range 1918 of angles of elevation discussed previously herein.

FIG. 20 is a flowchart illustrating a method of facilitating rotation of a volumetric virtual object in a three-dimensional environment in accordance with some embodiments. In some embodiments, the method 2000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2000 are, optionally, combined and/or the order of some operations is, optionally, changed.

In some embodiments, method 2000 is performed at a computer system (e.g., computer system 101) in communication with a display generation component (e.g., display generation component 120) and one or more input devices (e.g., image sensors 114a-114c). For example, the computer system is or includes a mobile device (e.g., a tablet, a smartphone, a media player, or a wearable device), or a computer. In some embodiments, the computer system has one or more characteristics of the computer system in methods 800, 1000, 1200, 1400, 1600, and/or 1800. In some embodiments, the display generation component has one or more characteristics of the display generation component in methods 800, 1000, 1200, 1400, 1600, and/or 1800. In some embodiments, the one or more input devices have one or more characteristics of the one or more input devices in methods 800, 1000, 1200, 1400, 1600, and/or 1800.

In some embodiments, while displaying, via the display generation component, a three-dimensional object (e.g., a virtual object) in an environment, such as three-dimensional object 1920 in three-dimensional environment 1900 in FIG. 19E, the computer system detects (2002a), via the one or more input devices, a first input corresponding to a request to change an angle of elevation of the three-dimensional object relative to a viewpoint of a user of the computer system within the environment, such as the input provided by hand 1903 as shown in FIG. 19E. In some embodiments, the environment is a three-dimensional environment that at least partially incorporates a representation of the real-world physical environment of the user while using the computer system (e.g., via active or passive passthrough). In some embodiments, the environment has one or more characteristics of the environments in methods 800, 1000, 1200, 1400, 1600, and/or 1800. In some embodiments, a virtual object refers to an object that is displayed by the computer system in the environment, that is generated by the computer system and is not part of the physical real-world environment. In some embodiments, the three-dimensional object corresponds to a virtual object having a volume (e.g., an apparent volume) in the environment. For example, the three-dimensional object corresponds to a three-dimensional virtual model or structure, a three-dimensional virtual shape, a three-dimensional virtual image, or other three-dimensional virtual content. In some embodiments, the three-dimensional object has one or more characteristics of the objects in methods 800, 1000, 1200, 1400, 1600, and/or 1800. In some embodiments, the three-dimensional object is displayed at a first location and/or has a first orientation in the environment (optionally in the field of view of the user of the computer system from the current viewpoint of the user in the environment). In some embodiments, detecting the first input includes detecting an air pinch gesture performed by a hand of the user of the computer system-such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the computer system while attention (e.g., including gaze) of the user is directed toward the virtual object. In some embodiments, the computer system detects the air pinch gesture directed toward a selection element (e.g., a grabber or handlebar element) associated with the three-dimensional object that is selectable to initiate movement of the three-dimensional object in the environment. In some embodiments, after detecting the air pinch gesture, the computer system detects movement of a portion of the user. For example, the computer system detects movement of the hand of the user in space, such as a movement while the hand is holding the pinch hand shape (e.g., the tips of the thumb and index finger remain touching) such as an air drag gesture. In some embodiments, the movement of the hand of the user is longitudinally (e.g., in a vertical direction relative to the viewpoint of the user) in space that is toward a second location in the environment. For example, the first input includes movement of the hand of the user that is vertical (or has a vertical component, such as diagonal movement) relative to gravity, or a combination of vertical and lateral movement occurring concurrently. In some embodiments, the movement input does not include and/or correspond to a request to rotate (e.g., change an orientation of) the three-dimensional object relative to the viewpoint of the user and/or the environment. For example, the movement of the hand of the user discussed above does not include a component that controls/defines rotation/tilt of the three-dimensional object relative to the viewpoint of the user and/or the three-dimensional environment. In some embodiments, the movement input has one or more characteristics of the inputs for moving objects described with respect to methods 800, 1000, 1200, 1400, 1600, and/or 1800.

In some embodiments, when the first input is detected, the three-dimensional object has a first angle of elevation (e.g., 0, 1, 2, 3, 5, 10, 15, 18, 20, 25, or 30 degrees) relative to the viewpoint of the user in the environment. In some embodiments, the angle of elevation of the three-dimensional environment is determined relative to a first portion of the user of the computer system, such as a location of the head of the user in space. In some embodiments, an angle of elevation relative to the viewpoint of the user corresponds to an angle of elevation relative to a horizon of the environment of the user and/or a horizon of the physical space of the user (e.g., independent of the field of view of the user). For example, the angle of elevation relative to the viewpoint of the user is measured relative to a first vector or plane (e.g., parallel to a ground/surface on which the user is positioned) extending from the user's head that is normal (e.g., or within 1, 2, 3, 4, 5, 8, or 10 degrees of being normal) to a horizontal axis across (e.g., a center of) the user's field of view and/or a plane of the horizon of the physical space of the user (e.g., independent of the field of view of the user). Additionally or alternatively, in some embodiments, the first vector is parallel to a floor of the physical environment surrounding the user (e.g., the first vector extends laterally (horizontally) from the head of the user in the direction of the lateral orientation of the three-dimensional object relative to the viewpoint/head of the user and is independent of a vertical and/or lateral orientation of the viewpoint and/or head of the user). For example, the first vector is determined irrespective of the location and/or direction of the attention (e.g., including gaze) of the user in the three-dimensional environment. Accordingly, in some embodiments, when determining the angle of elevation of the three-dimensional object in the three-dimensional environment relative to the location corresponding to the first portion of the user, the computer system evaluates the angle of elevation of the three-dimensional object relative to the first vector extending from the user's head (and, in some embodiments, the computer system) toward the horizon. For example, the angle of elevation of the three-dimensional object in the three-dimensional environment is an angle that is measured between the first vector described above and a second vector that extends from the (e.g., center of) the user's head to (e.g., a center of) of the three-dimensional object in the three-dimensional environment. In some embodiments, the angle of elevation of the three-dimensional object has one or more characteristics of the angle of elevation of the object in method 800, such as the angle of elevation of virtual object 706a in FIG. 7A.

In some embodiments, in response to detecting the first input (2002b), in accordance with a determination that the first input satisfies a first set of one or more criteria, the computer system changes (2002c) the angle of elevation of the three-dimensional object relative to the viewpoint of the user in the environment based on the first input (e.g., based on a direction, distance, and/or speed of the first input) and rotates the three-dimensional object in the environment to tilt a first portion (e.g., a first side) of the three-dimensional object toward a location of the viewpoint based on the change in the angle of elevation of the three-dimensional object relative to the viewpoint of the user (e.g., by rotating the three-dimensional object about a first axis in the environment, such as displaying the three-dimensional object with a second orientation relative to the environment, different from the first (e.g., initial) orientation of the three-dimensional object above), such as increasing angle of elevation 1911 of three-dimensional object 1920 and tilting the three-dimensional object 1920 as shown in side view 1940 in FIG. 19G. In some embodiments, as described in more detail below, satisfaction of the first set of one or more criteria is based on a magnitude of the change in the angle of elevation of the three-dimensional object relative to the viewpoint of the user in the environment in response to the first input (e.g., relative to the first (e.g., initial) angle of elevation of the three-dimensional object discussed above). In some embodiments, satisfaction of the first set of one or more criteria is based on a direction of the change in the angle of elevation of the three-dimensional object relative to the viewpoint of the user in the environment in response to the first input (e.g., whether the first input causes the angle of elevation of the three-dimensional environment to increase or decrease relative to the first (e.g., initial) angle of elevation of the three-dimensional object), as discussed in more detail below. In some embodiments, as discussed in more detail below, satisfaction of the first set of one or more criteria is based on the initial/starting angle of elevation of the three-dimensional object (e.g., the first angle of elevation discussed above) relative to the viewpoint of the user in the environment when the first input is detected. In some embodiments, in accordance with the determination that the first input satisfies the first set of one or more criteria, the computer system moves the three-dimensional object in the environment relative to the viewpoint of the user, such that the three-dimensional object has a second angle of elevation, different from the first angle of elevation discussed above, relative to the viewpoint of the user in the environment based on the first input. For example, the computer system moves the three-dimensional object in a vertical direction relative to the viewpoint of the user in accordance with the vertical movement of the hand of the user in space. In some embodiments, the three-dimensional object is moved laterally and vertically (e.g., successively, or concurrently (e.g., the three-dimensional object is moved diagonally)) in the three-dimensional environment relative to gravity in accordance with the vertical and lateral components of movement of the first input. In some embodiments, changing the angle of elevation of the three-dimensional object relative to the viewpoint of the user in the environment based on the first input includes increasing or decreasing the angle of elevation relative to the viewpoint of the user in the environment.

Additionally, in some embodiments, when the electronic device changes the angle of elevation relative to the viewpoint of the user in the environment in response to detecting the first input, the electronic device rotates (e.g., tilts) the three-dimensional object relative to the viewpoint of the user in the environment in accordance with the determination that the set of criteria is satisfied, such as the rotation of three-dimensional object 1920 in three-dimensional environment 1900 in FIG. 19G. In some embodiments, the first portion of the three-dimensional object corresponds to a top side (optionally topmost side) of the three-dimensional object. In some embodiments, the first portion of the three-dimensional object corresponds to a bottom side (optionally bottommost side, such as a base) of the three-dimensional object. In some embodiments, the first axis mentioned above corresponds to a horizontal axis through (e.g., a center of) the head of the user. For example, the computer system rotates the virtual object about an axis through (e.g., a center) of the three-dimensional object and that is perpendicular to the second vector described above (e.g., the vector extending from the user's head to (e.g., the center of) the three-dimensional object, as the three-dimensional object is moved vertically in the three-dimensional environment, causing the first portion of the three-dimensional object to tilt toward the viewpoint of the user in the environment. In some embodiments, a direction of the rotation of the three-dimensional object is based on the direction of longitudinal movement of the three-dimensional object in the three-dimensional environment. For example, if the first input causes the computer system to move the three-dimensional object upward relative to the viewpoint of the user in the three-dimensional environment, the computer system rotates the three-dimensional object counterclockwise about the first axis in the three-dimensional environment (e.g., radially along a sphere centered at the user's head), such that the first portion of the three-dimensional object is tilted downward to face toward the viewpoint of the user in the environment. Similarly, if the first input causes the computer system to move the three-dimensional object downward in the three-dimensional environment, the computer system optionally rotates the virtual object clockwise about the first axis in the three-dimensional environment, such that the first portion of the three-dimensional object is tilted upward to face toward the viewpoint of the user in the environment. In some embodiments, the direction of the rotation of the three-dimensional object (e.g., clockwise or counterclockwise rotation) about the first axis in the environment corresponds to a sign (e.g., positive or negative) of a cross product of the first axis (e.g., a vector parallel to the first axis) and a vector through an edge (e.g., base) of a surface of the three-dimensional object. For example, whether the rotation of the three-dimensional object is clockwise or counterclockwise about the first axis in the environment is determined using the right hand rule (e.g., in which the direction of the thumb of the right hand dictates/corresponds to the direction of the rotation of the three-dimensional object relative to the viewpoint of the user). In some embodiments, an amount (e.g., an angular amount) of the rotation of the three-dimensional object about the first axis is based on the degree of change of the angle of elevation of the three-dimensional object in the three-dimensional environment. For example, if the first input causes the computer system to change the angle of elevation of the three-dimensional object by a first amount (e.g., a first number of degrees) in the three-dimensional environment, the computer system rotates the three-dimensional object (e.g., clockwise or counterclockwise) about the first axis by a first angular amount that is based on (e.g., equivalent to or proportional to) the first amount. Similarly, if the first input causes the computer system to change the angle of elevation of the three-dimensional object by a second amount, greater than the first amount, in the three-dimensional environment, the computer system optionally rotates the three-dimensional object about the first axis by a second angular amount, greater than the first angular amount, that is based on the second amount. In some embodiments, rotating the three-dimensional object has one or more characteristics of rotating the object in method 800, such as rotating the virtual object 706a as shown in FIG. 7B. Rotating a three-dimensional object in a three-dimensional environment when changing an angle of elevation of the three-dimensional object relative to the viewpoint of the user in response to detecting movement of the object in the three-dimensional environment enables the three-dimensional object to automatically remain visibly displayed and/or oriented towards the viewpoint of the user in the user's field of view after the movement of the object, which negates and/or reduces a number of inputs that would be needed to reorient the three-dimensional object in the user's field of view of the three-dimensional environment, thereby improving user-device interaction.

In some embodiments, in response to detecting the first input, in accordance with a determination that the first input does not satisfy the first set of one or more criteria, the computer system changes the angle of elevation of the three-dimensional object relative to the viewpoint of the user in the environment based on the first input (e.g., based on a direction, distance, and/or speed of the first input), without rotating the three-dimensional object in the environment, such as decreasing the angle of elevation 1911 of the three-dimensional object 1920 without tilting the three-dimensional object 1920 as shown in the side view 1940 in FIG. 19F. For example, as similarly described above, in response to detecting the first input, the computer system moves the three-dimensional object in a vertical direction (and/or in a horizontal direction) relative to the viewpoint of the user in accordance with the vertical (e.g., and/or horizontal) movement of the hand of the user in space. In some embodiments, because the first input does not satisfy the first set of one or more criteria, the first computer system forgoes tilting first portion (e.g., a first side) of the three-dimensional object toward a location of the viewpoint based on the change in the angle of elevation of the three-dimensional object relative to the viewpoint of the user (e.g., by rotating the three-dimensional object about a first axis in the environment, such as displaying the three-dimensional object with a second orientation relative to the environment, different from the first (e.g., initial) orientation of the three-dimensional object above). Accordingly, the computer system changes the angle of elevation of the three-dimensional object relative to the viewpoint of the user in the environment based on the first input irrespective of whether the first set of one or more criteria is satisfied. Changing an angle of elevation of a three-dimensional object relative to the viewpoint of the user without rotating the three-dimensional object in a three-dimensional environment in response to detecting movement of the object that does not satisfy one or more criteria enables the three-dimensional object to automatically remain visibly displayed and/or helps avoid unnecessary and/or unintentional tilting of the three-dimensional object in the user's field of view of the three-dimensional environment, thereby improving user-device interaction and preserving computing resources.

In some embodiments, in response to detecting the first input and in accordance with the determination that the first input satisfies the first set of one or more criteria, in accordance with a determination that the change in the angle of elevation of the three-dimensional object relative to the viewpoint of the user in the environment based on the first input is a first amount of change (e.g., a first vertical distance and/or a first number of degrees), the three-dimensional object is rotated by a first amount in the environment, such as the rotation of the three-dimensional object 1920 based on the movement of the hand 1903 as shown in FIG. 19G. In some embodiments, in accordance with a determination that the change in the angle of elevation of the three-dimensional object relative to the viewpoint of the user in the environment based on the first input is a second amount, different from the first amount, of change, the three-dimensional object is rotated by a second amount (e.g., a second vertical distance and/or a second number of degrees), different from the first amount, in the environment, such as the rotation of the three-dimensional object 1920 based on the movement of the hand 1903 as shown in FIG. 19H. For example, as similarly discussed above, the computer system rotates (e.g., tilts the first portion of) the three-dimensional object in the environment by an amount that is based on (e.g., corresponds to and/or is proportional to) a magnitude (e.g., of distance) of the change in the angle of elevation of the three-dimensional object relative to the viewpoint of the user in the environment. In some embodiments, if the first amount of change in the angle of elevation of the three-dimensional object relative to the viewpoint of the user is greater than the second amount of change, the first amount of rotation of the three-dimensional object is greater than the second amount of rotation. In some embodiments, if the first amount of change in the angle of elevation of the three-dimensional object relative to the viewpoint of the user is less than the second amount of change, the first amount of rotation of the three-dimensional object is less than the second amount of rotation. Rotating a three-dimensional object in a three-dimensional environment by an amount that is based on a magnitude of a change in an angle of elevation of the three-dimensional object relative to the viewpoint of the user in response to detecting movement of the object in the three-dimensional environment enables the three-dimensional object to automatically remain visibly displayed and/or oriented towards the viewpoint of the user in the user's field of view based on the movement of the object, which negates and/or reduces a number of inputs that would be needed to reorient the three-dimensional object in the user's field of view of the three-dimensional environment, thereby improving user-device interaction.

In some embodiments, the first set of one or more criteria includes a criterion that is satisfied when a respective setting associated with rotation of the three-dimensional object is enabled, such as activation of the tilt mode setting in settings 1938 as shown in FIG. 19C. For example, the rotation of the three-dimensional object in the environment is controlled by a rotation setting, such as via a toggle, a switch, a button (e.g., virtual button or hardware button), or other user interface element, that is selectable/controllable by the user for enabling and disabling the rotation of the three-dimensional object. In some embodiments, while the respective setting is enabled, the computer system rotates the three-dimensional object in the environment when changing the angle of elevation of the three-dimensional object relative to the viewpoint of the user in response to user input as similarly discussed above. In some embodiments, while the respective setting is disabled, the computer system forgoes rotating the three-dimensional object in the environment when changing the angle of elevation of the three-dimensional object relative to the viewpoint of the user in response to user input. In some embodiments, the respective setting is accessible via (e.g., displayed in the environment via) a plurality of settings associated with the three-dimensional object and/or the environment, such as via a settings user interface for the three-dimensional object and/or the environment. In some embodiments, the respective setting is enabled based on the type of object of the three-dimensional object. For example, the respective setting is enabled for the three-dimensional object based on the application with which the three-dimensional object is associated, the size of the three-dimensional object in the environment, including a height of the three-dimensional object, and/or content included within and/or on the three-dimensional object. Rotating a three-dimensional object in a three-dimensional environment when changing an angle of elevation of the three-dimensional object relative to the viewpoint of the user based on whether a rotation setting for the three-dimensional object is enabled when detecting movement of the object in the three-dimensional environment enables the three-dimensional object to automatically remain visibly displayed and/or oriented towards the viewpoint of the user in the user's field of view after the movement of the object, which negates and/or reduces a number of inputs that would be needed to reorient the three-dimensional object in the user's field of view of the three-dimensional environment, thereby improving user-device interaction.

In some embodiments, the respective setting associated with the rotation of the three-dimensional object is enabled by default, as similarly described with reference to the tilt mode setting in the settings 1938 in FIG. 19C. For example, when the three-dimensional object is initially displayed in the environment (e.g., in response to detecting user input for displaying the three-dimensional object in the environment, such as via a selection of an icon or other selectable option corresponding to an application associated with the three-dimensional object), the rotation setting for the three-dimensional object is automatically enabled. Accordingly, unless the computer system detects input for disabling the respective setting, the first set of one or more criteria are satisfied when detecting the first input discussed above. In other words, the computer system rotates the three-dimensional object in the environment when changing the angle of elevation of the three-dimensional object relative to the viewpoint of the user based on the first input (e.g., and subsequent inputs) until the respective setting is disabled by the user. Rotating a three-dimensional object in a three-dimensional environment when changing an angle of elevation of the three-dimensional object relative to the viewpoint of the user based on whether a rotation setting for the three-dimensional object is enabled when detecting movement of the object in the three-dimensional environment enables the three-dimensional object to automatically remain visibly displayed and/or oriented towards the viewpoint of the user in the user's field of view after the movement of the object, which negates and/or reduces a number of inputs that would be needed to reorient the three-dimensional object in the user's field of view of the three-dimensional environment, thereby improving user-device interaction.

In some embodiments, the first set of one or more criteria includes a criterion that is satisfied when a direction of a change in the angle of elevation of the three-dimensional object relative to the viewpoint of the user in the environment is a first direction, such as increasing the angle of elevation 1911 of the three-dimensional object 1920 as shown in the side view 1940 in FIG. 19G, and that is not satisfied when the direction of the change in the angle of elevation of the three-dimensional object relative to the viewpoint of the user is a second direction, different from the first direction, such as decreasing the angle of elevation 1911 of the three-dimensional object 1920 as shown in the side view 1940 in FIG. 19F. For example, the rotation of the three-dimensional object in the environment is based on the direction of the movement of the three-dimensional object in the environment relative to the viewpoint of the user. In some embodiments, the first direction corresponds to upward (e.g., vertically) movement of the three-dimensional object relative to the viewpoint of the user in the environment. For example, the computer system tilts the first portion of the three-dimensional object to face toward the location of the viewpoint of the user in the environment in the manner discussed above in accordance with a determination that the change in the angle of elevation of the three-dimensional object corresponds to an increase in the angle of elevation of the three-dimensional object relative to the viewpoint of the user. Accordingly, in some embodiments, in accordance with a determination that the change in the angle of elevation of the three-dimensional object (e.g., in the second direction) corresponds to a decrease in the angle of elevation of the three-dimensional object relative to the viewpoint of the user (e.g., the three-dimensional object is moved downward (e.g., vertically) in the environment relative to the viewpoint of the user), the computer system forgoes rotating the three-dimensional object in the environment relative to the viewpoint of the user. Additionally or alternatively, in some embodiments, the criterion discussed above is specific to a particular angle of elevation and/or a respective range of angles of elevation of the three-dimensional object relative to the viewpoint of the user. For example, the first direction of the change in the angle of elevation of the three-dimensional object relative to the viewpoint of the user in the environment satisfies the first set of one or more criteria in accordance with a determination that the angle of elevation of the three-dimensional object relative to the viewpoint of the user when the first input is detected is a respective angle of elevation (e.g., −20, −15, −10, −5, 0, 5, 10, 15, or 20 degrees relative to the horizon plane) and/or is within a respective range of angles of elevation (e.g., a range between −20 and 20 degrees relative to the horizon plane). Accordingly, in some embodiments, the first direction and the second direction of the change in the angle of elevation of the three-dimensional object relative to the viewpoint of the user in the environment does not satisfy the first set of one or more criteria in accordance with a determination that the angle of elevation of the three-dimensional object relative to the viewpoint of the user when the first input is detected is within a second respective range of angles of elevation, different from the respective range of angles of elevation. Rotating a three-dimensional object in a three-dimensional environment when changing an angle of elevation of the three-dimensional object relative to the viewpoint of the user based on a direction of the change in the angle of elevation relative to the viewpoint in the three-dimensional environment enables the three-dimensional object to automatically remain visibly displayed and/or oriented towards the viewpoint of the user in the user's field of view when moving the object in a particular direction, which avoids and/or prevents consumption of computing resources on unneeded rotation of the three-dimensional object in the user's field of view of the three-dimensional environment, thereby improving user-device interaction and preserving computing resources.

In some embodiments, when the first input is detected, the angle of elevation of the three-dimensional object relative to the viewpoint of the user within the environment is within a threshold range of angles of elevation (e.g., a range from a value of −5 degrees relative to the horizon of the environment and below, −10 degrees relative to the horizon and below, −15 degrees relative to the horizon and below, −20 degrees relative to the horizon and below, −25 degrees relative to the horizon and below, and/or −30 degrees relative to the horizon and below) relative to the viewpoint of the user, such as range 1918 of angles of elevation in the side view 1940 as shown in FIG. 19E. For example, when the first input discussed above is detected, the three-dimensional object is displayed with an initial angle of elevation that is at or below a maximum value of the threshold range of angles of elevation, such as at −5, −10, −15, −20, −25, or −30 degrees, relative to the viewpoint of the user in the environment.

In some embodiments, the first direction corresponds to an increase in the angle of elevation relative to the threshold range of angles of elevation relative to the viewpoint of the user, such as increasing the angle of elevation 1911 of the three-dimensional object 1920 as shown in side view 1940 in FIG. 19G. For example, the first direction of the change in the angle of elevation of the three-dimensional object causes the three-dimensional object to move beyond the threshold range of angles of elevation, such that, in response to the first input, the angle of elevation of the three-dimensional object relative to the viewpoint of the user is more than −5, −10, −15, −20, −25, or −30 degrees relative to the viewpoint of the user in the environment.

In some embodiments, the second direction corresponds to a decrease in the angle of elevation relative to the threshold range of angles of elevation relative to the viewpoint of the user, such as decreasing the angle of elevation 1911 of the three-dimensional object 1920 as shown in the side view 1940 in FIG. 19F. For example, the second direction of the change in the angle of elevation of the three-dimensional object causes the three-dimensional object to remain within the threshold range of angles of elevation relative to the viewpoint of the user in the environment. In some embodiments, the second direction of the change in the angle of elevation of the three-dimensional object causes the three-dimensional object to have an angle of elevation that is below a minimum value of the threshold range of angles of elevation, such as below −5, −10, −15, −20, −25, or −30 degrees, relative to the viewpoint of the user in the environment. Rotating a three-dimensional object in a three-dimensional environment when changing an angle of elevation of the three-dimensional object relative to the viewpoint of the user based on a direction of the change in the angle of elevation relative to the viewpoint in the three-dimensional environment enables the three-dimensional object to automatically remain visibly displayed and/or oriented towards the viewpoint of the user in the user's field of view when moving the object in a particular direction, which avoids and/or prevents consumption of computing resources on unneeded rotation of the three-dimensional object in the user's field of view of the three-dimensional environment, thereby improving user-device interaction and preserving computing resources.

In some embodiments, the first set of one or more criteria includes a criterion that is satisfied when the angle of elevation of the three-dimensional object in the environment is a first angle of elevation relative to a threshold range of angles of elevation (e.g., a range from a value of −5 degrees relative to the horizon of the environment and below, −10 degrees relative to the horizon and below, −15 degrees relative to the horizon and below, −20 degrees relative to the horizon and below, −25 degrees relative to the horizon and below, and/or −30 degrees relative to the horizon and below) relative to the viewpoint of the user, such as the angle of elevation 1911 of the three-dimensional object 1920 in FIG. 19E, and that is not satisfied when the angle of elevation of the three-dimensional object in the environment is a second angle of elevation, different from the first angle of elevation, relative to the threshold range of angles of elevation relative to the viewpoint of the user, such as the angle of elevation 1911 of the three-dimensional object 1920 in FIG. 19F. For example, satisfaction of the first set of one or more criteria is based on the angle of elevation of the three-dimensional object relative to the threshold range of angles of elevation when the first input is detected. In some embodiments, the first angle of elevation is at or outside of the threshold range of angles of elevation when the first input is detected. For example, the three-dimensional object is at or below −5, −10, −15, −20, −25, or −30 degrees relative to the viewpoint of the user. Accordingly, in some embodiments, the second angle of elevation is outside/above the threshold range of angles of elevation when the first input is detected. For example, the three-dimensional object is above −5, −10, −15, −20, −25, or −30 degrees relative to the viewpoint of the user. Additionally or alternatively, in some embodiments, as similarly discussed above, depending on the angle of elevation of the three-dimensional object in the environment when the first input is detected, satisfaction of the criterion above is based on the direction of the change in the angle of elevation of the three-dimensional object relative to the viewpoint of the user in the environment. For example, if the angle of elevation of the three-dimensional object in the environment is outside of the threshold range of angles of elevation (e.g., above the threshold range discussed above), the change in the angle of elevation of the three-dimensional object in either direction (e.g., upward or downward vertically) relative to the viewpoint of the user satisfies the first set of one or more criteria above. As another example, if the angle of elevation of the three-dimensional object relative to the viewpoint of the user is within the threshold range of angles of elevation, changing the angle of elevation of the three-dimensional object in a first direction (e.g., a vertically upward direction) relative to the viewpoint of the user satisfies the first set of one or more criteria, whereas changing the angle of elevation of the three-dimensional object in a second direction that is opposite the first direction (e.g., a vertically downward direction) relative to the viewpoint of the user does not satisfy the first set of one or more criteria. Rotating a three-dimensional object in a three-dimensional environment when changing an angle of elevation of the three-dimensional object relative to the viewpoint of the user based on an initial angle of elevation of the three-dimensional object relative to the viewpoint in the three-dimensional environment enables the three-dimensional object to automatically remain visibly displayed and/or oriented towards the viewpoint of the user in the user's field of view when moving the object based on the initial angle of elevation, which avoids and/or prevents consumption of computing resources on unneeded rotation of the three-dimensional object in the user's field of view of the three-dimensional environment, thereby improving user-device interaction and preserving computing resources.

In some embodiments, in accordance with a determination that, when the first input is detected, the angle of elevation of the three-dimensional object relative to the viewpoint of the user within the environment is above the threshold range of angles of elevation relative to the viewpoint of the user, such as the angle of elevation 1911 being above the range 1918 of angles of elevation as shown in side view 1940 in FIG. 19G, the first set of one or more criteria includes a criterion that is satisfied when a direction of a change in the angle of elevation of the three-dimensional object relative to the viewpoint of the user is a first direction or a second direction, opposite the first direction. For example, if, when the first input discussed above is detected, the angle of elevation of the three-dimensional object is above −5, −10, −15, −20, −25, or −30 degrees relative to the viewpoint of the user, the computer system rotates the three-dimensional object to tilt the first portion of the three-dimensional object to face toward the viewpoint of the user in the manner discussed above irrespective of whether the change in the angle of elevation corresponds to an increase or a decrease in the angle of elevation of the three-dimensional object relative to the viewpoint of the user.

In some embodiments, in accordance with a determination that, when the first input is detected, the angle of elevation of the three-dimensional object relative to the viewpoint of the user within the environment is below (e.g., and/or within) the threshold range of angles of elevation relative to the viewpoint of the user, such as the angle of elevation 1911 being within the range 1918 of angles of elevation as shown in side view 1940 in FIG. 19F, the first set of one or more criteria includes a criterion that is not satisfied when the direction of the change in the angle of elevation of the three-dimensional object relative to the viewpoint of the user is the first direction or the second direction. For example, if, when the first input discussed above is detected, the angle of elevation of the three-dimensional object is below −5, −10, −15, −20, −25, or −30 degrees relative to the viewpoint of the user, the computer system forgoes rotating the three-dimensional object to tilt the first portion of the three-dimensional object to face toward the viewpoint of the user in the manner discussed above irrespective of whether the change in the angle of elevation corresponds to an increase or a decrease in the angle of elevation of the three-dimensional object relative to the viewpoint of the user. Rotating a three-dimensional object in a three-dimensional environment when changing an angle of elevation of the three-dimensional object relative to the viewpoint of the user based on an initial angle of elevation of the three-dimensional object relative to the viewpoint in the three-dimensional environment enables the three-dimensional object to automatically remain visibly displayed and/or oriented towards the viewpoint of the user in the user's field of view when moving the object based on the initial angle of elevation, which avoids and/or prevents consumption of computing resources on unneeded rotation of the three-dimensional object in the user's field of view of the three-dimensional environment, thereby improving user-device interaction and preserving computing resources.

In some embodiments, in accordance with a determination that, when the first input is detected, the angle of elevation of the three-dimensional object relative to the viewpoint of the user within the environment corresponds to a maximum angle of the threshold range of angles of elevation relative to the viewpoint of the user, such as the angle of elevation 1911 being at a maximum of the range 1918 of angles of elevation as shown in side view 1940 in FIG. 19E, the first set of one or more criteria includes a criterion that is satisfied when the direction of the change in the angle of elevation of the three-dimensional object relative to the viewpoint of the user is the first direction (e.g., an upward direction relative to horizon plane 1910 in the side view 1940), and that is not satisfied when the direction of the change in the angle of elevation of the three-dimensional object relative to the viewpoint of the user is the second direction (e.g., a downward direction relative to the horizon plane 1910 in the side view 1940). For example, if, when the first input discussed above is detected, the angle of elevation of the three-dimensional object is equal to −5, −10, −15, −20, −25, or −30 degrees relative to the viewpoint of the user, the computer system rotates the three-dimensional object to tilt the first portion of the three-dimensional object to face toward the viewpoint of the user in the manner discussed above in response to detecting a change in the angle of elevation that corresponds to an increase in the angle of elevation of the three-dimensional object relative to the viewpoint of the user. Accordingly, in some embodiments, if the change in the angle of elevation corresponds to a decrease in the angle of elevation of the three-dimensional object while the angle of elevation of the three-dimensional object is at the maximum angle of the threshold range of angles of elevation relative to the viewpoint of the user, the computer system forgoes rotating the three-dimensional object to tilt the first portion of the three-dimensional object to face toward the viewpoint of the user in response to detecting the first input, as similarly discussed above. Rotating a three-dimensional object in a three-dimensional environment when changing an angle of elevation of the three-dimensional object relative to the viewpoint of the user based on an initial angle of elevation of the three-dimensional object relative to the viewpoint in the three-dimensional environment enables the three-dimensional object to automatically remain visibly displayed and/or oriented towards the viewpoint of the user in the user's field of view when moving the object based on the initial angle of elevation, which avoids and/or prevents consumption of computing resources on unneeded rotation of the three-dimensional object in the user's field of view of the three-dimensional environment, thereby improving user-device interaction and preserving computing resources.

In some embodiments, the threshold range of angles of elevation relative to the viewpoint of the user is a threshold range of angles relative to a plane with an orientation that is selected based on a fixed spatial reference in the physical environment (e.g., perpendicular to a direction of gravity, parallel to a ground (or other surface) on which the user is positioned (e.g., as similarly described above), and/or perpendicular to one or more walls), such as the horizon plane 1910 in the side view 1940 in FIG. 19E. In some embodiments, the computer system detects the fixed spatial reference (e.g., the ground (or other surface) on which the user is positioned) in a physical environment of the display generation component. For example, the ground is detected using one or more cameras or depth sensors of the computer system. In some embodiments, the computer system estimates the ground (or other surface) on which the user is positioned. For example, the ground is estimated (e.g., calculated) based on gravity. In some embodiments, the plane parallel to the ground is parallel to (e.g., or within a threshold amount, such as 0, 1, 2, 5, 8, 10, 15, 18, 20, or 25 degrees, of being parallel to) a horizon of the viewport of the user (e.g., a horizontal line across a center of the user's viewport). In some embodiments, the horizon of the viewport is normal to (e.g., or within a threshold amount, such as 0, 1, 2, 5, 8, 10, or 15 degrees, of being normal to) the force of gravity in the physical environment. In some embodiments, the horizon of the viewport is a horizon of a virtual environment (e.g., an immersive environment displayed in the three-dimensional environment) or of the physical environment surrounding the display generation component. In some embodiments, the plane parallel to the fixed spatial reference is based on a height of the head of the user relative to the ground in the physical environment. For example, if the head of the user is a first height (e.g., a first vertical distance) from the ground in the physical environment, the plane parallel to the fixed spatial reference is at a second height from the ground. In some embodiments, if the head of the user is a third height, different from the first height, from the ground in the physical environment, the plane parallel to the fixes spatial reference is at a fourth height, different from the second height, from the ground. Accordingly, in some embodiments, the first set of one or more criteria includes a criterion that is satisfied when the angle of elevation of the three-dimensional object in the environment is a first angle of elevation relative to the threshold range of angles of elevation (e.g., a range from a value of −5 degrees relative to the horizon of the environment and below, −10 degrees relative to the horizon and below, −15 degrees relative to the horizon and below, −20 degrees relative to the horizon and below, −25 degrees relative to the horizon and below, and/or −30 degrees relative to the horizon and below) relative to the plane, and that is not satisfied when the angle of elevation of the three-dimensional object in the environment is a second angle of elevation, different from the first angle of elevation, relative to the threshold range of angles of elevation relative to the plane. Rotating a three-dimensional object in a three-dimensional environment when changing an angle of elevation of the three-dimensional object relative to a horizon plane of the physical environment based on an initial angle of elevation of the three-dimensional object relative to the horizon plane in the three-dimensional environment enables the three-dimensional object to automatically remain visibly displayed and/or oriented towards the viewpoint of the user in the user's field of view when moving the object based on the initial angle of elevation, which avoids and/or prevents consumption of computing resources on unneeded rotation of the three-dimensional object in the user's field of view of the three-dimensional environment, thereby improving user-device interaction and preserving computing resources.

In some embodiments, in accordance with a determination that a location of the three-dimensional object is a first distance from the viewpoint of the user in the environment, such as the distance of the three-dimensional object 1920 from the viewpoint of the user in the side view 1940 in FIG. 19E, the threshold range of angles is a first threshold range of angles, such as shown by the range 1918 in the side view 1940 in FIG. 19E. In some embodiments, in accordance with a determination that the location of the three-dimensional object is a second distance, different from the first distance, from the viewpoint of the user in the environment, such as the distance of the three-dimensional object 1920 from the viewpoint of the user in the side view 1940 in FIG. 19J, the threshold range of angles is a second threshold range of angles, different from the first threshold range of angles, such as shown by the range 1918 in the side view 1940 in FIG. 19J. For example, the threshold range of angles of elevation relative to the viewpoint of the user is determined based on a distance of the three-dimensional object from the viewpoint of the user in the environment. In some embodiments, if the first distance is larger than the second distance, the first threshold range of angles is smaller than the second threshold range of angles of elevation. In some embodiments, if the first distance is smaller than the second distance, the first threshold range of angles is greater than the second threshold range of angles of elevation. Alternatively, in some embodiments, if the first distance is larger than the second distance, the first threshold range of angles is greater than the second threshold range of angles of elevation relative to the viewpoint of the user. Determining a threshold range of angles of elevation according to which a three-dimensional object is rotated in a three-dimensional environment when changing an angle of elevation of the three-dimensional object based on a distance of the three-dimensional object from the viewpoint of the user in the three-dimensional environment enables the three-dimensional object to automatically remain visibly displayed and/or oriented towards the viewpoint of the user in the user's field of view when moving the object based on the distance of the three-dimensional object from the viewpoint of the user, which avoids and/or prevents consumption of computing resources on unneeded rotation of the three-dimensional object in the user's field of view of the three-dimensional environment, thereby improving user-device interaction and preserving computing resources.

In some embodiments, prior to detecting the first input and prior to displaying the three-dimensional object in the environment (e.g., while the three-dimensional object is not displayed in the environment), the computer system detects, via the one or more input devices, an input corresponding to a request to display the three-dimensional object in the environment, such as selection of icon 1930a as shown in FIG. 19A. For example, the computer system detects an input launching the three-dimensional object via an application for display in the environment. In some embodiments, the input includes selection of an icon or other user interface object corresponding to the application with which the three-dimensional object is associated, such as via an air pinch gesture directed to a respective application icon from a home screen user interface of the computer system. In some embodiments, the input includes a selection of a particular file or icon corresponding to the three-dimensional object, such as from a repository of objects that includes the three-dimensional object. In some embodiments, the input has one or more characteristics of the input(s) in methods 800, 1000, 1200, 1400, 1600, and/or 1800.

In some embodiments, in response to detecting the input, the computer system displays, via the display generation component, the three-dimensional object in the environment at a first angle of elevation (e.g., an initial/default angle of elevation), such as reference angle 1913 in the side view 1940 in FIG. 19E, measured between a vector (e.g., vector 1909 in the side view 1940 in FIG. 19E) extending between a first portion of the user (e.g., a head of the user of the computer system), such as the head 1908 of the user in the side view 1940 in FIG. 19E, and a first portion (e.g., a surface of and/or a center of) of the three-dimensional object, such as first portion 1906 of the three-dimensional object 1920 in the side view 1940 in FIG. 19E, and a plane (or other reference portion) of the three-dimensional object (e.g., a plane extending through and/or parallel to a base/bottom surface of the three-dimensional object), such as a plane of base 1922 of the three-dimensional object 1909 in the side view 1909 in FIG. 19E, wherein the plane of the three-dimensional object has an orientation selected based on a fixed spatial reference in the physical environment (e.g., parallel to a floor, normal to gravity, and/or perpendicular to one or more walls) (e.g., the three-dimensional object is initially gravity aligned when the three-dimensional object is first displayed in the three-dimensional environment). In some embodiments, the plane of the three-dimensional object is parallel to the plane described above with respect to the threshold range of angles. In some embodiments, displaying the three-dimensional object in the environment at the first angle of elevation causes the three-dimensional object to be displayed in a center of the field of view of the user and/or at an angle of elevation that lies directly ahead of the viewpoint of the user in the environment. For example, a center of the three-dimensional object, as discussed in more detail below, lies directly ahead (e.g., intersects a forward vector extending from) the head of the user. Additionally, in some embodiments, because the first angle of elevation is aligned to the plane having the orientation selected based on the fixed spatial reference, a front-facing surface/edge of the three-dimensional object is flat/vertical relative to the viewpoint of the user in the environment when the three-dimensional object is initially displayed. In some embodiments, as similarly discussed above, the first angle of elevation has a negative value. For example, the first angle of elevation is −5, −10, −15, −20, −25, or −30 degrees measured between the vector extending between the head of the user and the first portion of the three-dimensional object and the plane of the three-dimensional object. Alternatively, in some embodiments, the first angle of elevation has a positive or non-negative value, such as 0, 5, 10, 15, 20, 25, or 30 degrees. Displaying a three-dimensional object in a three-dimensional environment at an initial angle of elevation that is gravity aligned relative to the viewpoint of the user enables the three-dimensional object to be visibly displayed and/or oriented towards the viewpoint of the user in the user's field of view when first displaying the object, which negates and/or reduces a number of inputs that would be needed to reorient the three-dimensional object in the user's field of view of the three-dimensional environment based on the viewpoint of the user, thereby improving user-device interaction.

In some embodiments, in response to detecting the first input, in accordance with the determination that the first input satisfies the first set of one or more criteria, changing the angle of elevation of the three-dimensional object relative to the viewpoint of the user in the environment based on the first input includes changing the angle of elevation relative to the viewpoint of the user based on the first input while maintaining the first angle of elevation measured between the vector and the plane (or other reference portion) of the three-dimensional object, such as maintaining the reference angle 1913 in the side view 1940 as shown in FIG. 19G. For example, when the computer system changes the angle of elevation of the three-dimensional object relative to the viewpoint of the user in response to detecting the first input as discussed above, the angle of elevation is changed relative to the first vector in the environment. In some embodiments, the computer system increases or decreases the angle of elevation of the three-dimensional object relative to the first angle of elevation (e.g., the initial angle of elevation) in the environment in response to detecting the first input. Accordingly, in some embodiments, the tilting of the first portion (e.g., the first side) of the three-dimensional object toward the location of the viewpoint based on the change in the angle of elevation of the three-dimensional object is also relative to the first vector in the environment. In some embodiments, the computer system changes the angle of elevation of the three-dimensional object without rotating the three-dimensional object initially in response to detecting the first input that satisfies the first set of one or more criteria. For example, the computer system forgoes tilting the first portion of the three-dimensional object toward the location of the viewpoint for a first range of angles of elevation (e.g., 1, 2, 3, 4, 5, 8, 10, or 15 degrees) relative to the viewpoint of the user in response to detecting the first input, and subsequently begins tilting the first portion of the three-dimensional object once the angle of elevation of the three-dimensional object exceeds the first range of angles of elevation. Rotating a three-dimensional object in a three-dimensional environment when changing an angle of elevation of the three-dimensional object relative to a vector extending between the head of the user and the three-dimensional object in response to detecting movement of the object in the three-dimensional environment enables the three-dimensional object to automatically remain visibly displayed and/or oriented towards the viewpoint of the user in the user's field of view after the movement of the object, which negates and/or reduces a number of inputs that would be needed to reorient the three-dimensional object in the user's field of view of the three-dimensional environment, thereby improving user-device interaction.

In some embodiments, the first portion of the three-dimensional object corresponds to a center of the three-dimensional object, such as a center of three-dimensional object 1920 in FIG. 19E. For example, as similarly discussed above, the center of the three-dimensional object corresponds to a volumetric center of the three-dimensional object (e.g., based on at least a length, height, and/or radius of the three-dimensional object, depending on a shape of the three-dimensional object). In some embodiments, the center of the three-dimensional object corresponds to a geometric center of a particular surface or area of the three-dimensional object. For example, if the three-dimensional object includes a base (e.g., a rectangular, triangular, circular, square-shaped, octagonal, or oval-shaped two-dimensional or three-dimensional surface), on which content is optionally displayed and/or positioned, the first portion of the three-dimensional object corresponds to a center of the base. Rotating a three-dimensional object in a three-dimensional environment when changing an angle of elevation of the three-dimensional object relative to a vector extending between the head of the user and a center of the three-dimensional object in response to detecting movement of the object in the three-dimensional environment enables the three-dimensional object to automatically remain visibly displayed and/or oriented towards the viewpoint of the user in the user's field of view after the movement of the object, which negates and/or reduces a number of inputs that would be needed to reorient the three-dimensional object in the user's field of view of the three-dimensional environment, thereby improving user-device interaction.

In some embodiments, the first portion of the three-dimensional object corresponds to a front portion (e.g., surface, region, or edge) of the three-dimensional object relative to the viewpoint of the user, such as first portion 1916 of the base 1922 of the three-dimensional object 1920 in FIG. 19E. For example, the front portion of the three-dimensional object is a front-facing surface that faces and/or is closest to the viewpoint of the user in the environment. In some embodiments, the front portion of the three-dimensional object relative to the viewpoint of the user is based on a current orientation of the three-dimensional object in the environment relative to the viewpoint of the user. For example, the three-dimensional object is configured to be rotated about a vertical axis through (e.g., a center of) the three-dimensional object in the environment in response to detecting input for rotating the three-dimensional object, such as lateral (e.g., rightward or leftward) movement of the hand of the user relative to the viewpoint of the user directed to a rotation element/option associated with the three-dimensional object. In such an instance, based on the clockwise or counterclockwise rotation of the three-dimensional object about the vertical axis, different and/or alternate portions of the three-dimensional object are closest to the viewpoint of the user and/or correspond to a front of the three-dimensional object relative to the current viewpoint of the user. In some embodiments, the front portion of the three-dimensional is a same portion (e.g., surface, region, or edge) of the three-dimensional object irrespective of rotation of the three-dimensional object in the environment, such as an initial or default front surface of the three-dimensional object (e.g., determined upon display/launching of the three-dimensional object in the environment). Rotating a three-dimensional object in a three-dimensional environment when changing an angle of elevation of the three-dimensional object relative to a vector extending between the head of the user and a surface of the three-dimensional object in response to detecting movement of the object in the three-dimensional environment enables the three-dimensional object to automatically remain visibly displayed and/or oriented towards the viewpoint of the user in the user's field of view after the movement of the object, which negates and/or reduces a number of inputs that would be needed to reorient the three-dimensional object in the user's field of view of the three-dimensional environment, thereby improving user-device interaction.

In some embodiments, the first portion of the three-dimensional object corresponds to a location of one or more movement controls associated with the three-dimensional object, such as grabber bar 1936 associated with the three-dimensional object 1920 in FIG. 19E. For example, the three-dimensional object is associated with one or more user interface elements controlling one or more of movement, rotation, size, and/or display of the three-dimensional object in the environment. In some embodiments, the first input discussed above includes interaction with a first movement control (e.g., a grabber bar) of the one or more movement controls. In some embodiments, the one or more movement controls are displayed adjacent to the three-dimensional object in the environment from the viewpoint of the user. For example, the one or more movement controls are displayed below the three-dimensional object, above the three-dimensional object, along a side of the three-dimensional object, and/or at a corner of the three-dimensional object in the environment relative to the viewpoint of the user. In some embodiments, the location of the one or more movement controls associated with the three-dimensional object is closer to the viewpoint of the user than the location of the three-dimensional object in the environment. In some embodiments, the location of the one or more movement controls associated with the three-dimensional object is fixed (e.g., remains the same) relative to the three-dimensional object in the environment (e.g., irrespective of movement and/or rotation of the three-dimensional object in the environment relative to the viewpoint of the user). Rotating a three-dimensional object in a three-dimensional environment when changing an angle of elevation of the three-dimensional object relative to a vector extending between the head of the user and a location of one or more movement controls of the three-dimensional object in response to detecting movement of the object in the three-dimensional environment enables the three-dimensional object to automatically remain visibly displayed and/or oriented towards the viewpoint of the user in the user's field of view after the movement of the object, which negates and/or reduces a number of inputs that would be needed to reorient the three-dimensional object in the user's field of view of the three-dimensional environment, thereby improving user-device interaction.

In some embodiments, the first angle of elevation between the vector extending between the first portion of the user (e.g., a head of the user of the computer system) and the first portion (e.g., a surface of and/or a center of) of the three-dimensional object and the plane (or other reference portion) of the three-dimensional object is fixed in the environment, such as the reference angle 1913 in the side view 1940 being fixed as described with reference to FIG. 19G. For example, the reference angle of elevation defined between the vector extending between the head of the user and the first portion of the three-dimensional object and the plane (e.g., the base of the three-dimensional object) remains unchanged in the environment (e.g., is fixed irrespective of user input). In some embodiments, movement and/or rotation of the three-dimensional object does not cause the first angle of elevation to change in the environment. In some embodiments, updating display of content associated with the three-dimensional object does not cause the first angle of elevation to change in the environment. For example, the three-dimensional object is associated with and/or includes a base, platter, or other surface on which content is able to be placed/positioned in the environment. In some embodiments, updating display of the content associated with the three-dimensional object changes a size (e.g., a height) of the three-dimensional object in the environment relative to the viewpoint of the user. In such an instance, the computer system forgoes changing the first angle of elevation between the vector and the horizon plane in the environment (e.g., despite a center of the three-dimensional object optionally changing due to the updating of the content displayed on, with, and/or within the three-dimensional object). Additionally, in some embodiments, if the computer system ceases display of the three-dimensional object (e.g., in response to detecting an input corresponding to a request to close the three-dimensional object) in the environment, and subsequently detects an input to redisplay the three-dimensional object in the environment, the computer system redisplays the three-dimensional object at the first angle of elevation discussed above that is measured between the vector and the plane of the three-dimensional object in the environment. Displaying a three-dimensional object in a three-dimensional environment at a fixed initial angle of elevation that is gravity aligned relative to the viewpoint of the user enables the three-dimensional object to be visibly displayed and/or oriented towards the viewpoint of the user in the user's field of view when first displaying the object, which negates and/or reduces a number of inputs that would be needed to reorient the three-dimensional object in the user's field of view of the three-dimensional environment based on the viewpoint of the user, thereby improving user-device interaction.

In some embodiments, displaying, via the display generation component, the three-dimensional object in the environment at the first angle of elevation includes, in accordance with a determination that the three-dimensional object has a first height in the environment relative to the viewpoint of the user, such as the height of the three-dimensional object 1920 in FIG. 19D, the first angle of elevation is a first respective angle of elevation in the environment, such as the angle of elevation 1911 in the side view 1940 in FIG. 19D, and in accordance with a determination that the three-dimensional object has a second height, different from the first height, in the environment relative to the viewpoint of the user, such as the height of the three-dimensional object 1920 in FIG. 19E, the first angle of elevation is a second respective angle of elevation, different from the first respective angle of elevation, in the environment, such as the angle of elevation 1911 in the side view 1940 in FIG. 19E. For example, the reference angle of elevation defined between the vector extending between the head of the user and the first portion of the three-dimensional object and the plane of the three-dimensional object is determined based on the height of the three-dimensional object in the environment (e.g., as measured from a base of the three-dimensional object to a peak or tip of the three-dimensional object). In some embodiments, the height of the three-dimensional object is based on an amount, including height, of available display area/space associated with the three-dimensional object. For example, as similarly discussed herein, the three-dimensional object includes a (e.g., two-dimensional or three-dimensional) base or platter on which content is able to be displayed/positioned in the environment. Accordingly, the height of the three-dimensional object is optionally measured from a base of the three-dimensional object to a peak or tip of the display space above/on top of the base of the three-dimensional object (e.g., optionally irrespective of the content that is actually displayed on the base). In some embodiments, if the first height is greater than the second height, the first angle of elevation of the three-dimensional object that is equal to the first respective angle of elevation in the environment is lower (e.g., in degrees) relative to the viewpoint of the user than the first angle of elevation of the three-dimensional object that is equal to the second respective angle of elevation in the environment. In some embodiments, if the first height is smaller than the second height, the first angle of elevation of the three-dimensional object that is equal to the first respective angle of elevation in the environment is greater (e.g., in degrees) relative to the viewpoint of the user than the first angle of elevation of the three-dimensional object that is equal to the second respective angle of elevation in the environment. Displaying a three-dimensional object in a three-dimensional environment at an initial angle of elevation that is based on a height of the three-dimensional object relative to the viewpoint of the user enables the three-dimensional object to be visibly displayed and/or oriented towards the viewpoint of the user in the user's field of view for a given height of the three-dimensional object, which negates and/or reduces a number of inputs that would be needed to reorient the three-dimensional object in the user's field of view of the three-dimensional environment based on the viewpoint of the user, thereby improving user-device interaction.

In some embodiments, in accordance with a determination that the three-dimensional object includes content (e.g., blocks of the three-dimensional object 1920 on the base 1922 in FIG. 19D) having a first height in the environment, the first angle of elevation is a first respective angle of elevation in the environment, such as the angle of elevation 1911 of the three-dimensional object 1920 shown in the side view 1940 in FIG. 19D. In some embodiments, in accordance with a determination that the three-dimensional object includes content (e.g., blocks of the three-dimensional object 1920 on the base 1922 in FIG. 19E) having a second height, different from the first height, in the environment, the first angle of elevation is a second respective angle of elevation, different from the first respective angle of elevation, in the environment, such as the angle of elevation 1911 of the three-dimensional object 1920 shown in the side view 1940 in FIG. 19E. For example, the reference angle of elevation defined between the vector extending between the head of the user and the first portion of the three-dimensional object and the plane of the three-dimensional object is determined based on the height of the content that is displayed with, on, and/or within the three-dimensional object in the environment (e.g., as measured from a base of the three-dimensional object to a peak or tip of the content on the three-dimensional object). In some embodiments, the height of the three-dimensional object is based on the height (e.g., a maximum height) of content that is actually displayed/positioned on and/or with the three-dimensional object in the environment. For example, as similarly discussed herein, the three-dimensional object includes a (e.g., two-dimensional or three-dimensional) base or platter on which content is able to be displayed/positioned in the environment. Accordingly, the height of the three-dimensional object is optionally measured from a base of the three-dimensional object to a peak or tip of the content above/on top of the base of the three-dimensional object. In some embodiments, if the first height is greater than the second height, the first angle of elevation of the three-dimensional object that is equal to the first respective angle of elevation in the environment is lower (e.g., in degrees) relative to the viewpoint of the user than the first angle of elevation of the three-dimensional object that is equal to the second respective angle of elevation in the environment. In some embodiments, if the first height is smaller than the second height, the first angle of elevation of the three-dimensional object that is equal to the first respective angle of elevation in the environment is greater (e.g., in degrees) relative to the viewpoint of the user than the first angle of elevation of the three-dimensional object that is equal to the second respective angle of elevation in the environment. Displaying a three-dimensional object in a three-dimensional environment at an initial angle of elevation that is based on a height of content associated with the three-dimensional object relative to the viewpoint of the user enables the three-dimensional object to be visibly displayed and/or oriented towards the viewpoint of the user in the user's field of view for a given height of the content associated with the three-dimensional object, which negates and/or reduces a number of inputs that would be needed to reorient the three-dimensional object in the user's field of view of the three-dimensional environment based on the viewpoint of the user, thereby improving user-device interaction.

In some embodiments, while displaying the three-dimensional object in the environment, the computer system detects, via the one or more input devices, a second input corresponding to a request to move the three-dimensional object within the environment, such as the input provided by the hand 1903 as shown in FIG. 19K. In some embodiments, detecting the second input includes detecting an air pinch gesture performed by a hand of the user of the computer system that is detected by the one or more input devices (e.g., a hand tracking device) in communication with the computer system while attention (e.g., including gaze) of the user is directed toward the three-dimensional object. In some embodiments, the computer system detects the second input irrespective of the location of the attention of the user in the three-dimensional environment. In some embodiments, the computer system detects the air pinch gesture directed toward a selection element (e.g., a grabber or handlebar element) associated with the three-dimensional object that is selectable to initiate movement of the virtual object in the three-dimensional environment. In some embodiments, after detecting the air pinch gesture, the computer system detects movement of a portion of the user. For example, the computer system detects an air drag gesture. In some embodiments, the movement of the hand of the user is laterally (e.g., in a horizontal direction relative to the viewpoint of the user) in space that is away from the body of the user in space. In some embodiments, detecting the second input includes detecting movement of a head of the user, which moves the viewpoint of the user in the environment. For example, the three-dimensional object is viewpoint-locked in the three-dimensional environment, and movement of the viewpoint of the user laterally (e.g., leftward or rightward) in space causes the three-dimensional object to move within the three-dimensional environment, as discussed below. In some embodiments, the lateral movement of the three-dimensional object in the environment is relative to gravity (e.g., a vertical vector that is parallel to the force of gravity and/or perpendicular to the physical floor of the physical environment of the user). For example, the lateral movement is horizontal relative to, and therefore normal to (e.g., or within 0.5, 1, 3, 5, 8, 10, 15, 20, 25, or 30 degrees of being normal to), the vertical vector that is parallel to the force of gravity. In some embodiments, the second input has one or more characteristics of the first input discussed above.

In some embodiments, in response to detecting the second input, the computer system changes a position of the three-dimensional object within the environment based on the second input, such as the movement of the three-dimensional object 1920 in accordance with the movement of the hand 1903 as shown in FIG. 19L. In some embodiments, in accordance with a determination that the three-dimensional object has a first angle of elevation (e.g., 0, 1, 2, 3, 5, 10, 15, 18, 20, 25, or 30 degrees) relative to the viewpoint of the user (e.g., and that the second input satisfies the first set of one or more criteria discussed above, such as the first angle of elevation being within the threshold range of angles of elevation), changing the position of the three-dimensional object within the environment based on the second input includes moving the three-dimensional object (e.g., moving the object in one, two, or three dimensions) by an amount that is based on one or more parameters of the second input (e.g., a direction, distance, and/or speed of the first input) and rotating the three-dimensional object about a first axis in the environment (e.g., based on the changed position of the object), such as the rotation of the three-dimensional object 1920 in top-down view 1941 about axis 1908 in the side view 1940 as shown in FIG. 19L. For example, the computer system moves the three-dimensional object from a first location to a second location, different from the first location, in the environment in accordance with the movement of the hand of the user and/or the movement of the viewpoint of the user (e.g., the three-dimensional object is moved laterally in the environment relative to gravity in accordance with the lateral movement of the second input or the object is moved laterally and vertically (e.g., successively, or concurrently (e.g., the three-dimensional object is moved diagonally)) in the environment relative to gravity in accordance with the vertical and lateral components of movement of the second input). In some embodiments, while moving the three-dimensional object in accordance with the second input, if the computer system determines that the three-dimensional object has the first angle of elevation relative to the viewpoint of the user, the computer system rotates the object about a first rotation axis in the environment. For example, the computer system rotates the three-dimensional object such that a front-facing surface of the object (e.g., the front-facing surface when the first input is detected) continues to face toward the viewpoint of the user in the user's viewport as the three-dimensional object is moved laterally in the three-dimensional environment by rotating the object about the first axis. In some embodiments, the first axis corresponds to a vertical axis through (e.g., a center of) a head of the user. For example, if the three-dimensional object has the first angle of elevation relative to the viewpoint of the user when the first input is detected, the computer system rotates the three-dimensional object about a vertical axis through the user's head as the object is moved laterally in the three-dimensional environment. In some embodiments, a direction of the rotation of the object is based on the direction of lateral movement of the object in the environment. For example, if the second input causes the computer system to move the three-dimensional object rightward in the user's viewport, the computer system rotates the object clockwise about the first axis in the environment (e.g., radially along a sphere centered at the user's head). Similarly, if the second input causes the computer system to move the three-dimensional object leftward in the user's viewport, the computer system optionally rotates the object counterclockwise about the first axis in the environment. In some embodiments, an amount (e.g., an angular amount) of the rotation of the three-dimensional object about the first axis is based on the distance of lateral movement of the object in the three-dimensional environment. For example, if the second input causes the computer system to move the object laterally by a first distance in the three-dimensional environment, the computer system rotates the object (e.g., clockwise or counterclockwise) about the first axis by a first angular amount that is based on (e.g., equivalent to or proportional to) the first distance. Similarly, if the second input causes the computer system to move the three-dimensional object laterally by a second distance, greater than the first distance, in the environment, the computer system optionally rotates the object about the first axis by a second angular amount, greater than the first angular amount, that is based on the second distance. In some embodiments, while the three-dimensional object is rotated about the first axis in the environment, a front-facing surface of the three-dimensional object remains normal to (e.g., and/or within a threshold of being normal to, such as 1, 2, 3, 4, 5, 8, 10, 15, 20, or 30 degrees) the vector discussed above that extends between the head of the user and the first portion (e.g., center) of the three-dimensional object. In some embodiments, rotating the three-dimensional object about the first axis in the environment has one or more characteristics of rotating object(s) in the environment as discussed in method 800, such as the rotation of the virtual object 706a about first axis 713-1 in the side view 720 in FIG. 7B.

In some embodiments, in accordance with a determination that the three-dimensional object has a second angle of elevation (e.g., 15, 20, 25, 30, 40, 45, 60, 75, 80, or 90 degrees), different from the first angle of elevation (e.g., greater than the first angle of elevation), relative to the viewpoint of the user (e.g., and that the second input satisfies the first set of one or more criteria discussed above, such as the second angle of elevation being within the threshold range of angles of elevation), changing the position of the three-dimensional object within the environment based on the second input includes moving the object (e.g., moving the object in one, two, or three dimensions) by an amount that is based on the one or more parameters (e.g., a direction, distance, and/or speed of the first input) of the second input and rotating the object about a second axis, different from the first axis, in the environment (e.g., based on the changed position of the object), such as the rotation of the three-dimensional object 1920 about the axis 1908 in the side view 1940 based on the movement of the hand 1903 as shown in FIG. 19M. In some embodiments, while moving the three-dimensional object in accordance with the second input, if the computer system determines that the three-dimensional object has the second angle of elevation relative to the viewpoint of the user, the computer system rotates the object about a second rotation axis in the three-dimensional environment, as similarly discussed above. In some embodiments, the second axis corresponds to a first vertical axis that is offset from a second vertical axis that is through (e.g., a center of) the first portion of the user. For example, the first vertical axis and the second vertical axis intersect at the user's head, and the first vertical axis is offset from the second vertical axis by 1, 5, 10, 15, 20, 25, 30, 40, 45, 50, 60, 75, or 90 degrees. Accordingly, if the three-dimensional object has the second angle of elevation relative to the viewpoint of the user when the second input is detected, the computer system rotates the three-dimensional object about the second vertical axis through the user's head as the object is moved laterally in the environment. In some embodiments, an amount that the second vertical axis is offset from the first vertical axis is based on the angle of elevation of the object in the environment. In some embodiments, as similarly discussed above, a direction of the rotation of the three-dimensional object about the second axis is based on the direction of lateral movement of the object in the environment. Additionally, as similarly discussed above, in some embodiments, an amount (e.g., angular amount) of the rotation of the three-dimensional object about the second axis is based on the distance of lateral movement of the object in the environment. In some embodiments, in response to detecting the second input, in accordance with a determination that the second input does not satisfy the first set of one or more criteria (e.g., because the first angle of elevation or the second angle of elevation is within the threshold range of angles of elevation) discussed above, the first axis is the same as the second axis. In some embodiments, rotating the three-dimensional object about the second axis in the environment has one or more characteristics of rotating object(s) in the environment as discussed in method 800, such as the rotation of the virtual object 706a about second axis 713-2 in the side view 720 as shown in FIG. 7E. Varying an axis of rotation of a three-dimensional object in a three-dimensional environment in response to detecting movement of the three-dimensional object in the three-dimensional environment based on an angle of elevation of the object relative to a location of a portion of the user enables the object to automatically remain visibly displayed and/or oriented towards the viewpoint of the user in the user's field of view after the movement of the object, which negates and/or reduces a number of inputs that would be needed to reorient the object in the user's field of view of the three-dimensional environment, thereby improving user-device interaction.

In some embodiments, while displaying the three-dimensional object in the environment, the computer system detects, via the one or more input devices, a second input corresponding to a request to interact with the three-dimensional object relative to the viewpoint of the user within the environment, such as the input provided by the hand 1903 as shown in FIG. 19N. For example, the computer system detects an air pinch gesture provided by a hand of the user directed toward the three-dimensional object (e.g., or a grabber bar displayed with the three-dimensional object) in the environment, optionally followed by movement of the hand of the user in space (e.g., vertically in space relative to the viewpoint of the user). In some embodiments, the second input has one or more characteristics of the first input discussed above.

In some embodiments, while detecting the second input (e.g., before detecting termination of the second input), the computer system detects, via the one or more input devices, movement of the viewpoint of the user relative to the three-dimensional object in the environment to an updated viewpoint, such as movement of the viewpoint as indicated by the downward arrow in the side view 1940 in FIG. 19M. For example, while detecting the hand of the movement of the user in space (e.g., while detecting the air pinch and drag gesture directed to the three-dimensional object), the computer system detects movement of the viewpoint of the user relative to the three-dimensional object. In some embodiments, the movement of the viewpoint of the user corresponds to movement of the head of the user, which causes the display generation component (e.g., and the computer system) to move in the physical environment of the display generation component, thereby shifting the viewpoint. In some embodiments, the movement of the viewpoint of the user corresponds to a shifting of the viewpoint (e.g., laterally or longitudinally in the physical environment) relative to the three-dimensional object (e.g., relative to a reference point or portion of the three-dimensional object, such as a front-facing surface of the three-dimensional object or an edge of the three-dimensional object) and/or corresponds to a rotation of the viewpoint (e.g., clockwise or counterclockwise in space) about a vertical axis through the (e.g., center of the) head of the user. In some embodiments, because the movement of the viewpoint of the user is detected while the second input is being detected, the viewpoint of the user is updated while the display of the three-dimensional object is being updated, optionally concurrently (e.g., while the three-dimensional object is being moved and/or tilted in the environment as discussed below).

In some embodiments, in response to detecting the second input, the computer system rotates the three-dimensional object in the environment to tilt the first portion of the three-dimensional object toward a location of the updated viewpoint based on a change in the angle of elevation of the three-dimensional object relative to the updated viewpoint of the user, such as rotating the three-dimensional object 1920 based on the updated viewpoint of the user as shown in the side view 1940 in FIG. 19P. In some embodiments, if the second input includes a request to change the angle of elevation of the three-dimensional object relative to the viewpoint of the user and the second input satisfies the first set of one or more criteria, the computer system changes the angle of elevation of the three-dimensional object relative to the updated viewpoint of the user in the environment based on the second input, as similarly discussed above. In some embodiments, in accordance with the determination that the second input satisfies the first set of one or more criteria, the computer system moves the three-dimensional object in the environment relative to the updated viewpoint of the user, such that the three-dimensional object has an updated angle of elevation relative to the updated viewpoint of the user in the environment based on the second input. For example, the computer system moves the three-dimensional object in a vertical direction relative to the updated viewpoint of the user (e.g., in accordance with vertical movement of the hand of the user in space). In some embodiments, the three-dimensional object is moved laterally and vertically (e.g., successively, or concurrently (e.g., the three-dimensional object is moved diagonally)) in the three-dimensional environment relative to gravity (e.g., in accordance with the vertical and lateral components of movement of the second input) from the updated viewpoint of the user. In some embodiments, changing the angle of elevation of the three-dimensional object relative to the updated viewpoint of the user in the environment based on the second input includes increasing or decreasing the angle of elevation relative to the updated viewpoint of the user in the environment. Additionally, in some embodiments, when the computer system changes the angle of elevation relative to the updated viewpoint of the user in the environment in response to detecting the second input, the computer system rotates (e.g., tilts) the three-dimensional object relative to the updated viewpoint of the user in the environment in accordance with the determination that the first set of one or more criteria is satisfied. In some embodiments, as similarly discussed above, in accordance with a determination that the second input includes a request to change the angle of elevation of the three-dimensional object relative to the viewpoint of the user but does not satisfy the first set of one or more criteria, the computer system changes the angle of elevation of the three-dimensional object relative to the updated viewpoint of the user in the environment based on the second input, without rotating the three-dimensional object in the environment. Rotating a three-dimensional object in a three-dimensional environment in response to detecting interaction with the object in the three-dimensional environment based on an updated viewpoint of the user when changing an angle of elevation of the three-dimensional object while movement of the viewpoint of the user is detected enables the three-dimensional object to automatically remain visibly displayed and/or oriented towards the changing viewpoint of the user in the user's field of view during and/or after the movement of the object, which negates and/or reduces a number of inputs that would be needed to reorient the three-dimensional object in the user's field of view of the three-dimensional environment, thereby improving user-device interaction.

In some embodiments, in response to detecting the second input, in accordance with a determination that the change in the angle of elevation of the three-dimensional object relative to the updated viewpoint of the user is a first amount (e.g., in degrees), such as a difference between the viewpoint of the user in the side view 1940 in FIG. 19M and the viewpoint of the user in the side view 1940 in FIG. 19N, the computer system rotates the three-dimensional object in the environment to a first orientation, such as the rotation of the three-dimensional object 1920 as shown in FIG. 19P. In some embodiments, in accordance with a determination that the change in the angle of elevation of the three-dimensional object relative to the updated viewpoint of the user is a second amount, different from the first amount, the computer system rotates the three-dimensional object in the environment to a second orientation, different from the first orientation, as similarly described with reference to the rotation of the three-dimensional object 1920 in FIG. 19P. For example, in response to detecting the second input, the computer system changes the orientation of the three-dimensional object to correspond to a target orientation that is based on the location of the updated viewpoint of the user in the environment. In some embodiments, the greater the change in the angle of elevation of the three-dimensional object relative to the updated viewpoint of the user, the greater the rotation of the three-dimensional object relative to the updated viewpoint of the user. For example, if the first amount of the change in the angle of elevation of the three-dimensional object is greater than the second amount, the first orientation is steeper/sharper than the second orientation relative to the updated viewpoint of the user. In some embodiments, if the first amount of the change in the angle of elevation of the three-dimensional object is less than the second amount, the first orientation is shallower/flatter than the second orientation relative to the updated viewpoint of the user. Rotating a three-dimensional object in a three-dimensional environment in response to detecting interaction with the object in the three-dimensional environment based on an updated viewpoint of the user when changing an angle of elevation of the three-dimensional object while movement of the viewpoint of the user is detected enables the three-dimensional object to automatically remain visibly displayed and/or oriented towards the changing viewpoint of the user in the user's field of view during and/or after the movement of the object, which negates and/or reduces a number of inputs that would be needed to reorient the three-dimensional object in the user's field of view of the three-dimensional environment, thereby improving user-device interaction.

In some embodiments, in response to detecting the second input, the computer system changes a size of the three-dimensional object from the updated viewpoint of the user (optionally while rotating the three-dimensional object in the environment), such as a size of the three-dimensional object changing relative to the updated viewpoint of the user in FIG. 19P. For example, prior to the computer system detecting the second input, the three-dimensional object has a first size in the environment relative to the viewpoint of the user (e.g., the three-dimensional object has a first volume, a first area, a first surface area, or otherwise occupies a first amount of the viewport of the user). In some embodiments, when the second input discussed above is detected, and optionally in accordance with the determination that the second input satisfies the first set of one or more criteria, the computer system increases or decreases the size of the three-dimensional environment in the environment from the viewpoint of the user while rotating the three-dimensional object to tilt the first portion of the three-dimensional object toward the location of the updated viewpoint of the user. In some embodiments, the change in the size of the three-dimensional object is based on the movement of the viewpoint of the user to the updated viewpoint discussed above. For example, if the movement of the viewpoint of the user to the updated viewpoint causes a distance between the three-dimensional object and the viewpoint of the user to increase in the environment, the computer system moves the three-dimensional object toward the updated viewpoint of the user in response to detecting the second input, which causes the apparent size of the three-dimensional object to increase in the environment from the updated viewpoint (e.g., the three-dimensional object occupies a greater amount of the viewport of the user). Similarly, in some embodiments, if the movement of the viewpoint of the user to the updated viewpoint causes the distance between the three-dimensional object and the viewpoint of the user to decrease in the environment, the computer system moves the three-dimensional object away from the updated viewpoint of the user in response to detecting the second input, which causes the apparent size of the three-dimensional object to decrease in the environment from the updated viewpoint (e.g., the three-dimensional object occupies a smaller amount of the viewport of the user). In some embodiments, the increase or decrease in the size of the three-dimensional object causes an apparent size (e.g., the amount of the viewport that is occupied by the three-dimensional object) to remain the size between the previous viewpoint of the user and the updated viewpoint of the user. In some embodiments, in accordance with the determination that the second input does not satisfy the first set of one or more criteria, the computer system forgoes changing the size of the three-dimensional object in the environment relative to the updated viewpoint of the user. For example, the three-dimensional object remains the first size in the environment. Changing a size of a three-dimensional object in a three-dimensional environment when rotating the three-dimensional object in the three-dimensional environment based on an updated viewpoint of in response to input changing an angle of elevation of the three-dimensional object enables the three-dimensional object to automatically remain visibly displayed and/or oriented towards the changing viewpoint of the user in the user's field of view during and/or after the movement of the object, which negates and/or reduces a number of inputs that would be needed to reorient the three-dimensional object in the user's field of view of the three-dimensional environment, thereby improving user-device interaction.

In some embodiments, rotating the three-dimensional object in the environment to tilt the first portion of the three-dimensional object toward the location of the updated viewpoint based on the change in the angle of elevation of the three-dimensional object relative to the updated viewpoint of the user includes gradually rotating the three-dimensional object in the environment over a respective time period (e.g., over a predetermined period of time, such as 1, 2, 3, 4, 5, 8, or 10 seconds) until the first portion is tilted toward the location of the updated viewpoint, such as the gradual rotation of the three-dimensional object 1920 relative to the updated viewpoint of the user as shown in the side view 1940 from FIGS. 19N-19P. For example, in accordance with the determination that the second input satisfies the first set of one or more criteria discussed above, the computer system gradually rotates the three-dimensional object in the environment, such that the first portion of the three-dimensional object gradually tilts from its orientation prior to detecting the second input to an updated orientation that faces toward the location of the updated viewpoint of the user in the environment. In some embodiments, as similarly discussed above, the computer system changes an apparent size of the three-dimensional object in the environment relative to the updated viewpoint of the user while rotating the three-dimensional object in the environment. In some such embodiments, the computer system gradually changes the size (e.g., gradually increases or decreases the size) of the three-dimensional object in the environment over a respective time period (e.g., such as the predetermined period of time above) from the viewpoint of the user. For example, the computer system gradually moves the three-dimensional object toward or away from the viewpoint of the user in the environment, which causes the size of the three-dimensional object to gradually increase or decrease, respectively, in the environment from the viewpoint of the user. In some embodiments, the computer system gradually rotates the three-dimensional object according to a spring-based model or a magnetics-based model in the environment. In some embodiments, when the computer system rotates the three-dimensional object in the environment relative to the updated viewpoint of the user according to the spring-based model, the computer system tilts the first portion of the three-dimensional object from a first orientation prior to detecting the second input to a second orientation that faces toward the location of the updated viewpoint of the user in a pulling or “rubberbanding” motion (e.g., as in a mass attached to a spring), such as tilting the first portion of the three-dimensional object beyond a target orientation (e.g., including location) and reversing the tilt of the first portion of the three-dimensional object back to the target orientation (e.g., including location) in the environment. In some embodiments, the computer system detects an amount of displacement measured between the location of the previous viewpoint of the user in the environment (e.g., prior to detecting the movement of the viewpoint discussed above) and the location of the updated viewpoint of the user in the environment and animates a transition of the orientation of the three-dimensional object from the first orientation to the second orientation with a magnitude of rotation based on the displacement, such that the greater the displacement, the greater the rotation of the three-dimensional object when the second input is terminated (e.g., when the computer system detects a release of the air pinch gesture). In some embodiments, the relationship between the displacement and the simulated rotation of the three-dimensional object (e.g., the tilting of the first portion of the three-dimensional object toward the location of the updated viewpoint) is linear, exponential, logarithmic, and/or some other non-linear relationship between the displacement and the simulated rotation. In some embodiments, the size of the three-dimensional object is changed in a similar manner as discussed above with reference to rotating the three-dimensional object in the environment relative to the viewpoint of the user according to the spring-based model. As another example, when the computer system rotates the three-dimensional object in the environment relative to the updated viewpoint of the user according to the magnetic-based model, the computer system tilts the first portion of the three-dimensional object from a first orientation prior to detecting the second input to a second orientation that faces toward the location of the updated viewpoint of the user in a pulling motion (e.g., as in an attraction between two magnets). Gradually rotating a three-dimensional object in a three-dimensional environment when changing an angle of elevation of the three-dimensional object relative to the viewpoint of the user in response to detecting movement of the object in the three-dimensional environment enables the three-dimensional object to automatically remain visibly displayed and/or oriented towards the viewpoint of the user in the user's field of view, while providing the eyes of the user time to adjust to the updated orientation of the three-dimensional object, which helps prevent user discomfort while viewing the three-dimensional object, thereby improving user-device interaction.

In some embodiments, while displaying the three-dimensional object in the environment and while not interacting with the three-dimensional object, the computer system detects, via the one or more input devices, movement of the viewpoint of the user relative to the three-dimensional object in the environment to an updated viewpoint, such as the movement of the viewpoint of the user as indicated by the downward arrow in the side view 1940 in FIG. 19M. For example, the computer system detects movement of the viewpoint of the user relative to the three-dimensional object without detecting other input, such as hand-based input (e.g., in the form of air pinch gestures or controller-based inputs), directed to the three-dimensional object. In some embodiments, the movement of the viewpoint of the user corresponds to movement of the head of the user, which causes the display generation component (e.g., and the computer system) to move in the physical environment of the display generation component, thereby shifting the viewpoint. In some embodiments, the movement of the viewpoint of the user corresponds to a shifting of the viewpoint (e.g., laterally or longitudinally in the physical environment) relative to the three-dimensional object (e.g., relative to a reference point or portion of the three-dimensional object, such as a front-facing surface of the three-dimensional object or an edge of the three-dimensional object) and/or corresponds to a rotation of the viewpoint (e.g., clockwise or counterclockwise in space) about a vertical axis through the (e.g., center of the) head of the user.

In some embodiments, in response to detecting the movement of the viewpoint, the computer system maintains an orientation of the three-dimensional object in the environment (e.g., forgoing rotating the three-dimensional object in the environment to tilt the first portion of the three-dimensional object toward a location of the updated viewpoint), such as maintaining the orientation of the three-dimensional object 1920 in the side view as shown in FIG. 19N. For example, though the position and/or orientation of the three-dimensional object changes relative to the updated viewpoint of the user due to the movement of the viewpoint of the user (e.g., because the viewpoint is from a different location and/or angle in the three-dimensional environment), the three-dimensional object remains at and/or is maintained with the same location and/or with the same orientation relative to the environment as before the movement of the viewpoint is detected (e.g., the three-dimensional object is environment-locked). Additionally, in some embodiments, the computer system forgoes changing the angle of elevation of the three-dimensional object relative to the horizon of the environment in response to detecting the movement of the viewpoint of the user. In some embodiments, as similarly discussed above, if the computer system detects an input directed to the three-dimensional object in the environment, such as an air pinch gesture, the computer system updates display of the three-dimensional object based on the updated viewpoint of the user. For example, the computer system changes the angle of elevation of the three-dimensional object and/or rotates the three-dimensional object in the environment to tilt the first portion of the three-dimensional object toward the location of the updated viewpoint based on the input as similarly discussed above. Forgoing rotating a three-dimensional object in a three-dimensional environment in response to detecting movement of the viewpoint of the user relative to the three-dimensional environment helps avoid unnecessary and/or undesired rotation of the three-dimensional object relative to the updated viewpoint of the user, thereby preserving computing resources and improving user-device interaction.

It should be understood that the particular order in which the operations in method 2000 have been described is merely exemplary and is not intended to indicate that the described order is the only order in which the operations could be performed. One of ordinary skill in the art would recognize various ways to reorder the operations described herein. In some embodiments, aspects/operations of methods 800, 1000, 1200, 1400, 1600, 1800 and/or 2000 may be interchanged, substituted, and/or added between these methods. For example, various object manipulation techniques, object movement techniques, and/or simulated physics and/or inertia techniques of methods 800, 1000, 1200, 1400, 1600, 1800 and/or 2000 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-27. (canceled)

28. A method comprising:
at a computer system in communication with a display generation component and one or more input devices:
displaying, via the display generation component, a virtual object at a first position within a three-dimensional environment;
while displaying, via the display generation component, the virtual object at the first position, detecting, via the one or more input devices, a first input including a request to move the virtual object from the first position to a second position within the three-dimensional environment, different from the first position;
in response to receiving the first input, displaying, via the display generation component, the virtual object at the second position within the three-dimensional environment;
after detecting termination of the first input:
in accordance with a determination that the second position satisfies one or first criteria, including a criterion that is satisfied when a respective portion of the virtual object corresponds to a respective position within the three-dimensional environment that is beyond a movement threshold in the three-dimensional environment, moving the virtual object from the second position to a third position within the three-dimensional environment, wherein the third position is different from the first position and the second position; and
in accordance with a determination that the second position does not satisfy the one or more first criteria, maintaining display of the virtual object at the second position within the three-dimensional environment.

29. The method of claim 28, wherein the virtual object is moved to the second position while the first input is ongoing, and the virtual object is moved to the third position in response to detecting the termination of the first input.

30. The method of claim 28, wherein the displaying of the virtual object at the second position occurs in response to receiving the first input and after detecting the termination of the first input.

31. The method of claim 30, further comprising:
in response to receiving the first input, after detecting the termination of the first input, and before displaying the virtual object at the second position and before displaying the virtual object at the third position, moving the virtual object from a fourth position to the second position within the three-dimensional environment with simulated inertia.

32. The method of claim 28, wherein the third position corresponds to a position within the three-dimensional environment coincident with the movement threshold.

33. The method of claim 28, wherein the movement threshold corresponds to a minimum allowed distance between the respective portion of the virtual object and a current viewpoint of a user of the computer system in the three-dimensional environment.

34. The method of claim 33, wherein the movement threshold has a respective spatial profile relative to the three-dimensional environment based on a respective portion of a body of the user of the computer system.

35. The method of claim 28, wherein the movement threshold corresponds to a maximum allowed distance between the respective portion of the virtual object and a current viewpoint of a user of the computer system in the three-dimensional environment.

36. The method of claim 28, wherein the movement threshold corresponds to a floor of a physical environment of a user of the computer system.

37. The method of claim 28, further comprising:
after detecting termination of the first input:
in accordance with a determination that the second position satisfies one or more second criteria, different from the one or more first criteria, including a criterion that is satisfied when the respective portion of the virtual object corresponds to a second respective position within the three-dimensional environment that is beyond a second movement threshold in the three-dimensional environment, different from the movement threshold in the three-dimensional environment, moving the virtual object from the second position to a fourth position within the three-dimensional environment, wherein the fourth position is different from the first position and the second position; and
in accordance with a determination that the second position does not satisfy the one or more second criteria and does not satisfy the one or more first criteria, maintaining display of the virtual object at the second position within the three-dimensional environment.

38. The method of claim 37, wherein the respective portion of the virtual object is different from a second respective portion of the virtual object.

39. The method of claim 28, wherein the movement threshold is a continuous threshold that corresponds to a plurality of different movement boundaries in the three-dimensional environment.

40. The method of claim 28, wherein the first input includes a first request to move the virtual object by a first magnitude beyond the movement threshold, and a second request to move the virtual object a second magnitude after moving the first magnitude beyond the movement threshold, the method further comprising:
in response to the first request, moving the virtual object a first amount beyond the movement threshold, wherein moving the virtual object the first amount beyond the movement threshold includes moving the virtual object a respective first movement per unit of movement in the first request; and
in response to the second request, moving the virtual object a second amount beyond the movement threshold, less than the first amount, wherein moving the virtual object the second amount beyond the movement threshold includes moving the virtual object a respective second movement per unit of movement in the second request, different from than the respective first movement per unit of movement.

41. The method of claim 28, wherein the first input includes a first request to move the virtual object a first magnitude beyond a respective movement threshold, and a second request to move the virtual object a second magnitude beyond the respective movement threshold, different from the first request, the method further comprising:
in accordance with a determination that the respective movement threshold is a first movement threshold
in response to the first request, moving the virtual object a first amount beyond the movement threshold, wherein moving the virtual object the first amount beyond the movement threshold includes moving the virtual object a respective first movement per unit of movement in the first request; and
in response to the second request, moving the virtual object a second amount beyond the movement threshold, less than the first amount, wherein moving the virtual object the second amount beyond the movement threshold includes moving the virtual object a respective second movement per unit of movement in the second request, different from the respective first movement per unit of movement in the first request; and
in accordance with a determination that the respective movement threshold is a second movement threshold, different from the first movement threshold:
in response to the first request, moving the virtual object a third amount beyond the movement threshold wherein moving the virtual object the third amount beyond the movement threshold includes moving the virtual object a respective third movement per unit of movement in the first request; and
in response to the second request, moving the virtual object a fourth amount beyond the movement threshold, less than the third amount, wherein moving the virtual object the fourth amount beyond the movement threshold includes moving the virtual object a respective fourth movement per unit of movement in the second request different from the respective third movement per unit of movement in the first request.

42. The method of claim 28, wherein the moving of the virtual object from the second position to the third position includes displaying an animation of the movement of the virtual object from the second position to the third position.

43. The method of claim 42, wherein displaying the animation of the movement of the virtual object from the second position to the third position includes:
in accordance with a determination that a distance between the second position and the movement threshold is a first distance, displaying the animation with a first magnitude; and
in accordance with a determination that the distance between the second position and the movement threshold is a second distance, different from the first distance, displaying the animation with a second magnitude, different from the first magnitude.

44. The method of claim 28, wherein movement of the virtual object beyond the movement threshold and movement of the virtual object from the second position to the third position is in accordance with a first set of one or more simulated physical properties associated with the movement threshold, the method further comprising:
while displaying, via the display generation component, the virtual object at the first position, detecting, via the one or more input devices, a second input, different from the first input, including a request to move the virtual object from the first position to a first updated position within the three-dimensional environment, different from the first position and the second position;
in response to receiving the second input, displaying, via the display generation component, the virtual object at the first updated position within the three-dimensional environment; and
after detecting termination of the second input:
in accordance with a determination that the first updated position satisfies one or second criteria, including a criterion that is satisfied when the respective portion of the virtual object corresponds to a respective second position within the three-dimensional environment that is beyond a second movement threshold in the three-dimensional environment, different from the movement threshold, moving the virtual object from the first updated position to a second updated position within the three-dimensional environment, wherein the second updated position is different from the first position and the first updated position, and wherein moving the virtual object to the second updated position is in accordance with the first set of one or more simulated physical properties; and
in accordance with a determination that the first updated position does not satisfy the one or more second criteria, maintaining display of the virtual object at the first updated position within the three-dimensional environment.

45. The method of claim 28, wherein movement of the virtual object beyond the movement threshold and movement of the virtual object from the second position to the third position is in accordance with a first set of one or more simulated physical properties associated with the movement threshold, the method further comprising:
while displaying, via the display generation component, the virtual object at the first position, detecting, via the one or more input devices, a second input, different from the first input, including a request to move the virtual object from the first position to a first updated position within the three-dimensional environment, different from the first position and the second position;
in response to receiving the second input, displaying, via the display generation component, the virtual object at the first updated position within the three-dimensional environment; and
after detecting termination of the second input:
in accordance with a determination that the first updated position satisfies one or second criteria, including a criterion that is satisfied when the respective portion of the virtual object corresponds to a respective second position within the three-dimensional environment that is beyond a second movement threshold in the three-dimensional environment, different from the movement threshold, moving the virtual object from the first updated position to a second updated position within the three-dimensional environment, wherein the second updated position is different from the first position and the first updated position, and wherein moving the virtual object from the first updated position to the second updated position is in accordance with a second set of one or more simulated physical properties, different from the first set of one or more simulated physical properties; and
in accordance with a determination that the first updated position does not satisfy the one or more second criteria, maintaining display of the virtual object at the first updated position within the three-dimensional environment.

46. The method of claim 45, further comprising:
while displaying, via the display generation component, the virtual object at the first position, detecting, via the one or more input devices, a third input, different from the first input and the second input, including a request to move the virtual object from the first position to a third updated position within the three-dimensional environment, different from the first position, the second position, and the first updated position;
in response to receiving the third input, displaying, via the display generation component, the virtual object at the third updated position within the three-dimensional environment;
after detecting termination of the third input:
in accordance with a determination that the third updated position satisfies the one or more first criteria and the one or second criteria, moving the virtual object from the third updated position to a fourth updated position within the three-dimensional environment, wherein the fourth updated position is different from the first position and the second updated position, and wherein moving the virtual object from the third updated position to the fourth updated position is in accordance with the first set of one or more simulated physical properties and the second set of one or more simulated physical properties; and
in accordance with a determination that the third updated position does not satisfy the one or more first criteria and does not satisfy the second one or more criteria, maintaining display of the virtual object at the third updated position within the three-dimensional environment.

47. The method of claim 28, wherein movement of the virtual object beyond the movement threshold and movement of the virtual object from the second position to the third position is in accordance with a first set of one or more simulated physical properties associated with the movement threshold, the method further comprising:
while displaying, via the display generation component, the virtual object at the first position, detecting, via the one or more input devices, a second input, different from the first input, including a request to move the virtual object from the first position to a first updated position within the three-dimensional environment, different from the first position and the second position;
in response to receiving the second input, displaying, via the display generation component, the virtual object at the first updated position within the three-dimensional environment;
after detecting termination of the second input:
in accordance with a determination that the first updated position satisfies one or second criteria, including a criterion that is satisfied when the respective portion of the virtual object corresponds to a respective second position within the three-dimensional environment that is beyond a second movement threshold in the three-dimensional environment, different from the movement threshold, moving the virtual object from the first updated position to a second updated position within the three-dimensional environment, wherein moving the virtual object from the first position to the first updated position and moving the virtual object from the first updated position to the second updated position is in accordance with the first set of one or more simulated physical properties; and
in accordance with a determination that the first updated position does not satisfy the one or more second criteria, maintaining display of the virtual object at the first updated position within the three-dimensional environment;
while displaying, via the display generation component, the virtual object at the first position, detecting, via the one or more input devices, a third input, different from the first input and the second input, including a request to move the virtual object from the first position to a third updated position within the three-dimensional environment, different from the first position and the first updated position;
in response to receiving the third input, displaying, via the display generation component, the virtual object at the third updated position within the three-dimensional environment;
after detecting termination of the third input:
in accordance with a determination that the third updated position satisfies one or more third criteria, including a criterion that is satisfied when the respective portion of the virtual object corresponds to a respective third position within the three-dimensional environment that is beyond a third movement threshold in the three-dimensional environment, different from the movement threshold and the second movement threshold, moving the virtual object from the third updated position to a fourth updated position within the three-dimensional environment, wherein moving the virtual object from the first position to the third updated position and moving the virtual object from the third updated position to the fourth updated position is in accordance with a second set of one or more simulated physical properties, different from the first set of one or more simulated physical properties; and
in accordance with a determination that the third updated position does not satisfy the one or more third criteria, maintaining display of the virtual object at the third updated position within the three-dimensional environment.

48. The method of claim 28, wherein:
in accordance with a determination that a posture of a user of the computer system is a first posture, the movement threshold corresponds to a first location within the three-dimensional environment; and
in accordance with a determination that the posture of the user is a second posture, different from the first posture, the movement threshold corresponds to a second location within the three-dimensional environment, different from the first location.

49. The method of claim 28, wherein the movement threshold corresponds to a first range of permissible distances relative to the three-dimensional environment in a first direction relative to the three-dimensional environment, the method further comprising:
while displaying, via the display generation component, the virtual object at the first position, detecting, via the one or more input devices, a second input, different from the first input, including a request to move the virtual object from the first position to a first updated position within the three-dimensional environment, different from the first position and the second position, wherein the movement of the virtual object is in a second direction relative to the three-dimensional environment, different from the first direction, and the first updated position corresponds to a position within the three-dimensional environment that corresponds to a location beyond a physical boundary within a physical environment of a user of the computer system; and
in response to receiving the second input, displaying, via the display generation component, the virtual object at the first updated position within the three-dimensional environment.

50. A computer system that is in communication with a display generation component and one or more input devices, the computer system comprising:
memory storing one or more programs; and
one or more processors, wherein the one or more programs are stored in the memory and configured to be executed by the one or more processors, the one or more programs including instructions for:
displaying, via the display generation component, a virtual object at a first position within a three-dimensional environment;
while displaying, via the display generation component, the virtual object at the first position, detecting, via the one or more input devices, a first input including a request to move the virtual object from the first position to a second position within the three-dimensional environment, different from the first position;
in response to receiving the first input, displaying, via the display generation component, the virtual object at the second position within the three-dimensional environment;
after detecting termination of the first input:
in accordance with a determination that the second position satisfies one or first criteria, including a criterion that is satisfied when a respective portion of the virtual object corresponds to a respective position within the three-dimensional environment that is beyond a movement threshold in the three-dimensional environment, moving the virtual object from the second position to a third position within the three-dimensional environment, wherein the third position is different from the first position and the second position; and
in accordance with a determination that the second position does not satisfy the one or more first criteria, maintaining display of the virtual object at the second position within the three-dimensional environment.

51. A non-transitory computer readable storage medium storing one or more programs, the one or more programs comprising instructions, which when executed by one or more processors of a computer system that is in communication with a display generation component and one or more input devices, cause the computer system to perform a method comprising:
displaying, via the display generation component, a virtual object at a first position within a three-dimensional environment;
while displaying, via the display generation component, the virtual object at the first position, detecting, via the one or more input devices, a first input including a request to move the virtual object from the first position to a second position within the three-dimensional environment, different from the first position;
in response to receiving the first input, displaying, via the display generation component, the virtual object at the second position within the three-dimensional environment;
after detecting termination of the first input:
in accordance with a determination that the second position satisfies one or first criteria, including a criterion that is satisfied when a respective portion of the virtual object corresponds to a respective position within the three-dimensional environment that is beyond a movement threshold in the three-dimensional environment, moving the virtual object from the second position to a third position within the three-dimensional environment, wherein the third position is different from the first position and the second position; and
in accordance with a determination that the second position does not satisfy the one or more first criteria, maintaining display of the virtual object at the second position within the three-dimensional environment.

52-170. (canceled)
